(19) United States
(12) Patent Application Publication
(10) Pub. No.: US 2007/0093969 A1
(43) Pub. Date: Apr. 26, 2007

(54) Molecular nephrotoxicology modeling

(76) Inventors: Donna L. Mendrick, Gaithersburg, MD (US); Mark W. Porter, Gaithersburg, MD (US); Kory R. Johnson, Gaithersburg, MD (US); Arthur Castle, Gaithersburg, MD (US); Brandon Higgs, Gaithersburg, MD (US); Michael Elashoff, Gaithersburg, MD (US)

Correspondence Address: COOLEY GODWARD LLP, THE BROWN BUILDING - 875 15TH STREET, NW, SUITE 800, WASHINGTON, DC, 20005-2221, US

(21) Appl. No.: 10/515,325

(22) PCT Filed: Nov. 24, 2003
(86) PCT No.: PCT/US03/37556

§ 371 Date: Sep. 16, 2005

(30) Foreign Application Priority Data
Nov. 22, 2002 (US) 10301856

(51) Int. Cl. G06F 19/00

(52) U.S. Cl. 702/20

(57) ABSTRACT

The present invention is based on the elucidation of the global changes in gene expression and the identification of toxicity markers in kidney tissues or cells exposed to a known renal toxin. The genes may be used as toxicity markers in drug screening and toxicity assays. The invention includes a database of genes characterized by toxin-induced differential expression that is designed for use with microarrays and other solid-phase probes.

### RELATED APPLICATIONS

This application is a continuation-in-part of U.S. application Ser. No. 10/301,856, filed Nov. 22, 2002, which is a continuation-in-part of U.S. application Ser. No. 10/152,319, filed May 22, 2002, which claims priority under 35 U.S.C. §119(e) to U.S. Provisional Application 60/292,335, filed May 22, 2001; 60/297,523, filed Jun. 13, 2001; 60/298,925, filed Jun. 19, 2001; 60/303,810, filed Jul. 10, 2001; 60/303,807, filed Jul. 10, 2001; 60/303,808, filed Jul. 10, 2001; 60/315,047, filed Aug. 28, 2001; 60/324,928, filed Sep. 27, 2001; 60/330,867, filed Nov. 1, 2001; 60/330,462, Oct. 22, 2001; 60/331,805, filed Nov. 21, 2001; 60/336,144, filed Dec. 6, 2001; 60/340,873, filed Dec. 19, 2001; 60/357,843, filed Feb. 21, 2002; 60/357,842, filed Feb. 21, 2002; 60/357,844, filed Feb. 21, 2002; 60/364,134 filed Mar. 15, 2002; 60/370,206, filed Apr. 8, 2002; 60/370,247, filed Apr. 8, 2002; 60/370,144, filed Apr. 8, 2002; 60/371,679, filed Apr. 12, 2002; and 60/372,794, filed Apr. 17, 2002, all of which are herein incorporated by reference in their entirety.

### SEQUENCE LISTING SUBMISSION ON COMPACT DISC

The Sequence Listing submitted concurrently herewith on compact disc under 37 C.F.R. §§1.821(c) and 1.821(e) is herein incorporated by reference in its entirety. Three copies of the Sequence Listing, one on each of three compact discs are provided. Copy 1 and Copy 2 are identical. Copies 1 and 2 are also identical to the CRF. Each electronic copy of the Sequence Listing was created on Nov. 20, 2003 with a file size of 2373 KB. The file names are as follows: Copy 1—g1508901wo.txt; Copy 2—g1508901wo.txt; CRF—g1508901wo.txt.

### BACKGROUND OF THE INVENTION

The need for methods of assessing the toxic impact of a compound, pharmaceutical agent or environmental pollutant on a cell or living organism has led to the development of procedures which utilize living organisms as biological monitors. The simplest and most convenient of these systems utilize unicellular microorganisms such as yeast and bacteria, since they are the most easily maintained and manipulated. In addition, unicellular screening systems often use easily detectable changes in phenotype to monitor the effect of test compounds on the cell. Unicellular organisms, however, are inadequate models for estimating the potential effects of many compounds on complex multicellular animals, as they do not have the ability to carry out biotransformations.

The biotransformation of chemical compounds by multicellular organisms is a significant factor in determining the overall toxicity of agents to which they are exposed. Accordingly, multicellular screening systems may be preferred or required to detect the toxic effects of compounds. The use of multicellular organisms as toxicology screening tools has been significantly hampered, however, by the lack of convenient screening mechanisms or endpoints, such as those available in yeast or bacterial systems. Additionally, previous attempts to produce toxicology prediction systems have failed to provide the necessary modeling data and statistical information to accurately predict toxic responses (e.g., WO 00/12760, WO 00/47761, WO 00/63435, WO 01/32928, and WO 01/38579).

### SUMMARY OF THE INVENTION

The present invention is based on the elucidation of the global changes in gene expression in renal tissues or cells exposed to known toxins, in particular renal toxins, as compared to unexposed tissues or cells as well as the identification of individual genes that are differentially expressed upon toxin exposure.

In various aspects, the invention includes methods of predicting at least one toxic effect of a compound, predicting the progression of a toxic effect of a compound, and predicting the renal toxicity of a compound. The invention also includes methods of identifying agents that modulate the onset or progression of a toxic response. Also provided are methods of predicting the cellular pathways that a compound modulates in a cell. The invention also includes methods of identifying agents that modulate protein activities.

In a further aspect, the invention includes probes comprising sequences that specifically hybridize to genes in Tables 1-5N. In some instances, the genes are rat genes. Also included are solid supports comprising at least two of the previously mentioned probes. The invention also includes a computer system that has a database containing information identifying the expression level in a tissue or cell sample exposed to a renal toxin of a set of genes comprising at least two genes in Tables 1-5N.

### DETAILED DESCRIPTION

Many biological functions are accomplished by altering the expression of various genes through transcriptional (e.g. through control of initiation, provision of RNA precursors, RNA processing, etc.) and/or translational control. For example, fundamental biological processes such as cell cycle, cell differentiation and cell death, are often characterized by the variations in the expression levels of groups of genes.

Changes in gene expression are also associated with the effects of various chemicals, drugs, toxins, pharmaceutical agents and pollutants on an organism or cell. For example, the lack of sufficient expression of functional tumor suppressor genes and/or the over expression of oncogene/protooncogenes after exposure to an agent could lead to tumorgenesis or hyperplastic growth of cells (Marshall (1991), Cell 64:313-326; Weinberg (1991), Science 254:1138-1146). Thus, changes in the expression levels of particular genes (e.g. oncogenes or tumor suppressors) may serve as signposts for the presence and progression of toxicity or other cellular responses to exposure to a particular compound.

Monitoring changes in gene expression may also provide certain advantages during drug screening and development. Often drugs are screened for the ability to interact with a major target without regard to other effects the drugs have on cells. These cellular effects may cause toxicity in the whole animal, which prevents the development and clinical use of the potential drug.

The present inventors have examined tissue from animals exposed to known renal toxins which induce detrimental kidney effects, to identify global changes in gene expression induced by these compounds. These global changes in gene expression, which can be detected by the production of expression profiles (an expression level of one or more genes), provide useful toxicity markers that can be used to monitor toxicity and/or toxicity progression by a test compound. Some of these markers may also be used to monitor or detect various disease or physiological states, disease progression, drug efficacy, and drug metabolism.

Identification of Toxicity Markers

To evaluate and identify gene expression changes that are predictive of toxicity, studies using selected compounds with well characterized toxicity have been conducted by the present inventors to catalogue altered gene expression. In the present studies, two different methods were used to create models and databases for predicting toxicity. In one model, RMA/PLS (raw data analysis by the robust multi-array average algorithm, with evaluation of predictive ability by the partial least squares algorithm), high doses of 39 compounds were selected as known renal toxins: acyclovir, adriamycin, amphotericin B, BEA (bromoethylamine hydrobromide), carboplatin, carbon tetrachloride, cephaloridine, chloroform, cidofovir, ciprofibrate, cisplatin, colchicine, cyclophosphamide, cyclosporine A, dantrolene, diflunisal, ethylene glycol, gentamicin, hexachloro-1,3-butadiene, hydralazine, ifosfamide, indomethacin, lithium chloride, meloxicam, menadione, mercuric chloride, olsalazine, puromycin aminonucleoside, pentamidine, phenacetin, propyleneimine, semustine, sodium chromate, sodium oxalate, sulfadiazine, suramin, tacrolimus, thioacetamide and vancomycin. Low doses of these compounds, or the vehicles in which they were prepared, were used as negative controls. Eight additional compounds, or the vehicles in which they were prepared were also selected as negative controls: ceftazidime (a broad spectrum, beta-lactam antibiotic), 17-alpha-ethinylestradiol (a synthetic estrogen), gemfibrozil (a drug that lowers serum triglycerides and LDL cholesterol and increases HDL cholesterol), phenobarbital (a sedative and anticholinergic/antispasmodic drug), streptomycin (an aminoglycoside antibiotic), tamoxifen (an anti-estrogen, breast cancer drug), temozolomide (an anti-cancer drug, especially for brain tumors) and transplatin (an anti-tumor drug).

In the other model, MAS/LDA (raw data analysis by the Affymetrix® MAS4 algorithm, with evaluation of predictive ability by linear discriminant analysis), high doses of the following compounds were selected as known renal toxins: indomethacin, diflunisal, colchicine, chloroform, diclofenac, menadione, sodium chromate, sodium oxalate, thioacetamide, vancomycin, acyclovir, adriamycin, AY-25329, bromoethylamine HBr (BEA), carboplatin, carbon tetrachloride, cephalosporine, cidofovir, cisplatin, citrinin, cyclophosphamide, cyclosporine, gentamicin, hexachloro-1,3-butadiene, hydralazine, ifosfamide, lithium chloride, mercuric chloride, pamindronate, puromycin aminonucleoside (PAN), semustine and sulfadiazine. Negative controls include low doses of these compounds and the vehicles in which the compounds were prepared. Additional negative controls include the following compounds: captopril, ceftazidime, phenobrbital, streptomycin, tamoxifen, temozolomide and transplatin, as well as the vehicles in which they were prepared. In the MAS/LDA model the following vehicles were used: corn oil, methylcellulose, gum tragacanth and saline.

Rat Nephrotoxins

Cephaloridine is an amphoteric, semi-synthetic, broad-spectrum cephalosporin derived from cephalosporin C. Cephalosporins are β-lactam-containing antibiotics which prevent bacterial growth by inhibiting polymerization of the peptidoglycan bacterial cell wall. The linear glycan chains (composed of N-acetylglucosime and N-acetylmuramic acid) are cross-linked to each other by the coupling of short chains of several amino acids, the coupling resulting from the action of a transpeptidase. It is believed that cephalosporins act by blocking the activity of the transpeptidase (Goodman & Gilman's The Pharmalogical Basis of Therapeutics 9^{th} ed., J. G. Hardman et al. Eds., McGraw Hill, New York, 1996, pp. 1074-1075, 1089-1095).

Cephaloridine is administered intramuscularly and is used to treat infections of the respiratory tract, gastrointestinal tract and urinary tract, as well as infections of soft tissue, bones and joints. Noted adverse effects include hypersensitivity reactions (such as anaphylactic shock, urticaria and bronchospasm), gastrointestinal disturbances, candidiasis, and cardiovascular and blood toxicity, in particular, toxicity to the hematopoietic system (cells responsible for the formation of red and white blood cells and platelets).

Although cephaloridine may be nephrotoxic at high dosages, it is not as harmful to the kidneys as are the aminoglycosides and polymixins. High dosages of cephaloridine may cause acute renal tubular necrosis (Cecil Textbook of Medicine. 20^{th} ed., part XII, p. 586, J. C. Bennett and F. Plum Eds., W.B. Saunders Co., Philadelphia, 1996) or drug-induced interstitial nephritis, which is accompanied by elevated IgE levels, fever, arthralgia and maculopapular rash. Renal biopsopy demonstrates edema and interstitial inflammatory lesions, mainly with lymphocytes, monocytes, eosinophils and plasma cells. Vasculitis of small vessels may develop, leading to necrotising glomerulonephritis (G. Koren, “The nephrotoxic potential of drugs and chemicals. Pharmacological basis and clinical relevance.,” Med Toxicol Adverse Drug Exp 4(1):59-72, 1989).

Cephaloridine has also been shown to reduce mitochondrial respiration and uptake of anionic succinate and carrier-mediated anionic substrate transport (Tune et al. (1990), J Pharmacol Exp Ther 252:65-69). In a study of oxidative stress and damage to kidney tissue, cephaloridine depleted reduced glutathione (GSH) and produced oxidized glutathione (GSSG) in the renal cortex. This drug also inhibited glutathione reductase and produced malondialdehyde and conjugated dienes (Tune et al. (1989), Biochem Pharmacol 38:795-802). Because cephaloridine is actively transported into the proximal renal tubule, but slowly transported across the lumenal membrane into the tubular fluid, high concentrations can accumulate and cause necrosis. Necrosis can be prevented by administering inhibitors of organic anion transport, although such treatment may be counterproductive, as cephaloridine is passed in and out of the kidney by the renal organic anion transport system (Tune et al. (1980), J Pharmacol Exp Ther 215:186-190).

Cisplatin (Pt (NH₃)₂(Cl)₂), a broad-spectrum anti-tumor agent, is commonly used to treat tumors of the testicles, ovaries, bladder, skin, head and neck, and lungs (PDR 47^{th} ed., pp. 754-757, Medical Economics Co., Inc., Montvale, N.J., 1993; Goodman & Gilman's The Pharmalogical Basis of Therapeutics 9^{th} ed., pp. 1269-1271, J. G. Hardman et al. Eds., McGraw Hill, New York, 1996). Cisplatin diffuses into cells and functions mainly by alkylating the N⁷ of guanine, a highly reactive site, causing interstrand and intrastrand crosslinks in the DNA that are lethal to cells. The drug is not sensitive to the cell cycle, although its effects are most pronounced in S phase.

Because the drug is cleared from the body mainly by the kidneys, the most frequent adverse effect of cisplatin usage is nephrotoxicity, the severity of which increases with increasing dosage and treatment terms. Other adverse effects include renal tubule damage, myelosuppression (reduced numbers of circulating platelets, leukocytes and erythrocytes), nausea and vomiting, ototoxicity, serum electrolyte disturbances (decreased concentrations of magnesium, calcium, sodium, potassium and phosphate, probably resulting from renal tubule damage), increased serum concentrations of urea and creatinine, and peripheral neuropathies.

In one study on rats (Nonclercq et al. (1989), Exp Mol Pathol 51:123-140) administration of cisplatin or carboplatin induced renal injury, carboplatin causing less damage than cisplatin. The most prominent injury was to the straight portion of proximal renal tubule.

In another rat study (Goldstein et al. (1981), Toxicol Appl Pharmacol 60:163-175) animals injected with cisplatin displayed decreased food intake as drug dosage increased. On day 2, the high-dose groups (10-15 mg/kg) exhibited a six or seven-fold elevation in BUN. On day 4, BUN elevation was noted in the 5 mg/kg group. An increase in urine volume was observed beginning on days 3-4, along with decreased urine osmolality in the low-dose groups (2.5 or 5 mg/kg). Another experiment on rats (Agarwal et al. (1995), Kidney Int 48:1298-1307) showed that cisplatin treatment produced elevations in serum creatinine levels, which began on day 3 and progressed for the duration of the study.

Puromycin aminonucleoside (PAN, C₂₂H₂₉N₇O₅), an antibiotic produced by Streptomyces alboniger, inhibits protein synthesis and is commonly used experimentally on rats to mimic human minimal change disease. One study showed that PAN-injected rats demonstrated an increase in levels of serum non-esterified fatty acids, while the serum albumin concentration was negatively affected (Sasaki et al. (1999), Adv Exp Med Biol 467:341-346).

In another rat study, an adenosine deaminase inhibitor prevented PAN nephrotoxicity, indicating that PAN toxicity is linked to adenosine metabolism (Nosaka et al. (1997), Free Radic Biol Med 22:597-605). Another group showed that PAN, when administered to rats, led to proteinuria, a condition associated with abnormal amounts of protein in the urine, and renal damage, e.g. blebbing of glomerular epithelial cells, focal separation of cells from the glomerular basement membrane, and fusion of podocytes (Olson et al. (1981), Lab Invest 44:271-279). In another study on rats, administration of PAN induced glomerular epithelial cell apoptosis in a dose- and time-dependent manner (Sanwal et al. (2001), Exp Mol Pathol 70:54-64).

One study with PAN-injected rats (Koukouritaki et al. (1998), J Investig Med 46: 284-289) examined the changes in the expression of the proteins paxillin, focal adhesion kinase, and Rho, all of which regulate cell adhesion to the extracellular matrix. Paxillin levels increased steadily, peaked at day 9 after PAN injection, and then remained elevated even after proteinuria resolved. There was no observed change in expression of either focal adhesion kinase or Rho.

BEA, (C₂H₆BrN.HBr), is commonly used experimentally on rats to induce papillary necrosis and renal cortex damage, which is similar to human analgesic nephropathy. BEA-induced papillary necrosis in rats eventually leads to the onset of focal glomerular sclerosis and nephrotic proteinuria (Garber et al. (1999), Am J Kidney Dis 33: 1033-1039). Even at low doses (50 mg/kg), BEA can induce an apex limited renal papillary necrosis (Bach et al. (1983), Toxicol Appl Pharmacol 69:333-344). In male Wistar rats, BEA administered at 100 mg/kg was shown to cause renal papillary necrosis within 24 hours (Bach et al. (1991), Food Chem Toxicol 29:211-219). Additionally, Bach et al. showed that there was an increase in urinary triglycerides, and lipid deposits were seen by Oil Red O lipid staining in the cells of the collecting ducts and hyperplastic urothelia adjacent to the necrosed region.

It has also been shown that succinate and citrate concentrations are significantly lower in the urine of BEA-treated rats (Holmes et al. (1995), Arch Toxicol 70:89-95). Moreover, BEA treatment induced glutaric and adipic aciduria, which is symptomatic of an enzyme deficiency in the acyl CoA dehydrogenases. The same study examined urinary taurine levels in desert mice, and in BEA-treated desert mice there was an increase in the urinary taurine level which is indicative of liver toxicity.

Another study on BEA-treated rats showed that there was an increase in the concentrations of creatine in the renal papilla and glutaric acid in the liver, renal cortex, and renal medulla as soon as 6 hours post-treatment (Garrod et al. (2001), Magn Reson Med 45: 781-790).

Discovered and purified in the early 1960's, gentamicin is a broad-spectrum aminoglycoside antibiotic that is cidal to aerobic gram-negative bacteria and commonly used to treat infections, e.g., those of the urinary tract, lungs and meninges. As is typical for an aminoglycoside, the compound is made of two amino sugar rings linked to a central aminocyclitol ring by glycosidic bonds. Aminoglycosides are absorbed poorly with oral administration, but are excreted rapidly by the kidneys. As a result, kidney toxicity is the main adverse effect, although ototoxicity and neuromuscular blockade can also occur. Gentamicin acts by interfering with bacterial protein synthesis. This compound is more potent than most other antibacterial inhibitors of protein synthesis, which are merely bacteriostatic, and its effects on the body are, likewise, more severe (Goodman & Gilman's The Pharmalogical Basis of Therapeutics 9^{th} ed., pp. 1103-1115, J. G. Hardman et al. Eds., McGraw Hill, New York, 1996).

Aminoglycosides work rapidly, and the rate of bacterial killing is concentration-dependent. Residual bactericidal activity remains after serum concentration has fallen below the minimum inhibitory concentration (MIC), with a duration that is also dosage/concentration-dependent. The residual activity allows for once-a-day administration in some patients. These drugs diffuse into bacterial cells through porin channels in the outer membrane and are then transported across the cytoplasmic membrane via a membrane potential that is negative on the inside (Goodman & Gilman, supra).

Kidney damage, which can develop into renal failure, is due to the attack of gentamicin on the proximal convoluted tubule, particularly in the S1 and S2 segments. The necrosis, however, is often patchy and focal (Shanley et al. (1990), Ren Fail 12:83-87). A rat study by Shanley et al. showed that superficial nephrons are more susceptible to necrosis than juxtamedullary nephrons, although the initial segment of the superficial nephrons is remarkably resistant to necrosis.

Reported enzymatic changes upon gentamicin treatment are increased activities of N-acetyl-beta-D-glucosamimidase and alkaline phosphatase and decreased activities of sphingomyelinase, cathepsin B, Na⁺/K⁺-ATPase, lactate dehydrogenase and NADPH cytochrome C reductase, along with decreased protein synthesis and alpha-methylglucose transport (Monteil et al. (1993), Ren Fail 15:475-483). An increase in gamma-glutamyl transpeptidase activity in urine has also been reported (Kocaoglu et al. (1994), Arch Immunol Ther Exp (Warsz) 42:125-127), and the quantification of this enzyme in urine is a useful marker for monitoring gentamicin toxicity.

One source of renal pathology resulting from gentamicin treatment is the generation of reactive oxygen metabolites. Gentamicin has been shown, both in vitro and in vivo, to be capable of enhancing the production of reactive oxygen species. Iron, a necessary co-factor that catalyzes free-radical formation, is supplied by cytochrome P450 (Baliga et al. (1999), Drug Metab Rev 31:971-997).

A gene delivery experiment in rats, in which the human kallikrein gene was cloned into an adenovirus vector and the construct then co-administered with a gentamicin preparation, showed that kallikrein can protect against gentamicin-induced nephrotoxicity. Significantly increased renal blood flow, glomerular filtration rates and urine flow were observed, along with decreased renal tubular damage, cellular necrosis and lumenal protein casts. Kallikrein gene delivery also caused a decrease in blood urea nitrogen levels and increases in urinary kinin and nitrite/nitrate levels. This study provides evidence that the tissue kallikrein-kinin system may be a key pathway that is perturbed during the induction of nephrotoxicity by gentamicin (Murakami et al. (1998), Kidney Int 53:1305-1313).

Ifosfamide, an alkylating agent, is commonly used in chemotherapy to treat testicular, cervical, and lung cancer. Ifosfamide is slowly activated in the liver by hydroxylation, forming the triazene derivative 5-(3,3-dimethyl-1-triazeno)-imidazole-4-carboxamide (DTIC) (Goodman & Gilman's The Pharmacological Basis of Therapeutics 9^{th} ed., p. 1235, J. G. Hardman et al., Eds., McGraw Hill, New York, 1996). Cytochrome P450 activates DTIC via an N-demethylation reaction yielding an alkylating moiety, diazomethane. The active metabolites are then able to cross-link DNA causing growth arrest and cell death. Though ifosfamide is therapeutically useful, it is also associated with nephrotoxicity, urotoxicity, and central neurotoxicity.

Mesna, another therapeutic, is often administered concomitantly to prevent kidney and bladder problems from arising (Brock and Pohl (1986), IARC Sci Publ 78:269-279). However, there are documented cases in which tubular toxicity occurred and elevated urinary levels of alanine aminopeptidase and N-acetyl-beta-D-glucosamimidase were found in patients even though mesna was administered alongside ifosfamide (Goren et al. (1987), Cancer Treat Rep 71:127-130).

One study examined 42 patients that had been administered ifosfamide to treat advanced soft-tissue sarcoma (Stuart-Harris et al. (1983), Cancer Chemother Pharmacol 11:69-72). The ifosfamide dosage varied from 5.0 g/m² to 8.0 g/m², and all of the patients were given mesna to counteract the negative effects of ifosfamide. Even so, nausea and vomiting were common to all of the patients. Out of the 42 patients, seven developed nephrotoxicity, and two of the cases progressed to fatal renal failure.

In another clinical study, renal tubular function was monitored in 18 neuroblastoma patients (Caron et al. (1992), Med Pediatr Oncol 20:42-47). Tubular toxicity occurred in at least 12 of the patients, and seven of those patients eventually developed Debre-de Toni-Fanconi syndrome, although in 3 cases the syndrome was reversible.

Fanconi syndrome is a disorder marked by dysfunction of the proximal tubules of the kidney. It is associated with aminoaciduria, renal glycosuria, and hyperphosphaturia. Ifosfamide is often used experimentally on rats to induce Fanconi syndrome. In one study, rats that were administered 80 mg/kg of ifosfamide had significantly lower body weight and hematocrit than control rats (Springate and Van Liew (1995), J Appl Toxicol 15:399-402). Additionally, the rats had low-grade glucosuria, proteinuria, and phosphaturia. In a mouse study, ifosfamide induced elevated serum creatinine and urea levels and decreased the clearance rate of creatinine (Badary (1999), J Ethnopharmacol 67:135-142).

Cyclophosphamide, a nitrogen mustard and alkylating agent, is highly toxic to dividing cells and is commonly used in chemotherapy to treat malignant lymphomas, such as non-Hodgkin's lymphomas and Burkitt's lymphoma, multiple myeloma, leukemias, neuroblastomas, ovarian adenocarcinomas and retinoblastomas, as well as breast and lung cancer (Goodman & Gilman's The Pharmacological Basis of Therapeutics 9^{th} ed., pp. 1234, 1237-1239, J. G. Hardman et al., eds., McGraw Hill, New York, 1996; Physicians Desk Reference, 47^{th} ed., pp. 744-745, Medical Economics Co., Inc., Montvale, N.J., 1993). Additionally, cyclophosphamide is used as an immunosuppressive agent in bone marrow transplantation and following organ transplantation. Although cyclophosphamide is therapeutically useful against certain types of cancer, it is also associated with cardiotoxicity, nephrotoxicity (including renal tubular necrosis), hemorrhagic cystitis, myelosuppression, hepatotoxicity, impairment of male and female reproductive systems, interstitial pneumonitis and central nervous system toxicity.

Once in the liver, cyclophosphamide is hydroxylated by the cytochrome P450 mixed function oxidase system, producing the active metabolites phosphoramide mustard and acrolein, which cross-link DNA and cause growth arrest and cell death. These metabolites, however, are highly toxic and cause adverse effects in the other organs into which they are transported, such as the kidneys. Acrolein is removed from the kidneys by secretion into the urine, resulting in cystitis (inflammation of the bladder), often hemorrhagic cystitis.

In the kidney, cyclophosphamide induces necrosis of the renal distal tubule. Cyclophosphamide, which is structurally similar to the anti-cancer drug ifosfamide, does not induce damage to the renal proximal tubule nor does it induce Debre-de Toni-Fanconi syndrome (Rossi et al. (1997), Nephrol Dial Transplant 12:1091-1092).

One clinical trial of patients being treated with cyclophosphamide showed that renal damage from the drug leads to a reduced biotransformation rate and low renal clearance of the drug, resulting in a build-up of toxic alkylating metabolic products (Wagner et al. (1980), Arzneimittelforschung 30:1588-1592).

In a study of patients suffering from malignant lymphomas and mammary carcinomas, a direct relationship was found between the dose of cyclophosphamide used in treatment and the concentration of alkylating metabolites in the patients' urine. The upper limit of the dose was determined by the nature and degree of the toxic side effects, rather than by the rate at which the drug could be metabolized (Saul et al. (1979), J Cancer Res Clin Oncol 94:277-286). It is the acrolein itself that is toxic, not the alkylating activity of cyclophosphamide (Brock et al. (1979), Arzneimittelforschung 29:659-661). A study on rats also showed that acrolein from the kidneys can produce hemorrhagic cystitis and that the acrolein concentration is directly related to the frequency and severity of the cystitis (Chijiwa et al. (1983), Cancer Res 43:5205-5209).

Carboplatin, a platinum coordination complex, is commonly used in chemotherapy as an anti-tumor agent. As a chemotherapeutic agent, carboplatin acts similarly to cisplatin. Carboplatin enters the cell by diffusion where it is activated by hydrolysis (Goodman & Gilman's The Pharmacological Basis of Therapeutics 9th ed., p. 1270-1271, J. G. Hardman et al. Eds., McGraw Hill, New York 1996). Once activated, the platinum complexes are able to react with DNA causing cross-linking to occur. One of the differences between carboplatin and cisplatin is that carboplatin is better tolerated clinically. Some of the side-effects associated with cisplatin, such as nausea, neurotoxicity, and nephrotoxicity, are seen at a lesser degree in patients administered carboplatin. Some other side-effects are hypomagnesaemia and hypokalaemia (Kintzel (2001), Drug Saf 24:19-38).

In one study on male Wistar rats, carboplatin was administered at a dosage of 65 mg/kg (Wolfgang et al. (1994), Fundam Appl Toxicol 22:73-79). After treatment with carboplatin, CGT excretion was increased approximately two-fold.

Another study compared cisplatin and carboplatin when given in combination with vindesine and mitomycin C (Jelic et al. (2001) Lung Cancer 34:1-13). The study showed that carboplatin administered with vindesine and mitomycin C was advantageous in terms of overall survival, although the regimen was more hematologically toxic than when cisplatin was given.

AY-25329, is a phenothiazine that has been shown to be mildly hepatotoxic and to induce nephrosis. Its structure is shown below.

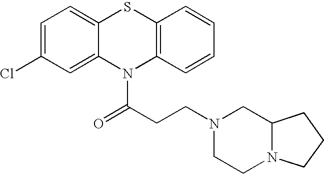

Phenothiazines are a class of psychoactive drugs. They have been used to treat schizophrenia, paranoia, mania, hyperactivity in children, some forms of senility, and anxiety (http://www.encyclopedia.com/articlesnew/36591.html). Some side effects associated with prolonged use of the drugs are reduced blood pressure, Parkinsonism, reduction of motor activity, and visual impairment.

Chlorpromazine (Thorazine or Largactil) is an aliphatic phenothiazine and is widely used for treating schizophrenia and manic depression. Prolactin secretion is increased while taking chlorpromazine, and galactorrhea and gynecomastia have both been associated with the drug (http://www.mentalhealth.com/drug/p30-c01.html). Trifluoperazine is another prescribed phenothiazine. It is used to treat anxiety, to prevent nausea and vomiting, and to manage psychotic disorders (http://www.mentalhealth.com/drug/p30-s04.html). Negative side-effects that have been associated with the drug are liver damage, bone marrow depression, and Parkinsonism.

Acyclovir (9-[(2-hydroxyethyl)methyl]guanine, Zovirax®), an anti-viral guanosine analogue, is used to treat herpes simplex virus (HSV), varicella zoster virus (VZV) and Epstein-Barr virus (EBV) infections. It is transported into cells by the nucleoside transporter that imports guanine, and acyclovir is phosphorylated by virally encoded thymidine kinase (TK). Other kinases convert acyclovir to its activated di- and triphosphate forms, which prevent the polymerization of viral DNA. Acyclovir triphosphate competes with dGTP for the viral polymerase, and acyclovir is preferentially incorporated, but as a monophosphate. As a result, chain elongation ceases (Fields Virology 3d ed., Fields et al., eds., pp. 436-440, Lippincott-Raven Publishers, Philadelphia, 1996; Cecil Textbook of Medicine, 20^{th} ed., part XII, p. 1742, J. C. Bennett and F. Plum Eds., W.B. Saunders Co., Philadelphia, 1996).

The pharmacokinetics of acyclovir show that it has a useful half-life of about three hours and that most of it is excreted in the urine largely unchanged (Brigden et al. (1985), Scand J Infect Dis Suppl 47:33-39). Not surprisingly, the most frequent adverse effect of acyclovir treatment is damage to various parts of the kidney, particularly the renal tubules. Crystalluria, or the precipitation of crystals (in this case, crystals of acyclovir), in the lumina of the renal tubules can occur (Fogazzi (1996), Nephrol Dial Transplant 11:379-387). If the drug crystallizes in the renal collecting tubules, obstructive nephropathy and tubular necrosis can result (Richardson (2000), Vet Hum Toxicol 42:370-371). Tissues from biopsies of affected patients showed dilation of the proximal and distal renal tubules, with loss of the brush border, flattening of the lining cells and focal nuclear loss (Becker et al. (1993), Am J Kidney Dis 22:611-615).

Citrinin, a mycotoxin produced by the fungus Penicillium citrinum, is a natural contaminant of foods and feeds (Bondy and Armstrong (1998) Cell Biol. Toxicol. 14:323-332). It is known that mycotoxins can have negative effects on the immune system, however citrinin-treated animals have been shown to stimulate responses against antigens (Sharma (1993) J. Dairy Sci. 76:892-897). Citrinin is a known nephrotoxin, and in birds such as chickens, ducklings, and turkeys, it causes diarrhea, increased food consumption and reduced weight gain due to kidney degeneration (Mehdi et al. (1981) Food Cosmet. Toxicol. 19:723-733; Mehdi et al. (1984) Vet. Pathol. 21:216-223). In the turkey and duckling study, both species exhibited nephrosis with the occurrence of hepatic and lymphoid lesions (Mehdi et al., 1984).

In one study, citrinin was administered to rabbits as a single oral dose of either 120 or 67 mg/kg (Hanika et al. (1986) Vet. Pathol. 23:245-253). Rabbits treated with citrinin exhibited renal alterations such as condensed and distorted mitochondria, distended intercellular spaces of the medullary and straight cortical distal tubules, and disorganization of interdigitating processes. In another rabbit study, citrinin-administered rabbits displayed azotaemia and metabolic acidosis (Hanika et al. (1984) Food Chem. Toxicol. 22:999-1008). Renal failure was indicated by decreased creatinine clearance and increased blood urea nitrogen and serum-creatinine levels.

In the past, mercury was an important component of pharmaceuticals, particularly of antiseptics, antibacterials, skin ointments, diuretics and laxatives. Although, mercury has been largely replaced by more effective, more specific and safer compounds, making drug-induced mercury poisoning rare, it is still widely used in industry. Poisoning from occupational exposure and environmental pollution, such as mercury release into public water supplies, remains a concern as wildlife, domestic animals and humans are affected.

Because of their lipid solubility and ability to cross the blood-brain barrier, the most dangerous form of mercury is the organomercurials, the most common of which is methylmercury, a fungicide used for disinfecting crop seeds. In a number of countries, incidents involving large-scale illness and death from mercury poisoning have been reported when mercury-contaminated seeds were planted and the crops harvested and consumed. A second source of organic mercury poisoning results from industrial chemicals containing inorganic mercury, such as mercury catalysts, which form methylmercury as a reaction product. If this waste product is released into reservoirs, lakes, rivers or bays, the surrounding population can become sick or die, particularly those who eat local fish.

The inorganic salt mercuric chloride, HgCl₂, as well as other mercuric salts, are more irritating and more toxic than the mercurous forms. Mercuric chloride is used today in industry, for the manufacture of bleach, electronics, plastics, fungicides and dental amalgams. The main source of human exposure is industrial dumping into rivers (Goodman & Gilman's: The Pharmacological Basis of Therapeutics (9th ed.), pp. 1654-1659, McGraw-Hill, New York, 1996).

When inorganic mercury salts are ingested, about 10% of the mercuric ions are absorbed by the gastrointenstinal tract, and a considerable portion of the Hg²⁺ can remain bound to the mucosal surfaces. The highest concentration of Hg²⁺ is found in the kidneys, as it is retained there longer than in other tissues. Consequently, the kidneys are the organ most adversely affected by inorganic mercury poisoning. The proximal tubules are the major site of damage, where tubular necrosis results. The mercury affects primarily the S2 and S3 portions of the proximal tubules, but, at high levels of mercury exposure, the S1 and distal portions of the tubules are also damaged. These regions of the nephrons are affected because they contain enzymes (such as gamma-glutamyltranspeptidase) and transport proteins (such as the basolateral organic anion transport system) involved in mercury uptake (Diamond et al. (1998), Toxicol Pathol 26:92-103).

Urinary markers of mercury toxicity which can be detected in NMR spectra include elevated levels of lactate, acetate and taurine and decreased levels of hippurate (Holmes et al. (2000), Chem Res Toxicol 13:471-478). Known changes in gene expression in kidneys exposed to Hg²⁺ include up-regulation of the heat-shock protein hsp72 and of the glucose-regulated protein grp94. The degree of tissue necrosis and level of expression of these proteins is proportional to both the dose of mercury (Hg²⁺) and the length of the exposure time to mercury (Hg²⁺), with hsp72 accumulating in the renal cortex and grp94 accumulating in the renal medulla (Goering et al. (2000), Toxicol Sci 53:447-457).

Indomethacin is a non-steroidal antiinflammatory, antipyretic and analgesic drug commonly used to treat diseases such as rheumatoid arthritis, osteoarthritis, ankylosing spondylitis and gout. This drug acts as a potent inhibitor of prostaglandin synthesis; it inhibits the cyclooxygenase enzyme necessary for the conversion of arachidonic acid to prostaglandins (PDR 47th ed., Medical Economics Co., Inc., Montvale, N.J., 1993; Goodman & Gilman's The Pharmalogical Basis of Therapeutics 9th ed., J. G. Hardman et al., Eds., McGraw Hill, New York, 1996, pp. 1074-1075, 1089-1095; Cecil Textbook of Medicine, 20th ed., part XII, pp. 772-773, 805-808, J. C. Bennett and F. Plum Eds., W.B. Saunders Co., Philadelphia, 1996).

The most frequent adverse effects of indomethacin treatment are gastrointestinal disturbances, e.g., bleeding, ulcers and perforations, although renal toxicity can also result, particularly after long-term administration. In rats, hemorrhage and necrosis have been observed in the renal papillae and fornix, as well as damage to the thick ascending limbs (mTALs), and interstitial nephritis with hematuria, proteinuria and nephrotic syndrome have been reported in humans. Patients suffering from renal dysfunction risk developing a reduction in renal blood flow and urinary outflow, because renal prostaglandins play an important role in renal perfusion and glomerular filtration (Heyman et al. (1997), Kidney Int 51: 653-663).

Diflunisal, a non-steroidal anti-inflammatory drug (NSAID), is a difluorophenyl derivative of salicylic acid (Goodman & Gilman's The Pharmacological Basis of Therapeutics 9^{th} ed., p. 631, J. G. Hardman et al., Eds., McGraw Hill, New York, 1996). It is most frequently used in the treatment of osteoarthritis and musculoskeletal strains. NSAIDs have analgesic, antipyretic and anti-inflammatory actions, however hepatotoxicity is known to be an adverse side effect of NSAID treatment (Masubuchi et al. (1998) J. Pharmacol. Exp. Ther. 287:208-213). Diflunisal has been shown to be less toxic than other NSAIDs, nevertheless over long periods of dosage it can lead to deleterious effects on platelet or kidney function (Bergamo et al. (1989) Am. J. Nephrol. 9:460-463). Other side effects that have been associated with diflunisal treatment are diarrhea, dizziness, drowsiness, gas or heartburn, headache, nausea, vomiting, and insomnia (http://arthritisinsight.com/medical/meds/dolobid.html).

Masubuchi et al. compared the hepatotoxicity of 18 acidic NSAIDs. In the study, diflunisal (administered at a concentration of 500 μM) was shown to increase LDH leakage in rat hepatocytes, a marker for cell injury, when compared to the control sample. In addition, treatment with diflunisal led to decreased intracellular ATP concentrations.

One study compared the effects of diflunisal and ibuprofen when given to patients over a two week period (Muncie and Nasrallah (1989) Clin. Ther. 11:539-544). In both the ibuprofen and the diflunisal group, two patients complained of abdominal cramping. The study indicated that even during short-term usage some gastrointestinal effects may occur. The toxic dose used in this study was chosen as one that did not induce significant gastric ulceration in rats. The group of rats given the high dosage of diflunisal had increased concentrations of creatinine which is consistent with renal injury, although dehydration may also cause increases in creatinine concentration.

Cidofovir (Vistide®) is an antiviral cytosine analog used in the treatment of viral infections such as herpesvirus, adenovirus, papillomavirus, poxvirus and hepadnavirus (Goodman & Gilman's The Pharmacological Basis of Therapeutics 9^{th} ed., p. 1216, J. G. Hardman et al., Eds., McGraw Hill, New York, 1996). It is also useful for the treatment of cytomegalovirus (CMV) infection, which is a type of herpesvirus.

Some mild side effects seen in patients receiving cidofovir are nausea, vomiting, and fever. The most serious reported side effect of the drug is kidney toxicity (http://tthivclinic.com/cido.html). In response to the threat of nephrotoxicity, it is necessary for patients receiving cidofovir to have their kidneys checked before treatment, and the patients must be monitored during treatment for early symptoms of kidney problems. In addition, cidofovir is given with fluids to help reduce the risk of kidney toxicity (http://www.aidsinfonyc.org/network/simple/cido.html). Probenecid, a drug that helps protect the kidneys, is normally administered concomitantly (Lalezari and Kuppermann (1997) J. Acquir. Immune Defic. Syndr. Hum. Retrovirol. 14:S27-31).

One study compared the safety and efficacy of cidofovir in the treatment of CMV (Lalezari et al. (1998) J. Acquir. Immune Defic. Syndr. Hum. Retrovirol. 17:339-344). Approximately 40% of the patients exhibited dose-dependent asymptomatic proteinuria and 25% of the patients had elevated serum creatinine levels.

Pamidronate (Aredia®) is a bisphosphonate drug that is clinically used to inhibit bone resorption and make bones more stable. It is used to treat hypercalcemia (too much calcium in the blood) that occurs with some types of cancer. Typically administered by intravenous injection, pamidronate is frequently used in patients with breast cancer or multiple myeloma whose disease has spread to the bones. Some side effects related to pamidronate treatment are abdominal cramps, chills, confusion, fever, muscle spasms, nausea, muscle stiffness, and swelling at the injection site (http://www.nursing.uiowa.edu/sites/PedsPain/Adjuvants/PAMIDRnt.html). Patients with kidney problems may be prohibited from using pamidronate as it is excreted through the kidneys.

In one study, rats and mice were given varying doses of labeled pamidronate (Cal and Daley-Yates (1990) Toxicology 65:179-197). Pamidronate treatment led to significant weight loss and a decrease in creatinine clearance. Morphological studies showed a loss of brush border membranes and the presence of focal proximal tubular necrosis.

Another study compared the tolerability of different treatments for hypercalcemia of malignancy by reviewing articles published between 1979 and 1998 (Zojer et al. (1999) Drug Saf. 21:389-406). The authors found that elevated serum creatinine level, nausea, and fever were reported following treatment with bisphosphonates such as pamidronate.

Markowitz et al. (2001, J. Am. Soc. Nephrol. 12:1164-1172) tried to determine whether there was a correlation between pamidronate treatment and collapsing focal segmental glomerulosclerosis (FSGS). The authors examined the histories of seven patients who had developed collapsing FSGS, and they found that the only drug treatment in common was the administration of pamidronate. When given at the recommended dose of 90 mg per month, renal toxicity was rare. However, when pamidronate was given at higher doses nephrotoxicity occurred.

Lithium, an alkali metal, is the main pharmacological treatment for bipolar disorders. It is typically given as a salt, such as lithium carbonate or lithium citrate. Some common side effects of lithium treatment are an increase in urination, increase in drinking, dry mouth, weight gain, fine tremor, and fatigue. Some more serious side effects related to lithium treatment are blurred vision, mental confusion, seizures, vomiting, diarrhea, muscle weakness, drowsiness, and coarse tremor (Goodman & Gilman's The Pharmacological Basis of Therapeutics 9^{th} ed., p. 448, J. G. Hardman et al., Eds., McGraw Hill, New York, 1996).

Since lithium is often used on a maintenance basis for a lifelong period, numerous studies have been performed to try and elucidate the effects of lithium on the kidney. One group administered lithium in daily doses within the human therapeutic range to male Wistar rats (Kling et al. (1984) Lab Invest 50:526-535). Rats that were given lithium developed marked polyuria within three weeks of the initial dosing. The rats displayed elevated free water clearance and vasopressin-resistant diabetes insipidus. The cortical collecting tubules displayed morphological changes, e.g. dilation of the tubules, bulging cells lining the tubules, enlarged nuclei, following lithium treatment.

Another study examined a human population that had been given lithium for the treatment of bipolar disorder (Markowitz et al. (2000) J. Am. Soc. Nephrol. 11: 1439-1448). The patients had a mean age of 42.5 years and had been undergoing lithium treatment from 2 to 25 years (mean of 13.6 years). Approximately one fourth of the patients had nephrotic proteinuria, almost 90% of them had nephrogenic diabetes insipidus (NDI), and renal biopsies revealed a chronic tubulointerstitial nephropathy in all of the patients. Following cessation of lithium treatment, seven of the patients proceeded to end-stage renal disease.

Even though nephrotoxicity is a known side effect of lithium treatment, some studies have indicated that in actuality it is not all that common (Johnson (1998) Neuropsychopharmacology 19:200-205). One study showed that the NDI-like effect in lithium treatment was easily overcome by increasing the levels of arginine vasopressin (AVP) (Carney et al. (1996) Kidney Int 50:377-383). Other studies have suggested that patients with psychiatric disorders display certain defects in renal function without undergoing lithium treatment (Gitlin (1999) Drug Saf 20:231-243).

Hydralazine, an antihypertensive drug, causes relaxation of arteriolar smooth muscle. Such vasodilation is linked to vigorous stimulation of the sympathetic nervous system, which in turn leads to increased heart rate and contractility, increased plasma renin activity, and fluid retention (Goodman & Gilman's The Pharmacological Basis of Therapeutics 9^{th} ed., p. 794, J. G. Hardman et al., Eds., McGraw Hill, New York, 1996). The increased renin activity leads to an increase in angiotensin II, which in turn causes stimulation of aldosterone and sodium reabsorption.

Hydralazine is used for the treatment of high blood pressure (hypertension) and for the treatment of pregnant women suffering from high blood pressure (pre-eclampsia or eclampsia). Some common side effects associated with hydralazine use are diarrhea, rapid heartbeat, headache, decreased appetite, and nausea. Hydralazine is often used concomitantly with drugs that inhibit sympathetic activity to combat the mild pulmonary hypertension that can be associated with hydralazine usage.

In one hydralazine study, rats were fed hydralazine and mineral metabolism was monitored (Peters et al. (1988) Toxicol Lett 41:193-202). Manganese and zinc concentrations were not effected by hydralazine treatment, however tissue iron concentrations were decreased and kidney copper concentrations were increased compared to control groups.

Another study compared the effects of hydrazine, phenelzine, and hydralazine treatment on rats (Runge-Morris et al. (1996) Drug Metab Dispos 24:734-737). Hydralazine caused an increase in renal GST-alpha subunit expression, although unlike hydrazine and phenelzine it did not alter renal cytochrome P4502E1 expression.

Colchicine, an alkoloid of Colchicum autumale, is an antiinflammnatory agent used in the treatment of gouty arthritis (Goodman & Gilman's The Pharmacological Basis of Therapeutics 9^{th} ed., p. 647, J. G. Hardman et al., Eds., McGraw Hill, New York, 1996).

An antimitotic agent, colchicine binds to tubulin which leads to depolymerization and disappearance of the fibrillar microtubules in granulocytes and other motile cells. In doing so, the migration of granulocytes into the inflamed area is inhibited. Through a series of events, the inflammatory response is blocked.

Some common, mild side effects associated with colchicine treatment are loss of appetite and hair loss. More severe side effects that warrant cessation of treatment are nausea, vomiting, diarrhea, and abdominal pain. Colchicine overdose can induce multiorgan failure with a high incidence of mortality. In this setting, renal failure is multifactorial and related to prolonged hypotension, hypoxemia, sepsis, and rhabdomyolysis. In rats, less dramatic doses have been shown to inhibit the secretion of many endogenous proteins such as insulin and parathyroid hormone.

One study investigated the effects of colchicine on microtubule polymerization status and post-translational modifications of tubulin in rat seminiferous tubules (Correa and Miller (2001) Biol Reprod 64:1644-1652). Colchicine caused extensive microtubule depolymerization, and total tubulin levels decreased twofold after colchicine treatment. The authors also found that colchicine treatment led to a decrease in tyrosination of the microtubule pool of tubulin which was associated with depolymerization of microtubules.

Sulfadiazine, a sulfonamide, is an antimicrobial agent. It is commonly used concomitantly with pyrimethamine to treat toxoplasmosis, an infection of the brain, in patient suffering from AIDS. These drugs are able to cross the blood-brain barrier and are used at relatively high doses. In addition, sulfadiazine has been shown to be effective at preventing certain types of meningococcal diseases and in treating urinary tract infections.

Sulfonamides in general are structural analogs of para-aminobenzoic acid (PABA). Because they are competitive antagonists of PABA, sulfonamides are effective against bacteria that are required to utilize PABA for the synthesis of folic acid (Goodman & Gilman's The Pharmacological Basis of Therapeutics 9^{th} ed., p. 1058-1060, J. G. Hardman et al., Eds., McGraw Hill, New York, 1996).

The main side effects associated with sulfadiazine treatment are fever and skin rashes. Decreases in white blood cells, red blood cells, and platelets, nausea, vomiting, and diarrhea are some other side effects that may result from sulfadiazine treatment. The most troublesome problem with this drug for HIV/AIDS patients is kidney toxicity. These patients tend to use these drugs for extended periods of time, which puts a constant strain on the kidneys. In addition, kidney stones tend to form in the bladder and ureter thereby blocking the flow of urine. Kidney damage may result, and if left untreated kidney failure may occur. Therefore, patients being treated with sulfadiazine are instructed to increase their fluid intake in order to prevent crystal formation in the kidneys.

One case study examined four HIV-positive patients who had been given sulfadiazine to treat toxoplasmosis (Crespo et al. (2000) Clin Nephrol 54:68-72). All four of the patients, one of whom was a previously healthy person, developed oliguria, abdominal pain, renal failure, and displayed multiple radiolucent renal calculi in echography. Following extensive hydration and alcalinization, the renal function of the patients returned to normal.

Adriamycin, known generically as doxorubicin, is an anthracycline antibiotic produced by the fungus Streptomyces peucetius. It is an anti-tumor drug used in the treatment of breast, ovarian, bladder, and lung cancers as well as non-Hodgkin's lymphoma, Hodgkin's disease and sarcoma (Goodman & Gilman's The Pharmacological Basis of Therapeutics 9^{th} ed., p. 1264-1265, J. G. Hardman et al., Eds., McGraw Hill, New York, 1996).

Adriamycin has tetracycline ring structures with the sugar daunosamine attached by glycosidic linkage. It is able to intercalate with DNA, it affects DNA and RNA synthesis, and it can interact with cell membranes and alter their functions. Typically the drug is cell-cycle specific for the S phase of cell division. By binding to the cancer cells' DNA and blocking topoisomerase II, cancer cells are unable to divide and grow.

Some common side effects associated with adriamycin treatment are fatigue, a drop in white blood cell, red blood cell, or platelet count, hair loss, skin discoloration, and watery eyes (www.cancerhelp.org.uk/help/default.asp?page=4025). More serious side effects include myocardial toxicity, ulceration and necrosis of the colon, and development of a second cancer.

Because of its utility in fighting cancer, numerous studies have been performed in attempts to further understand the mechanisms and effects of adriamycin. In one study, investigators injected mice with a single dose of adriamycin (Chen et al. (1998) Nephron 78:440-452). The mice exhibited signs of combined glomerular albuminuria and immunoglublinuria, progressively elevated levels of nitrite/nitrate in the urine, abnormal renal function, and other symptoms indicative of focal segmental glomerulosclerosis.

In another study, rats were given adriamycin and the effects on angiotensin converting enzyme (ACE) were monitored (Venkatesan et al. (1993) Toxicology 85:137-148). The rats developed glomerular and tubular injury, and serum ACE levels were significantly elevated 20, 25, and 30 days post-treatment. A different study followed rabbits for up to one year that were treated with either adriamycin, nephrectomy, or combinations thereof (Gadeholt-Gothlin et al. (1995) Urol Res 23:169-173). The rabbits that were treated with adriamycin exhibited signs of nephrotoxicity at relatively low doses.

Menadione (vitamin K₃) is a fat-soluble vitamin precursor that is converted into menaquinone in the liver. The primary known function of vitamin K is to assist in normal blood clotting, but it may also play a role in bone calcificaton. Menadione is a quinone compound that induces oxidative stress. It has been used as an anticancer agent and radiosensitizer and can produce toxicity in the kidney, lung, heart, and liver. In the kidney, signs of toxicity are dose-dependent, ranging from minor degranulation of tubular cells at lower doses to tubular dilatation, formation of protein casts in the renal tubules, calcium mineralization, vacuolization in the proximal and distal renal tubules, granular degeneration in the cortex and necrosis and apoptosis (Chiou et al., Toxicology (1997) 124(3):193-202).

Monocrotaline, an alkaloid obtained from Crotalaria spectabilis, a warm-climate garden plant, induces multi-organ toxicity affecting the kidney, heart, liver and lung. This compound is used to induce mesangiolysis in the kidney, to mimic the effects of Habu venom poisoning and hemolytic-uremic syndrome. Renal lesions in rats first appeared in the glomerular capillaries (endothelial cell detachment and adhesion of platelets to the basal lamina), followed by severe edema in the mesangium. Mesangiolysis subsequently occurred, accompanied by dilatation or obliteration of capillaries and necrosis and hemorrhage in the mesangium (Kurozumi et al., Exp Mol Pathol (1983) 39(3):377-386).

Vancomycin is a polycyclic glycoprotein antibiotic that is used to treat severe systemic infections by beta-lactam-resistant bacteria, in particular, resistant staphylococci. This drug may be given to patients who are allergic to penicillin. Vancomycin can induce renal failure and interstitial nephritis (Physicians Desk Reference 56th Ed., pp. 1970-1971, Medical Economics Co., Montvale, N.J., 2002).

Sodium chromate, a model compound used to induce liver toxicity, also produces toxic effects in the kidney. Necrosis of the S1 segment of the proximal tubule has been reported, as well as acute renal failure, characterized by increased levels of kininogens in the renal cortex and medulla and in urine and decreased rates of glomerular filtration (Bompart et al., Nephron (1993) 65(4):612-618; Beckwith-Hall et al., Chem Res Toxicol (1998) 11(4):260-272).

In the kidney, sodium oxalate forms crystals in the urinary tract, resulting in tubular obstruction, and produces calcific kidney stones in humans and in rats. The stones are located on renal papillary surfaces and consist of an organic matrix and crystals of calcium oxalate and/or calcium phosphate. The matrix is intimately associated with the crystals and contains substances that both promote and inhibit calcification: osteopontin, Tamm-Horsfall protein, bikunin and prothrombin fragment 1. Rats with these stones show decreased urine levels of magnesium and citrate, and the same is believed to occur in humans. Males of both species tend to develop calcium oxalate kidney stones, whereas females tend to form calcium phosphate stones (Khan, World J Urol (1997) 15(4):236-243).

Hexachloro-1,2-butadiene (HCBD) is a solvent that forms toxic conjugates and metabolites with glutathione, cysteine and N-acetyl cysteine. These then cause damage to the S1, S2 and S3 (pars recta) segments of the proximal tubules in the outer medulla of the kidney. Mitochondrial swelling has been observed in the S1 and S2 segments, although most of the pathological changes occur in the S2 and S3 segments (loss of brush boarder and cellular necrosis in S2, necrosis in S3). In rats, HCBD is about four times more toxic to females than to males (Ishmael et al., Toxicol Pathol (1986) 14(2):258-262; Ishmael et al., J Pathol (1982) 138(2):99-113).

Chloroform (CHCl₃) is widely used in the manufacture of drugs, cosmetics, plastics and cleaning agents and is a contaminant by-product in chlorinated drinking water. Chloroform was also an early anesthetic used in humans, and, therefore, much is known regarding its toxicity. Exposure can induce liver and kidney damage and cardiac arrthymias.

Toxic levels of exposure in rodents are carcinogenic due to the chronic cycle of cell injury and repair that is induced, rather than because of direct genotoxic action. The injury to the liver and kidney are thought to occur by two different mechanisms related to its metabolism in the target organ. Studies have shown that the extent of liver and kidney damage and necrosis relates multiple factors including sex, strain, route of exposure and the vehicle used. In the kidney, biotransformation of chloroform by cytochrome P450 produces reactive intermediates, which damage mainly the renal proximal tubules. Typical signs of nephrotoxicity include proteinuria, glucosuria and increased BUN levels (Casarett & Doull's Toxicology: The Basic Science of Poisons 6th Ed., Klaasen, ed., Chap. 14, pp. 503-508, McGraw-Hill, New York, 2001; Smith et al., Toxicol Appl Pharmacol 70:467-479, 1983).

Diclofenac, a non-steroidal anti-inflammatory drug, is commonly administered to patients suffering from rheumatoid arthritis, osteoarthritis, and ankylosing spondylitis. Following oral administration, diclofenac is rapidly absorbed and then metabolized in the liver by cytochrome P450 isozyme of the CYC2C subfamily (Goodman & Gilman's The Pharmacological Basis of Therapeutics 9^{th} Ed., Hardman et al., eds., p. 637, McGraw Hill, New York, 1996). In addition, diclofenac is used topically to treat pain due to corneal damage (Jayamanne et al., Eye 11(Pt. 1):79-83, 1997; Dornic et al., Am J. Ophthalmol 125(5):719-721, 1998).

Metabolism of diclofenac in kidney tissue produces reactive oxygen species that can cause severe oxidative stress and genomic DNA fragmentation. Examination of diverse types of kidney cells for nuclei with apoptotic characteristics showed that such nuclei are found in the linings of the renal proximal and distal tubules. Additional toxic effects include elevated levels of BUN, malondialdehyde (MDA), SOD, and activated Ca²⁺—Mg²⁺-endonuclease (Hickey et al., Free Radic Biol Med (2001) 31(2):139-152).

Thioacetamide's only significant commercial use is as a replacement for hydrogen sulfide in qualitative analyses (IARC, Vol. 7, 1974). It has also been used as an organic solvent in the leather, textile and paper industries, as an accelerator in the vulcanization of buna rubber, and as a stabilizer of motor fuel. The primary routes of human exposure are inhalation and skin contact with products in which thioacetamide was used as a solvent (9th Report on Carcinogens, U.S. Dept. of Health and Human Services, Public Health Service, National Toxicology Program, http://ehp.niehs.nih.gov/roc/toc9.html).

In exposed rats, thioacetamide was shown to accumulate in the liver and kidney, resulting in elevated levels of serum total bilirubin, aspartate aminotransferase, alanine aminotransferase, BUN, creatinine and TNFα. Impaired clearance of the toxin and increased secretion of TNFα are related to the progression of toxic effects in the liver and kidney (Nakatani et al., Liver (2001) 21(1):64-70). Additional histological changes in kidney tissue include glomerular tuft collapse and interstitial haemorrhage (Caballero et al., Gut (2001) 48(1):34-40).

Amphotericin B is widely used for severe life-threatening fungal infections. Its use is limited by a dose-dependent nephrotoxicity manifested by a reduction in glomerular filtration rate and tubular dysfunction. Elevated creatinine levels associated with amphotericin B are not only a marker for renal dysfunction but are also linked to the use of hemodialysis and a higher mortality rates. Therefore amphotericin B nephrotoxicity is not a benign complication and its prevention is essential (Deray et al. (2002), Nephrologie 23(3):119-122).

Carbon tetrachloride is a common organic solvent largely employed to make chlorofluorocarbon propellants and refrigerants, though this use has been declining steadily. Other uses include: as dry cleaning agent and fire extinguisher, in making nylon, as a solvent for rubber cement, soaps, and insecticides. In a study in rats, carbon tetrachloride has been shown to produce nephrotoxicity. Significant increases in kidney superoxide dismutase and catalase activities and a significant decrease in glutathione peroxidase activity, as well as glomerular and tubular alterations in the renal cortex, have been observed in carbon tetrachloride-treated rats (Ozturk et al. (2003), Urology 62(2):353-356).

Ciprofibrate, a lipid regulating drug that decreases serum triglyceride levels and increases serum HDL cholesterol levels, along with other fibrate drugs, has been reported to induce renal dysfunction. Patients taking these drugs exhibited elevated plasma creatinine and urea levels (Broeders et al. (2000), Nephrol Dial Transplant 15(12):1993-1999).

Cyclosporin A is an immunosuppressant routinely given to organ transplant patients has been shown to cause kidney damage and hypertension. Its nephrotoxicity has been attributed primarily to renal haemodynamic alterations caused by afferent arteriolar vasoconstriction. Its toxic effects are also characterized by pre-glomerular disturbances and interstitial injury that may occur independently of haemodynamic changes. Given the high lipophilic activity of cyclosporin A, direct tubular injury is likely to contribute to nephrotoxicity (Carvalho da Costa et al. (2003) Nephrol Dial Transplant 18(11):2262-2268).

Dantrolene, a muscle relaxant, is used to treat spasticity or muscle spasms associated with conditions such as spinal cord injuries, stroke, multiple sclerosis and cerebral palsy.

Ethylene glycol is a compound used to make antifreeze and de-icing solutions for cars, airplanes, and boats; to make polyester compounds; and as solvents in the paint and plastics industries. Ethylene glycol is also an ingredient in photographic developing solutions, hydraulic brake fluids and in inks used in stamp pads, ballpoint pens, and print shops. Ethylene glycol intoxication produces multisystem organ injury, including acute renal failure and damage to the proximal tubules, via the action of toxic metabolites, in particular glycoaldehyde and glyoxylate. These compounds caused ATP depletion, LDH degradation and release and phospholipid degradation. In addition, the low solubility of ethylene glycol metabolites causes crystal formation within the tubular lumen, contributing to a reduced glomerular filtration rate that in turn leads to renal failure (Poldeski et al. (2001), Am J Kidney Dis 38(2):339-348; Van Vleet et al. (2003), Semin Nephrol 23(5):500-508).

Meloxicam is a non-steroidal anti-inflammatory drug (NSAID) that has hemodynamic (functional) side effects and idiosyncratic side effects on the kidney. The common link in both types of side effects seems to be renal ischemia related to prostaglandin synthesis inhibition. The key enzymes in this processes are the cyclooxygenases COX-1 and COX-2. Although COX-2 inhibition produces the antiinflammatory effect of NSAIDs, COX-1 inhibition produces gastrotoxicity (ulcers and gastrointestinal bleeding) and nephrotoxicity (Fackovcova et al. (2000), Bratisl Lek Listy 101(8):417-422).

Olsalazine, an anti-inflammatory drug, is used to treat ulcerative colitis (inflamed bowel). Studies in the rat have shown the kidney to be the major target organ of toxicity, where interstitial nephritis and tubular necrosis were observed. In longer term and higher dose studies, pelvic dilatation, focal mineral deposition, transitional cell hyperplasia, and congestion and/or haemorrhage and fibrosis were seen (Medsafe Data Sheets, http://www.medsafe.govt.nz/profs/Datasheet/DSForm.asp).

Pentamidine is used in the prevention and treatment of pneumocystis carinii pneumonia (PCP). It is also used as an antiparasitic agent for the treatment of parasites. Pentamidine is typically used when a person has experienced adverse effects or toxicity to other drugs, such as trimethoprim-sulfamethoxazole (TMP-SMX) or dapsone. Renal side-effects are frequently observed after parenteral administration of pentamidine. In studies in rats, nephrotoxicity was assessed by measuring urinary loss of tubular cells, malate dehydrogenase activity and creatinine clearance. The tubular toxicity of pentamidine appears to be dose-related and reversible (Feddersen et al. (1991) J Antimicrob Chemother 28(3):437-446.)

The analgesic drug phenacetin, a NSAID, was taken off the market in the United States in 1983 for causing analgesic-associated nephropathy (AAN) and subsequent end-stage renal disease. A metabolite of phenacetin is acetominophen (Tylenol®) which can also have toxic effects on the kidney. The NSAIDs exert their anti-inflammatory and fever-lowering effects by inhibiting cyclooxygenases (COX-1 and COX-2), enzymes responsible for the production of prostaglandins. Prostaglandins are not key renal blood flow mediators in healthy people with normal kidneys, but in people with a decreased blood volume or circulation problems, the kidney depends on the dilating effect on renal blood vessels of the prostaglandins to maintain renal blood flow, which is critical to maintaining renal function. Because NSAIDs decrease prostaglandin production, people at greatest risk for renal toxicity are those who already have these problems, such as those using diuretics or those suffering from dehydration, heart failure or liver failure. Inhibition of prostaglandin synthesis by NSAIDs is also responsible for electrolyte disturbances such as increased potassium and sodium blood levels and decreased secretion of aldosterone, whose major function is to maintain blood volume when blood pressure drops. Because prostaglandins facilitate sodium excretion, some patients also may experience sodium retention when taking NSAIDs, causing edema and elevated blood pressure and exacerbating the symptoms of heart failure. People at greatest risk are those with diabetes, renal disease, circulatory complications and advanced age (Dilanchian (2002), NurseWeek, http://www.nurseweek.com/ce/ce80a.asp).

Propyleneimine (2-methyl-aziridine) is used as an intermediate in the paper, textile, rubber, and pharmaceutical industries. It is severely irritating to the eyes and upper respiratory tract from acute (short-term) inhalation exposure in humans and is also known to cause necrosis in the renal papillae. Clinical signs of papillary toxicity are decreased urine levels of succinate and citrate elevated levels of creatine (Holmes et al. (1997) Comp Biochem Physiol C Pharmacol Toxicol Endocrinol 116(2):125-134).

Semustine (MeCCNU) is an anti-cancer drug has been shown to produce proximal tubule injury and papillary necrosis in rats. Progressive nephropathy, which was delayed in onset, and characterized by polyuria, enzymuria, accumulations of organic ions and decreased urine concentrating ability was observed. Administration of semustine also lead to karyomegaly in the collecting ducts in the renal medulla (Kramer et al. (1986), Toxicol Appl Pharmacol 82(3):540-550).

Suramin is an anti-parasitic drug and reverse transcriptase inhibitor that is used to treat metastatic cancer. This compound is known to inhibit the binding of growth factors (e.g., epidermal growth factor (EGF), platelet-derived growth factor (PDGF) and tumor growth factor-beta (TGF-beta)) to their receptors and thus antagonize the ability of these factors to stimulate growth of tumor cells in vitro. Experiments in rats have shown that the renal parenchyma is adversely affected by exposure to the drug. Marked and widespread alterations were detected in both cortex and medulla, indicating that suramin induces severe chronic renal damage in rats (Soldani et al. (1992) In Vivo 6(6):617-620).

Tacrolimus is another immunosuppressant routinely given to organ transplant patients. In the kidneys, proximal tubular epithelial cells (PTEC) tend to undergo apoptosis in response to immunosuppressors such as tacrolimus and participate in the onset of several renal diseases. Immunosuppressors probably induce apoptosis through a mechanism that involves the irreversible opening of the mitochondrial permeability transition pore. Activation of caspases 3 and 7 has also been observed. Apoptosis in the proximal tubules may contribute to the renal toxicity that is observed in the course of immunosuppressive therapy.

Toxicity Prediction and Modeling

The genes and gene expression information (including Tox Group Mean, Non-tox Group Mean, LDA score and PLS score for each gene), gene expression profiles, as well as the portfolios and subsets of the genes provided in Tables 1-5N, may be used to predict at least one toxic effect, including the nephrotoxicity of a test or unknown compound. As used, herein, at least one toxic effect includes, but is not limited to, a detrimental change in the physiological status of a cell or organism. The response may be, but is not required to be, associated with a particular pathology, such as tissue necrosis. Accordingly, the toxic effect includes effects at the molecular and cellular level. Nephrotoxicity is an effect as used herein and includes but is not limited to the pathologies of nephritis, tubular toxicity, kidney necrosis, glomerular and tubular injury, and focal segmental glomerulosclerosis. As used herein, a gene expression profile comprises any quantitative representation of the expression of at least one mRNA species in a cell sample or population and includes profiles made by various methods such as differential display, PCR, microarray and other hybridization analysis, etc.

In general, assays to predict the toxicity or nephrotoxicity of a test agent (or compound or multi-component composition) comprise the steps of exposing a cell population to the test compound, assaying or measuring the level of relative or absolute gene expression of one or more of the genes in Tables 1-5N and comparing the identified expression level(s) to the expression levels or other representations of expression levels disclosed in the Tables and database(s) disclosed herein. Such gene expression information includes the Tox Group Mean, Non-tox Group Mean, LDA (linear discriminant analysis) score and PLS (partial least squares) score for the genes listed in Tables 5A-5N. Assays may include the measurement of the expression levels of about 2, 3, 4, 5, 6, 7, 8, 9, 10, 15, 20, 25, 30, 50, 75, 100, 200, 500, 1000 or more genes from Tables 1-5N, or ranges of these numbers, such as about 2-10, about 10-20, about 20-50, about 50-100, about 100-200, about 200-500 or about 500-1000 genes from Tables 1-5N. Assays for toxicity prediction may also include the measurement of nearly all the genes in Tables 1-5N. “Nearly all” the genes may be considered to mean at least 80% of the genes in any one of or all of Tables 1-5N.

In some methods of the invention, the gene expression level for a gene or genes induced by the test agent, compound or compositions may be comparable to the levels found in the Tables or databases disclosed herein if the expression level varies within a factor of about 2, about 1.5 or about 1.0 fold. In some cases, the expression levels are comparable if the agent induces a change in the expression of a gene in the same direction (e.g., up or down) as a reference toxin.

In other methods of the invention, an RMA (robust multi-array average) fold-change value for the gene or genes of a gene expression profile using data from a test compound-exposed sample and from a control vehicle-exposed sample is calculated (see Irizarry et al. (2003), “Summaries of Affymetrix GeneChip probe level data,” Nucl Acids Res 31(4):e15, 8 pp.; and Irizarry et al. (2003), “Exploration, normalization, and summaries of high density oligonucleotide array probe level data,” Biostatistics 4(2): 249-264, both of which are incorporated herein by reference in their entirety). The RMA fold-change value may then be multiplied on a gene-by-gene basis by a PLS weight (or PLS score, see Table 5N) for each gene and these resulting values can be summed across all the genes or across a selected set of genes. This sum creates a single predictive score for the sample. Comparison of this predictive score with a cut-off value, as provided herein, indicates whether or not the test compound has induced at least one toxic response.

The cell population that is exposed to the test agent, compound or composition may be exposed in vitro or in vivo. For instance, cultured or freshly isolated renal cells, in particular rat renal cells, may be exposed to the agent under standard laboratory and cell culture conditions. In another assay format, in vivo exposure may be accomplished by administration of the agent to a living animal, for instance a laboratory rat.

Procedures for designing and conducting toxicity tests in in vitro and in vivo systems are well known, and are described in many texts on the subject, such as Loomis et al., Loomis's Esstentials of Toxicology, 4th Ed., Academic Press, New York, 1996; Echobichon, The Basics of Toxicity Testing, CRC Press, Boca Raton, 1992; Frazier, editor, In Vitro Toxicity Testing, Marcel Dekker, New York, 1992; and the like.

In in vitro toxicity testing, two groups of test organisms are usually employed: One group serves as a control and the other group receives the test compound in a single dose (for acute toxicity tests) or a regimen of doses (for prolonged or chronic toxicity tests). Because, in some cases, the extraction of tissue as called for in the methods of the invention requires sacrificing the test animal, both the control group and the group receiving compound must be large enough to permit removal of animals for sampling tissues, if it is desired to observe the dynamics of gene expression through the duration of an experiment.

In setting up a toxicity study, extensive guidance is provided in the literature for selecting the appropriate test organism for the compound being tested, route of administration, dose ranges, and the like. Water or physiological saline (0.9% NaCl in water) is the solute of choice for the test compound since these solvents permit administration by a variety of routes. When this is not possible because of solubility limitations, vegetable oils such as corn oil or organic solvents such as propylene glycol may be used.

Regardless of the route of administration, the volume required to administer a given dose is limited by the size of the animal that is used. It is desirable to keep the volume of each dose uniform within and between groups of animals. When rats or mice are used, the volume administered by the oral route generally should not exceed about 0.005 ml per gram of animal. Even when aqueous or physiological saline solutions are used for parenteral injection the volumes that are tolerated are limited, although such solutions are ordinarily thought of as being innocuous. The intravenous LD₅₀ of distilled water in the mouse is approximately 0.044 ml per gram and that of isotonic saline is 0.068 ml per gram of mouse. In some instances, the route of administration to the test animal should be the same as, or as similar as possible to, the route of administration of the compound to man for therapeutic purposes.

When a compound is to be administered by inhalation, special techniques for generating test atmospheres are necessary. The methods usually involve aerosolization or nebulization of fluids containing the compound. If the agent to be tested is a fluid that has an appreciable vapor pressure, it may be administered by passing air through the solution under controlled temperature conditions. Under these conditions, dose is estimated from the volume of air inhaled per unit time, the temperature of the solution, and the vapor pressure of the agent involved. Gases are metered from reservoirs. When particles of a solution are to be administered, unless the particle size is less than about 2 μm the particles will not reach the terminal alveolar sacs in the lungs. A variety of apparatuses and chambers are available to perform studies for detecting effects of irritant or other toxic endpoints when they are administered by inhalation. The preferred method of administering an agent to animals is via the oral route, either by intubation or by incorporating the agent in the feed.

When the agent is exposed to cells in vitro or in cell culture, the cell population to be exposed to the agent may be divided into two or more subpopulations, for instance, by dividing the population into two or more identical aliquots. In some preferred embodiments of the methods of the invention, the cells to be exposed to the agent are derived from kidney tissue. For instance, cultured or freshly isolated rat renal cells may be used.

The methods of the invention may be used generally to predict at least one toxic response, and, as described in the Examples, may be used to predict the likelihood that a compound or test agent will induce various specific kidney pathologies, such as nephritis, kidney necrosis, glomerular and tubular injury, focal segmental glomerulosclerosis, or other pathologies associated with at least one of the toxins herein described. The methods of the invention may also be used to determine the similarity of a toxic response to one or more individual compounds. In addition, the methods of the invention may be used to predict or elucidate the potential cellular pathways influenced, induced or modulated by the compound or test agent due to the similarity of the expression profile compared to the profile induced by a known toxin (see Tables 1-5N). In particular, Table 2 provides a description of metabolic pathways in which each listed gene is involved.

Building a Database for Toxicity Prediction—RMA/PLS

In the present invention, a toxicity study or “tox study” comprises a set of cell or tissue samples from rats. These samples are organized into cohorts by test compound, time (time from initial test compound dosage at which the rats were sacrificed), and dose (amount of test compound administered). All cohorts in a tox study share the same vehicle control. For example, a cohort may be a set of samples from rats that were treated with acyclovir for 6 hours at a high dosage (100 mg/kg). A time-matched vehicle cohort is a set of samples that serve as controls for treated animals within a tox study, e.g., for 6-hour acyclovir-treated high dose samples the time-matched vehicle cohort would be the 6-hour vehicle-treated samples with that study.

A toxicity database or “tox database” is a set of tox studies that comprises a reference database. The reference database includes data from rat tissue and cell samples from rats that were treated with different test compounds at different dosages and exposed to the test compounds for varying lengths of time. RMA, or robust multi-array average, is an algorithm that converts raw fluorescence intensities, such as those derived from hybridization of sample nucleic acids to an Affymetrix GeneChip®, into expression values, one value for each gene fragment on a chip (Irizarry et al. (2003), Nucleic Acids Res. 31(4):e15, 8 pp.). RMA produces values on a log2 scale, typically between 4 and 12 for genes that are expressed significantly above or below control levels. These RMA values can be positive or negative and are centered around zero for a fold-change of about 1. PLS, or Partial Least Squares, is a modeling algorithm that takes as inputs a matrix of predictors and a vector of supervised scores to generate a set of prediction weights for each of the input predictors (Nguyen et al. (2002), Bioinformatics 18:39-50). These prediction weights can be converted to PLS scores to indicate the ability of each analyzed gene to predict a toxic response. RMA generates a matrix of gene expression values that can be subjected to PLS to produce a model for prediction of toxic responses, e.g., a model for predicting kidney toxicity.

Although other algorithms for analyzing DNA microarrays are known the art, present inventors have found that the combination of RMA and PLS provides greater accuracy in sample measurements and improved ability to use external data (data from tox studies that have not been added to a tox database). In RMA/PLS models, it was found that external data sets that may be viewed as incompatible according to other algorithms have little impact on the ability of the model to predict a toxic response if these data sets are added to the model. Consequently, an external data set may not require an assessment of compatibility. Additionally, this model allows all sample time points to be used, as all time points for high-dose toxin-treated samples are compared to all time points for non-toxin-treated samples, negative controls, vehicle control and low-dose-treated samples. Further, the model is not affected by the distribution of genes in a sample, and the rates of true positive samples are increased. Using these algorithms, evaluation of the similarity of test compounds is also improved, because a model containing a correlation matrix is generated, rather than separate models for each test compound.

Building a Database for Toxicity Prediction—MAS/LDA

In some embodiments of the present invention, a database for predicting kidney toxicity may be built from gene expression information from DNA microarrays that was generated by using the Affymetrix® MAS4 or MAS5 algorithms. These gene expression values are derived from fluorescence intensity measurements of probe pairs, a perfect match (PM) and a mismatch (MM), after hybridization to a target sequence. The data are converted to a log2 scale and are corrected for background and normalized (see Irizarry et al., Nucl Acids Res, supra). Linear discriminant analysis (LDA) methods may then be applied to identify the genes in a gene expression profile that have the best ability to predict a toxic response. LDA is a classical statistical approach for classifying samples of unknown classes, based on training samples with known classes. LDA has been previously applied to sample classification of microarray data (Hakak et al. (2001), Proc Natl Acad Sci USA 98(8):4746-4751; Dudoit et al. (2002), J Am Statistical Association, 97(457):77-87) and can be used to identify genes that are differentially expressed (up- or down-regulated) in pairwise comparisons. LDA seeks the linear combination of variables that maximizes the ratio of between-group variance and within-group variance by using grouping information. For two groups, the linear weights in LDA depend on how a gene separates in the two groups and how a gene correlates with other genes.

Diagnostic Uses for the Toxicity Markers

As described above, the genes and gene expression information or portfolios of the genes with their expression information as provided in Tables 1-5N may be used as diagnostic markers for the prediction or identification of the physiological state of tissue or cell sample that has been exposed to a compound or to identify or predict the toxic effects of a compound or agent. For instance, a tissue sample, such as kidney tissue, or a sample of peripheral blood cells or some other easily obtainable tissue, may be assayed by any of the methods described above, and the expression levels from a gene or genes from Tables 1-5N may be compared to the expression levels or related data found in tissues or cells exposed to the toxins described herein. These methods may result in the diagnosis of a physiological state in the cell or may be used to identify the potential toxicity of a compound, for instance a new or unknown compound or agent. The comparison of expression data, as well as available sequence or other information may be done by researcher or diagnostician or may be done with the aid of a computer and databases as described below.

In another format, the levels of a gene(s) of Tables 1-5N, its encoded protein(s), or any metabolite produced by the encoded protein may be monitored or detected in a sample, such as a bodily tissue or fluid sample to identify or diagnose a physiological state of an organism. Such samples may include any tissue or fluid sample, including urine, blood and easily obtainable cells such as peripheral lymphocytes.

Use of the Markers for Monitoring Toxicity Progression

As described above, the genes and gene expression information provided in Tables 1-5N may also be used as markers for the monitoring of toxicity progression, such as that found after initial exposure to a drug, drug candidate, toxin, pollutant, etc. For instance, a tissue or cell sample may be assayed by any of the methods described above, and the expression levels from a gene or genes from Tables 1-5N may be compared to the expression levels or related data found in tissue or cells exposed to the renal toxins described herein. The comparison of the expression data, as well as available sequence or other information may be done by a researcher or diagnostician or may be done with the aid of a computer and databases.

Use of the Toxicity Markers for Drug Screening

According to the present invention, the genes identified in Tables 1-5N may be used as markers or drug targets to evaluate the effects of a candidate drug, chemical compound or other agent on a cell or tissue sample. The genes may also be used as drug targets to screen for agents that modulate their expression and/or activity. In various formats, a candidate drug or agent can be screened for the ability to stimulate the transcription or expression of a given marker or markers or to down-regulate or counteract the transcription or expression of a marker or markers. According to the present invention, one can also compare the specificity of a drug's effects by looking at the number of markers which the drug induces and comparing them. More specific drugs will have less transcriptional targets. Similar sets of markers identified for two drugs may indicate a similarity of effects.

Assays to monitor the expression of a marker or markers as defined in Tables 1-5N may utilize any available means of monitoring for changes in the expression level of the nucleic acids of the invention. As used herein, an agent is said to modulate the expression of a nucleic acid of the invention if it is capable of up- or down-regulating expression of the nucleic acid in a cell.

In one assay format, gene chips containing probes to one, two or more genes from Tables 1-5N may be used to directly monitor or detect changes in gene expression in the treated or exposed cell. Cell lines, tissues or other samples are first exposed to a test agent and in some instances, a known toxin, and the detected expression levels of one or more, or preferably 2 or more of the genes of Tables 1-5N are compared to the expression levels or related data of those same genes exposed to a known toxin alone. Compounds that modulate the expression patterns of the known toxin(s) would be expected to modulate potential toxic physiological effects in vivo. The genes in Tables 1-5N are particularly appropriate markers in these assays as they are differentially expressed in cells upon exposure to a known renal toxin. Table 1 discloses those genes that are differentially expressed upon exposure to the named toxins and their corresponding GenBank Accession numbers and Unigene cluster titles. Table 2 indicates the metabolic pathways in which some of the genes in Table 1 function. Table 3 discloses the human homologues of some of the differentially expressed genes in Tables 1 and 2.

In another format, cell lines that contain reporter gene fusions between the open reading frame and/or the transcriptional regulatory regions of a gene in Tables 1-5N and any assayable fusion partner may be prepared. Numerous assayable fusion partners are known and readily available including the firefly luciferase gene and the gene encoding chloramphenicol acetyltransferase (Alam et al. (1990), Anal Biochem 188:245-254). Cell lines containing the reporter gene fusions are then exposed to the agent to be tested under appropriate conditions and time. Differential expression of the reporter gene between samples exposed to the agent and control samples identifies agents which modulate the expression of the nucleic acid.

Additional assay formats may be used to monitor the ability of the agent to modulate the expression of a gene identified in Tables 1-5N. For instance, as described above, mRNA expression may be monitored directly by hybridization of probes to the nucleic acids of the invention. Cell lines are exposed to the agent to be tested under appropriate conditions and time, and total RNA or mRNA is isolated by standard procedures such those disclosed in Sambrook et al. (Molecular Cloning: A Laboratory Manual, 2nd Ed. Cold Spring Harbor Laboratory Press, Cold Spring Harbor, N.Y., 1989).

In another assay format, cells or cell lines are first identified which express the gene products of the invention physiologically. Cells and/or cell lines so identified would be expected to comprise the necessary cellular machinery such that the fidelity of modulation of the transcriptional apparatus is maintained with regard to exogenous contact of agent with appropriate surface transduction mechanisms and/or the cytosolic cascades. Further, such cells or cell lines may be transduced or transfected with an expression vehicle (e.g., a plasmid or viral vector) construct comprising an operable non-translated 5′-promoter containing end of the structural gene encoding the gene products of Tables 1-5N fused to one or more antigenic fragments or other detectable markers, which are peculiar to the instant gene products, wherein said fragments are under the transcriptional control of said promoter and are expressed as polypeptides whose molecular weight can be distinguished from the naturally occurring polypeptides or may further comprise an immunologically distinct or other detectable tag. Such a process is well known in the art (see Sambrook et al., supra).

Cells or cell lines transduced or transfected as outlined above are then contacted with agents under appropriate conditions; for example, the agent comprises a pharmaceutically acceptable excipient and is contacted with cells comprised in an aqueous physiological buffer such as phosphate buffered saline (PBS) at physiological pH, Eagles balanced salt solution (BSS) at physiological pH, PBS or BSS comprising serum or conditioned media comprising PBS or BSS and/or serum incubated at 37° C. Said conditions may be modulated as deemed necessary by one of skill in the art. Subsequent to contacting the cells with the agent, said cells are disrupted and the polypeptides of the lysate are fractionated such that a polypeptide fraction is pooled and contacted with an antibody to be further processed by immunological assay (e.g., ELISA, immunoprecipitation or Western blot). The pool of proteins isolated from the agent-contacted sample is then compared with the control samples (no exposure and exposure to a known toxin) where only the excipient is contacted with the cells and an increase or decrease in the immunologically generated signal from the agent-contacted sample compared to the control is used to distinguish the effectiveness and/or toxic effects of the agent.

Another embodiment of the present invention provides methods for identifying agents that modulate at least one activity of a protein(s) encoded by the genes in Tables 1-5N. Such methods or assays may utilize any means of monitoring or detecting the desired activity.

In one format, the relative amounts of a protein (Tables 1-5N) between a cell population that has been exposed to the agent to be tested compared to an un-exposed control cell population and a cell population exposed to a known toxin may be assayed. In this format, probes such as specific antibodies are used to monitor the differential expression of the protein in the different cell populations. Cell lines or populations are exposed to the agent to be tested under appropriate conditions and time. Cellular lysates may be prepared from the exposed cell line or population and a control, unexposed cell line or population. The cellular lysates are then analyzed with the probe, such as a specific antibody.

Agents that are assayed in the above methods can be randomly selected or rationally selected or designed. As used herein, an agent is said to be randomly selected when the agent is chosen randomly without considering the specific sequences involved in the association of a protein of the invention alone or with its associated substrates, binding partners, etc. An example of randomly selected agents is the use a chemical library or a peptide combinatorial library, or a growth broth of an organism.

As used herein, an agent is said to be rationally selected or designed when the agent is chosen on a nonrandom basis which takes into account the sequence of the target site and/or its conformation in connection with the agent's action. Agents can be rationally selected or rationally designed by utilizing the peptide sequences that make up these sites. For example, a rationally selected peptide agent can be a peptide whose amino acid sequence is identical to or a derivative of any functional consensus site.

The agents of the present invention can be, as examples, peptides, small molecules, vitamin derivatives, as well as carbohydrates. Dominant negative proteins, DNAs encoding these proteins, antibodies to these proteins, peptide fragments of these proteins or mimics of these proteins may be introduced into cells to affect function. “Mimic” used herein refers to the modification of a region or several regions of a peptide molecule to provide a structure chemically different from the parent peptide but topographically and functionally similar to the parent peptide (see G. A. Grant in: Molecular Biology and Biotechnology, Meyers, ed., pp. 659-664, VCH Publishers, New York, 1995). A skilled artisan can readily recognize that there is no limit as to the structural nature of the agents of the present invention.

Nucleic Acid Assay Formats

The genes identified as being differentially expressed upon exposure to a known renal toxin (Tables 1-5N) may be used in a variety of nucleic acid detection assays to detect or quantify the expression level of a gene or multiple genes in a given sample. The genes described in Tables 1-5N may also be used in combination with one or more additional genes whose differential expression is associate with toxicity in a cell or tissue. In preferred embodiments, the genes in Tables 1-5N may be combined with one or more of the genes described in prior and related application Ser. No. 10/301,856, filed Nov. 22, 2002; Ser. No. 10/152,319, filed May 22, 2002; 60/292,335, filed May 22, 2001; 60/297,523, filed Jun. 13, 2001; 60/298,925, filed Jun. 19, 2001; 60/303,810, filed Jul. 10, 2001; 60/303,807, filed Jul. 10, 2001; 60/303,808, filed Jul. 10, 2001; 60/315,047, filed Aug. 28, 2001; 60/324,928, filed Sep. 27, 2001; 60/330,867, filed Nov. 1, 2001; 60/330,462, filed Oct. 22, 2001; 60/331,805, filed Nov. 21, 2001; 60/336,144, filed Dec. 6, 2001; 60/340,873, filed Dec. 19, 2001; 60/357,843, filed Feb. 21, 2002; 60/357,842, filed Feb. 21, 2002; 60/357,844, filed Feb. 21, 2002; 60/364,134; 60/370,206 filed Mar. 15, 2002, filed Apr. 8, 2002; 60/370,247, filed Apr. 8, 2002; 60/370,144, filed Apr. 8, 2002; 60/371,679, filed Apr. 12, 2002; and 60/372,794, filed Apr. 17, 2002, all of which are incorporated by reference on page 1 of this application.

Any assay format to detect gene expression may be used. For example, traditional Northern blotting, dot or slot blot, nuclease protection, primer directed amplification, RT-PCR, semi- or quantitative PCR, branched-chain DNA and differential display methods may be used for detecting gene expression levels. Those methods are useful for some embodiments of the invention. In cases where smaller numbers of genes are detected, amplification based assays may be most efficient. Methods and assays of the invention, however, may be most efficiently designed with hybridization-based methods for detecting the expression of a large number of genes.

Any hybridization assay format may be used, including solution-based and solid support-based assay formats. Solid supports containing oligonucleotide probes for differentially expressed genes of the invention can be filters, polyvinyl chloride dishes, particles, beads, microparticles or silicon or glass based chips, etc. Such chips, wafers and hybridization methods are widely available, for example, those disclosed by Beattie (WO 95/11755).

Any solid surface to which oligonucleotides can be bound, either directly or indirectly, either covalently or non-covalently, can be used. A preferred solid support is a high density array or DNA chip. These contain a particular oligonucleotide probe in a predetermined location on the array. Each predetermined location may contain more than one molecule of the probe, but each molecule within the predetermined location has an identical sequence. Such predetermined locations are termed features. There may be, for example, from 2, 10, 100, 1000 to 10,000, 100,000 or 400,000 or more of such features on a single solid support. The solid support, or the area within which the probes are attached may be on the order of about a square centimeter. Probes corresponding to the genes of Tables 1-5N or from the related applications described above may be attached to single or multiple solid support structures, e.g., the probes may be attached to a single chip or to multiple chips to comprise a chip set.

Oligonucleotide probe arrays for expression monitoring can be made and used according to any techniques known in the art (see for example, Lockhart et al. (1996), Nat Biotechnol 14:1675-1680; McGall et al. (1996), Proc Nat Acad Sci USA 93: 13555-13460). Such probe arrays may contain at least two or more oligonucleotides that are complementary to or hybridize to two or more of the genes described in Tables 1-5N. For instance, such arrays may contain oligonucleotides that are complementary to or hybridize to at least 2, 3, 4, 5, 6, 7, 8, 9, 10, 20, 30, 50, 70, 100 or more of the genes described herein. Preferred arrays contain all or nearly all of the genes listed in Tables 1-5N, or individually, the gene sets of Tables 5A-5N. In a preferred embodiment, arrays are constructed that contain oligonucleotides to detect all or nearly all of the genes in any one of or all of Tables 1-5N on a single solid support substrate, such as a chip.

The sequences of the expression marker genes of Tables 1-5N are in the public databases. Table 1 provides the GenBank Accession Number or NCBI RefSeq ID for each of the sequences (see www.ncbi.nlm.nih.gov/), as well as the title for the cluster of which gene is part. Table 2 lists the metabolic pathways in which each listed gene functions, while Table 3 provides the gene names and cluster titles for the human homologues of the genes described in Tables 1 and 2. The sequences of the genes in GenBank and/or RefSeq are expressly herein incorporated by reference in their entirety as of the filing date of this application, as are related sequences, for instance, sequences from the same gene of different lengths, variant sequences, polymorphic sequences, genomic sequences of the genes and related sequences from different species, including the human counterparts, where appropriate. These sequences may be used in the methods of the invention or may be used to produce the probes and arrays of the invention. In some embodiments, the genes in Tables 1-5N that correspond to the genes or fragments previously associated with a toxic response may be excluded from the Tables. Table 4 provides the key to the model codes used in Tables 3 and 5A-5L, where each model represents a toxin treatment or a set of pathological effects (disease state) resulting from a toxin treatment. In Tables 5A-5N, the genes that are differentially expressed, i.e., up- or down-regulated, in response to a toxin treatment or in a particular disease state are listed. The expression levels of these genes in samples in which a toxic response was found and in samples in which a toxic response was not found are also indicated.

As described above, in addition to the sequences of the GenBank Accession Numbers or NCBI Refeq ID's disclosed in the Tables 1-5N, sequences such as naturally occurring variants or polymorphic sequences may be used in the methods and compositions of the invention. For instance, expression levels of various allelic or homologous forms of a gene disclosed in Tables 1-5N may be assayed, including homologs from species other than rat. Any and all nucleotide variations that do not alter the functional activity of a gene listed in the Tables 1-5N, including all naturally occurring allelic variants of the genes herein disclosed, may be used in the methods and to make the compositions (e.g., arrays) of the invention.

Probes based on the sequences of the genes described above may be prepared by any commonly available method. Oligonucleotide probes for screening or assaying a tissue or cell sample are preferably of sufficient length to specifically hybridize only to appropriate, complementary genes or transcripts. Typically the oligonucleotide probes will be at least about 10, 12, 14, 16, 18, 20 or 25 nucleotides in length. In some cases, longer probes of at least about 30, 40, or 50 nucleotides will be desirable.

As used herein, oligonucleotide sequences that are complementary to one or more of the genes described in Tables 1-5N refer to oligonucleotides that are capable of hybridizing under stringent conditions to at least part of the nucleotide sequences of said genes. Such hybridizable oligonucleotides will typically exhibit at least about 75% sequence identity at the nucleotide level to said genes, preferably about 80% or 85% sequence identity or more preferably about 90% or 95% or more sequence identity to said genes.

“Bind(s) substantially” refers to complementary hybridization between a probe nucleic acid and a target nucleic acid and embraces minor mismatches that can be accommodated by reducing the stringency of the hybridization media to achieve the desired detection of the target polynucleotide sequence.

The terms “background” or “background signal intensity” refer to hybridization signals resulting from non-specific binding, or other interactions, between the labeled target nucleic acids and components of the oligonucleotide array (e.g., the oligonucleotide probes, control probes, the array substrate, etc.). Background signals may also be produced by intrinsic fluorescence of the array components themselves. A single background signal can be calculated for the entire array, or a different background signal may be calculated for each target nucleic acid. In a preferred embodiment, background is calculated as the average hybridization signal intensity for the lowest 5% to 10% of the probes in the array, or, where a different background signal is calculated for each target gene, for the lowest 5% to 10% of the probes for each gene. Of course, one of skill in the art will appreciate that where the probes to a particular gene hybridize well and thus appear to be specifically binding to a target sequence, they should not be used in a background signal calculation. Alternatively, background may be calculated as the average hybridization signal intensity produced by hybridization to probes that are not complementary to any sequence found in the sample (e.g. probes directed to nucleic acids of the opposite sense or to genes not found in the sample such as bacterial genes where the sample is mammalian nucleic acids). Background can also be calculated as the average signal intensity produced by regions of the array that lack any probes at all.

The phrase “hybridizing specifically to” or “specifically hybridizes” refers to the binding, duplexing, or hybridizing of a molecule substantially to or only to a particular nucleotide sequence or sequences under stringent conditions when that sequence is present in a complex mixture (e.g., total cellular) DNA or RNA.

Assays and methods of the invention may utilize available formats to simultaneously screen at least about 100, preferably about 1000, more preferably about 10,000 and most preferably about 1,000,000 different nucleic acid hybridizations.

As used herein a “probe” is defined as a nucleic acid, capable of binding to a target nucleic acid of complementary sequence through one or more types of chemical bonds, usually through complementary base pairing, usually through hydrogen bond formation. As used herein, a probe may include natural (i.e., A, G, U, C, or T) or modified bases (7-deazaguanosine, inosine, etc.). In addition, the bases in probes may be joined by a linkage other than a phosphodiester bond, so long as it does not interfere with hybridization. Thus, probes may be peptide nucleic acids in which the constituent bases are joined by peptide bonds rather than phosphodiester linkages.

The term “perfect match probe” refers to a probe that has a sequence that is perfectly complementary to a particular target sequence. The test probe is typically perfectly complementary to a portion (subsequence) of the target sequence. The perfect match (PM) probe can be a “test probe”, a “normalization control” probe, an expression level control probe and the like. A perfect match control or perfect match probe is, however, distinguished from a “mismatch control” or “mismatch probe.”

The terms “mismatch control” or “mismatch probe” refer to a probe whose sequence is deliberately selected not to be perfectly complementary to a particular target sequence. For each mismatch (MM) control in a high-density array there typically exists a corresponding perfect match (PM) probe that is perfectly complementary to the same particular target sequence. The mismatch may comprise one or more bases.

While the mismatch(es) may be located anywhere in the mismatch probe, terminal mismatches are less desirable as a terminal mismatch is less likely to prevent hybridization of the target sequence. In a particularly preferred embodiment, the mismatch is located at or near the center of the probe such that the mismatch is most likely to destabilize the duplex with the target sequence under the test hybridization conditions.

The term “stringent conditions” refers to conditions under which a probe will hybridize to its target subsequence, but with only insubstantial hybridization to other sequences or to other sequences such that the difference may be identified. Stringent conditions are sequence-dependent and will be different in different circumstances. Longer sequences hybridize specifically at higher temperatures. Generally, stringent conditions are selected to be about 5° C. lower than the thermal melting point (Tm) for the specific sequence at a defined ionic strength and pH.

Typically, stringent conditions will be those in which the salt concentration is at least about 0.01 to 1.0 M Na⁺ ion concentration (or other salts) at pH 7.0 to 8.3 and the temperature is at least about 30° C. for short probes (e.g., 10 to 50 nucleotides). Stringent conditions may also be achieved with the addition of destabilizing agents such as formamide.

The “percentage of sequence identity” or “sequence identity” is determined by comparing two optimally aligned sequences or subsequences over a comparison window or span, wherein the portion of the polynucleotide sequence in the comparison window may optionally comprise additions or deletions (i.e., gaps) as compared to the reference sequence (which does not comprise additions or deletions) for optimal alignment of the two sequences. The percentage is calculated by determining the number of positions at which the identical submit (e.g. nucleic acid base or amino acid residue) occurs in both sequences to yield the number of matched positions, dividing the number of matched positions by the total number of positions in the window of comparison and multiplying the result by 100 to yield the percentage of sequence identity. Percentage sequence identity when calculated using the programs GAP or BESTFIT (see below) is calculated using default gap weights.

Probe Design

One of skill in the art will appreciate that an enormous number of array designs are suitable for the practice of this invention. The high density array will typically include a number of test probes that specifically hybridize to the sequences of interest. Probes may be produced from any region of the genes identified in the Tables and the attached representative sequence listing. In instances where the gene reference in the Tables is an EST, probes may be designed from that sequence or from other regions of the corresponding full-length transcript that may be available in any of the sequence databases, such as those herein described. See WO 99/32660 for methods of producing probes for a given gene or genes. In addition, any available software may be used to produce specific probe sequences, including, for instance, software available from Molecular Biology Insights, Olympus Optical Co. and Biosoft International. In a preferred embodiment, the array will also include one or more control probes.

High density array chips of the invention include “test probes.” Test probes may be oligonucleotides that range from about 5 to about 500, or about 7 to about 50 nucleotides, more preferably from about 10 to about 40 nucleotides and most preferably from about 15 to about 35 nucleotides in length. In other particularly preferred embodiments, the probes are 20 or 25 nucleotides in length. In another preferred embodiment, test probes are double or single strand DNA sequences such as cDNA fragments. DNA sequences are isolated or cloned from natural sources or amplified from natural sources using native nucleic acid as templates. These probes have sequences complementary to particular subsequences of the genes whose expression they are designed to detect. Thus, the test probes are capable of specifically hybridizing to the target nucleic acid they are to detect.

In addition to test probes that bind the target nucleic acid(s) of interest, the high density array can contain a number of control probes. The control probes may fall into three categories referred to herein as 1) normalization controls; 2) expression level controls; and 3) mismatch controls.

Normalization controls are oligonucleotide or other nucleic acid probes that are complementary to labeled reference oligonucleotides or other nucleic acid sequences that are added to the nucleic acid sample to be screened. The signals obtained from the normalization controls after hybridization provide a control for variations in hybridization conditions, label intensity, “reading” efficiency and other factors that may cause the signal of a perfect hybridization to vary between arrays. In a preferred embodiment, signals (e.g., fluorescence intensity) read from all other probes in the array are divided by the signal (e.g., fluorescence intensity) from the control probes thereby normalizing the measurements.

Virtually any probe may serve as a normalization control. However, it is recognized that hybridization efficiency varies with base composition and probe length. Preferred normalization probes are selected to reflect the average length of the other probes present in the array, however, they can be selected to cover a range of lengths. The normalization control(s) can also be selected to reflect the (average) base composition of the other probes in the array, however in a preferred embodiment, only one or a few probes are used and they are selected such that they hybridize well (i.e., no secondary structure) and do not match any target-specific probes.

Expression level controls are probes that hybridize specifically with constitutively expressed genes in the biological sample. Virtually any constitutively expressed gene provides a suitable target for expression level controls. Typically expression level control probes have sequences complementary to subsequences of constitutively expressed “housekeeping genes” including, but not limited to the actin gene, the transferrin receptor gene, the GAPDH gene, and the like.

Mismatch controls may also be provided for the probes to the target genes, for expression level controls or for normalization controls. Mismatch controls are oligonucleotide probes or other nucleic acid probes identical to their corresponding test or control probes except for the presence of one or more mismatched bases. A mismatched base is a base selected so that it is not complementary to the corresponding base in the target sequence to which the probe would otherwise specifically hybridize. One or more mismatches are selected such that under appropriate hybridization conditions (e.g., stringent conditions) the test or control probe would be expected to hybridize with its target sequence, but the mismatch probe would not hybridize (or would hybridize to a significantly lesser extent). Preferred mismatch probes contain a central mismatch. Thus, for example, where a probe is a 20 mer, a corresponding mismatch probe will have the identical sequence except for a single base mismatch (e.g., substituting a G, a C or a T for an A) at any of positions 6 through 14 (the central mismatch).

Mismatch probes thus provide a control for non-specific binding or cross hybridization to a nucleic acid in the sample other than the target to which the probe is directed. For example, if the target is present the perfect match probes should be consistently brighter than the mismatch probes. In addition, if all central mismatches are present, the mismatch probes can be used to detect a mutation, for instance, a mutation of a gene in the accompanying Tables 1-5N. The difference in intensity between the perfect match and the mismatch probe provides a good measure of the concentration of the hybridized material.

Nucleic Acid Samples

Cell or tissue samples may be exposed to the test agent in vitro or in vivo. When cultured cells or tissues are used, appropriate mammalian cell extracts, such as liver extracts, may also be added with the test agent to evaluate agents that may require biotransformation to exhibit toxicity. In a preferred format, primary isolates or cultured cell lines of animal or human renal cells may be used.

The genes which are assayed according to the present invention are typically in the form of mRNA or reverse transcribed mRNA. The genes may or may not be cloned. The genes may or may not be amplified. The cloning and/or amplification do not appear to bias the representation of genes within a population. In some assays, it may be preferable, however, to use polyA+ RNA as a source, as it can be used with less processing steps.

As is apparent to one of ordinary skill in the art, nucleic acid samples used in the methods and assays of the invention may be prepared by any available method or process. Methods of isolating total mRNA are well known to those of skill in the art. For example, methods of isolation and purification of nucleic acids are described in detail in Chapter 3 of Laboratory Techniques in Biochemistry and Molecular Biology Vol. 24, Hybridization With Nucleic Acid Probes: Theory and Nucleic Acid Probes, P. Tijssen, Ed., Elsevier Press, New York, 1993. Such samples include RNA samples, but also include cDNA synthesized from a mRNA sample isolated from a cell or tissue of interest. Such samples also include DNA amplified from the cDNA, and RNA transcribed from the amplified DNA. One of skill in the art would appreciate that it is desirable to inhibit or destroy RNase present in homogenates before homogenates are used.

Biological samples may be of any biological tissue or fluid or cells from any organism as well as cells raised in vitro, such as cell lines and tissue culture cells. Frequently the sample will be a tissue or cell sample that has been exposed to a compound, agent, drug, pharmaceutical composition, potential environmental pollutant or other composition. In some formats, the sample will be a “clinical sample” which is a sample derived from a patient. Typical clinical samples include, but are not limited to, sputum, blood, blood-cells (e.g., white cells), tissue or fine needle biopsy samples, urine, peritoneal fluid, and pleural fluid, or cells therefrom. Biological samples may also include sections of tissues, such as frozen sections or formalin fixed sections taken for histological purposes.

Forming High Density Arrays

Methods of forming high density arrays of oligonucleotides with a minimal number of synthetic steps are known. The oligonucleotide analogue array can be synthesized on a single or on multiple solid substrates by a variety of methods, including, but not limited to, light-directed chemical coupling, and mechanically directed coupling (see Pirrung, U.S. Pat. No. 5,143,854).

In brief, the light-directed combinatorial synthesis of oligonucleotide arrays on a glass surface proceeds using automated phosphoramidite chemistry and chip masking techniques. In one specific implementation, a glass surface is derivatized with a silane reagent containing a functional group, e.g., a hydroxyl or amine group blocked by a photolabile protecting group. Photolysis through a photolithographic mask is used selectively to expose functional groups which are then ready to react with incoming 5′ photoprotected nucleoside phosphoramidites. The phosphoramidites react only with those sites which are illuminated (and thus exposed by removal of the photolabile blocking group). Thus, the phosphoramidites only add to those areas selectively exposed from the preceding step. These steps are repeated until the desired array of sequences have been synthesized on the solid surface. Combinatorial synthesis of different oligonucleotide analogues at different locations on the array is determined by the pattern of illumination during synthesis and the order of addition of coupling reagents.

In addition to the foregoing, additional methods which can be used to generate an array of oligonucleotides on a single substrate are described in PCT Publication Nos. WO 93/09668 and WO 01/23614. High density nucleic acid arrays can also be fabricated by depositing pre-made or natural nucleic acids in predetermined positions. Synthesized or natural nucleic acids are deposited on specific locations of a substrate by light directed targeting and oligonucleotide directed targeting. Another embodiment uses a dispenser that moves from region to region to deposit nucleic acids in specific spots.

Hybridization

Nucleic acid hybridization simply involves contacting a probe and target nucleic acid under conditions where the probe and its complementary target can form stable hybrid duplexes through complementary base pairing. See WO 99/32660. The nucleic acids that do not form hybrid duplexes are then washed away leaving the hybridized nucleic acids to be detected, typically through detection of an attached detectable label. It is generally recognized that nucleic acids are denatured by increasing the temperature or decreasing the salt concentration of the buffer containing the nucleic acids. Under low stringency conditions (e.g., low temperature and/or high salt) hybrid duplexes (e.g., DNA:DNA, RNA:RNA, or RNA:DNA) will form even where the annealed sequences are not perfectly complementary. Thus, specificity of hybridization is reduced at lower stringency. Conversely, at higher stringency (e.g., higher temperature or lower salt) successful hybridization tolerates fewer mismatches. One of skill in the art will appreciate that hybridization conditions may be selected to provide any degree of stringency.

In a preferred embodiment, hybridization is performed at low stringency, in this case in 6×SSPET at 37° C. (0.005% Triton X-100), to ensure hybridization and then subsequent washes are performed at higher stringency (e.g., 1×SSPET at 37° C.) to eliminate mismatched hybrid duplexes. Successive washes may be performed at increasingly higher stringency (e.g., down to as low as 0.25×SSPET at 37° C. to 50° C.) until a desired level of hybridization specificity is obtained. Stringency can also be increased by addition of agents such as formamide. Hybridization specificity may be evaluated by comparison of hybridization to the test probes with hybridization to the various controls that can be present (e.g., expression level control, normalization control, mismatch controls, etc.).

In general, there is a tradeoff between hybridization specificity (stringency) and signal intensity. Thus, in a preferred embodiment, the wash is performed at the highest stringency that produces consistent results and that provides a signal intensity greater than approximately 10% of the background intensity. Thus, in a preferred embodiment, the hybridized array may be washed at successively higher stringency solutions and read between each wash. Analysis of the data sets thus produced will reveal a wash stringency above which the hybridization pattern is not appreciably altered and which provides adequate signal for the particular oligonucleotide probes of interest.

Signal Detection

The hybridized nucleic acids are typically detected by detecting one or more labels attached to the sample nucleic acids. The labels may be incorporated by any of a number of means well known to those of skill in the art. See WO 99/32660.

Databases

The present invention includes relational databases containing sequence information, for instance, for the genes of Tables 1-5N, as well as gene expression or related information from tissue or cells exposed to various standard toxins, such as those herein described (see Tables 5A-5N). Databases may also contain information associated with a given sequence or tissue sample such as descriptive information about the gene associated with the sequence information (see Tables 1 and 2), or descriptive information concerning the clinical status of the tissue sample, or the animal from which the sample was derived. The database may be designed to include different parts, for instance a sequence database and a gene expression database. Methods for the configuration and construction of such databases and computer-readable media to which such databases are saved are widely available, for instance, see U.S. Publication No. 2003-0171876 (Ser. No. 10/090,144), filed Mar. 5, 2002, PCT Publication No. WO 02/095659, published Nov. 23, 2002, and U.S. Pat. No. 5,953,727, which are herein incorporated by reference in their entirety. In a preferred embodiment, the database is ToxExpress® marketed by Gene Logic, Inc., Gaithersburg, Md.

The databases of the invention may be linked to an outside or external database such as GenBank (www.ncbi.nlm.nih.gov/entrez.index.html); KEGG (www.genome.ad.jp/kegg); SPAD (www.grt.kyushu-u.ac.jp/spad/index.html); HUGO (www.gene.ucl.ac.uk/hugo); Swiss-Prot (www.expasy.ch.sprot); Prosite (www.expasy.ch/tools/scnpsit1.html); OMIM (www.ncbi.nlm.nih.gov/omim); and GDB (www.gdb.org). In a preferred embodiment, as described in Tables 1-5N, the external database is GenBank and the associated databases maintained by the National Center for Biotechnology Information (NCBI) (www.ncbi.nlm.nih.gov).

Any appropriate computer platform, user interface, etc. may be used to perform the necessary comparisons between sequence information, gene expression information and any other information in the database or information provided as an input. For example, a large number of computer workstations are available from a variety of manufacturers. Client/server environments, database servers and networks are also widely available and appropriate platforms for the databases of the invention.

The databases of the invention may be used to produce, among other things, electronic Northerns (E-NORTHERN™, Gene Logic, Inc., Gaithersburg, Md.) that allow the user to determine the cell type or tissue in which a given gene is expressed and to allow determination of the abundance or expression level of a given gene in a particular tissue or cell.

The databases of the invention may also be used to present information identifying the expression level in a tissue or cell of a set of genes comprising one or more of the genes in Tables 1-5N, comprising the step of comparing the expression level of at least one gene in Tables 1-5N in a cell or tissue exposed to a test agent to the level of expression of the gene in the database. In one embodiment, such methods may be used to predict the toxic potential of a given compound by comparing the level of expression of a gene or genes in Tables 1-5N from a tissue or cell sample exposed to the test agent to the expression levels found in a control tissue or cell samples exposed to a standard toxin or renal toxin such as those herein described. Such methods may also be used in the drug or agent screening assays as described herein.

Kits

The invention further includes kits combining, in different combinations, high-density oligonucleotide arrays, reagents for use with the arrays, protein reagents encoded by the genes of the Tables, signal detection and array-processing instruments, gene expression databases and analysis and database management software described above. The kits may be used, for example, to predict or model the toxic response of a test compound, to monitor the progression of renal disease states, to identify genes that show promise as new drug targets and to screen known and newly designed drugs as discussed above.

The databases packaged with the kits are a compilation of expression patterns from human or laboratory animal genes and gene fragments (corresponding to the genes of Tables 1-5N). In particular, the database software and packaged information that may contain the databases saved to a computer-readable medium include the expression results of Tables 1-5N that can be used to predict toxicity of a test agent by comparing the expression levels of the genes of Tables 1-5N induced by the test agent to the expression levels presented in Tables 5A-5N. In another format, database and software information may be provided in a remote electronic format, such as a website, the address of which may be packaged in the kit.

The kits may used in the pharmaceutical industry, where the need for early drug testing is strong due to the high costs associated with drug development, but where bioinformatics, in particular gene expression informatics, is still lacking. These kits will reduce the costs, time and risks associated with traditional new drug screening using cell cultures and laboratory animals. The results of large-scale drug screening of pre-grouped patient populations, pharmacogenomics testing, can also be applied to select drugs with greater efficacy and fewer side-effects. The kits may also be used by smaller biotechnology companies and research institutes who do not have the facilities for performing such large-scale testing themselves.

Databases and software designed for use with microarrays are discussed in Balaban et al., U.S. Pat. No. 6,229,911, a computer-implemented method for managing information, stored as indexed Tables 1-5N, collected from small or large numbers of microarrays, and U.S. Pat. No. 6,185,561, a computer-based method with data mining capability for collecting gene expression level data, adding additional attributes and reformatting the data to produce answers to various queries. Chee et al., U.S. Pat. No. 5,974,164, disclose a software-based method for identifying mutations in a nucleic acid sequence based on differences in probe fluorescence intensities between wild type and mutant sequences that hybridize to reference sequences.

Without further description, it is believed that one of ordinary skill in the art can, using the preceding description and the following illustrative examples, make and utilize the compounds of the present invention and practice the claimed methods. The following working examples therefore, specifically point out the preferred embodiments of the present invention, and are not to be construed as limiting in any way the remainder of the disclosure.

### EXAMPLES

### Example 1

### Identification of Toxicity Markers Using Linear Discriminant Analysis (LDA)

The renal toxins indomethacin, diflunisal, colchicine, chloroform, diclofenac, menadione, sodium chromate, sodium oxalate, thioacetamide, vancomycin, acyclovir, adriamycin, AY-25329, bromoethylamine HBr (BEA), carboplatin, carbon tetrachloride, cephalosporine, cidofovir, cisplatin, citrinin, cyclophosphamide, cyclosporine, gentamicin, hexachloro-1,3-butadiene, hydralazine, ifosfamide, lithium chloride, mercuric chloride, pamindronate, puromycin aminonucleoside (PAN), semustine and sulfadiazine were administered to male Sprague-Dawley rats at various timepoints using administration diluents, protocols and dosing regimes as previously described in the art and previously described in the priority applications discussed above. As negative controls, the compounds ceftazidime, streptomycin, transplatin captopril, phenobarbital, tamoxifen and temozolomide were used. In experiments using toxins A-G, as labeled in Table 4, blood and tissue samples were collected at the following time-points: chloroform (A), thioacetamide (F) and vancomycin (G)—after 6, 24 and 48 hours of exposure; diclofenac (B) and menadione (C)—after 3, 6 and 24 hours of exposure; and sodium chromate (D) and sodium oxalate (E)—after 6, 24 and 72 hours of exposure. For these compounds, no significant changes in the levels of gene expression were found with varying exposure time, i.e., short and long time-points showed the same pattern of differential gene expression. The low and high dose level for each compound are provided in the chart below.

| | Low Dose | | Method of |
|---|---|---|---|
| Renal Toxin | (mg/kg) | High Dose (mg/kg) | Administration |
| indomethacin | 1 | 10 | oral gavage |
| diflunisal | 2 | 400 | oral gavage |
| colchicine | 0.15 | 1.5 | intraperitoneal |
| chloroform | 11.95 | 239 | oral gavage |
| diclofenac | 1 | 200 | intraperitoneal |
| menadione | 15 | 150 | intravenous |
| sodium chromate | 3 | 30 | intraperitoneal |
| sodium oxalate | 10 | 100 | intraperitoneal |
| thioacetamide | 30 | 300 | intraperitoneal |
| vancomycin | 50 | 500 | intravenous |

For the remaining compounds, the doses and methods of administration used were as follows:

| | Low Dose | | High Dose | | Method of |
|---|---|---|---|---|---|
| Renal Toxin | (mg/kg) | | (mg/kg) | | Administration |
| cephaloridine | 100 | | 800 | | intravenous |
| cisplatin | 1 | | 5 | | intravenous |
| PAN | 10 | | 150 | | intravenous |
| BEA | 10 | | 200 | | intraperitoneal |
| gentamicin | 2 | | 80 | | intramuscular |
| ifosfamide | 5 | | 100 | | intraperitoneal |
| cyclophosphamide | 20 | | 2000 | | intraperitoneal |
| carboplatin | 5 | | 50 | | intravenous |
| AY-25329 | 25 | | 250 | | oral gavage |
| indomethacin | 1 | | 10 | | oral gavage |
| acyclovir | 10 | | 100 | | intraperitoneal |
| citrinin | 1 | | 35 | | intraperitoneal |
| mercuric chloride | 0.1 | | 1 | | intravenous |
| diflunisal | 2 | | 400 | | oral gavage |
| cidofovir | 10 | | 100 | | intraperitoneal |
| pamidronate | 1 | | 60 | | intraperitoneal |
| lithium | 0.3 | (nmol/kg) | 3 | (nmol/ | intraperitoneal |
| | | | | kg) | |
| hydralazine | 2.5 | | 25 | | intraperitoneal |
| colchicine | 0.15 | | 1.5 | | intraperitoneal |
| sulfadiazine | 100 | | 1000 | | intravenous |
| adriamycin | 1.3 | | 12.8 | | intravenous |

Animals were sacrificed and samples collected at the time points previously described in the priority applications discussed above.

After administration, the dosed animals were observed and tissues were collected as described below:

Observation of Animals

1. Clinical cage side observations—twice daily mortality and moribundity check. Skin and fur, eyes and mucous membrane, respiratory system, circulatory system, autonomic and central nervous system, somatomotor pattern, and behavior pattern were checked. Potential signs of toxicity, including tremors, convulsions, salivation, diarrhea, lethargy, coma or other atypical behavior or appearance, were recorded as they occurred and included a time of onset, degree, and duration.

2. Physical Examinations—Prior to randomization, prior to initial treatment, and prior to sacrifice.

3. Body Weights—Prior to randomization, prior to initial treatment, and prior to sacrifice.

Clinical Pathology

1. Frequency—Prior to necropsy.

2. Number of animals—All surviving animals.

3. Bleeding Procedure—Blood was obtained by puncture of the orbital sinus while under 70% CO₂/30% O₂ anesthesia.

Collection of Blood Samples—Approximately 0.5 mL of blood was collected into EDTA tubes for evaluation of hematology parameters. Approximately 1 mL of blood was collected into serum separator tubes for clinical chemistry analysis. Approximately 200 uL of plasma was obtained and frozen at ˜80° C. for test compound/metabolite estimation. An additional ˜2 mL of blood was collected into a 15 mL conical polypropylene vial to which ˜3 mL of Trizol was immediately added. The contents were immediately mixed with a vortex and by repeated inversion. The tubes were frozen in liquid nitrogen and stored at ˜80° C.

Termination Procedures

Terminal Sacrifice

Approximately 3, 6, 24, 48, 72, 120, 144, 168, 336, and/or 360 hours after the initial dose, rats were weighed, physically examined, sacrificed by decapitation, and exsanguinated. The animals were necropsied within approximately five minutes of sacrifice. Separate sterile, disposable instruments were used for each animal, with the exception of bone cutters, which were used to open the skull cap. The bone cutters were dipped in disinfectant solution between animals.

Necropsies were conducted on each animal following procedures approved by board-certified pathologists.

Animals not surviving until terminal sacrifice were discarded without necropsy (following euthanasia by carbon dioxide asphyxiation, if moribund). The approximate time of death for moribund or found dead animals was recorded.

Postmortem Procedures

Fresh and sterile disposable instruments were used to collect tissues. Gloves were worn at all times when handling tissues or vials. All tissues were collected and frozen within approximately 5 minutes of the animal's death. The liver sections and kidneys were frozen within approximately 3-5 minutes of the animal's death. The time of euthanasia, an interim time point at freezing of liver sections and kidneys, and time at completion of necropsy were recorded. Tissues were stored at approximately −80° C. or preserved in 10% neutral buffered formalin.

Tissue Collection and Processing

Liver

1. Right medial lobe—snap frozen in liquid nitrogen and stored at ˜−80° C.

2. Left medial lobe—Preserved in 10% neutral-buffered formalin (NBF) and evaluated for gross and microscopic pathology.

3. Left lateral lobe—snap frozen in liquid nitrogen and stored at ˜−80° C.

Heart-A sagittal cross-section containing portions of the two atria and of the two ventricles was preserved in 10% NBF. The remaining heart was frozen in liquid nitrogen and stored at ˜−80° C.

Kidneys (Both)

1. Left—Hemi-dissected; half was preserved in 10% NBF and the remaining half was frozen in liquid nitrogen and stored at ˜−80° C.

2. Right—Hemi-dissected; half was preserved in 10% NBF and the remaining half was frozen in liquid nitrogen and stored at ˜−80° C.

Testes (both)—A sagittal cross-section of each testis was preserved in 10% NBF. The remaining testes were frozen together in liquid nitrogen and stored at ˜−80° C.

Brain (whole)—A cross-section of the cerebral hemispheres and of the diencephalon was preserved in 10% NBF, and the rest of the brain was frozen in liquid nitrogen and stored at ˜−80° C.

Microarray sample preparation was conducted with minor modifications, following the protocols set forth in the Affymetrix GeneChip® Expression Technical Analysis Manual (Affymetrix, Inc. Santa Clara, Calif.). Frozen tissue was ground to a powder using a Spex Certiprep 6800 Freezer Mill. Total RNA was extracted with Trizol (Invitrogen, Carlsbad Calif.) utilizing the manufacturer's protocol. The total RNA yield for each sample was 200-500 μg per 300 mg tissue weight. mRNA was isolated using the Oligotex mRNA Midi kit (Qiagen) followed by ethanol precipitation. Double stranded cDNA was generated from mRNA using the SuperScript Choice system (Invitrogen, Carlsbad Calif.). First strand cDNA synthesis was primed with a T7-(dT24) oligonucleotide. The cDNA was phenol-chloroform extracted and ethanol precipitated to a final concentration of 1 μg/ml. From 2 μg of cDNA, cRNA was synthesized using Ambion's T7 MegaScript in vitro Transcription Kit.

To biotin label the cRNA, nucleotides Bio-11-CTP and Bio-16-UTP (Enzo Diagnostics) were added to the reaction. Following a 37° C. incubation for six hours, impurities were removed from the labeled cRNA following the RNeasy Mini kit protocol (Qiagen). cRNA was fragmented (fragmentation buffer consisting of 200 mM Tris-acetate, pH 8.1, 500 mM KOAc, 150 mM MgOAc) for thirty-five minutes at 94° C. Following the Affymetrix protocol, 55 μg of fragmented cRNA was hybridized on the Affymetrix rat array set for twenty-four hours at 60 rpm in a 45° C. hybridization oven. The chips were washed and stained with Streptavidin Phycoerythrin (SAPE) (Molecular Probes) in Affymetrix fluidics stations. To amplify staining, SAPE solution was added twice with an anti-streptavidin biotinylated antibody (Vector Laboratories) staining step in between. Hybridization to the probe arrays was detected by fluorometric scanning (Hewlett Packard Gene Array Scanner). Data was analyzed using Affymetrix GeneChip® version 2.0 and Expression Data Mining (EDMT) software (version 1.0), the GeneExpress® database, and S-Plus® statistical analysis software (Insightful Corp.).

Tables 1 and 2 disclose those genes that are differentially expressed upon exposure to the named toxins and their corresponding GenBank Accession and Sequence Identification numbers, the identities of the metabolic pathways in which the genes function, the gene names if known, and the unigene cluster titles. The model code represents the various toxicity state that each gene is able to discriminate as well as the individual toxin type associated with each gene. The codes are defined in Table 4. The GLGC ID is the internal Gene Logic identification number.

Table 3 discloses those genes that are the human homologues of those genes in Tables 1 and 2 that are differentially expressed upon exposure to the named toxins. The corresponding GenBank Accession and Sequence Identification numbers, the gene names if known, and the unigene cluster titles of the human homologues are listed.

Table 4 defines the models of Tables 5A-5N.

The models of Tables 5A-5M (individual toxin models, pathology models and general toxin models) disclose the summary statistics for each of the comparisons performed. Table 5A contains gene expression information from the chloroform toxicity model. Table 5B contains gene expression information from the diclofenac toxicity model. Table C contains gene expression information from the menadione toxicity model. contains gene expression information from the chloroform toxicity model. Table D contains gene expression information from the sodium chromate toxicity model. Table E contains gene expression information from the sodium oxalate toxicity model. Table F contains gene expression information from the thioacetamide toxicity model. Table G contains gene expression information from the vancomycin toxicity model. Table H contains gene expression information from the pathology model of damage to the S2 segment of the renal proximal tubule. Table I contains gene expression information from the pathology model of renal tubular toxicity. Table J contains gene expression information from the pathology model of glomerular injury. Table K contains gene expression information from the pathology model of tubular obstruction. Table L contains gene expression information from the NSAIDS (non-steroidal anti-inflammatory drugs) toxicity model. Lastly, Table M contains gene expression information from a general toxicity model.

Each of these tables contains a set of predictive genes and creates a model for predicting the renal toxicity of an unknown, i.e., untested compound. Each gene is identified by its Gene Logic identification number and can be cross-referenced to a gene name and representative SEQ ID NO. in Tables 1 and 2. For each comparison of gene expression levels between samples in the toxicity group (samples affected by exposure to a specific toxin) and samples in the non-toxicity group (samples not affected by exposure to that same specific toxin), the tox group mean (for toxicity group samples) is the mean signal intensity, as normalized for the various chip parameters that are being assayed. The non-tox group mean represents the mean signal intensity, as normalized for the various chip parameters that are being assayed, in samples from animals other than those treated with the high dose of the specific toxin. These animals were treated with a low dose of the specific toxin, or with vehicle alone, or with a different toxin. Samples in the toxicity groups were obtained from animals sacrificed at the time points previously described, while samples in the non-toxicity groups were obtained from animals sacrificed at all time points in the experiments. For individual genes, an increase in the tox mean compared to the non-tox mean indicates up-regulation upon exposure to a toxin. Conversely, a decrease in the tox mean compared to the non-tox mean indicates down-regulation.

The mean values are derived from Average Difference (AveDiff) values for a particular gene, averaged across the corresponding samples. Each individual Average Difference value is calculated by integrating the intensity information from multiple probe pairs that are tiled for a particular fragment. The normalization multiplies each expression intensity for a given experiment (chip) by a global scaling factor. The intent of this normalization is to make comparisons of individual genes between chips possible. The scaling factor is calculated as follows:

From all the unnormalized expression values in the experiment, delete the largest 2% and smallest 2% of the values. That is, if the experiment yields 10,000 expression values, order the values and delete the smallest 200 and the largest 200.

2. Compute the trimmed mean, which is equal to the mean of the remaining values.

3. Compute the scale factor SF=100/(trimmed mean).

The value of 100 used here is the standard target value used. Some AveDiff values may be negative due to the general noise involved in nucleic acid hybridization experiments. Although many conclusions can be made corresponding to a negative value on the GeneChip® platform, it is difficult to assess the meaning behind the negative value for individual fragments. Our observations show that, although negative values are observed at times within the predictive gene set, these values reflect a real biological phenomenon that is highly reproducible across all the samples from which the measurement was taken. For this reason, those genes that exhibit a negative value are included in the predictive set. It should be noted that other platforms of gene expression measurement may be able to resolve the negative numbers for the corresponding genes. The predictive ability of each of those genes does extend across platforms. Each mean value is accompanied by the standard deviation for the mean. The linear discriminant analysis score (discriminant score), as disclosed in the tables, measures the ability of each gene to predict whether or not a sample is toxic. The discriminant score is calculated by the following steps:

Calculation of a Discriminant Score

1. Let Xᵢ represent the AveDiff values for a given gene across the non-tox samples, i=1 . . . n.

2. Let Yᵢ represent the AveDiff values for a given gene across the tox samples, i=1 . . . t. The calculations proceed as follows:

3. Calculate mean and standard deviation for Xᵢ's and Yᵢ's, and denote these by m_{X}, m_{Y}, s_{X}, s_{Y}.

4. For all Xᵢ's and Yᵢ's, evaluate the function f(z)=((1/s_{Y})*exp(−0.5*((z−m_{Y})/s_{Y})²))/(((1/s_{Y})*exp(−0.5*((z−m_{Y})/sy)²))+((1/s_{X})*exp(−0.5*((z−m_{X})/s_{X})²))).

5. The number of correct predictions, say P, is then the number of Yᵢ's such that f(Yᵢ)>0.5 plus the number of Xᵢ's such that f(Xᵢ)<0.5.

6. The discriminant score is then P/(n+t).

Linear discriminant analysis uses both the individual measurements of each gene and the calculated measurements of all combinations of genes to classify samples. For each gene a weight is derived from the mean and standard deviation of the toxic and nontox groups. Every gene is multiplied by a weight and the sum of these values results in a collective discriminate score. This discriminant score is then compared against collective centroids of the tox and nontox groups. These centroids are the average of all tox and nontox samples respectively. Therefore, each gene contributes to the overall prediction. This contribution is dependent on weights that are large positive or negative numbers if the relative distances between the tox and nontox samples for that gene are large and small numbers if the relative distances are small. The discriminant score for each unknown sample and centroid values can be used to calculate a probability between zero and one as to the group in which the unknown sample belongs.

### Example 2

### Identification of Toxicity Markers Using RMA and PLS Algorithms

Dosing of animals with toxins and vehicle controls, sacrificing of animals, preparation and hybridization of RNA to DNA microarrays, and obtaining gene expression values were performed as described in Example 1 above. The following toxins and negative controls were used and administered according to the protocols in Table 6.

RMA/PLS models were built as follows. From DNA microarray data from one or more tox studies, a matrix of RMA fold-change expression values was generated. These values may be generated, for example, according to the method of Irizarry et al. (Nucl Acids Res 31(4):e15, 2003), which uses the following equation to produce a log scale linear additive model: T(PMᵢⱼ)=eᵢ+aⱼ+εᵢⱼ. T represents the transformation that corrects for background and normalizes and converts the PM (perfect match) intensities to a log scale. eᵢ represents the log2 scale expression values found on arrays i=1−I, aⱼ represents the log scale affinity effects for probes j=1−J, and εᵢⱼ represents error (to correct for the differences in variances when using probes that bind with different intensities). In RMA fold-change matrices, the rows represent individual fragments, and the columns are individual samples. A vehicle cohort median matrix was then calculated, in which the rows represent fragments and the columns represent vehicle cohorts, one cohort for each study/time-point combination. The values in this matrix are the median RMA expression values across the samples within those cohorts. Next, a matrix of normalized RMA expression values was generated, in which the rows represent individual fragments and the columns are individual samples. The normalized RMA values are the RMA values minus the value from the vehicle cohort median matrix corresponding to the time-matched vehicle cohort. PLS modeling was then applied to the normalized RMA matrix (a subset by taking certain fragments as described below), using a−1=non-tox, +1=tox supervised score vector.

To select fragments, a vehicle cohort mean matrix was generated, in which the rows represent fragments and the columns represent vehicle cohorts, one cohort for each study/time-point combination. The values in this matrix are the mean RMA expression values across the samples within those cohorts. A treated cohort mean matrix was then generated, in which the rows represent fragments and the columns represent treated (non-vehicle) cohorts, one cohort for each study/time-point/compound/dose combination. The values in this matrix are the mean RMA expression values across the samples within those cohorts. Next, a treated cohort fold-change matrix was generated, in which the rows represent fragments and the columns represent treated cohorts, one cohort for each study/time-point/compound/dose combination. The values in this matrix are the values in the treated cohort mean matrix minus the values in the vehicle cohort mean matrix corresponding to appropriate time-matched vehicle cohorts. Subsequently, a treated cohort p-value matrix was generated, in which the rows represent fragments and the columns represent treated cohorts, one cohort for each study/time-point/compound/dose combination. The values in this matrix are p-values based on two-sample t-tests comparing the treated cohort mean values to the vehicle cohort mean values corresponding to appropriate time-matched vehicle cohorts. This matrix was converted to a binary coding based on the p-values being less than 0.05 (coded as 1) or greater than 0.05 (coded as 0).

The row sums of the binary treated cohort p-value matrix were computed, where that row sum represents a “regulation score” for each fragment, representing the total number of treated cohorts where the fragment showed differential regulation (up- or down-regulation) compared to its time-matched vehicle cohort. PLS modeling and cross-validation were then performed based on taking the top N fragments according to the regulation score, varying N and recording the model success rate for each N. N was chosen to be the point at which the cross-validated error rate was minimized. In the PLS model, each of those N fragments receives a PLS weight (PLS score) corresponding to the fragment's utility, or predictive ability, in the model. The data in Table 5N are taken from a kidney toxicity prediction model in which 2179 samples were assayed. This predictive model is based on expression levels of 782 genes. Thus, using a set of genes and a supervised grouping of samples, PLS can identify optimal prediction weights for those genes.

To determine whether or not a sample from an animal treated with a test compound shows a toxic response, RNA is prepared from a treatment sample and hybridized to a DNA microarray, as described in Example 1 above. From the gene expression information, a prediction score is calculated for that sample and compared to a reference score from a kidney toxicity reference database according to the following equation. The sample prediction score=ΣwᵢR^{FC}^{ᵢ}. “i” is the index number for each gene in a gene expression profile to be evaluated. “wᵢ” is the PLS weight (or PLS score, see Table 5N) for each gene. “R^{FC}^{ᵢ}” is the RMA fold-change value for the i^{th} gene, as determined from a normalized RMA matrix of gene expression data from the sample (described above). The PLS weight multiplied by the RMA fold-change value gives a prediction score for each gene, and the prediction scores for all the individual genes are added to give a prediction score for the sample. In a kidney toxicity database of the instant invention, a cut-off prediction score is about 0.318. If the sample score is about 0.318 or above, it can be predicted that the sample shows a toxic response after exposure to the test compound. If the sample score is below 0.318, it can be predicted that the sample does not show a toxic response.

The model can be trained by setting a score of −1 for each gene that cannot predict a toxic response and by setting a score of +1 for each gene that can predict a toxic response. Cross-validation of RMA/PLS models was performed by the compound-drop method and by the 2/3:1/3 method. In the compound-drop method, sample data from animals treated with one particular test compound were removed from a model, and the ability of this model to predict toxicity was compared to that of a model containing a full data set. In the 2/3:1/3 method, gene expression information from a random third of the genes in the model was removed, and the ability of this subset model to predict toxicity was compared to that of a model containing a full data set.

Compared to LDA models for predicting kidney toxicity, RMA/PLS models showed about a 10% increase in the true positive sample rates (89% vs. 79%) and about a 1.5% increase in the false positive sample rates (2.5% vs. 1%).

### Example 3

### General Toxicity Modeling

Samples were selected for grouping into tox-responding and non-tox-responding groups by examining each study individually with Principal Components Analysis (PCA) to determine which treatments had an observable response. Only groups where confidence of their tox-responding and non-tox-responding status was established were included in building a general tox model (Table 5M).

Linear discriminant models were generated to describe toxic and non-toxic samples. The top discriminant genes and/or EST's were used to determine toxicity by calculating each gene's contribution with homo and heteroscedastic treatment of variance and inclusion or exclusion of mutual information between genes. Prediction of samples within the database exceeded 80% true positives with a false positive rate of less than 5%. It was determined that combinations of genes and/or EST's generally provided a better predictive ability than individual genes and that the more genes and/or EST used the better predictive ability. Although the preferred embodiment includes fifty or more genes, many pairings or greater combinations of genes and/or EST can work better than individual genes. All combinations of two or more genes from the selected list (Table 5M) could be used to predict toxicity. These combinations could be selected by pairing in an agglomerate, divisive, or random approach. Further, as yet undetermined genes and/or EST's could be combined with individual or combination of genes and/or EST's described here to increase predictive ability. However, the genes and/or EST's described here would contribute most of the predictive ability of any such undetermined combinations.

Other variations on the above method can provide adequate predictive ability. These include selective inclusion of components via agglomerate, divisive, or random approaches or extraction of loading and combining them in agglomerate, divisive, or random approaches. Also the use of composite variables in logistic regression to determine classification of samples can also be accomplished with linear discriminate analysis, neural or Bayesian networks, or other forms of regression and classification based on categorical or continual dependent and independent variables.

### Example 4

### Modeling Methods

The above modeling methods provide broad approaches of combining the expression of genes to predict sample toxicity. One could also provide no weight in a simple voting method or determine weights in a supervised or unsupervised method using agglomerate, divisive, or random approaches. All or selected combinations of genes may be combined in ordered, agglomerate, or divisive, supervised or unsupervised clustering algorithms with unknown samples for classification. Any form of correlation matrix may also be used to classify unknown samples. The spread of the group distribution and discriminate score alone provide enough information to enable a skilled person to generate all of the above types of models with accuracy that can exceed discriminate ability of individual genes. Some examples of methods that could be used individually or in combination after transformation of data types include but are not limited to: Discriminant Analysis, Multiple Discriminant Analysis, logistic regression, multiple regression analysis, linear regression analysis, conjoint analysis, canonical correlation, hierarchical cluster analysis, k-means cluster analysis, self-organizing maps, multidimensional scaling, structural equation modeling, support vector machine determined boundaries, factor analysis, neural networks, bayesian classifications, and resampling methods. Further, in any model, a compound may be classified as a negative control because it appears to produce reduced toxicity, although the compound may be added to the model as a toxin to increase the sensitivity for predicting toxicity.

### Example 5

### Grouping of Individual Compound and Pathology Classes

Samples were grouped into individual pathology classes based on known toxicological responses and observed clinical chemical and pathology measurements or into early and late phases of observable toxicity within a compound (Tables 5A-5L). The top 10, 25, 50, 100 genes based on individual discriminate scores were used in a model to ensure that combination of genes provided a better prediction than individual genes. As described above, all combinations of two or more genes from this list could potentially provide better prediction than individual genes when selected in any order or by ordered, agglomerate, divisive, or random approaches. In addition, combining these genes with other genes could provide better predictive ability, but most of this predictive ability would come from the genes listed herein.

Samples may be considered toxic if they score positive in any pathological or individual compound class represented here or in any modeling method mentioned under general toxicology models based on combination of individual time and dose grouping of individual toxic compounds obtainable from the data. The pathological groupings and early and late phase models are preferred examples of all obtainable combinations of sample time and dose points. Most logical groupings with one or more genes and one or more sample dose and time points should produce better predictions of general toxicity, pathological specific toxicity, or similarity to known toxicant than individual genes.

Although the present invention has been described in detail with reference to examples above, it is understood that various modifications can be made without departing from the spirit of the invention. Accordingly, the invention is limited only by the following claims. All cited patents, patent applications and publications referred to in this application are herein incorporated by reference in their entirety.

TABLE 1

| GLGC | | GenBank Acc | Model | | |
|---|---|---|---|---|---|
| Identifier | Seq ID | or RefSeq ID | Code | Known Gene Name | UniGene Cluster Title |
| 6917 | 1 | AA012709 | B | | Rattus norvegicus transcribed sequence with strong similarity to protein |
| | | | | | ref: NP_112456.1 (M. musculus) splicing factor 3b, subunit 1, 155 kDa [Mus |
| | | | | | musculus] |
| 25098 | 2 | AA108277 | N, C, H | | |
| 6049 | 3 | AA685178 | F | | Rattus norvegicus transcribed sequence with strong similarity to protein |
| | | | | | pir: T30827 (M. musculus) T30827 nascent polypeptide-associated complex |
| | | | | | alpha chain, non-muscle splice form - mouse |
| 25106 | 4 | AA686579 | B | | Rattus norvegicus transcribed sequence with strong similarity to protein |
| | | | | | sp: Q93068 (M. musculus) SM33_HUMAN Ubiquitin-like protein SMT3C |
| | | | | | precursor (Ubiquitin-homology domain protein PIC1) (Ubiquitin-like protein |
| | | | | | UBL1) (Ubiquitin-related protein SUMO-1) (GAP modifying protein 1) (GMP1) |
| | | | | | (Sentrin) |
| 12349 | 5 | AA799276 | M | ATPase, Ca++ transporting, cardiac muscle, slow twitch 2 | ATPase, Ca++ transporting, cardiac muscle, slow twitch 2 |
| 19222 | 6 | AA799279 | J | | Rattus norvegicus transcribed sequence with strong similarity to protein |
| | | | | | ref: NP_062732.1 (M. musculus) mitochondrial carrier homolog 2 [Mus |
| | | | | | musculus] |
| 18272 | 7 | AA799294 | I | | Rattus norvegicus transcribed sequence with moderate similarity to protein |
| | | | | | ref: NP_055993.1 (H. sapiens) KIAA0717 protein [Homo sapiens] |
| 18396 | 8 | AA799330 | M, N, H, I | | Rattus norvegicus transcribed sequence with strong similarity to protein |
| | | | | | ref: NP_057030.1 (H. sapiens) CGI-17 protein; pelota (Drosophila) homolog |
| | | | | | [Homo sapiens] |
| 16039 | 9 | AA799452 | H | transaldolase 1 | transaldolase 1 |
| 20961 | 10 | AA799465 | L | | Rattus norvegicus transcribed sequence |
| 16150 | 11 | AA799489 | G | acyl-coA oxidase | acyl-coA oxidase |
| 18291 | 12 | AA799497 | N | | Rattus norvegicus transcribed sequences |
| 15302 | 13 | AA799518 | M | | Rattus norvegicus transcribed sequence with moderate similarity to protein |
| | | | | | ref: NP_075223.1 (R. norvegicus) DnaJ-like protein [Rattus norvegicus] |
| 15303 | 13 | AA799518 | F | | Rattus norvegicus transcribed sequence with moderate similarity to protein |
| | | | | | ref: NP_075223.1 (R. norvegicus) DnaJ-like protein [Rattus norvegicus] |
| 23063 | 14 | AA799534 | M, N, K | | Rattus norvegicus transcribed sequences |
| 22669 | 15 | AA799567 | D | | Rattus norvegicus transcribed sequences |
| 18361 | 16 | AA799591 | M, N | | Rattus norvegicus transcribed sequence with strong similarity to protein |
| | | | | | prf: 1202265A (R. norvegicus) 1202265A tubulin T beta15 [Rattus norvegicus] |
| 15844 | 17 | AA799600 | D | | Rattus norvegicus transcribed sequence with strong similarity to protein |
| | | | | | ref: NP_115647.1 (H. sapiens) hypothetical protein DKFZp586I021 [Homo |
| | | | | | sapiens] |
| 22910 | 18 | AA799654 | K | | Rattus norvegicus transcribed sequence with strong similarity to protein |
| | | | | | ref: NP_038936.1 (M. musculus) f-box and WD-40 domain protein 5; F-box |
| | | | | | protein Fbw5 [Mus musculus] |
| 14309 | 19 | AA799676 | M, N | | Rattus norvegicus transcribed sequences |
| 17494 | 20 | AA799751 | M, K | | Rattus norvegicus transcribed sequence with weak similarity to protein |
| | | | | | ref: NP_476544.1 (R. norvegicus) brain-specific angiogenesis inhibitor 1- |
| | | | | | associated protein 2 [Rattus norvegicus] |
| 18360 | 21 | AA799771 | M, I | | Rattus norvegicus transcribed sequences |
| 21007 | 22 | AA799861 | N | | Rattus norvegicus transcribed sequence with strong similarity to protein |
| | | | | | sp: P70434 (M. musculus) IRF7_MOUSE Interferon regulatory factor 7 (IRF-7) |
| 23202 | 23 | AA799971 | M | | Rattus norvegicus transcribed sequence with moderate similarity to protein |
| | | | | | ref: NP_060761.1 (H. sapiens) hypothetical protein FLJ10986 [Homo sapiens] |
| 23203 | 23 | AA799971 | M, N | | Rattus norvegicus transcribed sequence with moderate similarity to protein |
| | | | | | ref: NP_060761.1 (H. sapiens) hypothetical protein FLJ10986 [Homo sapiens] |
| 21029 | 24 | AA799981 | C | protein kinase C-eta | protein kinase C-eta |
| 2098 | 25 | AA799995 | C | actin, beta | actin, beta |
| 4412 | 26 | AA800005 | N | CD151 antigen | CD151 antigen |
| 21035 | 27 | AA800025 | N | | Rattus norvegicus transcribed sequence with strong similarity to protein |
| | | | | | ref: NP_542787.1 (H. sapiens) chromosome 20 open reading frame 163 |
| | | | | | [Homo sapiens] |
| 21072 | 28 | AA800211 | K | pyridoxine 5-phosphate oxidase | pyridoxine 5-phosphate oxidase |
| 21086 | 29 | AA800305 | D | | Rattus norvegicus transcribed sequence with strong similarity to protein |
| | | | | | ref: NP_073183.1 (R. norvegicus) small GTP-binding protein rab5 [Rattus |
| | | | | | norvegicus] |
| 17325 | 30 | AA800587 | M, G, K | | Rattus norvegicus transcribed sequence with weak similarity to protein |
| | | | | | sp: P04041 (R. norvegicus) GSHC_RAT Glutathione peroxidase (GSHPX-1) |
| | | | | | (Cellular glutathione peroxidase) |
| 13930 | 31 | AA800613 | M | zinc finger protein 36 | zinc finger protein 36 |
| 18462 | 32 | AA800708 | N | | Rattus norvegicus transcribed sequences |
| 18564 | 33 | AA800745 | M | aminolevulinate, delta-, dehydratase | aminolevulinate, delta-, dehydratase |
| 6595 | 34 | AA800753 | C | | Rattus norvegicus transcribed sequences |
| 21388 | 35 | AA800771 | C | | Rattus norvegicus transcribed sequences |
| 12797 | 36 | AA800790 | D | | Rattus norvegicus transcribed sequences |
| 22386 | 37 | AA800844 | N, F | | Rattus norvegicus transcribed sequence with moderate similarity to protein |
| | | | | | sp: P16636 (R. norvegicus) LYOX_RAT Protein-lysine 6-oxidase precursor |
| | | | | | (Lysyl oxidase) |
| 15022 | 38 | AA801029 | N | nuclear receptor subfamily 2, group F, member 6 | nuclear receptor subfamily 2, group F, member 6 |
| 14600 | 39 | AA801076 | K | | Rattus norvegicus transcribed sequences |
| 23115 | 40 | AA801165 | A, F | | Rattus norvegicus transcribed sequence with strong similarity to protein |
| | | | | | sp: P02262 (R. norvegicus) H2A1_RAT Histone H2A.1 |
| 15027 | 41 | AA801212 | D | | Rattus norvegicus transcribed sequences |
| 7543 | 42 | AA801395 | M | | Rattus norvegicus transcribed sequence with moderate similarity to protein |
| | | | | | ref: NP_080242.1 (M. musculus) RIKEN cDNA 2310039H08 [Mus musculus] |
| 20753 | 43 | AA801441 | M, N, C, I | platelet-activating factor acetylhydrolase beta subunit | platelet-activating factor acetylhydrolase beta subunit (PAF-AH beta) |
| | | | | (PAF-AH beta) | |
| 5930 | 44 | AA817688 | B | | Rattus norvegicus transcribed sequences |
| 24237 | 45 | AA817726 | M | | Rattus norvegicus transcribed sequences |
| 1650 | 46 | AA817825 | A | Peptidylglycine alpha-amidating monooxygenase | Peptidylglycine alpha-amidating monooxygenase |
| 2109 | 47 | AA817887 | N, G | profilin | profilin |
| 16907 | 48 | AA817977 | C | | Rattus norvegicus transcribed sequence with weak similarity to protein |
| | | | | | ref: NP_079770.1 (M. musculus) similar to human ATP6C source AF363578.1 |
| | | | | | [Mus musculus] |
| 6675 | 49 | AA817994 | C | | Rattus norvegicus transcribed sequence with weak similarity to protein |
| | | | | | ref: NP_062213.1 (R. norvegicus) regulator of G-protein signaling 3 [Rattus |
| | | | | | norvegicus] |
| 3016 | 50 | AA818069 | H | polyubiquitin | polyubiquitin |
| 16756 | 51 | AA818089 | M, A, I | | Rattus norvegicus transcribed sequence with strong similarity to protein |
| | | | | | pir: A55314 (H. sapiens) A55314 glycine - tRNA ligase (EC 6.1.1.14) precursor |
| | | | | | [validated] - human |
| 10983 | 52 | AA818132 | G | | Rattus norvegicus transcribed sequences |
| 6014 | 53 | AA818153 | B, H | | Rattus norvegicus transcribed sequences |
| 6022 | 54 | AA818197 | E | | Rattus norvegicus protein tyrosine phosphatase non-receptor type 13 |
| | | | | | (Ptpn13), 3′UTR |
| 11421 | 55 | AA818199 | E | src associated in mitosis, 68 kDa | src associated in mitosis, 68 kDa |
| 17771 | 56 | AA818224 | M | | Rat mRNA for beta-tubulin T beta15 |
| 5923 | 57 | AA818355 | M, I | | Rattus norvegicus transcribed sequences |
| 11610 | 58 | AA818725 | J | | Rattus norvegicus transcribed sequence with moderate similarity to protein |
| | | | | | ref: NP_149107.1 (H. sapiens) hypothetical protein MGC16714 [Homo |
| | | | | | sapiens] |
| 4291 | 59 | AA818741 | M, I, J | | Rattus norvegicus transcribed sequences |
| 4330 | 60 | AA818747 | M, B | chemokine (C—X—C motif) ligand 12 | chemokine (C—X—C motif) ligand 12 |
| 19723 | 61 | AA818761 | M | | Rattus norvegicus transcribed sequence with strong similarity to protein |
| | | | | | pir: A36370 (M. musculus) A36370 immediate-early protein pip92 - mouse |
| 4952 | 62 | AA818907 | M, C | | Rattus norvegicus transcribed sequences |
| 10985 | 63 | AA818998 | M, I | | Rattus norvegicus transcribed sequences |
| 16958 | 64 | AA819021 | A | | |
| 5863 | 65 | AA819111 | M, H, I | | Rattus norvegicus transcribed sequences |
| 12684 | 66 | AA819179 | F | | Rattus norvegicus transcribed sequences |
| 9125 | 67 | AA819338 | N | signal sequence receptor 4 | signal sequence receptor 4 |
| 17824 | 68 | AA819362 | A | | Rattus norvegicus Ba1-643 mRNA, complete cds |
| 6336 | 69 | AA819403 | M | | Rattus norvegicus transcribed sequences |
| 6278 | 70 | AA819471 | B | | Rattus norvegicus transcribed sequence with strong similarity to protein |
| | | | | | ref: NP_079747.1 (M. musculus) RIKEN cDNA 1810030N24 [Mus musculus] |
| 19433 | 71 | AA819776 | H | | |
| 22820 | 72 | AA848315 | M | | Rattus norvegicus transcribed sequence with strong similarity to protein |
| | | | | | pir: JT0565 (M. musculus) JT0565 IMP dehydrogenase (EC 1.1.1.205) - mouse |
| 6614 | 73 | AA848389 | G | | Rattus norvegicus transcribed sequence with weak similarity to protein |
| | | | | | ref: NP_496764.1 (C. elegans) Iron-containing alcohol dehydrogenases |
| | | | | | [Caenorhabditis elegans] |
| 21125 | 74 | AA848437 | M, L | | Rattus norvegicus transcribed sequences |
| 23505 | 75 | AA848496 | J | | Rattus norvegicus transcribed sequence with weak similarity to protein |
| | | | | | sp: Q9WUK2 (M. musculus) IF4H_MOUSE Eukaryotic translation initiation |
| | | | | | factor 4H (elF-4H) (Williams-Beuren syndrome chromosome region 1 protein |
| | | | | | homolog) |
| 11653 | 76 | AA848689 | A, F | | Rattus norvegicus transcribed sequence with weak similarity to protein |
| | | | | | sp: P43165 (R. norvegicus) CAH5_RAT Carbonic anhydrase VA, mitochondrial |
| | | | | | precursor (Carbonate dehydratase VA) (CA-VA) |
| 21140 | 77 | AA848738 | J | | Rattus norvegicus transcribed sequence with weak similarity to protein |
| | | | | | ref: NP_035246.1 (M. musculus) phospholipase D3 [Mus musculus] |
| 21165 | 78 | AA848941 | K | actinin, alpha 1 | actinin, alpha 1 |
| 21166 | 78 | AA848941 | K | actinin, alpha 1 | actinin, alpha 1 |
| 2924 | 79 | AA848948 | H | | Rattus norvegicus transcribed sequence with weak similarity to protein |
| | | | | | ref: NP_510258.1 (C. elegans) F18H3.1.p [Caenorhabditis elegans] |
| 22631 | 80 | AA849030 | K | | Rattus norvegicus transcribed sequence with strong similarity to protein |
| | | | | | ref: NP_062310.1 (M. musculus) hypothetical protein 0610038L10Rik [Mus |
| | | | | | musculus] |
| 8888 | 81 | AA849036 | N, B | guanylate cyclase 1, soluble, alpha 3 | guanylate cyclase 1, soluble, alpha 3 |
| 19412 | 82 | AA849222 | D | | Rattus norvegicus transcribed sequence with weak similarity to protein |
| | | | | | ref: NP_291082.1 (M. musculus) arkadia [Mus musculus] |
| 17339 | 83 | AA849497 | M | | Rattus norvegicus transcribed sequence with strong similarity to protein |
| | | | | | ref: NP_062785.1 (M. musculus) acetyl-Coenzyme A synthetase 1 (AMP |
| | | | | | forming); acetyl-Coenzyme A synthetase 2 (AMP forming); acetyl-CoA |
| | | | | | synthetase [Mus musculus] |
| 6635 | 84 | AA849786 | M | | Rattus norvegicus transcribed sequence with weak similarity to protein |
| | | | | | sp: Q63117 (R. norvegicus) CLK3_RAT Protein kinase CLK3 (CDC-like kinase |
| | | | | | 3) |
| 18447 | 85 | AA849939 | F | | Rattus norvegicus transcribed sequence with strong similarity to protein |
| | | | | | pdb: 1BGM (E. coli) O Chain O, Beta-Galactosidase (Chains I-P) |
| 12129 | 86 | AA849966 | A, D | | Rattus norvegicus transcribed sequence with moderate similarity to protein |
| | | | | | ref: NP_291042.1 (M. musculus) Mpv17 transgene, kidney disease mutant-like |
| | | | | | [Mus musculus] |
| 21341 | 87 | AA850195 | I | | Rattus norvegicus transcribed sequences |
| 14410 | 88 | AA850292 | F | | Rattus norvegicus transcribed sequences |
| 13615 | 89 | AA850364 | L | | Rattus norvegicus transcribed sequences |
| 21766 | 90 | AA850916 | J | | Rattus norvegicus transcribed sequences |
| 1867 | 91 | AA850940 | N | ribosomal protein L4 | ribosomal protein L4 |
| 3925 | 92 | AA851017 | A, E | | Rattus norvegicus transcribed sequence with moderate similarity to protein |
| | | | | | ref: NP_038854.1 (M. musculus) molybdenum cofactor synthesis 2 [Mus |
| | | | | | musculus] |
| 18751 | 93 | AA851169 | G | protease (prosome, macropain) 28 subunit, beta | protease (prosome, macropain) 28 subunit, beta |
| 17823 | 94 | AA851214 | D | | Rattus norvegicus Ba1-643 mRNA, complete cds |
| 21462 | 95 | AA851261 | M, J | | Rattus norvegicus transcribed sequence with moderate similarity to protein |
| | | | | | ref: NP_054781.1 (H. sapiens) ART-4 protein [Homo sapiens] |
| 13349 | 96 | AA851417 | M, H, I | | Rattus norvegicus transcribed sequences |
| 1685 | 97 | AA851497 | J | hemoglobin, alpha 1 | hemoglobin, alpha 1 |
| 21509 | 98 | AA851618 | G | epithelial membrane protein 3 | epithelial membrane protein 3 |
| 23307 | 99 | AA851749 | D | splicing factor, arginine/serine-rich (transformer 2 | splicing factor, arginine/serine-rich (transformer 2 Drosophila homolog) 10 |
| | | | | Drosophila homolog) 10 | |
| 18001 | 100 | AA858573 | M | spp-24 precursor | spp-24 precursor |
| 24377 | 101 | AA858590 | H | | Rattus norvegicus transcribed sequences |
| 17411 | 102 | AA858621 | N | CaM-kinase II inhibitor alpha | CaM-kinase II inhibitor alpha |
| 1801 | 103 | AA858636 | E | | Rattus norvegicus transcribed sequence with strong similarity to protein |
| | | | | | ref: NP_032594.1 (M. musculus) mini chromosome maintenance deficient 7 (S. cerevisiae) |
| | | | | | [Mus musculus] |
| 12700 | 104 | AA858673 | N | pancreatic secretory trypsin inhibitor type II (PSTI-II) | pancreatic secretory trypsin inhibitor type II (PSTI-II) |
| 18350 | 105 | AA858674 | C | | Rattus norvegicus transcribed sequences |
| 11615 | 106 | AA858816 | D | | Rattus norvegicus transcribed sequence with weak similarity to protein |
| | | | | | ref: NP_497482.1 (C. elegans) F53A3.7.p [Caenorhabditis elegans] |
| 7279 | 107 | AA858892 | M | | Rattus norvegicus transcribed sequences |
| 5867 | 108 | AA858953 | M | | Rattus norvegicus transcribed sequence with weak similarity to protein |
| | | | | | sp: P15178 (R. norvegicus) SYD_RAT ASPARTYL-TRNA SYNTHETASE |
| | | | | | (ASPARTATE-TRNA LIGASE) (ASPRS) |
| 6431 | 109 | AA859085 | L | | Rattus norvegicus transcribed sequences |
| 17361 | 110 | AA859114 | M, A, G | | |
| 21025 | 111 | AA859241 | M, A, C | synaptojanin 2 binding protein | synaptojanin 2 binding protein |
| 14124 | 112 | AA859305 | N | tropomyosin isoform 6 | tropomyosin isoform 6 |
| 16314 | 113 | AA859348 | M, I | | Rattus norvegicus transcribed sequences |
| 4178 | 114 | AA859536 | M, N, A | | Rattus norvegicus transcribed sequence with strong similarity to protein |
| | | | | | sp: P07153 (R. norvegicus) RIB1_RAT Dolichyl-diphosphooligosaccharide- |
| | | | | | protein glycosyltransferase 67 kDa subunit precursor (Ribophorin I) (RPN-I) |
| 15150 | 115 | AA859562 | N | | |
| 14353 | 116 | AA859585 | D | | Rattus norvegicus transcribed sequences |
| 11852 | 117 | AA859593 | N | | Rattus norvegicus transcribed sequence with moderate similarity to protein |
| | | | | | pdb: 1LBG (E. coli) B Chain B, Lactose Operon Repressor Bound To 21-Base |
| | | | | | Pair Symmetric Operator Dna, Alpha Carbons Only |
| 4809 | 118 | AA859616 | N | | Rattus norvegicus transcribed sequence with weak similarity to protein |
| | | | | | ref: NP_502422.1 (C. elegans) FYVE zinc finger [Caenorhabditis elegans] |
| 19067 | 119 | AA859663 | M, N, B | | Rattus norvegicus transcribed sequence with weak similarity to protein |
| | | | | | ref: NP_080153.1 (M. musculus) RIKEN cDNA 2310067G05 [Mus musculus] |
| 20582 | 120 | AA859688 | N, A, E, F, K | | Rattus norvegicus transcribed sequence with weak similarity to protein |
| | | | | | pdb: 1DUB (R. norvegicus) F Chain F, 2-Enoyl-Coa Hydratase, Data Collected |
| | | | | | At 100 K, Ph 6.5 |
| 14138 | 121 | AA859700 | M | | Rattus norvegicus transcribed sequence with moderate similarity to protein |
| | | | | | sp: P51175 (M. musculus) PPOX_MOUSE PROTOPORPHYRINOGEN |
| | | | | | OXIDASE (PPO) |
| 22374 | 122 | AA859804 | N | | Rattus norvegicus transcribed sequence with weak similarity to protein |
| | | | | | sp: P20415 (R. norvegicus) IF4E_MOUSE EUKARYOTIC TRANSLATION |
| | | | | | INITIATION FACTOR 4E (EIF-4E) (EIF4E) (MRNA CAP-BINDING PROTEIN) |
| | | | | | (EIF-4F 25 KDA SUBUNIT) |
| 11079 | 123 | AA859829 | E | | Rattus norvegicus transcribed sequence with strong similarity to protein |
| | | | | | ref: NP_067475.1 (M. musculus) erythroblast macrophage protein [Mus |
| | | | | | musculus] |
| 11481 | 124 | AA859832 | B | | Rattus norvegicus transcribed sequences |
| 22562 | 125 | AA859835 | F | | Rattus norvegicus transcribed sequences |
| 14184 | 126 | AA859837 | M | guanine deaminase | guanine deaminase |
| 14185 | 126 | AA859837 | M | guanine deaminase | guanine deaminase |
| 22927 | 127 | AA859920 | N, E | nucleosome assembly protein 1-like 1 | nucleosome assembly protein 1-like 1 |
| 23000 | 128 | AA859933 | F | | Rattus norvegicus transcribed sequences |
| 23166 | 129 | AA859954 | M, C, L | vacuole Membrane Protein 1 | vacuole Membrane Protein 1 |
| 18468 | 130 | AA859966 | J | | |
| 19377 | 131 | AA859971 | A, E | | Rattus norvegicus transcribed sequence with moderate similarity to protein |
| | | | | | ref: NP_079603.1 (M. musculus) RIKEN cDNA 0610010112 [Mus musculus] |
| 4222 | 132 | AA860024 | N | | Rattus norvegicus transcribed sequence with strong similarity to protein |
| | | | | | sp: Q9D8N0 (M. musculus) EF1G_MOUSE Elongation factor 1-gamma (EF-1- |
| | | | | | gamma) (eEF-1B gamma) |
| 13974 | 133 | AA860030 | M, F | tubulin, beta 5 | tubulin beta 5 |
| 7090 | 134 | AA860039 | N | | Rattus norvegicus transcribed sequence |
| 19144 | 135 | AA860049 | A | | Rattus norvegicus transcribed sequence with strong similarity to protein |
| | | | | | pdb: 1BGM (E. coli) O Chain O, Beta-Galactosidase (Chains I-P) |
| 4462 | 136 | AA866264 | M, A, C, I | | Rattus norvegicus transcribed sequence with weak similarity to protein |
| | | | | | sp: P51652 (R. norvegicus) PE2R_RAT 20-alpha-hydroxysteroid |
| | | | | | dehydrogenase (20-alpha-HSD) (HSD1) |
| 15927 | 137 | AA866321 | N | | Rattus norvegicus transcribed sequences |
| 11865 | 138 | AA866383 | N | | Rattus norvegicus transcribed sequences |
| 9391 | 139 | AA866477 | J | | Rattus norvegicus cytochrome c oxidase subunit VIIb mRNA, complete cds |
| 19402 | 140 | AA874848 | N | Thymus cell surface antigen | Thymus cell surface antigen |
| 18741 | 141 | AA874859 | M | | |
| 16070 | 142 | AA874873 | D | | Rattus norvegicus transcribed sequences |
| 16082 | 143 | AA874887 | E | | Rattus norvegicus transcribed sequence with weak similarity to protein |
| | | | | | ref: NP_113871.1 (R. norvegicus) segregation of mitotic chromosomes b; SMC |
| | | | | | (segregation of mitotic chromosomes 1)-like 1 (yeast) [Rattus norvegicus] |
| 16091 | 144 | AA874897 | J | | Rattus norvegicus transcribed sequences |
| 22781 | 145 | AA874926 | F | | Rattus norvegicus focal adhesion kinase (FAK) mRNA, alternative 5′UTR |
| 16139 | 146 | AA874927 | N | | Rattus norvegicus transcribed sequences |
| 16312 | 147 | AA875032 | M, I, L | | Rattus norvegicus transcribed sequences |
| 6451 | 148 | AA875033 | N | fibulin 5 | fibulin 5 |
| 16419 | 149 | AA875102 | N | | Rattus norvegicus transcribed sequence with strong similarity to protein |
| | | | | | sp: P08578 (M. musculus) RUXE_HUMAN Small nuclear ribonucleoprotein E |
| | | | | | (snRNP-E) (Sm protein E) (Sm-E) (SmE) |
| 15339 | 150 | AA875171 | D | | Rattus norvegicus transcribed sequence with weak similarity to protein |
| | | | | | ref: NP_032951.1 (M. musculus) protein kinase C substrate 80K-H [Mus |
| | | | | | musculus] |
| 18084 | 151 | AA875186 | N | | |
| 15371 | 152 | AA875205 | N | | Rattus norvegicus transcribed sequence with strong similarity to protein |
| | | | | | sp: P55884 (H. sapiens) IF39_HUMAN Eukaryotic translation initiation factor 3 |
| | | | | | subunit 9 (eIF-3 eta) (eIF3 p116) (elF3 p110) |
| 15376 | 153 | AA875206 | N | ubiquilin 1 | ubiquilin 1 |
| 15887 | 154 | AA875225 | N | GTP-binding protein (G-alpha-i2) | GTP-binding protein (G-alpha-i2) |
| 15888 | 154 | AA875225 | N | GTP-binding protein (G-alpha-i2) | GTP-binding protein (G-alpha-i2) |
| 15401 | 155 | AA875257 | N | | Rattus norvegicus transcribed sequences |
| 15421 | 156 | AA875286 | C, L | | Rattus norvegicus transcribed sequence with strong similarity to protein |
| | | | | | ref: NP_059128.1 (H. sapiens) prostate tumor over expressed gene 1 [Homo |
| | | | | | sapiens] |
| 15446 | 157 | AA875327 | L | | Rattus norvegicus transcribed sequence with weak similarity to protein |
| | | | | | ref: NP_072143.1 (R. norvegicus) nucleolin-related protein NRP (NRP) [Rattus |
| | | | | | norvegicus] |
| 18902 | 158 | AA875390 | N | thioredoxin-like (32 kD) | thioredoxin-like (32 kD) |
| 15505 | 159 | AA875414 | N | | Rattus norvegicus transcribed sequence with weak similarity to protein |
| | | | | | ref: NP_059088.1 (M. musculus) cadherin EGF LAG seven-pass G-type |
| | | | | | receptor 2 [Mus musculus] |
| 7936 | 160 | AA875495 | M, A, B, C, I | | Rattus norvegicus transcribed sequences |
| 24472 | 161 | AA875523 | L | | Rattus norvegicus transcribed sequence with strong similarity to protein |
| | | | | | sp: Q64119 (R. norvegicus) MLES_RAT Myosin light chain alkali, smooth- |
| | | | | | muscle isoform (MLC3SM) |
| 6153 | 162 | AA875531 | N | | |
| 15574 | 163 | AA875552 | H | | Rattus norvegicus transcribed sequence with strong similarity to protein |
| | | | | | ref: NP_084528.1 (M. musculus) hypothetical protein, MGC: 7764; hypothetical |
| | | | | | protein MGC7764 [Mus musculus] |
| 15295 | 164 | AA875594 | M, H, I | (FK506 binding protein 2, FK506-binding protein 1a) | (FK506 binding protein 2, FK506-binding protein 1a) |
| 15618 | 165 | AA875620 | M | | Rattus norvegicus transcribed sequences |
| 5384 | 166 | AA891041 | I | jun B proto-oncogene | jun B proto-oncogene |
| 1644 | 167 | AA891068 | A, F | Peptidylglycine alpha-amidating monooxygenase | Peptidylglycine alpha-amidating monooxygenase |
| 15833 | 168 | AA891171 | K | | Rattus norvegicus transcribed sequence with moderate similarity to protein |
| | | | | | ref: NP_004540.1 (H. sapiens) NADH dehydrogenase (ubiquinone) 1, |
| | | | | | subcomplex unknown, 2 (14.5 kD, B14.5b) [Homo sapiens] |
| 24235 | 169 | AA891286 | M, N, H, I | thioredoxin reductase 1 | thioredoxin reductase 1 |
| 9952 | 170 | AA891422 | N | hypoxia induced gene 1 | hypoxia induced gene 1 |
| 16446 | 171 | AA891423 | L | | Rattus norvegicus transcribed sequence with moderate similarity to protein |
| | | | | | ref: NP_078813.1 H. sapiens hypothetical protein FLJ12118 [Homo sapiens] |
| 9071 | 172 | AA891578 | N | | Rattus norvegicus transcribed sequences |
| 474 | 173 | AA891670 | N, D | | Rattus norvegicus transcribed sequence with moderate similarity to protein |
| | | | | | ref: NP_034894.1 (M. musculus) mannosidase 2, alpha B1; lysosomal alpha- |
| | | | | | mannosidase [Mus musculus] |
| 9091 | 174 | AA891690 | N | | Rattus norvegicus transcribed sequence with strong similarity to protein |
| | | | | | ref: NP_076006.1 (M. musculus) tumor necrosis factor (ligand) superfamily, |
| | | | | | member 13 [Mus musculus] |
| 17420 | 175 | AA891693 | M, N | | Rattus norvegicus transcribed sequences |
| 18078 | 176 | AA891726 | N | solute carrier family 34, member 1 | solute carrier family 34, member 1 |
| 20839 | 177 | AA891729 | N | ribosomal protein S27a | ribosomal protein S27a |
| 11959 | 178 | AA891735 | N, D | | Rattus norvegicus transcribed sequences |
| 17693 | 179 | AA891737 | N, J | | Rattus norvegicus transcribed sequences |
| 14970 | 180 | AA891738 | M, B, H, I, K | sulfite oxidase | sulfite oxidase |
| 17256 | 181 | AA891739 | M, C, E, I | | Rattus norvegicus transcribed sequence with weak similarity to protein |
| | | | | | ref: NP_496168.1 (C. elegans) F52H3.5.p [Caenorhabditis elegans] |
| 15110 | 182 | AA891764 | M, I | low density lipoprotein receptor-related protein 2 | low density lipoprotein receptor-related protein 2 |
| 18269 | 183 | AA891769 | M, D, L | | Rattus norvegicus focal adhesion kinase (FAK) mRNA, alternative 5′UTR |
| 9905 | 184 | AA891774 | M, A, I, K | | Rattus norvegicus transcribed sequences |
| 17289 | 185 | AA891785 | N, E | | Rattus norvegicus transcribed sequence with weak similarity to protein |
| | | | | | sp: P41562 (R. norvegicus) IDHC_RAT ISOCITRATE DEHYDROGENASE |
| | | | | | [NADP] CYTOPLASMIC (OXALOSUCCINATE DECARBOXYLASE) (IDH) |
| | | | | | (NADP+-SPECIFIC ICDH) (IDP) |
| 17290 | 185 | AA891785 | N, E | | Rattus norvegicus transcribed sequence with weak similarity to protein |
| | | | | | sp: P41562 (R. norvegicus) IDHC_RAT ISOCITRATE DEHYDROGENASE |
| | | | | | [NADP] CYTOPLASMIC (OXALOSUCCINATE DECARBOXYLASE) (IDH) |
| | | | | | (NADP+-SPECIFIC ICDH) (IDP) |
| 21672 | 186 | AA891789 | C, D | | Rattus norvegicus transcribed sequence with strong similarity to protein |
| | | | | | ref: NP_062742.1 (M. musculus) cDNA sequence AB025049 [Mus musculus] |
| 22124 | 187 | AA891790 | D | | Rattus norvegicus transcribed sequences |
| 18128 | 188 | AA891800 | I | | Rattus norvegicus transcribed sequence with moderate similarity to protein |
| | | | | | ref: NP_008834.1 (H. sapiens) inorganic pyrophosphattase [Homo sapiens] |
| 4463 | 189 | AA891831 | M, A, I | | Rattus norvegicus transcribed sequence with weak similarity to protein |
| | | | | | sp: P51652 (R. norvegicus) PE2R_RAT 20-alpha-hydroxysteroid |
| | | | | | dehydrogenase (20-alpha-HSD) (HSD1) |
| 20522 | 190 | AA891842 | N, L | | Rattus norvegicus transcribed sequence with weak similarity to protein |
| | | | | | ref: NP_057713.1 (H. sapiens) hypothetical protein LOC51323 [Homo sapiens] |
| 20523 | 190 | AA891842 | N, B, L | | Rattus norvegicus transcribed sequence with weak similarity to protein |
| | | | | | ref: NP_057713.1 (H. sapiens) hypothetical protein LOC51323 [Homo sapiens] |
| 17249 | 191 | AA891858 | N, K | | Rattus norvegicus transcribed sequence with moderate similarity to protein |
| | | | | | sp: O88338 (M. musculus) CADG_MOUSE Cadherin-16 precursor (Kidney- |
| | | | | | specific cadherin) (Ksp-cadherin) |
| 16023 | 192 | AA891872 | N | | Rattus norvegicus transcribed sequence with strong similarity to protein |
| | | | | | pir: S54876 (M. musculus) S54876 NAD(P)+ transhydrogenase (B-specific) (EC |
| | | | | | 1.6.1.1) precursor - mouse |
| 2576 | 193 | AA891884 | K | | Rattus norvegicus transcribed sequences |
| 17779 | 194 | AA891914 | N | | Rattus norvegicus transcribed sequence with moderate similarity to protein |
| | | | | | pir: A47488 (H. sapiens) A47488 aminoacylase (EC 3.5.1.14) - human |
| 17933 | 195 | AA891916 | K | membrane interacting protein of RGS16 | membrane interacting protein of RGS16 |
| 17438 | 196 | AA891943 | M | | Rattus norvegicus transcribed sequences |
| 1159 | 197 | AA891949 | M, N, D, I | | Rattus norvegicus transcribed sequences |
| 4473 | 198 | AA891965 | M, A, D, I | | Rattus norvegicus transcribed sequence with strong similarity to protein |
| | | | | | ref: NP_071297.1 (M. musculus) fructosamine 3 kinase [Mus musculus] |
| 17088 | 199 | AA891998 | B, L | sequestosome 1 | sequestosome 1 |
| 2107 | 200 | AA892006 | D, K | | Rattus norvegicus transcribed sequence with weak similarity to protein |
| | | | | | sp: P50517 (R. norvegicus) VAB2_MOUSE Vacuolar ATP synthase subunit B, |
| | | | | | brain isoform (V-ATPase B2 subunit) (Vacuolar proton pump B isoform 2) |
| | | | | | (Endomembrane proton pump 58 kDa subunit) |
| 17630 | 201 | AA892012 | N | glutamate oxaloacetate transaminase 2 | glutamate oxaloacetate transaminase 2 |
| 17345 | 202 | AA892014 | E | HLA-B-associated transcript 1A | HLA-B-associated transcript 1A |
| 23047 | 203 | AA892027 | M | | Rattus norvegicus transcribed sequences |
| 19252 | 204 | AA892041 | H | peroxiredoxin 6 | peroxiredoxin 6 |
| 13420 | 205 | AA892042 | N | | Rattus norvegicus transcribed sequence with weak similarity to protein |
| | | | | | pir: JC2534 (R. norvegicus) JC2534 RVLG protein - rat |
| 19469 | 206 | AA892112 | M, D | | Rattus norvegicus transcribed sequence with strong similarity to protein |
| | | | | | ref: NP_062419.2 (M. musculus) proline dehydrogenase (oxidase) 2; proline |
| | | | | | oxidase 1; kidney and liver profine oxidase 1 [Mus musculus] |
| 4259 | 207 | AA892123 | N | ribosomal protein L36 | ribosomal protein L36 |
| 14595 | 208 | AA892128 | N, B, L | | Rattus norvegicus transcribed sequences |
| 15576 | 209 | AA892132 | J | | Rattus norvegicus transcribed sequence with moderate similarity to protein |
| | | | | | ref: NP_060937.1 (H. sapiens) uncharacterized hematopoietic stem/progenitor |
| | | | | | cells protein MDS032 [Homo sapiens] |
| 16529 | 210 | AA892154 | N | | Rattus norvegicus transcribed sequence with moderate similarity to protein |
| | | | | | pdb: 1LBG (E. coli) B Chain B, Lactose Operon Repressor Bound To 21-Base |
| | | | | | Pair Symmetric Operator Dna, Alpha Carbons Only |
| 4482 | 211 | AA892173 | N | | Rattus norvegicus transcribed sequence |
| 8317 | 212 | AA892234 | M, N | | Rattus norvegicus transcribed sequence with strong similarity to protein |
| | | | | | ref: NP_079845.1 (M. musculus) microsomal glutathione S-transferase 3 [Mus |
| | | | | | musculus] |
| 4484 | 213 | AA892258 | N | NADPH oxidase 4 | NADPH oxidase 4 |
| 9073 | 214 | AA892273 | J | | Rattus norvegicus transcribed sequences |
| 18190 | 215 | AA892280 | M, N | | Rattus norvegicus transcribed sequences |
| 17717 | 216 | AA892287 | N | | Rattus norvegicus transcribed sequence with weak similarity to protein |
| | | | | | ref: NP_061123.2 (H. sapiens) G protein-coupled receptor, family C, group 5, |
| | | | | | member C, isoform b, precursor; orphan G-protein coupled receptor; retinoic |
| | | | | | acid inducible gene 3 protein; retinoic acid responsive gene protein [Homo |
| | | | | | sapiens] |
| 4373 | 217 | AA892310 | F | | Rattus norvegicus transcribed sequence with strong similarity to protein |
| | | | | | ref: NP_080731.1 (M. musculus) RIKEN cDNA 2510049I19 [Mus musculus] |
| 9027 | 218 | AA892312 | N | potassium inwardly-rectifying channel, subfamily J, | potassium inwardly-rectifying channel, subfamily J, member 16 |
| | | | | member 16 | |
| 17161 | 219 | AA892333 | M | alpha-tubulin | alpha-tubulin |
| 17684 | 220 | AA892345 | M, I | dimethylglycine dehydrogenase precursor | dimethylglycine dehydrogenase precursor |
| 13647 | 221 | AA892367 | N, G | | Rattus norvegicus transcribed sequence with strong similarity to protein |
| | | | | | sp: P21531 (R. norvegicus) RL3_RAT 60S RIBOSOMAL PROTEIN L3 (L4) |
| 19768 | 222 | AA892373 | M, C, G | syntenin | syntenin |
| 3474 | 223 | AA892378 | C | | Rattus norvegicus transcribed sequence with strong similarity to protein |
| | | | | | ref: NP_079838.1 (M. musculus) RIKEN cDNA 2010003O14 [Mus musculus] |
| 17682 | 224 | AA892382 | M, I | camello-like 1 | camello-like 1 |
| 820 | 225 | AA892395 | N | aldolase B | (Rattus norvegicus transcribed sequence with strong similarity to protein |
| | | | | | sp: P00884 (R. norvegicus) ALFB_RAT FRUCTOSE-BISPHOSPHATE |
| | | | | | ALDOLASE B (LIVER-TYPE ALDOLASE), aldolase B) |
| 12016 | 226 | AA892404 | N, C | Na+ dependent glucose transporter 1 | Na+ dependent glucose transporter 1 |
| 23194 | 227 | AA892417 | M | ephrin A1 | ephrin A1 |
| 16469 | 228 | AA892462 | A, C | | Rattus norvegicus transcribed sequence with strong similarity to protein |
| | | | | | ref: NP_079926.1 (M. musculus) RIKEN cDNA 0710008D09 [Mus musculus] |
| 13609 | 229 | AA892468 | M, H, I | protease, serine, 8 (prostasin) | protease, serine, 8 (prostasin) |
| 13610 | 229 | AA892468 | M, A, C, F, H, | protease, serine, 8 (prostasin) | protease, serine, 8 (prostasin) |
| | | | I, K | | |
| 11991 | 230 | AA892483 | B | | Rattus norvegicus transcribed sequences |
| 21695 | 231 | AA892506 | N, G | coronin, actin binding protein 1A | coronin, actin binding protein 1A |
| 4499 | 232 | AA892511 | N | | Rattus norvegicus transcribed sequence with weak similarity to protein |
| | | | | | ref: NP_077053.1 (R. norvegicus) calcium binding protein P22 [Rattus |
| | | | | | norvegicus] |
| 8599 | 233 | AA892522 | M, N, F | | Rattus norvegicus transcribed sequences |
| 15154 | 234 | AA892532 | N | protein disulfide isomerase-related protein | protein disulfide isomerase-related protein |
| 12275 | 235 | AA892541 | N | | Rattus norvegicus transcribed sequences |
| 12276 | 235 | AA892541 | M, N, D, L | | Rattus norvegicus transcribed sequences |
| 17468 | 236 | AA892545 | D | | Rattus norvegicus transcribed sequence with moderate similarity to protein |
| | | | | | ref: NP_032793.1 (M. musculus) organic cationic transporter-like 2 [Mus |
| | | | | | musculus] |
| 17469 | 237 | AA892549 | D | | Rattus norvegicus transcribed sequences |
| 18906 | 238 | AA892561 | M, I | | Rattus norvegicus transcribed sequence with moderate similarity to protein |
| | | | | | ref: NP_054758.1 (H. sapiens) PTD012 protein [Homo sapiens] |
| 18274 | 239 | AA892572 | N | | Rattus norvegicus transcribed sequence with strong similarity to protein |
| | | | | | ref: NP_079639.1 (M. musculus) RIKEN cDNA 1110001J03 [Mus musculus] |
| 18275 | 239 | AA892572 | N, K | | Rattus norvegicus transcribed sequence with strong similarity to protein |
| | | | | | ref: NP_079639.1 (M. musculus) RIKEN cDNA 1110001J03 [Mus musculus] |
| 4512 | 240 | AA892578 | N | | Rattus norvegicus transcribed sequence with strong similarity to protein |
| | | | | | ref: NP_116238.1 (H. sapiens) hypothetical protein FLJ14834 [Homo sapiens] |
| 15876 | 241 | AA892582 | N, G | aldehyde dehydrogenase family 3, member A1 | aldehyde dehydrogenase family 3, member A1 |
| 19085 | 242 | AA892598 | M | nucleostemin | nucleostemin |
| 19086 | 242 | AA892598 | M | nucleostemin | nucleostemin |
| 17500 | 243 | AA892616 | N | solute carrier family 13 (sodium-dependent | solute carrier family 13 (sodium-dependent dicarboxylate transporter), |
| | | | | dicarboxylate transporter), member 3 | member 3 |
| 20088 | 244 | AA892666 | K | | Rattus norvegicus transcribed sequences |
| 23783 | 245 | AA892773 | M, N, I, K | | Rattus norvegicus transcribed sequence with moderate similarity to protein |
| | | | | | pdb: 1LBG (E. coli) B Chain B, Lactose Operon Repressor Bound To 21-Base |
| | | | | | Pair Symmetric Operator Dna, Alpha Carbons Only |
| 19251 | 246 | AA892796 | C | | Rattus norvegicus transcribed sequences |
| 13542 | 247 | AA892798 | N, B | uterine sensitization-associated gene 1 protein | uterine sensitization-associated gene 1 protein |
| 22537 | 248 | AA892799 | M, A, D | | Rattus norvegicus transcribed sequence with weak similarity to protein |
| | | | | | ref: NP_113808.1 (R. norvegicus) 3-phosphoglycerate dehydrogenase [Rattus |
| | | | | | norvegicus] |
| 22538 | 248 | AA892799 | M, D | | Rattus norvegicus transcribed sequence with weak similarity to protein |
| | | | | | ref: NP_113808.1 (R. norvegicus) 3-phosphoglycerate dehydrogenase [Rattus |
| | | | | | norvegicus] |
| 22539 | 248 | AA892799 | M, N | | Rattus norvegicus transcribed sequence with weak similarity to protein |
| | | | | | ref: NP_113808.1 (R. norvegicus) 3-phosphoglycerate dehydrogenase [Rattus |
| | | | | | norvegicus] |
| 15385 | 249 | AA892808 | N | isocitrate dehydrogenase 3, gamma | isocitrate dehydrogenase 3, gamma |
| 408 | 250 | AA892810 | M | low density lipoprotein receptor-related protein | low density lipoprotein receptor-related protein associated protein 1 |
| | | | | associated protein 1 | |
| 4529 | 251 | AA892818 | M | | Rattus norvegicus transcribed sequence with weak similarity to protein |
| | | | | | pir: S54293 (R. norvegicus) S54293 regulator protein p122-RhoGAP - rat |
| 23321 | 252 | AA892821 | M | aldo-keto reductase family 7, member A2 (aflatoxin | aldo-keto reductase family 7, member A2 (aflatoxin aldehyde reductase) |
| | | | | aldehyde reductase) | |
| 23322 | 252 | AA892821 | N | aldo-keto reductase family 7, member A2 (aflatoxin | aldo-keto reductase family 7, member A2 (aflatoxin aldehyde reductase) |
| | | | | aldehyde reductase) | |
| 17332 | 253 | AA892829 | J | | Rattus norvegicus transcribed sequence with strong similarity to protein |
| | | | | | prf: 2204316A (M. musculus) 2204316A ATP sulfurylase-adenosine |
| | | | | | phosphosulfate kinase [Mus musculus] |
| 17923 | 254 | AA892843 | D | | Rattus norvegicus transcribed sequence with moderate similarity to protein |
| | | | | | ref: NP_078816.1 (H. sapiens) hypothetical protein FLJ20917 [Homo sapiens] |
| 18887 | 255 | AA892860 | J | | Rattus norvegicus transcribed sequence with strong similarity to protein |
| | | | | | pir: S25716 (M. musculus) S25716 Ras guanine nucleotide exchange factor |
| | | | | | son-of-sevenless (sos) 1 - mouse |
| 9053 | 256 | AA892861 | M, I | | Rattus norvegicus transcribed sequences |
| 12848 | 257 | AA892916 | N, H, K | | Rattus norvegicus Ab2-305 mRNA, complete cds |
| 3438 | 258 | AA892921 | K | | Rat mRNA fragment with B2 repetitive sequence (clone pAR24) |
| 14465 | 259 | AA892950 | K | | Rattus norvegicus transcribed sequence with moderate similarity to protein |
| | | | | | pdb: 1G5I (M. musculus) A Chain A, Crystal Structure Of The Accessory |
| | | | | | Subunit Of Murine Mitochondrial Polymerase Gamma |
| 3853 | 260 | AA892999 | N, K | | Rattus norvegicus transcribed sequences |
| 3439 | 261 | AA893000 | N, B | | Rattus norvegicus transcribed sequence with strong similarity to protein |
| | | | | | pir: T00335 (H. sapiens) T00335 hypothetical protein KIAA0564 - human |
| | | | | | (fragment) |
| 12020 | 262 | AA693035 | N | HP33 | HP33 |
| 3863 | 263 | AA893060 | C, D | | Rattus norvegicus transcribed sequences |
| 13332 | 264 | AA893080 | M, K | | Rattus norvegicus transcribed sequences |
| 21305 | 265 | AA893082 | M, D, H, I | | Rattus norvegicus transcribed sequences |
| 3870 | 266 | AA893147 | N, F, G | | Rattus norvegicus transcribed sequences |
| 16881 | 267 | AA893185 | J | | Rattus norvegicus transcribed sequence with moderate similarity to protein |
| | | | | | ref: NP_002483.1 (H. sapiens) NADH dehydrogenase (ubiquinone) 1 beta |
| | | | | | subcomplex, 5 (16 kD, SGDH) [Homo sapiens] |
| 17447 | 268 | AA893192 | M | | Rattus norvegicus transcribed sequences |
| 17744 | 269 | AA893206 | M | | Rattus norvegicus transcribed sequence with weak similarity to protein |
| | | | | | ref: NP_062289.1 (M. musculus) nuclear localization signals binding protein 1 |
| | | | | | [Mus musculus] |
| 3878 | 270 | AA893230 | M | | Rattus norvegicus transcribed sequence with weak similarity to protein |
| | | | | | sp: P02593 (R. norvegicus) CALM_HUMAN Calmodulin |
| 548 | 271 | AA893235 | N | | Rattus norvegicus transcribed sequence with strong similarity to protein |
| | | | | | sp: Q61585 (M. musculus) G0S2_MOUSE Putative lymphocyte G0/G1 switch |
| | | | | | protein 2 (G0S2-like protein) |
| 17752 | 272 | AA893244 | N | | Rattus norvegicus transcribed sequences |
| 18967 | 273 | AA893260 | N, H | | Rattus norvegicus transcribed sequence with weak similarity to protein |
| | | | | | ref: NP_083358.1 (M. musculus) RIKEN cDNA 5830411J07 [Mus musculus] |
| 16168 | 274 | AA893280 | M, J | | Rattus norvegicus transcribed sequence with weak similarity to protein |
| | | | | | sp: P43884 (R. norvegicus) PLIN_RAT Perilipin (PERI) (Lipid droplet- |
| | | | | | associated protein) |
| 3886 | 275 | AA893289 | J | | Rattus norvegicus transcribed sequence with moderate similarity to protein |
| | | | | | pdb: 1LBG (E. coli) B Chain B, Lactose Operon Repressor Bound To 21-Base |
| | | | | | Pair Symmetric Operator Dna, Alpha Carbons Only |
| 4242 | 276 | AA893325 | N | ornithine aminotransferase | ornithine aminotransferase |
| 9082 | 277 | AA893357 | M | | Rattus norvegicus transcribed sequences |
| 17800 | 278 | AA893436 | K | | Rattus norvegicus transcribed sequences |
| 3465 | 279 | AA893611 | M, B, F | | Rattus norvegicus transcribed sequence with moderate similarity to protein |
| | | | | | sp: O09015 (R. norvegicus) MXI1_RAT MAX interacting protein 1 (MXI1 |
| | | | | | protein) |
| 17836 | 280 | AA893626 | D | | Rattus norvegicus transcribed sequence with weak similarity to protein |
| | | | | | ref: NP_112249.1 (R. norvegicus) guanine nucleotide-binding protein, beta-1# |
| | | | | | subunit [Rattus norvegicus] |
| 4542 | 281 | AA893643 | C | | Rattus norvegicus transcribed sequence with weak similarity to protein |
| | | | | | ref: NP_113981.1 (R. norvegicus) matrin cyclophilin (matrin-cyp) [Rattus |
| | | | | | norvegicus] |
| 7505 | 282 | AA893702 | N, A | transcobalamin II precursor | transcobalamin II precursor |
| 9084 | 283 | AA893717 | N, E | | Rattus norvegicus transcribed sequence with strong similarity to protein |
| | | | | | ref: NP_036155.1 (M. musculus) Rac GTPase-activating protein 1 [Mus |
| | | | | | musculus] |
| 12031 | 284 | AA893860 | M, I | | Rattus norvegicus transcribed sequence with strong similarity to protein |
| | | | | | ref: NP_149065.1 (M. musculus) hypothetical protein D15Wsu59e [Mus |
| | | | | | musculus] |
| 2128 | 285 | AA894008 | B | | Rattus norvegicus transcribed sequence with moderate similarity to protein |
| | | | | | ref: NP_446379.1 (R. norvegicus) erythrocyte protein band 4.1-like 3 [Rattus |
| | | | | | norvegicus] |
| 10540 | 286 | AA894027 | N | | |
| 3895 | 287 | AA894029 | N | | Rattus norvegicus transcribed sequences |
| 2191 | 288 | AA894086 | F | | Rattus norvegicus Ac1133 mRNA, complete cds |
| 2979 | 289 | AA894099 | H | vacuolar protein sorting protein 4a | vacuolar protein sorting protein 4a |
| 16435 | 290 | AA894174 | N | | Rattus norvegicus transcribed sequence with strong similarity to protein |
| | | | | | pir: A31568 (R. norvegicus) A31568 electron transfer flavoprotein alpha chain |
| | | | | | precursor - rat |
| 22783 | 291 | AA894207 | A, F | | Rattus norvegicus focal adhesion kinase (FAK) mRNA, alternative 5′UTR |
| 16849 | 292 | AA894298 | N | membrane metallo endopeptidase | membrane metallo endopeptidase |
| 21587 | 293 | AA899141 | D | 3-phosphoglycerate dehydrogenase | 3-phosphoglycerate dehydrogenase |
| 24329 | 294 | AA899253 | N | myristoylated alanine rich protein kinase C substrate | myristoylated alanine rich protein kinase C substrate |
| 22490 | 295 | AA899289 | A | | Rattus norvegicus transcribed sequence with strong similarity to protein |
| | | | | | ref: NP_055787.1 (H. sapiens) KIAA1049 protein [Homo sapiens] |
| 4661 | 296 | AA899709 | M, B, L | receptor (calcitonin) activity modifying protein 3 | receptor (calcitonin) activity modifying protein 3 |
| 21354 | 297 | AA899721 | B, L | | Rattus norvegicus transcribed sequences |
| 23778 | 298 | AA899854 | N, E | topoisomerase (DNA) 2 alpha | topoisomerase (DNA) 2 alpha |
| 9114 | 299 | AA899951 | M | | Rattus norvegicus transcribed sequences |
| 9541 | 300 | AA900505 | N, L | rhoB gene | rhoB gene |
| 3822 | 301 | AA900863 | M, H | | Rattus norvegicus transcribed sequence with weak similarity to protein |
| | | | | | sp: Q63413 (R. norvegicus) HE47_RAT Probable ATP-dependent RNA |
| | | | | | helicase p47 |
| 3959 | 302 | AA901338 | M | | Rattus norvegicus transcribed sequence with weak similarity to protein |
| | | | | | pir: A47305 (R. norvegicus) A47305 translation initiation factor eIF-5 - rat |
| 12355 | 303 | AA923857 | D | Carcinoembryonic antigen gene family (CGM3) | Carcinoembryonic antigen gene family (CGM3) |
| 6736 | 304 | AA924005 | C | | Rattus norvegicus transcribed sequence with moderate similarity to protein |
| | | | | | ref: NP_034081.1 (M. musculus) insulin-like growth factor 2, binding protein 1; |
| | | | | | coding region determinant binding protein; zipcode-binding protein 1; zipcode |
| | | | | | binding protein 1 [Mus musculus] |
| 17477 | 305 | AA924029 | M, K, L | phospholipid scramblase 1 | phospholipid scramblase 1 |
| 24192 | 306 | AA924210 | H | 3-hydroxy-3-methylglutaryl-Coenzyme A reductase | 3-hydroxy-3-methylglutaryl-Coenzyme A reductase |
| 20711 | 307 | AA924267 | N, L | cytochrome P450, 4A1 | cytochrome P450, 4A1 |
| 4933 | 308 | AA924301 | M, A | | Rattus norvegicus transcribed sequences |
| 23093 | 309 | AA924342 | G | | Rattus norvegicus transcribed sequence with strong similarity to protein |
| | | | | | ref: NP_064571.1 (H. sapiens) DC11 protein [Homo sapiens] |
| 4944 | 310 | AA924405 | M, H, I, K | | Rattus norvegicus transcribed sequence with weak similarity to protein |
| | | | | | ref: NP_068522.1 (R. norvegicus) Nopp140 associated protein [Rattus |
| | | | | | norvegicus] |
| 3631 | 311 | AA924460 | D | | Rattus norvegicus transcribed sequence with weak similarity to protein |
| | | | | | sp: Q9JHI7 (M. musculus) PMC1_MOUSE Polymyositis/scleroderma |
| | | | | | autoantigen 1 (Autoantigen PM/Scl 1) (Polymyositis/scleroderma autoantigen |
| | | | | | 75 kDa) (PM/Scl-75) (P75 polymyositis-scleroderma overlap syndrome |
| | | | | | associated autoantigen) |
| 22984 | 312 | AA924560 | E | | Rattus norvegicus transcribed sequence with strong similarity to protein |
| | | | | | pir: T12449 (H. sapiens) T12449 hypothetical protein DKFZp564E1616.1 - |
| | | | | | human (fragments) |
| 22540 | 313 | AA924630 | E | | Rattus norvegicus transcribed sequence with weak similarity to protein |
| | | | | | ref: NP_113808.1 (R. norvegicus) 3-phosphoglycerate dehydrogenase [Rattus |
| | | | | | norvegicus] |
| 23123 | 314 | AA924794 | K | | Rattus norvegicus transcribed sequence with weak similarity to protein |
| | | | | | sp: Q9Z1P2 (R. norvegicus) AAC1_RAT Alpha-actinin 1 (Alpha-actinin |
| | | | | | cytoskeletal isoform) (Non-muscle alpha-actinin 1) (F-actin cross linking |
| | | | | | protein) |
| 23195 | 315 | AA925026 | M | | Rattus norvegicus transcribed sequence with weak similarity to protein |
| | | | | | sp: P27435 (R. norvegicus) MCT7_RAT Mast cell protease 7 precursor (RMCP- |
| | | | | | 7) (Tryptase, skin) |
| 21458 | 316 | AA925049 | M | | Rattus norvegicus transcribed sequence with strong similarity to protein |
| | | | | | pdb: 1BGM (E. coli) O Chain O, Beta-Galactosidase (Chains I-P) |
| 14790 | 317 | AA925087 | M | | Rattus norvegicus transcribed sequences |
| 23261 | 318 | AA925145 | M, I | | Rattus norvegicus transcribed sequence with weak similarity to protein |
| | | | | | ref: NP_110477.1 (R. norvegicus) betaine-homocysteine methyltransferase |
| | | | | | [Rattus norvegicus] |
| 17363 | 319 | AA925150 | F, K | | Rattus norvegicus transcribed sequence with weak similarity to protein |
| | | | | | prf: 2118320A (R. norvegicus) 2118320A neurodegeneration-associated |
| | | | | | protein 1 [Rattus norvegicus] |
| 18271 | 320 | AA925267 | M, I | | Rattus norvegicus transcribed sequence with moderate similarity to protein |
| | | | | | ref: NP_055993.1 (H. sapiens) KIAA0717 protein [Homo sapiens] |
| 5129 | 321 | AA925335 | J | | Rattus norvegicus transcribed sequences |
| 23978 | 322 | AA925352 | M, L | | Rattus norvegicus transcribed sequences |
| 22479 | 323 | AA925418 | B, L | | Rattus norvegicus transcribed sequences |
| 17514 | 324 | AA925554 | E, G | succinate dehydrogenase complex, subunit A, | succinate dehydrogenase complex, subunit A, flavoprotein (Fp) |
| | | | | flavoprotein (Fp) | |
| 5183 | 325 | AA925662 | L | | Rattus norvegicus transcribed sequence with weak similarity to protein |
| | | | | | sp: Q9JK41 (R. norvegicus) COP1_RAT High-affinity copper uptake protein 1 |
| | | | | | (rCTR1) (Copper transporter 1) |
| 5205 | 326 | AA925747 | K | | Rattus norvegicus transcribed sequences |
| 5206 | 327 | AA925755 | E | glutaminase | glutaminase |
| 20866 | 328 | AA926098 | J | | Rattus norvegicus transcribed sequence with moderate similarity to protein |
| | | | | | ref: NP_444278.1 (H. sapiens) mitochondrial ribosomal protein L53 [Homo |
| | | | | | sapiens] |
| 17157 | 329 | AA926129 | M, N | | Rattus norvegicus transcribed sequence with strong similarity to protein |
| | | | | | ref: NP_446139.1 (R. norvegicus) schlafen 4 [Rattus norvegicus] |
| 16468 | 330 | AA926137 | N, A | | Rattus norvegicus transcribed sequence with strong similarity to protein |
| | | | | | ref: NP_079926.1 (M. musculus) RIKEN cDNA 0710008D09 [Mus musculus] |
| 13411 | 331 | AA926196 | M | | Rattus norvegicus transcribed sequences |
| 5295 | 332 | AA926247 | M, L | putative potassium channel TWIK | putative potassium channel TWIK |
| 21513 | 333 | AA926261 | H | | Rattus norvegicus transcribed sequences |
| 22928 | 334 | AA926262 | M | neuronal regeneration related protein | neuronal regeneration related protein |
| 894 | 335 | AA926305 | E | | Rattus norvegicus transcribed sequences |
| 15028 | 336 | AA942685 | N, F | cytosolic cysteine dioxygenase 1 | cytosolic cysteine dioxygenase 1 |
| 6039 | 337 | AA942716 | M, G | | Rattus norvegicus HN1 mRNA, complete cds |
| 23005 | 338 | AA942770 | I | | Rattus norvegicus transcribed sequences |
| 21318 | 339 | AA942774 | M | | Rattus norvegicus transcribed sequences |
| 18168 | 340 | AA942995 | E | | Rattus norvegicus transcribed sequence with weak similarity to protein |
| | | | | | pir: T14346 (M. musculus) T14346 herc2 protein - mouse |
| 6691 | 341 | AA943028 | J | | Rattus norvegicus transcribed sequence with strong similarity to protein |
| | | | | | pir: S16385 (R. norvegicus) S16385 macrophage colony-stimulating factor 1 |
| | | | | | receptor precursor - rat |
| 22180 | 342 | AA943202 | D | | Rattus norvegicus transcribed sequence with strong similarity to protein |
| | | | | | ref: NP_445869.1 (R. norvegicus) GRB2-associated binding protein 2 [Rattus |
| | | | | | norvegicus] |
| 21990 | 343 | AA943524 | C | | Rattus norvegicus transcribed sequences |
| 12673 | 344 | AA943773 | D, L | | Rattus norvegicus transcribed sequence with moderate similarity to protein |
| | | | | | sp: P43406 (M. musculus) ITAV_MOUSE Integrin alpha-V precursor |
| | | | | | (Vitronectin receptor alpha subunit) (CD51) |
| 18285 | 345 | AA943791 | F | | Rattus norvegicus transcribed sequences |
| 21696 | 346 | AA944324 | N, C | ADP-ribosylation factor 6 | ADP-ribosylation factor 6 |
| 22681 | 347 | AA944413 | M, I | | |
| 6711 | 348 | AA944439 | M | | Rattus norvegicus transcribed sequence with strong similarity to protein |
| | | | | | sp: Q9JHN8 (M. musculus) ST19_MOUSE Serine/threonine-protein kinase 19 |
| | | | | | (RP1 protein) |
| 14763 | 349 | AA944481 | L | | Rattus norvegicus transcribed sequence with weak similarity to protein |
| | | | | | sp: P57756 (R. norvegicus) FCN2_RAT Ficolin 2 precursor (Collagen/fibrinogen |
| | | | | | domain-containing protein 2) (Ficolin-B) (Ficolin B) (Serum lectin P35) (EBP- |
| | | | | | 37) (Hucolin) |
| 22536 | 350 | AA944803 | K | | R. norvegicus mRNA for parathyroid hormone regulated sequence (202 bp) |
| 22501 | 351 | AA944811 | H | putative zinc finger protein SERZ-1 | putative zinc finger protein SERZ-1 |
| 11974 | 352 | AA944958 | M | | R. norvegicus mRNA for 3′UTR of CDK6 (unknown) protein |
| 22554 | 353 | AA945076 | M, I | glycerol kinase | glycerol kinase |
| 1798 | 354 | AA945569 | M, D | pregnancy-zone protein | pregnancy-zone protein |
| 15175 | 355 | AA945583 | E | hydroxysteroid (17-beta) dehydrogenase 10 | hydroxysteroid (17-beta) dehydrogenase 10 |
| 20812 | 356 | AA945611 | N | ribosomal protein L10 | ribosomal protein L10 |
| 22612 | 357 | AA945624 | M, I | | Rattus norvegicus transcribed sequence with weak similarity to protein |
| | | | | | pir: A34162 (R. norvegicus) A34162 NAD(P)H dehydrogenase (quinone) (EC |
| | | | | | 1.6.99.2) - rat |
| 22618 | 358 | AA945656 | E | | Rattus norvegicus transcribed sequences |
| 22625 | 359 | AA945704 | H | | Rattus norvegicus transcribed sequences |
| 22656 | 360 | AA945818 | M, H | | Rattus norvegicus transcribed sequence with strong similarity to protein |
| | | | | | ref: NP_064624.1 (H. sapiens) small protein effector 1 of Cdc42 [Homo |
| | | | | | sapiens] |
| 22351 | 361 | AA945867 | N | v-jun sarcoma virus 17 oncogene homolog (avian) | v-jun sarcoma virus 17 oncogene homolog (avian) |
| 5565 | 362 | AA945879 | M, C | Bardet-Biedl syndrome 2 (human) | Bardet-Biedl syndrome 2 (human) |
| 21976 | 363 | AA946011 | B | | Rattus norvegicus transcribed sequences |
| 18524 | 364 | AA946017 | D | | Rattus norvegicus transcribed sequences |
| 20832 | 365 | AA946040 | A | | Rattus norvegicus transcribed sequence with strong similarity to protein |
| | | | | | ref: NP_079904.1 (M. musculus) RIKEN cDNA 2010000G05 [Mus musculus] |
| 18337 | 366 | AA946046 | M, I | | Rattus norvegicus transcribed sequences |
| 825 | 367 | AA946108 | M, A | laminin 5 alpha 3 | laminin 5 alpha 3 |
| 21157 | 368 | AA946189 | I | | Rattus norvegicus transcribed sequence with strong similarity to protein |
| | | | | | pir: A36983 (M. musculus) A36983 RNA1 homolog fug1 - mouse |
| 22770 | 369 | AA946428 | D | | Rattus norvegicus transcribed sequences |
| 12331 | 370 | AA946466 | M, H | X-prolyl aminopeptidase (aminopeptidase P) 2, | X-prolyl aminopeptidase (aminopeptidase P) 2, membrane-bound |
| | | | | membrane-bound | |
| 12332 | 370 | AA946466 | M, G | X-prolyl aminopeptidase (aminopeptidase P) 2, | X-prolyl aminopeptidase (aminopeptidase P) 2, membrane-bound |
| | | | | membrane-bound | |
| 17499 | 371 | AA946467 | M | | Rattus norvegicus transcribed sequences |
| 1809 | 372 | AA946503 | G, K | lipocalin 2 | lipocalin 2 |
| 9452 | 373 | AA955206 | M | fibrinogen-like 2 | fibrinogen-like 2 |
| 23512 | 374 | AA955282 | M | | Rattus norvegicus transcribed sequences |
| 22596 | 375 | AA955298 | M | | Rattus norvegicus transcribed sequence with weak similarity to protein |
| | | | | | ref: NP_072143.1 (R. norvegicus) nucleolin-related protein NRP (NRP) [Rattus |
| | | | | | norvegicus] |
| 19347 | 376 | AA955334 | D | | |
| 23532 | 377 | AA955347 | E | | |
| 23533 | 378 | AA955350 | E | | Rattus norvegicus transcribed sequences |
| 23546 | 379 | AA955393 | I | | Rattus norvegicus transcribed sequences |
| 23626 | 380 | AA955540 | D | | Rattus norvegicus transcribed sequences |
| 23718 | 381 | AA955790 | A | unr protein | unr protein |
| 498 | 382 | AA956278 | M | | Rattus norvegicus transcribed sequences |
| 23758 | 383 | AA956414 | C, G | | Rattus norvegicus transcribed sequence with weak similarity to protein |
| | | | | | pir: B34252 (R. norvegicus) B34252 acyl-CoA dehydrogenase (EC 1.3.99.3) |
| | | | | | short-chain-specific precursor, hepatic - rat |
| 23790 | 384 | AA956499 | D | | Rattus norvegicus transcribed sequence with strong similarity to protein |
| | | | | | ref: NP_060640.1 (H. sapiens) hypothetical protein FLJ10656 [Homo sapiens] |
| 19936 | 385 | AA956517 | D | ceroid-lipofuscinosis, neuronal 2 | ceroid-lipofuscinosis, neuronal 2 |
| 23834 | 386 | AA956659 | C | | Rattus norvegicus transcribed sequences |
| 23839 | 387 | AA956684 | D | | Rattus norvegicus transcribed sequences |
| 18288 | 388 | AA956813 | C | | Rattus norvegicus transcribed sequence with moderate similarity to protein |
| | | | | | pir: JC4761 (M. musculus) JC4761 recombination activating gene 1 inducing |
| | | | | | protein - mouse |
| 5990 | 389 | AA956907 | M | | Rattus norvegicus transcribed sequence with weak similarity to protein |
| | | | | | ref: NP_113997.1 (R. norvegicus) cyclic nucleotide-gated channel beta subunit |
| | | | | | 1 [Rattus norvegicus] |
| 23957 | 390 | AA957123 | M | | Rattus norvegicus transcribed sequence with moderate similarity to protein |
| | | | | | ref: NP_033879.1 (M. musculus) brain expressed X-linked 2 [Mus musculus] |
| 23958 | 391 | AA957125 | E | | Rattus norvegicus transcribed sequences |
| 16731 | 392 | AA957244 | D | | |
| 23314 | 393 | AA957270 | H, I | tumor necrosis factor receptor superfamily, member | tumor necrosis factor receptor superfamily, member 12a |
| | | | | 12a | |
| 2702 | 394 | AA957307 | M, I, J | | Rattus norvegicus transcribed sequence with strong similarity to protein |
| | | | | | sp: P26638 (M. musculus) SYS_MOUSE Seryl-tRNA synthetase (Serine - tRNA |
| | | | | | ligase) (SerRS) |
| 23843 | 395 | AA957410 | D | | Rattus norvegicus transcribed sequences |
| 24051 | 396 | AA957452 | J | | Rattus norvegicus transcribed sequence |
| 17523 | 397 | AA963240 | D | | Rattus norvegicus transcribed sequences |
| 24246 | 398 | AA963703 | H | | |
| 2195 | 399 | AA963746 | M | | Rattus norvegicus transcribed sequences |
| 9309 | 400 | AA963794 | E | | Rattus norvegicus transcribed sequence with weak similarity to protein |
| | | | | | sp: Q09167 (R. norvegicus) SFR5_RAT Splicing factor, arginine/serine-rich 5 |
| | | | | | (Pre-mRNA splicing factor SRP40) (Insulin-induced growth response protein |
| | | | | | CL-4) (Delayed-early protein HRS) |
| 2232 | 401 | AA963990 | D | | Rattus norvegicus transcribed sequences |
| 2282 | 402 | AA964147 | F | | Rattus norvegicus transcribed sequences |
| 2113 | 403 | AA964275 | D | | Rattus norvegicus transcribed sequence with weak similarity to protein |
| | | | | | ref: NP_079792.1 (M. musculus) serologically defined breast cancer antigen |
| | | | | | 84 [Mus musculus] |
| 2423 | 404 | AA964611 | D | | Rattus norvegicus transcribed sequences |
| 2457 | 405 | AA964752 | L | | Rattus norvegicus transcribed sequence with weak similarity to protein |
| | | | | | sp: P97852 (R. norvegicus) DHB4_RAT Estradiol 17 beta-dehydrogenase 4 (17- |
| | | | | | beta-HSD 4) (17-beta-hydroxysteroid dehydrogenase 4) (HSD IV) |
| 24233 | 406 | AA964756 | F | centrin 2 | centrin 2 |
| 12561 | 407 | AA964815 | M, C | | Rattus norvegicus transcribed sequences |
| 11324 | 408 | AA964832 | J, L | | |
| 21339 | 409 | AA964962 | J, L | ATP-binding cassette, sub-family A (ABC1), member 1 | ATP-binding cassette, sub-family A (ABC1), member 1 |
| 2563 | 410 | AA965113 | K | | Rattus norvegicus transcribed sequence with strong similarity to protein |
| | | | | | ref: NP_080588.1 (M. musculus) RIKEN cDNA 2610029G23 [Mus musculus] |
| 2569 | 411 | AA965122 | K | | Rattus norvegicus transcribed sequence with strong similarity to protein |
| | | | | | ref: NP_035433.1 (M. musculus) retinal short-chain dehydrogenase/reductase |
| | | | | | 1 [Mus musculus] |
| 645 | 412 | AA965132 | G, K | solute carrier family 12, member 3 | solute carrier family 12, member 3 |
| 2905 | 413 | AA996727 | M | | Rattus norvegicus transcribed sequences |
| 2964 | 414 | AA996954 | F | | Rattus norvegicus transcribed sequences |
| 20694 | 415 | AA997048 | M, I | | Rattus norvegicus transcribed sequences |
| 3145 | 416 | AA997237 | D | | Rattus norvegicus transcribed sequences |
| 3172 | 417 | AA997406 | B | | Rattus norvegicus transcribed sequence with strong similarity to protein |
| | | | | | sp: P48004 (R. norvegicus) PSA7_RAT Proteasome subunit alpha type 7 |
| | | | | | (Proteasome subunit RC6-1) |
| 12616 | 418 | AA997599 | E | | Rattus norvegicus transcribed sequences |
| 3020 | 419 | AA997656 | L | | Rattus norvegicus transcribed sequences |
| 3053 | 420 | AA997726 | H | | Rattus norvegicus transcribed sequence with strong similarity to protein |
| | | | | | sp: Q14690 (H. sapiens) RRP5_HUMAN RRP5 protein homolog (Fragment) |
| 3269 | 421 | AA997800 | E | | Rattus norvegicus transcribed sequence with moderate similarity to protein |
| | | | | | pir: T30249 (M. musculus) T30249 cell proliferation antigen Ki-67 - mouse |
| 20035 | 422 | AA997933 | M, H | Nopp140 associated protein | Nopp140 associated protein |
| 3407 | 423 | AA997953 | F | TCF3 (E2A) fusion partner (in childhood leukemia) | TCF3 (E2A) fusion partner (in childhood leukemia) |
| 21959 | 424 | AA997973 | D, E | core binding factor beta | core binding factor beta |
| 16625 | 425 | AA998062 | D | | Rattus norvegicus transcribed sequence with weak similarity to protein |
| | | | | | ref: NP_034202.1 (M. musculus) dolichol-phosphate (beta-D) |
| | | | | | mannosyltransferase 1 [Mus musculus] |
| 3572 | 426 | AA998516 | E | | Rattus norvegicus transcribed sequence with weak similarity to protein |
| | | | | | sp: P30277 (R. norvegicus) CGB1_RAT G2/mitotic-specific cyclin B1 |
| 2782 | 427 | AA998565 | J | cyclin-dependent kinase inhibitor 1C, p57 | cyclin-dependent kinase inhibitor 1C, p57 |
| 22737 | 428 | AA998660 | L | | Rattus norvegicus transcribed sequence with weak similarity to protein |
| | | | | | ref: NP_446222.1 (R. norvegicus) Arg/Abl-interacting protein ArgBP2 [Rattus |
| | | | | | norvegicus] |
| 17734 | 429 | AA998683 | M, C, I | heat shock 27 kDa protein 1 | heat shock 27 kDa protein 1 |
| 11558 | 430 | AA998894 | D | | Rattus norvegicus transcribed sequence with strong similarity to protein |
| | | | | | ref: NP_079615.1 (M. musculus) RIKEN cDNA 0610027O18 [Mus musculus] |
| 3069 | 431 | AA998910 | G | | Rattus norvegicus transcribed sequence with strong similarity to protein |
| | | | | | ref: NP_109674.1 (M. musculus) endoplasmic reticulum chaperone SIL1 |
| | | | | | homolog (S. cerevisiae) [Mus musculus] |
| 3079 | 432 | AA999169 | M | | |
| 21211 | 433 | AB000098 | C | MIPP65 protein | MIPP65 protein |
| 1962 | 434 | AB000199 | J | CCA2 protein | CCA2 protein |
| 1509 | 435 | AB000507 | N, A | aquaporin 7 | aquaporin 7 |
| 17337 | 436 | AB000717 | N | | |
| 1535 | 437 | AB000778 | F | phospholipase D gene 1 | phospholipase D gene 1 |
| 1382 | 438 | AB002406 | G | ruvB-like protein 1 | ruvB-like protein 1 |
| 7914 | 439 | AB002584 | N | beta-alanine-pyruvate aminotransferase | beta-alanine-pyruvate aminotransferase |
| 1510 | 440 | AB004559 | M, D, K | solute carrier family 22 (organic anion transporter), | solute carrier family 22 (organic anion transporter), member 6 |
| | | | | member 6 | |
| 20708 | 441 | AB006461 | A | neurochondrin | neurochondrin |
| 3512 | 442 | AB006607 | F | choline/ethanolamine kinase | choline/ethanolamine kinase |
| 15750 | 443 | AB007690 | H | homer, neuronal immediate early gene, 2 | homer, neuronal immediate early gene, 2 |
| 15703 | 444 | AB009372 | N | lysophospholipase | lysophospholipase |
| 15662 | 445 | AB010119 | N, G | t-complex testis expressed 1 | t-complex testis expressed 1 |
| 1857 | 446 | AB010428 | L | cytosolic acyl-CoA thioesterase 1 | cytosolic acyl-CoA thioesterase 1 |
| 15701 | 447 | AB010467 | A, I | ATP-binding cassette, sub-family C (CFTR/MRP), | ATP-binding cassette, sub-family C (CFTR/MRP), member 3 |
| | | | | member 3 | |
| 4312 | 448 | AB010635 | N, J | carboxylesterase 2 (intestine, liver) | carboxylesterase 2 (intestine, liver) |
| 13973 | 449 | AB011679 | N, E | tubulin, beta 5 | tubulin, beta 5 |
| 1422 | 450 | AB012759 | M, B, G, L | prolyl endopeptidase | prolyl endopeptidase |
| 15926 | 451 | AB012933 | D | fatty acid Coenzyme A ligase, long chain 5 | fatty acid Coenzyme A ligase, long chain 5 |
| 20457 | 452 | AB012944 | M, B, K, L | parathyroid hormone receptor | parathyroid hormone receptor |
| 18300 | 453 | AB013453 | M, H, I, L | | Rattus norvegicus mRNA for NaPi-2 alpha, complete cds |
| 18075 | 454 | AB013455 | N | solute carrier family 34, member 1 | solute carrier family 34, member 1 |
| 18076 | 454 | AB013455 | N | solute carrier family 34, member 1 | solute carrier family 34, member 1 |
| 18597 | 455 | AB013732 | N, B, H | UDP-glucose dehydrogeanse | UDP-glucose dehydrogeanse |
| 2632 | 456 | AB016489 | A, D | jumping translocation breakpoint | jumping translocation breakpoint |
| 4234 | 457 | AB016536 | N, K | (argininosuccinate lyase, heterogeneous nuclear | (argininosuccinate lyase, heterogeneous nuclear ribonucleoprotein A/B) |
| | | | | ribonucleoprotein A/B) | |
| 23625 | 458 | AB017260 | N, D | solute carrier family 22, member 5 | solute carrier family 22, member 5 |
| 15242 | 459 | AB017912 | D | MAD homolog 2 (Drosophila) | MAD homolog 2 (Drosophila) |
| 15243 | 459 | AB017912 | N | MAD homolog 2 (Drosophila) | MAD homolog 2 (Drosophila) |
| 954 | 460 | AF000114 | B | contactin associated protein 1 | contactin associated protein 1 |
| 1727 | 461 | AF001417 | M | core promoter element binding protein | core promoter element binding protein |
| 18070 | 462 | AF003008 | M, N | max interacting protein 1 | max interacting protein 1 |
| 1511 | 463 | AF004017 | D | solute carrier family 4, member 4 | solute carrier family 4, member 4 |
| 7488 | 464 | AF007758 | N | synuclein, alpha | synuclein, alpha |
| 7489 | 464 | AF007758 | M, G, I, J, L | synuclein, alpha | synuclein, alpha |
| 1183 | 465 | AF013144 | N | MAP-kinase phosphatase (cpg21) | MAP-kinase phosphatase (cpg21) |
| 1081 | 466 | AF013145 | M, D | PDZ domain containing 1 | PDZ domain containing 1 |
| 19254 | 467 | AF014009 | H | peroxiredoxin 6 | peroxiredoxin 6 |
| 1597 | 468 | AF014503 | L | nuclear protein 1 | nuclear protein 1 |
| 18074 | 469 | AF015305 | K | solute carrier family 29, member 2 | solute carrier family 29, member 2 |
| 11483 | 470 | AF020618 | M, I | myeloid differentiation primary response gene 116 | myeloid differentiation primary response gene 116 |
| 18043 | 470 | AF020618 | F | myeloid differentiation primary response gene 116 | myeloid differentiation primary response gene 116 |
| 16407 | 471 | AF022247 | N | cubilin | cubilin |
| 19665 | 472 | AF022819 | D, L | putative potassium channel TWIK | putative potassium channel TWIK |
| 25165 | 473 | AF022952 | N | vascular endothelial growth factor B | vascular endothelial growth factor B |
| 23868 | 474 | AF023087 | M, L | early growth response 1 | early growth response 1 |
| 16116 | 475 | AF025670 | F | caspase 6 | caspase 6 |
| 25168 | 476 | AF030050 | A | replication factor C | replication factor C |
| 3454 | 477 | AF030091 | N, J | cyclin L | cyclin L |
| 15790 | 478 | AF032120 | E | regulator of G-protein signaling 19 interacting protein 1 | regulator of G-protein signaling 19 interacting protein 1 |
| 2439 | 479 | AF032668 | A, F | SEC15 homolog (S. cerevisiae) | SEC15 homolog (S. cerevisiae) |
| 23045 | 480 | AF034218 | N | hyaluronidase 2 | hyaluronidase 2 |
| 15800 | 481 | AF035822 | A | synaptosomal-associated protein, 29 kD | synaptosomal-associated protein, 29 kD |
| 1564 | 482 | AF035963 | E, G, K | kidney injury molecule 1 | kidney injury molecule 1 |
| 8426 | 483 | AF036335 | N, E, F | NonO/p54nrb homolog | NonO/p54nrb homolog |
| 17326 | 484 | AF036548 | N | Rgc32 protein | Rgc32 protein |
| 17327 | 484 | AF036548 | N | Rgc32 protein | Rgc32 protein |
| 15008 | 485 | AF038591 | E | cytoplasmic aminopeptidase P | cytoplasmic aminopeptidase P |
| 21491 | 486 | AF040954 | B | putative protein phosphatase 1 nuclear targeting | putative protein phosphatase 1 nuclear targeting subunit |
| | | | | subunit | |
| 22602 | 487 | AF044574 | M | 2-4-dienoyl-Coenzyme A reductase 2, peroxisomal | 2-4-dienoyl-Coenzyme A reductase 2, peroxisomal |
| 22603 | 487 | AF044574 | N | 2-4-dienoyl-Coenzyme A reductase 2, peroxisomal | 2-4-dienoyl-Coenzyme A reductase 2, peroxisomal |
| 20864 | 488 | AF045464 | N, B, J | aflatoxin B1 aldehyde reductase | aflatoxin B1 aldehyde reductase |
| 10241 | 489 | AF048687 | N, C, K | UDP-Gal: betaGlcNAc beta 1,4-galactosyltransferase, | UDP-Gal: betaGlcNAc beta 1,4-galactosyltransferase, polypeptide 6 |
| | | | | polypeptide 6 | |
| 117 | 490 | AF049239 | N | sodium channel, voltage-gated, type 8, alpha | sodium channel, voltage-gated, type 8, alpha polypeptide |
| | | | | polypeptide | |
| 16649 | 491 | AF051895 | M, N, E | annexin 5 | annexin 5 |
| 985 | 492 | AF053312 | N | small inducible cytokine subfamily A20 | small inducible cytokine subfamily A20 |
| 19058 | 493 | AF054618 | E | cortactin isoform B | cortactin isoform B |
| 11843 | 494 | AF054826 | A | vesicle-associated membrane protein 5 | vesicle-associated membrane protein 5 |
| 17324 | 495 | AF056031 | M | kynurenine 3-hydroxylase | kynurenine 3-hydroxylase |
| 4011 | 496 | AF056333 | N, J | cytochrome P450, subfamily 2E, polypeptide 1 | cytochrome P450, subfamily 2E, polypeptide 1 |
| 1104 | 497 | AF058714 | N | solute carrier family 13, member 2 | solute carrier family 13, member 2 |
| 4589 | 498 | AF062389 | M, N, D | kidney-specific protein (KS) | kidney-specific protein (KS) |
| 16006 | 499 | AF062594 | M | nucleosome assembly protein 1-like 1 | nucleosome assembly protein 1-like 1 |
| 16007 | 499 | AF062594 | N, E | nucleosome assembly protein 1-like 1 | nucleosome assembly protein 1-like 1 |
| 15761 | 500 | AF062741 | B | pyruvate dehydrogenase phosphatase isoenzyme 2 | pyruvate dehydrogenase phosphatase isoenzyme 2 |
| 4327 | 501 | AF063447 | M, G, I | nuclear RNA helicase, DECD variant of DEAD box | nuclear RNA helicase, DECD variant of DEAD box family |
| | | | | family | |
| 16444 | 502 | AF065438 | N | peptidylprolyl isomerase C-associated protein | peptidylprolyl isomerase C-associated protein |
| 16155 | 503 | AF068860 | N | defensin beta 1 | defensin beta 1 |
| 25198 | 504 | AF069782 | M, N, I, K | Nopp140 associated protein | Nopp140 associated protein |
| 17426 | 505 | AF073839 | C | dynein-associated protein RKM23 | dynein-associated protein RKM23 |
| 744 | 506 | AF076856 | M, N | espin | espin |
| 5496 | 507 | AF080468 | M, N, D, E | glucose-6-phosphatase, transport protein 1 | glucose-6-phosphatase, transport protein 1 |
| 5497 | 507 | AF080468 | M, N, D, E | glucose-6-phosphatase, transport protein 1 | glucose-6-phosphatase, transport protein 1 |
| 25204 | 508 | AF080507 | N | | |
| 10015 | 509 | AF083269 | M, G, K | actin related protein ⅔ complex, subunit 1B | actin related protein ⅔ complex, subunit 1B |
| 10016 | 509 | AF083269 | M, G | actin related protein ⅔ complex, subunit 1B | actin related protein ⅔ complex, subunit 1B |
| 20741 | 510 | AF084186 | A, J | alpha-spectrin 2 | alpha-spectrin 2 |
| 23679 | 511 | AF087037 | C, L | B-cell translocation gene 3 | B-cell translocation gene 3 |
| 15791 | 512 | AF089817 | C | regulator of G-protein signaling 19 interacting protein 1 | regulator of G-protein signaling 19 interacting protein 1 |
| 17535 | 513 | AF090306 | N, E | retinoblastoma binding protein 7 | retinoblastoma binding protein 7 |
| 16156 | 514 | AF093536 | N | defensin beta 1 | defensin beta 1 |
| 4723 | 515 | AF093773 | N | malate dehydrogenase 1 | malate dehydrogenase 1 |
| 2367 | 516 | AF095741 | N | Mg87 protein | Mg87 protein |
| 2368 | 516 | AF095741 | N, K | Mg87 protein | Mg87 protein |
| 6554 | 517 | AF097723 | N | plasma glutamate carboxypeptidase | plasma glutamate carboxypeptidase |
| 15232 | 518 | AI007622 | D | | Rattus norvegicus transcribed sequences |
| 24109 | 519 | AI007725 | J | | Rattus norvegicus transcribed sequences |
| 15848 | 520 | AI007820 | N | | Rattus norvegicus heat shock protein 90 beta mRNA, partial sequence |
| 1804 | 521 | AI007824 | L | | |
| 6804 | 522 | AI007877 | M | | Rattus norvegicus transcribed sequences |
| 15849 | 523 | AI008074 | N | | Rattus norvegicus heat shock protein 90 beta mRNA, partial sequence |
| 16394 | 524 | AI008106 | K | calcium binding protein A6 (calcyclin) | calcium binding protein A6 (calcyclin) |
| 3121 | 525 | AI008160 | M, G, K | | Rattus norvegicus transcribed sequence with moderate similarity to protein |
| | | | | | pir: T44603 (H. sapiens) T44603 hypothetical protein CGI-83 [imported]- |
| | | | | | human |
| 11162 | 526 | AI008183 | C | solute carrier family 29 (nucleoside transporters), | solute carrier family 29 (nucleoside transporters), member 3 |
| | | | | member 3 | |
| 23917 | 527 | AI008441 | H, I | | Rattus norvegicus transcribed sequence with strong similarity to protein |
| | | | | | sp: P52209 (H. sapiens) 6PGD_HUMAN 6-phosphogluconate dehydrogenase, |
| | | | | | decarboxylating |
| 22599 | 528 | AI008458 | M | | Rattus norvegicus transcribed sequences |
| 22698 | 529 | AI008578 | L | | Rattus norvegicus transcribed sequences |
| 19268 | 530 | AI008641 | D | ribosomal protein L22 | ribosomal protein L22 |
| 15434 | 531 | AI008836 | N | high mobility group box 2 | high mobility group box 2 |
| 410 | 532 | AI008974 | M, E | low density lipoprotein receptor-related protein | low density lipoprotein receptor-related protein associated protein 1 |
| | | | | associated protein 1 | |
| 21632 | 533 | AI009167 | M, H, I | | Rattus norvegicus transcribed sequence with strong similarity to protein |
| | | | | | sp: O95816 (H. sapiens) BAG2_HUMAN BAG-family molecular chaperone |
| | | | | | regulator-2 |
| 6382 | 534 | AI009362 | M | | Rattus norvegicus transcribed sequence with strong similarity to protein |
| | | | | | sp: P05423 (H. sapiens) BN51_HUMAN BN51 protein |
| 15097 | 535 | AI009405 | N | insulin-like growth factor binding protein 3 | insulin-like growth factor binding protein 3 |
| 10532 | 536 | AI009602 | K | | Rattus norvegicus transcribed sequences |
| 23362 | 537 | AI009605 | N | Ras homolog enriched in brain | Ras homolog enriched in brain |
| 895 | 538 | AI009614 | E | | Rattus norvegicus transcribed sequences |
| 19358 | 539 | AI009675 | J | | Rattus norvegicus transcribed sequences |
| 6833 | 540 | AI009687 | L | | Rattus norvegicus transcribed sequences |
| 15089 | 541 | AI009752 | M, K | | Rattus norvegicus transcribed sequences |
| 6842 | 542 | AI009764 | K | | Rattus norvegicus transcribed sequence with strong similarity to protein |
| | | | | | ref: NP_109630.1 (M. musculus) mesoderm development candidate 1 [Mus |
| | | | | | musculus] |
| 15138 | 543 | AI009801 | C | macrophage migration inhibitory factor | macrophage migration inhibitory factor |
| 17473 | 544 | AI009806 | M, N, K | dynein, cytoplasmic, light chain 1 | dynein, cytoplasmic, light chain 1 |
| 22619 | 545 | AI009825 | L | | Rattus norvegicus transcribed sequences |
| 26133 | 546 | AI009950 | F | | |
| 6869 | 547 | AI010025 | D | | Rattus norvegicus transcribed sequence |
| 16824 | 548 | AI010027 | D | | Rattus norvegicus transcribed sequences |
| 21105 | 549 | AI010067 | M, F | | Rattus norvegicus transcribed sequence with strong similarity to protein |
| | | | | | ref: NP_057032.1 (H. sapiens) CGI-19 protein [Homo sapiens] |
| 12716 | 550 | AI010178 | M | | Rattus norvegicus transcribed sequences |
| 2912 | 551 | AI010220 | M, A, F | | Rattus norvegicus transcribed sequence with weak similarity to protein |
| | | | | | sp: Q9Z1L1 (R. norvegicus) CLD7_RAT CLAUDIN-7 |
| 13104 | 552 | AI010224 | D | adducin 3, gamma | adducin 3, gamma |
| 17938 | 553 | AI010332 | C | | Rattus norvegicus transcribed sequences |
| 12095 | 554 | AI010339 | D | | Rattus norvegicus transcribed sequence with weak similarity to protein |
| | | | | | ref: NP_077128.2 (M. musculus) ethanol induced 6 [Mus musculus] |
| 6916 | 555 | AI010430 | M | | Rattus norvegicus transcribed sequences |
| 18657 | 556 | AI010435 | K | | Rattus norvegicus transcribed sequences |
| 16521 | 557 | AI010470 | B, J, L | ceruloplasmin | ceruloplasmin |
| 6927 | 558 | AI010542 | M | | Rattus norvegicus transcribed sequences |
| 17524 | 559 | AI010568 | M, A, I | growth hormone receptor | growth hormone receptor |
| 21659 | 560 | AI010584 | D | interferon induced transmembrane protein 3-like | interferon induced transmembrane protein 3-like |
| 23509 | 561 | AI010962 | A | | Rattus norvegicus transcribed sequence with weak similarity to protein |
| | | | | | ref: NP_445863.1 (R. norvegicus) sorting nexin 1 [Rattus norvegicus] |
| 15679 | 562 | AI011058 | B, L | | Rattus norvegicus transcribed sequences |
| 3934 | 563 | AI011510 | D | | Rattus norvegicus transcribed sequences |
| 3941 | 564 | AI011598 | M, J | | Rattus norvegicus transcribed sequence with moderate similarity to protein |
| | | | | | sp: Q61001 (M. musculus) LMA5_MOUSE Laminin alpha-5 chain precursor |
| 17550 | 565 | AI011607 | M, I | trimethyllysine hydroxylase, epsilon | trimethyllysine hydroxylase, epsilon |
| 3995 | 566 | AI011678 | M, I, K | syndecan 2 | syndecan 2 |
| 20804 | 567 | AI011684 | H | transketolase | transketolase |
| 14267 | 568 | AI011738 | A | | Rattus norvegicus transcribed sequence with strong similarity to protein |
| | | | | | sp: P38718 (R. norvegicus) P044_RAT 0-44 protein |
| 21060 | 569 | AI011746 | A | | Rattus norvegicus transcribed sequence with strong similarity to protein |
| | | | | | ref: NP_114131.1 (H. sapiens) transmembrane protein induced by tumor |
| | | | | | necrosis factor alpha [Homo sapiens] |
| 15616 | 570 | AI011998 | N | dnaJ homolog, subfamily b, member 9 | dnaJ homolog, subfamily b, member 9 |
| 13151 | 571 | AI012030 | M | matrix Gla protein | matrix Gla protein |
| 6518 | 572 | AI012114 | M | | Rattus norvegicus transcribed sequence with moderate similarity to protein |
| | | | | | sp: Q9NXH9 (H. sapiens) TRM1_HUMAN Probable N(2),N(2)- |
| | | | | | dimethylguanosine tRNA methyltransferase (tRNA(guanine-26, N(2)-N(2)) |
| | | | | | methyltransferase) (tRNA 2,2-dimethylguanosine-26 methyltransferase) |
| | | | | | (tRNA(m(2,2)G26)dimethyltransferase) |
| 17832 | 573 | AI012182 | J | hemoglobin beta chain complex | hemoglobin beta chain complex |
| 21796 | 574 | AI012221 | M, K | Seminal vesicle protein, secretion 2 | Seminal vesicle protein, secretion 2 |
| 23946 | 575 | AI012240 | M | | Rattus norvegicus transcribed sequences |
| 13633 | 576 | AI012335 | M | activating transcription factor ATF-4 | activating transcription factor ATF-4 |
| 2250 | 577 | AI012354 | M | histone 2b | histone 2b |
| 24200 | 578 | AI012356 | M, B, L | | Rattus norvegicus transcribed sequences |
| 7471 | 579 | AI012379 | L | | Rattus norvegicus transcribed sequences |
| 9116 | 580 | AI012457 | A, C | | Rattus norvegicus transcribed sequence with strong similarity to protein |
| | | | | | ref: NP_006336.2 (H. sapiens) chromosome 4 open reading frame 1; |
| | | | | | expressed in human embryonic lung [Homo sapiens] |
| 7127 | 581 | AI012464 | M | | Rattus norvegicus transcribed sequences |
| 20817 | 582 | AI012589 | M, N | (glutathione S-transferase, pi 2, glutathione-S- | (glutathione S-transferase, pi 2, glutathione-S-transferase, pi 1) |
| | | | | transferase, pi 1) | |
| 3493 | 583 | AI012590 | D, K | | Rattus norvegicus transcribed sequences |
| 3961 | 584 | AI012598 | A | | Rattus norvegicus transcribed sequence with strong similarity to protein |
| | | | | | ref: NP_032333.1 (M. musculus) Hpall tiny fragments locus 9c [Mus musculus] |
| 18713 | 585 | AI012604 | N, L | eukaryotic initiation factor 5 (elF-5) | eukaryotic initiation factor 5 (elF-5) |
| 2242 | 586 | AI012635 | M, H, I, J | flavin-containing monooxygenase 3 | flavin-containing monooxygenase 3 |
| 7142 | 587 | AI012689 | C | | Rattus norvegicus transcribed sequences |
| 23810 | 588 | AI012781 | E | | Rattus norvegicus transcribed sequence with strong similarity to protein |
| | | | | | sp: Q61188 (M. musculus) EZH2_MOUSE Enhancer of zeste homolog 2 (ENX- |
| | | | | | 1) |
| 1409 | 589 | AI012802 | M, A, C, E, F | Hydroxyacyl glutathione hydrolase | Hydroxyacyl glutathione hydrolase |
| 20086 | 590 | AI013260 | M, H | lamin A | lamin A |
| 21302 | 591 | AI013297 | J | | Rattus norvegicus transcribed sequence with strong similarity to protein |
| | | | | | ref: NP_035017.1 (M. musculus) NADH dehydrogenase (ubiquinone) Fe—S |
| | | | | | protein 4; NADH dehydrogenase (ubiquinone) Fe—S protein 4 (18 kDa) [Mus |
| | | | | | musculus] |
| 6758 | 592 | AI013394 | B, L | heparan sulfate (glucosamine) 3-O-sulfotransferase 1 | heparan sulfate (glucosamine) 3-O-sulfotransferase 1 |
| 7270 | 593 | AI013564 | D | | Rattus norvegicus Ab2-416 mRNA, complete cds |
| 6674 | 594 | AI013568 | I | | Rattus norvegicus transcribed sequences |
| 15159 | 595 | AI013697 | D | | Rattus norvegicus transcribed sequence with strong similarity to protein |
| | | | | | ref: NP_075918.1 (M. musculus) RIKEN cDNA 6030432N09 [Mus musculus] |
| 7278 | 596 | AI013738 | J | | Rattus norvegicus transcribed sequences |
| 22592 | 597 | AI013740 | M, G, K | | Rattus norvegicus transcribed sequence with strong similarity to protein |
| | | | | | ref: NP_062729.1 (M. musculus) proteolipid protein 2 [Mus musculus] |
| 15928 | 598 | AI013829 | M, K | | Rattus norvegicus transcribed sequence with strong similarity to protein |
| | | | | | ref: NP_031947.1 (M. musculus) E74-like factor 3 [Mus musculus] |
| 21950 | 599 | AI013861 | N, G | 3-hydroxyisobutyrate dehydrogenase | 3-hydroxyisobutyrate dehydrogenase |
| 21391 | 600 | AI013902 | M, K | annexin A7 | annexin A7 |
| 7299 | 601 | AI013911 | M, A, B, L | RNA binding motif protein 3 | RNA binding motif protein 3 |
| 15904 | 602 | AI013971 | F | neurofascin | neurofascin |
| 815 | 603 | AI014087 | N | ribosomal protein S26 | ribosomal protein S26 |
| 17908 | 604 | AI014163 | M | interferon-related developmental regulator 1 | interferon-related developmental regulator 1 |
| 7216 | 605 | AI014165 | A | | Rattus norvegicus transcribed sequences |
| 15247 | 606 | AI014169 | N | upregulated by 1,25-dihydroxyvitamin D-3 | upregulated by 1,25-dihydroxyvitamin D-3 |
| 11326 | 607 | AI029015 | F | | Rattus norvegicus transcribed sequences |
| 22502 | 608 | AI029017 | H | putative zinc finger protein SERZ-1 | putative zinc finger protein SERZ-1 |
| 12812 | 609 | AI029126 | M, H | | Rattus norvegicus transcribed sequences |
| 3874 | 610 | AI029428 | M, I | | Rattus norvegicus transcribed sequence with strong similarity to protein |
| | | | | | pir: S50082 (H. sapiens) S50082 nuclear cap binding protein - human |
| 7451 | 611 | AI029450 | L | | Rattus norvegicus transcribed sequence with moderate similarity to protein |
| | | | | | sp: P07814 (H. sapiens) SYEP_HUMAN Bifunctional aminoacyl-tRNA |
| | | | | | synthetase [Includes: Glutamyl-tRNA synthetase (Glutamate-tRNA ligase); |
| | | | | | Prolyl-tRNA synthetase (Proline-tRNA ligase)] |
| 22415 | 612 | AI029795 | C | growth response protein (CL-6) | growth response protein (CL-6) |
| 7537 | 613 | AI029829 | M | | Rattus norvegicus transcribed sequences |
| 24893 | 614 | AI029920 | B | insulin-like growth factor-binding protein 5 | insulin-like growth factor-binding protein 5 |
| 7586 | 615 | AI030024 | C | | Rattus norvegicus transcribed sequences |
| 2370 | 616 | AI030179 | M, I | | Rattus norvegicus transcribed sequence with weak similarity to protein |
| | | | | | ref: NP_446030.1 (R. norvegicus) vacuolar proton-ATPase subunit M9.2 |
| | | | | | [Rattus norvegicus] |
| 7634 | 617 | AI030248 | A | | Rattus norvegicus transcribed sequence with strong similarity to protein |
| | | | | | ref: NP_444391.1 (M. musculus) mitochondrial ribosomal protein L27 [Mus |
| | | | | | musculus] |
| 665 | 618 | AI030430 | B | | Rattus norvegicus transcribed sequences |
| 7681 | 619 | AI030449 | J | | Rattus norvegicus transcribed sequence with strong similarity to protein |
| | | | | | ref: NP_034922.1 (M. musculus) methyltransferase-like 1 (S. cerevisiae) [Mus |
| | | | | | musculus] |
| 11559 | 620 | AI030472 | C | | Rattus norvegicus transcribed sequence with strong similarity to protein |
| | | | | | ref: NP_079615.1 (M. musculus) RIKEN cDNA 0610027O18 [Mus musculus] |
| 17419 | 621 | AI030524 | D | | Rattus norvegicus transcribed sequence with strong similarity to protein |
| | | | | | pir: JC5223 (M. musculus) JC5223 histidine - tRNA ligase (EC 6.1.1.21) - |
| | | | | | mouse |
| 7665 | 622 | AI030668 | E | nucleosome assembly protein 1-like 1 | nucleosome assembly protein 1-like 1 |
| 16169 | 623 | AI030932 | J | | Rattus norvegicus transcribed sequence with weak similarity to protein |
| | | | | | sp: P43884 (R. norvegicus) PLIN_RAT Perilipin (PERI) (Lipid droplet- |
| | | | | | associated protein) |
| 7825 | 624 | AI031023 | F | | Rattus norvegicus transcribed sequence with strong similarity to protein |
| | | | | | pdb: 1BGM (E. coli) O Chain O, Beta-Galactosidase (Chains I-P) |
| 14856 | 625 | AI043721 | A | | Rattus norvegicus transcribed sequence with strong similarity to protein |
| | | | | | pdb: 1BGM (E. coli) O Chain O, Beta-Galactosidase (Chains I-P) |
| 7896 | 626 | AI043772 | D | | Rattus norvegicus transcribed sequences |
| 7903 | 627 | AI043805 | M | | Rattus norvegicus transcribed sequences |
| 10818 | 628 | AI043990 | M, I | | Rattus norvegicus transcribed sequences |
| 7964 | 629 | AI044046 | G | | Rattus norvegicus transcribed sequences |
| 5430 | 630 | AI044253 | F | | Rattus norvegicus transcribed sequences |
| 5461 | 631 | AI044338 | M, B | | Rattus norvegicus transcribed sequence with weak similarity to protein |
| | | | | | pir: S19586 (R. norvegicus) S19586 N-methyl-D-aspartate receptor glutamate- |
| | | | | | binding chain - rat |
| 1431 | 632 | AI044610 | D | dopa decarboxylase | dopa decarboxylase |
| 2348 | 633 | AI044794 | M, D | | Rattus norvegicus transcribed sequence with strong similarity to protein |
| | | | | | prf: 2208451B (M. musculus) 2208451B syntrophin [Mus musculus] |
| 20983 | 634 | AI044900 | K | fatty acid Coenzyme A ligase, long chain 2 | fatty acid Coenzyme A ligase, long chain 2 |
| 21682 | 635 | AI045030 | N | CCAAT/enhancerbinding, protein (C/EBP) delta | CCAAT/enhancerbinding, protein (C/EBP) delta |
| 19235 | 636 | AI045074 | M | | Rattus norvegicus transcribed sequence with moderate similarity to protein |
| | | | | | pir: A37086 (M. musculus) A37086 beta-galactosidase (EC 3.2.1.23) precursor - |
| | | | | | mouse |
| 5711 | 637 | AI045151 | M | | Rattus norvegicus transcribed sequence with weak similarity to protein |
| | | | | | ref: NP_446417.1 (R. norvegicus) solute carrier family 25 |
| | | | | | (carnitine/acylcarnitine translocase), member 20 [Rattus norvegicus] |
| 5474 | 638 | AI045477 | M | | Rattus norvegicus transcribed sequences |
| 10004 | 639 | AI045509 | C | | Rattus norvegicus transcribed sequences |
| 17755 | 640 | AI045608 | C, I | | Rattus norvegicus transcribed sequence with moderate similarity to protein |
| | | | | | pir: I60307 (E. coli) I60307 beta-galactosidase, alpha peptide - Escherichia coli |
| 26173 | 641 | AI045626 | F | | |
| 5855 | 642 | AI045669 | M | | Rattus norvegicus transcribed sequences |
| 23712 | 643 | AI045827 | L | | Rattus norvegicus transcribed sequence with weak similarity to protein |
| | | | | | pir: T00043 (M. musculus) T00043 BH-protocadherin-a - mouse |
| 5900 | 644 | AI045866 | I | | Rattus norvegicus transcribed sequence |
| 7540 | 645 | AI045882 | M, B, L | vitamin A-deficient testicular protein 5 | vitamin A-deficient testicular protein 5 |
| 5329 | 646 | AI045970 | M | amphiphysin | amphiphysin |
| 10069 | 647 | AI058503 | F | | Rattus norvegicus transcribed sequence with moderate similarity to protein |
| | | | | | sp: Q92537 (H. sapiens) Y247_HUMAN Hypothetical protein KIAA0247 |
| 8065 | 648 | AI058509 | B, L | | Rattus norvegicus transcribed sequence |
| 8104 | 649 | AI058655 | B | | |
| 8143 | 650 | AI058759 | M | | Rattus norvegicus transcribed sequences |
| 4789 | 651 | AI058889 | M | | Rattus norvegicus transcribed sequence with strong similarity to protein |
| | | | | | pdb: 1BGM (E. coli) O Chain O, Beta-Galactosidase (Chains I-P) |
| 8188 | 652 | AI058943 | M | erythrocyte protein band 4.1-like 3 | erythrocyte protein band 4.1-like 3 |
| 8202 | 653 | AI058990 | L | | Rattus norvegicus transcribed sequence with moderate similarity to protein |
| | | | | | ref: NP_055702.1 (H. sapiens) hypothetical protein from BCRA2 region [Homo |
| | | | | | sapiens] |
| 8283 | 654 | AI059290 | H | | Rattus norvegicus transcribed sequences |
| 20802 | 655 | AI059508 | N, H | transketolase | transketolase |
| 3083 | 656 | AI060150 | E | | Rattus norvegicus transcribed sequence with moderate similarity to protein |
| | | | | | ref: NP_003600.1 (H. sapiens) HIRA-interacting protein 3 [Homo sapiens] |
| 9067 | 657 | AI070087 | M | prolactin | prolactin |
| 6343 | 658 | AI070108 | A | | Rattus norvegicus transcribed sequence with moderate similarity to protein |
| | | | | | ref: NP_444504.1 (H. sapiens) FKBP-associated protein isoform FAP68; |
| | | | | | FK506-binding protein-associated protein [Homo sapiens] |
| 8820 | 659 | AI070152 | B, H, L | Smhs1 protein | Smhs1 protein |
| 26183 | 660 | AI070204 | A | | Rattus norvegicus transcribed sequences |
| 352 | 661 | AI070295 | H | growth arrest and DNA-damage-inducible 45 alpha | growth arrest and DNA-damage-inducible 45 alpha |
| 24197 | 662 | AI070314 | B, L | | Rattus norvegicus transcribed sequence with strong similarity to protein |
| | | | | | pdb: 1BGM (E. coli) O Chain O, Beta-Galactosidase (Chains I-P) |
| 14424 | 663 | AI070421 | M | | Rattus norvegicus transcribed sequences |
| 10434 | 664 | AI070497 | B | | Rattus norvegicus transcribed sequences |
| 8927 | 665 | AI070523 | A | | Rattus norvegicus transcribed sequence with strong similarity to protein |
| | | | | | ref: NP_079737.1 (M. musculus) RIKEN cDNA 1810020G14 [Mus musculus] |
| 19031 | 666 | AI070532 | M, L | T-cell death associated gene | T-cell death associated gene |
| 8944 | 667 | AI070597 | F | | Rattus norvegicus transcribed sequence with strong similarity to protein |
| | | | | | sp: Q9Y3A5 (H. sapiens) YC97_HUMAN Hypothetical protein CGI-97 |
| 8946 | 668 | AI070611 | A | | Rattus norvegicus transcribed sequences |
| 10446 | 669 | AI070638 | B | | Rattus norvegicus transcribed sequence with moderate similarity to protein |
| | | | | | ref: NP_067053.1 (H. sapiens) myeloid/lymphoid or mixed-lineage leukemia 3; |
| | | | | | ALR-like protein [Homo sapiens] |
| 8739 | 670 | AI070859 | D | | Rattus norvegicus transcribed sequence with strong similarity to protein |
| | | | | | ref: NP_080044.1 (M. musculus) GH regulated TBC protein 1 [Mus musculus] |
| 9026 | 671 | AI070944 | L | | Rattus norvegicus transcribed sequences |
| 8721 | 672 | AI071024 | M, A, D, I | | Rattus norvegicus transcribed sequence |
| 9212 | 673 | AI071098 | K | tropomyosin isoform 6 | tropomyosin isoform 6 |
| 18792 | 674 | AI071177 | M, I | | Rattus norvegicus transcribed sequences |
| 9583 | 675 | AI071185 | M, C, L | | Rattus norvegicus transcribed sequences |
| 9079 | 676 | AI071251 | B, I | | Rattus norvegicus transcribed sequence with strong similarity to protein |
| | | | | | pir: A57050 (M. musculus) A57050 K-glypican precursor - mouse |
| 11057 | 677 | AI071509 | L | | Rattus norvegicus transcribed sequences |
| 22929 | 678 | AI071578 | M, F | neuronal regeneration related protein | neuronal regeneration related protein |
| 22930 | 678 | AI071578 | M | neuronal regeneration related protein | neuronal regeneration related protein |
| 9673 | 679 | AI071581 | M, I | | Rattus norvegicus transcribed sequences |
| 8099 | 680 | AI071586 | B | | Rattus norvegicus transcribed sequence with moderate similarity to protein |
| | | | | | ref: NP_071364.1 (H. sapiens) hypothetical protein bK1048E9.5 [Homo |
| | | | | | sapiens] |
| 11075 | 681 | AI071639 | F | | Rattus norvegicus transcribed sequence |
| 9699 | 682 | AI071646 | M | | Rattus norvegicus transcribed sequences |
| 9781 | 683 | AI071943 | M, I | | Rattus norvegicus transcribed sequences |
| 8665 | 684 | AI071965 | C | | R. norvegicus hsp70.2 mRNA for heat shock protein 70 |
| 12846 | 685 | AI072068 | J | | Rattus norvegicus transcribed sequence with moderate similarity to protein |
| | | | | | pir: I60307 (E. coli) I60307 beta-galactosidase, alpha peptide - Escherichia coli |
| 9191 | 686 | AI072107 | A | | |
| 10849 | 687 | AI072189 | F | | Rattus norvegicus transcnbed sequences |
| 20003 | 688 | AI072362 | M | | Rattus norvegicus transcribed sequences |
| 21797 | 689 | AI072439 | G, K | Seminal vesicle protein, secretion 2 | Seminal vesicle protein, secretion 2 |
| 1501 | 690 | AI072634 | M, C, G, K | keratin complex 1, acidic, gene 18 | keratin complex 1, acidic, gene 18 |
| 9176 | 691 | AI072675 | A | dystonia 1, torsion (autosomal dominant; torsin A) | dystonia 1, torsion (autosomal dominant; torsin A) |
| 16813 | 692 | AI072746 | I | | |
| 19930 | 693 | AI072799 | F | | Rattus norvegicus transcribed sequence |
| 21885 | 694 | AI072886 | M | | Rattus norvegicus transcribed sequences |
| 9439 | 695 | AI072934 | J | | Rattus norvegicus transcribed sequences |
| 9468 | 696 | AI073021 | M | | Rattus norvegicus transcribed sequences |
| 24165 | 697 | AI101113 | F | | Rattus norvegicus transcribed sequences |
| 6321 | 698 | AI101256 | M | | Rattus norvegicus transcribed sequence with weak similarity to protein |
| | | | | | sp: Q9JJ54 (R. norvegicus) ROD_RAT Heterogeneous nuclear |
| | | | | | ribonucleoprotein D0 (hnRNP D0) (AU-rich element RNA-binding protein 1) |
| 17743 | 699 | AI101660 | J | | Rattus norvegicus transcribed sequences |
| 4119 | 700 | AI101901 | L | | Rattus norvegicus transcribed sequence with strong similarity to protein |
| | | | | | ref: NP_032404.1 (M. musculus) imprinted and ancient [Mus musculus] |
| 2824 | 701 | AI101999 | C | | Rattus norvegicus transcribed sequences |
| 18642 | 702 | AI102023 | C | | Rattus norvegicus transcribed sequence with strong similarity to protein |
| | | | | | sp: Q9QY73 (M. musculus) C1O8_MOUSE Protein C1orf8 homolog precursor |
| | | | | | (Thymic dendritic cell-derived factor 1) |
| 11953 | 703 | AI102505 | A | cytochrome c oxidase, subunit VIIIa | cytochrome c oxidase, subunit VIIIa |
| 2125 | 704 | AI102519 | G | | Rattus norvegicus transcribed sequence with strong similarity to protein |
| | | | | | ref: NP_035792.1 (M. musculus) TYRO protein tyrosine kinase binding protein; |
| | | | | | killer cell activating receptor associated protein [Mus musculus] |
| 15190 | 705 | AI102562 | M, N | Metallothionein | Metallothionein |
| 19011 | 706 | AI102618 | L | | Rattus norvegicus transcribed sequences |
| 23837 | 707 | AI102620 | M, N | | Rattus norvegicus transcribed sequences |
| 23538 | 708 | AI102727 | M | solute carrier family 20 (phosphate transporter), | solute carrier family 20 (phosphate transporter), member 1 |
| | | | | member 1 | |
| 17234 | 709 | AI102741 | J | Tissue inhibitor of metalloproteinase 3 | Tissue inhibitor of metalloproteinase 3 |
| 17850 | 710 | AI102750 | H | | Rattus norvegicus transcribed sequence with weak similarity to protein |
| | | | | | pir: JQ0866 (R. norvegicus) JQ0866 T-complex protein 1 - rat |
| 6796 | 711 | AI102753 | M, B | ring finger protein 4 | ring finger protein 4 |
| 4449 | 712 | AI102838 | N, B, G, K | Isovaleryl Coenzyme A dehydrogenase | Isovaleryl Coenzyme A dehydrogenase |
| 8837 | 713 | AI102849 | C | general transcription factor II I | general transcription factor II I |
| 15861 | 714 | AI102868 | N | | Rattus norvegicus phosphoserine aminotransferase mRNA, complete cds |
| 16918 | 715 | AI103074 | N | ribosomal protein S12 | ribosomal protein S12 |
| 3584 | 716 | AI103106 | E | lamin B1 | lamin B1 |
| 3279 | 717 | AI103224 | F | carbonyl reductase | carbonyl reductase |
| 13028 | 718 | AI103253 | A | | Rattus norvegicus transcribed sequences |
| 1807 | 719 | AI103365 | L | | Rattus norvegicus transcribed sequences |
| 7622 | 720 | AI103472 | A | | Rattus norvegicus transcribed sequence with moderate similarity to protein |
| | | | | | pdb: 1LBG (E. coli) B Chain B, Lactose Operon Repressor Bound To 21-Base |
| | | | | | Pair Symmetric Operator Dna, Alpha Carbons Only |
| 20918 | 721 | AI103552 | J | | Rattus norvegicus transcribed sequences |
| 4856 | 722 | AI103708 | G | | Rattus norvegicus transcribed sequences |
| 16884 | 723 | AI103758 | E | aldehyde dehydrogenase family 9, subfamily A1 | aldehyde dehydrogenase family 9, subfamily A1 |
| 1649 | 724 | AI103782 | F | Peptidylglycine alpha-amidating monooxygenase | Peptidylglycine alpha-amidating monooxygenase |
| 22885 | 725 | AI103828 | M, B | | Rattus norvegicus transcribed sequence with strong similarity to protein |
| | | | | | ref: NP_079514.1 (H. sapiens) BTB (POZ) domain containing 1 [Homo |
| | | | | | sapiens] |
| 15050 | 726 | AI103911 | I | | Rattus norvegicus transcribed sequence with strong similarity to protein |
| | | | | | pir: A32296 (R. norvegicus) A32296 ubiquinol-cytochrome-c reductase (EC |
| | | | | | 1.10.2.2) Rieske iron-sulfur protein precursor - rat (fragment) |
| 7128 | 727 | AI103937 | M | | Rattus norvegicus transcribed sequences |
| 22271 | 728 | AI103947 | F | | Rattus norvegicus transcribed sequence with moderate similarity to protein |
| | | | | | ref: NP_444393.1 (M. musculus) mitochondrial ribosomal protein L36 [Mus |
| | | | | | musculus] |
| 12450 | 729 | AI103955 | C | LRP16 protein | LRP16 protein |
| 19991 | 730 | AI103956 | K | mitochondrial aconitase (nuclear aco2 gene) | mitochondrial aconitase (nuclear aco2 gene) |
| 20833 | 731 | AI104035 | N, A | | Rattus norvegicus transcribed sequence with strong similarity to protein |
| | | | | | ref: NP_079904.1 (M. musculus) RIKEN cDNA 2010000G05 [Mus musculus] |
| 22101 | 732 | AI104251 | M, C, I | | Rattus norvegicus transcribed sequence with moderate similarity to protein |
| | | | | | ref: NP_056222.1 (H. sapiens) DKFZP564O243 protein [Homo sapiens] |
| 4235 | 733 | AI104524 | M, H, K, L | heterogeneous nuclear ribonucleoprotein A/B | heterogeneous nuclear ribonucleoprotein A/B |
| 18509 | 734 | AI104528 | A | | Rattus norvegicus DD6C4-4 mRNA, partial sequence |
| 12798 | 735 | AI104773 | M | | Rattus norvegicus transcribed sequence with strong similarity to protein |
| | | | | | ref: NP_079411.1 (H. sapiens) hypothetical protein KIAA1695; hypothetical |
| | | | | | protein FLJ22297; KIAA1695 protein [Homo sapiens] |
| 11232 | 736 | AI104864 | F | | Rattus norvegicus transcribed sequence with strong similarity to protein |
| | | | | | ref: NP_076952.1 (H. sapiens) hypothetical protein MGC3037 [Homo sapiens] |
| 16887 | 737 | AI104883 | F | | Rattus norvegicus transcribed sequence with strong similarity to protein |
| | | | | | ref: NP_080841.1 (M. musculus) RIKEN cDNA 9430083G14 [Mus musculus] |
| 21253 | 738 | AI105110 | F | | Rattus norvegicus transcribed sequence with strong similarity to protein |
| | | | | | sp: P48024 (M. musculus) SUI1_MOUSE Protein translation factor SUI1 |
| | | | | | homolog |
| 16885 | 739 | AI105188 | K | aldehyde dehydrogenase family 9, subfamily A1 | aldehyde dehydrogenase family 9, subfamily A1 |
| 18077 | 740 | AI105198 | N | solute carrier family 34, member 1 | solute carrier family 34, member 1 |
| 5199 | 741 | AI105272 | M, G | | Rattus norvegicus transcribed sequence with strong similarity to protein |
| | | | | | ref: NP_076133.1 (M. musculus) methylcrotonoyl-Coenzyme A carboxylase 1 |
| | | | | | (alpha) [Mus musculus] |
| 15364 | 742 | AI105348 | J | cofilin 1 | cofilin 1 |
| 7049 | 743 | AI105371 | C | | Rattus norvegicus transcribed sequences |
| 7700 | 744 | AI105383 | M, D | sphingosine kinase 1 | sphingosine kinase 1 |
| 13343 | 745 | AI105398 | M | | Rattus norvegicus transcribed sequences |
| 17221 | 746 | AI105429 | K | | Rattus norvegicus transcribed sequence with moderate similarity to protein |
| | | | | | pdb: 1LBG (E. coli) B Chain B, Lactose Operon Repressor Bound To 21-Base |
| | | | | | Pair Symmetric Operator Dna, Alpha Carbons Only |
| 23660 | 747 | AI105448 | N | hydroxysteroid 11-beta dehydrogenase 1 | hydroxysteroid 11-beta dehydrogenase 1 |
| 15291 | 748 | AI111401 | D | muliple inositol polyphosphate histidine phosphatase 1 | mutiple inositol polyphosphate histidine phosphatase 1 |
| 16718 | 749 | AI111537 | H | | Rattus norvegicus Class II MHC RT1.D(a) beta chain precursor (RT1.D(a)) |
| | | | | | mRNA, complete cds |
| 4479 | 750 | AI111599 | M | growth arrest specific 5 | growth arrest specific 5 |
| 24211 | 751 | AI111853 | G | | Rattus norvegicus transcribed sequence with strong similarity to protein |
| | | | | | sp: P06351 (M. musculus) H33_HUMAN Histone H3.3 (H3.A) (H3.B) (H3.3Q) |
| 12925 | 752 | AI111970 | B | | Rattus norvegicus transcribed sequence with moderate similarity to protein |
| | | | | | pir: I60307 (E. coli) I60307 beta-galactosidase, alpha peptide - Escherichia coli |
| 9017 | 753 | AI112138 | M | | Rattus norvegicus transcribed sequences |
| 11198 | 754 | AI112199 | F | | Rattus norvegicus transcribed sequences |
| 12945 | 755 | AI112212 | F | | Rattus norvegicus transcribed sequence with weak similarity to protein |
| | | | | | ref: NP_071348.1 (H. sapiens) hypothetical protein FLJ21877; death receptor- |
| | | | | | interacting protein [Homo sapiens] |
| 20919 | 756 | AI112516 | N | zinc finger protein 36, C3H type-like 1 | zinc finger protein 36, C3H type-like 1 |
| 3713 | 757 | AI112571 | M, J | | Rattus norvegicus transcribed sequence with strong similarity to protein |
| | | | | | ref: NP_112595.1 (H. sapiens) hypothetical protein DKFZp564B1162 [Homo |
| | | | | | sapiens] |
| 15538 | 758 | AI112633 | L | proteasome (prosome, macropain) subunit, alpha type 6 | proteasome (prosome, macropain) subunit, alpha type 6 |
| 12921 | 759 | AI112636 | M, B, L | | Rattus norvegicus transcribed sequence with strong similarity to protein |
| | | | | | pir: A57501 (M. musculus) A57501 uridine phosphorylase (EC 2.4.2.3) I - |
| | | | | | mouse |
| 13013 | 760 | AI136233 | B | | Rattus norvegicus transcribed sequence with moderate similarity to protein |
| | | | | | pdb: 1LBG (E. coli) B Chain B, Lactose Operon Repressor Bound To 21-Base |
| | | | | | Pair Symmetric Operator Dna, Alpha Carbons Only |
| 13020 | 761 | AI136338 | F | | Rattus norvegicus transcribed sequence with weak similarity to protein |
| | | | | | ref: NP_064411.1 (M. musculus) Bat2; DNA segment, Chr 17, human D6S51E; |
| | | | | | RIKEN cDNA 3110039B05 gene [Mus musculus] |
| 9504 | 762 | AI136723 | F | | Rattus norvegicus transcribed sequence with weak similarity to protein |
| | | | | | sp: O88553 (R. norvegicus) ZF37_RAT Zinc finger protein 37 (Zfp-37) |
| 20920 | 763 | AI136891 | N | zinc finger protein 36, C3H type-like 1 | zinc finger protein 36, C3H type-like 1 |
| 13091 | 764 | AI136977 | L | FK506 binding protein 4 (59 kDa) | FK506 binding protein 4 (59 kDa) |
| 14638 | 765 | AI137049 | J | nibrin | nibrin |
| 11937 | 766 | AI137218 | I | | Rattus norvegicus transcribed sequence with moderate similarity to protein |
| | | | | | ref: NP_076977.1 (H. sapiens) hypothetical protein MGC2835 [Homo sapiens] |
| 13111 | 767 | AI137224 | M | oxysterol binding protein-like 1A | oxysterol binding protein-like 1A |
| 5290 | 768 | AI137227 | D | | Rattus norvegicus transcribed sequences |
| 14142 | 769 | AI137435 | K | | Rattus norvegicus transcribed sequences |
| 6638 | 770 | AI137579 | M | | Rattus norvegicus transcribed sequence with strong similarity to protein |
| | | | | | sp: P58006 (M. musculus) SES1_MOUSE Sestrin 1 (p53-regulated protein |
| | | | | | PA26) |
| 16510 | 771 | AI137583 | N | | |
| 7414 | 772 | AI137586 | K | | |
| 13157 | 773 | AI138020 | D | | Rattus norvegicus transcribed sequence with weak similarity to protein |
| | | | | | sp: P48026 (M. musculus) ATDA_MOUSE Diamine acetyltransferase |
| | | | | | (Spermidine/spermine N(1)-acetyltransferase) (SSAT) (Putrescine |
| | | | | | acetyltransferase) |
| 2264 | 774 | AI144741 | F | | Rattus norvegicus transcribed sequences |
| 14458 | 775 | AI145095 | M | | Rattus norvegicus transcribed sequences |
| 3610 | 776 | AI145151 | M, G, I, J | histamine N-methyltransferase | histamine N-methyltransferase |
| 16227 | 777 | AI145177 | F | early growth response 4 | early growth response 4 |
| 165 | 778 | AI145329 | F | malate dehydrogenase, mitochondrial | malate dehydrogenase, mitochondrial |
| 8339 | 779 | AI145761 | M | | Rattus norvegicus Ac2-202 mRNA, complete cds |
| 5531 | 780 | AI145859 | F | | Rattus norvegicus transcribed sequences |
| 18522 | 781 | AI145870 | A, F, I | | Rattus norvegicus transcribed sequence with moderate similarity to protein |
| | | | | | ref: NP_075969.1 (M. musculus) RIKEN cDNA 1110025H10 [Mus musculus] |
| 2059 | 782 | AI146005 | A, H | | Rattus norvegicus transcribed sequence with strong similarity to protein |
| | | | | | sp: Q9WU56 (M. musculus) TRUA_MOUSE tRNA pseudouridine synthase A |
| | | | | | (Pseudouridylate synthase I) (Pseudouridine synthase I) (Uracil hydrolyase) |
| 18503 | 783 | AI169021 | G | calbindin 1 | calbindin 1 |
| 23748 | 784 | AI169037 | F | | Rattus norvegicus transcribed sequence with strong similarity to protein |
| | | | | | sp: Q9R0Q9 (M. musculus) MPU1_MOUSE Mannose-P-dolichol utilization |
| | | | | | defect 1 protein (Suppressor of Lec15 and Lec35 glycosylation mutation |
| | | | | | homolog) (SL15) |
| 5369 | 785 | AI169058 | A | | Rattus norvegicus transcribed sequence with strong similarity to protein |
| | | | | | sp: Q13438 (H. sapiens) OS9_HUMAN Protein OS-9 precursor |
| 7300 | 786 | AI169077 | C | solute carrier family 7 (cationic amino acid transporter, | solute carrier family 7 (cationic amino acid transporter, y + system), member 7 |
| | | | | y + system), member 7 | |
| 11618 | 787 | AI169115 | M, C, F, I | | Rattus norvegicus transcribed sequences |
| 5920 | 788 | AI169163 | B | Na/Pi cotransporter 4 | Na/Pi cotransporter 4 |
| 12979 | 789 | AI169177 | M, B, H, I, L | | Rattus norvegicus transcribed sequence with strong similarity to protein |
| | | | | | sp: P46694 (M. musculus) IEX1_MOUSE Radiation-inducible immediate-early |
| | | | | | gene IEX-1 (Immediate early protein GLY96) (Immediate early response 3 |
| | | | | | protein) |
| 6290 | 790 | AI169232 | C | kinase D-interacting substance of 220 kDa | kinase D-interacting substance of 220 kDa |
| 15002 | 791 | AI169327 | M, E, G, K | tissue inhibitor of metalloproteinase 1 | tissue inhibitor of metalloproteinase 1 |
| 15003 | 791 | AI169327 | G, K | tissue inhibitor of metalloproteinase 1 | tissue inhibitor of metalloproteinase 1 |
| 17160 | 792 | AI169370 | N | alpha-tubulin | alpha-tubulin |
| 16338 | 793 | AI169374 | D | | Rattus norvegicus transcribed sequence with weak similarity to protein |
| | | | | | ref: NP_075794.2 (M. musculus) ubiquitin-associated protein [Mus musculus] |
| 8234 | 794 | AI169517 | B | | Rattus norvegicus transcribed sequence with moderate similarity to protein |
| | | | | | ref: NP_060972.1 (H. sapiens) hypothetical protein PRO1580 [Homo sapiens] |
| 24592 | 795 | AI169622 | D | serine protease inhibitor, Kazal type 1 | serine protease inhibitor, Kazal type 1 |
| 10839 | 796 | AI169655 | G | | Rattus norvegicus transcribed sequence with weak similarity to protein |
| | | | | | ref: NP_035061.1 (M. musculus) nuclear protein 95 [Mus musculus] |
| 12682 | 797 | AI169656 | D | solute carrier family 22 member 8 | solute carrier family 22 member 8 |
| 11429 | 798 | AI169706 | H | ceroid-lipofuscinosis, neuronal 2 | ceroid-lipofuscinosis, neuronal 2 |
| 8749 | 799 | AI169802 | N | ferritin, heavy polypeptide 1 | ferritin, heavy polypeptide 1 |
| 3916 | 800 | AI169947 | M, I | | Rattus norvegicus transcribed sequences |
| 16898 | 801 | AI170249 | B | | Rattus norvegicus transcribed sequence with strong similarity to protein |
| | | | | | ref: NP_061367.1 (M. musculus) G21 protein [Mus musculus] |
| 14929 | 802 | AI170353 | M, G, K | ribosomal protein L21 | ribosomal protein L21 |
| 5297 | 803 | AI170379 | M, D | | Rattus norvegicus transcribed sequence with strong similarity to protein |
| | | | | | sp: O54931 (M. musculus) AKA2_MOUSE A-kinase anchor protein 2 (Protein |
| | | | | | kinase A anchoring protein 2) (PRKA2) (AKAP expressed in kidney and lung) |
| | | | | | (AKAP-KL) |
| 18687 | 804 | AI170568 | N | dodecenoyl-coenzyme A delta isomerase | dodecenoyl-coenzyme A delta isomerase |
| 2534 | 805 | AI170632 | D, K | | Rattus norvegicus transcribed sequences |
| 15393 | 806 | AI170663 | J | gap junction membrane channel protein alpha 1 | gap junction membrane channel protein alpha 1 |
| 10130 | 807 | AI170759 | M, A, I | | Rattus norvegicus transcribed sequences |
| 3803 | 808 | AI170773 | A | | Rattus norvegicus transcribed sequence with moderate similarity to protein |
| | | | | | sp: Q04637 (H. sapiens) IF4G_HUMAN Eukaryotic translation initiation factor 4 |
| | | | | | gamma (elF-4-gamma) (elF-4G) (elF4G) (P220) |
| 2812 | 809 | AI171090 | J | 3-hydroxy-3-methylglutaryl CoA lyase | 3-hydroxy-3-methylglutaryl CoA lyase |
| 22985 | 810 | AI171093 | A, F | | Rattus norvegicus transcribed sequences |
| 22626 | 811 | AI171159 | M, K | a disintegrin and metalloproteinase with | a disintegrin and metalloproteinase with thrombospondin motifs 1 (ADAMTS- |
| | | | | thrombospondin motifs 1 (ADAMTS-1) | 1) |
| 736 | 812 | AI171314 | G | | Rattus norvegicus transcribed sequence with weak similarity to protein |
| | | | | | pdb: 1DT7 (R. norvegicus) A Chain A, Solution Structure Of The C-Terminal |
| | | | | | Negative Regulatory Domain Of P53 In A Complex With Ca2+-Bound |
| | | | | | S100b(Bb) |
| 13285 | 813 | AI171361 | A | | Rattus norvegicus transcribed sequence with strong similarity to protein |
| | | | | | ref: NP_473384.1 (M. musculus) Musashi homolog 2 (Drosophila) [Mus |
| | | | | | musculus] |
| 20828 | 814 | AI171462 | M, E, K | CD24 antigen | CD24 antigen |
| 11761 | 815 | AI171526 | A | | Rattus norvegicus transcribed sequence with moderate similarity to protein |
| | | | | | pdb: 1LBG (E. coli) B Chain B, Lactose Operon Repressor Bound To 21-Base |
| | | | | | Pair Symmetric Operator Dna, Alpha Carbons Only |
| 8215 | 816 | AI171692 | D | | Rattus norvegicus transcribed sequence with strong similarity to protein |
| | | | | | pir: S48737 (R. norvegicus) S48737 kynurenine aminotransferase - rat |
| 10087 | 817 | AI171803 | M | methylmalonate semialdehyde dehydrogenase gene | methylmalonate semialdehyde dehydrogenase gene |
| 11708 | 818 | AI171807 | M | | Rattus norvegicus transcribed sequences |
| 22747 | 819 | AI171832 | M | | Rattus norvegicus transcribed sequence with moderate similarity to protein |
| | | | | | ref: NP_079752.1 (M. musculus) RIKEN cDNA 2410005O16 [Mus musculus] |
| 7197 | 820 | AI171962 | M, G, K, L | annexin 1 | annexin 1 |
| 21956 | 821 | AI171980 | L | | Rattus norvegicus transcribed sequences |
| 11205 | 822 | AI172057 | G | | Rattus norvegicus transcribed sequences |
| 6630 | 823 | AI172184 | F | | Rattus norvegicus transcribed sequence with weak similarity to protein |
| | | | | | sp: P07825 (R. norvegicus) SYPH_RAT SYNAPTOPHYSIN (MAJOR |
| | | | | | SYNAPTIC VESICLE PROTEIN P38) |
| 3698 | 824 | AI172193 | C | | Rattus norvegicus transcribed sequence with strong similarity to protein |
| | | | | | sp: Q9CWP8 (M. musculus) DPD4_MOUSE DNA polymerase delta subunit 4 |
| | | | | | (DNA polymerase delta subunit p12) |
| 18681 | 825 | AI172206 | J | | Rattus norvegicus transcribed sequence with weak similarity to protein |
| | | | | | sp: Q9WUK2 (M. musculus) IF4H_MOUSE Eukaryotic translation initiation |
| | | | | | factor 4H (elF-4H) (Williams-Beuren syndrome chromosome region 1 protein |
| | | | | | homolog) |
| 11968 | 826 | AI172208 | F | | Rattus norvegicus transcribed sequence with weak similarity to protein |
| | | | | | sp: P02773 (R. norvegicus) FETA_RAT Alpha-fetoprotein precursor (Alpha- |
| | | | | | fetoglobulin) (Alpha-1-fetoprotein) |
| 21975 | 827 | AI172247 | N, B, L | xanthine dehydrogenase | xanthine dehydrogenase |
| 21842 | 828 | AI172293 | N | sterol-C4-methyl oxidase-like | sterol-C4-methyl oxidase-like |
| 15382 | 829 | AI172302 | M, H | | Rattus norvegicus transcribed sequence with weak similarity to protein |
| | | | | | pir: S43056 (M. musculus) S43056 hypothetical protein - mouse |
| 17887 | 830 | AI172414 | J | brain protein 44-like | brain protein 44-like |
| 13106 | 831 | AI172615 | D | | Rattus norvegicus transcribed sequences |
| 13457 | 832 | AI175319 | F | | Rattus norvegicus transcribed sequences |
| 4445 | 833 | AI175466 | G | | Rattus norvegicus transcribed sequence with weak similarity to protein |
| | | | | | sp: P20171 (R. norvegicus) RASH_RAT TRANSFORMING PROTEIN P21/H- |
| | | | | | RAS-1 (C-H-RAS) |
| 15663 | 834 | AI175566 | M | t-complex testis expressed 1 | t-complex testis expressed 1 |
| 22352 | 835 | AI175959 | M, H | v-jun sarcoma virus 17 oncogene homolog (avian) | v-jun sarcoma virus 17 oncogene homolog (avian) |
| 22311 | 836 | AI176007 | B | | Rattus norvegicus transcribed sequences |
| 17223 | 837 | AI176140 | D | | Rattus norvegicus transcribed sequence with strong similarity to protein |
| | | | | | ref: NP_077751.1 (M. musculus) testis expressed gene 189 [Mus musculus] |
| 6782 | 838 | AI176170 | B | FK506-binding protein 1a | FK506-binding protein 1a |
| 17921 | 839 | AI176422 | F | | Rattus norvegicus transcribed sequence with strong similarity to protein |
| | | | | | pir: S41115 (H. sapiens) S41115 probable flavoprotein-ubiquinone |
| | | | | | oxidoreductase (EC 1.6.5.—) - human |
| 15191 | 840 | AI176456 | M, N, F, L | | Rattus norvegicus transcribed sequence with strong similarity to protein |
| | | | | | sp: P04355 (R. norvegicus) MT2_RAT METALLOTHIONEIN-II (MT-II) |
| 21088 | 841 | AI176472 | A | | Rattus norvegicus transcribed sequences |
| 24236 | 842 | AI176473 | M | | Rattus norvegicus transcribed sequences |
| 18418 | 843 | AI176483 | D | | Rattus norvegicus transcribed sequences |
| 20717 | 844 | AI176504 | N | glutaminase | glutaminase |
| 16518 | 845 | AI176546 | N, C, K | heat shock protein 86 | heat shock protein 86 |
| 3431 | 846 | AI176595 | N | Cathepsin L | Cathepsin L |
| 17516 | 847 | AI176621 | A, E, L | iron-responsive element-binding protein | iron-responsive element-binding protein |
| 17735 | 848 | AI176658 | C, K | heat shock 27 kDa protein 1 | heat shock 27 kDa protein 1 |
| 23299 | 849 | AI176839 | M | | Rattus norvegicus transcribed sequences |
| 22103 | 850 | AI176849 | L | | Rattus norvegicus transcribed sequence with moderate similarity to protein |
| | | | | | sp: Q92503 (H. sapiens) SC14_HUMAN SEC14-like protein 1 |
| 15146 | 851 | AI176969 | M, K | | Rattus norvegicus transcribed sequences |
| 20873 | 852 | AI177042 | G | | Rattus norvegicus DD6G4-2 mRNA, partial sequence |
| 23018 | 853 | AI177093 | D | | Rattus norvegicus transcribed sequence with moderate similarity to protein |
| | | | | | ref: NP_038755.1 (M. musculus) 5-azacytidine induced gene 2 [Mus musculus] |
| 13310 | 854 | AI177119 | L | | Rattus norvegicus transcribed sequence with weak similarity to protein |
| | | | | | pir: S49158 (R. norvegicus) S49158 complement protein C1q beta chain |
| | | | | | precursor - rat |
| 14083 | 855 | AI177181 | C | | Rattus norvegicus transcribed sequence with weak similarity to protein |
| | | | | | ref: NP_076976.1 (H. sapiens) hypothetical protein MGC2550 [Homo sapiens] |
| 15964 | 856 | AI177360 | M, A, B, H, I, | | Rattus norvegicus transcribed sequences |
| | | | K, L | | |
| 14989 | 857 | AI177366 | M, K | Integrin, beta 1 | Integrin, beta 1 |
| 14978 | 858 | AI177386 | F | protein tyrosine phosphatase, receptor type, D | protein tyrosine phosphatase, receptor type, D |
| 4987 | 859 | AI177428 | F | | Rattus norvegicus transcribed sequence with strong similarity to protein |
| | | | | | ref: NP_055556.1 (H. sapiens) KIAA0652 gene product [Homo sapiens] |
| 18095 | 860 | AI177482 | D | chaperonin subunit 4 (delta) | chaperonin subunit 4 (delta) |
| 15642 | 861 | AI177503 | M, F, J | H3 histone, family 3B | H3 histone, family 3B |
| 150 | 862 | AI177510 | F | | Rattus norvegicus transcribed sequences |
| 17570 | 863 | AI177683 | N, C, E | | Rattus norvegicus mRNA for hnRNP protein, partial |
| 14425 | 864 | AI177755 | M, L | pre-B-cell colony-enhancing factor | pre-B-cell colony-enhancing factor |
| 14484 | 865 | AI177867 | M | | Rattus norvegicus transcribed sequence with weak similarity to protein |
| | | | | | ref: NP_062100.1 (R. norvegicus) intersectin (SH3 domain protein 1A) [Rattus |
| | | | | | norvegicus] |
| 3834 | 866 | AI177902 | G | | Rattus norvegicus transcribed sequence with strong similarity to protein |
| | | | | | ref: NP_080665.1 (M. musculus) RIKEN cDNA 1300003F06 [Mus musculus] |
| 5929 | 867 | AI177962 | E | | Rattus norvegicus transcribed sequence with moderate similarity to protein |
| | | | | | pir: S23251 (M. musculus) S23251 protein-tyrosine kinase (EC 2.7.1.112) ark |
| | | | | | precursor - mouse |
| 17833 | 868 | AI177992 | F | hemoglobin beta chain complex | hemoglobin beta chain complex |
| 19184 | 869 | AI178025 | M, H, I | | Rattus norvegicus transcribed sequence with strong similarity to protein |
| | | | | | sp: P70284 (M. musculus) TGIF_MOUSE 5′-TG-3′ INTERACTING FACTOR |
| | | | | | (HOMEOBOX PROTEIN TGIF) |
| 15259 | 870 | AI178135 | N | complement component 1, q subcomponent binding | complement component 1, q subcomponent binding protein |
| | | | | protein | |
| 6059 | 871 | AI178245 | M, J | | Rattus norvegicus transcribed sequence with moderate similarity to protein |
| | | | | | pir: T13963 (M. musculus) T13963 formin related protein, lymphocyte specific - |
| | | | | | mouse |
| 18996 | 872 | AI178326 | J | | Rattus norvegicus transcribed sequence with strong similarity to protein |
| | | | | | ref: NP_077291.1 (H. sapiens) hypothetical protein MGC4175 [Homo sapiens] |
| 8445 | 873 | AI178394 | J | | Rattus norvegicus transcribed sequences |
| 22197 | 874 | AI178527 | M, H | | Rattus norvegicus clone D920 intestinal epithelium proliferating cell- |
| | | | | | associated mRNA sequence |
| 17563 | 875 | AI178750 | N | eukaryotic translation elongation factor 2 | eukaryotic translation elongation factor 2 |
| 22648 | 876 | AI178996 | A | | Rattus norvegicus transcribed sequence with weak similarity to protein |
| | | | | | sp: Q10758 (R. norvegicus) K2C8_RAT Keratin, type II cytoskeletal 8 |
| | | | | | (Cytokeratin 8) (Cytokeratin endo A) |
| 14983 | 877 | AI179150 | D | | |
| 8477 | 878 | AI179167 | M | | Rattus norvegicus transcribed sequence with strong similarity to protein |
| | | | | | pdb: 1BGM (E. coli) O Chain O, Beta-Galactosidase (Chains I-P) |
| 13611 | 879 | AI179378 | M, F, H | protease, serine, 8 (prostasin) | protease, serine, 8 (prostasin) |
| 13634 | 880 | AI179381 | M | activating transcription factor ATF-4 | activating transcription factor ATF-4 |
| 13607 | 881 | AI179403 | H | | Rattus norvegicus transcribed sequence with weak similarity to protein |
| | | | | | sp: O75643 (H. sapiens) U520_HUMAN U5 small nuclear ribonucleoprotein |
| | | | | | 200 kDa helicase (U5 snRNP-specific 200 kDa protein) (U5-200 KD) |
| 13614 | 882 | AI179407 | B, L | | Rattus norvegicus transcribed sequences |
| 15042 | 883 | AI179422 | M | | Rattus norvegicus transcribed sequences |
| 17829 | 884 | AI179576 | N, J | hemoglobin beta chain complex | hemoglobin beta chain complex |
| 23151 | 885 | AI179595 | B, L | FXYD domain-containing ion transport regulator 6 | FXYD domain-containing ion transport regulator 6 |
| 19822 | 886 | AI179599 | A | Ras-related GTP-binding protein Rab29 | Ras-related GTP-binding protein Rab29 |
| 5901 | 887 | AI179605 | D | | Rattus norvegicus transcribed sequences |
| 16081 | 888 | AI179610 | N | Heme oxygenase | Heme oxygenase |
| 3049 | 889 | AI179892 | M | lipocalin 7 | lipocalin 7 |
| 1687 | 890 | AI179971 | J | hemoglobin, alpha 1 | hemoglobin, alpha 1 |
| 22569 | 891 | AI179979 | M, I | | Rattus norvegicus transcribed sequence with weak similarity to protein |
| | | | | | ref: NP_077349.1 (R. norvegicus) polypeptide GalNAc transferase T1 [Rattus |
| | | | | | norvegicus] |
| 5481 | 892 | AI180170 | M | | Rattus norvegicus transcribed sequence with strong similarity to protein |
| | | | | | pir: S50853 (H. sapiens) S50853 translation releasing factor eRF-1 [validated] - |
| | | | | | human |
| 6765 | 893 | AI227761 | M, H, I | | Rattus norvegicus transcribed sequence with weak similarity to protein |
| | | | | | sp: Q9JLT0 (R. norvegicus) MYHA_RAT Myosin heavy chain, nonmuscle type |
| | | | | | B (Cellular myosin heavy chain, type B) (Nonmuscle myosin heavy chain-B) |
| | | | | | (NMMHC-B) |
| 6487 | 894 | AI227919 | M | | Rattus norvegicus transcribed sequences |
| 19188 | 895 | AI227938 | G, J | | Rattus norvegicus transcribed sequences |
| 1651 | 896 | AI228068 | A, H | Peptidylglycine alpha-amidating monooxygenase | Peptidylglycine alpha-amidating monooxygenase |
| 16913 | 897 | AI228236 | E | | Rattus norvegicus transcribed sequence with strong similarity to protein |
| | | | | | ref: NP_062308.1 (M. musculus) neuronal protein 15.6 [Mus musculus] |
| 15879 | 898 | AI228313 | M, K | | Rattus norvegicus transcribed sequences |
| 13727 | 899 | AI228326 | M, A | | Rattus norvegicus transcribed sequence with weak similarity to protein |
| | | | | | ref: NP_491986.1 (C. elegans) C30F12.2.p [Caenorhabditis elegans] |
| 6102 | 900 | AI228335 | L | | Rattus norvegicus transcribed sequences |
| 17892 | 901 | AI228438 | H | | Rattus norvegicus transcribed sequence with weak similarity to protein |
| | | | | | prf: 2112356A (R. norvegicus) 2112356A hepatocyte nuclear factor [Rattus |
| | | | | | norvegicus] |
| 13740 | 902 | AI228455 | A | | Rattus norvegicus transcribed sequence with moderate similarity to protein |
| | | | | | ref: NP_037457.2 (H. sapiens) KIAA0943 protein [Homo sapiens] |
| 1474 | 903 | AI228548 | N | | Rattus norvegicus transcribed sequence with strong similarity to protein |
| | | | | | sp: P35467 (R. norvegicus) S10A_RAT S-100 protein, alpha chain |
| 18612 | 904 | AI228624 | G | ribosomal protein L29 | ribosomal protein L29 |
| 13176 | 905 | AI228654 | M | | Rattus norvegicus transcribed sequences |
| 4392 | 906 | AI228674 | H | Peptidylprolyl isomerase A (cyclophilin A) | Peptidylprolyl isomerase A (cyclophilin A) |
| 15296 | 907 | AI228738 | N, H, I | (FK506 binding protein 2, FK506-binding protein 1a) | (FK506 binding protein 2, FK506-binding protein 1a) |
| 22328 | 908 | AI229142 | M | | Rattus norvegicus transcribed sequences |
| 7892 | 909 | AI229172 | K | | Rattus norvegicus transcribed sequence with weak similarity to protein |
| | | | | | sp: P06399 (R. norvegicus) FIBA_RAT Fibrinogen alpha/alpha-E chain |
| | | | | | precursor |
| 6886 | 910 | AI229332 | F | | Rattus norvegicus transcribed sequence |
| 23435 | 911 | AI229502 | H, I | | Rattus norvegicus transcribed sequence with weak similarity to protein |
| | | | | | ref: NP_061898.1 (H. sapiens) chromosome 20 open reading frame 16 [Homo |
| | | | | | sapiens] |
| 17448 | 912 | AI229637 | N | MYB binding protein 1a | MYB binding protein 1a |
| 3099 | 913 | AI229680 | E | | Rattus norvegicus transcribed sequence with moderate similarity to protein |
| | | | | | ref: NP_004542.1 (H. sapiens) NADH dehydrogenase (ubiquinone) Fe—S |
| | | | | | protein 3 (30 kD) (NADH-coenzyme Q reductase) [Homo sapiens] |
| 1652 | 914 | AI229728 | A | Peptidylglycine alpha-amidating monooxygenase | Peptidylglycine alpha-amidating monooxygenase |
| 9035 | 915 | AI229879 | F, J | | Rattus norvegicus transcribed sequences |
| 11866 | 916 | AI229966 | F | | Rattus norvegicus transcribed sequence with strong similarity to protein |
| | | | | | ref: NP_032776.1 (M. musculus) nucleoredoxin [Mus musculus] |
| 12587 | 917 | AI229979 | M | | Rattus norvegicus transcribed sequence with weak similarity to protein |
| | | | | | sp: Q63344 (R. norvegicus) MOT2_RAT Monocarboxylate transporter 2 (MCT |
| | | | | | 2) |
| 24042 | 918 | AI230002 | C | | Rattus norvegicus transcribed sequences |
| 12551 | 919 | AI230056 | C, K | | Rattus norvegicus transcribed sequences |
| 6629 | 920 | AI230165 | D | | Rattus norvegicus transcribed sequence with strong similarity to protein |
| | | | | | ref: NP_057038.1 (H. sapiens) CGI-26 protein [Homo sapiens] |
| 15862 | 921 | AI230228 | N | | Rattus norvegicus phosphoserine aminotransferase mRNA, complete cds |
| 4280 | 922 | AI230247 | F | selenoprotein P, plasma, 1 | selenoprotein P, plasma, 1 |
| 14450 | 923 | AI230262 | B | | Rattus norvegicus transcribed sequence with weak similarity to protein |
| | | | | | sp: Q13045 (H. sapiens) FLIH_HUMAN Flightless-I protein homolog |
| 18528 | 924 | AI230284 | K | Tropomycin 4 | Tropomycin 4 |
| 20895 | 925 | AI230549 | H | | Rattus norvegicus transcribed sequences |
| 12961 | 926 | AI230554 | M | | Rattus norvegicus transcribed sequences |
| 24264 | 927 | AI230712 | M | Subtilisin - like endoprotease | Subtilisin - like endoprotease |
| 18529 | 928 | AI230716 | M, K | Tropomycin 4 | Tropomycin 4 |
| 13618 | 929 | AI230724 | M, I | SAC1 (supressor of actin mutations 1, homolog)-like (S. cerevisiae) | SAC1 (supressor of actin mutations 1, homolog)-like (S. cerevisiae) |
| 24108 | 930 | AI230728 | G | | Rattus norvegicus transcribed sequence with strong similarity to protein |
| | | | | | pir: S42114 (M. musculus) S42114 small nuclear ribonucleoprotein U1A- |
| | | | | | mouse |
| 21648 | 931 | AI230880 | J | | Rattus norvegicus transcribed sequence with weak similarity to protein |
| | | | | | pir: JE0343 (R. norvegicus) JE0343 terf protein - rat |
| 1688 | 932 | AI230970 | J | hemoglobin, alpha 1 | hemoglobin, alpha 1 |
| 16087 | 933 | AI231011 | F | | Rattus norvegicus transcribed sequences |
| 3125 | 934 | AI231028 | K | erythrocyte protein band 4.1-like 1 | erythrocyte protein band 4.1-like 1 |
| 13934 | 935 | AI231044 | F | | Rattus norvegicus transcribed sequences |
| 15132 | 936 | AI231180 | G | calcium-regulated heat-stable protein (24 kD) | calcium-regulated heat-stable protein (24 kD) |
| 18678 | 937 | AI231295 | L | | Rattus norvegicus transcribed sequences |
| 17268 | 938 | AI231317 | F | | Rattus norvegicus transcribed sequence with strong similarity to protein |
| | | | | | ref: NP_080171.1 (M. musculus) endothelial-derived gene [Mus musculus] |
| 3050 | 939 | AI231321 | M | lipocalin 7 | lipocalin 7 |
| 13966 | 940 | AI231421 | B | nuclear ubiquitous casein kinase 2 | nuclear ubiquitous casein kinase 2 |
| 12343 | 941 | AI231433 | C | | Rattus norvegicus transcribed sequences |
| 17196 | 942 | AI231519 | M, N, I | sialyltransferase 7c | sialyltransferase 7c |
| 13092 | 943 | AI231547 | L | | Rattus norvegicus transcribed sequence with strong similarity to protein |
| | | | | | pir: S14538 (M. musculus) S14538 transition protein - mouse |
| 15171 | 944 | AI231792 | H | | Rattus norvegicus transcribed sequence with strong similarity to protein |
| | | | | | sp: Q9JLV1 (M. musculus) BAG3_MOUSE BAG-family molecular chaperone |
| | | | | | regulator-3 (BCL-2 binding athanogene-3) (BAG-3) (Bcl-2-binding protein Bis) |
| 8211 | 945 | AI231807 | H | ferritin light chain 1 | ferritin light chain 1 |
| 8212 | 945 | AI231807 | N, L | ferritin light chain 1 | ferritin light chain 1 |
| 20702 | 946 | AI231821 | N | stathmin 1 | stathmin 1 |
| 10789 | 947 | AI232059 | M | aspartoacylase | aspartoacylase |
| 14020 | 948 | AI232076 | M | | Rattus norvegicus transcribed sequence with moderate similarity to protein |
| | | | | | ref: NP_076138.1 (M. musculus) harmonin isoform a1 [Mus musculus] |
| 573 | 949 | AI232087 | N, J | hydroxyacid oxidase (glycolate oxidase) 3 | hydroxyacid oxidase (glycolate oxidase) 3 |
| 12366 | 950 | AI232088 | F | | Rattus norvegicus transcribed sequences |
| 15039 | 951 | AI232096 | M, F, I | solute carrier family 15, member 2 | solute carrier family 15, member 2 |
| 9332 | 952 | AI232210 | F | MIC2 like 1 | MIC2 like 1 |
| 409 | 953 | AI232268 | M, N, I | low density lipoprotein receptor-related protein | low density lipoprotein receptor-related protein associated protein 1 |
| | | | | associated protein 1 | |
| 15955 | 954 | AI232294 | M, G, I | | Rattus norvegicus transcribed sequences |
| 15246 | 955 | AI232332 | D | | Rattus norvegicus transcribed sequence with moderate similarity to protein |
| | | | | | pdb: 1LBG (E. coli) B Chain B, Lactose Operon Repressor Bound To 21-Base |
| | | | | | Pair Symmetric Operator Dna, Alpha Carbons Only |
| 24321 | 956 | AI232340 | M, K, L | chemokine (C—X—C motif) ligand 12 | chemokine (C—X—C motif) ligand 12 |
| 16172 | 957 | AI232341 | K | | Rattus norvegicus transcribed sequence with weak similarity to protein |
| | | | | | ref: NP_498462.1 (C. elegans) C13B9.2.p [Caenorhabditis elegans] |
| 5601 | 958 | AI232461 | M, I | flavin containing monooxygenase 4 | flavin containing monooxygenase 4 |
| 11157 | 959 | AI232494 | K | | Rattus norvegicus transcribed sequence with strong similarity to protein |
| | | | | | pdb: 1BGM (E. coli) O Chain O, Beta-Galactosidase (Chains I-P) |
| 4440 | 960 | AI232643 | M, I | | Rattus norvegicus transcribed sequences |
| 7285 | 961 | AI232731 | M | | Rattus norvegicus transcribed sequence with moderate similarity to protein |
| | | | | | ref: NP_080434.1 (M. musculus) RIKEN cDNA 0610042E07 [Mus musculus] |
| 17695 | 962 | AI232784 | E | | Rattus norvegicus transcribed sequence with weak similarity to protein |
| | | | | | sp: P97852 (R. norvegicus) DHB4_RAT Estradiol 17 beta-dehydrogenase 4 (17- |
| | | | | | beta-HSD 4) (17-beta-hydroxysteroid dehydrogenase 4) (HSD IV) |
| 12467 | 963 | AI232924 | M | | Rattus norvegicus transcribed sequences |
| 19998 | 964 | AI232999 | M | PDZ domain containing 1 | PDZ domain containing 1 |
| 3823 | 965 | AI233147 | M | | Rattus norvegicus transcribed sequence with weak similarity to protein |
| | | | | | sp: Q63413 (R. norvegicus) HE47_RAT Probable ATP-dependent RNA |
| | | | | | helicase p47 |
| 11967 | 966 | AI233155 | M, J | | Rattus norvegicus transcribed sequences |
| 13954 | 967 | AI233209 | M | crystallin, mu | crystallin, mu |
| 4574 | 968 | AI233216 | N | glutamate dehydrogenase 1 | glutamate dehydrogenase 1 |
| 17907 | 969 | AI233224 | M | epidermal growth factor receptor | epidermal growth factor receptor |
| 10378 | 970 | AI233300 | A | | Rattus norvegicus transcribed sequence with moderate similarity to protein |
| | | | | | sp: P06684 (M. musculus) CO5_MOUSE Complement C5 precursor (Hemolytic |
| | | | | | complement) [Contains: C5A anaphylatoxin] |
| 14120 | 971 | AI233433 | K | | Rattus norvegicus transcribed sequences |
| 19509 | 972 | AI233437 | L | | Rattus norvegicus transcribed sequences |
| 14095 | 973 | AI233468 | M, I | | Rattus norvegicus transcribed sequence with weak similarity to protein |
| | | | | | ref: NP_542421.1 (R. norvegicus) cask-interacting protein 1 [Rattus |
| | | | | | norvegicus] |
| 14131 | 974 | AI233493 | L | | Rattus norvegicus transcribed sequences |
| 6046 | 975 | AI233530 | M, B, I, L | | Rattus norvegicus transcribed sequences |
| 7888 | 976 | AI233583 | M | tissue inhibitor of metalloproteinase 2 | tissue inhibitor of metalloproteinase 2 |
| 3816 | 977 | AI233729 | H | | Rattus norvegicus transcribed sequence with strong similarity to protein |
| | | | | | ref: NP_542121.1 (M. musculus) proteasome (prosome, macropain) 26S |
| | | | | | subunit, non-ATPase, 5 [Mus musculus] |
| 7804 | 978 | AI233771 | K | | Rattus norvegicus transcribed sequences |
| 13563 | 979 | AI233773 | E | MAWD binding protein | MAWD binding protein |
| 1653 | 980 | AI233806 | A | Peptidylglycine alpha-amidating monooxygenase | Peptidylglycine alpha-amidating monooxygenase |
| 535 | 981 | AI233916 | E | | Rattus norvegicus transcribed sequences |
| 13392 | 982 | AI234146 | M | cysteine rich protein 1 | cysteine rich protein 1 |
| 8325 | 983 | AI234293 | E | | Rattus norvegicus transcribed sequence with weak similarity to protein |
| | | | | | ref: NP_008958.1 (H. sapiens) topoisomerase (DNA) II binding protein [Homo |
| | | | | | sapiens] |
| 6416 | 984 | AI234295 | M, K | solute carrier family 34 (sodium phosphate), member 2 | solute carrier family 34 (sodium phosphate), member 2 |
| 17764 | 985 | AI234604 | N | heat shock protein 8 | heat shock protein 8 |
| 14677 | 986 | AI234620 | M, G, K, L | | Rattus norvegicus transcribed sequence with weak similarity to protein |
| | | | | | ref: NP_071796.1 (R. norvegicus) plectin [Rattus norvegicus] |
| 22213 | 987 | AI234858 | K | | Rattus norvegicus transcribed sequence with weak similarity to protein |
| | | | | | pir: JC7152 (M. musculus) JC7152 UV-damaged DNA-binding 127K protein - |
| | | | | | mouse |
| 26319 | 988 | AI234887 | H | | Rattus norvegicus transcribed sequence with strong similarity to protein |
| | | | | | ref: NP_076401.1 (M. musculus) ubiquitous protein kinase-like (105 kDa) [Mus |
| | | | | | musculus] |
| 15277 | 989 | AI234889 | D | ubiquitin-conjugating enzyme E2D 3 (homologous to | ubiquitin-conjugating enzyme E2D 3 (homologous to yeast UBC4/5) |
| | | | | yeast UBC4/5) | |
| 22662 | 990 | AI234939 | M | | Rattus norvegicus transcribed sequence with strong similarity to protein |
| | | | | | ref: NP_076320.1 (M. musculus) RIKEN cDNA 1500035H01 [Mus musculus] |
| 24649 | 991 | AI234950 | C, K | acid phosphatase 2 | acid phosphatase 2 |
| 3875 | 992 | AI235047 | M, A | | Rattus norvegicus transcribed sequence with strong similarity to protein |
| | | | | | pir: S50082 (H. sapiens) S50082 nuclear cap binding protein - human |
| 8850 | 993 | AI235059 | B | | Rattus norvegicus transcribed sequences |
| 15004 | 994 | AI235224 | M, G, K | tissue inhibitor of metalloproteinase 1 | tissue inhibitor of metalloproteinase 1 |
| 6632 | 995 | AI235277 | C | | Rattus norvegicus transcribed sequence with strong similarity to protein |
| | | | | | sp: P54577 (H. sapiens) SYY_HUMAN Tyrosyl-tRNA synthetase (Tyrosyl - |
| | | | | | tRNA ligase) (TyrRS) |
| 896 | 996 | AI235313 | E | | Rattus norvegicus transcribed sequences |
| 15468 | 997 | AI235364 | N | ribosomal protein S15a | ribosomal protein S15a |
| 7937 | 998 | AI235414 | B | | Rattus norvegicus transcribed sequences |
| 1462 | 999 | AI235585 | M, E, G | cathepsin D | cathepsin D |
| 21061 | 1000 | AI235631 | M, A | | Rattus norvegicus transcribed sequence with strong similarity to protein |
| 21061 | 1000 | AI235631 | M, A | | ref: NP_114131.1 (H. sapiens) transmembrane protein induced by tumor |
| | | | | | necrosis factor alpha [Homo sapiens] |
| 11164 | 1001 | AI235739 | M, I | | Rattus norvegicus transcribed sequence with moderate similarity to protein |
| | | | | | pir: A56716 (H. sapiens) A56716 aromatic ester hydrolase (EC 3.1.1.—) - human |
| 7307 | 1002 | AI235935 | G, K | | Rattus norvegicus transcribed sequence with weak similarity to protein |
| | | | | | ref: NP_071953.1 (R. norvegicus) C1-tetrahydrofolate synthase [Rattus |
| | | | | | norvegicus] |
| 15836 | 1003 | AI235951 | A | | Rattus norvegicus transcribed sequence with moderate similarity to protein |
| | | | | | ref: NP_004540.1 (H. sapiens) NADH dehydrogenase (ubiquinone) 1, |
| | | | | | subcomplex unknown, 2 (14.5 kD, B14.5b) [Homo sapiens] |
| 3091 | 1004 | AI236027 | M, A, C, H, I | | Rattus norvegicus transcribed sequences |
| 14867 | 1005 | AI236061 | M | | Rattus norvegicus transcribed sequences |
| 22855 | 1006 | AI236150 | A | | Rattus norvegicus transcribed sequence with strong similarity to protein |
| | | | | | ref: NP_062416.1 (M. musculus) Down syndrome critical region protein c [Mus |
| | | | | | musculus] |
| 13004 | 1007 | AI236284 | J, L | fatty acid Coenzyme A ligase, long chain 4 | fatty acid Coenzyme A ligase, long chain 4 |
| 15051 | 1008 | AI236332 | M | | Rattus norvegicus Ab2-402 mRNA, complete cds |
| 1689 | 1009 | AI236360 | J | hemoglobin, alpha 1 | hemoglobin, alpha 1 |
| 10667 | 1010 | AI236366 | C | siah binding protein 1; FBP interacting repressor; | siah binding protein 1; FBP interacting repressor; pyrimidine tract binding |
| | | | | pyrimidine tract binding splicing factor; Ro | splicing factor; Ro ribonucleoprotein-binding protein 1 |
| | | | | nbonucleoprotein-binding protein 1 | |
| 783 | 1011 | AI236589 | F | lipase, hormone sensitive | lipase, hormone sensitive |
| 17950 | 1012 | AI236590 | L | | Rattus norvegicus transcribed sequence with strong similarity to protein |
| | | | | | sp: P22366 (M. musculus) MY88_MOUSE MYELOID DIFFERENTIATION |
| | | | | | PRIMARY RESPONSE PROTEIN MYD88 |
| 18259 | 1013 | AI236601 | H | | Rattus norvegicus transcribed sequence with strong similarity to protein |
| | | | | | sp: Q81699 (M. musculus) H105_MOUSE Heat-shock protein 105 kDa (Heat |
| | | | | | shock-related 100 kDa protein E7I) (HSP-E7I) (Heat shock 110 kDa protein) |
| | | | | | (42 degrees C-HSP) |
| 2574 | 1014 | AI236616 | F | | Rattus norvegicus transcribed sequences |
| 16859 | 1015 | AI236753 | M, D | | Rattus norvegicus transcribed sequences |
| 5208 | 1016 | AI236754 | G | pregnancy-induced growth inhibitor | pregnancy-induced growth inhibitor |
| 24388 | 1017 | AI236772 | M, K | | Rattus norvegicus transcribed sequence with weak similarity to protein |
| | | | | | ref: NP_113865.1 (R. norvegicus) four and a half LIM domains 2 [Rattus |
| | | | | | norvegicus] |
| 15850 | 1018 | AI236795 | N, K | | Rattus norvegicus heat shock protein 90 beta mRNA, partial sequence |
| 18303 | 1019 | AI236863 | M | | Rattus norvegicus transcribed sequences |
| 19890 | 1020 | AI237108 | F | | Rattus norvegicus transcribed sequences |
| 23076 | 1021 | AI237388 | K | | Rattus norvegicus transcribed sequence with weak similarity to protein |
| | | | | | sp: P20695 (R. norvegicus) IFR1_RAT INTERFERON-RELATED |
| | | | | | DEVELOPMENTAL REGULATOR 1 (NERVE GROWTH FACTOR- |
| | | | | | INDUCIBLE PROTEIN PC4) (IRPR) |
| 21653 | 1022 | AI237535 | M, C, K | LPS-induced TNF-alpha factor | LPS-induced TNF-alpha factor |
| 3615 | 1023 | AI237645 | J | | Rattus norvegicus transcribed sequences |
| 8759 | 1024 | AI237646 | B, L | | Rattus norvegicus transcribed sequences |
| 3467 | 1025 | AI237835 | M, I | | Rattus norvegicus transcribed sequence with moderate similarity to protein |
| | | | | | sp: O09015 (R. norvegicus) MXI1_RAT MAX interacting protein 1 (MXI1 |
| | | | | | protein) |
| 6127 | 1026 | AI638960 | A | | Rattus norvegicus transcribed sequences |
| 11692 | 1027 | AI638982 | M, N | sulfotransferase family, cytosolic, 1C, member 2 | sulfotransferase family, cytosolic, 1C, member 2 |
| 20000 | 1028 | AI638989 | A, B | | Rattus norvegicus transcribed sequence with moderate similarity to protein |
| | | | | | pir: T14273 (M. musculus) T14273 zinc finger protein 106 - mouse |
| 23781 | 1029 | AI639012 | F | | Rattus norvegicus transcribed sequence with weak similarity to protein |
| | | | | | ref: NP_076947.1 (H. sapiens) hypothetical protein MGC2601 [Homo sapiens] |
| 25862 | 1030 | AI639022 | A | | |
| 19997 | 1031 | AI639043 | N | | Rattus norvegicus transcribed sequences |
| 10071 | 1032 | AI639058 | N, F | | Rattus norvegicus transcribed sequence with strong similarity to protein |
| | | | | | ref: NP_075371.1 (M. musculus) Nedd4 WW binding# protein 4; Nedd4 WW- |
| | | | | | binding protein 4 [Mus musculus] |
| 16676 | 1033 | AI639082 | N, E | mini chromosome maintenance deficient 6 (S. cerevisiae) | mini chromosome maintenance deficient 6 (S. cerevisiae) |
| 19952 | 1034 | AI639108 | N | | Rattus norvegicus transcribed sequences |
| 25902 | 1035 | AI639154 | H | | Rattus norvegicus transcribed sequence |
| 19112 | 1036 | AI639157 | J | ribosomal protein L13 | ribosomal protein L13 |
| 15379 | 1037 | AI639162 | N, B | | Rattus norvegicus transcribed sequences |
| 25907 | 1038 | AI639167 | N | | Rattus norvegicus transcribed sequences |
| 25921 | 1039 | AI639209 | A, F | | |
| 15330 | 1040 | AI639285 | M, F, I | | Rattus norvegicus transcribed sequences |
| 19152 | 1041 | AI639387 | M, D | | Rattus norvegicus transcribed sequence with strong similarity to protein |
| | | | | | sp: P58064 (M. musculus) RT06_MOUSE Mitochondrial 28S ribosomal protein |
| | | | | | S6 (MRP-S6) |
| 19679 | 1042 | AI639418 | M, A, D, G, I | deiodinase, iodothyronine, type I | deiodinase, iodothyronine, type I |
| 19002 | 1043 | AI639465 | N | ring finger protein 28 | ring finger protein 28 |
| 19003 | 1043 | AI639465 | F | ring finger protein 28 | ring finger protein 28 |
| 21542 | 1044 | AI639476 | J | | Rattus norvegicus transcribed sequence with strong similarity to protein |
| | | | | | ref: NP_058622.1 (M. musculus) squamous cell carcinoma antigen recognized |
| | | | | | by T-cells 3 [Mus musculus] |
| 19943 | 1045 | AI639479 | M, N, F, G | | Rattus norvegicus transcribed sequence with strong similarity to protein |
| | | | | | prf: 2008147A (R. norvegicus) 2008147A protein RAKb [Rattus norvegicus] |
| 20082 | 1046 | AI639488 | M, N, H, I, J | | Rattus norvegicus transcribed sequence with strong similarity to protein |
| | | | | | pir: A42772 (R. norvegicus) A42772 mdm2 protein - rat (fragments) |
| 20056 | 1047 | AI639504 | M, I | | Rattus norvegicus Ac2-202 mRNA, complete cds |
| 15237 | 1048 | AI639535 | J | | Rattus norvegicus transcribed sequence with weak similarity to protein |
| | | | | | ref: NP_445944.1 (R. norvegicus) transporter-like protein [Rattus norvegicus] |
| 1203 | 1049 | AJ000485 | N | cytoplasmic linker 2 | cytoplasmic linker 2 |
| 25233 | 1050 | AJ000556 | E | Janus kinase 1 | Janus kinase 1 |
| 14332 | 1051 | AJ001044 | D | tumor-associated calcium signal transducer 1 | tumor-associated calcium signal transducer 1 |
| 25235 | 1052 | AJ001290 | F | solute carrier family 5 (inositol transporters), member 3 | solute carrier family 5 (inositol transporters), member 3 |
| 12422 | 1053 | AJ006971 | N | Death-associated like kinase | Death-associated like kinase |
| 12423 | 1053 | AJ006971 | N | Death-associated like kinase | Death-associated like kinase |
| 25247 | 1054 | AJ011608 | N | DNA primase, p49 subunit | DNA primase, p49 subunit |
| 20404 | 1055 | AJ011656 | N, L | claudin 3 | claudin 3 |
| 16350 | 1056 | AJ011811 | G | claudin 7 | claudin 7 |
| 16351 | 1056 | AJ011811 | G | claudin 7 | claudin 7 |
| 13485 | 1057 | AJ012603 | B | a disintegrin and metalloproteinase domain 17 | a disintegrin and metalloproteinase domain 17 |
| 4290 | 1058 | AJ224120 | L | peroxisomal membrane protein Pmp26p (Peroxin-11) | peroxisomal membrane protein Pmp26p (Peroxin-11) |
| 18956 | 1059 | D00512 | N | acetyl-coenzyme A acetyltransferase 1 | acetyl-coenzyme A acetyltransferase 1 |
| 15408 | 1060 | D00569 | N | 2,4-dienoyl CoA reductase 1, mitochondrial | 2,4-dienoyl CoA reductase 1, mitochondrial |
| 15409 | 1060 | D00569 | N, L | 2,4-dienoyl CoA reductase 1, mitochondrial | 2,4-dienoyl CoA reductase 1, mitochondrial |
| 4615 | 1061 | D00680 | N | glutathione peroxidase 3 | glutathione peroxidase 3 |
| 18686 | 1062 | D00729 | N | dodecenoyl-coenzyme A delta isomerase | (Rattus norvegicus mRNA for delta3, delta2-enoyl-CoA isomerase, complete |
| | | | | | cds, dodecenoyl-coenzyme A delta isomerase) |
| 2554 | 1063 | D00913 | M, N | intercellular adhesion molecule 1 | intercellular adhesion molecule 1 |
| 2555 | 1063 | D00913 | M, C, I | intercellular adhesion molecule 1 | intercellular adhesion molecule 1 |
| 1515 | 1064 | D10233 | J | renin-binding protein | renin-binding protein |
| 1306 | 1065 | D10262 | N | choline kinase | choline kinase |
| 24821 | 1066 | D10392 | J | syntaxin 1a | syntaxin 1a |
| 3608 | 1067 | D10693 | M, J | histamine N-methyltransferase | histamine N-methyltransferase |
| 25253 | 1068 | D10754 | H | proteasome (prosome, macropain) subunit, beta type 6 | proteasome (prosome, macropain) subunit, beta type 6 |
| 15535 | 1069 | D10755 | L | proteasome (prosome, macropain) subunit, alpha type 6 | poroteasome (prosome, macropain) subunit, alpha type 6 |
| 3254 | 1070 | D10756 | N, L | proteasome (prosome, macropain) subunit, alpha type 5 | proteasome (prosome, macropain) subunit, alpha type 5 |
| 4003 | 1071 | D10757 | N | proteosome (prosome, macropain) subunit, beta type 9 | proteosome (prosome, macropain) subunit, beta type 9 (large multifunctional |
| | | | | (large multifunctional protease 2) | protease 2) |
| 23109 | 1072 | D10854 | N | aldo-keto reductase family 1, member A1 | aldo-keto reductase family 1, member A1 |
| 8640 | 1073 | D12769 | D | Kruppel-like factor 9 | Kruppel-like factor 9 |
| 24428 | 1074 | D13126 | N | neural visinin-like Ca2+-binding protein type 3 | neural visinin-like Ca2+-binding protein type 3 |
| 15281 | 1075 | D13623 | N | | |
| 25257 | 1075 | D13623 | N | | |
| 1214 | 1076 | D13871 | M, N, K | (nuclear receptor subfamily 1, group H, member 4, | (nuclear receptor subfamily 1, group H, member 4, solute carrier family 2, |
| | | | | solute carrier family 2, member 5) | member 5) |
| 18958 | 1077 | D13921 | N | acetyl-coenzyme A acetyltransferase 1 | acetyl-coenzyme A acetyltransferase 1 |
| 18727 | 1078 | D13978 | N | argininosuccinate lyase | argininosuccinate lyase |
| 11434 | 1079 | D14014 | N, B | cyclin D1 | cyclin D1 |
| 19834 | 1080 | D14048 | E | system N1 Na+ and H+-coupled glutamine transporter | system N1 Na+ and H+-coupled glutamine transporter |
| 18246 | 1081 | D14441 | N, B, F | brain acidic membrane protein | brain acidic membrane protein |
| 503 | 1082 | D16443 | C | prostaglandin E receptor 3 | prostaglandin E receptor 3 |
| 16768 | 1083 | D16478 | N | hydroxyacyl-Coenzyme A dehydrogenase/3-ketoacyl- | hydroxyacyl-Coenzyme A dehydrogenase/3-ketoacyl-Coenzyme A |
| | | | | Coenzyme A hiolase/enoyl-Coenzyme A hydratase | hiolase/enoyl-Coenzyme A hydratase (trifunctional protein), alpha subunit |
| | | | | (trifunctional protein), alpha subunit | |
| 3015 | 1084 | D16554 | A | polyubiquitin | polyubiquitin |
| 18452 | 1085 | D17370 | M, N | CTL target antigen | CTL target antigen |
| 18453 | 1085 | D17370 | N, G | CTL target antigen | CTL target antigen |
| 16683 | 1086 | D17445 | N | Tyrosine 3-monooxygenase/tryptophan 5- | Tyrosine 3-monooxygenase/tryptophan 5-monooxygenase activation protein, |
| | | | | monooxygenase activation protein, eta polypeptide | eta polypeptide |
| 16684 | 1086 | D17445 | M | Tyrosine 3-monooxygenase/tryptophan 5- | Tyrosine 3-monooxygenase/tryptophan 5-monooxygenase activation protein, |
| | | | | monooxygenase activation protein, eta polypeptide | eta polypeptide |
| 13369 | 1087 | D21132 | D | phosphotidylinositol transfer protein, beta | phosphotidylinositol transfer protein, beta |
| 24885 | 1088 | D25224 | N | laminin receptor 1 (67 kD, ribosomal protein SA) | laminin receptor 1 (67 kD, ribosomal protein SA) |
| 472 | 1089 | D26111 | G | chloride channel K1-like | chloride channel K1-like |
| 20493 | 1090 | D28339 | M, N | 3-hydroxyanthranilate 3,4-dioxygenase | 3-hydroxyanthranilate 3,4-dioxygenase |
| 16610 | 1091 | D28557 | N, E, L | cold shock domain protein A | cold shock domain protein A |
| 25279 | 1092 | D30740 | C | Tyrosine 3-monooxygenase/tryptophan 5- | Tyrosine 3-monooxygenase/tryptophan 5-monooxygenase activation protein, |
| | | | | monooxygenase activation protein, zeta polypeptide | zeta polypeptide |
| 28 | 1093 | D31662 | M, F, G, I, J, L | Regucalcin | Regucalcin |
| 187 | 1094 | D32209 | F | acidic nuclear phosphoprotein 32 family, member A | acidic nuclear phosphoprotein 32 family, member A |
| 16681 | 1095 | D37920 | N, B, L | squalene epoxidase | squalene epoxidase |
| 24631 | 1096 | D37951 | F | human immunodeficiency virus type 1 enhancer- | human immunodeficiency virus type 1 enhancer-binding protein 2 |
| | | | | binding protein 2 | |
| 5492 | 1097 | D38061 | N | UDP glycosyltransferase 1 family, polypeptide A6 | UDP glycosyltransferase 1 family, polypeptide A6 |
| 18028 | 1098 | D38062 | N | UDP glycosyltransferase 1 family, polypeptide A7 | UDP glycosyltransferase 1 family, polypeptide A7 |
| 1354 | 1099 | D38065 | N | UDP glycosyltransferase 1 family, polypeptide A1 | UDP glycosyltransferase 1 family, polypeptide A1 |
| 755 | 1100 | D38448 | M, N | diacylglycerol kinase, gamma | diacylglycerol kinase, gamma |
| 16650 | 1101 | D42137 | E | annexin 5 | annexin 5 |
| 25290 | 1102 | D42148 | N, J | growth arrest specific 6 | growth arrest specific 6 |
| 20494 | 1103 | D44494 | N, E | 3-hydroxyanthranilate 3,4-dioxygenase | 3-hydroxyanthranilate 3,4-dioxygenase |
| 20801 | 1104 | D44495 | M, N, H, I, J, L | apurinic/apyrimidinic endonuclease 1 | apurinic/apyrimidinic endonuclease 1 |
| 18750 | 1105 | D45250 | N, G | protease (prosome, macropain) 28 subunit, beta | protease (prosome, macropain) 28 subunit, beta |
| 20960 | 1106 | D45254 | D | cellular nucleic acid binding protein | cellular nucleic acid binding protein |
| 245 | 1107 | D45412 | J | protein tyrosine phosphatase, receptor type, O | protein tyrosine phosphatase, receptor type, O |
| 16354 | 1108 | D50564 | N, C | mercaptopyruvate sulfurtransferase | mercaptopyruvate sulfurtransferase |
| 1884 | 1109 | D50695 | I | proteasome (prosome, macropain) 26S subunit, | proteasome (prosome, macropain) 26S subunit, ATPase, 4 |
| | | | | ATPase, 4 | |
| 811 | 1110 | D63704 | M, I | dihydropyrimidinase | dihydropyrimidinase |
| 812 | 1110 | D63704 | M, I | dihydropyrimidinase | dihydropyrimidinase |
| 21147 | 1111 | D63772 | M, F, H, I, J, L | solute carrier family 1, member 1 | solute carrier family 1, member 1 |
| 770 | 1112 | D83044 | M, N | solute carrier family 22, member 2 | solute carrier family 22, member 2 |
| 15126 | 1113 | D83796 | N | (UDP glycosyltransferase 1 family, polypeptide A1, | (UDP glycosyltransferase 1 family, polypeptide A1, UDP glycosyltransferase 1 |
| | | | | UDP glycosyltransferase 1 family, polypeptide A6, UDP | family, polypeptide A6, UDP glycosyltransferase 1 family, polypeptide A7, |
| | | | | glycosyltransferase 1 family, polypeptide A7, UDP- | UDP-glucuronosyltransferase 1A8) |
| | | | | glucuronosyltransferase 1A8) | |
| 15437 | 1114 | D84418 | E | high mobility group box 2 | high mobility group box 2 |
| 17554 | 1115 | D85100 | N | solute carrier family 27 (fatty acid transporter), member | solute carrier family 27 (fatty acid transporter), member 32 |
| | | | | 32 | |
| 13005 | 1116 | D85189 | N, C | fatty acid Coenzyme A ligase, long chain 4 | fatty acid Coenzyme A ligase, long chain 4 |
| 16448 | 1117 | D86297 | N | aminolevulinic acid synthase 2 | aminolevulinic acid synthase 2 |
| 15297 | 1118 | D86641 | N, K | (FK506 binding protein 2, FK506-binding protein 1a) | (FK506 binding protein 2, FK506-binding protein 1a) |
| 968 | 1119 | D86745 | G, K | nuclear receptor subfamily 0, group B, member 2 | nuclear receptor subfamily 0, group B, member 2 |
| 945 | 1120 | D88666 | N | phosphatidylserine-specific phospholipase A1 | phosphatidylserine-specific phospholipase A1 |
| 25315 | 1121 | D89730 | N | | |
| 3987 | 1122 | D90258 | M, N | proteasome (prosome, macropain) subunit, alpha type 3 | proteasome (prosome, macropain) subunit, alpha type 3 |
| 1921 | 1123 | E01524 | N | P450 (cytochrome) oxidoreductase | P450 (cytochrome) oxidoreductase |
| 25024 | 1124 | E03229 | N | cytosolic cysteine dioxygenase 1 | cytosolic cysteine dioxygenase 1 |
| 19824 | 1125 | E13557 | N, G, K | cysteine-sulfinate decarboxylase | cysteine-sulfinate decarboxylase |
| 4360 | 1126 | H31813 | M, G, I | | Rattus norvegicus transcribed sequence with strong similarity to protein |
| | | | | | pir: T14781 (H. sapiens) T14781 hypothetical protein DKFZp586B1621.1 - |
| | | | | | human (fragment) |
| 4361 | 1127 | H31839 | N | BCL2-antagonist/killer 1 | BCL2-antagonist/killer 1 |
| 21011 | 1128 | H32189 | N | glutathione S-transferase, mu 1 | glutathione S-transferase, mu 1 |
| 4386 | 1129 | H33093 | N | | Rattus norvegicus transcribed sequences |
| 24033 | 1130 | H33101 | H | | Rattus norvegicus transcribed sequence with moderate similarity to protein |
| | | | | | ref: NP_219480.1 (H. sapiens) hypothetical protein similar to CG7943 [Homo |
| | | | | | sapiens] |
| 17159 | 1131 | J00797 | M, G, K | alpha-tubulin | alpha-tubulin |
| 1301 | 1132 | J02585 | N | stearoyl-Coenzyme A desaturase 1 | stearoyl-Coenzyme A desaturase 1 |
| 21012 | 1133 | J02592 | N, B | Glutathione-S-transferase, mu type 2 (Yb2) | Glutathione-S-transferase, mu type 2 (Yb2) |
| 15124 | 1134 | J02612 | N, B | (UDP glycosyltransferase 1 family, polypeptide A1, | (UDP glycosyltransferase 1 family, polypeptide A1, UDP glycosyltransferase 1 |
| | | | | UDP glycosyltransferase 1 family, polypeptide A6, UDP | family, polypeptide A6, UDP glycosyltransferase 1 family, polypeptide A7, |
| | | | | glycosyltransferase 1 family, polypeptide A7, UDP- | UDP-glucuronosyltransferase 1A8) |
| | | | | glucuronosyltransferase 1A8) | |
| 4592 | 1135 | J02646 | H | eukaryotic translation initiation factor 2, subunit 1 (alpha) | eukaryotic translation initiation factor 2, subunit 1 (alpha) |
| 1174 | 1136 | J02657 | N | Cytochrome P450, subfamily IIC (mephenytoin 4- | Cytochrome P450, subfamily IIC (mephenytoin 4-hydroxylase) |
| | | | | hydroxylase) | |
| 1698 | 1137 | J02679 | M, B, H, I | NAD(P)H dehydrogenase, quinone 1 | NAD(P)H dehydrogenase, quinone 1 |
| 16080 | 1138 | J02722 | N | Heme oxygenase | Heme oxygenase |
| 23698 | 1139 | J02749 | N, D | acetyl-Coenzyme A acyltransferase 1 (peroxisomal 3- | acetyl-Coenzyme A acyltransferase 1 (peroxisomal 3-oxoacyl-Coenzyme A |
| | | | | oxoacyl-Coenzyme A thiolase) | thiolase) |
| 23699 | 1139 | J02749 | N, D, E | acetyl-Coenzyme A acyltransferase 1 (peroxisomal 3- | acetyl-Coenzyme A acyltransferase 1 (peroxisomal 3-oxoacyl-Coenzyme A |
| | | | | oxoacyl-Coenzyme A thiolase) | thiolase) |
| 16148 | 1140 | J02752 | N | acyl-coA oxidase | acyl-coA oxidase |
| 16476 | 1141 | J02773 | M, L | fatty acid binding protein 3 | fatty acid binding protein 3 |
| 1514 | 1142 | J02780 | N | Tropomycin 4 | Tropomycin 4 |
| 21078 | 1143 | J02791 | N, G | acetyl-coenzyme A dehydrogenase, medium chain | acetyl-coenzyme A dehydrogenase, medium chain |
| 21013 | 1144 | J02810 | N | glutathione S-transferase, mu 1 | glutathione S-transferase, mu 1 |
| 17284 | 1145 | J02827 | N, G | branched chain keto acid dehydrogenase subunit E1, | branched chain keto acid dehydrogenase subunit E1, alpha polypeptide |
| | | | | alpha polypeptide | |
| 17285 | 1145 | J02827 | N | branched chain keto acid dehydrogenase subunit E1, | branched chain keto acid dehydrogenase subunit E1, alpha polypeptide |
| | | | | alpha polypeptide | |
| 22321 | 1146 | J02962 | M, B, G, L | lectin, galactose binding, soluble 3 | lectin, galactose binding, soluble 3 |
| 1762 | 1147 | J03179 | N | D site albumin promoter binding protein | D site albumin promoter binding protein |
| 1763 | 1147 | J03179 | N | D site albumin promoter binding protein | D site albumin promoter binding protein |
| 21038 | 1148 | J03190 | H | aminolevulinic acid synthase 1 | aminolevulinic acid synthase 1 |
| 21039 | 1148 | J03190 | H | aminolevulinic acid synthase 1 | aminolevulinic acid synthase 1 |
| 13479 | 1149 | J03481 | N | quinoid dihydropteridine reductase | quinoid dihydropteridine reductase |
| 13480 | 1149 | J03481 | N | quinoid dihydropteridine reductase | quinoid dihydropteridine reductase |
| 14997 | 1150 | J03572 | N | alkaline phosphatase, tissue-nonspecific | alkaline phosphatase, tissue-nonspecific |
| 16948 | 1151 | J03588 | N, A, C | Guanidinoacetate methyltransferase | Guanidinoacetate methyltransferase |
| 19040 | 1152 | J03627 | M, C, G, K | S100 calcium binding protein A10 (calpactin) | S100 calcium binding protein A10 (calpactin) |
| 15017 | 1153 | J03752 | N, B | microsomal glutathione S-transferase 1 | microsomal glutathione S-transferase 1 |
| 24459 | 1154 | J03886 | C | myosin light chain kinase 2, skeletal muscle | myosin light chain kinase 2, skeletal muscle |
| 21014 | 1155 | J03914 | B, L | Glutathione-S-transferase, mu type 2 (Yb2) | Glutathione-S-transferase, mu type 2 (Yb2) |
| 17394 | 1156 | J03969 | M, N, L | nucleophosmin 1 | nucleophosmin 1 |
| 7784 | 1157 | J04591 | M, N, I | Dipeptidyl peptidase 4 | Dipeptidyl peptidase 4 |
| 23524 | 1158 | J04792 | N | | |
| 17393 | 1159 | J04943 | M, N | nucleophosmin 1 | nucleophosmin 1 |
| 6780 | 1160 | J05029 | N | acetyl-Coenzyme A dehydrogenase, long-chain | acetyl-Coenzyme A dehydrogenase, long-chain |
| 4450 | 1161 | J05031 | N, E | Isovaleryl Coenzyme A dehydrogenase | Isovaleryl Coenzyme A dehydrogenase |
| 4451 | 1161 | J05031 | M, N, F | Isovaleryl Coenzyme A dehydrogenase | Isovaleryl Coenzyme A dehydrogenase |
| 15125 | 1162 | J05132 | N, B | (UDP glycosyltransferase 1 family, polypeptide A1, | (UDP glycosyltransferase 1 family, polypeptide A1, UDP glycosyltransferase 1 |
| | | | | UDP glycosyltransferase 1 family, polypeptide A6, UDP | family, polypeptide A6, UDP glycosyltransferase 1 family, polypeptide A7, |
| | | | | glycosyltransferase 1 family, polypeptide A7, UDP- | UDP-glucuronosyltransferase 1A8) |
| | | | | glucuronosyltransferase 1A8) | |
| 1247 | 1163 | J05181 | N, J | glutamate-cysteine ligase catalytic subunit | glutamate-cysteine ligase catalytic subunit |
| 1977 | 1164 | J05470 | N, L | Carnitine palmitoyltransferase 2 | Carnitine palmitoyltransferase 2 |
| 10464 | 1165 | J05510 | M, I | inositol 1,4,5-triphosphate receptor 1 | inositol 1,4,5-triphosphate receptor 1 |
| 1549 | 1166 | J05519 | G | C1-tetrahydrofolate synthase | C1-tetrahydrofolate synthase |
| 24563 | 1167 | J05592 | N, G, K | protein phosphatase 1, regulatory (inhibitor) subunit 1A | protein phosphatase 1, regulatory (inhibitor) subunit 1A |
| 24564 | 1167 | J05592 | N, G, K | protein phosphatase 1, regulatory (inhibitor) subunit 1A | protein phosphatase 1, regulatory (inhibitor) subunit 1A |
| 18989 | 1168 | K00136 | N | glutathione-S-transferase, alpha type2 | glutathione-S-transferase, alpha type2 |
| 11136 | 1169 | K00750 | J | | |
| 11137 | 1169 | K00750 | J | | |
| 634 | 1170 | K01932 | N | glutathione S-transferase, alpha 1 | glutathione S-transferase, alpha 1 |
| 1850 | 1171 | K02814 | M | T-kininogen | T-kininogen |
| 20149 | 1172 | K03243 | N, F | | |
| 17758 | 1173 | K03249 | N | enoyl-Coenzyme A, hydratase/3-hydroxyacyl | enoyl-Coenzyme A, hydratase/3-hydroxyacyl Coenzyme A dehydrogenase |
| | | | | Coenzyme A dehydrogenase | |
| 10878 | 1174 | K03250 | N | ribosomal protein S11 | ribosomal protein S11 |
| 20865 | 1175 | L00117 | M, N | Elastase 1 | Elastase 1 |
| 1894 | 1176 | L03201 | N, B, L | cathepsin S | cathepsin S |
| 1712 | 1177 | L06096 | M | inositol 1,4,5-triphosphate receptor 3 | inosital 1,4,5-triphosphate receptor 3 |
| 15411 | 1178 | L07736 | N, B, L | carnitine palmitoyltransferase 1 | carnitine palmitoyltransferase 1 |
| 617 | 1179 | L08831 | N | Glucose-dependent insulinotropic peptide | Glucose-dependent insulinotropic peptide |
| 8984 | 1180 | L10652 | D | methionine aminopeptidase 2 | methionine aminopeptidase 2 |
| 3549 | 1181 | L11319 | N | signal peptidase complex 18 kD | signal peptidase complex 18 kD |
| 574 | 1182 | L13039 | M, E, G, K | calpactin I heavy chain | calpactin I heavy chain |
| 25364 | 1183 | L13237 | F | | |
| 22412 | 1184 | L13619 | N, C, H | growth response protein (CL-6) | growth response protein (CL-6) |
| 22413 | 1184 | L13619 | N, C, H | growth response protein (CL-6) | growth response protein (CL-6) |
| 108 | 1185 | L14002 | J | Polymeric immunoglobulin receptor | Polymeric immunoglobulin receptor |
| 25366 | 1186 | L14003 | J | | |
| 109 | 1187 | L14004 | N | Polymeric immunoglobulin receptor | Polymeric immunoglobulin receptor |
| 20414 | 1188 | L14323 | M | Phospholipase C-beta1 | Phospholipase C-beta1 |
| 2079 | 1189 | L14462 | F | amino-terminal enhancer of split | amino-terminal enhancer of split |
| 1475 | 1190 | L16764 | N, C | heat shock 70 kD protein 1A | heat shock 70 kD protein 1A |
| 24770 | 1191 | L19031 | M, N, G, I, J | solute carrier family 21, member 1 | solute carrier family 21, member 1 |
| 4748 | 1192 | L19998 | N | sulfotransferase family 1A, phenol-preferring, member 1 | sulfotransferase family 1A, phenol-preferring, member 1 |
| 4749 | 1192 | L19998 | N, L | sulfotransferase family 1A, phenol-preferring, member 1 | sulfotransferase family 1A, phenol-preferring, member 1 |
| 10248 | 1193 | L23148 | N | Inhibitor of DNA binding 1, helix-loop-helix protein | Inhibitor of DNA binding 1, helix-loop-helix protein (splice variation) |
| | | | | (splice variation) | |
| 43 | 1194 | L23413 | N | solute carrier family 26 (sulfate transporter), member 1 | solute carrier family 26 (sulfate transporter), member 1 |
| 25377 | 1195 | L25387 | D | phosphofructokinase, platelet | |
| 17401 | 1196 | L25785 | M, B, G | Transforming growth factor beta stimulated clone 22 | Transforming growth factor beta stimulated clone 22 |
| 19 | 1197 | L26268 | M | B-cell translocation gene 1 | B-cell translocation gene 1 |
| 22411 | 1198 | L26292 | N | Kruppel-like factor 4 (gut) | Kruppel-like factor 4 (gut) |
| 25379 | 1198 | L26292 | M, C | Kruppel-like factor 4 (gut) | Kruppel-like factor 4 (gut) |
| 605 | 1199 | L27340 | C | sonic hedgehog homolog (Drosophila) | sonic hedgehog homolog (Drosophila) |
| 24219 | 1200 | L27843 | M, L | protein tyrosine phosphatase 4a1 | protein tyrosine phosphatase 4a1 |
| 15872 | 1201 | L28135 | N | solute carrier family 2, member 2 | solute carrier family 2, member 2 |
| 20458 | 1202 | L31394 | M, I, K, L | parathyroid hormone receptor | parathyroid hormone receptor |
| 353 | 1203 | L32591 | M, H, I | growth arrest and DNA-damage-inducible 45 alpha | growth arrest and DNA-damage-inducible 45 alpha |
| 354 | 1203 | L32591 | M, H, I | growth arrest and DNA-damage-inducible 45 alpha | growth arrest and DNA-damage-inducible 45 alpha |
| 16520 | 1204 | L33869 | M, B, C, L | ceruloplasmin | ceruloplasmin |
| 15111 | 1205 | L34049 | M, I | low density lipoprotein receptor-related protein 2 | low density lipoprotein receptor-related protein 2 |
| 15112 | 1205 | L34049 | N, I | low density lipoprotein receptor-related protein 2 | low density lipoprotein receptor-related protein 2 |
| 1321 | 1206 | L37333 | N | glucose-6-phosphatase, catalytic | glucose-6-phosphatase, catalytic |
| 13682 | 1207 | L38482 | N | | |
| 6405 | 1208 | L38615 | G | glutathione synthetase | glutathione synthetase |
| 6406 | 1208 | L38615 | N | glutathione synthetase | glutathione synthetase |
| 1427 | 1209 | L38644 | N | karyopherin, beta 1 | karyopherin, beta 1 |
| 18629 | 1210 | L40362 | G | RT1 class lb gene | RT1 class lb gene |
| 24568 | 1211 | L48060 | M, B | prolactin receptor | prolactin receptor |
| 11955 | 1212 | L48209 | N | cytochrome c oxidase, subunit VIIIa | cytochrome c oxidase, subunit VIIIa |
| 1920 | 1213 | M10068 | N | P450 (cytochrome) oxidoreductase | P450 (cytochrome) oxidoreductase |
| 15741 | 1214 | M11670 | N | Catalase | Catalase |
| 15189 | 1215 | M11794 | N, B | Metallothionein | Metallothionein |
| 17765 | 1216 | M11942 | N | heat shock protein 8 | heat shock protein 8 |
| 17502 | 1217 | M12156 | N | heterogeneous nuclear ribonucleoprotein A1 | heterogeneous nuclear ribonucleoprotein A1 |
| 6055 | 1218 | M12337 | M, N, D | Phenylalanine hydroxylase | Phenylalanine hydroxylase |
| 4254 | 1219 | M12450 | N | Group-specific component (vitamin D-binding protein) | Group-specific component (vitamin D-binding protein) |
| 7064 | 1220 | M12919 | N | aldolase A | aldolase A |
| 25399 | 1221 | M13101 | F | | |
| 1466 | 1222 | M14050 | N | heat shock 70 kD protein 5 | heat shock 70 kD protein 5 |
| 23651 | 1223 | M14656 | M, G, K | secreted phosphoprotein 1 | secreted phosphoprotein 1 |
| 20714 | 1224 | M14972 | J, L | | |
| 455 | 1225 | M15474 | N, E | tropomyosin 1, alpha | tropomyosin 1, alpha |
| 21053 | 1226 | M15481 | M | insulin-like growth factor 1 | insulin-like growth factor 1 |
| 19255 | 1227 | M15562 | N | | Rat MHC class II RT1.u-D-alpha chain mRNA, 3′ end |
| 19256 | 1227 | M15562 | N | | Rat MHC class II RT1.u-D-alpha chain mRNA, 3′ end |
| 17154 | 1228 | M15883 | J | clathrin, light polypeptide (Lcb) | clathrin, light polypeptide (Lcb) |
| 20809 | 1229 | M17069 | N, D | Calmodulin 2 (phosphorylase kinase, delta) | Calmodulin 2 (phosphorylase kinase, delta) |
| 25405 | 1230 | M18330 | N | protein kinase C, delta | protein kinase C, delta |
| 23872 | 1231 | M18416 | M | early growth response 1 | early growth response 1 |
| 17274 | 1232 | M18854 | J | | Rat T-cell receptor active beta-chain C-region mRNA, partial cds, clone TRB4 |
| 23806 | 1233 | M19257 | D | Retinol-binding protein 1 | Retinol-binding protein 1 |
| 24567 | 1234 | M19304 | N, F | prolactin receptor | prolactin receptor |
| 17197 | 1235 | M19647 | N | | |
| 17198 | 1235 | M19647 | N, G | kallikrein 1 | kallikrein 1 |
| 25415 | 1236 | M19648 | G | | |
| 4010 | 1237 | M20131 | N | | |
| 20876 | 1238 | M21060 | J | superoxide dismutase 1 | superoxide dismutase 1 |
| 24437 | 1239 | M22357 | A | Myelin-associated glycoprotein | Myelin-associated glycoprotein |
| 20481 | 1240 | M22631 | M, N, G, K | Propionyl Coenzyme A carboxylase, alpha polypeptide | Propionyl Coenzyme A carboxylase, alpha polypeptide |
| 25419 | 1241 | M22922 | G | | |
| 46 | 1242 | M23697 | N | Plasminogen activator, tissue | Plasminogen activator, tissue |
| 15540 | 1243 | M24067 | K | serine (or cysteine) proteinase inhibitor, member 1 | serine (or cysteine) proteinase inhibitor, member 1 |
| 18619 | 1244 | M24324 | N | RT1 class Ib gene | RT1 class Ib gene |
| 11454 | 1245 | M24604 | M | Proliferating cell nuclear antigen | Proliferating cell nuclear antigen |
| 11455 | 1245 | M24604 | M | Proliferating cell nuclear antigen | Proliferating cell nuclear antigen |
| 1540 | 1246 | M25073 | N | alanyl (membrane) aminopeptidase | alanyl (membrane) aminopeptidase |
| 17541 | 1247 | M26125 | M, N, A, B, H, I | epoxide hydrolase 1 | epoxide hydrolase 1 |
| 16245 | 1248 | M26534 | G | | |
| 23225 | 1249 | M27467 | N | cytochrome oxidase subunit VIc | cytochrome oxidase subunit VIc |
| 11956 | 1250 | M28255 | N | cytochrome c oxidase, subunit VIIIa | cytochrome c oxidase, subunit VIIIa |
| 17104 | 1251 | M29358 | M, G | ribosomal protein S6 | ribosomal protein S6 |
| 17105 | 1251 | M29358 | N | ribosomal protein S6 | ribosomal protein S6 |
| 14346 | 1252 | M31109 | N, B, H | UDP-glucuronosyltransferase 2B3 precursor, | UDP-glucuronosyltransferase 2B3 precursor, microsomal |
| | | | | microsomal | |
| 1814 | 1253 | M31174 | N | thyroid hormone receptor alpha | thyroid hormone receptor alpha |
| 18501 | 1254 | M31178 | N | calbindin 1 | calbindin 1 |
| 18502 | 1254 | M31178 | N, G, J | calbindin 1 | calbindin 1 |
| 1312 | 1255 | M31788 | J | phosphoglycerate kinase 1 | phosphoglycerate kinase 1 |
| 20868 | 1256 | M32062 | N | Fc receptor, IgG, low affinity III | Fc receptor, IgG, low affinity III |
| 20869 | 1256 | M32062 | N | Fc receptor, IgG, low affinity III | Fc receptor, IgG, low affinity III |
| 20298 | 1257 | M32783 | N, I | | |
| 15580 | 1258 | M33648 | N | 3-hydroxy-3-methylglutaryl-Coenzyme A synthase 2 | 3-hydroxy-3-methylglutaryl-Coenzyme A synthase 2 |
| 11755 | 1259 | M33746 | N, B, H | UDP-glucuronosyltransferase 2 family, member 5 | UDP-glucuronosyltransferase 2 family, member 5 |
| 35 | 1260 | M33822 | C | gamma-glutamyl transpeptidase | gamma-glutamyl transpeptidase |
| 1844 | 1261 | M33962 | J | protein tyrosine phosphatase, non-receptor type 1 | protein tyrosine phosphatase, non-receptor type 1 |
| 24672 | 1262 | M34097 | C | granzyme B | granzyme B |
| 20126 | 1263 | M34253 | N, K | Interferon regulatory factor 1 | Interferon regulatory factor 1 |
| 24590 | 1264 | M35299 | N, D | serine protease inhibitor, Kazal type 1 | serine protease inhibitor, Kazal type 1 |
| 20699 | 1265 | M35601 | N | Fibrinogen, A alpha polypeptide | Fibrinogen, A alpha polypeptide |
| 20700 | 1265 | M35601 | N | Fibrinogen, A alpha polypeptide | Fibrinogen, A alpha polypeptide |
| 21400 | 1266 | M36410 | C, F | sepiapterin reductase | sepiapterin reductase |
| 17661 | 1267 | M37584 | N, E | H2A histone family, member Z | H2A histone family, member Z |
| 67 | 1268 | M37828 | B | cytochrome P450, 4a12 | cytochrome P450, 4a12 |
| 9109 | 1269 | M38135 | N | Cathepsin H | Cathepsin H |
| 17807 | 1270 | M54926 | M, G | lactate dehydrogenase A | lactate dehydrogenase A |
| 8829 | 1271 | M55015 | M, A, F, K | Nucleolin | Nucleolin |
| 13723 | 1272 | M55534 | N, K | crystallin, alpha B | crystallin, alpha B |
| 1246 | 1273 | M57507 | M, J | guanylate cyclase, soluble, beta 2 | guanylate cyclase, soluble, beta 2 |
| 4467 | 1274 | M57664 | N | creatine kinase, brain | creatine kinase, brain |
| 20713 | 1275 | M57718 | N, J, L | cytochrome P450, 4A1 | cytochrome P450, 4A1 |
| 20816 | 1276 | M58404 | M, G, K | thymosin, beta 10 | thymosin, beta 10 |
| 25057 | 1277 | M58495 | N | | |
| 16982 | 1278 | M58634 | M, B, L | insulin-like growth factor binding protein 1 | insulin-like growth factor binding protein 1 |
| 20841 | 1279 | M58758 | H | ATPase, H+ transporting, lysosomal noncatalytic | ATPase, H+ transporting, lysosomal noncatalytic accessory protein 1a |
| | | | | accessory protein 1a | |
| 2465 | 1280 | M59814 | G, K | Eph receptor B2 | Eph receptor B2 |
| 12606 | 1281 | M59861 | N, E, K | 10-formyltetrahydrofolate dehydrogenase | 10-formyltetrahydrofolate dehydrogenase |
| 457 | 1282 | M60666 | E, G, K | tropomyosin 1, alpha | tropomyosin 1, alpha |
| 15300 | 1283 | M60921 | M | B-cell translocation gene 2 | B-cell translocation gene 2 |
| 17378 | 1284 | M62388 | N, D | ubiquitin conjugating enzyme | ubiquitin conjugating enzyme |
| 24431 | 1285 | M63282 | M, F | Activating transcription factor 3 | Activating transcription factor 3 |
| 14956 | 1286 | M64301 | N | mitogen-activated protein kinase 6 | mitogen-activated protein kinase 6 |
| 14957 | 1286 | M64301 | N | mitogen-activated protein kinase 6 | mitogen-activated protein kinase 6 |
| 7101 | 1287 | M64733 | M, E | clusterin | clusterin |
| 19825 | 1288 | M64755 | N | cysteine-sulfinate decarboxylase | cysteine-sulfinate decarboxylase |
| 19110 | 1289 | M64986 | A, J | high mobility group box 1 | high mobility group box 1 |
| 21683 | 1290 | M65149 | M, C, I, L | CCAAT/enhancerbinding, protein (C/EBP) delta | CCAAT/enhancerbinding, protein (C/EBP) delta |
| 21193 | 1291 | M69055 | F | Insulin-like growth factor binding protein 6 | |
| 17301 | 1292 | M69246 | N, E, I | serine (or cysteine) proteinase inhibitor, clade H, | serine (or cysteine) proteinase inhibitor, clade H, member 1 |
| | | | | member 1 | |
| 23884 | 1293 | M73714 | J | aldehyde dehydrogenase family 3, subfamily A2 | aldehyde dehydrogenase family 3, subfamily A2 |
| 24648 | 1294 | M74054 | M, N | angiotensin receptor 1a | angiotensin receptor 1a |
| 20405 | 1295 | M74067 | N, B | claudin 3 | claudin 3 |
| 24566 | 1296 | M74152 | B, F, L | prolactin receptor | prolactin receptor |
| 240 | 1297 | M75153 | N | RAB11a, member RAS oncogene family | RAB11a, member RAS oncogene family |
| 23961 | 1298 | M77694 | M, N, E, G, I | fumarylacetoacetate hydrolase | fumarylacetoacetate hydrolase |
| 1527 | 1299 | M77850 | B | 6-pyruvoyl-tetrahydropterin synthase | 6-pyruvoyl-tetrahydropterin synthase |
| 1622 | 1300 | M80804 | N | solute carrier family 3, member 1 | solute carrier family 3, member 1 |
| 24843 | 1301 | M80826 | N, J | trefoil factor 3 | trefoil factor 3 |
| 1529 | 1302 | M81687 | M, B, F, I | syndecan 2 | syndecan 2 |
| 5733 | 1303 | M81855 | N | (ATP-binding cassette, sub-family B (MDR/TAP), | (ATP-binding cassette, sub-family B (MDR/TAP), member 1A, P- |
| | | | | member 1A, P-glycoprotein/multidrug resistance 1) | glycoprotein/multidrug resistance 1) |
| 17149 | 1304 | M83107 | N | Transgelin (Smooth muscle 22 protein) | Transgelin (Smooth muscle 22 protein) |
| 17150 | 1304 | M83107 | N | Transgelin (Smooth muscle 22 protein) | Transgelin (Smooth muscle 22 protein) |
| 4198 | 1305 | M83143 | M, N, I | Sialyltransferase 1 (beta-galactoside alpha-2,6- | Sialyltransferase 1 (beta-galactoside alpha-2,6-sialytransferase) |
| | | | | sialytransferase) | |
| 4199 | 1305 | M83143 | M, N | Sialyltransferase 1 (beta-galactoside alpha-2,6- | Sialyltransferase 1 (beta-galactoside alpha-2,6-sialytransferase) |
| | | | | sialytransferase) | |
| 24651 | 1306 | M83678 | N | RAB13 | RAB13 |
| 20831 | 1307 | M83680 | B | GTPase Rab14 | GTPase Rab14 |
| 21882 | 1308 | M83740 | M, N, D | 6-pyruvoyl-tetrahydropterin synthase/dimerization | 6-pyruvoyl-tetrahydropterin synthase/dimerization cofactor of hepatocyte |
| | | | | cofactor of hepatocyte nuclear factor 1 alpha | nuclear factor 1 alpha |
| 1430 | 1309 | M84648 | M | dopa decarboxylase | dopa decarboxylase |
| 23445 | 1310 | M84719 | M, N | Flavin-containing monooxygenase 1 | Flavin-containing monooxygenase 1 |
| 24438 | 1311 | M85183 | M, N, F, L | angiotensin/vasopressin receptor | angiotensin/vasopressin receptor |
| 24496 | 1312 | M85300 | M, N, I, K | solute carrier family 9, member 3 | solute carrier family 9, member 3 |
| 16895 | 1313 | M86240 | N | fructose-1,6-biphosphatase 1 | fructose-1,6-biphosphatase 1 |
| 17736 | 1314 | M86389 | H, K | heat shock 27 kDa protein 1 | heat shock 27 kDa protein 1 |
| 7872 | 1315 | M86912 | M, N, B | | |
| 25453 | 1315 | M86912 | M, L | | |
| 291 | 1316 | M88347 | M, N, F | Cystathionine beta synthase | Cystathionine beta synthase |
| 17357 | 1317 | M88601 | M, F, G, I, L | Meprin 1 beta | Meprin 1 beta |
| 24615 | 1318 | M89646 | N, D | ribosomal protein S24 | ribosomal protein S24 |
| 15069 | 1319 | M89945 | H | farensyl diphosphate synthase | farensyl diphosphate synthase |
| 25460 | 1319 | M89945 | N | farensyl diphosphate synthase | farensyl diphosphate synthase |
| 11153 | 1320 | M91652 | N | glutamine synthetase 1 | glutamine synthetase 1 |
| 25467 | 1321 | M93297 | N, G | ornithine aminotransferase | ornithine aminotransferase |
| 17269 | 1322 | M93401 | M | methylmalonate semialdehyde dehydrogenase gene | methylmalonate semialdehyde dehydrogenase gene |
| 20716 | 1323 | M94548 | G | cytochrome P450, subfamily IVF, polypeptide 14 | cytochrome P450, subfamily IVF, polypeptide 14 (leukotriene B4 omega |
| | | | | (leukotriene B4 omega hydroxylase) | hydroxylase) |
| 25468 | 1324 | M94918 | N, J | hemoglobin beta chain complex | hemoglobin beta chain complex |
| 25469 | 1325 | M94919 | N, J | | |
| 1976 | 1326 | M95493 | N | guanylate cyclase activator 2A | guanylate cyclase activator 2A |
| 16449 | 1327 | M95591 | N | farnesyl diphosphate farnesyl transferase 1 | farnesyl diphosphate farnesyl transferase 1 |
| 16450 | 1327 | M95591 | N | farnesyl diphosphate farnesyl transferase 1 | farnesyl diphosphate farnesyl transferase 1 |
| 729 | 1328 | M95762 | N, D | solute carrier family 6 (neurotransmitter transporter, | solute carrier family 6 (neurotransmitter transporter, GABA), member 13 |
| | | | | GABA), member 13 | |
| 25470 | 1329 | M95791 | E | | |
| 1410 | 1330 | M96548 | H | zinc finger protein 354A | zinc finger protein 354A |
| 1678 | 1331 | M96674 | N | glucagon receptor | glucagon receptor |
| 1508 | 1332 | M97662 | N, G | ureidopropionase, beta | ureidopropionase, beta |
| 22434 | 1333 | NM_012974 | F | Laminin chain beta 2 | Laminin chain beta 2 |
| 21145 | 1334 | NM_013032 | M, B | solute carrier family 1, member 1 | solute carrier family 1, member 1 |
| 23708 | 1335 | NM_013113 | N | ATPase Na+/K+ transporting beta 1 polypeptide | ATPase Na+/K+ transporting beta 1 polypeptide |
| 754 | 1336 | NM_013126 | N | diacylglycerol kinase, gamma | diacylglycerol kinase, gamma |
| 16967 | 1337 | NM_013146 | E | Caldesmon 1 | Caldesmon 1 |
| 1946 | 1338 | NM_017061 | F | lysyl oxidase | lysyl oxidase |
| 13938 | 1339 | NM_017212 | N | microtubule-associated protein tau | microtubule-associated protein tau |
| 13939 | 1339 | NM_017212 | D | microtubule-associated protein tau | microtubule-associated protein tau |
| 15299 | 1340 | NM_017259 | M, I, J | B-cell translocation gene 2 | B-cell translocation gene 2 |
| 15666 | 1341 | NM_017265 | L | | |
| 15667 | 1341 | NM_017265 | L | | |
| 1729 | 1342 | NM_019147 | N, B | jagged 1 | jagged 1 |
| 1143 | 1343 | NM_019280 | A | gap junction membrane channel protein alpha 5 | gap junction membrane channel protein alpha 5 |
| 235 | 1344 | NM_019347 | C | solute carrier family 14, member 2 | solute carrier family 14, member 2 |
| 18716 | 1345 | NM_020075 | F | eukaryotic initiation factor 5 (eIF-5) | eukaryotic initiation factor 5 (eIF-5) |
| 7690 | 1346 | NM_022284 | M | melanoma antigen, family D, 1 | melanoma antigen, family D, 1 |
| 22414 | 1347 | NM_022392 | H | growth response protein (CL-6) | growth response protein (CL-6) |
| 21024 | 1348 | NM_022599 | M | synaptojanin 2 binding protein | synaptojanin 2 binding protein |
| 15201 | 1349 | NM_031093 | N | | |
| 18008 | 1350 | NM_031588 | N | neuregulin 1 | neuregulin 1 |
| 16003 | 1351 | NM_031757 | C | matrix metalloproteinase 24 (membrane-inserted) | matrix metalloproteinase 24 (membrane-inserted) |
| 16726 | 1352 | NM_031855 | M, N, E, G, H, I | Ketohexokinase | Ketohexokinase |
| 25802 | 1353 | NM_031969 | G, K | Calmodulin 1 (phosphorylase kinase, delta) | Calmodulin 1 (phosphorylase kinase, delta) |
| 1888 | 1354 | NM_057130 | B | BH3 interacting domain 3 | BH3 interacting domain 3 |
| 23033 | 1355 | NM_080888 | A, C, K | BCL2/adenovirus E1B 19 kDa-interacting protein 3-like | BCL2/adenovirus E1B 19 kDa-interacting protein 3-like |
| 23709 | 1356 | NM_138532 | N | (ATPase Na+/K+ transporting beta 1 polypeptide, | (ATPase Na+/K+ transporting beta 1 polypeptide, NME7) |
| | | | | NME7) | |
| 15072 | 1357 | NM_144730 | A | GATA-binding protein 4 | GATA-binding protein 4 |
| 26083 | 1358 | NM_147146 | B, H | | |
| 24232 | 1359 | NM_171992 | B | cyclin D1 | cyclin D1 |
| 20795 | 1360 | NM_175761 | N, H | heat shock protein 86 | heat shock protein 86 |
| 5952 | 1361 | NM_181090 | E | solute carrier family 38, member 2 | solute carrier family 38, member 2 |
| 24762 | 1362 | NM_181092 | M, D | (solute carrier family 7 (cationic amino acid transporter, | (solute carrier family 7 (cationic amino acid transporter, y+ system), member |
| | | | | y+ system), member 8, synaptic Ras GTPase activating | 8, synaptic Ras GTPase activating protein 1) |
| | | | | protein 1) | |
| 5837 | 1363 | S43408 | M, N, F | Meprin 1 alpha | Meprin 1 alpha |
| 5838 | 1363 | S43408 | M, F, G | Meprin 1 alpha | Meprin 1 alpha |
| 25064 | 1364 | S45392 | N, H, K | | |
| 21977 | 1365 | S46785 | A, B | insulin-like growth factor binding protein, acid labile | insulin-like growth factor binding protein, acid labile subunit |
| | | | | subunit | |
| 25480 | 1365 | S46785 | N | insulin-like growth factor binding protein, acid labile | insulin-like growth factor binding protein, acid labile subunit |
| | | | | subunit | |
| 25481 | 1366 | S46798 | N | | |
| 4012 | 1367 | S48325 | N, J | cytochrome P450, subfamily 2E, polypeptide 1 | cytochrome P450, subfamily 2E, polypeptide 1 |
| 10886 | 1368 | S49003 | N | | |
| 5493 | 1369 | S56936 | N | UDP glycosyltransferase 1 family, polypeptide A6 | UDP glycosyltransferase 1 family, polypeptide A6 |
| 15127 | 1370 | S56937 | N | (UDP glycosyltransferase 1 family, polypeptide A1, | (UDP glycosyltransferase 1 family, polypeptide A1, UDP glycosyltransferase 1 |
| | | | | UDP glycosyltransferase 1 family, polypeptide A6, UDP | family, polypeptide A6, UDP glycosyltransferase 1 family, polypeptide A7, |
| | | | | glycosyltransferase 1 family, polypeptide A7, UDP- | UDP-glucuronosyltransferase 1A8) |
| | | | | glucuronosyltransferase 1A8) | |
| 7196 | 1371 | S57478 | M, E, G, K | annexin 1 | annexin 1 |
| 8210 | 1372 | S61960 | M | | |
| 3244 | 1373 | S63519 | M | | |
| 14003 | 1374 | S65555 | N, B, J | glutamate cysteine ligase, modifier subunit | glutamate cysteine ligase, modifier subunit |
| 355 | 1375 | S66024 | N | cAMP responsive element modulator | cAMP responsive element modulator |
| 356 | 1375 | S66024 | N | cAMP responsive element modulator | cAMP responsive element modulator |
| 16248 | 1376 | S68135 | N | solute carrier family 2, member 1 | solute carrier family 2, member 1 |
| 15832 | 1377 | S68589 | N | | |
| 1471 | 1378 | S68809 | N | S100 calcium binding protein A1 | |
| 18647 | 1379 | S69316 | N | tumor rejection antigen gp96 | |
| 20740 | 1380 | S69874 | D | fatty acid binding protein 5, epidermal | fatty acid binding protein 5, epidermal |
| 9224 | 1381 | S70011 | N, C | | |
| 25518 | 1381 | S70011 | N | | |
| 15135 | 1382 | S71021 | N, G | ribosomal protein L6 | ribosomal protein L6 |
| 25525 | 1383 | S72505 | N | glutathione S-transferase, alpha 1 | glutathione S-transferase, alpha 1 |
| 18990 | 1384 | S72506 | N, H | | |
| 15137 | 1385 | S73424 | L | macrophage migration inhibitory factor | macrophage migration inhibitory factor |
| 16211 | 1386 | S75960 | N | uromodulin | uromodulin |
| 1460 | 1387 | S76054 | M, A, C, I, K | | |
| 1943 | 1388 | S77494 | N, L | lysyl oxidase | lysyl oxidase |
| 21583 | 1389 | S77900 | N | | |
| 25545 | 1389 | S77900 | N | | |
| 25546 | 1390 | S78154 | N, K | | |
| 25547 | 1391 | S78556 | C | | |
| 25550 | 1392 | S79213 | J | protein phosphatase 1, regulatory (inhibitor) subunit 2 | |
| 10260 | 1393 | S81497 | N | lipase A, lysosomal acid | lipase A, lysosomal acid |
| 25563 | 1393 | S81497 | N | lipase A, lysosomal acid | lipase A, lysosomal acid |
| 14121 | 1394 | S82383 | N, I | tropomyosin isoform 6 | tropomyosin isoform 6 |
| 3609 | 1395 | S82579 | N, F | histamine N-methyltransferase | histamine N-methyltransferase |
| 25069 | 1396 | S82820 | N, H | | |
| 25070 | 1397 | S83279 | M, N | peroxisomal multifunctional enzyme type II | peroxisomal multifunctional enzyme type II |
| 3430 | 1398 | S85184 | M, G, I | | |
| 25567 | 1398 | S85184 | M, I | | |
| 18449 | 1399 | U00926 | H | ATP synthase, H+ transporting, mitochondrial F1 | ATP synthase, H+ transporting, mitochondrial F1 complex, delta subunit |
| | | | | complex, delta subunit | |
| 347 | 1400 | U01914 | D | A kinase anchor protein 8 | A kinase anchor protein 8 |
| 18005 | 1401 | U02320 | N | neuregulin 1 | neuregulin 1 |
| 18011 | 1402 | U02322 | M, H | neuregulin 1 | neuregulin 1 |
| 20885 | 1403 | U04842 | N, G, K | epidermal growth factor | epidermal growth factor |
| 1570 | 1404 | U05014 | A | eukaryotic translation initiation factor 4E binding protein 1 | eukaryotic translation initiation factor 4E binding protein 1 |
| 2010 | 1405 | U05675 | K | Fibrinogen, B beta polypeptide | Fibrinogen, B beta polypeptide |
| 23606 | 1406 | U05784 | N | microtubule-associated proteins 1A/1B light chain 3 | microtubule-associated proteins 1A/1B light chain 3 |
| 17806 | 1407 | U06273 | N | UDP-glucuronosyltransferase | UDP-glucuronosyltransferase |
| 17805 | 1408 | U06274 | N, B | UDP-glucuronosyltransferase | UDP-glucuronosyltransferase |
| 7124 | 1409 | U07181 | E | lactate dehydrogenase B | lactate dehydrogenase B |
| 24874 | 1410 | U07619 | N | coagulation factor 3 | coagulation factor 3 |
| 16775 | 1411 | U07971 | M, D, I, L | glycine amidinotransferase (L-arginine: glycine | glycine amidinotransferase (L-arginine: glycine amidinotransferase) |
| | | | | amidinotransferase) | |
| 20925 | 1412 | U08976 | N, L | enoyl coenzyme A hydratase 1 | enoyl coenzyme A hydratase 1 |
| 20803 | 1413 | U09256 | N, B, H, I | transketolase | transketolase |
| 4532 | 1414 | U10096 | J | solute carrier family 12, member 1 | solute carrier family 12, member 1 |
| 646 | 1415 | U10097 | N, G, K | solute carrier family 12, member 3 | solute carrier family 12, member 3 |
| 714 | 1416 | U10279 | N | solute carrier family 28 (sodium-coupled nucleoside | solute carrier family 28 (sodium-coupled nucleoside transporter), member 1 |
| | | | | transporter), member 1 | |
| 45 | 1417 | U10354 | M, J, L | calcium-sensing receptor | calcium-sensing receptor |
| 1928 | 1418 | U10357 | N | pyruvate dehydrogenase kinase 2 | pyruvate dehydrogenase kinase 2 |
| 1929 | 1418 | U10357 | N, A, C, D, E | pyruvate dehydrogenase kinase 2 | pyruvate dehydrogenase kinase 2 |
| 16268 | 1419 | U10894 | N | (allograft inflammatory factor 1, balloon angioplasty | (allograft inflammatory factor 1, balloon angioplasty responsive transcript) |
| | | | | responsive transcript) | |
| 24900 | 1420 | U12973 | N, H | X transporter protein 2 | X transporter protein 2 |
| 15273 | 1421 | U13177 | E | ubiquitin-conjugating enzyme E2D 3 (homologous to | ubiquitin-conjugating enzyme E2D 3 (homologous to yeast UBC4/5) |
| | | | | yeast UBC4/5) | |
| 20443 | 1422 | U14192 | H | vesicle docking protein, 115 kDa | vesicle docking protein, 115 kDa |
| 1424 | 1423 | U14746 | N | von Hippel-Lindau syndrome homolog | von Hippel-Lindau syndrome homolog |
| 809 | 1424 | U17035 | C | chemokine (C—X—C motif) ligand 10 | chemokine (C—X—C motif) ligand 10 |
| 16674 | 1425 | U17565 | E | mini chromosome maintenance deficient 6 (S. cerevisiae) | mini chromosome maintenance deficient 6 (S. cerevisiae) |
| 16675 | 1425 | U17565 | N, E | mini chromosome maintenance deficient 6 (S. cerevisiae) | mini chromosome maintenance deficient 6 (S. cerevisiae) |
| 9520 | 1426 | U17837 | B | | |
| 1824 | 1427 | U17971 | K | protein tyrosine phosphatase 2E | protein tyrosine phosphatase 2E |
| 16871 | 1428 | U18314 | N, E | thymopoietin | thymopoietin |
| 19712 | 1429 | U18374 | K | nuclear receptor subfamily 1, group H, member 4 | nuclear receptor subfamily 1, group H, member 4 |
| 17999 | 1430 | U19485 | M | spp-24 precursor | spp-24 precursor |
| 18000 | 1430 | U19485 | I | spp-24 precursor | spp-24 precursor |
| 1949 | 1431 | U19614 | A | lamina-associated polypeptide 1C | lamina-associated polypeptide 1C |
| 25589 | 1432 | U21718 | F | hypothetical RNA binding protein RDA288 | hypothetical RNA binding protein RDA288 |
| 22196 | 1433 | U21719 | M, N | | Rattus norvegicus clone D920 intestinal epithelium proliferating cell- |
| | | | | | associated mRNA sequence |
| 275 | 1434 | U22424 | M | hydroxysteroid 11-beta dehydrogenase 2 | hydroxysteroid 11-beta dehydrogenase 2 |
| 1581 | 1435 | U23769 | M, A, C | PDZ and LIM domain 1 | PDZ and LIM domain 1 |
| 133 | 1436 | U24174 | N | cyclin-dependent kinase inhibitor 1A | cyclin-dependent kinase inhibitor 1A |
| 1340 | 1437 | U25651 | B | phosphofructokinase, muscle | phosphofructokinase, muscle |
| 1553 | 1438 | U25808 | J | Kidney androgen-regulated protein | Kidney androgen-regulated protein |
| 20555 | 1439 | U26033 | F | carnitine O-octanoyltransferase | carnitine O-octanoyltransferase |
| 1472 | 1440 | U26356 | K | | |
| 1537 | 1441 | U27518 | N, H | UDP-glucuronosyltransferase | UDP-glucuronosyltransferase |
| 1558 | 1442 | U28504 | N, H | solute carrier family 17 vesicular glutamate transporter), | solute carrier family 17 vesicular glutamate transporter), member 1 |
| | | | | member 1 | |
| 1559 | 1442 | U28504 | N | solute carrier family 17 vesicular glutamate transporter), | solute carrier family 17 vesicular glutamate transporter), member 1 |
| | | | | member 1 | |
| 247 | 1443 | U28938 | J | protein tyrosine phosphatase, receptor type, O | protein tyrosine phosphatase, receptor type, O |
| 20780 | 1444 | U29881 | M, N, D | low affinity Na-dependent glucose transporter (SGLT2) | low affinity Na-dependent glucose transporter (SGLT2) |
| 1598 | 1445 | U30186 | N | DNA-damage inducible transcript 3 | DNA-damage inducible transcript 3 |
| 1970 | 1446 | U31463 | N, K | myosin, heavy polypeptide 9 | myosin, heavy polypeptide 9 |
| 1478 | 1447 | U32314 | M | Pyruvate carboxylase | Pyruvate carboxylase |
| 1479 | 1447 | U32314 | N, D | Pyruvate carboxylase | Pyruvate carboxylase |
| 18301 | 1448 | U33500 | M | | Rattus norvegicus retinol dehydrogenase type II mRNA, complete cds |
| 18302 | 1448 | U33500 | M | | Rattus norvegicus retinol dehydrogenase type II mRNA, complete cds |
| 16552 | 1449 | U36482 | L | endoplasmic retuclum protein 29 | endoplasmic retuclum protein 29 |
| 433 | 1450 | U37142 | C | Brevican | Brevican |
| 23826 | 1451 | U38180 | N | solute carrier family 19, member 1 | solute carrier family 19, member 1 |
| 797 | 1452 | U38253 | N | eukaryotic translation initiation factor 2B, subunit 3 | eukaryotic translation initiation factor 2B, subunit 3 (gamma, 58 kD) |
| | | | | (gamma, 58 kD) | |
| 15851 | 1453 | U42719 | M | complement component 4a | complement component 4a |
| 24484 | 1454 | U42976 | H | cholinergic receptor, nicotinic, beta polypeptide 4 | cholinergic receptor, nicotinic, beta polypeptide 4 |
| 19543 | 1455 | U44948 | N | cysteine rich protein 2 | cysteine rich protein 2 |
| 1453 | 1456 | U48596 | F, K | mitogen activated protein kinase kinase kinase 1 | mitogen activated protein kinase kinase kinase 1 |
| 1454 | 1456 | U48596 | M, K | mitogen activated protein kinase kinase kinase 1 | mitogen activated protein kinase kinase kinase 1 |
| 20829 | 1457 | U49062 | M, D | CD24 antigen | CD24 antigen |
| 20830 | 1457 | U49062 | M | CD24 antigen | CD24 antigen |
| 15489 | 1458 | U50194 | F | tripeptidylpeptidase II | tripeptidylpeptidase II |
| 16147 | 1459 | U51898 | M, N | phospholipase A2, group VI | phospholipase A2, group VI |
| 21654 | 1460 | U53184 | M, I, L | LPS-induced TNF-alpha factor | LPS-induced TNF-alpha factor |
| 25606 | 1461 | U53214 | C | tubulin tyrosine ligase | tubulin tyrosine ligase |
| 12014 | 1462 | U54632 | N | Ubiquitin conjugating enzyme E2I | Ubiquitin conjugating enzyme E2I |
| 699 | 1463 | U55765 | E | serine (or cysteine) proteinase inhibitor, clade A (alpha- | serine (or cysteine) proteinase inhibitor, clade A (alpha-1 antiproteinase, |
| | | | | 1 antiproteinase, antitrypsin), member 10 | antitrypsin), member 10 |
| 989 | 1464 | U56242 | N, D, F | v-maf musculoaponeurotic fibrosarcoma (avian) | v-maf musculoaponeurotic fibrosarcoma (avian) oncogene homolog (c-maf) |
| | | | | oncogene homolog (c-maf) | |
| 16708 | 1465 | U57042 | M, N | adenosine kinase | adenosine kinase |
| 15470 | 1466 | U57050 | H | 26S proteasome, subunit p112 | 26S proteasome, subunit p112 |
| 1439 | 1467 | U57391 | H | SH2-B PH domain containing signaling mediator 1 | SH2-B PH domain containing signaling mediator 1 |
| 912 | 1468 | U59184 | N | bcl2-associated X protein | bcl2-associated X protein |
| 15174 | 1469 | U59809 | N | insulin-like growth factor 2 receptor | insulin-like growth factor 2 receptor |
| 20772 | 1470 | U60882 | N | heterogeneous nuclear ribonucleoproteins | heterogeneous nuclear ribonucleoproteins methyltransferase-like 2 (S. cerevisiae) |
| | | | | methyltransferase-like 2 (S. cerevisiae) | |
| 725 | 1471 | U62316 | B | solute carrier family 16, member 7 | solute carrier family 16, member 7 |
| 15035 | 1472 | U62897 | B | carboxypeptidase D | carboxypeptidase D |
| 1490 | 1473 | U63839 | E | nucleoporin p58 | nucleoporin p58 |
| 24234 | 1474 | U63923 | M, A, I | thioredoxin reductase 1 | thioredoxin reductase 1 |
| 20896 | 1475 | U64030 | A, F | Deoxyuridinetriphosphatase (dUTPase) | Deoxyuridinetriphosphatase (dUTPase) |
| 794 | 1476 | U68168 | M, I | kynureninase (L-kynurenine hydrolase) | kynureninase (L-kynurenine hydrolase) |
| 24643 | 1477 | U68417 | N, K | branched chain aminotransferase 2, mitochondrial | branched chain aminotransferase 2, mitochondrial |
| 16398 | 1478 | U75392 | N | B-cell receptor-associated protein 37 | B-cell receptor-associated protein 37 |
| 23869 | 1479 | U75397 | L | early growth response 1 | early growth response 1 |
| 2153 | 1480 | U75404 | M, L | | Rattus norvegicus Ssecks 322 mRNA, 3′ untranslated region, partial sequence |
| 25632 | 1481 | U75405 | N | collagen, type 1, alpha 1 | collagen, type 1, alpha 1 |
| 20682 | 1482 | U75917 | B | clathrin-associated protein 17 | clathrin-associated protein 17 |
| 1602 | 1483 | U76379 | N | solute carrier family 22, member 1 | solute carrier family 22, member 1 |
| 20886 | 1484 | U76635 | E, G | Deoxyribonuclease I | Deoxyribonuclease I |
| 20887 | 1484 | U76635 | N, E, G | Deoxyribonuclease I | Deoxyribonuclease I |
| 4956 | 1485 | U76714 | H | solute carrier family 39 (iron-regulated transporter), | solute carrier family 39 (iron-regulated transporter), member 1 |
| | | | | member 1 | |
| 4957 | 1485 | U76714 | N | solute carrier family 39 (iron-regulated transporter), | solute carrier family 39 (iron-regulated transporter), member 1 |
| | | | | member 1 | |
| 25643 | 1486 | U77829 | N, A | growth arrest specific 5 | growth arrest specific 5 |
| 25647 | 1487 | U83119 | F | | |
| 23300 | 1488 | U84727 | N | 2-oxoglutarate carrier | 2-oxoglutarate carrier |
| 1546 | 1489 | U85512 | M, N, G | GTP cyclohydrolase I feedback regulatory protein | GTP cyclohydrolase I feedback regulatory protein |
| 15032 | 1490 | U89905 | M, A, H, I, K, L | alpha-methylacyl-CoA racemase | alpha-methylacyl-CoA racemase |
| 23282 | 1491 | U90725 | A | lipoprotein-binding protein | lipoprotein-binding protein |
| 1419 | 1492 | U90887 | N | arginase 2 | arginase 2 |
| 22675 | 1493 | U92081 | N, G | glycoprotein 38 | glycoprotein 38 |
| 1401 | 1494 | U93692 | J | preimplantation protein 2 | preimplantation protein 2 |
| 4504 | 1495 | U95178 | D | disabled homolog 2, mitogen-responsive | disabled homolog 2, mitogen-responsive phosphoprotein (Drosophila) |
| | | | | phosphoprotein (Drosophila) | |
| 17158 | 1496 | V01227 | N | alpha-tubulin | alpha-tubulin |
| 818 | 1497 | X02291 | N | aldolase B | aldolase B |
| 20818 | 1498 | X02904 | M, N | (glutathione S-transferase, pi 2, glutathione-S- | (glutathione S-transferase, pi 2, glutathione-S-transferase, pi 1) |
| | | | | transferase, pi 1) | |
| 14633 | 1499 | X03478 | H | UDP glycosyltransferase 2 family, polypeptide B | UDP glycosyltransferase 2 family, polypeptide B |
| 33 | 1500 | X03518 | N | gamma-glutamyl transpeptidase | gamma-glutamyl transpeptidase |
| 25662 | 1501 | X05472 | F | | |
| 20849 | 1502 | X05566 | M, G, K | myosin regulatory light chain | myosin regulatory light chain |
| 20513 | 1503 | X05684 | N | pyruvate kinase, liver and RBC | pyruvate kinase, liver and RBC |
| 1550 | 1504 | X06150 | N | Glycine methyltransferase | Glycine methyltransferase |
| 1551 | 1504 | X06150 | N, G | Glycine methyltransferase | Glycine methyltransferase |
| 16204 | 1505 | X06423 | M, N, G | ribosomal protein S8 | ribosomal protein S8 |
| 16205 | 1505 | X06423 | N, F | ribosomal protein S8 | ribosomal protein S8 |
| 6577 | 1506 | X06942 | F | A-raf | A-raf |
| 20715 | 1507 | X07259 | N, L | cytochrome P450,4A1 | cytochrome P450,4A1 |
| 1399 | 1508 | X07467 | M, H, I | glucose-6-phosphate dehydrogenase | glucose-6-phosphate dehydrogenase |
| 23523 | 1509 | X07944 | N | ornithine decarboxylase 1 | ornithine decarboxylase 1 |
| 16947 | 1510 | X08056 | N | Guanidinoacetate methyltransferase | Guanidinoacetate methyltransferase |
| 1853 | 1511 | X12367 | N | Glutathione peroxidase 1 | |
| 20597 | 1512 | X12459 | N | arginosuccinate synthetase | arginosuccinate synthetase |
| 20884 | 1513 | X12748 | N, G, K | epidermal growth factor | epidermal growth factor |
| 17377 | 1514 | X13058 | N | tumor protein p53 | tumor protein p53 |
| 24778 | 1515 | X13119 | N | serine dehydratase | serine dehydratase |
| 16847 | 1516 | X13549 | N | ribosomal protein S10 | ribosomal protein S10 |
| 20810 | 1517 | X14181 | N, G | | |
| 25675 | 1517 | X14181 | N | | |
| 15653 | 1518 | X14210 | N, G | ribosomal protein S4, X-linked | |
| 25676 | 1519 | X14254 | N | | |
| 20518 | 1520 | X14265 | N | calmodulin 3 | calmodulin 3 |
| 19244 | 1521 | X15013 | N | | |
| 1069 | 1522 | X15096 | N | acidic ribosomal protein P0 | acidic ribosomal protein P0 |
| 20167 | 1523 | X15705 | E | testis-specific heat shock protein-related gene hst70 | testis-specific heat shock protein-related gene hst70 |
| 20483 | 1524 | X15939 | N | myosin heavy chain, polypeptide 7 | myosin heavy chain, polypeptide 7 |
| 21562 | 1525 | X15958 | N, A | enoyl Coenzyme A hydratase, short chain 1 | enoyl Coenzyme A hydratase, short chain 1 |
| 14996 | 1526 | X16038 | M, D | alkaline phosphatase, tissue-nonspecific | alkaline phosphatase, tissue-nonspecific |
| 3202 | 1527 | X16043 | N | Protein phosphatase 2 (formerly 2A), catalytic subunit, | Protein phosphatase 2 (formerly 2A), catalytic subunit, alpha isoform |
| | | | | alpha isoform | |
| 24582 | 1528 | X16554 | D | phosphoribosyl pyrophosphate synthetase 1 | phosphoribosyl pyrophosphate synthetase 1 |
| 1847 | 1529 | X16555 | B | phosphoribosyl pyrophosphate synthetase 2 | phosphoribosyl pyrophosphate synthetase 2 |
| 25682 | 1530 | X16933 | N | RNA binding protein p45AUF1 | RNA binding protein p45AUF1 |
| 20449 | 1531 | X17053 | M | small inducible cytokine A2 | small inducible cytokine A2 |
| 25686 | 1532 | X51536 | N, F | ribosomal protein S3 | |
| 23987 | 1533 | X51615 | N, B | | |
| 20872 | 1534 | X51707 | N | ribosomal protein S19 | |
| 9620 | 1535 | X53377 | N | ribosomal protein S7 | ribosomal protein S7 |
| 20427 | 1536 | X53378 | N | ribosomal protein S13 | ribosomal protein S13 |
| 18606 | 1537 | X53504 | M | | |
| 25691 | 1537 | X53504 | N, G | | |
| 12903 | 1538 | X53517 | N | CD37 antigen | CD37 antigen |
| 20617 | 1539 | X53581 | F | | |
| 25692 | 1539 | X53581 | D | | |
| 1463 | 1540 | X54467 | M, G, K | cathepsin D | cathepsin D |
| 20725 | 1541 | X54510 | A | ATP synthase, H+ transporting, mitochondrial F0 | ATP synthase, H+ transporting, mitochondrial F0 complex, subunit F6 |
| | | | | complex, subunit F6 | |
| 20848 | 1542 | X54617 | M, G, K | | |
| 20161 | 1543 | X54686 | M, C, I | jun B proto-oncogene | jun B proto-oncogene |
| 21575 | 1544 | X55298 | J | ribophorin 2 | ribophorin 2 |
| 1447 | 1545 | X55986 | D | proteasome (prosome, macropain) subunit, alpha type 4 | proteasome (prosome, macropain) subunit, alpha type 4 |
| 21122 | 1546 | X56228 | N, E | thiosulfate sulfurtransferase | thiosulfate sulfurtransferase |
| 21123 | 1546 | X56228 | N, D | thiosulfate sulfurtransferase | thiosulfate sulfurtransferase |
| 1684 | 1547 | X56325 | J | hemoglobin, alpha 1 | hemoglobin, alpha 1 |
| 1885 | 1548 | X56546 | M, N | transcription factor 2 | transcription factor 2 |
| 10860 | 1549 | X57133 | N | hepatocyte nuclear factor 4, alpha | hepatocyte nuclear factor 4, alpha |
| 25699 | 1549 | X57133 | N | hepatocyte nuclear factor 4, alpha | hepatocyte nuclear factor 4, alpha |
| 10267 | 1550 | X57432 | N | ribosomal protein S2 | ribosomal protein S2 |
| 1037 | 1551 | X57523 | N | transporter 1, ATP-binding cassette, sub-family B | transporter 1, ATP-binding cassette, sub-family B (MDR/TAP) |
| | | | | (MDR/TAP) | |
| 19678 | 1552 | X57999 | M | deiodinase, iodothyronine, type I | deiodinase, iodothyronine, type I |
| 5667 | 1553 | X58200 | N | ribosomal protein L23 | |
| 18611 | 1553 | X58200 | N | ribosomal protein L23 | |
| 17175 | 1554 | X58389 | M, N | | |
| 10109 | 1555 | X58465 | N, G | ribosomal protein S5 | |
| 25702 | 1555 | X58465 | N, G | ribosomal protein S5 | |
| 25705 | 1556 | X59375 | M, J | | |
| 1141 | 1557 | X59601 | M, C, G | plectin | plectin |
| 25707 | 1558 | X59677 | N | solute carrier family 13, member 2 | solute carrier family 13, member 2 |
| 18354 | 1559 | X59859 | J | decorin | decorin |
| 21651 | 1560 | X60767 | N, E | cell division cycle 2 homolog A (S. pombe) | cell division cycle 2 homolog A (S. pombe) |
| 21239 | 1561 | X60769 | M, H, I | CCAAT/enhancer binding protein (C/EBP), beta | CCAAT/enhancer binding protein (C/EBP), beta |
| 21657 | 1562 | X61381 | M | | |
| 15875 | 1563 | X62145 | N | ribosomal protein L8 | |
| 25718 | 1563 | X62145 | M, G | ribosomal protein L8 | |
| 4441 | 1564 | X62146 | N, G | | |
| 25719 | 1564 | X62146 | N | | |
| 13646 | 1565 | X62166 | M, N, A, G | | |
| 18108 | 1566 | X62528 | N | ribonuclease/angiogenin inhibitor | ribonuclease/angiogenin inhibitor |
| 16012 | 1567 | X62875 | M, I | high mobility group AT-hook 1 | high mobility group AT-hook 1 |
| 15185 | 1568 | X62952 | M | vimentin | vimentin |
| 556 | 1569 | X64336 | M, N | Protein C | Protein C |
| 20844 | 1570 | X65228 | N | | |
| 16929 | 1571 | X66370 | G | ribosomal protein S9 | ribosomal protein S9 |
| 20085 | 1572 | X66870 | C | lamin A | lamin A |
| 495 | 1573 | X68041 | J | superoxide dismutase 3 | superoxide dismutase 3 |
| 417 | 1574 | X70141 | N | | |
| 405 | 1575 | X70223 | M, H, K | peroxisomal membrane protein 2 | peroxisomal membrane protein 2 |
| 24640 | 1576 | X70521 | N | Sodium channel, nonvoltage-gated 1, alpha (epithelial) | Sodium channel, nonvoltage-gated 1, alpha (epithelial) |
| 21443 | 1577 | X71127 | M, L | complement component 1, q subcomponent, beta | complement component 1, q subcomponent, beta polypeptide |
| | | | | polypeptide | |
| 22219 | 1578 | X72792 | N, F | alcohol dehydrogenase 1 | alcohol dehydrogenase 1 |
| 1877 | 1579 | X74593 | A, D, E | sorbitol dehydrogenase | sorbitol dehydrogenase |
| 15599 | 1580 | X75253 | J | phosphatidylethanolamine binding protein | phosphatidylethanolamine binding protein |
| 24626 | 1581 | X75856 | N | Testis enhanced gene transcript | Testis enhanced gene transcript |
| 16272 | 1582 | X76456 | N | afamin | afamin |
| 1993 | 1583 | X76985 | M, E, G, K | latexin | latexin |
| 24639 | 1584 | X77932 | N | Sodium channel, nonvoltage-gated 1, beta (epithelial) | Sodium channel, nonvoltage-gated 1, beta (epithelial) |
| 23854 | 1585 | X78327 | N, G | ribosomal protein L13 | ribosomal protein L13 |
| 635 | 1586 | X78848 | N | glutathione S-transferase, alpha 1 | glutathione S-transferase, alpha 1 |
| 13940 | 1587 | X79321 | N, D | microtubule-associated protein tau | microtubule-associated protein tau |
| 466 | 1588 | X81395 | N | carboxylesterase 1 | carboxylesterase 1 |
| 25747 | 1589 | X81448 | M, C, K | keratin complex 1, acidic, gene 18 | keratin complex 1, acidic, gene 18 |
| 570 | 1590 | X82445 | N | nuclear distribution gene C homolog (Aspergillus) | nuclear distribution gene C homolog (Aspergillus) |
| 1764 | 1591 | X83399 | C | eukaryotic translation initiation factor 4E | eukaryotic translation initiation factor 4E |
| 343 | 1592 | X91810 | L | signal transducer and activator of transcription 3 | signal transducer and activator of transcription 3 |
| 11849 | 1593 | X93352 | M, N, G | ribosomal protein L10a | ribosomal protein L10a |
| 18107 | 1594 | X94242 | N | ribosomal protein L14 | ribosomal protein L14 |
| 12978 | 1595 | X96437 | M, H, I | | |
| 25770 | 1595 | X96437 | N | | |
| 21585 | 1596 | X97772 | D | 3-phosphoglycerate dehydrogenase | 3-phosphoglycerate dehydrogenase |
| 21586 | 1596 | X97772 | D | 3-phosphoglycerate dehydrogenase | 3-phosphoglycerate dehydrogenase |
| 14347 | 1597 | Y00156 | N, H | UDP-glucuronosyltransferase 2B3 precursor, | UDP-glucuronosyltransferase 2B3 precursor, microsomal |
| | | | | microsomal | |
| 2629 | 1598 | Y00396 | K | v-myc avian myelocytomatosis viral oncogene homolog | v-myc avian myelocytomatosis viral oncogene homolog |
| 4594 | 1599 | Y07704 | N | Best5 protein | Best5 protein |
| 25777 | 1600 | Y08355 | M, A, F, I | sequestosome 1 | sequestosome 1 |
| 1858 | 1601 | Y09333 | B, L | (cytosolic acyl-CoA thioesterase 1, mitochondrial acyl- | (cytosolic acyl-CoA thioesterase 1, mitochondrial acyl-CoA thioesterase 1) |
| | | | | CoA thioesterase 1) | |
| 15986 | 1602 | Y09945 | M, I | putative integral membrane transport UST1r | putative integral membrane transport UST1r |
| 21914 | 1603 | Y13336 | J | | |
| 11840 | 1604 | Y15068 | H, I | stress-induced-phosphoprotein 1 (Hsp70/Hsp90- | stress-induced-phosphoprotein 1 (Hsp70/Hsp90-organizing protein) |
| | | | | organizing protein) | |
| 20173 | 1605 | Z11932 | N, C | arginine vasopressin receptor 2 | arginine vasopressin receptor 2 |
| 406 | 1606 | Z11995 | M | low density lipoprotein receptor-related protein | low density lipoprotein receptor-related protein associated protein 1 |
| | | | | associated protein 1 | |
| 407 | 1606 | Z11995 | N, C | low density lipoprotein receptor-related protein | low density lipoprotein receptor-related protein associated protein 1 |
| | | | | associated protein 1 | |
| 18352 | 1607 | Z12298 | L | | |
| 23780 | 1608 | Z19552 | E | topoisomerase (DNA) 2 alpha | topoisomerase (DNA) 2 alpha |
| 439 | 1609 | Z22607 | N, F | Bone morphogenetic protein 4 | Bone morphogenetic protein 4 |
| 494 | 1610 | Z24721 | J | superoxide dismutase 3 | superoxide dismutase 3 |
| 8663 | 1611 | Z27118 | N | heat shock 70 kD protein 1A | heat shock 70 kD protein 1A |
| 17226 | 1612 | Z36980 | N, C, E | D-dopachrome tautomerase | D-dopachrome tautomerase |
| 17227 | 1612 | Z36980 | N, E | D-dopachrome tautomerase | D-dopachrome tautomerase |
| 6641 | 1613 | Z49858 | M, A, I | plasmolipin | plasmolipin |
| 1542 | 1614 | Z50144 | N, J | kynurenine aminotransferase 2 | kynurenine aminotransferase 2 |
| 8664 | 1615 | Z75029 | N, C, D | | R. norvegicus hsp70.2 mRNA for heat shock protein 70 |
| 15569 | 1616 | Z78279 | N | collagen, type 1, alpha 1 | collagen, type 1, alpha 1 |
| 10887 | 1617 | Z83757 | M, I | growth hormone receptor | growth hormone receptor |

TABLE 2

| GLGC | | GenBank Acc or | Model | |
|---|---|---|---|---|
| Identifier | Seq ID | RefSeq ID | Code | Pathway Name |
| 25802 | 1353 | NM_031969 | G, K | [symbol] |
| | | | | activation of JNK Pathway via Pyk2 dependent signaling, BCR |
| | | | | Signaling Pathway, Bioactive Peptide Induced Signaling Pathway, |
| | | | | Ca++/Calmodulin-dependent Protein Kinase Activation, Control of |
| | | | | skeletal myogenesis by HDAC & calcium/calmodulin-dependent |
| | | | | kinase (CaMK), Corticosteroids and cardioprotection, Effects of |
| | | | | calcineurin in Keratinocyte Differentiation, Fc Epsilon Receptor I |
| | | | | Signaling in Mast Cells, Huntington's disease, Links between Pyk2 |
| | | | | and Map Kinases, NFAT and Hypertrophy of the heart (Transcription |
| | | | | in the broken heart), Neuropeptides VIP and PACAP inhibit the |
| | | | | apoptosis of activated T cells, Nitric Oxide Signaling Pathway, |
| | | | | Pertussis toxin-insensitive CCR5 Signaling in Macrophage, |
| | | | | Phosphatidylinositol signaling system, Regulation of PGC-1a, Role of |
| | | | | MEF2D in T-cell Apoptosis, Signaling Pathway from G-Protein |
| | | | | Families, T Cell Receptor Signaling Pathway, fMLP induced |
| | | | | chemokine gene expression in HMC-1 cells) |
| 20414 | 1188 | L14323 | M | (Activation of PKC through G protein coupled receptor, Aspirin |
| | | | | Blocks Signaling Pathway Involved in Platelet Activation, CCR3 |
| | | | | signaling in Eosinophils, Cadmium induces DNA synthesis and |
| | | | | proliferation in macrophages, G-Protein Signaling Through Tubby |
| | | | | Proteins, Inositol phosphate metabolism, PKC-catalyzed |
| | | | | phosphorylation of inhibitory phosphoprotein of myosin phosphatase, |
| | | | | Phosphatidylinositol signaling system, Phospholipase C Signaling |
| | | | | Pathway, Phospholipids as signalling intermediaries, Regulation of |
| | | | | ck1/cdk5 by type 1 glutamate receptors, Thrombin signaling and |
| | | | | protease-activated receptors, fMLP induced chemokine gene |
| | | | | expression in HMC-1 cells) |
| 556 | 1569 | X64336 | M, N | (Acute Myocardial Infarction, Extrinsic Prothrombin Activation |
| | | | | Pathway, Intrinsic Prothrombin Activation Pathway) |
| 46 | 1242 | M23697 | N | (Acute Myocardial Infarction, Fibrinolysis Pathway) |
| 14989 | 857 | AI177366 | M, K | (Adhesion Molecules on Lymphocyte, Agrin in Postsynaptic |
| | | | | Differentiation, Aspirin Blocks Signaling Pathway Involved in Platelet |
| | | | | Activation, B Cell Survival Pathway, Cells and Molecules involved in |
| | | | | local acute inflammatory response, Eph Kinases and ephrins support |
| | | | | platelet aggregation, Erk and PI-3 Kinase Are Necessary for |
| | | | | Collagen Binding in Corneal Epithelia, Erk1/Erk2 Mapk Signaling |
| | | | | pathway, Integrin Signaling Pathway, Monocyte and its Surface |
| | | | | Molecules, PTEN dependent cell cycle arrest and apoptosis, Ras- |
| | | | | Independent pathway in NK cell-mediated cytotoxicity, Signaling of |
| | | | | Hepatocyte Growth Factor Receptor, mCalpain and friends in Cell |
| | | | | motility, uCalpain and friends in Cell spread) |
| 2554 | 1063 | D00913 | M, N | (Adhesion Molecules on Lymphocyte, B Lymphocyte Cell Surtace |
| | | | | Molecules, CTL mediated immune response against target cells, |
| | | | | Cells and Molecules involved in local acute inflammatory response, |
| | | | | Monocyte and its Surface Molecules, Neutrophil and Its Surface |
| | | | | Molecules, T Cytotoxic Cell Surface Molecules, T Helper Cell Surface |
| | | | | Molecules) |
| 2555 | 1063 | D00913 | M, C, I | (Adhesion Molecules on Lymphocyte, B Lymphocyte Cell Surface |
| | | | | Molecules, CTL mediated immune response against target cells, |
| | | | | Cells and Molecules involved in local acute inflammatory response, |
| | | | | Monocyte and its Surface Molecules, Neutrophil and Its Surface |
| | | | | Molecules, T Cytotoxic Cell Surface Molecules, T Helper Cell Surface |
| | | | | Molecules) |
| 17907 | 969 | AI233224 | M | (Agrin in Postsynaptic Differentiation, Angiotensin II mediated |
| | | | | activation of JNK Pathway via Pyk2 dependent signaling, CBL |
| | | | | mediated ligand-induced downregulation of EGF receptors, EGF |
| | | | | Signaling Pathway, Erk1/Erk2 Mapk Signaling pathway, Keratinocyte |
| | | | | Differentiation, Map Kinase Inactivation of SMRT Corepressor, Role |
| | | | | of EGF Receptor Transactivation by GPCRs in Cardiac Hypertrophy, |
| | | | | Sprouty regulation of tyrosine kinase signals, The role of FYVE-finger |
| | | | | proteins in vesicle transport, mCalpain and friends in Cell motility) |
| 21651 | 1560 | X60767 | N, E | (AKAP95 role in mitosis and chromosome dynamics, Activation of |
| | | | | Src by Protein-tyrosine phosphatase alpha, Cell Cycle: G1/S Check |
| | | | | Point, Cell Cycle: G2/M Checkpoint, Cyclins and Cell Cycle |
| | | | | Regulation, How Progesterone Initiates the Oocyte Maturation, |
| | | | | Inositol phosphate metabolism, Nicotinate and nicotinamide |
| | | | | metabolism, Protein Kinase A at the Centrosome, RB Tumor |
| | | | | Suppressor/Checkpoint Signaling in response to DNA damage, Sonic |
| | | | | Hedgehog (SHH) Receptor Ptc1 Regulates cell cycle, |
| | | | | Sphingoglycolipid metabolism, Starch and sucrose metabolism, |
| | | | | cdc25 and chk1 Regulatory Pathway in response to DNA damage) |
| 3202 | 1527 | X16043 | N | (AKAP95 role in mitosis and chromosome dynamics, AKT Signaling |
| | | | | Pathway, ChREBP regulation by carbohydrates and cAMP, |
| | | | | Deregulation of CDK5 in Alzheimers Disease, Erk1/Erk2 Mapk |
| | | | | Signaling pathway, Inactivation of Gsk3 by AKT causes accumulation |
| | | | | of b-catenin in Alveolar Macrophages, Keratinocyte Differentiation, |
| | | | | Protein Kinase A at the Centrosome, Regulation of ck1/cdk5 by type |
| | | | | 1 glutamate receptors, Skeletal muscle hypertrophy is regulated via |
| | | | | AKT/mTOR pathway, WNT Signaling Pathway, mTOR Signaling |
| | | | | Pathway) |
| 16518 | 845 | AI176546 | N, C, K | (AKT Signaling Pathway, Actions of Nitric Oxide in the Heart, Ahr |
| | | | | Signal Transduction Pathway, Corticosteroids and cardioprotection, |
| | | | | Hypoxia and p53 in the Cardiovascular system, Hypoxia-Inducible |
| | | | | Factor in the Cardiovascular System, Mechanism of Gene Regulation |
| | | | | by Peroxisome Proliferators via PPARa(alpha)) |
| 20795 | 1360 | NM_175761 | N, H | (AKT Signaling Pathway, Actions of Nitric Oxide in the Heart, Ahr |
| | | | | Signal Transduction Pathway, Corticosteroids and cardioprotection, |
| | | | | Hypoxia and p53 in the Cardiovascular system, Hypoxia-Inducible |
| | | | | Factor in the Cardiovascular System, Mechanism of Gene Regulation |
| | | | | by Peroxisome Proliferators via PPARa(alpha)) |
| 16683 | 1086 | D17445 | N | (AKT Signaling Pathway, Cell Cycle: G2/M Checkpoint, Control of |
| | | | | skeletal myogenesis by HDAC & calcium/calmodulin-dependent |
| | | | | kinase (CaMK), Multiple antiapoptotic pathways from IGF-1R |
| | | | | signaling lead to BAD phosphorylation, RB Tumor |
| | | | | Suppressor/Checkpoint Signaling in response to DNA damage, |
| | | | | Regulation of BAD phosphorylation, Regulation of PGC-1a, |
| | | | | Regulation of cell cycle progression by Plk3, Role of nicotinic |
| | | | | acetylcholine receptors in the regulation of apoptosis, Signal |
| | | | | Dependent Regulation of Myogenesis by Corepressor MITR, cdc25 |
| | | | | and chk1 Regulatory Pathway in response to DNA damage) |
| 16684 | 1086 | D17445 | M | (AKT Signaling Pathway, Cell Cycle: G2/M Checkpoint, Control of |
| | | | | skeletal myogenesis by HDAC & calcium/calmodulin-dependent |
| | | | | kinase (CaMK), Multiple antiapoptotic pathways from IGF-1R |
| | | | | signaling lead to BAD phosphorylation, RB Tumor |
| | | | | Suppressor/Checkpoint Signaling in response to DNA damage, |
| | | | | Regulation of BAD phosphorylation, Regulation of PGC-1a, |
| | | | | Regulation of cell cycle progression by Plk3, Role of nicotinic |
| | | | | acetylcholine receptors in the regulation of apoptosis, Signal |
| | | | | Dependent Regulation of Myogenesis by Corepressor MITR, cdc25 |
| | | | | and chk1 Regulatory Pathway in response to DNA damage) |
| 17524 | 559 | AI010568 | M, A, I | (AKT Signaling Pathway, Growth Hormone Signaling Pathway, |
| | | | | Regulation of elF4e and p70 S6 Kinase, The IGF-1 Receptor and |
| | | | | Longevity) |
| 10887 | 1617 | Z83757 | M, I | (AKT Signaling Pathway, Growth Hormone Signaling Pathway, |
| | | | | Regulation of elF4e and p70 S6 Kinase, The IGF-1 Receptor and |
| | | | | Longevity) |
| 17630 | 201 | AA892012 | N | (Alanine and aspartate metabolism, Arginine and proline metabolism, |
| | | | | Cysteine metabolism, Glutamate metabolism, Phenylalanine |
| | | | | metabolism, Phenylalanine, tyrosine and tryptophan biosynthesis, |
| | | | | Tyrosine metabolism) |
| 4234 | 457 | AB016536 | N, K | (Alanine and aspartate metabolism, Arginine and proline metabolism, |
| | | | | Urea cycle and metabolism of amino groups) |
| 18727 | 1078 | D13978 | N | (Alanine and aspartate metabolism, Arginine and proline metabolism, |
| | | | | Urea cycle and metabolism of amino groups) |
| 20597 | 1512 | X12459 | N | (Alanine and aspartate metabolism, Arginine and proline metabolism, |
| | | | | Urea cycle and metabolism of amino groups) |
| 19824 | 1125 | E13557 | N, G, K | (Alanine and aspartate metabolism, Butanoate metabolism, |
| | | | | Glutamate metabolism, Taurine and hypotaurine metabolism, beta- |
| | | | | Alanine metabolism) |
| 19825 | 1288 | M64755 | N | (Alanine and aspartate metabolism, Butanoate metabolism, |
| | | | | Glutamate metabolism, Taurine and hypotaurine metabolism, beta- |
| | | | | Alanine metabolism) |
| 1478 | 1447 | U32314 | M | (Alanine and aspartate metabolism, Citrate cycle (TCA cycle), |
| | | | | Pyruvate metabolism, Shuttle for transfer of acetyl groups from |
| | | | | mitochondria to the cytosol) |
| 1479 | 1447 | U32314 | N, D | (Alanine and aspartate metabolism, Citrate cycle (TCA cycle), |
| | | | | Pyruvate metabolism, Shuttle for transfer of acetyl groups from |
| | | | | mitochondria to the cytosol) |
| 15703 | 444 | AB009372 | N | (Alanine and aspartate metabolism, Glycerolipid metabolism, |
| | | | | Phospholipid degradation) |
| 7914 | 439 | AB002584 | N | (Alanine and aspartate metabolism, Glycine, serine and threonine |
| | | | | metabolism) |
| 10789 | 947 | AI232059 | M | (Alanine and aspartate metabolism, Histidine metabolism) |
| 15072 | 1357 | NM_144730 | A | (ALK in cardiac myocytes, Hop Pathway in Cardiac Development, |
| | | | | NFAT and Hypertrophy of the heart (Transcription in the broken |
| | | | | heart)) |
| 13938 | 1339 | NM_017212 | N | (Alzheimer's disease, Bioactive Peptide Induced Signaling Pathway, |
| | | | | Deregulation of CDK5 in Alzheimers Disease, Parkinson's disease) |
| 13939 | 1339 | NM_017212 | D | (Alzheimer's disease, Bioactive Peptide Induced Signaling Pathway, |
| | | | | Deregulation of CDK5 in Alzheimers Disease, Parkinson's disease) |
| 13940 | 1587 | X79321 | N, D | (Alzheimer's disease, Bioactive Peptide Induced Signaling Pathway, |
| | | | | Deregulation of CDK5 in Alzheimers Disease, Parkinson's disease) |
| 15376 | 153 | AA875206 | N | (Alzheimer's disease, Gamma-aminobutyric Acid Receptor Life |
| | | | | Cycle) |
| 7488 | 464 | AF007758 | N | (Alzheimer's disease, Parkinson's disease) |
| 7489 | 464 | AF007758 | M, G, I, J, L | (Alzheimer's disease, Parkinson's disease) |
| 20555 | 1439 | U26033 | F | (Aminosugars metabolism, Butanoate metabolism, Glycerolipid |
| | | | | metabolism, Histidine metabolism, Lysine biosynthesis, Lysine |
| | | | | degradation, Phenylalanine metabolism, Tyrosine metabolism, |
| | | | | Valine, leucine and isoleucine degradation) |
| 912 | 1468 | U59184 | N | (Amyotrophic lateral sclerosis (ALS), Apoptotic Signaling in |
| | | | | Response to DNA Damage, Ceramide Signaling Pathway, Hypoxia |
| | | | | and p53 in the Cardiovascular system, Regulation of BAD |
| | | | | phosphorylation, Role of Mitochondria in Apoptotic Signaling, p53 |
| | | | | Signaling Pathway) |
| 20876 | 1238 | M21060 | J | (Amyotrophic lateral sclerosis (ALS), Cardiac Protection Against |
| | | | | ROS, Free Radical Induced Apoptosis, The IGF-1 Receptor and |
| | | | | Longevity) |
| 1853 | 1511 | X12367 | N | (Amyotrophic lateral sclerosis (ALS), Glutathione metabolism) |
| 15741 | 1214 | M11670 | N | (Amyotrophic lateral sclerosis (ALS), Methane metabolism, The IGF- |
| | | | | 1 Receptor and Longevity, Tryptophan metabolism) |
| 275 | 1434 | U22424 | M | (Androgen and estrogen metabolism, C21-Steroid hormone |
| | | | | metabolism) |
| 23660 | 747 | AI105448 | N | (Androgen and estrogen metabolism, C21-Steroid hormone |
| | | | | metabolism, Visceral Fat Deposits and the Metabolic Syndrome) |
| 20772 | 1470 | U60882 | N | (Androgen and estrogen metabolism, Histidine metabolism, |
| | | | | Selenoamino acid metabolism, Tryptophan metabolism, Tyrosine |
| | | | | metabolism, Ubiquinone biosynthesis) |
| 25070 | 1397 | S83279 | M, N | (Androgen and estrogen metabolism, Mechanism of Gene |
| | | | | Regulation by Peroxisome Proliferators via PPARa(alpha)) |
| 5492 | 1097 | D38061 | N | (Androgen and estrogen metabolism, Pentose and glucuronate |
| | | | | interconversions, Porphyrin and chlorophyll metabolism, Starch and |
| | | | | sucrose metabolism) |
| 18028 | 1098 | D38062 | N | (Androgen and estrogen metabolism, Pentose and glucuronate |
| | | | | interconversions, Porphyrin and chlorophyll metabolism, Starch and |
| | | | | sucrose metabolism) |
| 1354 | 1099 | D38065 | N | (Androgen and estrogen metabolism, Pentose and glucuronate |
| | | | | interconversions, Porphyrin and chlorophyll metabolism, Starch and |
| | | | | sucrose metabolism) |
| 15126 | 1113 | D83796 | N | (Androgen and estrogen metabolism, Pentose and glucuronate |
| | | | | interconversions, Porphyrin and chlorophyll metabolism, Starch and |
| | | | | sucrose metabolism) |
| 15124 | 1134 | J02612 | N, B | (Androgen and estrogen metabolism, Pentose and glucuronate |
| | | | | interconversions, Porphyrin and chlorophyll metabolism, Starch and |
| | | | | sucrose metabolism) |
| 15125 | 1162 | J05132 | N, B | (Androgen and estrogen metabolism, Pentose and glucuronate |
| | | | | interconversions, Porphyrin and chlorophyll metabolism, Starch and |
| | | | | sucrose metabolism) |
| 14346 | 1252 | M31109 | N, B, H | (Androgen and estrogen metabolism, Pentose and glucuronate |
| | | | | interconversions, Porphyrin and chlorophyll metabolism, Starch and |
| | | | | sucrose metabolism) |
| 11755 | 1259 | M33746 | N, B, H | (Androgen and estrogen metabolism, Pentose and glucuronate |
| | | | | interconversions, Porphyrin and chlorophyll metabolism, Starch and |
| | | | | sucrose metabolism) |
| 5493 | 1369 | S56936 | N | (Androgen and estrogen metabolism, Pentose and glucuronate |
| | | | | interconversions, Porphyrin and chlorophyll metabolism, Starch and |
| | | | | sucrose metabolism) |
| 15127 | 1370 | S56937 | N | (Androgen and estrogen metabolism, Pentose and glucuronate |
| | | | | interconversions, Porphyrin and chlorophyll metabolism, Starch and |
| | | | | sucrose metabolism) |
| 17806 | 1407 | U06273 | N | (Androgen and estrogen metabolism, Pentose and glucuronate |
| | | | | interconversions, Porphyrin and chlorophyll metabolism, Starch and |
| | | | | sucrose metabolism) |
| 17805 | 1408 | U06274 | N, B | (Androgen and estrogen metabolism, Pentose and glucuronate |
| | | | | interconversions, Porphyrin and chlorophyll metabolism, Starch and |
| | | | | sucrose metabolism) |
| 1537 | 1441 | U27518 | N, H | (Androgen and estrogen metabolism, Pentose and glucuronate |
| | | | | interconversions, Porphyrin and chlorophyll metabolism, Starch and |
| | | | | sucrose metabolism) |
| 14633 | 1499 | X03478 | H | (Androgen and estrogen metabolism, Pentose and glucuronate |
| | | | | interconversions, Porphyrin and chlorophyll metabolism, Starch and |
| | | | | sucrose metabolism) |
| 14347 | 1597 | Y00156 | N, H | (Androgen and estrogen metabolism, Pentose and glucuronate |
| | | | | interconversions, Porphyrin and chlorophyll metabolism, Starch and |
| | | | | sucrose metabolism) |
| 1453 | 1456 | U48596 | F, K | [symbol] |
| | | | | dependent signaling, BCR Signaling Pathway, CD40L Signaling |
| | | | | Pathway, Ceramide Signaling Pathway, EGF Signaling Pathway, |
| | | | | FAS signaling pathway (CD95), Fc Epsilon Receptor I Signaling in |
| | | | | Mast Cells, HIV-I Nef: negative effector of Fas and TNF, Human |
| | | | | Cytomegalovirus and Map Kinase Pathways, Inhibition of Cellular |
| | | | | Proliferation by Gleevec, Inositol phosphate metabolism, |
| | | | | Keratinocyte Differentiation, Links between Pyk2 and Map Kinases, |
| | | | | MAPKinase Signaling Pathway, Map Kinase Inactivation of SMRT |
| | | | | Corepressor, NF-kB Signaling Pathway, Neuropeptides VIP and |
| | | | | PACAP inhibit the apoptosis of activated T cells, Nicotinate and |
| | | | | nicotinamide metabolism, PDGF Signaling Pathway, Rac 1 cell |
| | | | | motility signaling pathway, Role of MAL in Rho-Mediated Activation |
| | | | | of SRF, Signal transduction through IL1R, Sphingoglycolipid |
| | | | | metabolism, Starch and sucrose metabolism, T Cell Receptor |
| | | | | Signaling Pathway, TNF/Stress Related Signaling, TNFR1 Signaling |
| | | | | Pathway, TNFR2 Signaling Pathway, The 4-1BB-dependent immune |
| 1454 | 1456 | U48596 | M, K | [symbol] |
| | | | | dependent signaling, BCR Signaling Pathway, CD40L Signaling |
| | | | | Pathway, Ceramide Signaling Pathway, EGF Signaling Pathway, |
| | | | | FAS signaling pathway (CD95), Fc Epsilon Receptor I Signaling in |
| | | | | Mast Cells, HIV-I Nef: negative effector of Fas and TNF, Human |
| | | | | Cytomegalovirus and Map Kinase Pathways, Inhibition of Cellular |
| | | | | Proliferation by Gleevec, Inositol phosphate metabolism, |
| | | | | Keratinocyte Differentiation, Links between Pyk2 and Map Kinases, |
| | | | | MAPKinase Signaling Pathway, Map Kinase Inactivation of SMRT |
| | | | | Corepressor, NF-kB Signaling Pathway, Neuropeptides VIP and |
| | | | | PACAP inhibit the apoptosis of activated T cells, Nicotinate and |
| | | | | nicotinamide metabolism, PDGF Signaling Pathway, Rac 1 cell |
| | | | | motility signaling pathway, Role of MAL in Rho-Mediated Activation |
| | | | | of SRF, Signal transduction through IL1R, Sphingoglycolipid |
| | | | | metabolism, Starch and sucrose metabolism, T Cell Receptor |
| | | | | Signaling Pathway, TNF/Stress Related Signaling, TNFR1 Signaling |
| | | | | Pathway, TNFR2 Signaling Pathway, The 4-1BB-dependent immune |
| 15434 | 531 | AI008836 | N | (Apoptotic DNA fragmentation and tissue homeostasis, Granzyme A |
| | | | | mediated Apoptosis Pathway) |
| 15437 | 1114 | D84418 | E | (Apoptotic DNA fragmentation and tissue homeostasis, Granzyme A |
| | | | | mediated Apoptosis Pathway) |
| 16116 | 475 | AF025670 | F | (Apoptotic Signaling in Response to DNA Damage, Caspase |
| | | | | Cascade in Apoptosis, FAS signaling pathway (CD95), HIV-I Nef: |
| | | | | negative effector of Fas and TNF, Huntington's disease, Induction of |
| | | | | apoptosis through DR3 and DR4/5 Death Receptors, Role of |
| | | | | Mitochondria in Apoptotic Signaling) |
| 4592 | 1135 | J02646 | H | (Apoptotic Signaling in Response to DNA Damage, Double Stranded |
| | | | | RNA Induced Gene Expression, Eukaryotic protein translation, |
| | | | | Regulation of elF2, Skeletal muscle hypertrophy is regulated via |
| | | | | AKT/mTOR pathway) |
| 23884 | 1293 | M73714 | J | (Arginine and proline metabolism, Bile acid biosynthesis, Butanoate |
| | | | | metabolism, Fatty acid metabolism, Glycerolipid metabolism, |
| | | | | Glycolysis/Gluconeogenesis, Histidine metabolism, Lysine |
| | | | | degradation, Phenylalanine metabolism, Propanoate metabolism, |
| | | | | Pyruvate metabolism, Tryptophan metabolism, Tyrosine metabolism, |
| | | | | Valine, leucine and isoleucine degradation, beta-Alanine metabolism) |
| 16884 | 723 | AI103758 | E | (Arginine and proline metabolism, Bile acid biosynthesis, Butanoate |
| | | | | metabolism, Fatty acid metabolism, Glycerolipid metabolism, |
| | | | | Glycolysis/Gluconeogenesis, Histidine metabolism, Lysine |
| | | | | degradation, Propanoate metabolism, Pyruvate metabolism, |
| | | | | Tryptophan metabolism, Valine, leucine and isoleucine degradation, |
| | | | | beta-Alanine metabolism) |
| 16885 | 739 | AI105188 | K | (Arginine and proline metabolism, Bile acid biosynthesis, Butanoate |
| | | | | metabolism, Fatty acid metabolism, Glycerolipid metabolism, |
| | | | | Glycolysis/Gluconeogenesis, Histidine metabolism, Lysine |
| | | | | degradation, Propanoate metabolism, Pyruvate metabolism, |
| | | | | Tryptophan metabolism, Valine, leucine and isoleucine degradation, |
| | | | | beta-Alanine metabolism) |
| 4574 | 968 | AI233216 | N | (Arginine and proline metabolism, Glutamate metabolism, Urea cycle |
| | | | | and metabolism of amino groups) |
| 16948 | 1151 | J03588 | N, A, C | (Arginine and proline metabolism, Glycine, serine and threonine |
| | | | | metabolism, Urea cycle and metabolism of amino groups) |
| 16775 | 1411 | U07971 | M, D, I, L | (Arginine and proline metabolism, Glycine, serine and threonine |
| | | | | metabolism, Urea cycle and metabolism of amino groups) |
| 16947 | 1510 | X08056 | N | (Arginine and proline metabolism, Glycine, serine and threonine |
| | | | | metabolism, Urea cycle and metabolism of amino groups) |
| 4242 | 276 | AA893325 | N | (Arginine and proline metabolism, Urea cycle and metabolism of |
| | | | | amino groups) |
| 4467 | 1274 | M57664 | N | (Arginine and proline metabolism, Urea cycle and metabolism of |
| | | | | amino groups) |
| 25467 | 1321 | M93297 | N, G | (Arginine and proline metabolism, Urea cycle and metabolism of |
| | | | | amino groups) |
| 1419 | 1492 | U90887 | N | (Arginine and proline metabolism, Urea cycle and metabolism of |
| | | | | amino groups) |
| 23523 | 1509 | X07944 | N | (Arginine and proline metabolism, Urea cycle and metabolism of |
| | | | | amino groups) |
| 17377 | 1514 | X13058 | N | (ATM Signaling Pathway, Amyotrophic lateral scierosis (ALS), |
| | | | | Apoptotic Signaling in Response to DNA Damage, Cell Cycle: G1/S |
| | | | | Check Point, Cell Cycle: G2/M Checkpoint, Chaperones modulate |
| | | | | interferon Signaling Pathway, Double Stranded RNA Induced Gene |
| | | | | Expression, Huntington's disease, Hypoxia and p53 in the |
| | | | | Cardiovascular system, Overview of telomerase protein component |
| | | | | gene hTert Transcriptional Regulation, RB Tumor |
| | | | | Suppressor/Checkpoint Signaling in response to DNA damage, |
| | | | | Regulation of cell cycle progression by Plk3, Regulation of |
| | | | | transcriptional activity by PML, Tumor Suppressor Arf Inhibits |
| | | | | Ribosomal Biogenesis, p53 Signaling Pathway) |
| 133 | 1436 | U24174 | N | (ATM Signaling Pathway, Cell Cycle: G1/S Check Point, Cell Cycle: |
| | | | | G2/M Checkpoint, Cyclins and Cell Cycle Regulation, Effects of |
| | | | | calcineurin in Keratinocyte Differentiation, Erythropoietin mediated |
| | | | | neuroprotection through NF-kB, Hypoxia and p53 in the |
| | | | | Cardiovascular system, Influence of Ras and Rho proteins on G1 to |
| | | | | S Transition, p53 Signaling Pathway) |
| 352 | 661 | AI070295 | H | (ATM Signaling Pathway, Cell Cycle: G2/M Checkpoint, Hypoxia and |
| | | | | p53 in the Cardiovascular system, p53 Signaling Pathway) |
| 353 | 1203 | L32591 | M, H, I | (ATM Signaling Pathway, Cell Cycle: G2/M Checkpoint, Hypoxia and |
| | | | | p53 in the Cardiovascular system, p53 Signaling Pathway) |
| 354 | 1203 | L32591 | M, H, I | (ATM Signaling Pathway, Cell Cycle: G2/M Checkpoint, Hypoxia and |
| | | | | p53 in the Cardiovascular system, p53 Signaling Pathway) |
| 20841 | 1279 | M58758 | H | (ATP synthesis, Oxidative phosphorylation) |
| 18449 | 1399 | U00926 | H | (ATP synthesis, Oxidative phosphorylation) |
| 20725 | 1541 | X54510 | A | (ATP synthesis, Oxidative phosphorylation, Purine metabolism) |
| 23698 | 1139 | J02749 | N, D | (Bile acid biosynthesis, Fatty acid biosynthesis (path 2), Fatty acid |
| | | | | metabolism, Valine, leucine and isoleucine degradation) |
| 23699 | 1139 | J02749 | N, D, E | (Bile acid biosynthesis, Fatty acid biosynthesis (path 2), Fatty acid |
| | | | | metabolism, Valine, leucine and isoleucine degradation) |
| 22219 | 1578 | X72792 | N, F | (Bile acid biosynthesis, Fatty acid metabolism, Glycerolipid |
| | | | | metabolism, Glycolysis/Gluconeogenesis, Tyrosine metabolism) |
| 10260 | 1393 | S81497 | N | (Bile acid biosynthesis, Glycerolipid metabolism) |
| 25563 | 1393 | S81497 | N | (Bile acid biosynthesis, Glycerolipid metabolism) |
| 10241 | 489 | AF048687 | N, C, K | (Blood group glycolipid biosynthesis-lact series, Blood group |
| | | | | glycolipid biosynthesis-neolact series, Fructose and mannose |
| | | | | metabolism, Globoside metabolism, Glycerolipid metabolism, |
| | | | | Keratan sulfate biosynthesis, N-Glycans biosynthesis, O-Glycans |
| | | | | biosynthesis, Sphingoglycolipid metabolism) |
| 4198 | 1305 | M83143 | M, N, I | (Blood group glycolipid biosynthesis-neolact series, Keratan sulfate |
| | | | | biosynthesis, N-Glycans biosynthesis) |
| 4199 | 1305 | M83143 | M, N | (Blood group glycolipid biosynthesis-neolact series, Keratan sulfate |
| | | | | biosynthesis, N-Glycans biosynthesis) |
| 18956 | 1059 | D00512 | N | (Butanoate metabolism, Fatty acid biosynthesis (path 2), Fatty acid |
| | | | | metabolism, Low-density lipoprotein (LDL) pathway during |
| | | | | atherogenesis, Lysine degradation, Propanoate metabolism, |
| | | | | Pyruvate metabolism, Synthesis and degradation of ketone bodies, |
| | | | | Tryptophan metabolism) |
| 18958 | 1077 | D13921 | N | (Butanoate metabolism, Fatty acid biosynthesis (path 2), Fatty acid |
| | | | | metabolism, Low-density lipoprotein (LDL) pathway during |
| | | | | atherogenesis, Lysine degradation, Propanoate metabolism, |
| | | | | Pyruvate metabolism, Synthesis and degradation of ketone bodies, |
| | | | | Tryptophan metabolism) |
| 17758 | 1173 | K03249 | N | (Butanoate metabolism, Fatty acid biosynthesis (path 2), Fatty acid |
| | | | | metabolism, Lysine degradation, Mechanism of Gene Regulation by |
| | | | | Peroxisome Proliferators via PPARa(alpha), Propanoate metabolism, |
| | | | | Tryptophan metabolism, Valine, leucine and isoleucine degradation, |
| | | | | beta-Alanine metabolism) |
| 16768 | 1083 | D16478 | N | (Butanoate metabolism, Fatty acid biosynthesis (path 2), Fatty acid |
| | | | | metabolism, Lysine degradation, Propanoate metabolism, |
| | | | | Tryptophan metabolism, Valine, leucine and isoleucine degradation, |
| | | | | beta-Alanine metabolism) |
| 21562 | 1525 | X15958 | N, A | (Butanoate metabolism, Fatty acid biosynthesis (path 2), Fatty acid |
| | | | | metabolism, Lysine degradation, Propanoate metabolism, |
| | | | | Tryptophan metabolism, Valine, leucine and isoleucine degradation, |
| | | | | beta-Alanine metabolism) |
| 15175 | 355 | AA945583 | E | (Butanoate metabolism, Fatty acid biosynthesis (path 2), Fatty acid |
| | | | | metabolism, Lysine degradation, Tryptophan metabolism, Valine, |
| | | | | leucine and isoleucine degradation) |
| 19252 | 204 | AA892041 | H | (Butanoate metabolism, Methane metabolism, Pentose and |
| | | | | glucuronate interconversions, Phenylalanine metabolism) |
| 19254 | 467 | AF014009 | H | (Butanoate metabolism, Methane metabolism, Pentose and |
| | | | | glucuronate interconversions, Phenylalanine metabolism) |
| 783 | 1011 | AI236589 | F | (Butanoate metabolism, Pentose and glucuronate interconversions) |
| 2812 | 809 | AI171090 | J | (Butanoate metabolism, Synthesis and degradation of ketone bodies, |
| | | | | Valine, leucine and isoleucine degradation) |
| 15580 | 1258 | M33648 | N | (Butanoate metabolism, Synthesis and degradation of ketone bodies, |
| | | | | Valine, leucine and isoleucine degradation) |
| 2629 | 1598 | Y00396 | K | (Cadmium induces DNA synthesis and proliferation in macrophages, |
| | | | | Erk1/Erk2 Mapk Signaling pathway, IL-2 Receptor Beta Chain in T |
| | | | | cell Activation, Inhibition of Cellular Proliferation by Gleevec, |
| | | | | MAPKinase Signaling Pathway, Mechanism of Gene Regulation by |
| | | | | Peroxisome Proliferators via PPARa(alpha), Neuropeptides VIP and |
| | | | | PACAP inhibit the apoptosis of activated T cells, Overview of |
| | | | | telomerase protein component gene hTert Transcriptional |
| | | | | Regulation, Role of EGF Receptor Transactivation by GPCRs in |
| | | | | Cardiac Hypertrophy, Tumor Suppressor Arf Inhibits Ribosomal |
| | | | | Biogenesis, WNT Signaling Pathway, p38 MAPK Signaling Pathway) |
| 11434 | 1079 | D14014 | N, B | (CARM1 and Regulation of the Estrogen Receptor, Cell Cycle: G1/S |
| | | | | Check Point, Cyclins and Cell Cycle Regulation, Inactivation of Gsk3 |
| | | | | by AKT causes accumulation of b-catenin in Alveolar Macrophages, |
| | | | | Influence of Ras and Rho proteins on G1 to S Transition, WNT |
| | | | | Signaling Pathway, p53 Signaling Pathway) |
| 24232 | 1359 | NM_171992 | B | (CARM1 and Regulation of the Estrogen Receptor, Cell Cycle: G1/S |
| | | | | Check Point, Cyclins and Cell Cycle Regulation, Inactivation of Gsk3 |
| | | | | by AKT causes accumulation of b-catenin in Alveolar Macrophages, |
| | | | | Influence of Ras and Rho proteins on G1 to S Transition, WNT |
| | | | | Signaling Pathway, p53 Signaling Pathway) |
| 20086 | 590 | AI013260 | M, H | (Caspase Cascade in Apoptosis, FAS signaling pathway (CD95), |
| | | | | HIV-I Nef: negative effector of Fas and TNF, Induction of apoptosis |
| | | | | through DR3 and DR4/5 Death Receptors, TNFR1 Signaling |
| | | | | Pathway) |
| 20085 | 1572 | X66870 | C | (Caspase Cascade in Apoptosis, FAS signaling pathway (CD95), |
| | | | | HIV-I Nef: negative effector of Fas and TNF, Induction of apoptosis |
| | | | | through DR3 and DR4/5 Death Receptors, TNFR1 Signaling |
| | | | | Pathway) |
| 3584 | 716 | AI103106 | E | (Caspase Cascade in Apoptosis, FAS signaling pathway (CD95), |
| | | | | HIV-I Nef: negative effector of Fas and TNF, TNFR1 Signaling |
| | | | | Pathway) |
| 20885 | 1403 | U04842 | N, G, K | (CBL mediated ligand-induced downregulation of EGF receptors, |
| | | | | EGF Signaling Pathway, Keratinocyte Differentiation, Map Kinase |
| | | | | Inactivation of SMRT Corepressor, Role of EGF Receptor |
| | | | | Transactivation by GPCRs in Cardiac Hypertrophy, Sprouty |
| | | | | regulation of tyrosine kinase signals, The role of FYVE-finger |
| | | | | proteins in vesicle transport, mCalpain and friends in Cell motility) |
| 20884 | 1513 | X12748 | N, G, K | (CBL mediated ligand-induced downregulation of EGF receptors, |
| | | | | EGF Signaling Pathway, Keratinocyte Differentiation, Map Kinase |
| | | | | Inactivation of SMRT Corepressor, Role of EGF Receptor |
| | | | | Transactivation by GPCRs in Cardiac Hypertrophy, Sprouty |
| | | | | regulation of tyrosine kinase signals, The role of FYVE-finger |
| | | | | proteins in vesicle transport, mCalpain and friends in Cell motility) |
| 15364 | 742 | AI105348 | J | (CCR3 signaling in Eosinophils, Rac 1 cell motility signaling pathway, |
| | | | | Rho cell motility signaling pathway) |
| 21165 | 78 | AA848941 | K | (Cell to Cell Adhesion Signaling, Integrin Signaling Pathway, |
| | | | | uCalpain and friends in Cell spread) |
| 21166 | 78 | AA848941 | K | (Cell to Cell Adhesion Signaling, Integrin Signaling Pathway, |
| | | | | uCalpain and friends in Cell spread) |
| 17514 | 324 | AA925554 | E, G | (Citrate cycle (TCA cycle), Electron Transport Reaction in |
| | | | | Mitochondria, Oxidative phosphorylation, Propanoate metabolism) |
| 4723 | 515 | AF093773 | N | (Citrate cycle (TCA cycle), Malate-aspartate shuttle, Pyruvate |
| | | | | metabolism, Shuttle for transfer of acetyl groups from mitochondria to |
| | | | | the cytosol) |
| 165 | 778 | AI145329 | F | (Citrate cycle (TCA cycle), Pyruvate metabolism) |
| 15851 | 1453 | U42719 | M | (Classical Complement Pathway, Complement Pathway, Lectin |
| | | | | Induced Complement Pathway) |
| 21053 | 1226 | M15481 | M | (Control of skeletal myogenesis by HDAC & calcium/calmodulin- |
| | | | | dependent kinase (CaMK), Erythrocyte Differentiation Pathway, IGF- |
| | | | | 1 Signaling Pathway, NFAT and Hypertrophy of the heart |
| | | | | (Transcription in the broken heart), Regulation of BAD |
| | | | | phosphorylation, Skeletal muscle hypertrophy is regulated via |
| | | | | AKT/mTOR pathway, The IGF-1 Receptor and Longevity) |
| 4330 | 60 | AA818747 | M, B | (CXCR4 Signaling Pathway, Pertussis toxin-insensitive CCR5 |
| | | | | Signaling in Macrophage) |
| 24321 | 956 | AI232340 | M, K, L | (CXCR4 Signaling Pathway, Pertussis toxin-insensitive CCR5 |
| | | | | Signaling in Macrophage) |
| 24778 | 1515 | X13119 | N | (Cysteine metabolism, Glycine, serine and threonine metabolism) |
| 17807 | 1270 | M54926 | M, G | (Cysteine metabolism, Glycolysis/Gluconeogenesis, Hypoxia- |
| | | | | Inducible Factor in the Cardiovascular System, Propanoate |
| | | | | metabolism, Pyruvate metabolism) |
| 7124 | 1409 | U07181 | E | (Cysteine metabolism, Glycolysis/Gluconeogenesis, Propanoate |
| | | | | metabolism, Pyruvate metabolism, SARS Coronavirus Protease) |
| 18452 | 1085 | D17370 | M, N | (Cysteine metabolism, Methionine metabolism, Selenoamino acid |
| | | | | metabolism) |
| 18453 | 1085 | D17370 | N, G | (Cysteine metabolism, Methionine metabolism, Selenoamino acid |
| | | | | metabolism) |
| 15028 | 336 | AA942685 | N, F | (Cysteine metabolism, Taurine and hypotaurine metabolism) |
| 25024 | 1124 | E03229 | N | (Cysteine metabolism, Taurine and hypotaurine metabolism) |
| 1540 | 1246 | M25073 | N | (Dendritic cells in regulating TH1 and TH2 Development, Glutathione |
| | | | | metabolism, SARS Coronavirus Protease, Urea cycle and |
| | | | | metabolism of amino groups) |
| 7064 | 1220 | M12919 | N | (Downregulated of MTA-3 in ER-negative Breast Tumors, Fructose |
| | | | | and mannose metabolism, Glycolysis/Gluconeogenesis, Pentose |
| | | | | phosphate pathway) |
| 343 | 1592 | X91810 | L | (EGF Signaling Pathway, Erk1/Erk2 Mapk Signaling pathway, IL 6 |
| | | | | signaling pathway, IL22 Soluble Receptor Signaling Pathway, PDGF |
| | | | | Signaling Pathway, Signaling of Hepatocyte Growth Factor Receptor, |
| | | | | Stat3 Signaling Pathway, TPO Signaling Pathway) |
| 2109 | 47 | AA817887 | N, G | (Erk and PI-3 Kinase Are Necessary for Collagen Binding in Corneal |
| | | | | Epithelia, Rho cell motility signaling pathway) |
| 18713 | 585 | AI012604 | N, L | (Eukaryotic protein translation, Regulation of elF2) |
| 18716 | 1345 | NM_020075 | F | (Eukaryotic protein translation, Regulation of elF2) |
| 20741 | 510 | AF084186 | A, J | (FAS signaling pathway (CD95), HIV-I Nef: negative effector of Fas |
| | | | | and TNF, Induction of apoptosis through DR3 and DR4/5 Death |
| | | | | Receptors, TNFR1 Signaling Pathway, uCalpain and friends in Cell |
| | | | | spread) |
| 20849 | 1502 | X05566 | M, G, K | (FAS signaling pathway (CD95), HIV-I Nef: negative effector of Fas |
| | | | | and TNF, Keratinocyte Differentiation, MAPKinase Signaling |
| | | | | Pathway, Purine metabolism, Regulation of transcriptional activity by |
| | | | | PML, Stress Induction of HSP Regulation, p38 MAPK Signaling |
| | | | | Pathway) |
| 1977 | 1164 | J05470 | N, L | (Fatty acid metabolism, Glycerolipid metabolism, Mitochondrial |
| | | | | Carnitine Palmitoyltransferase (CPT) System) |
| 15411 | 1178 | L07736 | N, B, L | (Fatty acid metabolism, Glycerolipid metabolism, Mitochondrial |
| | | | | Carnitine Palmitoyltransferase (CPT) System, Reversal of Insulin |
| | | | | Resistance by Leptin) |
| 13004 | 1007 | AI236284 | J, L | (Fatty acid metabolism, Glycolysis/Gluconeogenesis, Propanoate |
| | | | | metabolism, Pyruvate metabolism) |
| 13005 | 1116 | D85189 | N, C | (Fatty acid metabolism, Glycolysis/Gluconeogenesis, Propanoate |
| | | | | metabolism, Pyruvate metabolism) |
| 4011 | 496 | AF056333 | N, J | (Fatty acid metabolism, Mechanism of Acetaminophen Activity and |
| | | | | Toxicity, Tryptophan metabolism) |
| 4012 | 1367 | S48325 | N, J | (Fatty acid metabolism, Mechanism of Acetaminophen Activity and |
| | | | | Toxicity, Tryptophan metabolism) |
| 16150 | 11 | AA799489 | G | (Fatty acid metabolism, Mechanism of Gene Regulation by |
| | | | | Peroxisome Proliferators via PPARa(alpha)) |
| 16148 | 1140 | J02752 | N | (Fatty acid metabolism, Mechanism of Gene Regulation by |
| | | | | Peroxisome Proliferators via PPARa(alpha)) |
| 21078 | 1143 | J02791 | N, G | (Fatty acid metabolism, Propanoate metabolism, Valine, leucine and |
| | | | | isoleucine degradation, beta-Alanine metabolism) |
| 20716 | 1323 | M94548 | G | (Fatty acid metabolism, Prostaglandin and leukotriene metabolism, |
| | | | | Tryptophan metabolism) |
| 1174 | 1136 | J02657 | N | (Fatty acid metabolism, Tryptophan metabolism) |
| 67 | 1268 | M37828 | B | (Fatty acid metabolism, Tryptophan metabolism) |
| 14997 | 1150 | J03572 | N | (Folate biosynthesis, Glycerolipid metabolism) |
| 14996 | 1526 | X16038 | M, D | (Folate biosynthesis, Glycerolipid metabolism) |
| 1431 | 632 | AI044610 | D | (Folate biosynthesis, Histidine metabolism, Phenylalanine |
| | | | | metabolism, Tryptophan metabolism, Tyrosine metabolism) |
| 1430 | 1309 | M84648 | M | (Folate biosynthesis, Histidine metabolism, Phenylalanine |
| | | | | metabolism, Tryptophan metabolism, Tyrosine metabolism) |
| 1549 | 1166 | J05519 | G | (Folate biosynthesis, One carbon pool by folate) |
| 6405 | 1208 | L38615 | G | (Free Radical Induced Apoptosis, Glutamate metabolism, |
| | | | | Glutathione metabolism) |
| 6406 | 1208 | L38615 | N | (Free Radical Induced Apoptosis, Glutamate metabolism, |
| | | | | Glutathione metabolism) |
| 21975 | 827 | AI172247 | N, B, L | (Free Radical Induced Apoptosis, Purine metabolism) |
| 1340 | 1437 | U25651 | B | (Fructose and mannose metabolism, Galactose metabolism, |
| | | | | Glycolysis/Gluconeogenesis, Pentose phosphate pathway) |
| 820 | 225 | AA892395 | N | (Fructose and mannose metabolism, Glycolysis/Gluconeogenesis, |
| | | | | Glycolysis Pathway, Pentose phosphate pathway) |
| 818 | 1497 | X02291 | N | (Fructose and mannose metabolism, Glycolysis/Gluconeogenesis, |
| | | | | Glycolysis Pathway, Pentose phosphate pathway) |
| 16895 | 1313 | M86240 | N | (Fructose and mannose metabolism, Glycolysis/Gluconeogenesis, |
| | | | | Pentose phosphate pathway) |
| 968 | 1119 | D86745 | G, K | (FXR and LXR Regulation of Cholesterol Metabolism, Mechanism of |
| | | | | Gene Regulation by Peroxisome Proliferators via PPARa(alpha)) |
| 1321 | 1206 | L37333 | N | (Galactose metabolism, Glycolysis/Gluconeogenesis, Starch and |
| | | | | sucrose metabolism) |
| 1622 | 1300 | M80804 | N | (Galactose metabolism, Starch and sucrose metabolism) |
| 1247 | 1163 | J05181 | N, J | (Glutamate metabolism, Glutathione metabolism) |
| 14003 | 1374 | S65555 | N, B, J | (Glutamate metabolism, Glutathione metabolism) |
| 20817 | 582 | AI012589 | M, N | (Glutathione metabolism, Multi-Drug Resistance Factors) |
| 20818 | 1498 | X02904 | M, N | (Glutathione metabolism, Multi-Drug Resistance Factors) |
| 1399 | 1508 | X07467 | M, H, I | (Glutathione metabolism, Pentose phosphate pathway) |
| 35 | 1260 | M33822 | C | (Glutathione metabolism, Prostaglandin and leukotriene metabolism, |
| | | | | Selenoamino acid metabolism, Taurine and hypotaurine metabolism) |
| 33 | 1500 | X03518 | N | (Glutathione metabolism, Prostaglandin and leukotriene metabolism, |
| | | | | Selenoamino acid metabolism, Taurine and hypotaurine metabolism) |
| 23109 | 1072 | D10854 | N | (Glycerolipid metabolism, Glycolysis/Gluconeogenesis, Pentose |
| | | | | and glucuronate interconversions) |
| 755 | 1100 | D38448 | M, N | (Glycerolipid metabolism, Phosphatidylinositol signaling system) |
| 754 | 1336 | NM_013126 | N | (Glycerolipid metabolism, Phosphatidylinositol signaling system) |
| 25279 | 1092 | D30740 | C | (Glycerolipid metabolism, Phospholipid degradation, Prostaglandin |
| | | | | and leukotriene metabolism) |
| 16147 | 1459 | U51898 | M, N | (Glycerolipid metabolism, Phospholipid degradation, Prostaglandin |
| | | | | and leukotriene metabolism) |
| 1535 | 437 | AB000778 | F | (Glycerolipid metabolism, Phospholipid degradation, Rac 1 cell |
| | | | | motility signaling pathway, Ras Signaling Pathway) |
| 16448 | 1117 | D86297 | N | (Glycine, serine and threonine metabolism, Hemoglobin''s |
| | | | | Chaperone) |
| 291 | 1316 | M88347 | M, N, F | (Glycine, serine and threonine metabolism, Huntington's disease, |
| | | | | Methionine metabolism, Selenoamino acid metabolism) |
| 1312 | 1255 | M31788 | J | (Glycolysis/Gluconeogenesis, Glycolysis Pathway) |
| 20513 | 1503 | X05684 | N | (Glycolysis/Gluconeogenesis, Glycolysis Pathway, Purine |
| | | | | metabolism, Pyruvate metabolism) |
| 15876 | 241 | AA892582 | N, G | (Glycolysis/Gluconeogenesis, Histidine metabolism, Phenylalanine |
| | | | | metabolism, Tyrosine metabolism) |
| 18564 | 33 | AA800745 | M | (Hemoglobin''s Chaperone, Porphyrin and chlorophyll metabolism) |
| 25405 | 1230 | M18330 | N | (HIV-I Nef: negative effector of Fas and TNF, Phosphatidylinositol |
| | | | | signaling system) |
| 20809 | 1229 | M17069 | N, D | (Huntington's disease, Phosphatidylinositol signaling system) |
| 20518 | 1520 | X14265 | N | (Huntington's disease, Phosphatidylinositol signaling system) |
| 5733 | 1303 | M81855 | N | (Hypoxia and p53 in the Cardiovascular system, Multi-Drug |
| | | | | Resistance Factors) |
| 1698 | 1137 | J02679 | M, B, H, I | (Hypoxia and p53 in the Cardiovascular system, Sterol biosynthesis) |
| 16081 | 888 | AI179610 | N | (IL-10 Anti-inflammatory Signaling Pathway, Porphyrin and |
| | | | | chlorophyll metabolism) |
| 16080 | 1138 | J02722 | N | (IL-10 Anti-inflammatory Signaling Pathway, Porphyrin and |
| | | | | chlorophyll metabolism) |
| 10087 | 817 | AI171803 | M | (Inositol metabolism, Propanoate metabolism, Valine, leucine and |
| | | | | isoleucine degradation) |
| 17269 | 1322 | M93401 | M | (Inositol metabolism, Propanoate metabolism, Valine, leucine and |
| | | | | isoleucine degradation) |
| 14956 | 1286 | M64301 | N | (Inositol phosphate metabolism, MAPKinase Signaling Pathway, |
| | | | | Nicotinate and nicotinamide metabolism, Sphingoglycolipid |
| | | | | metabolism, Starch and sucrose metabolism) |
| 14957 | 1286 | M64301 | N | (Inositol phosphate metabolism, MAPKinase Signaling Pathway, |
| | | | | Nicotinate and nicotinamide metabolism, Sphingoglycolipid |
| | | | | metabolism, Starch and sucrose metabolism) |
| 6577 | 1506 | X06942 | F | (Inositol phosphate metabolism, MAPKinase Signaling Pathway, |
| | | | | Nicotinate and nicotinamide metabolism, Sphingoglycolipid |
| | | | | metabolism, Starch and sucrose metabolism) |
| 21029 | 24 | AA799981 | C | (Inositol phosphate metabolism, Nicotinate and nicotinamide |
| | | | | metabolism, Phosphatidylinositol signaling system, Sphingoglycolipid |
| | | | | metabolism, Starch and sucrose metabolism) |
| 1542 | 1614 | Z50144 | N, J | (Lysine biosynthesis, Lysine degradation, Tryptophan metabolism) |
| 23300 | 1488 | U84727 | N | (Malate-aspartate shuttle, Shuttle for transfer of acetyl groups from |
| | | | | mitochondria to the cytosol) |
| 20896 | 1475 | U64030 | A, F | (Mechanism of Gene Regulation by Peroxisome Proliferators via |
| | | | | PPARa(alpha), Pyrimidine metabolism) |
| 1069 | 1522 | X15096 | N | (Methane metabolism, Phenylalanine metabolism, Ribosome) |
| 15295 | 164 | AA875594 | M, H, I | (NFAT and Hypertrophy of the heart (Transcription in the broken |
| | | | | heart), mTOR Signaling Pathway) |
| 6782 | 838 | AI176170 | B | (NFAT and Hypertrophy of the heart (Transcription in the broken |
| | | | | heart), mTOR Signaling Pathway) |
| 15296 | 907 | AI228738 | N, H, I | (NFAT and Hypertrophy of the heart (Transcription in the broken |
| | | | | heart), mTOR Signaling Pathway) |
| 15297 | 1118 | D86641 | N, K | (NFAT and Hypertrophy of the heart (Transcription in the broken |
| | | | | heart), mTOR Signaling Pathway) |
| 18597 | 455 | AB013732 | N, B, H | (Nucleotide sugars metabolism, Pentose and glucuronate |
| | | | | interconversions, Starch and sucrose metabolism) |
| 21211 | 433 | AB000098 | C | (Oxidative phosphorylation, Ubiquinone biosynthesis) |
| 20173 | 1605 | Z11932 | N, C | (Oxidative phosphorylation, Ubiquinone biosynthesis) |
| 811 | 1110 | D63704 | M, I | (Pantothenate and CoA biosynthesis, Pyrimidine metabolism, beta- |
| | | | | Alanine metabolism) |
| 812 | 1110 | D63704 | M, I | (Pantothenate and CoA biosynthesis, Pyrimidine metabolism, beta- |
| | | | | Alanine metabolism) |
| 1508 | 1332 | M97662 | N, G | (Pantothenate and CoA biosynthesis, Pyrimidine metabolism, beta- |
| | | | | Alanine metabolism) |
| 24643 | 1477 | U68417 | N, K | (Pantothenate and CoA biosynthesis, Valine, leucine and isoleucine |
| | | | | biosynthesis, Valine, leucine and isoleucine degradation) |
| 24582 | 1528 | X16554 | D | (Pentose phosphate pathway, Purine metabolism) |
| 1847 | 1529 | X16555 | B | (Pentose phosphate pathway, Purine metabolism) |
| 6055 | 1218 | M12337 | M, N, D | (Phenylalanine, tyrosine and tryptophan biosynthesis, Tryptophan |
| | | | | metabolism) |
| 13485 | 1057 | AJ012603 | B | (Presenilin action in Notch and Wnt signaling, Proteolysis and |
| | | | | Signaling Pathway of Notch, g-Secretase mediated ErbB4 Signaling |
| | | | | Pathway) |
| 24885 | 1088 | D25224 | N | (Prion disease, Ribosome) |
| 20481 | 1240 | M22631 | M, N, G, K | (Propanoate metabolism, Valine, leucine and isoleucine degradation) |
| 1928 | 1418 | U10357 | N | (PTEN dependent cell cycle arrest and apoptosis, Regulation of |
| | | | | elF4e and p70 S6 Kinase, Skeletal muscle hypertrophy is regulated |
| | | | | via AKT/mTOR pathway, mTOR Signaling Pathway) |
| 1929 | 1418 | U10357 | N, A, C, D, E | (PTEN dependent cell cycle arrest and apoptosis, Regulation of |
| | | | | elF4e and p70 S6 Kinase, Skeletal muscle hypertrophy is regulated |
| | | | | via AKT/mTOR pathway, mTOR Signaling Pathway) |
| 23709 | 1356 | NM_138532 | N | (Purine metabolism, Pyrimidine metabolism) |
| 1570 | 1404 | U05014 | A | (Regulation of elF4e and p70 S6 Kinase, Skeletal muscle |
| | | | | hypertrophy is regulated via AKT/mTOR pathway, mTOR Signaling |
| | | | | Pathway) |
| 355 | 1375 | S66024 | N | (Regulation of Spermatogenesis by CREM, Repression of Pain |
| | | | | Sensation by the Transcriptional Regulator DREAM) |
| 356 | 1375 | S66024 | N | (Regulation of Spermatogenesis by CREM, Repression of Pain |
| | | | | Sensation by the Transcriptional Regulator DREAM) |
| 17104 | 1251 | M29358 | M, G | (Ribosome, Skeletal muscle hypertrophy is regulated via AKT/mTOR |
| | | | | pathway, mTOR Signaling Pathway) |
| 17105 | 1251 | M29358 | N | (Ribosome, Skeletal muscle hypertrophy is regulated via AKT/mTOR |
| | | | | pathway, mTOR Signaling Pathway) |
| 605 | 1199 | L27340 | C | (Sonic Hedgehog (SHH) Receptor Ptc1 Regulates cell cycle, Sonic |
| | | | | Hedgehog (Shh) Pathway) |
| 16681 | 1095 | D37920 | N, B, L | (Sterol biosynthesis, Terpenoid biosynthesis) |
| 15069 | 1319 | M89945 | H | (Sterol biosynthesis, Terpenoid biosynthesis) |
| 25460 | 1319 | M89945 | N | (Sterol biosynthesis, Terpenoid biosynthesis) |
| 16449 | 1327 | M95591 | N | (Sterol biosynthesis, Terpenoid biosynthesis) |
| 16450 | 1327 | M95591 | N | (Sterol biosynthesis, Terpenoid biosynthesis) |
| 19058 | 493 | AF054618 | E | Agrin in Postsynaptic Differentiation |
| 18008 | 1350 | NM_031588 | N | Agrin in Postsynaptic Differentiation |
| 18005 | 1401 | U02320 | N | Agrin in Postsynaptic Differentiation |
| 18011 | 1402 | U02322 | M, H | Agrin in Postsynaptic Differentiation |
| 347 | 1400 | U01914 | D | AKAP95 role in mitosis and chromosome dynamics |
| 439 | 1609 | Z22607 | N, F | ALK in cardiac myocytes |
| 1515 | 1064 | D10233 | J | Aminosugars metabolism |
| 9125 | 67 | AA819338 | N | Amyotrophic lateral sclerosis (ALS) |
| 8426 | 483 | AF036335 | N, E, F | Antisense Pathway |
| 23778 | 298 | AA899854 | N, E | Apoptotic DNA fragmentation and tissue homeostasis |
| 19110 | 1289 | M64986 | A, J | Apoptotic DNA fragmentation and tissue homeostasis |
| 23780 | 1608 | Z19552 | E | Apoptotic DNA fragmentation and tissue homeostasis |
| 14638 | 765 | AI137049 | J | ATM Signaling Pathway |
| 16398 | 1478 | U75392 | N | CARM1 and Regulation of the Estrogen Receptor |
| 6758 | 592 | AI013394 | B, L | Chondroitin/Heparan sulfate biosynthesis |
| 15385 | 249 | AA892808 | N | Citrate cycle (TCA cycle) |
| 19991 | 730 | AI103956 | K | Citrate cycle (TCA cycle) |
| 17516 | 847 | AI176621 | A, E, L | Citrate cycle (TCA cycle) |
| 7197 | 820 | AI171962 | M, G, K, L | Corticosteroids and cardioprotection |
| 7196 | 1371 | S57478 | M, E, G, K | Corticosteroids and cardioprotection |
| 16354 | 1108 | D50564 | N, C | Cysteine metabolism |
| 1081 | 466 | AF013145 | M, D | Downregulated of MTA-3 in ER-negative Breast Tumors |
| 19998 | 964 | AI232999 | M | Downregulated of MTA-3 in ER-negative Breast Tumors |
| 1462 | 999 | AI235585 | M, E, G | Downregulated of MTA-3 in ER-negative Breast Tumors |
| 1463 | 1540 | X54467 | M, G, K | Downregulated of MTA-3 in ER-negative Breast Tumors |
| 17563 | 875 | AI178750 | N | Eukaryotic protein translation |
| 24874 | 1410 | U07619 | N | Extrinsic Prothrombin Activation Pathway |
| 20711 | 307 | AA924267 | N, L | Fatty acid metabolism |
| 15926 | 451 | AB012933 | D | Fatty acid metabolism |
| 20983 | 634 | AI044900 | K | Fatty acid metabolism |
| 18687 | 804 | AI170568 | N | Fatty acid metabolism |
| 18686 | 1062 | D00729 | N | Fatty acid metabolism |
| 6780 | 1160 | J05029 | N | Fatty acid metabolism |
| 20713 | 1275 | M57718 | N, J, L | Fatty acid metabolism |
| 20715 | 1507 | X07259 | N, L | Fatty acid metabolism |
| 15540 | 1243 | M24067 | K | Fibrinolysis Pathway |
| 13479 | 1149 | J03481 | N | Folate biosynthesis |
| 13480 | 1149 | J03481 | N | Folate biosynthesis |
| 21400 | 1266 | M36410 | C, F | Folate biosynthesis |
| 1527 | 1299 | M77850 | B | Folate biosynthesis |
| 16726 | 1352 | NM_031855 | M, N, E, G, H, I | Fructose and mannose metabolism |
| 1877 | 1579 | X74593 | A, D, E | Fructose and mannose metabolism |
| 1214 | 1076 | D13871 | M, N, K | FXR and LXR Regulation of Cholesterol Metabolism |
| 19712 | 1429 | U18374 | K | FXR and LXR Regulation of Cholesterol Metabolism |
| 5384 | 166 | AA891041 | I | GATA3 participate in activating the Th2 cytokine genes expression |
| 989 | 1464 | U56242 | N, D, F | GATA3 participate in activating the Th2 cytokine genes expression |
| 20161 | 1543 | X54686 | M, C, I | GATA3 participate in activating the Th2 cytokine genes expression |
| 5206 | 327 | AA925755 | E | Glutamate metabolism |
| 20717 | 844 | AI176504 | N | Glutamate metabolism |
| 11153 | 1320 | M91652 | N | Glutamate metabolism |
| 4615 | 1061 | D00680 | N | Glutathione metabolism |
| 21011 | 1128 | H32189 | N | Glutathione metabolism |
| 21012 | 1133 | J02592 | N, B | Glutathione metabolism |
| 21013 | 1144 | J02810 | N | Glutathione metabolism |
| 15017 | 1153 | J03752 | N, B | Glutathione metabolism |
| 21014 | 1155 | J03914 | B, L | Glutathione metabolism |
| 18989 | 1168 | K00136 | N | Glutathione metabolism |
| 634 | 1170 | K01932 | N | Glutathione metabolism |
| 25525 | 1383 | S72505 | N | Glutathione metabolism |
| 635 | 1586 | X78848 | N | Glutathione metabolism |
| 20753 | 43 | AA801441 | M, N, C, I | Glycerolipid metabolism |
| 22554 | 353 | AA945076 | M, I | Glycerolipid metabolism |
| 3512 | 442 | AB006607 | F | Glycerolipid metabolism |
| 1306 | 1065 | D10262 | N | Glycerolipid metabolism |
| 17684 | 220 | AA892345 | M, I | Glycine, serine and threonine metabolism |
| 21587 | 293 | AA899141 | D | Glycine, serine and threonine metabolism |
| 21038 | 1148 | J03190 | H | Glycine, serine and threonine metabolism |
| 21039 | 1148 | J03190 | H | Glycine, serine and threonine metabolism |
| 1550 | 1504 | X06150 | N | Glycine, serine and threonine metabolism |
| 1551 | 1504 | X06150 | N, G | Glycine, serine and threonine metabolism |
| 21585 | 1596 | X97772 | D | Glycine, serine and threonine metabolism |
| 21586 | 1596 | X97772 | D | Glycine, serine and threonine metabolism |
| 187 | 1094 | D32209 | F | Granzyme A mediated Apoptosis Pathway |
| 20801 | 1104 | D44495 | M, N, H, I, J, L | Granzyme A mediated Apoptosis Pathway |
| 1685 | 97 | AA851497 | J | Hemoglobin''s Chaperone |
| 17832 | 573 | AI012182 | J | Hemoglobin''s Chaperone |
| 17833 | 868 | AI177992 | F | Hemoglobin''s Chaperone |
| 17829 | 884 | AI179576 | N, J | Hemoglobin''s Chaperone |
| 1687 | 890 | AI179971 | J | Hemoglobin''s Chaperone |
| 1688 | 932 | AI230970 | J | Hemoglobin''s Chaperone |
| 1689 | 1009 | AI236360 | J | Hemoglobin''s Chaperone |
| 25468 | 1324 | M94918 | N, J | Hemoglobin''s Chaperone |
| 1684 | 1547 | X56325 | J | Hemoglobin''s Chaperone |
| 3610 | 776 | AI145151 | M, G, I, J | Histidine metabolism |
| 3608 | 1067 | D10693 | M, J | Histidine metabolism |
| 3609 | 1395 | S82579 | N, F | Histidine metabolism |
| 17154 | 1228 | M15883 | J | Huntington's disease |
| 15097 | 535 | AI009405 | N | Hypoxia and p53 in the Cardiovascular system |
| 1424 | 1423 | U14746 | N | Hypoxia-Inducible Factor in the Cardiovascular System |
| 4392 | 906 | AI228674 | H | IL-2 Receptor Beta Chain in T cell Activation |
| 15393 | 806 | AI170663 | J | Inactivation of Gsk3 by AKT causes accumulation of b-catenin in |
| | | | | Alveolar Macrophages |
| 7888 | 976 | AI233583 | M | Inhibition of Matrix Metalloproteinases |
| 17550 | 565 | AI011607 | M, I | Lysine degradation |
| 1814 | 1253 | M31174 | N | Map Kinase Inactivation of SMRT Corepressor |
| 15701 | 447 | AB010467 | A, I | Multi-Drug Resistance Factors |
| 21575 | 1544 | X55298 | J | N-Glycans biosynthesis |
| 12606 | 1281 | M59861 | N, E, K | One carbon pool by folate |
| 11953 | 703 | AI102505 | A | Oxidative phosphorylation |
| 11955 | 1212 | L48209 | N | Oxidative phosphorylation |
| 23225 | 1249 | M27467 | N | Oxidative phosphorylation |
| 11956 | 1250 | M28255 | N | Oxidative phosphorylation |
| 1598 | 1445 | U30186 | N | p38 MAPK Signaling Pathway |
| 11454 | 1245 | M24604 | M | p53 Signaling Pathway |
| 11455 | 1245 | M24604 | M | p53 Signaling Pathway |
| 24821 | 1066 | D10392 | J | Parkinson's disease |
| 16039 | 9 | AA799452 | H | Pentose phosphate pathway |
| 20804 | 567 | AI011684 | H | Pentose phosphate pathway |
| 20802 | 655 | AI059508 | N, H | Pentose phosphate pathway |
| 20803 | 1413 | U09256 | N, B, H, I | Pentose phosphate pathway |
| 1183 | 465 | AF013144 | N | Phosphatidylinositol signaling system |
| 14978 | 858 | AI177386 | F | Phosphatidylinositol signaling system |
| 245 | 1107 | D45412 | J | Phosphatidylinositol signaling system |
| 1712 | 1177 | L06096 | M | Phosphatidylinositol signaling system |
| 24219 | 1200 | L27843 | M, L | Phosphatidylinositol signaling system |
| 1844 | 1261 | M33962 | J | Phosphatidylinositol signaling system |
| 1824 | 1427 | U17971 | K | Phosphatidylinositol signaling system |
| 247 | 1443 | U28938 | J | Phosphatidylinositol signaling system |
| 7700 | 744 | AI105383 | M, D | Phospholipids as signalling intermediaries |
| 23868 | 474 | AF023087 | M, L | Phosphorylation of MEK1 by cdk5/p35 down regulates the MAP |
| | | | | kinase pathway |
| 23872 | 1231 | M18416 | M | Phosphorylation of MEK1 by cdk5/p35 down regulates the MAP |
| | | | | kinase pathway |
| 23869 | 1479 | U75397 | L | Phosphorylation of MEK1 by cdk5/p35 down regulates the MAP |
| | | | | kinase pathway |
| 16521 | 557 | AI010470 | B, J, L | Porphyrin and chlorophyll metabolism |
| 16520 | 1204 | L33869 | M, B, C, L | Porphyrin and chlorophyll metabolism |
| 17554 | 1115 | D85100 | N | Propanoate metabolism |
| 15538 | 758 | AI112633 | L | Proteasome |
| 25253 | 1068 | D10754 | H | Proteasome |
| 15535 | 1069 | D10755 | L | Proteasome |
| 3254 | 1070 | D10756 | N, L | Proteasome |
| 4003 | 1071 | D10757 | N | Proteasome |
| 1884 | 1109 | D50695 | I | Proteasome |
| 3987 | 1122 | D90258 | M, N | Proteasome |
| 15470 | 1466 | U57050 | H | Proteasome |
| 1447 | 1545 | X55986 | D | Proteasome |
| 8888 | 81 | AA849036 | N, B | Purine metabolism |
| 14184 | 126 | AA859837 | M | Purine metabolism |
| 14185 | 126 | AA859837 | M | Purine metabolism |
| 2979 | 289 | AA894099 | H | Purine metabolism |
| 4327 | 501 | AF063447 | M, G, I | Purine metabolism |
| 1466 | 1222 | M14050 | N | Purine metabolism |
| 1246 | 1273 | M57507 | M, J | Purine metabolism |
| 1970 | 1446 | U31463 | N, K | Purine metabolism |
| 16708 | 1465 | U57042 | M, N | Purine metabolism |
| 20483 | 1524 | X15939 | N | Purine metabolism |
| 24235 | 169 | AA891286 | M, N, H, I | Pyrimidine metabolism |
| 24234 | 1474 | U63923 | M, A, I | Pyrimidine metabolism |
| 1409 | 589 | AI012802 | M, A, C, E, F | Pyruvate metabolism |
| 240 | 1297 | M75153 | N | Rab GTPases Mark Targets In The Endocytotic Machinery |
| 1867 | 91 | AA850940 | N | Ribosome |
| 20839 | 177 | AA891729 | N | Ribosome |
| 4259 | 207 | AA892123 | N | Ribosome |
| 20812 | 356 | AA945611 | N | Ribosome |
| 19268 | 530 | AI008641 | D | Ribosome |
| 815 | 603 | AI014087 | N | Ribosome |
| 16918 | 715 | AI103074 | N | Ribosome |
| 14929 | 802 | AI170353 | M, G, K | Ribosome |
| 18612 | 904 | AI228624 | G | Ribosome |
| 15468 | 997 | AI235364 | N | Ribosome |
| 19112 | 1036 | AI639157 | J | Ribosome |
| 10878 | 1174 | K03250 | N | Ribosome |
| 24615 | 1318 | M89646 | N, D | Ribosome |
| 15135 | 1382 | S71021 | N, G | Ribosome |
| 16204 | 1505 | X06423 | M, N, G | Ribosome |
| 16205 | 1505 | X06423 | N, F | Ribosome |
| 16847 | 1516 | X13549 | N | Ribosome |
| 9620 | 1535 | X53377 | N | Ribosome |
| 10267 | 1550 | X57432 | N | Ribosome |
| 16929 | 1571 | X66370 | G | Ribosome |
| 23854 | 1585 | X78327 | N, G | Ribosome |
| 11849 | 1593 | X93352 | M, N, G | Ribosome |
| 18107 | 1594 | X94242 | N | Ribosome |
| 4361 | 1127 | H31839 | N | Role of Mitochondria in Apoptotic Signaling |
| 8829 | 1271 | M55015 | M, A, F, K | SARS Coronavirus Protease |
| 18354 | 1559 | X59859 | J | Small Leucine-rich Proteoglycan (SLRP) molecules |
| 24192 | 306 | AA924210 | H | Sterol biosynthesis |
| 15242 | 459 | AB017912 | D | TGF beta signaling pathway |
| 15243 | 459 | AB017912 | N | TGF beta signaling pathway |
| 17324 | 495 | AF056031 | M | Tryptophan metabolism |
| 20493 | 1090 | D28339 | M, N | Tryptophan metabolism |
| 20494 | 1103 | D44494 | N, E | Tryptophan metabolism |
| 794 | 1476 | U68168 | M, I | Tryptophan metabolism |
| 23961 | 1298 | M77694 | M, N, E, G, I | Tyrosine metabolism |
| 15277 | 989 | AI234889 | D | Ubiquitin mediated proteolysis |
| 17378 | 1284 | M62388 | N, D | Ubiquitin mediated proteolysis |
| 15273 | 1421 | U13177 | E | Ubiquitin mediated proteolysis |
| 21950 | 599 | AI013861 | N, G | Valine, leucine and isoleucine degradation |
| 4449 | 712 | AI102838 | N, B, G, K | Valine, leucine and isoleucine degradation |
| 17284 | 1145 | J02827 | N, G | Valine, leucine and isoleucine degradation |
| 17285 | 1145 | J02827 | N | Valine, leucine and isoleucine degradation |
| 4450 | 1161 | J05031 | N, E | Valine, leucine and isoleucine degradation |
| 4451 | 1161 | J05031 | M, N, F | Valine, leucine and isoleucine degradation |
| 21072 | 28 | AA800211 | K | Vitamin B6 metabolism |
| 16248 | 1376 | S68135 | N | Vitamin C in the Brain |

TABLE 3

| GLGC | | GenBank Acc or | | | |
|---|---|---|---|---|---|
| Identifier | Seq ID | RefSeq ID | Model Code | Human Homologous Gene Name | Human Homologous Cluster Title |
| 22602 | 487 | AF044574 | M | (2,4-dienoyl CoA reductase 2, peroxisomal, 2-4-dienoyl- | (2,4-dienoyl CoA reductase 2, peroxisomal, 2-4-dienoyl-Coenzyme |
| | | | | Coenzyme A reductase 2, peroxisomal) | A reductase 2, peroxisomal) |
| 22603 | 487 | AF044574 | N | (2,4-dienoyl CoA reductase 2, peroxisomal, 2-4-dienoyl- | (2,4-dienoyl CoA reductase 2, peroxisomal, 2-4-dienoyl-Coenzyme |
| | | | | Coenzyme A reductase 2, peroxisomal) | A reductase 2, peroxisomal) |
| 2812 | 809 | AI171090 | J | (3-hydroxy-3-methylglutaryl-Coenzyme A lyase, 3-hydroxymethyl- | (3-hydroxy-3-methylglutaryl-Coenzyme A lyase, 3-hydroxymethyl-3- |
| | | | | 3-methylglutaryl-Coenzyme A lyase | methylglutaryl-Coenzyme A lyase (hydroxymethylglutaricaciduria)) |
| | | | | (hydroxymethylglutaricaciduria)) | |
| 24192 | 306 | AA924210 | H | (3-hydroxy-3-methylglutaryl-Coenzyme A reductase, HMG | 3-hydroxy-3-methylglutaryl-Coenzyme A reductase |
| | | | | Coenzyme A reductase, Hydroxymethylglutaryl-coA reductase) | |
| 15580 | 1258 | M33648 | N | (3-hydroxy-3-methylglutaryl-Coenzyme A synthase 2,3-hydroxy- | (3-hydroxy-3-methylglutaryl-Coenzyme A synthase2,3-hydroxy-3- |
| | | | | 3-methylglutaryl-Coenzyme A synthase 2 (mitochondrial), | methylglutaryl-Coenzyme A synthase 2 (mitochondrial)) |
| | | | | hydroxymethlglutaryl-CoA synthase) | |
| 16768 | 1083 | D16478 | N | (3-hydroxyacyl-CoA dehydrogenase, hydroxyacyl-Coenzyme A | hydroxyacyl-Coenzyme A dehydrogenase/3-ketoacyl-Coenzyme A |
| | | | | dehydrogenase/3-ketoacyl-Coenzyme A thiolase/enoyl- | thiolase/enoyl-Coenzyme A hydratase (trifunctional protein), alpha |
| | | | | Coenzyme A hydratase (trifunctional protein), alpha subunit) | subunit |
| 21950 | 599 | AI013861 | N, G | (3-HYDROXYISOBUTYRATE DEHYDROGENASE | (3-hydroxyisobutyrate dehydrogenase, RIKEN cDNA 6430402H10 |
| | | | | PRECURSOR (EC 1.1.1.31) (HIBADH) (FRAGMENT), 3- | gene) |
| | | | | hydroxyisobutyrate dehydrogenase, RIKEN cDNA 6430402H10 | |
| | | | | gene) | |
| 20427 | 1536 | X53378 | N | (40S ribosomal protein S13, Ribosomal protein S13, ribosomal | ribosomal protein S13 |
| | | | | protein S13) | |
| 815 | 603 | AI014087 | N | (40S ribosomal protein S26, Ribosomal protein S26, ribosomal | ribosomal protein S26 |
| | | | | protein S26, similar to 40S ribosomal protein S26) | |
| 17104 | 1251 | M29358 | M, G | (40S ribosomal protein S6, Ribosomal protein S6, ribosomal | ribosomal protein S6 |
| | | | | protein S6) | |
| 17105 | 1251 | M29358 | N | (40S ribosomal protein S6, Ribosomal protein S6, ribosomal | ribosomal protein S6 |
| | | | | protein S6) | |
| 24885 | 1088 | D25224 | N | (40S ribosomal protein, laminin receptor 1 (ribosomal protein | (laminin receptor 1 (ribosomal protein SA), laminin receptor 1 |
| | | | | SA), laminin receptor 1 (ribosomal protein SA. 67 kDa)) | (ribosomal protein SA, 67 kDa)) |
| 15468 | 997 | AI235364 | N | (40S ribosomal protein, ribosomal protein S15a) | ribosomal protein S15a |
| 1527 | 1299 | M77850 | B | (6-pyruvoyl-tetrahydropterin synthase, 6-pyruvoyltetrahydropterin | (6-pyruvoyl-tetrahydropterin synthase, 6-pyruvoyltetrahydropterin |
| | | | | synthase, purple) | synthase) |
| 21882 | 1308 | M83740 | M, N, D | (6-pyruvoyl-tetrahydropterin synthase/dimerization cofactor of | 6-pyruvoyl-tetrahydropterin synthase/dimerization cofactor of |
| | | | | hepatocyte nuclear factor 1 alpha (TCF1), pterin-4a- | hepatocyte nuclear factor 1 atpha (TCF1) |
| | | | | carbinolamine dehydratase) | |
| 13485 | 1057 | AJ012603 | B | (a disintegrin and metalloproteinase domain 17, a disintegrin and | (a disintegrin and metalloproteinase domain 17, a disintegrin and |
| | | | | metalloproteinase domain 17 (tumor necrosis factor, alpha. | metalloproteinase domain 17 (tumor necrosis factor, alpha, |
| | | | | converting enzyme)) | converting enzyme)) |
| 18956 | 1059 | D00512 | N | (acetoacetyl CoA thiolase, acetyl-Coenzyme A acetyltransferase | (acetyl-Coenzyme A acetyltransferase 1, acetyl-Coenzyme A |
| | | | | 1, acetyl-Coenzyme A acetyltransferase 1 (acetoacetyl | acetyltransferase 1 (acetoacetyl Coenzyme A thiolase)) |
| | | | | Coenzyme A thiolase)) | |
| 18958 | 1077 | D13921 | N | (acetoacetyl CoA thiolase, acetyl-Coenzyme A acetyltransferase | (acetyl-Coenzyme A acetyltransferase 1, acetyl-Coenzyme A |
| | | | | 1, acetyl-Coenzyme A acetyltransferase 1 (acetoacetyl | acetyltransferase 1 (acetoacetyl Coenzyme A thiolase)) |
| | | | | Coenzyme A thiolase)) | |
| 23698 | 1139 | J02749 | N, D | (acetyl-Coenzyme A acyltransferase 1, acetyl-Coenzyme A | (acetyl-Coenzyme A acyltransferase 1, acetyl-Coenzyme A |
| | | | | acyltransferase 1 (peroxisomal 3-oxoacyl-Coenzyme A thiolase)) | acyltransferase 1 (peroxisomal 3-oxoacyl-Coenzyme A thiolase)) |
| 23699 | 1139 | J02749 | N, D, E | (acetyl-Coenzyme A acyltransferase 1, acetyl-Coenzyme A | (acetyl-Coenzyme A acyltransferase 1, acetyl-Coenzyme A |
| | | | | acyltransferase 1 (peroxisomal 3-oxoacyl-Coenzyme A thiolase)) | acyltransferase 1 (peroxisomal 3-oxoacyl-Coenzyme A thiolase)) |
| 6780 | 1160 | J05029 | N | (acetyl-Coenzyme A dehydrogenase, long-chain, acyl-Coenzyme | (acetyl-Coenzyme A dehydrogenase, long-chain, acyl-Coenzyme A |
| | | | | A dehydrogenase, long chain) | dehdrogenase, long chain |
| 21078 | 1143 | J02791 | N, G | (acetyl-Coenzyme A dehydrogenase, medium chain, acyl-CoA | (acetyl-Coenzyme A dehydrogenase, medium chain, acyl-Coenzyme |
| | | | | dehydrogenase, acyl-Coenzyme A dehydrogenase, C-4 to C-12 | A dehydrogenase, C-4 to C-12 straight chain) |
| | | | | straight chain) | |
| 187 | 1094 | D32209 | F | (acidic (leucine-rich) nuclear phosphoprotein 32 family, member | acidic (leucine-rich) nuclear phosphoprotein 32 family, member A |
| | | | | A, ectodermal) | |
| 19991 | 730 | AI103956 | K | (Aconitase, Aconitate hydratase, aconitase 2, mitochondrial, | aconitase 2, mitochondrial |
| | | | | wu: fa10e03) | |
| 2098 | 25 | AA799995 | C | (Actin 5C, actin, beta, actin, beta, cytoplasmic) | (actin, beta, actin, beta, cytoplasmic) |
| 21165 | 78 | AA848941 | K | (actinin, alpha 1, alpha actinin, alpha-actinin) | actinin, alpha 1 |
| 21166 | 78 | AA848941 | K | (actinin, alpha 1, alpha actinin, alpha-actinin) | actinin, alpha 1 |
| 13633 | 576 | AI012335 | M | (activating transcription factor 4, activating transcription factor 4 | (activating transcription factor 4, activating transcription factor 4 (tax- |
| | | | | (tax-responsive enhancer element B67)) | responsive enhancer element B67)) |
| 13634 | 880 | AI179381 | M | (activating transcription factor 4, activating transcription factor 4 | (activating transcription factor 4, activating transcription factor 4 (tax- |
| | | | | (tax-responsive enhancer element B67)) | responsive enhancer element B67)) |
| 4449 | 712 | AI102838 | N, B, G, K | (acyl-CoA dehydrogenase, isovaleryl Coenzyme A | (isovaleryl Coenzyme A dehydrogenase, isovaleryl coenzyme A |
| | | | | dehydrogenase, isovaleryl coenzyme A dehydrogenase) | dehydrogenase) |
| 4450 | 1161 | J05031 | N, E | (acyl-CoA dehydrogenase, isovaleryl Coenzyme A | (isovaleryl Coenzyme A dehydrogenase, isovaleryl coenzyme A |
| | | | | dehydrogenase, isovaleryl coenzyme A dehydrogenase) | dehydrogenase) |
| 4451 | 1161 | J05031 | M, N, F | (acyl-CoA dehydrogenase, isovaleryl Coenzyme A | (isovaleryl Coenzyme A dehydrogenase, isovaleryl coenzyme A |
| | | | | dehydrogenase, isovaleryl coenzyme A dehydrogenase) | dehydrogenase) |
| 16150 | 11 | AA799489 | G | (ACYL-COENZYME A OXIDASE, PEROXISOMAL (EC 1.3.3.6) | acyl-Coenzyme A oxidase 1, palmitoyl |
| | | | | (PALMITOYL-COA OXIDASE) (AOX), acyl-Coenzyme A oxidase | |
| | | | | 1, palmitoyl, wu: fb59h12) | |
| 16148 | 1140 | J02752 | N | (ACYL-COENZYME A OXIDASE, PEROXISOMAL (EC 1.3.3.6) | acyl-Coenzyme A oxidase 1, palmitoyl |
| | | | | (PALMITOYL-COA OXIDASE) (AOX), acyl-Coenzyme A oxidase | |
| | | | | 1, palmitoyl, wu: fb59h12) | |
| 21696 | 346 | AA944324 | N, C | (ADP ribosylation factor 51F, ADP-ribosylation factor 6, | ADP-ribosylation factor 6 |
| | | | | Y116A8C.12.p) | |
| 7914 | 439 | AB002584 | N | (alanine-glyoxylate aminotransferase 2, aminotransferase, | alanine-glyoxylate aminotransferase 2 |
| | | | | similar to beta-alanine-pyruvate aminotransferase) | |
| 1540 | 1246 | M25073 | N | (alanyl (membrane) aminopeptidase, alanyl (membrane) | (alanyl (membrane) aminopeptidase, alanyl (membrane) |
| | | | | aminopeptidase (aminopeptidase N, aminopeptidase M, | aminopeptidase (aminopeptidase N, aminopeptidase M, microsomal |
| | | | | microsomal aminopeptidase, CD13, p150)) | aminopeptidase, CD13, p150)) |
| 22219 | 1578 | X72792 | N, F | (alcohol dehydrogenase 1 (class I), alcohol dehydrogenase 1C | (alcohol dehydrogenase 1 (class I), alcohol dehydrogenase 1C |
| | | | | (class I), gamma polypeptide) | (class I), gamma polypeptide) |
| 25070 | 1397 | S83279 | M, N | (alcohol dehydrogenase; non-specific lipid transfer protein, | hydroxysteroid (17-beta) dehydrogenase 4 |
| | | | | hydroxysteroid (17-beta) dehydrogenase 4) | |
| 15876 | 241 | AA892582 | N, G | (aldehyde dehydrogenase 3 family, memberA1, aldehyde | (aldehyde dehydrogenase 3 family, memberA1, aldehyde |
| | | | | dehydrogenase family 3, subfamily A1) | dehydrogenase family 3, subfamily A1) |
| 10087 | 817 | AI171803 | M | (aldehyde dehydrogenase 6 family, member A1, aldehyde | (aldehyde dehydrogenase 6 family, member A1, aldehyde |
| | | | | dehydrogenase family 6, subfamily A1, methylmalonate- | dehydrogenase family 6, subfamily A1) |
| | | | | semialdehyde dehydrogenase) | |
| 17269 | 1322 | M93401 | M | (aldehyde dehydrogenase 6 family, member A1, aldehyde | (aldehyde dehydrogenase 6 family, member A1, aldehyde |
| | | | | dehydrogenase family 6, subfamily A1, methylmalonate- | dehydrogenase family 6, subfamily A1) |
| | | | | semialdehyde dehydrogenase) | |
| 23884 | 1293 | M73714 | J | (aldehyde dehydrogenase, aldehyde dehydrogenase 3 family, | (aldehyde dehydrogenase 3 family, member A2, aldehyde |
| | | | | member A2, aldehyde dehydrogenase family 3, subfamily A2) | dehydrogenase family 3, subfamily A2) |
| 16884 | 723 | AI103758 | E | (aldehyde dehydrogenase, aldehyde dehydrogenase 9 family, | (aldehyde dehydrogenase 9 family, member A1, aldehyde |
| | | | | member A1, aldehyde dehydrogenase 9, subfamily A1) | dehydrogenase 9, subfamily A1) |
| 16885 | 739 | AI105188 | K | (aldehyde dehydrogenase, aldehyde dehydrogenase 9 family, | (aldehyde dehydrogenase 9 family, member A1, aldehyde |
| | | | | member A1, aldehyde dehydrogenase 9, subfamily A1) | dehydrogenase 9, subfamily A1) |
| 23109 | 1072 | D10854 | N | (aldo-keto reductase family 1, member A1 (aldehyde reductase), | (aldo-keto reductase family 1, member A1 (aldehyde reductase), |
| | | | | aldo-keto reductase family 1, member A4 (aldehyde reductase)) | aldo-keto reductase family 1, member A4 (aldehyde reductase)) |
| 23321 | 252 | AA892821 | M | (aldo-keto reductase family 7, member A2 (aflatoxin aldehyde | (aldo-keto reductase family 7, member A2 (aflatoxin aldehyde |
| | | | | reductase), aldo-keto reductase family 7, member A5 (aflatoxin | reductase), aldo-keto reductase family 7, member A5 (aflatoxin |
| | | | | aldehyde reductase), wu: fb71a02) | aldehyde reductase)) |
| 23322 | 252 | AA892821 | N | (aldo-keto reductase family 7, member A2 (aflatoxin aldehyde | (aldo-keto reductase family 7, member A2 (aflatoxin aldehyde |
| | | | | reductase), aldo-keto reductase family 7, member A5 (aflatoxin | reductase), aldo-keto reductase family 7, member A5 (aflatoxin |
| | | | | aldehyde reductase), wu: fb71a02) | aldehyde reductase)) |
| 14997 | 1150 | J03572 | N | (alkaline phosphatase 2, liver, alkaline phosphatase, | (alkaline phosphatase 2, liver, alkaline phosphatase, |
| | | | | liver/bone/kidney) | liver/bone/kidney) |
| 14996 | 1526 | X16038 | M, D | (alkaline phosphatase 2, liver, alkaline phosphatase, | (alkaline phosphatase 2, liver, alkaline phosphatase, |
| | | | | liver/bone/kidney) | liver/bone/kidney) |
| 16268 | 1419 | U10894 | N | (allograft inflammatory factor 1, sb: cb10) | allograft inflammatory factor 1 |
| 20741 | 510 | AF084186 | A, J | (alpha Spectrin, spectrin alpha 2, spectrin, alpha, non- | (spectrin alpha 2, spectrin, alpha, non-erythrocytic 1 (alpha-fodrin)) |
| | | | | erythrocytic 1 (alpha-fodrin)) | |
| 17196 | 942 | AI231519 | M, N, I | (alpha-N-acetylgalactosaminide alpha-2,6-sialyltransferase III, | (alpha-N-acetylgalactosaminide alpha-2,6-sialyltransferase III, |
| | | | | sialyltransferase 7 ((alpha-N-acetylneuraminyl 2,3-betagalactosyl- | sialyltransferase 7 ((alpha-N-acetylneuraminyl 2,3-betagalactosyl- |
| | | | | 1,3)-N-acetyl galactosaminide alpha-2,6-sialyltransferase) C) | 1,3)-N-acetyl galactosaminide alpha-2,6-sialyltransferase) C) |
| 1542 | 1614 | Z50144 | N, J | (aminoadipate aminotransferase, kynurenine aminotransferase | (L-kynurenine/alpha-aminoadipate aminotransferase, kynurenine |
| | | | | II) | aminotransferase II) |
| 16448 | 1117 | D86297 | N | (aminolevulinate, delta-, synthase 2 (sideroblastic/hypochromic | (aminolevulinate, delta-, synthase 2 (sideroblastic/hypochromic |
| | | | | anemia), aminolevulinic acid synthase 1) | anemia), aminolevulinic acid synthase 1) |
| 2079 | 1189 | L14462 | F | (amino-terminal enhancer of split, chico) | amino-terminal enhancer of split |
| 5329 | 646 | AI045970 | M | (amphiphysin, amphiphysin (Stiff-Man syndrome with breast | (amphiphysin, amphiphysin (Stiff-Man syndrome with breast cancer |
| | | | | cancer 128 kDa autoantigen)) | 128 kDa autoantigen)) |
| 21391 | 600 | AI013902 | M, K | (Annexin X, annexin A7) | annexin A7 |
| 20801 | 1104 | D44495 | M, N, H, I, J, L | (APEX nuclease (multifunctional DNA repair enzyme) 1, | (APEX nuclease (multifunctional DNA repair enzyme) 1, |
| | | | | apurinic/apyrimidinic endonuclease 1, hm: zehn1532) | apurinic/apyrimidinic endonuclease 1) |
| 1419 | 1492 | U90887 | N | (arginase type II, arginase, type II, wu: fb67g02) | (arginase type II, arginase, type II) |
| 4467 | 1274 | M57664 | N | (Arginine kinase, arginine kinase, creatine kinase, brain) | creatine kinase, brain |
| 20173 | 1605 | Z11932 | N, C | (arginine vasopressin receptor 2, arginine vasopressin receptor 2 | (arginine vasopressin receptor 2, arginine vasopressin receptor 2 |
| | | | | (nephrogenic diabetes insipidus)) | (nephrogenic diabetes insipidus)) |
| 4234 | 457 | AB016536 | N, K | (argininosuccinate lyase, heterogeneous nuclear | (argininosuccinate lyase, heterogeneous nuclear ribonucleoprotein |
| | | | | ribonucleoprotein A/B) | A/B) |
| 20597 | 1512 | X12459 | N | (argininosuccinate synthetase, argininosuccinate synthetase 1) | (argininosuccinate synthetase, argininosuccinate synthetase 1) |
| 17630 | 201 | AA892012 | N | (Aspartate aminotransferase, glutamate oxaloacetate | (glutamate oxaloacetate transaminase 2, mitochondrial, glutamic- |
| | | | | transaminase 2, mitochondrial, glutamic-oxaloacetic | oxaloacetic transaminase 2, mitochondrial (aspartate |
| | | | | transaminase 2, mitochondrial (aspartate aminotransferase 2)) | aminotransferase 2)) |
| 10789 | 947 | AI232059 | M | (aspartoacylase (aminoacylase 2, Canavan disease), | (aspartoacylase (aminoacylase 2, Canavan disease), |
| | | | | aspartoacylase (aminoacylase) 2) | aspartoacylase (aminoacylase) 2) |
| 20725 | 1541 | X54510 | A | (ATP synthase, H+ transporting, mitochondrial F0 complex, | (ATP synthase, H+ transporting, mitochondrial F0 complex, subunit |
| | | | | subunit F, ATP synthase, H+ transporting, mitochondrial F0 | F, ATP synthase, H+ transporting, mitochondrial F0 complex, |
| | | | | complex, subunit F6) | subunit F6) |
| 18449 | 1399 | U00926 | H | (ATP synthase, H+ transporting, mitochondrial F1 complex, delta | (ATP synthase, H+ transporting, mitochondrial F1 complex, delta |
| | | | | subunit, RIKEN cDNA 0610008F14 gene) | subunit, RIKEN cDNA 0610008F14 gene) |
| 12349 | 5 | AA799276 | M | (ATPase, Ca++ transporting, cardiac muscle, slow twitch 2, | ATPase, Ca++ transporting, cardiac muscle, slow twitch 2 |
| | | | | Calcium ATPase at 60A, E1-E2 ATPases) | |
| 20841 | 1279 | M58758 | H | (ATPase, H+ transporting, lysosomal V0 subunit a isoform 1, | ATPase, H+ transporting, lysosomal V0 subunit a isoform 1 |
| | | | | CLATHRIN-COATED VESICLE/SYNAPTIC VESICLE PROTON | |
| | | | | PUMP 116 KD SUBUNIT (EC 3.6.1.34)) | |
| 23708 | 1335 | NM_013113 | N | (ATPase, Na+/K+ transporting, beta 1 polypeptide, ATPase, | ATPase, Na+/K+ transporting, beta 1 polypeptide |
| | | | | Na+/K+ transporting, beta 1a polypeptide) | |
| 23709 | 1356 | NM_138532 | N | (ATPase, Na+/K+ transporting, beta 1 polypeptide, ATPase, | (ATPase, Na+/K+ transporting, beta 1 polypeptide, non-metastatic |
| | | | | Na+/K+ transporting, beta 1a polypeptide, non-metastatic cells 7, | cells 7, protein expressed in, non-metastatic cells 7, protein |
| | | | | protein expressed in, non-metastatic cells 7, protein expressed in | expressed in (nucleoside-diphosphate kinase)) |
| | | | | (nucleoside-diphosphate kinase), nucleoside diphosphate kinase- | |
| | | | | Z4) | |
| 5733 | 1303 | M81855 | N | (ATP-binding cassette, sub-family B (MDR/TAP), member 1, | (ATP-binding cassette, sub-family B (MDR/TAP), member 1, ATP- |
| | | | | ATP-binding cassette, sub-family B (MDR/TAP), member 1A, | binding cassette, sub-family B (MDR/TAP), member 1A, ATP- |
| | | | | ATP-binding cassette, sub-family B (MDR/TAP), member 1B, | binding cassette, sub-family B (MDR/TAP), member 1B) |
| | | | | Multi drug resistance 49) | |
| 5565 | 362 | AA945879 | M, C | (Bardet-Biedl syndrome 2, Bardet-Biedl syndrome 2 homolog | (Bardet-Biedl syndrome 2, Bardet-Biedl syndrome 2 homolog |
| | | | | (human)) | (human)) |
| 8640 | 1073 | D12769 | D | (basic transcription element binding protein 1, similar to Kruppel- | basic transcription element binding protein 1 |
| | | | | like factor 9, wu: fi22b08) | |
| 16398 | 1478 | U75392 | N | (B-cell receptor-associated protein 37, Prohibitin, repressor of | (B-cell receptor-associated protein 37, repressor of estrogen |
| | | | | estrogen receptor activity) | receptor activity) |
| 19 | 1197 | L26268 | M | (B-cell translocation gene 1, anti-proliferative, similar to B-cell | B-cell translocation gene 1, anti-proliferative |
| | | | | translocation gene 1, anti-proliferative) | |
| 15300 | 1283 | M60921 | M | (B-cell translocation gene 2, anti-proliferative, BTG family, | (B-cell translocation gene 2, anti-proliferative, BTG family, member |
| | | | | member 2) | 2) |
| 15299 | 1340 | NM_017259 | M, I, J | (B-cell translocation gene 2, anti-proliferative, BTG family, | (B-cell translocation gene 2, anti-proliferative, BTG family, member |
| | | | | member 2) | 2) |
| 23679 | 511 | AF087037 | C, L | (B-cell translocation gene 3, BTG family, member 3) | (B-cell translocation gene 3, BTG family, member 3) |
| 23033 | 1355 | NM_080888 | A, C, K | (BCL2/adenovirus E1B 19 kDa interacting protein 3-like, | (BCL2/adenovirus E1B 19 kDa interacting protein 3-like, |
| | | | | BCL2/adenovirus E1B 19 kDa-interacting protein 3-like) | BCL2/adenovirus E1B 19 kDa-interacting protein 3-like) |
| 912 | 1468 | U59184 | N | (BCL2-associated X protein, Bcl2-associated X protein, bcl2- | (BCL2-associated X protein, Bcl2-associated X protein) |
| | | | | associated X protein) | |
| 14989 | 857 | AI177366 | M, K | (beta integrin, integrin beta 1 (fibronectin receptor beta), integrin, | (integrin beta 1 (fibronectin receptor beta), integrin, beta 1 |
| | | | | beta 1 (fibronectin receptor, beta polypeptide, antigen CD29 | (fibronectin receptor, beta polypeptide, antigen CD29 includes |
| | | | | includes MDF2, MSK12), myospheroid) | MDF2, MSK12)) |
| 1508 | 1332 | M97662 | N, G | (beta-ureidopropionase (rat), ureidopropionase, beta) | ureidopropionase, beta |
| 19824 | 1125 | E13557 | N, G, K | (black, cysteine sulfinic acid decarboxylase) | cysteine sulfinic acid decarboxylase |
| 19825 | 1288 | M64755 | N | (black, cysteine sulfinic acid decarboxylase) | cysteine sulfinic acid decarboxylase |
| 17887 | 830 | AI172414 | J | (brain protein 44-like, similar to apoptosis-regulating basic | brain protein 44-like |
| | | | | protein) | |
| 18503 | 783 | AI169021 | G | (calbindin 1, 28 kDa, calbindin-28K) | (calbindin 1, 28 kDa, calbindin-28K) |
| 18501 | 1254 | M31178 | N | (calbindin 1, 28 kDa, calbindin-28K) | (calbindin 1, 28 kDa, calbindin-28K) |
| 18502 | 1254 | M31178 | N, G, J | (calbindin 1, 28 kDa, calbindin-28K) | (calbindin 1, 28 kDa, calbindin-28K) |
| 15132 | 936 | AI231180 | G | (calcium regulated heat stable protein 1, calcium regulated heat | (calcium regulated heat stable protein 1, calcium regulated heat |
| | | | | stable protein 1, 24 kDa) | stable protein 1, 24 kDa) |
| 20809 | 1229 | M17069 | N, D | (calmodulin 2 (phosphorylase kinase, delta), similar to | calmodulin 2 (phosphorylase kinase, delta) |
| | | | | Calmodulin CMD-1 (16.8 kD) (cmd-1), wu: fb69c08) | |
| 25802 | 1353 | NM_031969 | G, K | (Calmodulin, calmodulin 1, calmodulin 1 (phosphorylase kinase, | (calmodulin 1, calmodulin 1 (phosphorylase kinase, delta)) |
| | | | | delta)) | |
| 20518 | 1520 | X14265 | N | (calmodulin, calmodulin 3, calmodulin 3 (phosphorylase kinase, | (calmodulin 3, calmodulin 3 (phosphorylase kinase, delta)) |
| | | | | delta)) | |
| 15035 | 1472 | U62897 | B | (carboxypeptidase, carboxypeptidase D, silver) | carboxypeptidase D |
| 15411 | 1178 | L07736 | N, B, L | (carnitine palmitoyltransferase 1, liver, carnitine | (carnitine palmitoyltransferase 1, liver, carnitine palmitoyltransferase |
| | | | | palmitoyltransferase 1A (liver), mitochondrial carnitine | 1A (liver)) |
| | | | | palmitoyltransferase I) | |
| 1977 | 1164 | J05470 | N, L | (carnitine palmitoyltransferase 2, carnitine palmitoyltransferase II, | (carnitine palmitoyltransferase 2, carnitine palmitoyltransferase II) |
| | | | | wu: fa03e08) | |
| 16116 | 475 | AF025670 | F | (caspase 6, caspase 6, apoptosis-related cysteine protease) | (caspase 6, caspase 6, apoptosis-related cysteine protease) |
| 15741 | 1214 | M11670 | N | (Catalase, catalase) | catalase |
| 1462 | 999 | AI235585 | M, E, G | (cathepsin D, cathepsin D (lysosomal aspartyl protease)) | (cathepsin D, cathepsin D (lysosomal aspartyl protease)) |
| 1463 | 1540 | X54467 | M, G, K | (cathepsin D, cathepsin D (lysosomal aspartyl protease)) | (cathepsin D, cathepsin D (lysosomal aspartyl protease)) |
| 20828 | 814 | AI171462 | M, E, K | (CD24a antigen, hypothetical gene supported by NM_013230; | (CD24a antigen, hypothetical gene supported by NM_013230; |
| | | | | AK026603; X69397; BC007674; D87667; M58664; S75311) | AK026603; X69397; BC007674; D87667; M58664; S75311) |
| 20829 | 1457 | U49062 | M, D | (CD24a antigen, hypothetical gene supported by NM_013230; | (CD24a antigen, hypothetical gene supported by NM_013230; |
| | | | | AK026603; X69397; BC007674; D87667; M58664; S75311) | AK026603; X69397; BC007674; D87667; M58664; S75311) |
| 20830 | 1457 | U49062 | M | (CD24a antigen, hypothetical gene supported by NM_013230; | (CD24a antigen, hypothetical gene supported by NM_013230; |
| | | | | AK026603; X69397; BC007674; D87667; M58664; S75311) | AK026603; X69397; BC007674; D87667; M58664; S75311) |
| 9332 | 952 | AI232210 | F | (CD99 antigen-like 2, MIC2 (monoclonal Imperial Cancer | (CD99 antigen-like 2, MIC2 (monoclonal Imperial Cancer Research |
| | | | | Research Fund 2)-like 1) | Fund 2)-like 1) |
| 21651 | 1560 | X60767 | N, E | (cdc2, cell division cycle 2 homolog A (S. pombe), cell division | (cell division cycle 2 homolog A (S. pombe), cell division cycle 2, G1 |
| | | | | cycle 2, G1 to S and G2 to M) | to S and G2 to M) |
| 2629 | 1598 | Y00396 | K | (cellular myelocytomatosis oncogene, myelocytomatosis | (myelocytomatosis oncogene, v-myc myelocytomatosis viral |
| | | | | oncogene, v-myc myelocytomatosis viral oncogene homolog | oncogene homolog (avian)) |
| | | | | (avian)) | |
| 20960 | 1106 | D45254 | D | (cellular nucleic acid binding protein, zinc finger protein 9 (a | (cellular nucleic acid binding protein, zinc finger protein 9 (a cellular |
| | | | | cellular retroviral nucleic acid binding protein)) | retroviral nucleic acid binding protein)) |
| 19936 | 385 | AA956517 | D | (ceroid-lipofuscinosis, neuronal 2, ceroid-lipofuscinosis, neuronal | (ceroid-lipofuscinosis, neuronal 2, ceroid-lipofuscinosis, neuronal 2, |
| | | | | 2, late infantile (Jansky-Bielschowsky disease), wu: fa01b09) | late infantile (Jansky-Bielschowsky disease)) |
| 11429 | 798 | AI169706 | H | (ceroid-lipofuscinosis, neuronal 2, ceroid-lipofuscinosis, neuronal | (ceroid-lipofuscinosis, neuronal 2, ceroid-lipofuscinosis, neuronal 2, |
| | | | | 2, late infantile (Jansky-Bielschowsky disease), wu: fa01b09) | late infantile (Jansky-Bielschowsky disease)) |
| 16521 | 557 | AI010470 | B, J, L | (ceruloplasmin, ceruloplasmin (ferroxidase)) | (ceruloplasmin, ceruloplasmin (ferroxidase)) |
| 16520 | 1204 | L33869 | M, B, C, L | (ceruloplasmin, ceruloplasmin (ferroxidase)) | (ceruloplasmin, ceruloplasmin (ferroxidase)) |
| 4330 | 60 | AA818747 | M, B | (chemokine (C—X—C motif) ligand 12, chemokine (C—X—C motif) | (chemokine (C—X—C motif) ligand 12, chemokine (C—X—C motif) ligand |
| | | | | ligand 12 (stromal cell-derived factor 1)) | 12 (stromal cell-derived factor 1)) |
| 24321 | 956 | AI232340 | M, K, L | (chemokine (C—X—C motif) ligand 12, chemokine (C—X—C motif) | (chemokine (C—X—C motif) ligand 12, chemokine (C—X—C motif) ligand |
| | | | | ligand 12 (stromal cell-derived factor 1)) | 12 (stromal cell-derived factor 1)) |
| 17535 | 513 | AF090306 | N, E | (Chromatin assembly factor 1 subunit, retinoblastoma binding | retinoblastoma binding protein 7 |
| | | | | protein 7) | |
| 16552 | 1449 | U36482 | L | (chromosome 12 open reading frame 8, endoplasmic reticulum | (chromosome 12 open reading frame 8, endoplasmic reticulum |
| | | | | protein 29) | protein 29) |
| 20682 | 1482 | U75917 | B | (Clathrin coat assembly protein, adaptor-related protein complex | adaptor-related protein complex 2, sigma 1 subunit |
| | | | | 2, sigma 1 subunit, similar to clathrin-associated protein 17 - rat) | |
| 17154 | 1228 | M15883 | J | (clatherin, light polypeptide (Lcb), similar to Clathrin light chain B | clathrin, light polypeptide (Lcb) |
| | | | | (Lcb)) | |
| 7101 | 1287 | M64733 | M, E | (clusterin, clusterin (complement lysis inhibitor, SP-40, 40, | (clusterin, clusterin (complement lysis inhibitor, SP-40, 40, sulfated |
| | | | | sulfated glycoprotein 2, testosterone-repressed prostate | glycoprotein 2, testosterone-repressed prostate message 2, |
| | | | | message 2, apolipoprotein J)) | apolipoprotein J)) |
| 24874 | 1410 | U07619 | N | (coagulation factor III, coagulation factor III (thromboplastin, | (coagulation factor III, coagulation factor III (thromboplastin, tissue |
| | | | | tissue factor)) | factor)) |
| 15364 | 742 | AI105348 | J | (cofilin 1 (non-muscle), similar to cofilin 1, non-muscle) | cofilin 1 (non-muscle) |
| 16610 | 1091 | D28557 | N, E, L | (cold shock domain protein A, ypsilon schachtel) | cold shock domain protein A |
| 811 | 1110 | D63704 | M, I | (Collapsin Response Mediator Protein, Ulip like protein, | dihydropyrimidinase |
| | | | | dihydropyrimidinase) | |
| 812 | 1110 | D63704 | M, I | (Collapsin Response Mediator Protein, Ulip like protein, | dihydropyrimidinase |
| | | | | dihydropyrimidinase) | |
| 15851 | 1453 | U42719 | M | (complement component 4 (within H—2S), complement | (complement component 4 (within H—2S), complement component |
| | | | | component 4B) | 4B) |
| 15393 | 806 | AI170663 | J | (connexin 43, gap junction membrane channel protein alpha 1, | (gap junction membrane channel protein alpha 1, gap junction |
| | | | | gap junction protein, alpha 1, 43 kDa (connexin 43)) | protein, alpha 1, 43 kDa (connexin 43)) |
| 3125 | 934 | AI231028 | K | (coracle, erythrocyte membrane protein band 4.1-like 1, | (erythrocyte membrane protein band 4.1-like 1, erythrocyte protein |
| | | | | erythrocyte membrane protein band 4.1-like 3, erythrocyte | band 4.1-like 1) |
| | | | | protein band 4.1-like 1) | |
| 1727 | 461 | AF001417 | M | (core promoter element binding protein, zinc finger protein) | core promoter element binding protein |
| 21695 | 231 | AA892506 | N, G | (coronin, actin binding protein 1A, coronin, actin binding protein, | (coronin, actin binding protein 1A, coronin, actin binding protein, 1A) |
| | | | | 1A) | |
| 19058 | 493 | AF054618 | E | (Cortactin, cortactin, ems1 sequence (mammary tumor and | (cortactin, ems1 sequence (mammary tumor and squamous cell |
| | | | | squamous cell carcinoma-associated (p80/85 src substrate)) | carcinoma-associated (p80/85 src substrate)) |
| 13723 | 1272 | M55534 | N, K | (crystallin, alpha A, crystallin, alpha B) | crystallin, alpha B |
| 16407 | 471 | AF022247 | N | (cubilin (intrinsic factor-cobalamin receptor), similar to cubilin; | cubilin (intrinsic factor-cobalamin receptor) |
| | | | | cubilin (intrinsic factor-cobalamin receptor)) | |
| 20876 | 1238 | M21060 | J | (Cu—Zn superoxide dismutase, similar to superoxide dismutase 1, | superoxide dismutase 1, soluble (amyotrophic lateral sclerosis 1 |
| | | | | soluble, superoxide dismutase 1, soluble (amyotrophic lateral | (adult)) |
| | | | | sclerosis 1 (adult))) | |
| 11434 | 1079 | D14014 | N, B | (cyclin D1, cyclin D1 (PRAD1: parathyroid adenomatosis 1)) | (cyclin D1, cyclin D1 (PRAD1: parathyroid adenomatosis 1)) |
| 24232 | 1359 | NM_171992 | B | (cyclin D1, cyclin D1 (PRAD1: parathyroid adenomatosis 1)) | (cyclin D1, cyclin D1 (PRAD1: parathyroid adenomatosis 1)) |
| 133 | 1436 | U24174 | N | (cyclin-dependent kinase inhibitor 1A (P21), cyclin-dependent | (cyclin-dependent kinase inhibitor 1A (P21), cyclin-dependent kinase |
| | | | | kinase inhibitor 1A (p21, Cip1)) | inhibitor 1A (p21, Cip1)) |
| 18452 | 1085 | D17370 | M, N | (cystathionase (cystathionine gamma-lyase), cystathionine | cystathionase (cystathionine gamma-lyase) |
| | | | | gamma-lyase, wu: fb48e03) | |
| 18453 | 1085 | D17370 | N, G | (cystathionase (cystathionine gamma-lyase), cystathionine | cystathionase (cystathionine gamma-lyase) |
| | | | | gamma-lyase, wu: fb48e03) | |
| 291 | 1316 | M88347 | M, N, F | (cystathionine beta-synthase, cystathionine-beta-synthase, | (cystathionine beta-synthase, cystathionine-beta-synthase) |
| | | | | wu: fq06c06) | |
| 13392 | 982 | AI234146 | M | (cysteine and glycine-rich protein 1, cysteine rich protein 1) | (cysteine and glycine-rich protein 1, cysteine rich protein 1) |
| 3431 | 846 | AI176595 | N | (Cysteine proteinase-1, cathepsin L, cathepsin L2, cathepsin-like | (cathepsin L, cathepsin L2) |
| | | | | protease, hatching gland gene 1) | |
| 19543 | 1455 | U44948 | N | (cysteine rich protein 2, cysteine-rich protein 2) | (cysteine rich protein 2, cysteine-rich protein 2) |
| 23225 | 1249 | M27467 | N | (cytochrome c oxidase subunit VIc, cytochrome c oxidase, | (cytochrome c oxidase subunit VIc, cytochrome c oxidase, subunit |
| | | | | subunit VIc) | VIc) |
| 1921 | 1123 | E01524 | N | (Cytochrome P450 reductase, NADPH-cytochrome P450, P450 | P450 (cytochrome) oxidoreductase |
| | | | | (cytochrome) oxidoreductase) | |
| 1920 | 1213 | M10068 | N | (Cytochrome P450 reductase, NADPH-cytochrome P450, P450 | P450 (cytochrome) oxidoreductase |
| | | | | (cytochrome) oxidoreductase) | |
| 4011 | 496 | AF056333 | N, J | (cytochrome P450, family 2, subfamily E, polypeptide 1, | (cytochrome P450, family 2, subfamily E, polypeptide 1, cytochrome |
| | | | | cytochrome P450, family 2, subfamily e, polypeptide 1) | P450, family 2, subfamily e, polypeptide 1) |
| 4012 | 1367 | S48325 | N, J | (cytochrome P450, family 2, subfamily E, polypeptide 1, | (cytochrome P450, family 2, subfamily E, polypeptide 1, cytochrome |
| | | | | cytochrome P450, family 2, subfamily e, polypeptide 1) | P450, family 2, subfamily e, polypeptide 1) |
| 67 | 1268 | M37828 | B | (cytochrome P450, family 4, subfamily A, polypeptide 11, | (cytochrome P450, family 4, subfamily A, polypeptide 11, |
| | | | | cytochrome P450, family 4, subfamily a, polypeptide 12) | cytochrome P450, family 4, subfamily a, polypeptide 12) |
| 20716 | 1323 | M94548 | G | (cytochrome P450, family 4, subfamily F, polypeptide 2, | (cytochrome P450, family 4, subfamily F, polypeptide 2, cytochrome |
| | | | | cytochrome P450, family 4, subfamily f, polypeptide 14) | P450, family 4, subfamily f, polypeptide 14) |
| 17473 | 544 | AI009806 | M, N, K | (Cytoplasmic dynein light chain 2, dynein, cytoplasmic, light | (dynein, cytoplasmic, light chain 1, dynein, cytoplasmic, light |
| | | | | chain 1, dynein, cytoplasmic, light polypeptide 1) | polypeptide 1) |
| 1762 | 1147 | J03179 | N | (D site albumin promoter binding protein, D site of albumin | (D site albumin promoter binding protein, D site of albumin promoter |
| | | | | promoter (albumin D-box) binding protein) | (albumin D-box) binding protein) |
| 1763 | 1147 | J03179 | N | (D site albumin promoter binding protein, D site of albumin | (D site albumin promoter binding protein, D site of albumin promoter |
| | | | | promoter (albumin D-box) binding protein) | (albumin D-box) binding protein) |
| 21587 | 293 | AA899141 | D | (D-3-Phosphoglycerate dehydrogenase, phosphoglycerate | phosphoglycerate dehydrogenase |
| | | | | dehydrogenase, similar to D-3-phosphoglycerate dehydrogenase | |
| | | | | (3-PGDH)) | |
| 21585 | 1596 | X97772 | D | (D-3-Phosphoglycerate dehydrogenase, phosphoglycerate | phosphoglycerate dehydrogenase |
| | | | | dehydrogenase, similar to D-3-phosphoglycerate dehydrogenase | |
| | | | | (3-PGDH)) | |
| 21586 | 1596 | X97772 | D | (D-3-Phosphoglycerate dehydrogenase, phosphoglycerate | phosphoglycerate dehydrogenase |
| | | | | dehydrogenase, similar to D-3-phosphoglycerate dehydrogenase | |
| | | | | (3-PGDH)) | |
| 4327 | 501 | AF063447 | M, G, I | (DEAD (Asp-Glu-Ala-Asp) box polypeptide 39, Helicase at 25E) | (DEAD (Asp-Glu-Ala-Asp) box polypeptide 39, DEAD/H (Asp-Glu- |
| | | | | | Ala-Asp/His) box polypeptide 39) |
| 12422 | 1053 | AJ006971 | N | (death-associated kinase 3, death-associated protein kinase 3) | (death-associated kinase 3, death-associated protein kinase 3) |
| 12423 | 1053 | AJ006971 | N | (death-associated kinase 3, death-associated protein kinase 3) | (death-associated kinase 3, death-associated protein kinase 3) |
| 755 | 1100 | D38448 | M, N | (diacylglycerol kinase, gamma, diacylglycerol kinase, gamma | (diacylglycerol kinase, gamma, diacylglycerol kinase, gamma |
| | | | | 90 kDa) | 90 kDa) |
| 754 | 1336 | NM_013126 | N | (diacylglycerol kinase, gamma, diacylglycerol kinase, gamma | (diacylglycerol kinase, gamma, diacylglycerol kinase, gamma |
| | | | | 90 kDa) | 90 kDa) |
| 13479 | 1149 | J03481 | N | (Dihydropteridine reductase, quininoid dihydropteridine | (quininoid dihydropteridine reductase, quinoid dihydropteridine |
| | | | | reductase, quinoid dihydropteridine reductase) | reductase) |
| 13480 | 1149 | J03481 | N | (Dihydropteridine reductase, quininoid dihydropteridine | (quininoid dihydropteridine reductase, quinoid dihydropteridine |
| | | | | reductase, quinoid dihydropteridine reductase) | reductase) |
| 7784 | 1157 | J04591 | M, N, I | (dipeptidylpeptidase 4, dipeptidylpeptidase 4 (CD26, adenosine | (dipeptidylpeptidase 4, dipeptidylpeptidase 4 (CD26, adenosine |
| | | | | deaminase complexing protein 2)) | deaminase complexing protein 2)) |
| 4504 | 1495 | U95178 | D | (disabled homolog 2 (Drosophila), disabled homolog 2, mitogen- | (disabled homolog 2 (Drosophila), disabled homolog 2, mitogen- |
| | | | | responsive phosphoprotein (Drosophila)) | responsive phosphoprotein (Drosophila)) |
| 25247 | 1054 | AJ011608 | N | (DNA primase, p49 subunit, primase, polypeptide 1, 49 kDa) | (DNA primase, p49 subunit, primase, polypeptide 1, 49 kDa) |
| 23718 | 381 | AA955790 | A | (DNA segment, Chr 3, MJeffers 1, NRAS-related gene) | (DNA segment, Chr 3, MJeffers 1, NRAS-related gene) |
| 23778 | 298 | AA899854 | N, E | (DNA topoisomerase II, Topoisomerase 2, topoisomerase (DNA) | (topoisomerase (DNA) II alpha, topoisomerase (DNA) II alpha |
| | | | | II alpha, topoisomerase (DNA) II alpha 170 kDa) | 170 kDa) |
| 23780 | 1608 | Z19552 | E | (DNA topoisomerase II, Topoisomerase 2, topoisomerase (DNA) | (topoisomerase (DNA) II alpha, topoisomerase (DNA) II alpha |
| | | | | II alpha, topoisomerase (DNA) II alpha 170 kDa) | 170 kDa) |
| 1598 | 1445 | U30186 | N | (DNA-damage inducible transcript 3, DNA-damage-inducible | (DNA-damage inducible transcript 3, DNA-damage-inducible |
| | | | | transcript 3) | transcript 3) |
| 23282 | 1491 | U90725 | A | (Dodeca-satellite-binding protein 1, high density lipoprotein | high density lipoprotein binding protein (vigilin) |
| | | | | binding protein (vigilin), high-density lipoprotein-binding protein) | |
| 18687 | 804 | AI170568 | N | (dodecenoyl-Coenzyme A delta isomerase (3,2 trans-enoyl- | (dodecenoyl-Coenzyme A delta isomerase (3,2 trans-enoyl- |
| | | | | Coenyme A isomerase), dodecenoyl-Coenzyme A delta | Coenyme A isomerase), dodecenoyl-Coenzyme A delta isomerase |
| | | | | isomerase (3,2 trans-enoyl-Coenzyme A isomerase)) | (3,2 trans-enoyl-Coenzyme A isomerase)) |
| 18686 | 1062 | D00729 | N | (dodecenoyl-Coenzyme A delta isomerase (3,2 trans-enoyl- | (dodecenoyl-Coenzyme A delta isomerase (3,2 trans-enoyl- |
| | | | | Coenyme A isomerase), dodecenoyl-Coenzyme A delta | Coenyme A isomerase), dodecenoyl-Coenzyme A delta isomerase |
| | | | | isomerase (3,2 trans-enoyl-Coenzyme A isomerase)) | (3,2 trans-enoyl-Coenzyme A isomerase)) |
| 1431 | 632 | AI044610 | D | (Dopa decarboxylase, aromatic-L-amino-acid decarboxylase, | (dopa decarboxylase, dopa decarboxylase (aromatic L-amino acid |
| | | | | dopa decarboxylase, dopa decarboxylase (aromatic L-amino | decarboxylase)) |
| | | | | acid decarboxylase)) | |
| 1430 | 1309 | M84648 | M | (Dopa decarboxylase, aromatic-L-amino-acid decarboxylase, | (dopa decarboxylase, dopa decarboxylase (aromatic L-amino acid |
| | | | | dopa decarboxylase, dopa decarboxylase (aromatic L-amino | decarboxylase)) |
| | | | | acid decarboxylase)) | |
| 1183 | 465 | AF013144 | N | (dual specificity phosphatase 5, similar to MAP-kinase | dual specificity phosphatase 5 |
| | | | | phosphatase (cpg21)) | |
| 20896 | 1475 | U64030 | A, F | (dUTP pyrophosphatase, deoxyuridine 5′-triphosphate | (dUTP pyrophosphatase, deoxyuridine triphosphatase) |
| | | | | nucleotidohydrolase, deoxyuridine triphosphatase) | |
| 15662 | 445 | AB010119 | N, G | (Dynein light chain 90F, t-complex testis expressed 1, t-complex- | (t-complex testis expressed 1, t-complex-associated-testis- |
| | | | | associated-testis-expressed 1-like 1) | expressed 1-like 1) |
| 15663 | 834 | AI175566 | M | (Dynein light chain 90F, t-complex testis expressed 1, t-complex- | (t-complex testis expressed 1, t-complex-associated-testis- |
| | | | | associated-testis-expressed 1-like 1) | expressed 1-like 1) |
| 9176 | 691 | AI072675 | A | (dystonia 1, dystonia 1, torsion (autosomal dominant; torsin A)) | (dystonia 1, dystonia 1, torsion (autosomal dominant; torsin A)) |
| 19712 | 1429 | U18374 | K | (Ecdysone receptor, nuclear receptor subfamily 1, group H, | nuclear receptor subfamily 1, group H, member 4 |
| | | | | member 4) | |
| 1214 | 1076 | D13871 | M, N, K | (Ecdysone receptor, nuclear receptor subfamily 1, group H, | (nuclear receptor subfamily 1, group H, member 4, solute carrier |
| | | | | member 4, solute carrier family 2 (facilitated glucose | family 2 (facilitated glucose transporter), member 5, solute carrier |
| | | | | transporter), member 5, solute carrier family 2 (facilitated | family 2 (facilitated glucose/fructose transporter), member 5) |
| | | | | glucose/fructose transporter), member 5) | |
| 7124 | 1409 | U07181 | E | (Ecdysone-inducible gene L3, lactate dehydrogenase 2, B chain, | (lactate dehydrogenase 2, B chain, lactate dehydrogenase B) |
| | | | | lactate dehydrogenase B, lactate dehydrogenase B4) | |
| 17563 | 875 | AI178750 | N | (Elongation factor 2b, Elongation factor Tu family (contains | eukaryotic translation elongation factor 2 |
| | | | | ATP/GTP binding P-loop), eukaryotic translation elongation | |
| | | | | factor 2) | |
| 20925 | 1412 | U08976 | N, L | (enoyl Coenzyme A hydratase 1, peroxisomal, enoyl coenzyme | (enoyl Coenzyme A hydratase 1, peroxisomal, enoyl coenzyme A |
| | | | | A hydratase 1, peroxisomal) | hydratase 1, peroxisomal) |
| 23194 | 227 | AA892417 | M | (ephrin A1, ephrin-A1) | (ephrin A1, ephrin-A1) |
| 17907 | 969 | AI233224 | M | (epidermal growth factor receptor, epidermal growth factor | (epidermal growth factor receptor, epidermal growth factor receptor |
| | | | | receptor (erythroblastic leukemia viral (v-erb-b) oncogene | (erythroblastic leukemia viral (v-erb-b) oncogene homolog, avian)) |
| | | | | homolog, avian)) | |
| 20885 | 1403 | U04842 | N, G, K | (epidermal growth factor, epidermal growth factor (beta- | (epidermal growth factor, epidermal growth factor (beta- |
| | | | | urogastrone)) | urogastrone)) |
| 20884 | 1513 | X12748 | N, G, K | (epidermal growth factor, epidermal growth factor (beta- | (epidermal growth factor, epidermal growth factor (beta- |
| | | | | urogastrone)) | urogastrone)) |
| 21509 | 98 | AA851618 | G | (epithelial membrane protein 3, wu: fa04d03) | epithelial membrane protein 3 |
| 17541 | 1247 | M26125 | M, N, A, B, H, I | (epoxide hydrolase, epoxide hydrolase 1, microsomal, epoxide | (epoxide hydrolase 1, microsomal, epoxide hydrolase 1, microsomal |
| | | | | hydrolase 1, microsomal (xenobiotic)) | xenobiotic)) |
| 8188 | 652 | AI058943 | M | (erythrocyte membrane protein band 4.1-like 3, erythrocyte | (erythrocyte membrane protein band 4.1-like 3, erythrocyte protein |
| | | | | protein band 4.1-like 3) | band 4.1-like 3) |
| 744 | 506 | AF076856 | M, N | (espin, forked) | espin |
| 4592 | 1135 | J02646 | H | (eukaryotic translation initiation factor 2, subunit 1 alpha, | (eukaryotic translation initiation factor 2, subunit 1 alpha, eukaryotic |
| | | | | eukaryotic translation initiation factor 2, subunit 1 alpha, 35 kDa) | translation initiation factor 2, subunit 1 alpha, 35 kDa) |
| 1764 | 1591 | X83399 | C | (eukaryotic translation initiation factor 4E, eukaryotic translation | (eukaryotic translation initiation factor 4E, similar to Eukaryotic |
| | | | | initiation factor elF4E-1, similar to Eukaryotic translation initiation | translation initiation factor 4E (elF-4E) (elF4E) (mRNA cap-binding |
| | | | | factor 4E (elF-4E) (elF4E) (mRNA cap-binding protein) (elF-4F | protein) (elF-4F 25 kDa subunit)) |
| | | | | 25 kDa subunit), translation initiation factor) | |
| 21147 | 1111 | D63772 | M, F, H, I, J, L | (Excitatory amino acid transporter 1, solute carrier family 1 | (solute carrier family 1 (neuronal/epithelial high affinity glutamate |
| | | | | (neuronal/epithelial high affinity glutamate transporter, system | transporter, system Xag), member 1, solute carrier family 1, member |
| | | | | Xag), member 1, solute carrier family 1, member 1) | 1) |
| 21145 | 1334 | NM_013032 | M, B | (Excitatory amino acid transporter 1, solute carrier family 1 | (solute carrier family 1 (neuronal/epithelial high affinity glutamate |
| | | | | (neuronal/epithelial high affinity glutamate transporter, system | transporter, system Xag), member 1, solute carrier family 1, member |
| | | | | Xag), member 1, solute carrier family 1, member 1) | 1) |
| 5920 | 788 | AI169163 | B | (expressed sequence AW261723, solute carrier family 17 | (expressed sequence AW261723, solute carrier family 17 (sodium |
| | | | | (sodium phosphate), member 3) | phosphate), member 3) |
| 16449 | 1327 | M95591 | N | (farnesyl diphosphate farnesyl transferase 1, farnesyl- | (farnesyl diphosphate farnesyl transferase 1, farnesyl-diphosphate |
| | | | | diphosphate farnesyltransferase 1) | farnesyltransferase 1) |
| 16450 | 1327 | M95591 | N | (farnesyl diphosphate farnesyl transferase 1, farnesyl- | (farnesyl diphosphate farnesyl transferase 1, farnesyl-diphosphate |
| | | | | diphosphate farnesyltransferase 1) | farnesyltransferase 1) |
| 15069 | 1319 | M89945 | H | (farnesyl diphosphate synthase (farnesyl pyrophosphate | (farnesyl diphosphate synthase (farnesyl pyrophosphate synthetase, |
| | | | | synthetase, dimethylallyltranstransferase, | dimethylallyltranstransferase, geranyltranstransferase), farnesyl |
| | | | | geranyltranstransferase), farnesyl diphosphate synthetase) | diphosphate synthetase) |
| 25460 | 1319 | M89945 | N | (farnesyl diphosphate synthase (farnesyl pyrophosphate | (farnesyl diphosphate synthase (farnesyl pyrophosphate synthetase, |
| | | | | synthetase, dimethylallyltranstransferase, | dimethylallyltranstransferase, geranyltranstransferase), farnesyl |
| | | | | geranyltranstransferase), farnesyl diphosphate synthetase) | diphosphate synthetase) |
| 16476 | 1141 | J02773 | M, L | (fatty acid binding protein 11, oocyte, fatty acid binding protein 3, | (fatty acid binding protein 3, muscle and heart, fatty acid binding |
| | | | | muscle and heart, fatty acid binding protein 3, muscle and heart | protein 3, muscle and heart (mammary-derived growth inhibitor)) |
| | | | | (mammary-derived growth inhibitor)) | |
| 20983 | 634 | AI044900 | K | (fatty acid Coenzyme A ligase, long chain 2, fatty-acid- | (fatty acid Coenzyme A ligase, long chain 2, fatty-acid-Coenzyme A |
| | | | | Coenzyme A ligase, long-chain 2) | ligase, long-chain 2) |
| 15926 | 451 | AB012933 | D | (fatty acid Coenzyme A ligase, long chain 5, fatty-acid- | (fatty acid Coenzyme A ligase, long chain 5, fatty-acid-Coenzyme A |
| | | | | Coenzyme A ligase, long-chain 5, wu: fa04h02) | ligase, long-chain 5) |
| 13004 | 1007 | AI236284 | J, L | (fatty acid-Coenzyme A ligase, long chain 4, fatty-acid- | (fatty acid-Coenzyme A ligase, long chain 4, fatty-acid-Coenzyme A |
| | | | | Coenzyme A ligase, long-chain 4, long-chain-fatty-acid coA | ligase, long-chain 4) |
| | | | | ligase) | |
| 13005 | 1116 | D85189 | N, C | (fatty acid-Coenzyme A ligase, long chain 4, fatty-acid- | (fatty acid-Coenzyme A ligase, long chain 4, fatty-acid-Coenzyme A |
| | | | | Coenzyme A ligase, long-chain 4, long-chain-fatty-acid coA | ligase, long-chain 4) |
| | | | | ligase) | |
| 20868 | 1256 | M32062 | N | (Fc fragment of IgG, low affinity IIa, receptor for (CD32), Fc | (Fc fragment of IgG, low affinityIIa, receptor for (CD32), Fc receptor, |
| | | | | receptor, IgG, low affinity III) | IgG, low affinity III) |
| 20869 | 1256 | M32062 | N | (Fc fragment of IgG, low affinity IIa, receptor for (CD32), Fc | (Fc fragment of IgG, low affinityIIa, receptor for (CD32), Fc receptor, |
| | | | | receptor, IgG, low affinity III) | IgG, low affinity III) |
| 1427 | 1209 | L38644 | N | (Female sterile (2) Ketel, karyopherin (importin) beta 1) | karyopherin (importin) beta 1 |
| 9452 | 373 | AA955206 | M | (fibrinogen-like 2, fibrinogen-like protein 2) | (fibrinogen-like 2, fibrinogen-like protein 2) |
| 15295 | 164 | AA875594 | M, H, I | (FK506 binding protein 1A, 12 kDa, FK506-binding protein 2) | FK506 binding protein 1A, 12 kDa |
| 6782 | 838 | AI176170 | B | (FK506 binding protein 1A, 12 kDa, FK506-binding protein 2) | FK506 binding protein 1A, 12 kDa |
| 15296 | 907 | AI228738 | N, H, I | (FK506 binding protein 1A, 12 kDa, FK506-binding protein 2) | FK506 binding protein 1A, 12 kDa |
| 15297 | 1118 | D86641 | N, K | (FK506 binding protein 1A, 12 kDa, FK506-binding protein 2) | FK506 binding protein 1A, 12 kDa |
| 13091 | 764 | AI136977 | L | (FK506 binding protein 4, FK506 binding protein 4, 59 kDa, | (FK506 binding protein 4, FK506 binding protein 4, 59 kDa) |
| | | | | FK506-binding protein FKBP59) | |
| 16895 | 1313 | M86240 | N | (fructose bisphosphatase 1, fructose-1,6-bisphosphatase 1) | (fructose bisphosphatase 1, fructose-1,6-bisphosphatase 1) |
| 7064 | 122 | M12919 | N | (Fructose-bisphosphate aldolase class-I, aldolase 1, A isoform, | (aldolase 1, A isoform, aldolase A, fructose-bisphosphate) |
| | | | | aldolase A, fructose-bisphosphate) | |
| 23961 | 1298 | M77694 | M, N, E, G, I | (Fumarylacetoacetase, fumarylacetoacetase, | (fumarylacetoacetate hydrolase, fumarylacetoacetate hydrolase |
| | | | | fumarylacetoacetate hydrolase, fumarylacetoacetate hydrolase | (fumarylacetoacetase)) |
| | | | | (fumarylacetoacetase)) | |
| 15887 | 154 | AA875225 | N | (G protein alphai subunit 65A, guanine nucleotide binding protein | (guanine nucleotide binding protein (G protein), alpha inhibiting |
| | | | | (G protein), alpha inhibiting activity polypeptide 2, guanine | activity polypeptide 2, guanine nucleotide binding protein, alpha |
| | | | | nucleotide binding protein, alpha inhibiting 2) | inhibiting 2) |
| 15888 | 154 | AA875225 | N | (G protein alphai subunit 65A, guanine nudeotide binding protein | (guanine nucleotide binding protein (G protein), alpha inhibiting |
| | | | | (G protein), alpha inhibiting activity polypeptide 2, guanine | activity polypeptide 2, guanine nucleotide binding protein, alpha |
| | | | | nucleotide binding protein, alpha inhibiting 2) | inhibiting 2) |
| 45 | 1417 | U10354 | M, J, L | (G protein-coupled receptor, family C, group 2, member A, | (G protein-coupled receptor, family C, group 2, member A, calcium- |
| | | | | calcium-sensing receptor (hypocalciuric hypercalcemia 1, severe | sensing receptor (hypocalciuric hypercalcemia 1, severe neonatal |
| | | | | neonatal hyperparathyroidism)) | hyperparathyroidism)) |
| 729 | 1328 | M95762 | N, D | (gamma-aminobutyric acid (GABA-A) transporter 3, solute carrier | (gamma-aminobutyric acid (GABA-A) transporter 3, solute carrier |
| | | | | family 6 (neurotransmitter transporter, GABA), member 13) | family 6 (neurotransmitter transporter, GABA), member 13) |
| 15072 | 1357 | NM_144730 | A | (GATA binding protein 4, GATA-binding protein 4) | GATA binding protein 4 |
| 16248 | 1376 | S68135 | N | (Glucose transporter 1, solute carrier family 2 (facilitated glucose | solute carrier family 2 (facilitated glucose transporter), member 1 |
| | | | | transporter), member 1, sugar transporter) | |
| 1321 | 1206 | L37333 | N | (glucose-6-phosphatase, catalytic, glucose-6-phosphatase, | (glucose-6-phosphatase, catalytic, glucose-6-phosphatase, catalytic |
| | | | | catalytic (glycogen storage disease type I, von Gierke disease)) | (glycogen storage disease type I, von Gierke disease)) |
| 5496 | 507 | AF080468 | M, N, D, E | (glucose-6-phosphatase, transport (glucose-6-phosphate) | (glucose-6-phosphatase, transport (glucose-6-phosphate) protein 1, |
| | | | | protein 1, glucose-6-phosphatase, transport protein 1) | glucose-6-phosphatase, transport protein 1) |
| 5497 | 507 | AF080468 | M, N, D, E | (glucose-6-phosphatase, transport (glucose-6-phosphate) | (glucose-6-phosphatase, transport (glucose-6-phosphate) protein 1, |
| | | | | protein 1, glucose-6-phosphatase, transport protein 1) | glucose-6-phosphatase, transport protein 1) |
| 4574 | 968 | AI233216 | N | (Glutamate dehydrogenase, glutamate dehydrogenase, | (glutamate dehydrogenase, glutamate dehydrogenase 1) |
| | | | | glutamate dehydrogenase 1) | |
| 14003 | 1374 | S65555 | N, B, J | (glutamate-cysteine ligase, modifier subunit, glutamate-cysteine | (glutamate-cysteine ligase, modifier subunit, glutamate-cysteine |
| | | | | ligase, modifier subunit) | ligase, modifier subunit) |
| 1247 | 1163 | J05181 | N, J | (Glutamate-cysteine ligase catalytic subunit, glutamate-cysteine | glutamate-cysteine ligase, catalytic subunit |
| | | | | ligase, glutamate-cysteine ligase, catalytic subunit) | |
| 1853 | 1511 | X12367 | N | (glutathione peroxidase 1, similar to glutathione peroxidase 1) | |
| 4615 | 1061 | D00680 | N | (glutathione peroxidase 3, glutathione peroxidase 3 (plasma)) | (glutathione peroxidase 3, glutathione peroxidase 3 (plasma)) |
| 18989 | 1168 | K00136 | N | (glutathione S-transferase A5, glutathione S-transferase, alpha 2 | (glutathione S-transferase A5, glutathione S-transferase, alpha 2 |
| | | | | (Yc2)) | (Yc2)) |
| 20817 | 582 | AI012589 | M, N | (glutathione S-transferase pi, glutathione S-transferase, pi 2) | (glutathione S-transferase pi, glutathione S-transferase, pi 2) |
| 20818 | 1498 | X02904 | M, N | (glutathione S-transferase pi, glutathione S-transferase, pi 2) | (glutathione S-transferase pi, glutathione S-transferase, pi 2) |
| 573 | 949 | AI232087 | N, J | (glycolate oxidase, hydroxyacid oxidase (glycolate oxidase) 3, | (hydroxyacid oxidase (glycolate oxidase) 3, hydroxyacid oxidase 2 |
| | | | | hydroxyacid oxidase 2 (long chain)) | (long chain)) |
| 22675 | 1493 | U92081 | N, G | (glycoprotein 38, lung type-I cell membrane-associated | (glycoprotein 38, lung type-I cell membrane-associated glycoprotein) |
| | | | | glycoprotein) | |
| 4254 | 1219 | M12450 | N | (group specific component, group-specific component (vitamin D | (group specific component, group-specific component (vitamin D |
| | | | | binding protein)) | binding protein)) |
| 352 | 661 | AI070295 | H | (growth arrest and DNA-damage-inducible 45 alpha, growth | (growth arrest and DNA-damage-inducible 45 alpha, growth arrest |
| | | | | arrest and DNA-damage-inducible, alpha) | and DNA-damage-inducible, alpha) |
| 353 | 1203 | L32591 | M, H, I | (growth arrest and DNA-damage-inducible 45 alpha, growth | (growth arrest and DNA-damage-inducible 45 alpha, growth arrest |
| | | | | arrest and DNA-damage-inducible, alpha) | and DNA-damage-inducible, alpha) |
| 354 | 1203 | L32591 | M, H, I | (growth arrest and DNA-damage-inducible 45 alpha, growth | (growth arrest and DNA-damage-inducible 45 alpha, growth arrest |
| | | | | arrest and DNA-damage-inducible, alpha) | and DNA-damage-inducible, alpha) |
| 25290 | 1102 | D42148 | N, J | (growth arrest specific 6, growth arrest-specific 6) | (growth arrest specific 6, growth arrest-specific 6) |
| 8888 | 81 | AA849036 | N, B | (Guanyl cyclase alpha-subunit at 99B, guanylate cyclase 1, | guanylate cyclase 1, soluble, alpha 3 |
| | | | | soluble, alpha 3) | |
| 1976 | 1326 | M95493 | N | (guanylate cyclase activator 1B (retina), guanylate cyclase | (guanylate cyclase activator 1B (retina), guanylate cyclase activator |
| | | | | activator 2 (guanylin 2, intestinal, heatstable), guanylate cyclase | 2 (guanylin 2, intestinal, heatstable), guanylate cyclase activator 2A |
| | | | | activator 2A (guanylin)) | (guanylin)) |
| 17661 | 1267 | M37584 | N, E | (H2A histone family, member Z, Histone H2A variant, histone | H2A histone family, member Z |
| | | | | H2A variant) | |
| 15642 | 861 | AI177503 | M, F, J | (H3 histone, family 3B, H3 histone, family 3B (H3.3B)) | (H3 histone, family 3B, H3 histone, family 3B (H3.3B)) |
| 20167 | 1523 | X15705 | E | (heat shock 70 kDa protein 2, heat shock protein 2) | (heat shock 70 kDa protein 2, heat shock protein 2) |
| 17764 | 985 | AI234604 | N | (heat shock 70 kDa protein 8, heat shock cognate 71-kd protein, | (heat shock 70 kDa protein 8, heat shock protein 8) |
| | | | | heat shock protein 1, heat shock protein 8) | |
| 17765 | 1216 | M11942 | N | (heat shock 70 kDa protein 8, heat shock cognate 71-kd protein, | (heat shock 70 kDa protein 8, heat shock protein 8) |
| | | | | heat shock protein 1, heat shock protein 8) | |
| 16518 | 845 | AI176546 | N, C, K | (heat shock 90 kDa protein 1, alpha, heat shock protein 1, alpha) | (heat shock 90 kDa protein 1, alpha, heat shock protein 1, alpha) |
| 20795 | 1360 | NM_175761 | N, H | (heat shock 90 kDa protein 1, alpha, heat shock protein 1, alpha) | (heat shock 90 kDa protein 1, alpha, heat shock protein 1, alpha) |
| 17301 | 1292 | M69246 | N, E, I | (heat shock protein 47, serine (or cysteine) proteinase inhibitor, | (serine (or cysteine) proteinase inhibitor, clade H (heat shock protein |
| | | | | clade H (heat shock protein 47), member 1, (collagen binding | 47), member 1, (collagen binding protein 1), serine (or cysteine) |
| | | | | protein 1), serine (or cysteine) proteinase inhibitor, clade H, | proteinase inhibitor, clade H, member 1) |
| | | | | member 1) | |
| 1466 | 1222 | M14050 | N | (Heat shock protein cognate 3, heat shock 70 kD protein 5 | (heat shock 70 kD protein 5 (glucose-regulated protein), heat shock |
| | | | | (glucose-regulated protein), heat shock 70 kDa protein 5 (glucose | 70 kDa protein 5 (glucose-regulated protein, 78 kDa)) |
| | | | | regulated protein, 78 kDa), heat shock protein) | |
| 605 | 1199 | L27340 | C | (hedgehog, sonic hedgehog, sonic hedgehog homolog | (sonic hedgehog, sonic hedgehog homolog (Drosophila)) |
| | | | | (Drosophila)) | |
| 1685 | 97 | AA851497 | J | (hemoglobin alpha, adult chain 1, hemoglobin alpha, adult chain | (hemoglobin alpha, adult chain 1, hemoglobin, alpha 1, hemoglobin, |
| | | | | 2, hemoglobin, alpha 1, hemoglobin, alpha 2) | alpha 2) |
| 1687 | 890 | AI179971 | J | (hemoglobin alpha, adult chain 1, hemoglobin alpha, adult chain | (hemoglobin alpha, adult chain 1, hemoglobin, alpha 1, hemoglobin, |
| | | | | 2, hemoglobin, alpha 1, hemoglobin, alpha 2) | alpha 2) |
| 1688 | 932 | AI230970 | J | (hemoglobin alpha, adult chain 1, hemoglobin alpha, adult chain | (hemoglobin alpha, adult chain 1, hemoglobin, alpha 1, hemoglobin, |
| | | | | 2, hemoglobin, alpha 1, hemoglobin, alpha 2) | alpha 2) |
| 1689 | 1009 | AI236360 | J | (hemoglobin alpha, adult chain 1, hemoglobin alpha, adult chain | (hemoglobin alpha, adult chain 1, hemoglobin, alpha 1, hemoglobin, |
| | | | | 2, hemoglobin, alpha 1, hemoglobin, alpha 2) | alpha 2) |
| 1684 | 1547 | X56325 | J | (hemoglobin alpha, adult chain 1, hemoglobin alpha, adult chain | (hemoglobin alpha, adult chain 1, hemoglobin, alpha 1, hemoglobin, |
| | | | | 2, hemoglobin, alpha 1, hemoglobin, alpha 2) | alpha 2) |
| 6055 | 1218 | M12337 | M, N, D | (Henna, phenylalanine hydroxylase, phenylalanine-4- | phenylalanine hydroxylase |
| | | | | hydroxylase (PH4H)) | |
| 10860 | 1549 | X57133 | N | (Hepatocyte nuclear factor 4, hepatic nuclear factor 4, | (hepatic nuclear factor 4, hepatocyte nuclear factor 4, alpha) |
| | | | | hepatocyte nuclear factor 4, alpha) | |
| 25699 | 1549 | X57133 | N | (Hepatocyte nuclear factor 4, hepatic nuclear factor 4, | (hepatic nuclear factor 4, hepatocyte nuclear factor 4, alpha) |
| | | | | hepatocyte nuclear factor 4, alpha) | |
| 17502 | 1217 | M12156 | N | (Heterogeneous nuclear ribonucleoprotein at 98DE, | heterogeneous nuclear ribonucleoprotein A1 |
| | | | | heterogeneous nuclear ribonucleoprotein A1) | |
| 25682 | 1530 | X16933 | N | (heterogeneous nuclear ribonucleoprotein D, heterogeneous | (heterogeneous nuclear ribonucleoprotein D, heterogeneous nuclear |
| | | | | nuclear ribonucleoprotein D (AU-rich element RNA binding | ribonucleoprotein D (AU-rich element RNA binding protein 1, |
| | | | | protein 1, 37 kDa)) | 37 kDa)) |
| 19834 | 1080 | D14048 | E | (heterogeneous nuclear ribonucleoprotein U, heterogeneous | (heterogeneous nuclear ribonucleoprotein U, heterogeneous nuclear |
| | | | | nuclear ribonucleoprotein U (scaffold attachment factor A)) | ribonucleoprotein U (scaffold attachment factor A)) |
| 19110 | 1289 | M64986 | A, J | (high-mobility group box 1, similar to Amphoterin) | high-mobility group box 1 |
| 24428 | 1074 | D13126 | N | (hippocalcin-like 1, similar to neural visinin-like Ca2+-binding | hippocalcin-like 1 |
| | | | | protein type 3) | |
| 17345 | 202 | AA892014 | E | (HLA-B associated transcript 1, HLA-B-associated transcript 1A) | (HLA-B associated transcript 1, HLA-B-associated transcript 1A) |
| 25279 | 1092 | D30740 | C | (hm: zehn0976, tyrosine 3-monooxygenase/tryptophan 5- | tyrosine 3-monooxygenase/tryptophan 5-monooxygenase activation |
| | | | | monooxygenase activation protein, zeta polypeptide) | protein, zeta polypeptide |
| 14929 | 802 | AI170353 | M, G, K | (hm: zehp0199, ribosomal protein L21) | ribosomal protein L21 |
| 20772 | 1470 | U60882 | N | (HMT1 hnRNP methyltransferase-like 2 (S. cerevisiae), | (HMT1 hnRNP methyltransferase-like 2 (S. cerevisiae), |
| | | | | heterogeneous nuclear ribonucleoproteins methyltransferase- | heterogeneous nuclear ribonucleoproteins methyltransferase-like 2 |
| | | | | like 2 (S. cerevisiae)) | (S. cerevisiae)) |
| 783 | 1011 | AI236589 | F | (hormone sensitive lipase, lipase, hormone sensitive, lipase, | (lipase, hormone sensitive, lipase, hormone-sensitive) |
| | | | | hormone-sensitive) | |
| 11840 | 1604 | Y15068 | H, I | (Hsp70/Hsp90 organizing protein homolog, stress-induced | (stress-induced phosphoprotein 1, stress-induced-phosphoprotein 1 |
| | | | | phosphoprotein 1, stress-induced-phosphoprotein 1 | (Hsp70/Hsp90-organizing protein)) |
| | | | | (Hsp70/Hsp90-organizing protein)) | |
| 23045 | 480 | AF034218 | N | (hyaluronidase 1, hyaluronoglucosaminidase 1) | (hyaluronidase 1, hyaluronoglucosaminidase 1) |
| 15175 | 355 | AA945583 | E | (hydroxyacyl-Coenzyme A dehydrogenase type II, hydroxyacyl- | (hydroxyacyl-Coenzyme A dehydrogenase type II, hydroxyacyl- |
| | | | | Coenzyme A dehydrogenase, type II, scully) | Coenzyme A dehydrogenase, type II) |
| 275 | 1434 | U22424 | M | (hydroxysteroid (11-beta) dehydrogenase 2, hydroxysteroid 11- | (hydroxysteroid (11-beta) dehydrogenase 2, hydroxysteroid 11-beta |
| | | | | beta dehydrogenase 2) | dehydrogenase 2) |
| 18612 | 904 | AI228624 | G | (hypothetical gene supported by AK036061, ribosomal protein | ribosomal protein L29 |
| | | | | L29) | |
| 16204 | 1505 | X06423 | M, N, G | (hypothetical gene supported by X73829; AK011058; AK012665; | ribosomal protein S8 |
| | | | | AK019223; AK088660; BC027217; NM_009098, mg: ab03d05, | |
| | | | | ribosomal protein S8 | |
| 16205 | 1505 | X06423 | N, F | (hypothetical gene supported by X73829; AK011058; AK012665; | ribosomal protein S8 |
| | | | | AK019223; AK088660; BC027217; NM_009098, mg: ab03d05, | |
| | | | | ribosomal protein S8) | |
| 4589 | 498 | AF062389 | M, N, D | (hypothetical protein LOC123876, hypothetical protein | (hypothetical protein LOC123876, hypothetical protein MGC37245) |
| | | | | MGC37245) | |
| 24459 | 1154 | J03886 | C | (hypothetical protein LOC228785, myosin light chain kinase 2, | (hypothetical protein LOC228785, myosin light chain kinase 2, |
| | | | | skeletal muscle) | skeletal muscle) |
| 15138 | 543 | AI009801 | C | (hypothetical protein LOC284889, macrophage migration | (hypothetical protein LOC284889, macrophage migration inhibitory |
| | | | | inhibitory factor) | factor) |
| 15137 | 1385 | S73424 | L | (hypothetical protein LOC284889, macrophage migration | (hypothetical protein LOC284889, macrophage migration inhibitory |
| | | | | inhibitory factor) | factor) |
| 1949 | 1431 | U19614 | A | (hypothetical protein MGC6357, lamina-associated polypeptide | (hypothetical protein MGC6357, lamina-associated polypeptide 1B) |
| | | | | 1B) | |
| 9952 | 170 | AA891422 | N | (hypoxia induced gene 1, similar to HSPC010) | |
| 17401 | 1196 | L25785 | M, B, G | (id: ibd5097, transforming growth factor beta 1 induced transcript | (transforming growth factor beta 1 induced transcript 4, transforming |
| | | | | 4, transforming growth factor beta-stimulated protein TSC-22) | growth factor beta-stimulated protein TSC-22) |
| 10248 | 1193 | L23148 | N | (inhibitor of DNA binding 1, inhibitor of DNA binding 1, dominant | (inhibitor of DNA binding 1, inhibitor of DNA binding 1, dominant |
| | | | | negative helix-loop-helix protein) | negative helix-loop-helix protein) |
| 10464 | 1165 | J05510 | M, I | (Inositol 1,4,5,-tris-phosphate receptor, inositol 1,4,5- | inositol 1,4,5-triphosphate receptor, type 1 |
| | | | | triphosphate receptor, inositol 1,4,5-triphosphate receptor, type | |
| | | | | 1, similar to inositol 1,4,5-triphosphate receptor 1; InsP3R type I; | |
| | | | | Purkinje cell protein 1; opisthotonus) | |
| 21053 | 1226 | M15481 | M | (insulin-like growth factor 1, insulin-like growth factor 1 | (insulin-like growth factor 1, insulin-like growth factor 1 |
| | | | | (somatomedin C)) | (somatomedin C)) |
| 2554 | 1063 | D00913 | M, N | (intercellular adhesion molecule, intercellular adhesion molecule | (intercellular adhesion molecule, intercellular adhesion molecule 1 |
| | | | | 1 (CD54), human rhinovirus receptor) | (CD54), human rhinovirus receptor) |
| 2555 | 1063 | D00913 | M, C, I | (intercellular adhesion molecule, intercellular adhesion molecule | (intercellular adhesion molecule, intercellular adhesion molecule 1 |
| | | | | 1 (CD54), human rhinovirus receptor) | (CD54), human rhinovirus receptor) |
| 21659 | 560 | AI010584 | D | (interferon induced transmembrane protein 2 (1-8D), similar to | interferon induced transmembrane protein 2 (1-8D) |
| | | | | interferon-inducible protein 16) | |
| 17516 | 847 | AI176621 | A, E, L | (Iron regulatory protein 1B, aconitase 1, aconitase 1, soluble) | (aconitase 1, aconitase 1, soluble) |
| 1729 | 1342 | NM_019147 | N, B | (jagged 1, jagged 1 (Alagille syndrome), jagged3) | (jagged 1, jagged 1 (Alagille syndrome)) |
| 5384 | 166 | AA891041 | I | (Jun-B oncogene, Jun-related antigen, jun B proto-oncogene) | (Jun-B oncogene, jun B proto-oncogene) |
| 20161 | 1543 | X54686 | M, C, I | (Jun-B oncogene, Jun-related antigen, jun B proto-oncogene) | (Jun-B oncogene, jun B proto-oncogene) |
| 16726 | 1352 | NM_031855 | M, N, E, G, H, I | (ketohexokinase, ketohexokinase (fructokinase)) | (ketohexokinase, ketohexokinase (fructokinase)) |
| 11421 | 55 | AA818199 | E | (KH domain containing, RNA binding, signal transduction | KH domain containing, RNA binding, signal transduction associated 1 |
| | | | | associated 1, wu: fc56c11) | |
| 794 | 1476 | U68168 | M, I | (kynureninase, kynureninase (L-kynurenine hydrolase)) | kynureninase (L-kynurenine hydrolase) |
| 17807 | 1270 | M54926 | M, G | (lactate dehydrogenase A, lactate dehydrogenase A4) | lactate dehydrogenase A |
| 4723 | 515 | AF093773 | N | (lactate dehydrogenase, malate dehydrogenase 1, NAD | (malate dehydrogenase 1, NAD (soluble), malate dehydrogenase, |
| | | | | (soluble), malate dehydrogenase, soluble) | soluble) |
| 20086 | 590 | AI013260 | M, H | (Lamin, lamin A, lamin A/C) | (lamin A, lamin A/C) |
| 20085 | 1572 | X66870 | C | (Lamin, lamin A, lamin A/C) | (lamin A, lamin A/C) |
| 16871 | 1428 | U18314 | N, E | (lamina-associated protein 2, thymopoietin) | thymopoietin |
| 22434 | 1333 | NM_012974 | F | (laminin, beta 1, laminin, beta 2 (laminin S), similar to laminin, | laminin, beta 2 (laminin S) |
| | | | | beta 2) | |
| 16444 | 502 | AF065438 | N | (lectin, galactoside-binding, soluble, 3 binding protein, | (lectin, galactoside-binding, soluble, 3 binding protein, peptidylprolyl |
| | | | | peptidylprolyl isomerase C-associated protein) | isomerase C-associated protein) |
| 14978 | 858 | AI177386 | F | (Leukocyte-antigen-related-like, protein tyrosine phosphatase, | protein tyrosine phosphatase, receptor type, S |
| | | | | receptor type, S, protein-tyrosine phosphatase with fibronectin | |
| | | | | type III-like domains (DPTP and LAR like)) | |
| 10260 | 1393 | S81497 | N | (lipase A, lysosomal acid, cholesterol esterase (Wolman | (lipase A, lysosomal acid, cholesterol esterase (Wolman disease), |
| | | | | disease), lysosomal acid lipase 1) | lysosomal acid lipase 1) |
| 25563 | 1393 | S81497 | N | (lipase A, lysosomal acid, cholesterol esterase (Wolman | (lipase A, lysosomal acid, cholesterol esterase (Wolman disease), |
| | | | | disease), lysosomal acid lipase 1) | lysosomal acid lipase 1) |
| 1809 | 372 | AA946503 | G, K | (lipocalin 2, lipocalin 2 (oncogene 24p3)) | (lipocalin 2, lipocalin 2 (oncogene 24p3)) |
| 20753 | 43 | AA801441 | M, N, C, I | (Lissencephaly-1, platelet-activating factor acetylhydrolase, | (platelet-activating factor acetylhydrolase, isoform 1b, beta1 subunit, |
| | | | | isoform 1b, beta1 subunit, platelet-activating factor | platelet-activating factor acetylhydrolase, isoform Ib, alpha subunit |
| | | | | acetylhydrolase, isoform Ib, alpha subunit 45 kDa) | 45 kDa) |
| 15110 | 182 | AA891764 | M, I | (low density lipid receptor-rlated protein, low density lipoprotein | (low density lipoprotein receptor-related protein 2, low density |
| | | | | receptor-related protein 2, low density lipoprotein-related protein | lipoprotein-related protein 2) |
| | | | | 2) | |
| 15111 | 1205 | L34049 | M, I | (low density lipid receptor-rlated protein, low density lipoprotein | (low density lipoprotein receptor-related protein 2, low density |
| | | | | receptor-related protein 2, low density lipoprotein-related protein | lipoprotein-related protein 2) |
| | | | | 2) | |
| 15112 | 1205 | L34049 | N, I | (low density lipid receptor-rlated protein, low density lipoprotein | (low density lipoprotein receptor-related protein 2, low density |
| | | | | receptor-related protein 2, low density lipoprotein-related protein | lipoprotein-related protein 2) |
| | | | | 2) | |
| 21653 | 1022 | AI237535 | M, C, K | (LPS-induced TN factor, lipopolysaccharide-induced TNF factor) | (LPS-induced TN factor, lipopolysaccharide-induced TNF factor) |
| 21654 | 1460 | U53184 | M, I, L | (LPS-induced TN factor, lipopolysaccharide-induced TNF factor) | (LPS-induced TN factor, lipopolysaccharide-induced TNF factor) |
| 12450 | 729 | AI103955 | C | (LRP16 protein, RIKEN cDNA D930010J01 gene) | (LRP16 protein, RIKEN cDNA D930010J01 gene) |
| 15242 | 459 | AB017912 | D | (MAD homolog 2 (Drosophila), MAD, mothers against | (MAD homolog 2 (Drosophila), MAD, mothers against |
| | | | | decapentaplegic homolog 2 (Drosophila)) | decapentaplegic homolog 2 (Drosophila)) |
| 15243 | 459 | AB017912 | N | (MAD homolog 2 (Drosophila), MAD, mothers against | (MAD homolog 2 (Drosophila), MAD, mothers against |
| | | | | decapentaplegic homolog 2 (Drosophila)) | decapentaplegic homolog 2 (Drosophila)) |
| 165 | 778 | AI145329 | F | (malate dehydrogenase 2, NAD (mitochondrial), malate | (malate dehydrogenase 2, NAD (mitochondrial), malate |
| | | | | dehydrogenase, mitochondrial) | dehydrogenase, mitochondrial) |
| 13563 | 979 | AI233773 | E | (MAWD binding protein, RIKEN cDNA 0610038K03 gene) | (MAWD binding protein, RIKEN cDNA 0610038K03 gene) |
| 18070 | 462 | AF003008 | M, N | (MAX interacting protein 1, Max interacting protein 1, max | (MAX interacting protein 1, Max interacting protein 1) |
| | | | | interacting protein) | |
| 16676 | 1033 | AI639082 | N, E | (MCM6 minichromosome maintenance deficient 6 (MIS5 | (MCM6 minichromosome maintenance deficient 6 (MIS5 homolog, |
| | | | | homolog, S. pombe) (S. cerevisiae), Minichromosome | S. pombe) (S. cerevisiae), minichromosome maintenance deficient 6 |
| | | | | maintenance 6, minichromosome maintenance deficient 6 (MIS5 | (MIS5 homolog, S. pombe) (S. cerevisiae)) |
| | | | | homolog, S. pombe) (S. cerevisiae)) | |
| 16674 | 1425 | U17565 | E | (MCM6 minichromosome maintenance deficient 6 (MIS5 | (MCM6 minichromosome maintenance deficient 6 (MIS5 homolog, |
| | | | | homolog, S. pombe) (S. cerevisiae), Minichromosome | S. pombe) (S. cerevisiae), minichromosome maintenance deficient 6 |
| | | | | maintenance 6, minichromosome maintenance deficient 6 (MIS5 | (MIS5 homolog, S. pombe) (S. cerevisiae)) |
| | | | | homolog, S. pombe) (S. cerevisiae)) | |
| 16675 | 1425 | U17565 | N, E | (MCM6 minichromosome maintenance deficient 6 (MIS5 | (MCM6 minichromosome maintenance deficient 6 (MIS5 homolog, |
| | | | | homolog, S. pombe) (S. cerevisiae), Minichromosome | S. pombe) (S. cerevisiae), minichromosome maintenance deficient 6 |
| | | | | maintenance 6, minichromosome maintenance deficient 6 (MIS5 | (MIS5 homolog, S. pombe) (S. cerevisiae)) |
| | | | | homolog, S. pombe) (S. cerevisiae)) | |
| 16849 | 292 | AA894298 | N | (membrane metallo endopeptidase, membrane metallo- | (membrane metallo endopeptidase, membrane metallo- |
| | | | | endopeptidase (neutral endopeptidase, enkephalinase, CALLA, | endopeptidase (neutral endopeptidase, enkephalinase, CALLA, |
| | | | | CD10), neprilysin) | CD10)) |
| 5837 | 1363 | S43408 | M, N, F | (meprin 1 alpha, meprin A, alpha (PABA peptide hydrolase)) | (meprin 1 alpha, meprin A, alpha (PABA peptide hydrolase)) |
| 5838 | 1363 | S43408 | M, F, G | (meprin 1 alpha, meprin A, alpha (PABA peptide hydrolase)) | (meprin 1 alpha, meprin A, alpha (PABA peptide hydrolase)) |
| 1409 | 589 | AI012802 | M, A, C, E, F | (Metallo-beta-lactamase superfamily, hydroxyacyl glutathione | hydroxyacyl glutathione hydrolase |
| | | | | hydrolase) | |
| 15190 | 705 | AI102562 | M, N | (metallothionein 1, metallothionein 1K) | (metallothionein 1, metallothionein 1K) |
| 15189 | 1215 | M11794 | N, B | (metallothionein 1, metallothionein 1K) | (metallothionein 1, metallothionein 1K) |
| 8984 | 1180 | L10652 | D | (methionine aminopeptidase 2, methionyl aminopeptidase 2, | (methionine aminopeptidase 2, methionyl aminopeptidase 2) |
| | | | | uninitiated) | |
| 1549 | 1166 | J05519 | G | (methylenetetrahydrofolate dehydrogenase (NADP+ dependent), | (methylenetetrahydrofolate dehydrogenase (NADP+ dependent), |
| | | | | methenyltetrahydrofolate cyclohydrolase, formyltetrahydrofolate | methenyltetrahydrofolate cyclohydrolase, formyltetrahydrofolate |
| | | | | synthase, methylenetetrahydrofolate dehydrogenase (NADP+ | synthase, methylenetetrahydrofolate dehydrogenase (NADP+ |
| | | | | dependent), methenyltetrahydrofolate cyclohydrolase, | dependent), methenyltetrahydrofolate cyclohydrolase, |
| | | | | formyltetrahydrofolate synthetase, tetrahydrofolate synthase) | formyltetrahydrofolate synthetase) |
| 23606 | 1406 | U05784 | N | (microtubule-associated protein 1 light chain 3, microtubule- | (microtubule-associated protein 1 light chain 3, microtubule- |
| | | | | associated protein 1 light chain 3 beta) | associated protein 1 light chain 3 beta) |
| 23300 | 1488 | U84727 | N | (mitochrondrial 2-oxoglutarate/malate carrier protein, solute | solute carrier family 25 (mitochondrial carrier; oxoglutarate carrier), |
| | | | | carrier family 25 (mitochondrial carrier; oxoglutarate carrier), | member 11 |
| | | | | member 11, wu: fa07h09) | |
| 1453 | 1456 | U48596 | F, K | (mitogen-activated protein kinase kinase kinase 1, similar to | mitogen-activated protein kinase kinase kinase 1 |
| | | | | Mitogen-activated protein kinase kinase kinase 1 (MAPK/ERK | |
| | | | | kinase kinase 1) (MEK kinase 1) (MEKK 1)) | |
| 1454 | 1456 | U48596 | M, K | (mitogen-activated protein kinase kinase kinase 1, similar to | mitogen-activated protein kinase kinase kinase 1 |
| | | | | Mitogen-activated protein kinase kinase kinase 1 (MAPK/ERK | |
| | | | | kinase kinase 1) (MEK kinase 1) (MEKK 1)) | |
| 17324 | 495 | AF056031 | M | (Monooxygenase, cinnabar, kynurenine 3-monooxygenase | kynurenine 3-monooxygenase (kynurenine 3-hydroxylase) |
| | | | | (kynurenine 3-hydroxylase)) | |
| 11454 | 1245 | M24604 | M | (mutagen-sensitive 209, proliferating cell nuclear antigen) | proliferating cell nuclear antigen |
| 11455 | 1245 | M24604 | M | (mutagen-sensitive 209, proliferating cell nuclear antigen) | proliferating cell nuclear antigen |
| 24437 | 1239 | M22357 | A | (myelin associated glycoprotein, myelin-associated glycoprotein) | (myelin associated glycoprotein, myelin-associated glycoprotein) |
| 11483 | 470 | AF020618 | M, I | (myeloid differentiation primary response gene 116, protein | (myeloid differentiation primary response gene 116, protein |
| | | | | phosphatase 1, regulatory (inhibitor) subunit 15A) | phosphatase 1, regulatory (inhibitor) subunit 15A) |
| 18043 | 470 | AF020618 | F | (myeloid differentiation primary response gene 116, protein | (myeloid differentiation primary response gene 116, protein |
| | | | | phosphatase 1, regulatory (inhibitor) subunit 15A) | phosphatase 1, regulatory (inhibitor) subunit 15A) |
| 1970 | 1446 | U31463 | N, K | (myosin heavy chain IX, myosin, heavy polypeptide 9, non- | (myosin heavy chain IX, myosin, heavy polypeptide 9, non-muscle) |
| | | | | muscle, zipper) | |
| 20483 | 1524 | X15939 | N | (Myosin heavy chain, myosin, heavy polypeptide 7, cardiac | myosin, heavy polypeptide 7, cardiac muscle, beta |
| | | | | muscle, beta) | |
| 1104 | 497 | AF058714 | N | (Na+/sulphate co-transporter like, solute carrier family 13 | solute carrier family 13 (sodium-dependent dicarboxylate |
| | | | | (sodium-dependent dicarboxylate transporter), member 2) | transporter), member 2 |
| 25707 | 1558 | X59677 | N | (Na+/sulphate co-transporter like, solute carrier family 13 | solute carrier family 13 (sodium-dependent dicarboxylate |
| | | | | sodium-dependent dicarboxylate transporter), member 2) | transporter) member 2 |
| 21211 | 433 | AB000098 | C | (NADH dehydrogenase (ubiquinone) flavoprotein 3, 10 kDa, | (NADH dehydrogenase (ubiquinone) flavoprotein 3, 10 kDa, RIKEN |
| | | | | RIKEN cDNA 1500032D16 gene) | cDNA 1500032D16 gene) |
| 14638 | 765 | AI137049 | J | (Nijmegen breakage syndrome 1 (nibrin), nibrin) | (Nijmegen breakage syndrome 1 (nibrin), nibrin) |
| 570 | 1590 | X82445 | N | (nuclear distribution gene C homolog (A. nidulans), nuclear | (nuclear distribution gene C homolog (A. nidulans), nuclear |
| | | | | distribution gene C homolog (Aspergillus)) | distribution gene C homolog (Aspergillus)) |
| 1597 | 468 | AF014503 | L | (nuclear protein 1, p8 protein (candidate of metastasis 1)) | (nuclear protein 1, p8 protein (candidate of metastasis 1)) |
| 20035 | 422 | AA997933 | M, H | (nucleolar protein 5, nucleolar protein NOP5/NOP58) | (nucleolar protein 5, nucleolar protein NOP5/NOP58) |
| 25198 | 504 | AF069782 | M, N, I, K | (nucleolar protein 5, nucleolar protein NOP5/NOP58) | (nucleolar protein 5, nucleolar protein NOP5/NOP58) |
| 8829 | 1271 | M55015 | M, A, F, K | (nucleolin, wu: fa12d03) | nucleolin |
| 17394 | 1156 | J03969 | M, N, L | (nucleophosmin (nucleolar phosphoprotein B23, numatrin), | (nucleophosmin (nucleolar phosphoprotein B23, numatrin), |
| | | | | nucleophosmin 1) | nucleophosmin 1) |
| 17393 | 1159 | J04943 | M, N, | (nucleophosmin (nucleolar phosphoprotein B23, numatrin), | (nucleophosmin (nucleolar phosphoprotein B23, numatrin), |
| | | | | nucleophosmin 1) | nucleophosmin 1) |
| 1401 | 1494 | U93692 | J | (nucleoporin, nucleoporin 88 kDa) | (nucleoporin, nucleoporin 88 kDa) |
| 22927 | 127 | AA859920 | N, E | (Nucleosome assembly protein 1, nucleosome assembly protein | nucleosome assembly protein 1-like 1 |
| | | | | 1-like 1) | |
| 16006 | 499 | AF062594 | M | (Nucleosome assembly protein 1, nucleosome assembly protein | nucleosome assembly protein 1-like 1 |
| | | | | 1-like 1) | |
| 16007 | 499 | AF062594 | N, E | (Nucleosome assembly protein 1, nucleosome assembly protein | nucleosome assembly protein 1-like 1 |
| | | | | 1-like 1) | |
| 7665 | 622 | AI030668 | E | (Nucleosome assembly protein 1, nucleosome assembly protein | nucleosome assembly protein 1-like 1 |
| | | | | 1-like 1) | |
| 4242 | 276 | AA893325 | N | (ornithine aminotransferase, ornithine aminotransferase (gyrate | (ornithine aminotransferase, ornithine aminotransferase (gyrate |
| | | | | atrophy, ornithine aminotransferse precursor) | atrophy)) |
| 25467 | 1321 | M93297 | N, G | (ornithine aminotransferase, ornithine aminotransferase (gyrate | (ornithine aminotransferase, ornithine aminotransferase (gyrate |
| | | | | atrophy), ornithine aminotransferse precursor) | atrophy)) |
| 23523 | 1509 | X07944 | N | (Ornithine decarboxylase 1, ornithine decarboxylase, ornithine | ornithine decarboxylase 1 |
| | | | | decarboxylase 1, similar to Ornithine decarboxylase (ODC)) | |
| 25589 | 1432 | U21718 | F | (PAI-1 mRNA-binding protein, similar to PAI-1 mRNA-binding | (PAI-1 mRNA-binding protein, similar to PAI-1 mRNA-binding |
| | | | | protein; chromodomain helicase DNA binding protein 3 | protein; chromodomain helicase DNA binding protein 3 interacting |
| | | | | interacting protein) | protein) |
| 4392 | 906 | AI228674 | H | (Peptidyl-prolyl cis-trans isomerases, peptidylprolyl isomerase A, | (peptidylprolyl isomerase A, peptidylprolyl isomerase A (cyclophilin |
| | | | | peptidylprolyl isomerase A (cyclophilin A)) | A)) |
| 19252 | 204 | AA892041 | H | (Peroxiredoxin 6005, peroxiredoxin 6) | peroxiredoxin 6 |
| 19254 | 467 | AF014009 | H | (Peroxiredoxin 6005, peroxiredoxin 6) | peroxiredoxin 6 |
| 4290 | 1058 | AJ224120 | L | (peroxisomal biogenesis factor 11A, peroxisomal biogenesis | (peroxisomal biogenesis factor 11A, peroxisomal biogenesis factor |
| | | | | factor 11a) | 11a) |
| 405 | 1575 | X70223 | M, H, K | (peroxisomal membrane protein 2, peroxisomal membrane | (peroxisomal membrane protein 2, peroxisomal membrane protein |
| | | | | protein 2, 22 kDa) | 2, 22 kDa) |
| 21029 | 24 | AA799981 | C | (Phorbol esters/diacylglycerol binding domain (2 domains), | protein kinase C, eta |
| | | | | Protein kinase C terminal domain, Protein C kinase 98E, protein | |
| | | | | kinase C, eta) | |
| 23538 | 708 | AI102727 | M | (phosphate permease, solute carrier family 20 (phosphate | (solute carrier family 20 (phosphate transporter), member 1, solute |
| | | | | transporter), member 1, solute carrier family 20, member 1, | carrier family 20, member 1) |
| | | | | wu: fa05g12) | |
| 1340 | 1437 | U25651 | B | (Phosphofructokinase, phosphofructokinase, muscle) | phosphofructokinase, muscle |
| 1312 | 1255 | M31788 | J | (Phosphoglycerate kinase, phosphoglycerate kinase, | phosphoglycerate kinase 1 |
| | | | | phosphoglycerate kinase 1, similar to phosphoglycerate kinase | |
| | | | | 1) | |
| 16147 | 1459 | U51898 | M, N | (phospholipase A2, group VI, phospholipase A2, group VI | (phospholipase A2, group VI, phospholipase A2, group VI (cytosolic, |
| | | | | (cytosolic, calcium-independent)) | calcium-independent)) |
| 20414 | 1188 | L14323 | M | (phospholipase C, beta 1, phospholipase C, beta 1 | (phospholipase C, beta 1, phospholipase C, beta 1 |
| | | | | (phosphoinositide-specific)) | (phosphoinositide-specific)) |
| 1535 | 437 | AB000778 | F | (phospholipase D1, phospholipase D1, phophatidylcholine- | (phospholipase D1, phospholipase D1, phophatidylcholine-specific) |
| | | | | specific) | |
| 13369 | 1087 | D21132 | D | (phosphotidylinositol transfer protein, beta, vibrator) | phosphotidylinositol transfer protein, beta |
| 1141 | 1557 | X59601 | M, C, G | (plectin 1, intermediate filament binding protein 500 kDa, short | plectin 1, intermediate filament binding protein 500 kDa |
| | | | | stop) | |
| 6577 | 1506 | X06942 | F | (pole hole, raf-related oncogene, v-raf murine sarcoma 3611 viral | (raf-related oncogene, v-raf murine sarcoma 3611 viral oncogene |
| | | | | oncogene homolog 1) | homolog 1) |
| 1798 | 354 | AA945569 | M, D | (pregnancy zone protein, similar to alpha-2-macroglobulin) | |
| 20481 | 1240 | M22631 | M, N, G, K | (propionyl Coenzyme A carboxylase, alpha polypeptide, | (propionyl Coenzyme A carboxylase, alpha polypeptide, propionyl- |
| | | | | propionyl-Coenzyme A carboxylase, alpha polypeptide) | Coenzyme A carboxylase, alpha polypeptide) |
| 15599 | 1580 | X75253 | J | (prostatic binding protein, similar to hippocampal cholinergic | prostatic binding protein |
| | | | | neurostimulating peptide precursor protein) | |
| 18751 | 93 | AA851169 | G | (proteasome (prosome, macropain) 28 subunit, beta, | (proteasome (prosome, macropain) 28 subunit, beta, proteasome |
| | | | | proteasome (prosome, macropain) activator subunit 2 (PA28 | (prosome, macropain) activator subunit 2 (PA28 beta)) |
| | | | | beta), proteasome activator subunit 2) | |
| 18750 | 1105 | D45250 | N, G | (proteasome (prosome, macropain) 28 subunit, beta, | (proteasome (prosome, macropain) 28 subunit, beta proteasome |
| | | | | proteasome (prosome, macropain) activator subunit 2 (PA28 | (prosome, macropain) activator subunit 2 (PA28 beta)) |
| | | | | beta), proteasome activator subunit 2) | |
| 3987 | 1122 | D90258 | M, N | (proteasome (prosome, macropain) subunit, alpha type 3, | (proteasome (prosome, macropain) subunit, alpha type 3, |
| | | | | proteasome (prosome, macropain) subunit, alpha type, 3) | proteasome (prosome, macropain) subunit, alpha type, 3) |
| 15538 | 758 | AI112633 | L | (proteasome (prosome, macropain) subunit, alpha type 6, | (proteasome (prosome, macropain) subunit, alpha type 6, |
| | | | | (proteasome (prosome, macropain) subunit alpha type, 6, | proteasome (prosome, macropain) subunit, alpha type, 6) |
| | | | | proteasome (prosome, macropain) subunit, alpha type, 6a) | |
| 15535 | 1069 | D10755 | L | (proteasome (prosome, macropain) subunit, alpha type 6, | (proteasome (prosome, macropain) subunit, alpha type 6, |
| | | | | proteasome (prosome, macropain) subunit, alpha type 6, | proteasome (prosome, macropain) subunit, alpha type, 6) |
| | | | | proteasome (prosome, macropain) subunit, alpha type, 6a) | |
| 25253 | 1068 | D10754 | H | (proteasome (prosome, macropain) subunit beta type 6, | (proteasome (prosome, macropain) subunit, beta type 6, |
| | | | | proteasome (prosome, macropain) subunit, beta type, 6) | proteasome (prosome, macropain) subunit, beta type, 6) |
| 1447 | 1545 | X55986 | D | (Proteasome 29 kD subunit, endopeptidase, proteasome | (proteasome (prosome, macropain) subunit, alpha type 4, |
| | | | | (prosome, macropain) subunit, alpha type 4, proteasome | proteasome (prosome, macropain) subunit, alpha type, 4) |
| | | | | (prosome, macropain) subunit, alpha type, 4) | |
| 3254 | 1070 | D10756 | N, L | (Proteasome alpha subunit, proteasome (prosome, macropain) | (proteasome (prosome, macropain) subunit, alpha type 5, |
| | | | | subunit, alpha type 5, proteasome (prosome, macropain) | proteasome (prosome, macropain) subunit, alpha type, 5) |
| | | | | subunit, alpha type, 5) | |
| 556 | 1569 | X64336 | M, N | (protein C, protein C (inactivator of coagulation factors Va and | (protein C, protein C (inactivator of coagulation factors Va and |
| | | | | VIIIa)) | VIIIa)) |
| 25405 | 1230 | M18330 | N | (protein kinase, protein kinase C, delta) | protein kinase C, delta |
| 3202 | 1527 | X16043 | N | (protein phosphatase 2 (formerly 2A), catalytic subunit, alpha | (protein phosphatase 2 (formerly 2A), catalytic subunit, alpha |
| | | | | isoform, protein phosphatase 2a, catalytic subunit, alpha isoform) | isoform, protein phosphatase 2a, catalytic subunit, alpha isoform) |
| 245 | 1107 | D45412 | J | (Protein tyrosine phosphatase 10D, protein tyrosine | protein tyrosine phosphatase, receptor type, O |
| | | | | phosphatase, receptor type, O) | |
| 247 | 1443 | U28938 | J | (Protein tyrosine phosphatase 10D, protein tyrosine | protein tyrosine phosphatase, receptor type, O |
| | | | | phosphatase, receptor type, O) | |
| 24219 | 1200 | L27843 | M, L | (protein tyrosine phosphatase 4a1, protein tyrosine phosphatase | (protein tyrosine phosphatase 4a1, protein tyrosine phosphatase |
| | | | | type IVA, member 1, protein-tyrosine phosphotase) | type IVA, member 1) |
| 1844 | 1261 | M33962 | J | (Protein tyrosine phosphatase 61F, hypothetical gene supported | protein tyrosine phosphatase, non-receptor type 1 |
| | | | | by AK085713, protein tyrosine phosphatase 1b, protein tyrosine | |
| | | | | phosphatase, non-receptor type 1) | |
| 15761 | 500 | AF062741 | B | (putative pyruvate dehydrogenase phosphatase isoenzyme 2, | pyruvate dehydrogenase phosphatase isoenzyme 2 |
| | | | | pyruvate dehydrogenase phosphatase isoenzyme 2, similar to | |
| | | | | [Pyruvate dehydrogenase [Lipoamide]]-phosphatase 2, | |
| | | | | mitochondrial precursor (PDP 2) (Pyruvate dehydrogenase | |
| | | | | phosphatase, catalytic subunit 2) (PDPC 2)) | |
| 24235 | 169 | AA891286 | M, N, H, I | (pyridine nucleotide-disulphide oxidoreductase, thioredoxin | thioredoxin reductase 1 |
| | | | | reductase 1) | |
| 24234 | 1474 | U63923 | M, A, I | (pyridine nucleotide-disulphide oxidoreductase, thioredoxin | thioredoxin reductase 1 |
| | | | | reductase 1) | |
| 1928 | 1418 | U10357 | N | (Pyruvate dehydrogenase kinase, pyruvate dehydrogenase | pyruvate dehydrogenase kinase, isoenzyme 2 |
| | | | | kinase, isoenzyme 2) | |
| 1929 | 1418 | U10357 | N, A, C, D, E | (Pyruvate dehydrogenase kinase, pyruvate dehydrogenase | pyruvate dehydrogenase kinase, isoenzyme 2 |
| | | | | kinase, isoenzyme 2) | |
| 20513 | 1503 | X05684 | N | (Pyruvate kinase, pyruvate kinase liver and red blood cell, | (pyruvate kinase liver and red blood cell, pyruvate kinase, liver and |
| | | | | pyruvate kinase, liver and RBC) | RBC) |
| 240 | 1297 | M75153 | N | (RAB11A, member RAS oncogene family, RAB11a, member | (RAB11A, member RAS oncogene family, RAB11a, member RAS |
| | | | | RAS oncogene family) | oncogene family) |
| 24651 | 1306 | M83678 | N | (RAB13, member RAS oncogene family, hm: zeh0455) | RAB13, member RAS oncogene family |
| 20831 | 1307 | M83680 | B | (RAB14, member RAS oncogene family, RAS-related protein, | RAB14, member RAS oncogene family |
| | | | | Rab-protein 14) | |
| 9541 | 300 | AA900505 | N, L | (ras homolog gene family, member AB, ras homolog gene family, | (ras homolog gene family, member AB, ras homolog gene family, |
| | | | | member B) | member B) |
| 28 | 1093 | D31662 | M, F, G, I, J, L | (regucalcin, regucalcin (senescence marker protein-30)) | (regucalcin, regucalcin (senescence marker protein-30)) |
| 15790 | 478 | AF032120 | E | (regulator of G-protein signaling 19 interacting protein 1, | (regulator of G-protein signaling 19 interacting protein 1, regulator of |
| | | | | regulator of G-protein signalling 19 interacting protein 1) | G-protein signalling 19 interacting protein 1) |
| 15791 | 512 | AF089817 | C | (regulator of G-protein signaling 19 interacting protein 1, | (regulator of G-protein signaling 19 interacting protein 1, regulator of |
| | | | | regulator of G-protein signalling 19 interacting protein 1) | G-protein signalling 19 interacting protein 1) |
| 23806 | 1233 | M19257 | D | (retinol binding protein 1, cellular, similar to retinol binding protein | retinol binding protein 1, cellular |
| | | | | 1, cellular) | |
| 18108 | 1566 | X62528 | N | (ribonuclease/angiogenin inhibitor, ribonuclease/angiogenin | (ribonuclease/angiogenin inhibitor, ribonuclease/angiogenin inhibitor |
| | | | | inhibitor 1) | 1) |
| 24582 | 1528 | X16554 | D | (Ribose-phosphate pyrophosphokinase, phosphoribosyl | phosphoribosyl pyrophosphate synthetase 1 |
| | | | | pyrophosphate synthetase 1) | |
| 20812 | 356 | AA945611 | N | ribosomal protein 10, ribosomal protein L10) | (ribosomal protein 10, ribosomal protein L10) |
| 11849 | 1593 | X93352 | M, N, G | (ribosomal protein L10A, ribosomal protein L10a) | (ribosomal protein L10A, ribosomal protein L10a) |
| 19112 | 1036 | AI639157 | J | (Ribosomal protein L13, ribosomal protein L13) | ribosomal protein L13 |
| 23854 | 1585 | X78327 | N, G | (Ribosomal protein L13, ribosomal protein L13) | ribosomal protein L13 |
| 19268 | 530 | AI008641 | D | (Ribosomal protein L22, ribosomal protein L22) | ribosomal protein L22 |
| 4259 | 207 | AA892123 | N | (Ribosomal protein L36, ribosomal protein L36) | ribosomal protein L36 |
| 15875 | 1563 | X62145 | N | (Ribosomal protein L8, ribosomal protein L8) | |
| 25718 | 1563 | X62145 | M, G | (Ribosomal protein L8, ribosomal protein L8) | |
| 1069 | 1522 | X15096 | N | (Ribosomal protein P0, deoxyribonuclease, ribosomal protein, | similar to BLOCK 23 |
| | | | | large, P0, similar to 60S acidic ribosomal protein P0 (L10E), | |
| | | | | similar to BLOCK 23) | |
| 24615 | 1318 | M89646 | N, D | (ribosomal protein S24, similar to ribosomal protein S24) | ribosomal protein S24 |
| 20839 | 177 | AA891729 | N | (Ribosomal protein S27A, ribosomal protein S27a) | ribosomal protein S27a |
| 25686 | 1532 | X51536 | N, F | (Ribosomal protein S3, ribosomal protein S3) | |
| 10109 | 1555 | X58465 | N, G | Ribosomal protein S5, ribosomal protein S5) | |
| 25702 | 1555 | X58465 | N, G | Ribosomal protein S5, ribosomal protein S5) | |
| 18001 | 100 | AA858573 | M | (RIKEN cDNA 0610038O04 gene, secreted phosphoprotein 2, | (RIKEN cDNA 0610038O04 gene, secreted phosphoprotein 2, |
| | | | | 24 kDa) | 24 kDa) |
| 17999 | 1430 | U19485 | M | (RIKEN cDNA 0610038O04 gene, secreted phosphoprotein 2, | (RIKEN cDNA 0610038O04 gene, secreted phosphoprotein 2, |
| | | | | 24 kDa) | 24 kDa) |
| 18000 | 1430 | U19485 | I | (RIKEN cDNA 0610038O04 gene, secreted phosphoprotein 2, | (RIKEN cDNA 0610038O04 gene, secreted phosphoprotein 2, |
| | | | | 24 kDa) | 24 kDa) |
| 15277 | 989 | AI234889 | D | (RIKEN cDNA 1100001F19 gene, effete, ubiquitin-conjugating | (RIKEN cDNA 1100001F19 gene, ubiquitin-conjugating enzyme E2D |
| | | | | enzyme E2D 3 (UBC4/5 homolog, yeast)) | 3 (UBC4/5 homolog, yeast)) |
| 15273 | 1421 | U13177 | E | (RIKEN cDNA 1100001F19 gene, effete, ubiquitin-conjugating | (RIKEN cDNA 1100001F19 gene, ubiquitin-conjugating enzyme E2D |
| | | | | enzyme E2D 3 (UBC4/5 homolog, yeast)) | 3 (UBC4/5 homolog, yeast)) |
| 17758 | 1173 | K03249 | N | (RIKEN cDNA 1300002P22 gene, enoyl-Coenzyme A, | (RIKEN cDNA 1300002P22 gene, enoyl-Coenzyme A, hydratase/3- |
| | | | | hydratase/3-hydroxyacyl Coenzyme A dehydrogenase) | hydroxyacyl Coenzyme A dehydrogenase) |
| 20849 | 1502 | X05566 | M, G, K | (RIKEN cDNA 1500001M02 gene, death-associated protein 6, | (RIKEN cDNA 1500001M02 gene, death-associated protein 6, |
| | | | | myosin regulatory light chain 2, myosin regulatory light chain | myosin regulatory light chain MRCL3) |
| | | | | MRCL3, spaghetti squash) | |
| 8820 | 659 | AI070152 | B, H, L | (RIKEN cDNA 1700037B15 gene, similar to Smhs1 protein) | (RIKEN cDNA 1700037B15 gene, similar to Smhs1 protein) |
| 1867 | 91 | AA850940 | N | (RIKEN cDNA 2010004J23 gene, Ribosomal protein L1, | (RIKEN cDNA 2010004J23 gene, ribosomal protein L4) |
| | | | | ribosomal protein L1, ribosomal protein L4) | |
| 16847 | 1516 | X13549 | N | (RIKEN cDNA 2210402A09 gene, ribosomal protein S10) | (RIKEN cDNA 2210402A09 gene, ribosomal protein S10) |
| 25606 | 1461 | U53214 | C | (RIKEN cDNA 2410003M22 gene, tubulin-tyrosine ligase) | (RIKEN cDNA 2410003M22 gene, tubulin-tyrosine ligase) |
| 10667 | 1010 | AI236366 | C | (RIKEN cDNA 2410104I19 gene, RNA-binding protein, fuse- | (RIKEN cDNA 2410104I19 gene, fuse-binding protein-interacting |
| | | | | binding protein-interacting repressor, poly U binding factor 68 kD) | repressor) |
| 2367 | 516 | AF095741 | N | (RIKEN cDNA 2810484M10 gene, hypothetical protein | (RIKEN cDNA 2810484M10 gene, hypothetical protein FLJ22390) |
| | | | | FLJ22390) | |
| 2368 | 516 | AF095741 | N, K | (RIKEN cDNA 2810484M10 gene, hypothetical protein | (RIKEN cDNA 2810484M10 gene, hypothetical protein FLJ22390) |
| | | | | FLJ22390) | |
| 16929 | 1571 | X66370 | G | (RIKEN cDNA 3010033P07 gene, Ribosomal protein S9, | (RIKEN cDNA 3010033P07 gene, ribosomal protein S9) |
| | | | | ribosomal protein S9) | |
| 6290 | 790 | AI169232 | C | (RIKEN cDNA 3110039L19 gene, likely homolog of rat kinase D- | (RIKEN cDNA 3110039L19 gene, likely homolog of rat kinase D- |
| | | | | interacting substance of 220 kDa) | interacting substance of 220 kDa) |
| 23166 | 129 | AA859954 | M, C, L | (RIKEN cDNA 4930579A11 gene, likely ortholog of rat vacuole | (RIKEN cDNA 4930579A11 gene, likely ortholog of rat vacuole |
| | | | | membrane protein 1) | membrane protein 1) |
| 634 | 1170 | K01932 | N | (RIKEN cDNA 5730496E24 gene, glutathione S-transferase A3) | (RIKEN cDNA 5730496E24 gene, glutathione S-transferase A3) |
| 25525 | 1383 | S72505 | N | (RIKEN cDNA 5730496E24 gene, glutathione S-transferase A3) | (RIKEN cDNA 5730496E24 gene, glutathione S-transferase A3) |
| 635 | 1586 | X78848 | N | (RIKEN cDNA 5730496E24 gene, glutathione S-transferase A3) | (RIKEN cDNA 5730496E24 gene, glutathione S-transferase A3) |
| 24496 | 1312 | M85300 | M, N, I, K | (RIKEN cDNA 9030624O13 gene, solute carrier family 9 | (RIKEN cDNA 9030624O13 gene, solute carrier family 9 |
| | | | | (sodium/hydrogen exchanger), isoform 3, solute carrier family 9 | (sodium/hydrogen exchanger), isoform 3, solute carrier family 9 |
| | | | | (sodium/hydrogen exchanger), member 3) | (sodium/hydrogen exchanger), member 3) |
| 15703 | 444 | AB009372 | N | (RIKEN cDNA A530050D06 gene, chromosome 14 open reading | (RIKEN cDNA A530050D06 gene, chromosome 14 open reading |
| | | | | frame 76) | frame 76) |
| 15986 | 1602 | Y09945 | M, I | (RIKEN cDNA D630043A20 gene, solute carrier family 22 | (RIKEN cDNA D630043A20 gene, solute carrier family 22 (organic |
| | | | | (organic anion/cation transporter), member 9) | anion/cation transporter), member 9) |
| 19002 | 1043 | AI639465 | N | (ring finger protein 28, ring finger protein 30) | (ring finger protein 28, ring finger protein 30) |
| 19003 | 1043 | AI639465 | F | (ring finger protein 28, ring finger protein 30) | (ring finger protein 28, ring finger protein 30) |
| 21975 | 827 | AI172247 | N, B, L | (rosy, xanthine dehydrogenase) | xanthine dehydrogenase |
| 1382 | 438 | AB002406 | G | (RuvB-like 1 (E. coli), RuvB-like protein 1, Yeast hypothetical | (RuvB-like 1 (E. coli), RuvB-like protein 1) |
| | | | | 50.5 KD protein like, pontin) | |
| 19040 | 1152 | J03627 | M, C, G, K | (S100 calcium binding protein A10 (annexin II ligand, calpactin I, | (S100 calcium binding protein A10 (annexin II ligand, calpactin I, |
| | | | | light polypeptide (p11)), S100 calcium binding protein A10 | light polypeptide (p11)), S100 calcium binding protein A10 |
| | | | | (calpactin)) | (calpactin)) |
| 13618 | 929 | AI230724 | M, I | (SAC1 (supressor of actin mutations 1, homolog)-like (S. cerevisiae), | (SAC1 (supressor of actin mutations 1, homolog)-like (S. cerevisiae), |
| | | | | SAC1 suppressor of actin mutations 1-like (yeast), | SAC1 suppressor of actin mutations 1-like (yeast)) |
| | | | | Yeast recessive suppressor RSD1 like) | |
| 13542 | 247 | AA892798 | N, B | (sclerostin domain containing 1, sclerostin-like) | (cystine-knot containing secreted protein, sclerostin-like) |
| 2439 | 479 | AF032668 | A, F | (SEC15 (S. cerevisiae)-like, SEC15 homolog (S. cerevisiae)) | (SEC15 (S. cerevisiae)-like, SEC15 homolog (S. cerevisiae)) |
| 23651 | 1223 | M14656 | M, G, K | (secreted phosphoprotein 1, secreted phosphoprotein 1 | (secreted phosphoprotein 1, secreted phosphoprotein 1 |
| | | | | (osteopontin, bone sialoprotein I, early T-lymphocyte activation | (osteopontin, bone sialoprotein I, early T-lymphocyte activation 1)) |
| | | | | 1)) | |
| 21400 | 1266 | M36410 | C, F | (sepiapterin reductase, sepiapterin reductase (7,8- | (sepiapterin reductase, sepiapterin reductase (7,8- |
| | | | | dihydrobiopterin: NADP+ oxidoreductase)) | dihydrobiopterin: NADP+ oxidoreductase)) |
| 15540 | 1243 | M24067 | K | (serine (or cysteine) proteinase inhibitor, clade E (nexin, | (serine (or cysteine) proteinase inhibitor, clade E (nexin, |
| | | | | plasminogen activator inhibitor type 1), member 1, serine (or | plasminogen activator inhibitor type 1), member 1, serine (or |
| | | | | cysteine) proteinase inhibitor, clade E, member 1) | cysteine) proteinase inhibitor, clade E, member 1) |
| 3549 | 1181 | L11319 | N | (signal peptidase complex, signal peptidase complex (18 kD)) | (signal peptidase complex, signal peptidase complex (18 kD)) |
| 9125 | 67 | AA819338 | N | (signal sequence receptor, delta, signal sequence receptor, delta | (signal sequence receptor, delta, signal sequence receptor, delta |
| | | | | (translocon-associated protein delta)) | (translocon-associated protein delta)) |
| 343 | 1592 | X91810 | L | (signal transducer and activator of transcription 3, signal | (signal transducer and activator of transcription 3, signal transducer |
| | | | | transducer and activator of transcription 3 (acute-phase | and activator of transcription 3 (acute-phase response factor)) |
| | | | | response factor), signal transduction and activation of | |
| | | | | transcription 3) | |
| 23307 | 99 | AA851749 | D | (silica-induced gene 41, splicing factor, arginine/serine-rich 10 | (silica-induced gene 41, splicing factor, arginine/serine-rich 10 |
| | | | | (transformer 2 homolog, Drosophila)) | (transformer 2 homolog, Drosophila)) |
| 24762 | 1362 | NM_181092 | M, D | (similar to KIAA1938 protein, solute carrier family 7 (cationic | solute carrier family 7 (cationic amino acid transporter, y+ system), |
| | | | | amino acid transporter, y+ system), member 8) | member 8 |
| 10267 | 1550 | X57432 | N | (similar to ribosomal protein S2, similar to ribosomal protein S2; | |
| | | | | 40S ribosomal protein S2) | |
| 6796 | 711 | AI102753 | M, B | (similar to RING finger protein 4, similar to ring finger protein 4) | similar to RING finger protein 4 |
| 714 | 1416 | U10279 | N | (similar to solute carrier family 28 (sodium-coupled nucleoside | solute carrier family 28 (sodium-coupled nucleoside transporter), |
| | | | | transporter), member 1, solute carrier family 28 (sodium-coupled | member 1 |
| | | | | nucleoside transporter), member 1) | |
| 7300 | 786 | AI169077 | C | (similar to solute carrier family 7 (cationic amino acid transporter, | solute carrier family 7 (cationic amino acid transporter, y+ system), |
| | | | | y+ system), member 7, solute carrier family 7 (cationic amino | member 7 |
| | | | | acid transporter, y+ system), member 7) | |
| 18528 | 924 | AI230284 | K | (similar to Tropomyosin alpha 4 chain (Tropomyosin 4) | tropomyosin 4 |
| | | | | (TM30p1), tropomyosin 4) | |
| 18529 | 928 | AI230716 | M, K | (similar to Tropomyosin alpha 4 chain (Tropomyosin 4) | tropomyosin 4 |
| | | | | (TM30p1), tropomyosin 4) | |
| 1514 | 1142 | J02780 | N | (similar to Tropomyosin alpha 4 chain (Tropomyosin 4) | tropomyosin 4 |
| | | | | (TM30p1), tropomyosin 4) | |
| 24640 | 1576 | X70521 | N | (sodium channel, nonvoltage-gated 1 alpha, sodium channel, | (sodium channel, nonvoltage-gated 1 alpha, sodium channel, |
| | | | | nonvoltage-gated, type I, alpha polypeptide) | nonvoltage-gated, type I, alpha polypeptide) |
| 24639 | 1584 | X77932 | N | (sodium channel, nonvoltage-gated 1 beta, sodium channel, | (sodium channel, nonvoltage-gated 1 beta, sodium channel, |
| | | | | nonvoltage-gated 1, beta (Liddle syndrome)) | nonvoltage-gated 1, beta (Liddle syndrome)) |
| 117 | 490 | AF049239 | N | (sodium channel, voltage gated, type VIII, alpha, sodium | (sodium channel, voltage gated, type VIII, alpha, sodium channel, |
| | | | | channel, voltage-gated, type VIII, alpha polypeptide) | voltage-gated, type VIII, alpha polypeptide) |
| 645 | 412 | AA965132 | G, K | (solute carrier family 12 (sodium/chloride transporters), member | (solute carrier family 12 (sodium/chloride transporters), member 3, |
| | | | | 3, solute carrier family 12, member 3) | solute carrier family 12, member 3) |
| 646 | 1415 | U10097 | N, G, K | (solute carrier family 12 (sodium/chloride transporters), member | (solute carrier family 12 (sodium/chloride transporters), member 3, |
| | | | | 3, solute carrier family 12, member 3) | solute carrier family 12, member 3) |
| 4532 | 1414 | U10096 | J | (solute carrier family 12 (sodium/potassium/chloride | (solute carrier family 12 (sodium/potassium/chloride transporters), |
| | | | | transporters), member 1, solute carrier family 12, member 1) | member 1, solute carrier family 12, member 1) |
| 23826 | 1451 | U38180 | N | (solute carrier family 19 (folate transporter), member 1, solute | (solute carrier family 19 (folate transporter), member 1, solute carrier |
| | | | | carrier family 19 (sodium/hydrogen exchanger), member 1) | family 19 (sodium/hydrogen exchanger), member 1) |
| 24770 | 1191 | L19031 | M, N, G, I, J | (solute carrier family 21 (organic anion transporter), member 1, | (solute carrier family 21 (organic anion transporter), member 1, |
| | | | | solute carrier family 21 (organic anion transporter), member 3) | solute carrier family 21 (organic anion transporter), member 3) |
| 1622 | 1300 | M80804 | N | (solute carrier family 3 (cystine, dibasic and neutral amino acid | (solute carrier family 3 (cystine, dibasic and neutral amino acid |
| | | | | transporters, activator of cystine, dibasic and neutral amino acid | transporters, activator of cystine, dibasic and neutral amino acid |
| | | | | transport), member 1, solute carrier family 3, member 1) | transport), member 1, solute carrier family 3, member 1) |
| 18078 | 176 | AA891726 | N | (solute carrier family 34 (sodium phosphate), member 1, solute | solute carrier family 34 (sodium phosphate), member 1 |
| | | | | carrier family 34 (sodium phosphate), member 2) | |
| 18075 | 454 | AB013455 | N | (solute carrier family 34 (sodium phosphate), member 1, solute | solute carrier family 34 (sodium phosphate), member 1 |
| | | | | carrier family 34 (sodium phosphate), member 2) | |
| 18076 | 454 | AB013455 | N | (solute carrier family 34 (sodium phosphate), member 1, solute | solute carrier family 34 (sodium phosphate), member 1 |
| | | | | carrier family 34 (sodium phosphate), member 2) | |
| 18077 | 740 | AI105198 | N | (solute carrier family 34 (sodium phosphate), member 1, solute | solute carrier family 34 (sodium phosphate), member 1 |
| | | | | carrier family 34 (sodium phosphate), member 2) | |
| 4956 | 1485 | U76714 | H | (solute carrier family 39 (iron-regulated transporter), member 1, | solute carrier family 40 (iron-regulated transporter), member 1 |
| | | | | solute carrier family 40 (iron-regulated transporter), member 1) | |
| 4957 | 1485 | U76714 | N | (solute carrier family 39 (iron-regulated transporter), member 1, | solute carrier family 40 (iron-regulated transporter), member 1 |
| | | | | solute carrier family 40 (iron-regulated transporter), member 1) | |
| 1511 | 463 | AF004017 | D | (solute carrier family 4 (anion exchanger), member 4, solute | (solute carrier family 4 (anion exchanger), member 4, solute carrier |
| | | | | carrier family 4, sodium bicarbonate cotransporter, member 4) | family 4, sodium bicarbonate cotransporter, member 4) |
| 1877 | 1579 | X74593 | A, D, E | (Sorbitol dehydrogenase 1, sorbitol dehydrogenase) | sorbitol dehydrogenase |
| 20702 | 946 | AI231821 | N | (stathmin 1, stathmin 1/oncoprotein 18) | (stathmin 1, stathmin 1/oncoprotein 18) |
| 17514 | 324 | AA925554 | E, G | (Succinyl coenzyme A synthetase flavoprotein subunit, | succinate dehydrogenase complex, subunit A, flavoprotein (Fp) |
| | | | | flavoprotein, succinate dehydrogenase complex, subunit A, | |
| | | | | flavoprotein (Fp)) | |
| 4748 | 1192 | L19998 | N | (sulfotransferase family 1A, phenol-preferring, member 1, | (sulfotransferase family 1A, phenol-preferring, member 1, |
| | | | | sulfotransferase family, cytosolic, 1A, phenol-preferring, member | sulfotransferase family, cytosolic, 1A, phenol-preferring, member 1) |
| | | | | 1) | |
| 4749 | 1192 | L19998 | N, L | (sulfotransferase family 1A, phenol-preferring, member 1, | (sulfotransferase family 1A, phenol-preferring, member 1, |
| | | | | sulfotransferase family, cytosolic, 1A, phenol-preferring, member | sulfotransferase family, cytosolic, 1A, phenol-preferring, member 1) |
| | | | | 1) | |
| 10015 | 509 | AF083269 | M, G, K | (Suppressor of profilin 2, actin related protein ⅔ complex, | (actin related protein ⅔ complex, subunit 1B, actin related protein |
| | | | | subunit 1B, actin related protein ⅔ complex, subunit 1B, 41 kDa) | ⅔ complex, subunit 1B, 41 kDa) |
| 10016 | 509 | AF083269 | M, G | (Suppressor of profilin 2, actin related protein ⅔ complex, | (actin related protein ⅔ complex, subunit 1B, actin related protein |
| | | | | subunit 1B, actin related protein ⅔ complex, subunit 1B, 41 kDa) | ⅔ complex, subunit 1B, 41 kDa) |
| 15800 | 481 | AF035822 | A | (synaptosomal-associated protein, synaptosomal-associated | (synaptosomal-associated protein, synaptosomal-associated |
| | | | | protein, 29 kDa) | protein, 29 kDa) |
| 3995 | 566 | AI011678 | M, I, K | (syndecan 2, syndecan 2 (heparan sulfate proteoglycan 1, cell | (syndecan 2, syndecan 2 (heparan sulfate proteoglycan 1, cell |
| | | | | surface-associated, fibroglycan)) | surface-associated, fibroglycan)) |
| 1529 | 1302 | M81687 | M, B, F, I | (syndecan 2, syndecan 2 (heparan sulfate proteoglycan 1, cell | (syndecan 2, syndecan 2 (heparan sulfate proteoglycan 1, cell |
| | | | | surface-associated, fibroglycan)) | surface-associated, fibroglycan)) |
| 19768 | 222 | AA892373 | M, C, G | (syndecan binding protein, syndecan binding protein (syntenin)) | (syndecan binding protein, syndecan binding protein (syntenin)) |
| 3407 | 423 | AA997953 | F | (TCF3 (E2A) fusion partner, TCF3 (E2A) fusion partner (in | (TCF3 (E2A) fusion partner, TCF3 (E2A) fusion partner (in childhood |
| | | | | childhood Leukemia)) | Leukemia)) |
| 24626 | 1581 | X75856 | N | (testis enhanced gene transcript, testis enhanced gene transcript | (testis enhanced gene transcript, testis enhanced gene transcript |
| | | | | (BAX inhibitor 1)) | (BAX inhibitor 1)) |
| 18902 | 158 | AA875390 | N | (thioredoxin-like, thioredoxin-like, 32 kDa) | (thioredoxin-like, thioredoxin-like, 32 kDa) |
| 21122 | 1546 | X56228 | N, E | (thiosulfate sulfurtransferase (rhodanese), thiosulfate | (thiosulfate sulfurtransferase (rhodanese), thiosulfate |
| | | | | sulfurtransferase, mitochondrial) | sulfurtransferase, mitochondrial) |
| 21123 | 1546 | X56228 | N, D | (thiosulfate sulfurtransferase (rhodanese), thiosulfate | (thiosulfate sulfurtransferase (rhodanese), thiosulfate |
| | | | | sulfurtransferase, mitochondrial) | sulfurtransferase, mitochondrial) |
| 19402 | 140 | AA874848 | N | (Thy-1 co-transcribed, thymus cell antigen 1, theta) | (Thy-1 co-transcribed, thymus cell antigen 1, theta) |
| 1814 | 1253 | M31174 | N | (thyroid hormone receptor alpha, thyroid hormone receptor, | (thyroid hormone receptor alpha, thyroid hormone receptor, alpha |
| | | | | alpha (erythroblastic leukemia viral (v-erb-a) oncogene homolog, | (erythroblastic leukemia viral (v-erb-a) oncogene homolog, avian)) |
| | | | | avian)) | |
| 20919 | 756 | AI112516 | N | (Tis11 homolog, wu: fb80h11, zinc finger protein 36, C3H type- | zinc finger protein 36, C3H type-like 1 |
| | | | | like 1) | |
| 20920 | 763 | AI136891 | N | (Tis11 homolog, wu: fb80h11, zinc finger protein 36, C3H type- | zinc finger protein 36, C3H type-like 1 |
| | | | | like 1) | |
| 16039 | 9 | AA799452 | H | (Transaldolase, transaldolase 1) | transaldolase 1 |
| 7505 | 282 | AA893702 | N, A | (transcobalamin 2, transcobalamin II; macrocytic anemia) | (transcobalamin 2, transcobalamin II; macrocytic anemia) |
| 17377 | 1514 | X13058 | N | (transformation related protein 53, tumor protein p53 (Li- | (transformation related protein 53, tumor protein p53 (Li-Fraumeni |
| | | | | Fraumeni syndrome)) | syndrome)) |
| 17284 | 1145 | J02827 | N, G | (Transketolase, branched chain keto acid dehydrogenase E1, | (branched chain keto acid dehydrogenase E1, alpha polypeptide |
| | | | | alpha polypeptide (maple syrup urine disease), branched chain | (maple syrup urine disease), branched chain ketoacid |
| | | | | ketoacid dehydrogenase E1, alpha polypeptide) | dehydrogenase E1, alpha polypeptide) |
| 17285 | 1145 | J02827 | N | (Transketolase, branched chain keto acid dehydrogenase E1, | (branched chain keto acid dehydrogenase E1, alpha polypeptide |
| | | | | alpha polypeptide (maple syrup urine disease), branched chain | (maple syrup urine disease), branched chain ketoacid |
| | | | | ketoacid dehydrogenase E1, alpha polypeptide) | dehydrogenase E1, alpha polypeptide) |
| 20804 | 567 | AI011684 | H | (transketolase, transketolase (Wernicke-Korsakoff syndrome)) | (transketolase, transketolase (Wernicke-Korsakoff syndrome)) |
| 20802 | 655 | AI059508 | N, H | (transketolase, transketolase (Wernicke-Korsakoff syndrome)) | (transketolase, transketolase (Wernicke-Korsakoff syndrome)) |
| 20803 | 1413 | U09256 | N, B, H, I | (transketolase, transketolase (Wernicke-Korsakoff syndrome)) | (transketolase, transketolase (Wernicke-Korsakoff syndrome)) |
| 6641 | 1613 | Z49858 | M, A, I | (transmembrane 4 superfamily member 11, transmembrane 4 | (transmembrane 4 superfamily member 11, transmembrane 4 |
| | | | | superfamily member 11 (plasmolipin)) | superfamily member 11 (plasmolipin)) |
| 24843 | 1301 | M80826 | N, J | (trefoil factor 3 (intestinal), trefoil factor 3, intestinal) | (trefoil factor 3 (intestinal), trefoil factor 3, intestinal) |
| 15489 | 1458 | U50194 | F | (Tripeptidyl-peptidase II, tripeptidyl peptidase II) | tripeptidyl peptidase II |
| 455 | 1225 | M15474 | N, E | (Tropomyosin 1, tropomyosin 1 (alpha), tropomyosin 1, alpha) | (tropomyosin 1 (alpha), tropomyosin 1, alpha) |
| 457 | 1282 | M60666 | E, G, K | (Tropomyosin 1, tropomyosin 1 (alpha), tropomyosin 1, alpha) | (tropomyosin 1 (alpha), tropomyosin 1, alpha) |
| 17161 | 219 | AA892333 | M | (tubulin, alpha 1, tubulin, alpha 3) | (tubulin, alpha 1, tubulin, alpha 3) |
| 17160 | 792 | AI169370 | N | (tubulin, alpha 1, tubulin, alpha 3) | (tubulin, alpha 1, tubulin, alpha 3) |
| 17159 | 1131 | J00797 | M, G, K | (tubulin, alpha 1, tubulin, alpha 3) | (tubulin, alpha 1, tubulin, alpha 3) |
| 17158 | 1496 | V01227 | N | (tubulin, alpha 1, tubulin, alpha 3) | tubulin, alpha 1, tubulin, alpha 3) |
| 23314 | 393 | AA957270 | H, I | (tumor necrosis factor receptor superfamily, member 12A, tumor | (tumor necrosis factor receptor superfamily, member 12A, tumor |
| | | | | necrosis factor receptor superfamily, member 12a) | necrosis factor receptor superfamily, member 12a) |
| 18647 | 1379 | S69316 | N | (tumor rejection antigen (gp96) 1, tumor rejection antigen gp96) | |
| 15376 | 153 | AA875206 | N | (ubiquilin 1, wu: fb48e11) | ubiquilin 1 |
| 17378 | 1284 | M62388 | N, D | (Ubiquitin conjugating enzyme, ubiquitin conjugating-protein, | (ubiquitin-conjugating enzyme E2B (RAD6 homolog), ubiquitin- |
| | | | | ubiquitin-conjugating enzyme E2B (RAD6 homolog), ubiquitin- | conjugating enzyme E2B, RAD6 homology (S. cerevisiae)) |
| | | | | conjugating enzyme E2B, RAD6 homology (S. cerevisiae)) | |
| 15126 | 1113 | D83796 | N | (UDP glycosyltransferase 1 family, polypeptide A cluster, UDP | |
| | | | | glycosyltransferase 1 family, polypeptide A6, similar to phenol | |
| | | | | UDP-glucuronosyltransferase) | |
| 15124 | 1134 | J02612 | N, B | (UDP glycosyltransferase 1 family, polypeptide A cluster, UDP | |
| | | | | glycosyltransferase 1 family, polypeptide A6, similar to phenol | |
| | | | | UDP-glucuronosyltransferase) | |
| 15125 | 1162 | J05132 | N, B | (UDP glycosyltransferase 1 family, polypeptide A cluster, UDP | |
| | | | | glycosyltransferase 1 family, polypeptide A6, similar to phenol | |
| | | | | UDP-glucuronosyltransferase) | |
| 15127 | 1370 | S56937 | N | (UDP glycosyltransferase 1 family, polypeptide A cluster, UDP | |
| | | | | glycosyltransferase 1 family, polypeptide A6, similar to phenol | |
| | | | | UDP-glucuronosyltransferase) | |
| 10241 | 489 | AF048687 | N, C, K | (UDP-Gal:betaGlcNAc beta 1,4-galactosyltransferase, | (UDP-Gal:betaGlcNAc beta 1,4-galactosyltransferase, polypeptide |
| | | | | polypeptide 6, UDP-Gal:betaGlcNAc beta 1,4- | 6, UDP-Gal:betaGlcNAc beta 1,4-galactosyltransferase, polypeptide |
| | | | | galactosyltransferase, polypeptide 6) | 6) |
| 18597 | 455 | AB013732 | N, B, H | (UDP-glucose dehydrogenase, UDP-glucose dehydrogenase, | UDP-glucose dehydrogenase |
| | | | | SQuashed Vulva, sugarless) | |
| 16211 | 1386 | S75960 | N | (uromodulin, uromodulin (uromucoid, Tamm-Horsfall | (uromodulin, uromodulin (uromucoid, Tamm-Horsfall glycoprotein)) |
| | | | | glycoprotein)) | |
| 2979 | 289 | AA894099 | H | (vacuolar protein sorting 4A (yeast), vacuolar protein sorting 4a | (vacuolar protein sorting 4A (yeast), vacuolar protein sorting 4a |
| | | | | (yeast), wu: fc57d08) | (yeast)) |
| 20443 | 1422 | U14192 | H | (vesicle docking protein, vesicle docking protein p115) | (vesicle docking protein, vesicle docking protein p115) |
| 4594 | 1599 | Y07704 | N | (viperin, viral hemorrhagic septicemia virus(VHSV) induced gene | (viperin, viral hemorrhagic septicemia virus(VHSV) induced gene 1) |
| | | | | 1) | |
| 989 | 1464 | U56242 | N, D, F | (v-maf musculoaponeurotic fibrosarcoma (avian) oncogene | v-maf musculoaponeurotic fibrosarcoma oncogene homolog (avian) |
| | | | | homolog, v-maf musculoaponeurotic fibrosarcoma oncogene | |
| | | | | homolog (avian)) | |
| 1424 | 1423 | U14746 | N | (von Hippel-Lindau syndrome, von Hippel-Lindau syndrome | (von Hippel-Lindau syndrome, von Hippel-Lindau syndrome |
| | | | | homolog) | homolog) |
| 24900 | 1420 | U12973 | N, H | (X transporter protein 2, hypothetical protein FLJ31236) | (X transporter protein 2, similar to X transporter protein 2) |
| 13930 | 31 | AA800613 | M | (zinc finger protein 36, zinc finger protein 36, C3H type, homolog | (zinc finger protein 36, zinc finger protein 36, C3H type, homolog |
| | | | | (mouse)) | (mouse)) |
| 23868 | 474 | AF023087 | M, L | (Zinc finger, C2H2 type (3 domains), early growth response 1, | early growth response 1 |
| | | | | stripe) | |
| 23872 | 1231 | M18416 | M | (Zinc finger, C2H2 type (3 domains), early growth response 1, | early growth response 1 |
| | | | | stripe) | |
| 23869 | 1479 | U75397 | L | (Zinc finger, C2H2 type (3 domains), early growth response 1, | early growth response 1 |
| | | | | stripe) | |
| 1399 | 1508 | X07467 | M, H, I | (Zwischenferment, glucose-6-phosphate dehydrogenase, | (glucose-6-phosphate dehydrogenase, glucose-6-phosphate |
| | | | | glucose-6-phosphate dehydrogenase 2, glucose-6-phosphate-1- | dehydrogenase 2) |
| | | | | dehydrogenase) | |
| 15408 | 1060 | D00569 | N | 2,4-dienoyl CoA reductase 1, mitochondrial | 2,4-dienoyl CoA reductase 1, mitochondrial |
| 15409 | 1060 | D00569 | N, L | 2,4-dienoyl CoA reductase 1, mitochondrial | 2,4-dienoyl CoA reductase 1, mitochondrial |
| 20493 | 1090 | D28339 | M, N | 3-hydroxyanthranilate 3,4-dioxygenase | 3-hydroxyanthranilate 3,4-dioxygenase |
| 20494 | 1103 | D44494 | N, E | 3-hydroxyanthranilate 3,4-dioxygenase | 3-hydroxyanthranilate 3,4-dioxygenase |
| 22626 | 811 | AI171159 | M, K | a disintegrin-like and metalloprotease (reprolysin type) with | a disintegrin-like and metalloprotease (reprolysin type) with |
| | | | | thrombospondin 1 type motif, 1 | thrombospondin type 1 motif, 1 |
| 347 | 1400 | U01914 | D | A kinase (PRKA) anchor protein 8 | A kinase (PRKA) anchor protein 8 |
| 24649 | 991 | AI234950 | C, K | acid phosphatase 2, lysosomal | acid phosphatase 2, lysosomal |
| 24431 | 1285 | M63282 | M, F | activating transcription factor 3 | activating transcripion factor 3 |
| 13104 | 552 | AI010224 | D | adducin 3 (gamma) | adducin 3 (gamma) |
| 16708 | 1465 | U57042 | M, N | adenosine kinase | adenosine kinase |
| 16272 | 1582 | X76456 | N | afamin | afamin |
| 820 | 225 | AA892395 | N | aldolase B, fructose-bisphosphate | aldolase B, fructose-bisphosphate |
| 818 | 1497 | X02291 | N | aldolase B, fructose-bisphosphate | aldolase B, fructose-bisphosphate |
| 15032 | 1490 | U89905 | M, A, H, I, K, L | alpha-methylacyl-CoA racemase | alpha-methylacyl-CoA racemase |
| 18564 | 33 | AA800745 | M | aminolevulinate, delta-, dehydratase | aminolevulinate, delta-, dehydratase |
| 7197 | 820 | AI171962 | M, G, K, L | annexin A1 | annexin A1 |
| 7196 | 1371 | S57478 | M, E, G, K | annexin A1 | annexin A1 |
| 574 | 1182 | L13039 | M, E, G, K | annexin A2 | annexin A2 |
| 16649 | 491 | AF051895 | M, N, E | annexin A5 | annexin A5 |
| 16650 | 1101 | D42137 | E | annexin A5 | annexin A5 |
| 1509 | 435 | AB000507 | N, A | aquaporin 7 | aquaporin 7 |
| 18727 | 1078 | D13978 | N | argininosuccinate lyase | argininosuccinate lyase |
| 21339 | 409 | AA964962 | J, L | ATP-binding cassette, sub-family A (ABC1), member 1 | ATP-binding cassette, sub-family A (ABC1), member 1 |
| 15701 | 447 | AB010467 | A, I | ATP-binding cassette, sub-family C (CFTR/MRP), member 3 | ATP-binding cassette, sub-family C (CFTR/MRP), member 3 |
| 4361 | 1127 | H31839 | N | BCL2-antagonist/killer 1 | BCL2-antagonist/killer 1 |
| 439 | 1609 | Z22607 | N, F | bone morphogenetic protein 4 | bone morphogenetic protein 4 |
| 18246 | 1081 | D14441 | N, B, F | brain abundant, membrane attached signal protein 1 | brain abundant, membrane attached signal protein 1 |
| 24643 | 1477 | U68417 | N, K | branched chain aminotransferase 2, mitochondrial | branched chain aminotransferase 2, mitochondrial |
| 16967 | 1337 | NM_013146 | E | caldesmon 1 | caldesmon 1 |
| 355 | 1375 | S66024 | N | cAMP responsive element modulator | cAMP responsive element modulator |
| 356 | 1375 | S66024 | N | cAMP responsive element modulator | cAMP responsive element modulator |
| 20555 | 1439 | U26033 | F | carnitine O-octanoyltransferase | carnitine O-octanoyltransferase |
| 9109 | 1269 | M38135 | N | cathepsin H | cathepsin H |
| 1894 | 1176 | L03201 | N, B, L | cathepsin S | cathepsin S |
| 21682 | 635 | AI045030 | N | CCAAT/enhancer binding protein (C/EBP), delta | CCAAT/enhancer binding protein (C/EBP), delta |
| 21683 | 1290 | M65149 | M, C, I, L | CCAAT/enhancer binding protein (C/EBP), delta | CCAAT/enhancer binding protein (C/EBP), delta |
| 4412 | 26 | AA800005 | N | CD151 antigen | CD151 antigen |
| 12903 | 1538 | X53517 | N | CD37 antigen | CD37 antigen |
| 985 | 492 | AF053312 | N | chemokine (C—C motif) ligand 20 | chemokine (C—C motif) ligand 20 |
| 1306 | 1065 | D10262 | N | choline kinase | choline kinase |
| 24484 | 1454 | U42976 | H | cholinergic receptor, nicotinic, beta polypeptide 4 | cholinergic receptor, nicotinic, beta polypeptide 4 |
| 16350 | 1056 | AJ011811 | G | claudin 7 | claudin 7 |
| 16351 | 1056 | AJ011811 | G | claudin 7 | claudin 7 |
| 15259 | 870 | AI178135 | N | complement component 1, q subcomponent binding protein | complement component 1, q subcomponent binding protein |
| 21443 | 1577 | X71127 | M, L | complement component 1, q subcomponent, beta polypeptide | complement component 1, q subcomponent, beta polypeptide |
| 954 | 460 | AF000114 | B | contactin associated protein 1 | contactin associated protein 1 |
| 3454 | 477 | AF030091 | N, J | cyclin L1 | cyclin L1 |
| 15028 | 336 | AA942685 | N, F | cysteine dioxygenase, type I | cysteine dioxygenase, type I |
| 25024 | 1124 | E03229 | N | cysteine dioxygenase, type I | cysteine dioxygenase, type I |
| 1203 | 1049 | AJ000485 | N | cytoplasmic linker 2 | cytoplasmic linker 2 |
| 17226 | 1612 | Z36980 | N, C, E | D-dopachrome tautomerase | D-dopachrome tautomerase |
| 17227 | 1612 | Z36980 | N, E | D-dopachrome tautomerase | D-dopachrome tautomerase |
| 18354 | 1559 | X59859 | J | decorin | decorin |
| 3279 | 717 | AI103224 | F | dehydrogenase/reductase (SDR family) member 4 | dehydrogenase/reductase (SDR family) member 4 |
| 19679 | 1042 | AI639418 | M, A, D, G, I | deiodinase, iodothyronine, type I | deiodinase, iodothyronine, type I |
| 19678 | 1552 | X57999 | M | deiodinase, iodothyronine, type I | deiodinase, iodothyronine, type I |
| 20886 | 1484 | U76635 | E, G | deoxyribonuclease I | deoxyribonuclease I |
| 20887 | 1484 | U76635 | N, E, G | deoxyribonuclease I | deoxyribonuclease I |
| 17684 | 220 | AA892345 | M, I | dimethylglycine dehydrogenase precursor | dimethylglycine dehydrogenase precursor |
| 15616 | 570 | AI011998 | N | DnaJ (Hsp40) homolog, subfamily B, member 9 | DnaJ (Hsp40) homolog, subfamily B, member 9 |
| 16227 | 777 | AI145177 | F | early growth response 4 | early growth response 4 |
| 20865 | 1175 | L00117 | M, N | elastase 1, pancreatic | elastase 1, pancreatic |
| 21562 | 1525 | X15958 | N, A | enoyl Coenzyme A hydratase, short chain, 1, mitochondrial | enoyl Coenzyme A hydratase, short chain, 1, mitochondrial |
| 797 | 1452 | U38253 | N | eukaryotic translation initiation factor 2B, subunit 3 gamma, | eukaryotic translation initiation factor 2B, subunit 3 gamma, 58 kDa |
| | | | | 58 kDa | |
| 1570 | 1404 | U05014 | A | eukaryotic translation initiation factor 4E binding protein 1 | eukaryotic translation initiation factor 4E binding protein 1 |
| 18713 | 585 | AI012604 | N, L | eukaryotic translation initiation factor 5 | eukaryotic translation initiation factor 5 |
| 18716 | 1345 | NM_020075 | F | eukaryotic translation initiation factor 5 | eukaryotic translation initiation factor 5 |
| 6451 | 148 | AA875033 | N | fibulin 5 | fibulin 5 |
| 23445 | 1310 | M84719 | M, N | flavin containing monooxygenase 1 | flavin containing monooxygenase 1 |
| 2242 | 586 | AI012635 | M, H, I, J | flavin containing monooxygenase 3 | flavin containing monooxygenase 3 |
| 5601 | 958 | AI232461 | M, I | flavin containing monooxygenase 4 | flavin containing monooxygenase 4 |
| 1143 | 1343 | NM_019280 | A | gap junction protein, alpha 5, 40 kDa (connexin 40) | gap junction protein, alpha 5, 40 kDa (connexin 40) |
| 617 | 1179 | L08831 | N | gastric inhibitory polypeptide | gastric inhibitory polypeptide |
| 1678 | 1331 | M96674 | N | glucagon receptor | glucagon receptor |
| 11153 | 1320 | M91652 | N | glutamate-ammonia ligase (glutamine synthase) | glutamate-ammonia ligase (glutamine synthase) |
| 5206 | 327 | AA925755 | E | glutaminase | glutaminase |
| 20717 | 844 | AI176504 | N | glutaminase | glutaminase |
| 6405 | 1208 | L38615 | G | glutathione synthetase | glutathione synthetase |
| 6406 | 1208 | L38615 | N | glutathione synthetase | glutathione synthetase |
| 22554 | 353 | AA945076 | M, I | glycerol kinase | glycerol kinase |
| 1550 | 1504 | X06150 | N | glycine N-methyltransferase | glycine N-methyltransferase |
| 1551 | 1504 | X06150 | N, G | glycine N-methyltransferase | glycine N-methyltransferase |
| 17524 | 559 | AI010568 | M, A, I | growth hormone receptor | growth hormone receptor |
| 10887 | 1617 | Z83757 | M, I | growth hormone receptor | growth hormone receptor |
| 1546 | 1489 | U85512 | M, N, G | GTP cyclohydrolase I feedback regulatory protein | GTP cyclohydrolase I feedback regulatory protein |
| 14184 | 126 | AA859837 | M | guanine deaminase | guanine deaminase |
| 14185 | 126 | AA859837 | M | guanine deaminase | guanine deaminase |
| 1246 | 1273 | M57507 | M, J | guanylate cyclase 1, soluble, beta 2 | guanylate cyclase 1, soluble, beta 2 |
| 16081 | 888 | AI179610 | N | heme oxygenase (decycling) 1 | heme oxygenase (decycling) 1 |
| 16080 | 1138 | J02722 | N | heme oxygenase (decycling) 1 | heme oxygenase (decycling) 1 |
| 17832 | 573 | AI012182 | J | hemoglobin, beta | hemoglobin, beta |
| 17833 | 868 | AI177992 | F | hemoglobin, beta | hemoglobin, beta |
| 17829 | 884 | AI179576 | N, J | hemoglobin, beta | hemoglobin, beta |
| 25468 | 1324 | M94918 | N, J | hemoglobin, beta | hemoglobin, beta |
| 6758 | 592 | AI013394 | B, L | heparan sulfate (glucosamine) 3-O-sulfotransferase 1 | heparan sulfate (glucosamine) 3-O-sulfotransferase 1 |
| 4235 | 733 | AI104524 | M, H, K, L | heterogeneous nuclear ribonucleoprotein A/B | heterogeneous nuclear ribonucleoprotein A/B |
| 16012 | 1567 | X62875 | M, I | high mobility group AT-hook 1 | high mobility group AT-hook 1 |
| 15434 | 531 | AI008836 | N | high-mobility group box 2 | high-mobility group box 2 |
| 15437 | 1114 | D84418 | E | high-mobility group box 2 | high-mobility group box 2 |
| 3610 | 776 | AI145151 | M, G, I, J | histamine N-methyltransferase | histamine N-methyltransferase |
| 3608 | 1067 | D10693 | M, J | histamine N-methyltransferase | histamine N-methyltransferase |
| 3609 | 1395 | S82579 | N, F | histamine N-methyltransferase | histamine N-methyltransferase |
| 15750 | 443 | AB007690 | H | homer homolog 2 (Drosophila) | homer homolog 2 (Drosophila) |
| 24631 | 1096 | D37951 | F | human immunodeficiency virus type I enhancer binding protein 2 | human immunodeficiency virus type I enhancer binding protein 2 |
| 1962 | 434 | AB000199 | J | hydroxy-delta-5-steroid dehydrogenase, 3 beta- and steroid delta | hydroxy-delta-5-steroid dehydrogenase, 3 beta- and steroid delta- |
| | | | | isomerase 7 | isomerase 7 |
| 23660 | 747 | AI105448 | N | hydroxysteroid (11-beta) dehydrogenase 1 | hydroxysteroid (11-beta) dehydrogenase 1 |
| 15174 | 1469 | U59809 | N | insulin-like growth factor 2 receptor | insulin-like growth factor 2 receptor |
| 16982 | 1278 | M58634 | M, B, L | insulin-like growth factor binding protein 1 | insulin-like growth factor binding protein 1 |
| 15097 | 535 | AI009405 | N | insulin-like growth factor binding protein 3 | insulin-like growth factor binding protein 3 |
| 24893 | 614 | AI029920 | B | insulin-like growth factor binding protein 5 | insulin-like growth factor binding protein 5 |
| 21193 | 1291 | M69055 | F | insulin-like growth factor binding protein 6 | |
| 21977 | 1365 | S46785 | A, B | insulin-like growth factor binding protein, acid labile subunit | insulin-like growth factor binding protein, acid labile subunit |
| 25480 | 1365 | S46785 | N | insulin-like growth factor binding protein, acid labile subunit | insulin-like growth factor binding protein, acid labile subunit |
| 20126 | 1263 | M34253 | N, K | interferon regulatory factor 1 | interferon regulatory factor 1 |
| 17908 | 604 | AI014163 | M | interferon-related developmental regulator 1 | interferon-related developmental regulator 1 |
| 2632 | 456 | AB016489 | A, D | jumping translocation breakpoint | jumping translocation breakpoint |
| 3584 | 716 | AI103106 | E | lamin B1 | lamin B1 |
| 3049 | 889 | AI179892 | M | lipocalin 7 | lipocalin 7 |
| 3050 | 939 | AI231321 | M | lipocalin 7 | lipocalin 7 |
| 408 | 250 | AA892810 | M | low density lipoprotein receptor-related protein associated | low density lipoprotein receptor-related protein associated protein 1 |
| | | | | protein 1 | |
| 410 | 532 | AI008974 | M, E | low density lipoprotein receptor-related protein associated | low density lipoprotein receptor-related protein associated protein 1 |
| | | | | protein 1 | |
| 409 | 953 | AI232268 | M, N, I | low density lipoprotein receptor-related protein associated | low density lipoprotein receptor-related protein associated protein 1 |
| | | | | protein 1 | |
| 406 | 1606 | Z11995 | M | low density lipoprotein receptor-related protein associated | low density lipoprotein receptor-related protein associated protein 1 |
| | | | | protein 1 | |
| 407 | 1606 | Z11995 | N, C | low density lipoprotein receptor-related protein associated | low density lipoprotein receptor-related protein associated protein 1 |
| | | | | protein 1 | |
| 1946 | 1338 | NM_017061 | F | lysyl oxidase | lysyl oxidase |
| 1943 | 1388 | S77494 | N, L | lysyl oxidase | lysyl oxidase |
| 13151 | 571 | AI012030 | M | matrix Gla protein | matrix Gla protein |
| 7690 | 1346 | NM_022284 | M | melanoma antigen, family D, 1 | melanoma antigen, family D, 1 |
| 17357 | 1317 | M88601 | M, F, G, I, L | meprin A, beta | meprin A, beta |
| 16354 | 1108 | D50564 | N, C | mercaptopyruvate sulfurtransferase | mercaptopyruvate sulfurtransferase |
| 15017 | 1153 | J03752 | N, B | microsomal glutathione S-transferase 1 | microsomal glutathione S-transferase 1 |
| 13938 | 1339 | NM_017212 | N | microtubule-associated protein tau | microtubule-associated protein tau |
| 13939 | 1339 | NM_017212 | D | microtubule-associated protein tau | microtubule-associated protein tau |
| 13940 | 1587 | X79321 | N, D | microtubule-associated protein tau | microtubule-associated protein tau |
| 25235 | 1052 | AJ001290 | F | mitochondrial ribosomal protein S6 | mitochondrial ribosomal protein S6 |
| 14956 | 1286 | M64301 | N | mitogen-activated protein kinase 6 | mitogen-activated protein kinase 6 |
| 14957 | 1286 | M64301 | N | mitogen-activated protein kinase 6 | mitogen-activated protein kinase 6 |
| 15291 | 748 | AI111401 | D | multiple inositol polyphosphate histidine phosphatase, 1 | multiple inositol polyphosphate histidine phosphatase, 1 |
| 17448 | 912 | AI229637 | N | MYB binding protein (P160) 1a | MYB binding protein (P160) 1a |
| 1698 | 1137 | J02679 | M, B, H, I | NAD(P)H dehydrogenase, quinone 1 | NAD(P)H dehydrogenase, quinone 1 |
| 4484 | 213 | AA892258 | N | NADPH oxidase 4 | NADPH oxidase 4 |
| 18008 | 1350 | NM_031588 | N | neuregulin 1 | neuregulin 1 |
| 18005 | 1401 | U02320 | N | neuregulin 1 | neuregulin 1 |
| 18011 | 1402 | U02322 | M, H | neuregulin 1 | neuregulin 1 |
| 20708 | 441 | AB006461 | A | neurochondrin | neurochondrin |
| 968 | 1119 | D86745 | G, K | nuclear receptor subfamily 0, group B, member 2 | nuclear receptor subfamily 0, group B, member 2 |
| 15022 | 38 | AA801029 | N | nuclear receptor subfamily 2, group F, member 6 | nuclear receptor subfamily 2, group F, member 6 |
| 1490 | 1473 | U63839 | E | nucleoporin like 1 | nucleoporin like 1 |
| 24264 | 927 | AI230712 | M | paired basic amino acid cleaving system 4 | paired basic amino acid cleaving system 4 |
| 20457 | 452 | AB012944 | M, B, K, L | parathyroid hormone receptor 1 | parathyroid hormone receptor 1 |
| 20458 | 1202 | L31394 | M, I, K, L | parathyroid hormone receptor 1 | parathyroid hormone receptor 1 |
| 1581 | 1435 | U23769 | M, A, C | PDZ and LIM domain 1 (elfin) | PDZ and LIM domain 1 (elfin) |
| 1081 | 466 | AF013145 | M, D | PDZ domain containing 1 | PDZ domain containing 1 |
| 19998 | 964 | AI232999 | M | PDZ domain containing 1 | PDZ domain containing 1 |
| 1650 | 46 | AA817825 | A | peptidylglycine alpha-amidating monooxygenase | peptidylglycine alpha-amidating monooxygenase |
| 1644 | 167 | AA891068 | A, F | peptidylglycine alpha-amidating monooxygenase | peptidylglycine alpha-amidating monooxygenase |
| 1649 | 724 | AI103782 | F | peptidylglycine alpha-amidating monooxygenase | peptidylglycine alpha-amidating monooxygenase |
| 1651 | 896 | AI228068 | A, H | peptidylglycine alpha-amidating monooxygenase | peptidylglycine alpha-amidating monooxygenase |
| 1652 | 914 | AI229728 | A | peptidylglycine alpha-amidating monooxygenase | peptidylglycine alpha-amidating monooxygenase |
| 1653 | 980 | AI233806 | A | peptidylglycine alpha-amidating monooxygenase | peptidylglycine alpha-amidating monooxygenase |
| 17477 | 305 | AA924029 | M, K, L | phospholipid scramblase 1 | phospholipid scramblase 1 |
| 1847 | 1529 | X16555 | B | phosphoribosyl pyrophosphate synthetase 2 | phosphoribosyl pyrophosphate synthetase 2 |
| 6554 | 517 | AF097723 | N | plasma glutamate carboxypeptidase | plasma glutamate carboxypeptidase |
| 46 | 1242 | M23697 | N | plasminogen activator, tissue | plasminogen activator, tissue |
| 19031 | 666 | AI070532 | M, L | pleckstrin homology-like domain, family A, member 1 | pleckstrin homology-like domain, family A, member 1 |
| 108 | 1185 | L14002 | J | polymeric immunoglobulin receptor | polymeric immunoglobulin receptor |
| 109 | 1187 | L14004 | N | polymeric immunoglobulin receptor | polymeric immunoglobulin receptor |
| 5295 | 332 | AA926247 | M, L | potassium channel, subfamily K, member 1 | potassium channel, subfamily K, member 1 |
| 19665 | 472 | AF022819 | D, L | potassium channel, subfamily K, member 1 | potassium channel, subfamily K, member 1 |
| 9027 | 218 | AA892312 | N | potassium inwardly-rectifying channel, subfamily J, member 16 | potassium inwardly-rectifying channel, subfamily J, member 16 |
| 14425 | 864 | AI177755 | M, L | pre-B-cell colony-enhancing factor | (pre-B-cell colony-enhancing factor, similar to Pre-B cell enhancing |
| | | | | | factor precursor) |
| 5208 | 1016 | AI236754 | G | pregnancy-induced growth inhibitor | pregnancy-induced growth inhibitor |
| 2109 | 47 | AA817887 | N, G | profilin 1 | profilin 1 |
| 9067 | 657 | AI070087 | M | prolactin | prolactin |
| 24568 | 1211 | L48060 | M, B | prolactin receptor | prolactin receptor |
| 24567 | 1234 | M19304 | N, F | prolactin receptor | prolactin receptor |
| 24566 | 1296 | M74152 | B, F, L | prolactin receptor | prolactin receptor |
| 1422 | 450 | AB012759 | M, B, G, L | prolyl endopeptidase | prolyl endopeptidase |
| 503 | 1082 | D16443 | C | prostaglandin E receptor 3 (subtype EP3) | prostaglandin E receptor 3 (subtype EP3) |
| 13609 | 229 | AA892468 | M, H, I | protease, serine, 8 (prostasin) | protease, serine, 8 (prostasin) |
| 13610 | 229 | AA892468 | M, A, C, F, H, I, K | protease, serine, 8 (prostasin) | protease, serine, 8 (prostasin) |
| 13611 | 879 | AI179378 | M, F, H | protease, serine, 8 (prostasin) | protease, serine, 8 (prostasin) |
| 1884 | 1109 | D50695 | I | proteasome (prosome, macropain) 26S subunit, ATPase, 4 | proteasome (prosome, macropain) 26S subunit, ATPase, 4 |
| 15470 | 1466 | U57050 | H | proteasome (prosome, macropain) 26S subunit, non-ATPase, 1 | proteasome (prosome, macropain) 26S subunit, non-ATPase, 1 |
| 4003 | 1071 | D10757 | N | proteasome (prosome, macropain) subunit, beta type, 9 (large | proteasome (prosome, macropain) subunit, beta type, 9 (large |
| | | | | multifunctional protease 2) | multifunctional protease 2) |
| 24563 | 1167 | J05592 | N, G, K | protein phosphatase 1, regulatory (inhibitor) subunit 1A | protein phosphatase 1, regulatory (inhibitor) subunit 1A |
| 24564 | 1167 | J05592 | N, G, K | protein phosphatase 1, regulatory (inhibitor) subunit 1A | protein phosphatase 1, regulatory (inhibitor) subunit 1A |
| 21491 | 486 | AF040954 | B | protein phosphatase 1, regulatory subunit 10 | protein phosphatase 1, regulatory subunit 10 |
| 1824 | 1427 | U17971 | K | protein tyrosine phosphatase, non-receptor type 21 | protein tyrosine phosphatase, non-receptor type 21 |
| 24438 | 1311 | M85183 | M, N, F, L | PYRIN-containing APAF1-like protein 5 | PYRIN-containing APAF1-like protein 5 |
| 1478 | 1447 | U32314 | M | pyruvate carboxylase | pyruvate carboxylase |
| 1479 | 1447 | U32314 | N, D | pyruvate carboxylase | pyruvate carboxylase |
| 23362 | 537 | AI009605 | N | Ras homolog enriched in brain | Ras homolog enriched in brain 2 |
| 4661 | 296 | AA899709 | M, B, L | receptor (calcitonin) activity modifying protein 3 | receptor (calcitonin) activity modifying protein 3 |
| 1515 | 1064 | D10233 | J | renin binding protein | renin binding protein |
| 21575 | 1544 | X55298 | J | ribophorin II | ribophorin II |
| 18107 | 1594 | X94242 | N | ribosomal protein L14 | ribosomal protein L14 |
| 5667 | 1553 | X58200 | N | ribosomal protein L23 | |
| 18611 | 1553 | X58200 | N | ribosomal protein L23 | |
| 15135 | 1382 | S71021 | N, G | ribosomal protein L6 | ribosomal protein L6 |
| 10878 | 1174 | K03250 | N | ribosomal protein S11 | ribosomal protein S11 |
| 20872 | 1534 | X51707 | N | ribosomal protein S19 | |
| 15653 | 1518 | X14210 | N, G | ribosomal protein S4, X-linked | |
| 16394 | 524 | AI008106 | K | S100 calcium binding protein A6 (calcyclin) | S100 calcium binding protein A6 (calcyclin) |
| 4280 | 922 | AI230247 | F | selenoprotein P, plasma, 1 | selenoprotein P, plasma, 1 |
| 699 | 1463 | U55765 | E | serine (or cysteine) proteinase inhibitor, clade A (alpha-1 | (hypothetical protein MGC25863, serine (or cysteine) proteinase |
| | | | | antiproteinase, antitrypsin), member 10 | inhibitor, clade A (alpha-1 antiproteinase, antitrypsin), member 10) |
| 24778 | 1515 | X13119 | N | serine dehydratase | serine dehydratase |
| 4198 | 1305 | M83143 | M, N, I | sialyltransferase 1 (beta-galactoside alpha-2,6-sialyltransferase) | sialyltransferase 1 (beta-galactoside alpha-2,6-sialyltransferase) |
| 4199 | 1305 | M83143 | M, N | sialyltransferase 1 (beta-galactoside alpha-2,6-sialyltransferase) | sialyltransferase 1 (beta-galactoside alpha-2,6-sialyltransferase) |
| 17500 | 243 | AA892616 | N | solute carrier family 13 (sodium-dependent dicarboxylate | solute carrier family 13 (sodium-dependent dicarboxylate |
| | | | | transporter), member 3 | transporter), member 3 |
| 235 | 1344 | NM_019347 | C | solute carrier family 14 (urea transporter), member 2 | solute carrier family 14 (urea transporter), member 2 |
| 15039 | 951 | AI232096 | M, F, I | solute carrier family 15 (H+/peptide transporter), member 2 | solute carrier family 15 (H+/peptide transporter), member 2 |
| 725 | 1471 | U62316 | B | solute carrier family 16 (monocarboxylic acid transporters), | solute carrier family 16 (monocarboxylic acid transporters), member 7 |
| | | | | member 7 | |
| 15872 | 1201 | L28135 | N | solute carrier family 2 (facilitated glucose transporter), member 2 | solute carrier family 2 (facilitated glucose transporter), member 2 |
| 1510 | 440 | AB004559 | M, D, K | solute carrier family 22 (organic anion transporter), member 6 | solute carrier family 22 (organic anion transporter), member 6 |
| 12682 | 797 | AI169656 | D | solute carrier family 22 (organic anion transporter), member 8 | solute carrier family 22 (organic anion transporter), member 8 |
| 1602 | 1483 | U76379 | N | solute carrier family 22 (organic cation transporter), member 1 | solute carrier family 22 (organic cation transporter), member 1 |
| 770 | 1112 | D83044 | M, N | solute carrier family 22 (organic cation transporter), member 2 | solute carrier family 22 (organic cation transporter), member 2 |
| 23625 | 458 | AB017260 | N, D | solute carrier family 22 (organic cation transporter), member 5 | solute carrier family 22 (organic cation transporter), member 5 |
| 43 | 1194 | L23413 | N | solute carrier family 26 (sulfate transporter), member 1 | solute carrier family 26 (sulfate transporter), member 1 |
| 17554 | 1115 | D85100 | N | solute carrier family 27 (fatty acid transporter), member 2 | solute carrier family 27 (fatty acid transporter), member 2 |
| 18074 | 469 | AF015305 | K | solute carrier family 29 (nucleoside transporters), member 2 | solute carrier family 29 (nucleoside transporters), member 2 |
| 6416 | 984 | AI234295 | M, K | solute carrier family 34 (sodium phosphate), member 2 | solute carrier family 34 (sodium phosphate), member 2 |
| 20780 | 1444 | U29881 | M, N, D | solute carrier family 5 (sodium/glucose cotransporter), member 2 | solute carrier family 5 (sodium/glucose cotransporter), member 2 |
| 7700 | 744 | AI105383 | M, D | sphingosine kinase 1 | sphingosine kinase 1 |
| 8426 | 483 | AF036335 | N, E, F | splicing factor proline/glutamine rich (polypyrimidine tract binding | splicing factor proline/glutamine rich (polypyrimidine tract binding |
| | | | | protein associated) | protein associated) |
| 16681 | 1095 | D37920 | N, B, L | squalene epoxidase | squalene epoxidase |
| 21842 | 828 | AI172293 | N | sterol-C4-methyl oxidase-like | sterol-C4-methyl oxidase-like |
| 14970 | 180 | AA891738 | M, B, H, I, K | sulfite oxidase | sulfite oxidase |
| 11692 | 1027 | AI638982 | M, N | sulfotransferase family, cytosolic, 1C, member 1 | sulfotransferase family, cytosolic, 1C, member 1 |
| 495 | 1573 | X68041 | J | superoxide dismutase 3, extracellular | superoxide dismutase 3, extracellular |
| 494 | 1610 | Z24721 | J | superoxide dismutase 3, extracellular | superoxide dismutase 3, extracellular |
| 21025 | 111 | AA859241 | M, A, C | synaptojanin 2 binding protein | synaptojanin 2 binding protein |
| 21024 | 1348 | NM_022599 | M | synaptojanin 2 binding protein | synaptojanin 2 binding protein |
| 15247 | 606 | AI014169 | N | thioredoxin interacting protein | thioredoxin interacting protein |
| 20816 | 1276 | M58404 | M, G, K | thymosin, beta 10 | thymosin, beta 10 |
| 7888 | 976 | AI233583 | M | tissue inhibitor of metalloproteinase 2 | tissue inhibitor of metalloproteinase 2 |
| 17149 | 1304 | M83107 | N | transgelin | transgelin |
| 17150 | 1304 | M83107 | N | transgelin | transgelin |
| 17550 | 565 | AI011607 | M, I | trimethyllysine hydroxylase, epsilon | trimethyllysine hydroxylase, epsilon |
| 14332 | 1051 | AJ001044 | D | tumor-associated calcium signal transducer 1 | tumor-associated calcium signal transducer 1 |
| 16683 | 1086 | D17445 | N | tyrosine 3-monooxygenase/tryptophan 5-monooxygenase | tyrosine 3-monooxygenase/tryptophan 5-monooxygenase activation |
| | | | | activation protein, eta polypeptide | protein, eta polypeptide |
| 16684 | 1086 | D17445 | M | tyrosine 3-monooxygenase/tryptophan 5-monooxygenase | tyrosine 3-monooxygenase/tryptophan 5-monooxygenase activation |
| | | | | activation protein, eta polypeptide | protein, eta polypeptide |
| 3016 | 50 | AA818069 | H | ubiquitin B | ubiquitin B |
| 3015 | 1084 | D16554 | A | ubiquitin B | ubiquitin B |
| 11843 | 494 | AF054826 | A | vesicle-associated membrane protein 5 (myobrevin) | vesicle-associated membrane protein 5 (myobrevin) |
| 15185 | 1568 | X62952 | M | vimentin | vimentin |
| 15008 | 485 | AF038591 | E | X-prolyl aminopepidase (aminopeptidase P) 1, soluble | X-prolyl aminopeptidase (aminopeptidase P) 1, soluble |
| 12331 | 370 | AA946466 | M, H | X-prolyl aminopeptidase (aminopepidase P) 2, membrane- | X-prolyl aminopeptidase (aminopeptidase P) 2, membrane-bound |
| | | | | bound | |
| 12332 | 370 | AA946466 | M, G | X-prolyl aminopeptidase (aminopeptidase P) 2, membrane- | X-prolyl aminopeptidase (aminopeptidase P) 2, membrane-bound |
| | | | | bound | |
| 1410 | 1330 | M96548 | H | zinc finger protein 354A | zinc finger protein 354A |
| 22501 | 351 | AA944811 | H | zinc finger, DHHC domain containing 7 | zinc finger, DHHC domain containing 7 |
| 22502 | 608 | AI029017 | H | zinc finger, DHHC domain containing 7 | zinc finger, DHHC domain containing 7 |

TABLE 4

| GLGC Model | GLGC Model Code | Table No. |
|---|---|---|
| General Nephrotoxicity | M (GENERAL1)* | 5M |
| General Nephrotoxicity | N (GENERAL2)** | 5N |
| Chloroform | A | 5A |
| Diclofenac | B | 5B |
| Menadione | C | 5C |
| SodiumChromate | D | 5D |
| SodiumOxalate | E | 5E |
| Thioacetamide | F | 5F |
| Vancomycin | G | 5G |
| proximal tubule S2 segment toxicity | H | 5H |
| Tubular Toxicity | I | 5I |
| Glomerular Injury | J | 5J |
| Tubular Obstruction | K | 5K |
| NSAIDS | L | 5L |

*MAS4 LDA Based
**RMA PLS Based

TABLE 5A

| GLGC | LDA | Tox Group | Tox Group | Non-Tox | Non-Tox |
|---|---|---|---|---|---|
| Identifier | Score | Mean | SD | Group Mean | Group SD |
| 3091 | 95.09 | 421.64 | 58.81 | 713.53 | 158.43 |
| 4462 | 93.09 | 414.41 | 198.64 | 953.78 | 313.55 |
| 22648 | 92.73 | 313.31 | 70.15 | 490.37 | 101.26 |
| 13610 | 92.33 | 226.14 | 59.71 | 365.06 | 107.29 |
| 21025 | 92.15 | 233.83 | 71.17 | 418.06 | 106.83 |
| 3961 | 91.61 | 74.40 | 10.55 | 49.45 | 14.81 |
| 2912 | 90.89 | 1436.37 | 179.76 | 2437.60 | 603.29 |
| 17361 | 90.70 | 50.93 | 20.08 | 137.86 | 55.93 |
| 23509 | 89.88 | 1570.55 | 137.71 | 2086.99 | 379.49 |
| 13028 | 89.85 | 137.00 | 17.66 | 89.57 | 32.90 |
| 20725 | 88.97 | 621.86 | 57.64 | 801.80 | 141.09 |
| 11953 | 88.88 | 1079.47 | 146.45 | 1693.94 | 588.62 |
| 1652 | 88.73 | 476.16 | 64.04 | 656.76 | 161.47 |
| 4463 | 88.62 | 43.16 | 34.48 | 150.98 | 58.66 |
| 25643 | 88.48 | 187.37 | 74.36 | 110.76 | 25.22 |
| 3875 | 88.29 | 252.35 | 75.16 | 478.18 | 126.13 |
| 16469 | 88.06 | 991.10 | 103.75 | 1321.05 | 271.57 |
| 1650 | 87.97 | 569.84 | 94.38 | 790.48 | 182.69 |
| 8829 | 87.88 | 505.66 | 151.99 | 282.86 | 84.70 |
| 23282 | 87.61 | 425.15 | 71.15 | 283.98 | 52.36 |
| 9191 | 87.55 | 277.28 | 132.99 | 657.06 | 277.10 |
| 13727 | 87.53 | 35.36 | 28.82 | 109.18 | 42.58 |
| 15032 | 87.42 | 175.94 | 47.04 | 265.22 | 74.56 |
| 2059 | 87.30 | 219.06 | 65.06 | 136.38 | 34.61 |
| 21088 | 87.30 | 56.92 | 8.06 | 40.35 | 14.32 |
| 18522 | 87.29 | 490.66 | 94.81 | 759.01 | 194.27 |
| 21977 | 87.24 | 38.53 | 11.16 | 77.01 | 45.15 |
| 11653 | 87.24 | 306.58 | 112.65 | 560.40 | 195.77 |
| 23033 | 87.21 | 431.39 | 57.07 | 579.07 | 117.99 |
| 19822 | 86.82 | 994.53 | 147.26 | 1418.54 | 381.93 |
| 9176 | 86.73 | 288.61 | 15.81 | 245.52 | 51.27 |
| 17524 | 86.71 | 799.10 | 105.47 | 1115.60 | 282.08 |
| 7216 | 86.71 | 123.29 | 34.23 | 234.44 | 71.10 |
| 11761 | 86.64 | 49.48 | 6.15 | 68.95 | 26.33 |
| 4473 | 86.50 | 95.76 | 32.22 | 172.47 | 49.25 |
| 3925 | 86.50 | 275.69 | 80.34 | 461.73 | 112.55 |
| 14856 | 86.45 | 330.60 | 53.33 | 438.34 | 100.70 |
| 2439 | 86.44 | 102.63 | 17.35 | 147.69 | 27.96 |
| 22490 | 86.42 | 811.57 | 139.35 | 602.93 | 96.00 |
| 14267 | 86.42 | 1171.51 | 258.92 | 1706.75 | 393.91 |
| 8927 | 86.42 | 508.53 | 79.40 | 689.86 | 154.77 |
| 8946 | 86.39 | 112.12 | 21.59 | 186.07 | 74.49 |
| 4178 | 86.29 | 444.39 | 54.78 | 619.34 | 136.02 |
| 23115 | 86.26 | 278.57 | 65.22 | 503.85 | 159.60 |
| 16958 | 86.15 | 61.46 | 19.84 | 30.96 | 13.91 |
| 9116 | 86.14 | 269.31 | 52.99 | 392.85 | 75.60 |
| 15836 | 86.00 | 121.07 | 16.96 | 214.57 | 101.58 |
| 13285 | 85.94 | 110.31 | 17.04 | 71.38 | 16.98 |
| 5369 | 85.88 | 274.28 | 47.68 | 200.95 | 43.34 |
| 8721 | 85.83 | 73.87 | 43.04 | 183.86 | 66.21 |
| 3803 | 85.73 | 975.63 | 205.56 | 722.11 | 154.02 |
| 1409 | 85.68 | 298.20 | 49.00 | 438.84 | 99.15 |
| 17824 | 85.62 | 205.14 | 27.09 | 142.57 | 42.17 |
| 7299 | 85.42 | 334.53 | 109.96 | 181.79 | 143.50 |
| 1653 | 85.35 | 686.13 | 93.92 | 993.47 | 242.55 |
| 17516 | 85.33 | 500.55 | 239.88 | 547.02 | 127.42 |
| 19377 | 85.21 | 155.74 | 30.08 | 109.47 | 24.61 |
| 1570 | 85.17 | 98.50 | 59.57 | 39.00 | 13.49 |
| 1651 | 85.17 | 577.75 | 69.32 | 788.50 | 180.99 |
| 7622 | 85.09 | 88.74 | 20.90 | 56.95 | 16.90 |
| 22855 | 85.05 | 373.13 | 49.91 | 519.30 | 117.46 |
| 21562 | 85.05 | 265.87 | 68.99 | 468.38 | 147.67 |
| 4933 | 84.98 | 743.88 | 516.81 | 142.53 | 232.49 |
| 15964 | 84.88 | 583.51 | 205.70 | 1089.69 | 286.46 |
| 24234 | 84.86 | 408.25 | 208.57 | 188.66 | 107.50 |
| 7634 | 84.86 | 538.91 | 181.95 | 645.21 | 126.88 |
| 12129 | 84.85 | 245.65 | 111.61 | 646.79 | 334.57 |
| 25777 | 84.83 | 1173.74 | 710.54 | 439.45 | 241.72 |
| 10378 | 84.82 | 69.21 | 33.23 | 143.74 | 101.86 |
| 1581 | 84.77 | 87.66 | 15.15 | 66.76 | 21.00 |
| 20582 | 84.74 | 347.72 | 63.49 | 487.44 | 95.49 |
| 20000 | 84.67 | 93.69 | 19.60 | 127.60 | 71.39 |
| 13740 | 84.64 | 257.51 | 18.03 | 221.70 | 39.96 |
| 16756 | 84.59 | 361.18 | 150.11 | 171.51 | 41.28 |
| 26183 | 84.58 | 64.68 | 11.03 | 47.22 | 22.02 |
| 22985 | 84.55 | 83.55 | 9.87 | 108.90 | 29.86 |
| 23718 | 84.42 | 65.41 | 10.03 | 97.59 | 40.96 |
| 10130 | 84.36 | 117.70 | 66.31 | 221.33 | 55.16 |
| 17541 | 84.35 | 1464.81 | 514.58 | 725.03 | 344.90 |
| 21060 | 84.30 | 133.69 | 25.56 | 83.14 | 27.48 |
| 16468 | 84.29 | 831.97 | 118.43 | 1136.11 | 219.87 |
| 20741 | 84.26 | 236.26 | 31.17 | 175.32 | 43.96 |
| 6641 | 84.21 | 233.86 | 84.82 | 396.94 | 88.30 |
| 22537 | 84.18 | 145.19 | 78.83 | 301.55 | 137.94 |
| 18509 | 83.95 | 311.54 | 43.78 | 430.03 | 88.77 |
| 19110 | 83.92 | 84.32 | 32.08 | 204.53 | 96.17 |
| 11843 | 83.88 | 61.43 | 4.65 | 52.11 | 10.69 |
| 15800 | 83.74 | 56.84 | 10.37 | 34.45 | 19.58 |
| 7936 | 83.74 | 93.98 | 18.72 | 137.68 | 31.48 |
| 22783 | 83.67 | 473.86 | 73.76 | 347.89 | 212.99 |
| 20832 | 83.65 | 534.47 | 85.79 | 785.26 | 199.66 |
| 1949 | 83.61 | 57.75 | 7.72 | 90.12 | 37.12 |
| 21061 | 83.52 | 86.99 | 17.50 | 50.51 | 22.34 |
| 25168 | 83.29 | 32.68 | 2.87 | 23.16 | 9.80 |
| 6127 | 83.24 | 41.36 | 8.04 | 64.30 | 27.81 |
| 19679 | 83.24 | 440.67 | 183.93 | 755.52 | 202.10 |
| 15701 | 83.20 | 63.42 | 22.84 | 30.93 | 12.46 |
| 20896 | 83.09 | 106.66 | 65.89 | 141.12 | 40.19 |
| 13646 | 82.98 | 1169.38 | 295.87 | 817.10 | 184.73 |
| 6343 | 82.92 | 46.79 | 4.81 | 34.28 | 11.62 |
| 1877 | 82.89 | 444.75 | 101.68 | 652.86 | 170.37 |
| 24437 | 82.76 | 56.38 | 5.77 | 61.94 | 29.69 |
| 16948 | 82.71 | 145.85 | 69.01 | 317.13 | 132.79 |
| 825 | 82.62 | 22.20 | 8.99 | 46.45 | 18.16 |
| 25862 | 82.39 | 38.61 | 8.30 | 23.01 | 10.20 |
| 1143 | 82.38 | 131.83 | 21.57 | 92.25 | 32.27 |
| 20708 | 82.38 | 80.85 | 9.57 | 61.19 | 17.28 |
| 20833 | 82.32 | 1010.33 | 178.76 | 1449.79 | 326.39 |
| 19144 | 82.32 | 36.63 | 8.07 | 25.15 | 10.80 |
| 2632 | 82.26 | 190.41 | 17.08 | 153.91 | 30.61 |
| 1644 | 82.23 | 418.83 | 62.93 | 560.68 | 126.32 |
| 3015 | 82.18 | 2837.91 | 186.68 | 2819.00 | 1012.99 |
| 7505 | 81.98 | 274.29 | 43.54 | 384.55 | 118.76 |
| 1509 | 81.62 | 431.65 | 81.24 | 550.73 | 118.16 |
| 25921 | 81.56 | 47.30 | 10.74 | 28.36 | 16.07 |
| 1460 | 81.41 | 281.25 | 87.21 | 192.24 | 83.91 |
| 1929 | 81.33 | 536.97 | 208.01 | 870.13 | 215.86 |
| 9905 | 81.30 | 538.90 | 116.34 | 744.96 | 153.52 |
| 15072 | 81.24 | 42.04 | 6.55 | 31.15 | 15.09 |

TABLE 5B

| GLGC | LDA | Tox Group | Tox Group | Non-Tox | Non-Tox |
|---|---|---|---|---|---|
| Identifier | Score | Mean | SD | Group Mean | Group SD |
| 7540 | 97.91 | 504.78 | 145.39 | 158.51 | 83.92 |
| 8820 | 97.91 | 743.55 | 284.97 | 139.15 | 119.88 |
| 7299 | 97.61 | 595.57 | 144.70 | 180.65 | 140.60 |
| 5920 | 97.46 | 1412.80 | 271.66 | 635.94 | 191.82 |
| 24200 | 97.01 | 885.64 | 139.99 | 426.56 | 138.77 |
| 17805 | 96.58 | 1504.75 | 444.21 | 682.13 | 328.81 |
| 4661 | 96.19 | 555.94 | 110.43 | 307.06 | 85.59 |
| 15964 | 95.49 | 487.88 | 126.89 | 1089.29 | 286.36 |
| 24197 | 95.31 | 82.06 | 26.90 | 235.59 | 79.78 |
| 15411 | 94.83 | 552.53 | 112.91 | 304.39 | 94.23 |
| 8065 | 94.80 | 236.57 | 31.67 | 163.82 | 37.32 |
| 21977 | 94.77 | 30.72 | 6.14 | 76.98 | 45.11 |
| 725 | 94.04 | 33.60 | 10.05 | 110.06 | 46.60 |
| 14450 | 93.98 | 45.80 | 9.30 | 146.93 | 73.46 |
| 7936 | 93.59 | 82.66 | 12.40 | 137.66 | 31.43 |
| 4330 | 93.19 | 242.18 | 59.53 | 461.51 | 139.37 |
| 21012 | 92.66 | 445.05 | 162.22 | 203.66 | 116.06 |
| 6046 | 92.65 | 83.37 | 33.70 | 193.87 | 62.20 |
| 3465 | 92.50 | 152.39 | 23.63 | 263.07 | 79.12 |
| 15017 | 92.48 | 2241.27 | 415.11 | 1149.81 | 399.55 |
| 7872 | 92.44 | 63.92 | 8.33 | 112.60 | 35.96 |
| 21014 | 92.42 | 352.43 | 145.68 | 149.67 | 82.43 |
| 19067 | 92.38 | 76.83 | 28.49 | 162.21 | 46.61 |
| 8234 | 92.38 | 22.24 | 6.70 | 47.07 | 15.98 |
| 5461 | 91.99 | 694.84 | 296.55 | 199.69 | 117.96 |
| 22311 | 91.96 | 1255.02 | 184.06 | 688.00 | 158.37 |
| 17541 | 91.84 | 1839.84 | 669.37 | 724.33 | 339.91 |
| 16982 | 91.81 | 1036.49 | 606.21 | 130.48 | 296.12 |
| 7937 | 91.71 | 34.46 | 21.21 | 176.64 | 93.91 |
| 15679 | 91.36 | 309.12 | 62.83 | 174.14 | 47.36 |
| 15125 | 91.33 | 3102.06 | 1017.25 | 1525.20 | 405.25 |
| 665 | 91.27 | 849.30 | 217.79 | 538.96 | 94.94 |
| 6278 | 91.08 | 58.48 | 10.10 | 94.99 | 25.06 |
| 14970 | 90.99 | 134.42 | 36.31 | 199.60 | 41.02 |
| 3172 | 90.74 | 36.28 | 40.56 | 206.90 | 111.79 |
| 8104 | 90.62 | 85.37 | 9.09 | 60.70 | 24.71 |
| 23151 | 90.62 | 204.97 | 55.56 | 355.14 | 101.19 |
| 14346 | 90.51 | 174.62 | 63.19 | 52.54 | 90.15 |
| 5930 | 90.51 | 73.85 | 24.31 | 26.85 | 19.94 |
| 1698 | 90.48 | 190.91 | 66.62 | 70.39 | 93.92 |
| 11755 | 90.42 | 343.83 | 127.98 | 144.25 | 136.11 |
| 6014 | 90.36 | 183.73 | 46.62 | 80.51 | 44.34 |
| 16898 | 90.26 | 55.03 | 10.77 | 78.17 | 16.44 |
| 14595 | 90.21 | 167.82 | 59.62 | 77.65 | 33.41 |
| 17401 | 90.15 | 1909.24 | 588.72 | 1010.74 | 422.89 |
| 10446 | 90.14 | 22.58 | 15.15 | 127.88 | 91.52 |
| 13614 | 90.06 | 497.29 | 91.75 | 324.46 | 71.36 |
| 15189 | 90.00 | 4842.58 | 1706.56 | 2020.75 | 1168.41 |
| 15035 | 89.99 | 23.84 | 16.64 | 124.98 | 68.66 |
| 13966 | 89.97 | 227.19 | 38.65 | 159.84 | 32.03 |
| 10434 | 89.97 | 77.07 | 35.03 | 33.65 | 20.30 |
| 1340 | 89.87 | 124.95 | 20.55 | 184.83 | 85.84 |
| 8850 | 89.82 | 175.34 | 58.83 | 99.07 | 34.66 |
| 16521 | 89.73 | 453.74 | 109.04 | 284.15 | 76.30 |
| 12921 | 89.73 | 213.56 | 56.93 | 102.59 | 48.69 |
| 13013 | 89.59 | 32.49 | 10.44 | 65.57 | 21.46 |
| 6758 | 89.57 | 59.84 | 19.18 | 28.92 | 13.70 |
| 22885 | 89.51 | 2441.02 | 725.57 | 1292.56 | 483.73 |
| 20831 | 89.50 | 55.62 | 17.29 | 138.12 | 57.86 |
| 21354 | 89.39 | 640.85 | 156.38 | 418.77 | 127.04 |
| 12979 | 89.39 | 742.50 | 248.93 | 366.97 | 196.56 |
| 11991 | 89.35 | 20.14 | 10.16 | 46.26 | 16.40 |
| 6796 | 89.30 | 304.75 | 71.31 | 192.78 | 51.24 |
| 21976 | 89.24 | 462.91 | 64.44 | 316.41 | 69.92 |
| 20523 | 89.18 | 1004.68 | 208.03 | 579.32 | 164.47 |
| 21975 | 89.03 | 357.73 | 79.92 | 212.58 | 62.99 |
| 9520 | 89.02 | 69.60 | 25.47 | 140.86 | 46.37 |
| 6917 | 88.81 | 111.53 | 14.34 | 176.04 | 69.10 |
| 8888 | 88.78 | 22.26 | 7.29 | 48.79 | 20.58 |
| 1527 | 88.63 | 51.23 | 9.78 | 88.23 | 39.31 |
| 22479 | 88.52 | 693.29 | 140.68 | 417.80 | 129.01 |
| 8099 | 88.52 | 72.23 | 24.65 | 43.64 | 14.56 |
| 12925 | 88.48 | 44.20 | 4.65 | 69.36 | 29.98 |
| 9079 | 88.46 | 1099.28 | 237.43 | 736.13 | 163.45 |
| 1858 | 88.43 | 253.42 | 73.25 | 153.78 | 50.88 |
| 26083 | 88.38 | 403.60 | 200.12 | 1199.39 | 721.99 |
| 8759 | 88.36 | 237.31 | 41.30 | 156.57 | 41.79 |
| 16520 | 87.97 | 174.46 | 63.58 | 88.91 | 110.98 |
| 24566 | 87.61 | 32.95 | 21.32 | 180.03 | 89.43 |
| 1422 | 87.45 | 174.39 | 46.71 | 300.07 | 105.44 |
| 20864 | 87.40 | 3112.64 | 637.13 | 1921.03 | 633.85 |
| 17088 | 87.37 | 98.27 | 17.79 | 58.55 | 31.41 |
| 25106 | 87.02 | 28.05 | 3.19 | 38.61 | 13.12 |
| 3439 | 86.94 | 135.79 | 26.09 | 92.94 | 24.52 |
| 20405 | 86.92 | 133.28 | 70.23 | 29.80 | 29.59 |
| 21145 | 86.79 | 76.23 | 47.54 | 200.42 | 66.53 |
| 2128 | 86.56 | 97.35 | 47.36 | 32.61 | 16.44 |
| 4449 | 86.33 | 156.15 | 44.78 | 243.11 | 70.20 |
| 24893 | 86.30 | 20.58 | 18.68 | 85.55 | 52.17 |
| 23987 | 86.20 | 596.80 | 251.48 | 276.13 | 75.22 |
| 11434 | 86.18 | 181.39 | 56.52 | 324.42 | 119.03 |
| 1847 | 86.15 | 22.26 | 10.03 | 62.17 | 36.21 |
| 20457 | 86.13 | 235.87 | 68.78 | 395.90 | 100.59 |
| 21491 | 86.07 | 67.51 | 10.34 | 100.55 | 23.55 |
| 24232 | 85.94 | 48.69 | 39.24 | 151.29 | 60.27 |
| 15379 | 85.72 | 33.32 | 11.21 | 67.90 | 28.41 |
| 16681 | 85.68 | 134.46 | 57.78 | 63.59 | 25.88 |
| 15761 | 85.67 | 22.22 | 16.23 | 77.85 | 34.65 |
| 13542 | 85.67 | 321.75 | 219.70 | 462.35 | 148.34 |
| 24568 | 85.63 | 78.30 | 23.68 | 153.33 | 67.67 |
| 1729 | 85.55 | 81.89 | 44.56 | 212.81 | 80.84 |
| 13485 | 85.51 | 38.32 | 7.99 | 57.48 | 16.43 |
| 67 | 85.37 | 1551.30 | 178.56 | 1151.89 | 254.88 |
| 6782 | 85.13 | 310.65 | 67.44 | 219.45 | 62.29 |
| 22321 | 85.13 | 138.89 | 29.75 | 94.97 | 68.63 |
| 15124 | 85.11 | 1897.22 | 536.70 | 1048.98 | 283.10 |
| 954 | 84.94 | 54.36 | 5.77 | 71.54 | 20.36 |
| 1894 | 84.89 | 294.35 | 70.10 | 198.20 | 72.90 |
| 1888 | 84.83 | 101.45 | 32.01 | 52.26 | 33.35 |
| 20682 | 84.77 | 226.38 | 89.62 | 409.19 | 108.15 |
| 18246 | 84.64 | 100.99 | 77.72 | 258.41 | 95.94 |
| 20000 | 84.61 | 24.08 | 20.83 | 127.92 | 70.97 |
| 11481 | 84.61 | 20.44 | 15.73 | 65.86 | 29.15 |
| 1529 | 84.43 | 194.31 | 45.08 | 294.86 | 70.18 |
| 14003 | 84.35 | 1575.92 | 414.94 | 932.50 | 241.80 |
| 18597 | 84.32 | 987.07 | 317.42 | 563.12 | 200.20 |
| 20803 | 84.29 | 737.50 | 199.95 | 473.34 | 124.77 |

TABLE 5C

| GLGC | LDA | Tox Group | Tox Group | Non-Tox | Non-Tox |
|---|---|---|---|---|---|
| Identifier | Score | Mean | SD | Group Mean | Group SD |
| 17734 | 98.79 | 321.98 | 49.82 | 114.29 | 102.66 |
| 18642 | 98.09 | 492.19 | 42.17 | 881.32 | 192.80 |
| 21388 | 97.24 | 104.79 | 11.52 | 27.72 | 24.11 |
| 16907 | 96.36 | 33.38 | 19.54 | 131.32 | 51.03 |
| 24042 | 95.76 | 73.75 | 40.11 | 21.09 | 79.30 |
| 22101 | 95.58 | 21.93 | 23.56 | 170.51 | 83.23 |
| 12343 | 95.55 | 89.32 | 12.94 | 50.29 | 16.25 |
| 16948 | 95.36 | 125.57 | 23.36 | 317.27 | 132.70 |
| 1141 | 95.33 | 394.51 | 55.69 | 241.23 | 66.76 |
| 8664 | 95.29 | 1388.21 | 550.83 | 89.50 | 215.23 |
| 7142 | 95.27 | 363.26 | 34.37 | 610.43 | 144.19 |
| 8665 | 95.26 | 2691.53 | 1101.20 | 343.63 | 497.74 |
| 1475 | 95.17 | 2063.49 | 658.77 | 155.80 | 379.29 |
| 16354 | 95.03 | 20.78 | 35.33 | 279.68 | 148.90 |
| 3863 | 94.79 | 122.87 | 17.81 | 196.59 | 86.02 |
| 12561 | 94.73 | 64.62 | 15.14 | 148.52 | 51.53 |
| 18288 | 94.67 | 217.71 | 34.85 | 124.55 | 43.60 |
| 21029 | 94.64 | 126.09 | 12.20 | 81.52 | 23.49 |
| 24649 | 94.42 | 65.78 | 19.06 | 112.21 | 22.95 |
| 1409 | 94.27 | 290.95 | 26.81 | 438.89 | 99.13 |
| 6290 | 94.18 | 167.05 | 14.13 | 232.79 | 37.78 |
| 17735 | 94.05 | 363.65 | 53.62 | 178.33 | 104.47 |
| 11618 | 94.03 | 224.46 | 33.16 | 380.82 | 110.84 |
| 14083 | 93.91 | 297.20 | 43.33 | 473.74 | 100.64 |
| 16518 | 93.89 | 2054.01 | 385.94 | 949.88 | 306.74 |
| 10004 | 93.55 | 78.40 | 13.45 | 39.38 | 19.65 |
| 3474 | 93.52 | 345.67 | 22.76 | 483.73 | 104.79 |
| 1764 | 93.42 | 138.74 | 17.01 | 88.17 | 27.95 |
| 17570 | 93.36 | 379.60 | 47.99 | 240.61 | 81.89 |
| 21672 | 93.27 | 447.28 | 37.64 | 314.18 | 77.63 |
| 23758 | 93.24 | 103.71 | 16.35 | 174.80 | 41.71 |
| 7586 | 93.24 | 455.38 | 78.29 | 769.55 | 187.42 |
| 809 | 93.23 | 100.66 | 16.68 | 39.56 | 39.66 |
| 17938 | 93.15 | 319.01 | 21.59 | 447.84 | 95.68 |
| 22412 | 93.08 | 196.70 | 39.42 | 91.13 | 45.28 |
| 11559 | 93.06 | 318.57 | 60.32 | 552.63 | 125.46 |
| 7300 | 93.06 | 545.82 | 63.96 | 744.66 | 285.54 |
| 22415 | 92.95 | 375.76 | 48.28 | 206.41 | 158.59 |
| 21400 | 92.85 | 211.40 | 61.58 | 361.76 | 72.81 |
| 20161 | 92.68 | 128.82 | 47.99 | 32.65 | 31.21 |
| 25547 | 92.64 | 407.00 | 28.91 | 267.96 | 104.45 |
| 9116 | 92.64 | 273.80 | 27.04 | 392.81 | 75.75 |
| 12551 | 92.58 | 95.87 | 15.38 | 164.16 | 42.22 |
| 3091 | 92.52 | 531.24 | 38.99 | 712.74 | 159.66 |
| 5565 | 92.52 | 206.09 | 47.75 | 389.83 | 117.52 |
| 21990 | 92.48 | 28.82 | 20.42 | 121.58 | 57.45 |
| 25606 | 92.45 | 66.28 | 8.55 | 40.17 | 15.01 |
| 16003 | 92.45 | 198.48 | 23.57 | 334.94 | 104.96 |
| 7049 | 92.42 | 153.66 | 20.90 | 227.04 | 46.15 |
| 18350 | 92.35 | 276.28 | 122.54 | 92.32 | 51.93 |
| 503 | 92.18 | 150.85 | 14.24 | 103.15 | 29.15 |
| 20173 | 92.18 | 32.74 | 11.51 | 77.29 | 31.95 |
| 17755 | 92.18 | 246.88 | 32.61 | 383.76 | 97.58 |
| 1460 | 92.12 | 251.67 | 29.18 | 192.46 | 84.37 |
| 24672 | 92.12 | 65.39 | 7.99 | 39.44 | 14.11 |
| 10667 | 92.09 | 94.44 | 15.07 | 38.95 | 41.37 |
| 6632 | 92.08 | 270.94 | 30.65 | 167.71 | 54.30 |
| 6736 | 92.06 | 131.85 | 22.79 | 69.09 | 33.18 |
| 6675 | 92.06 | 362.12 | 33.19 | 548.28 | 144.52 |
| 19768 | 92.02 | 1218.83 | 166.71 | 787.22 | 172.80 |
| 3698 | 91.97 | 66.85 | 13.21 | 128.16 | 41.97 |
| 9583 | 91.92 | 154.31 | 44.35 | 55.84 | 61.67 |
| 7936 | 91.91 | 84.99 | 15.68 | 137.74 | 31.39 |
| 6595 | 91.85 | 109.39 | 17.61 | 68.80 | 30.49 |
| 1581 | 91.79 | 87.16 | 7.56 | 66.76 | 21.04 |
| 2824 | 91.79 | 65.68 | 9.52 | 100.88 | 21.89 |
| 19040 | 91.74 | 323.49 | 86.16 | 184.44 | 121.72 |
| 23834 | 91.74 | 142.01 | 30.15 | 74.82 | 24.22 |
| 23033 | 91.64 | 422.53 | 36.80 | 579.14 | 117.96 |
| 21025 | 91.61 | 267.66 | 41.37 | 417.82 | 107.31 |
| 4952 | 91.59 | 200.30 | 34.51 | 106.14 | 44.92 |
| 21211 | 91.55 | 548.25 | 69.20 | 850.78 | 217.13 |
| 22413 | 91.53 | 141.51 | 32.80 | 68.54 | 38.43 |
| 8837 | 91.52 | 234.73 | 29.31 | 331.74 | 63.42 |
| 21653 | 91.50 | 363.77 | 66.02 | 237.45 | 68.10 |
| 4462 | 91.48 | 567.85 | 100.01 | 952.66 | 315.50 |
| 12450 | 91.48 | 35.96 | 20.64 | 127.75 | 69.86 |
| 11162 | 91.45 | 324.91 | 48.59 | 495.59 | 118.35 |
| 2555 | 91.44 | 145.97 | 22.76 | 85.01 | 42.88 |
| 605 | 91.39 | 38.02 | 5.26 | 21.20 | 10.90 |
| 15138 | 91.39 | 196.35 | 69.14 | 471.14 | 175.95 |
| 25379 | 91.38 | 117.64 | 16.80 | 71.75 | 25.39 |
| 235 | 91.30 | 320.65 | 25.66 | 230.34 | 61.53 |
| 1929 | 91.29 | 473.25 | 68.26 | 870.59 | 215.67 |
| 17256 | 91.27 | 259.66 | 52.16 | 429.33 | 122.40 |
| 24459 | 91.21 | 398.68 | 40.21 | 276.39 | 76.14 |
| 13610 | 91.17 | 219.12 | 31.55 | 365.11 | 107.30 |
| 35 | 91.15 | 784.74 | 75.75 | 1207.71 | 355.24 |
| 12016 | 91.15 | 252.53 | 37.75 | 465.80 | 181.24 |
| 21683 | 91.05 | 65.76 | 22.22 | 27.27 | 20.99 |
| 1501 | 91.02 | 99.81 | 25.56 | 52.93 | 56.99 |
| 25747 | 90.98 | 80.78 | 19.33 | 42.91 | 38.40 |
| 23166 | 90.98 | 229.86 | 42.08 | 126.92 | 62.06 |
| 25279 | 90.97 | 751.86 | 61.65 | 549.26 | 116.47 |
| 9224 | 90.94 | 418.49 | 23.57 | 559.20 | 140.71 |
| 4542 | 90.94 | 270.11 | 21.67 | 180.81 | 56.07 |
| 21696 | 90.92 | 282.32 | 32.07 | 175.33 | 47.74 |
| 20753 | 90.89 | 184.62 | 20.62 | 119.99 | 28.26 |
| 433 | 90.88 | 134.41 | 23.78 | 80.86 | 34.13 |
| 19251 | 90.88 | 562.71 | 31.16 | 694.44 | 105.77 |
| 16469 | 90.82 | 1028.80 | 54.62 | 1320.78 | 271.98 |
| 15791 | 90.79 | 201.52 | 56.18 | 123.78 | 84.57 |
| 17226 | 90.79 | 433.99 | 33.61 | 577.07 | 118.33 |
| 15421 | 90.70 | 562.11 | 32.28 | 738.52 | 153.62 |
| 20085 | 90.68 | 375.42 | 39.17 | 247.93 | 59.19 |
| 407 | 90.64 | 264.48 | 35.26 | 395.09 | 94.07 |
| 17426 | 90.61 | 429.40 | 38.59 | 568.65 | 91.40 |
| 2098 | 90.58 | 232.32 | 22.55 | 177.21 | 39.37 |
| 13005 | 90.56 | 143.19 | 30.68 | 80.63 | 29.18 |
| 25098 | 90.52 | 176.46 | 75.02 | 35.80 | 33.18 |
| 10241 | 90.38 | 114.02 | 25.12 | 59.17 | 24.28 |
| 23679 | 90.38 | 78.01 | 14.28 | 38.29 | 19.90 |
| 16520 | 90.36 | 123.97 | 17.89 | 89.12 | 111.29 |

TABLE 5D

| GLGC | LDA | Tox Group | Tox Group | Non-Tox | Non-Tox |
|---|---|---|---|---|---|
| Identifier | Score | Mean | SD | Group Mean | Group SD |
| 15291 | 97.74 | 227.69 | 93.17 | 97.65 | 27.73 |
| 7896 | 97.71 | 173.75 | 8.10 | 283.20 | 65.35 |
| 3631 | 97.59 | 146.49 | 9.89 | 93.75 | 22.59 |
| 2232 | 97.16 | 36.74 | 0.82 | 24.79 | 11.77 |
| 23626 | 97.10 | 201.76 | 49.28 | 78.54 | 37.73 |
| 24762 | 97.07 | 206.67 | 49.31 | 926.38 | 314.75 |
| 3493 | 96.95 | 123.15 | 24.99 | 61.58 | 18.38 |
| 16625 | 96.89 | 237.89 | 5.08 | 180.96 | 38.01 |
| 11959 | 96.86 | 62.25 | 10.64 | 125.40 | 27.59 |
| 15027 | 96.86 | 228.67 | 10.97 | 139.90 | 39.67 |
| 16338 | 96.77 | 97.00 | 8.89 | 58.64 | 16.37 |
| 5901 | 96.74 | 159.91 | 19.26 | 91.66 | 42.91 |
| 2423 | 96.59 | 192.07 | 14.10 | 132.98 | 27.14 |
| 12797 | 96.56 | 166.69 | 40.58 | 73.77 | 27.51 |
| 11558 | 96.56 | 70.08 | 17.91 | 160.77 | 43.05 |
| 2534 | 96.56 | 68.06 | 11.48 | 35.59 | 11.40 |
| 23790 | 96.53 | 123.00 | 38.12 | 63.08 | 19.14 |
| 16859 | 96.50 | 245.89 | 56.54 | 122.60 | 47.46 |
| 23698 | 96.41 | 147.28 | 9.50 | 275.19 | 124.72 |
| 16824 | 96.41 | 72.56 | 17.91 | 227.30 | 79.50 |
| 17223 | 96.41 | 1104.50 | 35.58 | 868.15 | 118.29 |
| 2113 | 96.38 | 222.44 | 37.93 | 132.53 | 29.47 |
| 18418 | 96.35 | 370.51 | 71.34 | 245.92 | 41.02 |
| 23843 | 96.32 | 187.45 | 30.50 | 103.55 | 28.14 |
| 21659 | 96.32 | 386.36 | 74.64 | 204.80 | 61.71 |
| 22538 | 96.29 | 172.72 | 15.27 | 339.80 | 93.47 |
| 12129 | 96.29 | 143.53 | 31.03 | 645.40 | 334.58 |
| 15232 | 96.26 | 257.50 | 24.61 | 169.53 | 35.85 |
| 17523 | 96.17 | 123.97 | 10.52 | 81.13 | 19.15 |
| 5290 | 96.17 | 22.52 | 4.12 | 50.65 | 15.13 |
| 19152 | 96.14 | 320.13 | 96.93 | 160.67 | 53.93 |
| 22180 | 96.14 | 145.82 | 40.45 | 88.52 | 23.95 |
| 8721 | 96.14 | 35.66 | 23.53 | 183.51 | 66.31 |
| 19412 | 96.11 | 219.32 | 2.99 | 183.37 | 50.07 |
| 7700 | 96.11 | 135.98 | 23.23 | 80.56 | 43.28 |
| 24592 | 96.05 | 74.35 | 27.61 | 329.43 | 142.17 |
| 23018 | 96.05 | 150.06 | 18.94 | 105.15 | 19.40 |
| 7270 | 96.02 | 267.75 | 28.36 | 171.64 | 36.71 |
| 15159 | 96.02 | 419.08 | 74.41 | 872.31 | 214.06 |
| 22770 | 95.99 | 460.91 | 61.30 | 293.34 | 60.75 |
| 13106 | 95.99 | 68.92 | 9.31 | 37.20 | 21.98 |
| 22537 | 95.96 | 40.88 | 34.27 | 301.20 | 137.68 |
| 14332 | 95.90 | 951.74 | 99.04 | 604.90 | 155.26 |
| 17419 | 95.90 | 336.07 | 70.94 | 197.65 | 45.14 |
| 17468 | 95.87 | 240.19 | 29.50 | 414.57 | 80.60 |
| 20829 | 95.84 | 1805.57 | 324.13 | 925.21 | 315.25 |
| 19469 | 95.84 | 134.02 | 40.80 | 367.99 | 99.90 |
| 12673 | 95.84 | 106.88 | 41.08 | 40.72 | 22.46 |
| 18095 | 95.84 | 1118.60 | 126.43 | 801.84 | 125.83 |
| 19665 | 95.81 | 204.31 | 35.07 | 88.59 | 51.54 |
| 2348 | 95.81 | 97.18 | 36.13 | 463.64 | 200.40 |
| 13940 | 95.72 | 100.29 | 27.43 | 216.02 | 51.74 |
| 12682 | 95.62 | 511.62 | 150.58 | 1734.71 | 588.20 |
| 13157 | 95.59 | 99.31 | 44.78 | 328.67 | 105.58 |
| 15277 | 95.56 | 1199.28 | 124.15 | 856.07 | 134.65 |
| 6055 | 95.56 | 447.44 | 133.36 | 1045.52 | 255.69 |
| 3145 | 95.56 | 152.93 | 22.06 | 426.44 | 138.00 |
| 16731 | 95.53 | 164.04 | 17.44 | 86.12 | 38.17 |
| 1431 | 95.53 | 84.36 | 35.10 | 462.05 | 168.52 |
| 3934 | 95.50 | 716.78 | 83.73 | 1225.51 | 254.53 |
| 15339 | 95.47 | 139.74 | 20.03 | 227.15 | 74.31 |
| 21959 | 95.41 | 234.36 | 36.74 | 132.11 | 42.91 |
| 13104 | 95.32 | 217.32 | 35.96 | 479.57 | 130.05 |
| 15246 | 95.23 | 104.02 | 19.45 | 63.14 | 17.15 |
| 12355 | 95.20 | 55.04 | 2.97 | 32.72 | 17.38 |
| 6869 | 95.20 | 79.10 | 7.52 | 32.43 | 29.17 |
| 23839 | 95.17 | 215.43 | 62.86 | 469.65 | 119.97 |
| 11615 | 95.14 | 539.91 | 16.66 | 412.37 | 87.18 |
| 1479 | 95.11 | 92.37 | 36.66 | 221.32 | 62.74 |
| 2107 | 95.11 | 260.72 | 38.29 | 437.31 | 95.82 |
| 19268 | 95.08 | 1507.38 | 104.73 | 1082.49 | 316.16 |
| 21587 | 95.08 | 63.47 | 12.04 | 184.59 | 76.44 |
| 8215 | 95.08 | 916.05 | 104.30 | 1510.03 | 332.10 |
| 14353 | 95.05 | 92.56 | 11.29 | 55.60 | 17.26 |
| 17378 | 95.02 | 212.42 | 29.92 | 131.90 | 39.98 |
| 6629 | 95.02 | 314.77 | 37.87 | 540.04 | 121.47 |
| 12095 | 94.99 | 365.17 | 58.23 | 1298.24 | 810.83 |
| 8739 | 94.99 | 97.84 | 18.34 | 265.76 | 118.29 |
| 25377 | 94.93 | 56.11 | 8.35 | 26.88 | 13.79 |
| 1510 | 94.93 | 412.23 | 94.86 | 837.44 | 225.06 |
| 19347 | 94.93 | 82.73 | 6.92 | 47.68 | 20.04 |
| 23307 | 94.90 | 142.12 | 10.93 | 93.63 | 26.00 |
| 18524 | 94.90 | 410.60 | 75.64 | 697.54 | 141.17 |
| 24615 | 94.84 | 1270.53 | 105.47 | 933.13 | 210.70 |
| 17823 | 94.84 | 683.68 | 66.28 | 459.89 | 95.30 |
| 1511 | 94.81 | 28.36 | 22.05 | 333.19 | 206.19 |
| 989 | 94.78 | 38.30 | 12.87 | 147.38 | 60.50 |
| 12276 | 94.78 | 72.82 | 16.26 | 186.84 | 61.45 |
| 19936 | 94.78 | 417.94 | 86.08 | 787.51 | 166.53 |
| 5297 | 94.75 | 143.95 | 30.44 | 352.41 | 109.46 |
| 19679 | 94.75 | 329.18 | 166.41 | 754.53 | 202.48 |
| 1798 | 94.69 | 119.14 | 47.77 | 336.07 | 205.61 |
| 16070 | 94.60 | 96.59 | 3.46 | 128.18 | 52.11 |
| 23625 | 94.57 | 138.13 | 48.08 | 319.20 | 91.62 |
| 16775 | 94.57 | 349.58 | 178.66 | 1164.24 | 399.53 |
| 21882 | 94.51 | 486.74 | 47.85 | 758.64 | 167.24 |
| 24582 | 94.45 | 69.68 | 15.24 | 31.85 | 17.38 |
| 14996 | 94.42 | 206.77 | 60.78 | 471.76 | 163.11 |
| 24590 | 94.36 | 43.33 | 17.37 | 166.07 | 70.63 |
| 4473 | 94.36 | 67.70 | 30.48 | 172.24 | 49.29 |
| 8640 | 94.33 | 66.36 | 5.36 | 141.04 | 58.77 |
| 23806 | 94.33 | 167.38 | 49.48 | 459.19 | 167.23 |
| 21086 | 94.21 | 164.64 | 11.89 | 103.24 | 34.93 |
| 21586 | 94.18 | 70.26 | 31.01 | 220.53 | 67.79 |
| 2632 | 94.09 | 197.64 | 7.08 | 154.04 | 30.64 |
| 21305 | 94.06 | 194.67 | 46.54 | 437.54 | 129.56 |
| 18269 | 94.00 | 394.51 | 86.48 | 771.13 | 179.69 |
| 5496 | 93.96 | 268.43 | 102.39 | 651.85 | 166.35 |
| 14983 | 93.93 | 3935.84 | 130.20 | 5873.51 | 4368.56 |
| 729 | 93.93 | 39.48 | 6.73 | 77.25 | 26.06 |
| 1929 | 93.93 | 476.55 | 93.68 | 868.90 | 216.79 |
| 347 | 93.87 | 123.84 | 14.40 | 78.57 | 23.09 |
| 3863 | 93.87 | 25.92 | 20.32 | 196.57 | 85.56 |
| 20740 | 93.84 | 355.52 | 75.34 | 210.92 | 62.22 |
| 17923 | 93.81 | 83.10 | 5.93 | 58.07 | 17.69 |
| 15926 | 93.75 | 149.75 | 18.03 | 92.20 | 42.90 |
| 25692 | 93.75 | 70.08 | 7.62 | 156.74 | 181.44 |
| 4504 | 93.75 | 445.80 | 139.02 | 1087.15 | 323.13 |
| 1159 | 93.75 | 590.14 | 150.75 | 991.96 | 225.85 |
| 13939 | 93.72 | 124.71 | 48.61 | 325.12 | 109.46 |
| 17469 | 93.72 | 34.52 | 5.63 | 72.44 | 30.50 |
| 17836 | 93.69 | 121.68 | 5.52 | 90.78 | 19.92 |
| 22124 | 93.60 | 116.89 | 12.88 | 78.17 | 21.00 |
| 20960 | 93.54 | 443.32 | 50.92 | 295.69 | 74.33 |
| 5497 | 93.48 | 371.29 | 150.42 | 785.01 | 190.34 |
| 21672 | 93.48 | 474.43 | 83.01 | 314.66 | 77.75 |
| 22669 | 93.45 | 61.36 | 13.28 | 33.21 | 14.07 |
| 15844 | 93.36 | 70.68 | 14.50 | 37.72 | 16.43 |
| 20780 | 93.33 | 152.07 | 119.67 | 539.74 | 202.23 |
| 20809 | 93.33 | 437.50 | 34.89 | 329.95 | 63.72 |
| 21585 | 93.18 | 157.63 | 45.39 | 342.07 | 89.26 |
| 13369 | 93.12 | 232.19 | 7.82 | 184.45 | 38.15 |
| 21123 | 93.09 | 321.71 | 96.61 | 661.80 | 184.33 |
| 15242 | 93.06 | 108.52 | 12.92 | 80.06 | 15.30 |
| 1081 | 93.03 | 278.96 | 102.51 | 527.65 | 126.56 |
| 4589 | 92.97 | 724.19 | 281.99 | 1414.61 | 338.33 |
| 8664 | 92.82 | 246.38 | 136.12 | 98.44 | 245.29 |
| 1877 | 92.82 | 314.31 | 125.56 | 652.38 | 170.00 |
| 23699 | 92.76 | 186.00 | 34.99 | 331.03 | 104.73 |
| 474 | 92.73 | 490.32 | 88.10 | 749.79 | 130.85 |
| 1447 | 92.70 | 268.68 | 38.24 | 201.70 | 34.81 |
| 8984 | 92.67 | 399.31 | 28.86 | 308.62 | 53.47 |

TABLE 5E

| GLGC | LDA | Tox Group | Tox Group | Non-Tox | Non-Tox |
|---|---|---|---|---|---|
| Identifier | Score | Mean | SD | Group Mean | Group SD |
| 17570 | 99.82 | 642.60 | 29.35 | 240.16 | 79.04 |
| 25470 | 99.79 | 125.97 | 5.72 | 31.22 | 18.52 |
| 19377 | 99.76 | 215.21 | 4.72 | 109.43 | 24.18 |
| 455 | 99.73 | 571.19 | 126.84 | 138.41 | 189.56 |
| 896 | 99.67 | 191.75 | 36.71 | 23.81 | 21.26 |
| 9309 | 99.67 | 329.43 | 22.61 | 174.98 | 41.72 |
| 17226 | 99.64 | 253.12 | 22.46 | 577.21 | 117.15 |
| 699 | 99.61 | 74.54 | 12.40 | 23.01 | 34.32 |
| 13563 | 99.55 | 355.81 | 42.90 | 937.62 | 228.58 |
| 22540 | 99.49 | 599.57 | 49.16 | 1780.91 | 551.74 |
| 23780 | 99.43 | 120.05 | 46.77 | 20.80 | 30.16 |
| 17289 | 99.43 | 410.41 | 33.11 | 1059.53 | 278.91 |
| 21959 | 99.40 | 327.36 | 32.91 | 131.72 | 41.66 |
| 13973 | 99.34 | 247.62 | 42.45 | 33.40 | 20.04 |
| 22984 | 99.34 | 266.02 | 27.63 | 100.26 | 30.89 |
| 11421 | 99.31 | 341.72 | 20.35 | 194.63 | 40.25 |
| 22618 | 99.31 | 117.66 | 20.00 | 30.61 | 11.80 |
| 5497 | 99.28 | 248.05 | 17.62 | 785.70 | 189.15 |
| 5929 | 99.28 | 168.33 | 15.69 | 36.89 | 20.17 |
| 16007 | 99.25 | 128.45 | 19.80 | 21.47 | 13.08 |
| 16610 | 99.25 | 316.65 | 10.82 | 165.32 | 65.78 |
| 12606 | 99.25 | 130.99 | 7.64 | 295.10 | 99.03 |
| 17695 | 99.21 | 249.77 | 34.66 | 668.20 | 180.15 |
| 895 | 99.21 | 668.52 | 123.70 | 177.65 | 76.45 |
| 23810 | 99.21 | 84.71 | 11.03 | 27.57 | 13.19 |
| 3083 | 99.21 | 158.35 | 14.18 | 74.00 | 21.63 |
| 16967 | 99.18 | 136.29 | 21.82 | 33.25 | 18.18 |
| 17290 | 99.18 | 509.27 | 62.67 | 1294.21 | 373.99 |
| 20494 | 99.15 | 297.13 | 78.23 | 1055.83 | 319.86 |
| 894 | 99.15 | 1783.60 | 174.73 | 652.12 | 224.42 |
| 16913 | 99.15 | 613.71 | 52.52 | 1257.86 | 287.28 |
| 11079 | 99.12 | 328.58 | 20.15 | 185.07 | 44.66 |
| 5206 | 99.12 | 507.97 | 41.61 | 176.59 | 17.00 |
| 15273 | 99.09 | 132.66 | 22.37 | 32.60 | 18.78 |
| 16726 | 99.09 | 352.81 | 48.90 | 1059.59 | 226.33 |
| 17256 | 99.09 | 125.36 | 14.47 | 429.20 | 121.73 |
| 19058 | 99.06 | 122.17 | 14.88 | 52.83 | 19.42 |
| 17227 | 99.06 | 499.29 | 60.99 | 982.39 | 179.08 |
| 1801 | 99.06 | 255.70 | 34.95 | 89.47 | 28.47 |
| 23958 | 99.06 | 203.79 | 34.98 | 61.18 | 25.94 |
| 23778 | 99.03 | 364.40 | 111.41 | 62.36 | 35.91 |
| 20167 | 99.03 | 96.57 | 19.35 | 24.31 | 11.29 |
| 3269 | 99.03 | 366.86 | 112.74 | 81.91 | 44.65 |
| 3572 | 99.03 | 172.95 | 63.76 | 38.98 | 21.80 |
| 16675 | 99.00 | 328.75 | 104.16 | 29.43 | 36.26 |
| 7124 | 99.00 | 529.78 | 56.03 | 1203.74 | 312.97 |
| 3925 | 99.00 | 198.37 | 20.86 | 461.33 | 112.52 |
| 410 | 99.00 | 465.49 | 50.55 | 1037.75 | 225.86 |
| 3584 | 99.00 | 203.98 | 20.49 | 61.56 | 30.32 |
| 8325 | 98.97 | 99.90 | 20.29 | 23.02 | 13.28 |
| 20828 | 98.97 | 1005.07 | 82.88 | 323.14 | 162.23 |
| 23533 | 98.97 | 204.49 | 10.44 | 83.11 | 38.10 |
| 1993 | 98.94 | 96.08 | 5.11 | 24.14 | 17.89 |
| 15008 | 98.94 | 306.66 | 36.44 | 576.58 | 114.19 |
| 16676 | 98.91 | 271.51 | 96.32 | 33.53 | 29.58 |
| 4450 | 98.91 | 136.12 | 13.21 | 279.34 | 61.49 |
| 15437 | 98.91 | 193.06 | 63.58 | 32.08 | 19.16 |
| 12616 | 98.91 | 144.41 | 20.14 | 60.76 | 20.41 |
| 7665 | 98.91 | 723.79 | 74.48 | 290.61 | 94.65 |
| 17301 | 98.88 | 593.47 | 75.23 | 238.07 | 75.73 |
| 16674 | 98.88 | 180.45 | 57.13 | 27.50 | 22.94 |
| 1564 | 98.88 | 1294.14 | 223.87 | 44.50 | 193.91 |
| 16082 | 98.88 | 129.78 | 28.85 | 40.75 | 17.41 |
| 23532 | 98.88 | 124.66 | 30.17 | 22.30 | 16.51 |
| 1462 | 98.85 | 1628.61 | 155.82 | 431.68 | 216.05 |
| 9084 | 98.85 | 145.53 | 46.17 | 40.68 | 17.08 |
| 6022 | 98.85 | 414.10 | 35.32 | 217.84 | 63.57 |
| 3099 | 98.85 | 554.56 | 35.33 | 894.32 | 163.71 |
| 17535 | 98.82 | 560.61 | 73.51 | 244.84 | 64.97 |
| 23699 | 98.82 | 137.82 | 16.18 | 331.30 | 104.43 |
| 17514 | 98.82 | 358.61 | 50.80 | 817.29 | 188.14 |
| 5952 | 98.82 | 255.47 | 23.17 | 83.50 | 40.80 |
| 535 | 98.79 | 96.78 | 13.35 | 38.89 | 21.47 |
| 21651 | 98.79 | 211.95 | 80.37 | 26.88 | 22.79 |
| 5496 | 98.79 | 219.25 | 23.70 | 652.26 | 165.76 |
| 15175 | 98.79 | 116.18 | 37.93 | 319.43 | 57.36 |
| 23961 | 98.79 | 379.40 | 51.33 | 785.34 | 150.80 |
| 18168 | 98.79 | 168.33 | 33.83 | 38.38 | 34.80 |
| 16884 | 98.79 | 1053.19 | 76.80 | 1909.01 | 474.48 |
| 25233 | 98.76 | 62.01 | 2.18 | 31.39 | 13.04 |
| 19834 | 98.76 | 416.63 | 72.40 | 169.62 | 42.80 |
| 21122 | 98.76 | 534.05 | 73.79 | 1146.33 | 236.16 |
| 17661 | 98.76 | 580.72 | 105.12 | 262.94 | 68.13 |
| 574 | 98.73 | 912.07 | 67.77 | 352.32 | 185.51 |
| 1409 | 98.73 | 201.45 | 22.59 | 438.68 | 98.73 |
| 20886 | 98.70 | 94.56 | 45.86 | 798.30 | 318.63 |
| 8426 | 98.67 | 120.65 | 12.99 | 49.38 | 20.34 |
| 1490 | 98.67 | 52.85 | 7.86 | 20.79 | 7.83 |
| 17516 | 98.64 | 304.60 | 25.38 | 547.56 | 127.91 |
| 16871 | 98.64 | 206.80 | 46.25 | 79.45 | 24.72 |
| 22927 | 98.64 | 210.74 | 21.37 | 84.48 | 34.52 |
| 7101 | 98.61 | 3734.58 | 971.30 | 404.36 | 664.35 |
| 15790 | 98.61 | 112.29 | 21.33 | 35.96 | 18.51 |
| 457 | 98.61 | 897.31 | 151.83 | 285.93 | 92.35 |
| 1929 | 98.61 | 362.48 | 40.32 | 869.55 | 215.82 |
| 16650 | 98.58 | 650.04 | 84.16 | 256.56 | 84.67 |
| 15002 | 98.55 | 420.90 | 46.06 | 135.44 | 107.26 |
| 17345 | 98.55 | 263.93 | 24.68 | 127.21 | 36.29 |
| 20887 | 98.52 | 191.50 | 66.84 | 871.37 | 342.61 |
| 16649 | 98.52 | 361.29 | 75.07 | 105.60 | 48.12 |
| 7196 | 98.52 | 549.97 | 33.63 | 177.67 | 91.15 |
| 1877 | 98.52 | 254.30 | 28.09 | 652.80 | 169.49 |
| 20582 | 98.52 | 287.05 | 13.73 | 487.15 | 95.43 |

TABLE 5F

| GLGC | LDA | Tox Group | Tox Group | Non-Tox | Non-Tox |
|---|---|---|---|---|---|
| Identifier | Score | Mean | SD | Group Mean | Group SD |
| 23115 | 96.27 | 218.73 | 37.94 | 504.64 | 158.87 |
| 18285 | 94.66 | 425.99 | 37.64 | 688.90 | 152.65 |
| 18522 | 94.29 | 477.42 | 63.58 | 759.42 | 194.18 |
| 21105 | 93.53 | 188.56 | 23.10 | 300.96 | 60.90 |
| 9504 | 93.05 | 71.31 | 11.15 | 48.44 | 20.69 |
| 13934 | 92.71 | 180.15 | 27.02 | 68.19 | 54.80 |
| 11653 | 92.35 | 269.88 | 75.12 | 561.59 | 194.36 |
| 15489 | 91.68 | 96.70 | 14.21 | 141.82 | 34.76 |
| 3279 | 91.44 | 394.77 | 37.63 | 552.89 | 119.12 |
| 2264 | 91.41 | 134.06 | 11.12 | 101.59 | 24.28 |
| 2282 | 91.08 | 90.03 | 26.05 | 212.24 | 65.58 |
| 22271 | 91.08 | 114.39 | 43.35 | 247.46 | 57.55 |
| 11232 | 90.98 | 413.94 | 45.20 | 291.89 | 76.35 |
| 11326 | 90.95 | 191.68 | 30.66 | 319.99 | 87.52 |
| 1649 | 90.83 | 363.72 | 54.17 | 561.87 | 156.83 |
| 10849 | 90.74 | 108.53 | 15.45 | 73.98 | 26.10 |
| 11618 | 90.72 | 179.78 | 41.87 | 381.46 | 109.96 |
| 13611 | 90.71 | 141.12 | 35.24 | 249.73 | 83.52 |
| 2912 | 90.60 | 1472.50 | 191.19 | 2440.94 | 597.53 |
| 14978 | 90.59 | 115.74 | 17.67 | 69.00 | 30.46 |
| 26133 | 90.48 | 395.06 | 106.85 | 188.25 | 84.91 |
| 783 | 90.47 | 122.89 | 16.37 | 83.12 | 25.36 |
| 11198 | 90.47 | 66.09 | 9.13 | 43.72 | 15.80 |
| 13457 | 90.47 | 108.45 | 8.39 | 75.26 | 26.79 |
| 4280 | 90.44 | 2201.62 | 242.72 | 1538.01 | 535.02 |
| 17268 | 90.32 | 317.63 | 20.88 | 445.26 | 113.01 |
| 25235 | 90.29 | 187.30 | 55.17 | 84.23 | 49.84 |
| 5837 | 90.29 | 586.00 | 88.17 | 850.13 | 202.51 |
| 165 | 90.11 | 145.31 | 43.89 | 58.63 | 36.81 |
| 20555 | 90.10 | 70.09 | 13.74 | 116.38 | 35.29 |
| 24233 | 90.10 | 411.31 | 46.44 | 567.75 | 108.66 |
| 26173 | 90.08 | 265.60 | 25.65 | 171.81 | 48.30 |
| 9332 | 90.02 | 39.70 | 10.71 | 102.53 | 42.52 |
| 4451 | 90.01 | 192.78 | 31.81 | 290.75 | 72.79 |
| 5430 | 89.98 | 60.14 | 21.49 | 135.42 | 58.52 |
| 16887 | 89.89 | 107.51 | 10.43 | 154.97 | 45.52 |
| 4987 | 89.86 | 161.07 | 15.62 | 234.26 | 58.10 |
| 15904 | 89.80 | 81.53 | 10.99 | 56.69 | 23.58 |
| 22985 | 89.78 | 61.31 | 12.25 | 109.17 | 29.50 |
| 2964 | 89.74 | 207.16 | 29.50 | 295.32 | 59.24 |
| 150 | 89.74 | 44.55 | 4.99 | 31.82 | 9.68 |
| 12684 | 89.68 | 216.15 | 19.77 | 153.61 | 44.73 |
| 1946 | 89.66 | 64.08 | 9.55 | 39.55 | 12.41 |
| 10069 | 89.56 | 267.84 | 30.41 | 197.01 | 47.53 |
| 18447 | 89.54 | 602.70 | 133.92 | 1098.88 | 276.35 |
| 19930 | 89.51 | 49.33 | 6.03 | 28.71 | 11.78 |
| 13020 | 89.44 | 111.03 | 18.18 | 74.64 | 23.70 |
| 14410 | 89.40 | 133.78 | 15.12 | 184.02 | 38.17 |
| 22929 | 89.40 | 330.05 | 142.49 | 797.70 | 312.82 |
| 19890 | 89.34 | 114.05 | 11.07 | 80.22 | 26.45 |
| 15028 | 89.26 | 172.40 | 66.68 | 366.39 | 126.77 |
| 6630 | 89.22 | 1020.91 | 101.07 | 1270.63 | 199.90 |
| 8944 | 89.19 | 61.50 | 9.22 | 40.45 | 16.66 |
| 23748 | 89.13 | 67.98 | 29.82 | 154.15 | 63.22 |
| 15039 | 89.11 | 118.00 | 47.79 | 272.70 | 91.84 |
| 20149 | 89.08 | 2751.06 | 487.03 | 1546.67 | 703.21 |
| 21400 | 89.05 | 217.92 | 45.44 | 361.83 | 72.95 |
| 7825 | 89.05 | 120.48 | 23.58 | 70.06 | 27.39 |
| 12945 | 89.02 | 168.30 | 33.30 | 289.09 | 69.55 |
| 1644 | 88.98 | 444.20 | 28.05 | 560.84 | 126.28 |
| 16087 | 88.96 | 147.89 | 19.38 | 87.68 | 30.47 |
| 11075 | 88.93 | 99.43 | 19.68 | 58.88 | 21.11 |
| 19943 | 88.92 | 210.88 | 54.72 | 366.97 | 116.34 |
| 21147 | 88.84 | 223.85 | 45.68 | 361.29 | 80.82 |
| 3407 | 88.84 | 48.51 | 16.65 | 22.82 | 14.74 |
| 12366 | 88.81 | 402.17 | 110.21 | 266.10 | 83.20 |
| 17833 | 88.80 | 178.08 | 13.51 | 132.77 | 41.58 |
| 11968 | 88.75 | 161.58 | 45.48 | 277.70 | 74.95 |
| 6886 | 88.66 | 74.86 | 18.86 | 44.24 | 15.63 |
| 5531 | 88.65 | 41.41 | 2.58 | 32.86 | 11.29 |
| 11866 | 88.65 | 193.70 | 21.24 | 133.49 | 72.18 |
| 17363 | 88.40 | 836.27 | 72.73 | 1036.86 | 193.05 |
| 21253 | 88.40 | 346.51 | 35.62 | 476.31 | 102.82 |
| 2574 | 88.38 | 110.78 | 17.74 | 72.92 | 19.69 |
| 2439 | 88.38 | 98.92 | 17.04 | 147.82 | 27.80 |
| 9035 | 88.25 | 93.11 | 9.82 | 126.24 | 27.10 |
| 291 | 88.11 | 145.69 | 31.30 | 224.02 | 46.48 |
| 24165 | 88.10 | 119.54 | 15.30 | 72.25 | 33.85 |
| 10071 | 87.87 | 177.18 | 42.47 | 350.75 | 123.95 |
| 187 | 87.75 | 202.63 | 72.64 | 75.52 | 52.59 |
| 28 | 87.68 | 260.01 | 111.55 | 531.88 | 180.16 |
| 17921 | 87.55 | 119.45 | 22.88 | 195.17 | 71.34 |
| 24567 | 87.37 | 34.58 | 19.86 | 111.01 | 63.84 |
| 20617 | 86.99 | 425.33 | 118.93 | 206.81 | 228.40 |
| 22386 | 86.89 | 148.02 | 26.48 | 252.07 | 98.25 |
| 8829 | 86.69 | 454.94 | 86.93 | 283.22 | 86.03 |
| 25921 | 86.50 | 50.94 | 6.86 | 28.33 | 16.05 |
| 25364 | 86.35 | 104.43 | 36.32 | 56.18 | 57.10 |
| 8599 | 86.17 | 222.32 | 55.03 | 389.47 | 116.57 |
| 17357 | 85.93 | 89.91 | 76.51 | 270.04 | 95.73 |
| 20582 | 85.77 | 353.36 | 43.17 | 487.57 | 95.61 |
| 20896 | 85.56 | 83.44 | 18.33 | 141.36 | 40.26 |
| 1535 | 85.53 | 44.01 | 11.60 | 85.58 | 31.50 |
| 15303 | 85.43 | 68.69 | 8.52 | 95.79 | 28.70 |
| 18716 | 85.36 | 53.32 | 13.29 | 29.64 | 11.72 |
| 25662 | 85.35 | 210.06 | 62.21 | 117.83 | 97.01 |
| 24438 | 85.26 | 89.77 | 17.89 | 143.35 | 40.49 |
| 6577 | 85.16 | 122.77 | 12.31 | 178.46 | 48.88 |
| 21193 | 84.95 | 50.26 | 5.87 | 33.25 | 14.85 |
| 1409 | 84.89 | 299.53 | 60.23 | 438.92 | 99.13 |
| 15330 | 84.84 | 36.66 | 19.02 | 81.96 | 24.24 |
| 15191 | 84.83 | 3728.02 | 829.67 | 2407.15 | 1233.18 |
| 6049 | 84.79 | 805.83 | 63.05 | 688.66 | 113.01 |
| 18043 | 84.79 | 99.39 | 38.52 | 41.39 | 22.49 |
| 24431 | 84.79 | 131.55 | 52.25 | 59.17 | 87.36 |
| 3870 | 84.58 | 91.07 | 23.43 | 152.03 | 56.60 |
| 22219 | 84.55 | 61.94 | 15.60 | 37.48 | 62.65 |
| 15642 | 84.42 | 750.42 | 224.71 | 433.34 | 115.91 |
| 24631 | 84.37 | 36.22 | 7.30 | 21.68 | 10.08 |
| 19003 | 84.31 | 141.69 | 17.27 | 102.43 | 33.94 |
| 25777 | 84.09 | 809.02 | 317.73 | 441.84 | 253.01 |
| 23000 | 84.06 | 41.94 | 3.47 | 35.87 | 9.55 |
| 2079 | 84.04 | 190.93 | 36.44 | 304.09 | 90.50 |
| 439 | 84.00 | 28.56 | 7.59 | 45.33 | 16.65 |
| 8426 | 83.89 | 77.60 | 12.47 | 49.42 | 20.66 |
| 16205 | 83.86 | 1418.72 | 140.70 | 1122.95 | 425.85 |
| 5838 | 83.75 | 443.80 | 68.13 | 652.08 | 145.88 |
| 3609 | 83.65 | 185.56 | 111.40 | 434.86 | 172.76 |
| 989 | 83.64 | 106.37 | 20.93 | 147.41 | 60.77 |
| 4373 | 83.62 | 166.60 | 16.69 | 133.42 | 26.68 |
| 22562 | 83.52 | 46.00 | 10.04 | 27.10 | 13.28 |
| 22783 | 83.50 | 566.84 | 84.58 | 347.17 | 212.46 |
| 16227 | 83.44 | 152.60 | 38.37 | 88.54 | 40.73 |
| 25399 | 83.38 | 392.81 | 122.41 | 185.18 | 190.17 |
| 2191 | 83.36 | 42.32 | 13.37 | 22.22 | 8.81 |
| 3512 | 83.28 | 129.79 | 11.72 | 106.87 | 19.31 |
| 22434 | 83.07 | 68.42 | 18.29 | 43.74 | 20.91 |
| 3465 | 82.92 | 173.23 | 36.47 | 263.26 | 79.05 |
| 18246 | 82.90 | 113.80 | 43.37 | 258.83 | 95.85 |
| 16116 | 82.88 | 61.16 | 6.60 | 78.82 | 19.59 |
| 25589 | 82.84 | 220.29 | 33.93 | 150.66 | 41.90 |
| 1529 | 82.83 | 226.95 | 35.67 | 294.63 | 70.00 |
| 22781 | 82.81 | 229.37 | 43.64 | 143.62 | 72.36 |
| 13974 | 82.76 | 355.79 | 36.94 | 315.24 | 173.81 |
| 13610 | 82.68 | 257.86 | 38.84 | 365.13 | 107.29 |
| 23781 | 82.57 | 67.71 | 7.21 | 85.97 | 27.49 |
| 25647 | 82.56 | 437.20 | 166.12 | 209.40 | 238.75 |
| 24566 | 82.52 | 103.57 | 24.04 | 179.92 | 89.90 |
| 25686 | 82.52 | 899.95 | 98.60 | 749.37 | 152.25 |
| 1453 | 82.50 | 89.33 | 27.93 | 52.20 | 26.79 |

TABLE 5G

| GLGC | LDA | Tox Group | Tox Group | Non-Tox | Non-Tox |
|---|---|---|---|---|---|
| Identifier | Score | Mean | SD | Group Mean | Group SD |
| 472 | 99.03 | 243.72 | 82.34 | 732.71 | 178.26 |
| 22675 | 98.67 | 118.93 | 55.69 | 28.15 | 15.37 |
| 574 | 98.51 | 1391.19 | 255.85 | 347.01 | 165.41 |
| 1564 | 98.51 | 924.30 | 353.42 | 42.69 | 192.73 |
| 15003 | 98.33 | 454.25 | 157.22 | 31.60 | 90.05 |
| 15004 | 98.30 | 770.01 | 324.95 | 154.94 | 147.16 |
| 646 | 98.30 | 83.09 | 64.74 | 528.44 | 191.02 |
| 15002 | 98.27 | 571.32 | 171.32 | 133.34 | 101.38 |
| 22592 | 98.27 | 1074.58 | 313.00 | 224.39 | 160.59 |
| 10015 | 98.18 | 563.53 | 77.79 | 229.49 | 80.02 |
| 10983 | 98.15 | 26.59 | 14.05 | 150.11 | 58.58 |
| 20816 | 98.12 | 1222.71 | 372.23 | 405.88 | 177.08 |
| 14929 | 98.12 | 2704.92 | 750.05 | 750.97 | 385.07 |
| 17325 | 98.06 | 566.28 | 234.26 | 55.28 | 99.39 |
| 25702 | 97.97 | 1078.58 | 151.22 | 623.33 | 125.71 |
| 16350 | 97.91 | 140.55 | 45.36 | 43.66 | 26.40 |
| 6039 | 97.88 | 656.26 | 129.35 | 309.49 | 76.09 |
| 645 | 97.85 | 22.16 | 19.08 | 135.98 | 49.42 |
| 10109 | 97.82 | 1679.00 | 1324.10 | 1190.54 | 238.15 |
| 10016 | 97.79 | 518.59 | 107.36 | 208.97 | 79.42 |
| 21797 | 97.79 | 751.43 | 151.51 | 331.28 | 105.33 |
| 20885 | 97.75 | 86.92 | 67.69 | 590.89 | 224.65 |
| 18751 | 97.72 | 1011.52 | 204.86 | 514.43 | 129.28 |
| 18503 | 97.69 | 87.10 | 55.82 | 769.37 | 319.53 |
| 10839 | 97.69 | 522.43 | 88.99 | 296.05 | 56.93 |
| 4327 | 97.66 | 213.79 | 52.87 | 82.05 | 36.57 |
| 24211 | 97.63 | 363.77 | 83.59 | 128.82 | 74.63 |
| 1551 | 97.57 | 44.36 | 13.06 | 122.96 | 105.41 |
| 20848 | 97.57 | 1070.75 | 145.58 | 548.58 | 158.87 |
| 22321 | 97.54 | 321.53 | 86.82 | 93.58 | 65.67 |
| 11205 | 97.54 | 218.47 | 59.26 | 555.88 | 160.64 |
| 23651 | 97.51 | 3310.38 | 741.12 | 733.68 | 659.72 |
| 20481 | 97.51 | 104.65 | 12.92 | 201.59 | 40.93 |
| 4856 | 97.51 | 225.36 | 26.28 | 113.64 | 35.44 |
| 14677 | 97.45 | 165.57 | 17.88 | 69.76 | 30.34 |
| 15876 | 97.45 | 2120.60 | 249.97 | 1361.28 | 237.57 |
| 15132 | 97.42 | 556.28 | 65.10 | 314.76 | 79.74 |
| 16245 | 97.42 | 69.92 | 89.96 | 412.35 | 124.91 |
| 19188 | 97.42 | 527.70 | 117.58 | 1311.37 | 331.19 |
| 20884 | 97.39 | 71.11 | 94.30 | 738.14 | 289.89 |
| 1422 | 97.39 | 102.77 | 18.65 | 300.99 | 104.53 |
| 5838 | 97.36 | 301.27 | 68.21 | 652.99 | 143.93 |
| 15955 | 97.18 | 283.29 | 93.14 | 689.98 | 159.09 |
| 7307 | 97.18 | 92.05 | 30.06 | 28.29 | 16.83 |
| 21509 | 97.18 | 356.98 | 61.72 | 91.05 | 94.62 |
| 736 | 97.15 | 1042.03 | 152.24 | 635.04 | 130.62 |
| 17357 | 97.12 | 50.26 | 40.35 | 270.21 | 95.37 |
| 15662 | 97.06 | 163.93 | 19.51 | 93.95 | 27.11 |
| 13646 | 97.06 | 1401.63 | 217.84 | 815.38 | 181.16 |
| 17807 | 97.06 | 1436.26 | 188.44 | 842.88 | 218.96 |
| 19679 | 97.03 | 257.82 | 106.61 | 757.15 | 199.62 |
| 23961 | 97.00 | 451.82 | 79.40 | 786.13 | 150.14 |
| 16204 | 96.97 | 1384.43 | 194.54 | 865.08 | 172.51 |
| 18750 | 96.91 | 341.14 | 53.21 | 168.24 | 62.25 |
| 5208 | 96.88 | 256.89 | 147.95 | 977.27 | 392.75 |
| 25419 | 96.81 | 31.08 | 22.07 | 149.42 | 67.18 |
| 7964 | 96.81 | 121.19 | 45.58 | 325.72 | 93.20 |
| 19824 | 96.75 | 72.58 | 25.39 | 216.05 | 72.84 |
| 3834 | 96.75 | 132.71 | 15.15 | 223.31 | 50.13 |
| 16929 | 96.69 | 1743.43 | 228.03 | 1095.03 | 207.82 |
| 11849 | 96.69 | 1317.16 | 211.89 | 773.90 | 177.28 |
| 18612 | 96.69 | 212.66 | 25.56 | 128.14 | 27.31 |
| 1141 | 96.60 | 436.63 | 69.87 | 241.00 | 65.86 |
| 17514 | 96.57 | 454.63 | 81.01 | 818.94 | 186.75 |
| 4441 | 96.54 | 1550.03 | 172.22 | 1061.96 | 187.57 |
| 25802 | 96.54 | 845.70 | 105.36 | 521.07 | 117.59 |
| 12332 | 96.54 | 184.06 | 71.27 | 549.08 | 160.38 |
| 24108 | 96.54 | 257.44 | 35.85 | 149.90 | 36.24 |
| 1382 | 96.51 | 90.08 | 11.91 | 49.24 | 15.74 |
| 4360 | 96.45 | 162.70 | 43.83 | 333.15 | 72.47 |
| 4445 | 96.39 | 803.11 | 134.14 | 477.79 | 96.26 |
| 25415 | 96.36 | 32.48 | 27.25 | 161.84 | 72.36 |
| 17284 | 96.30 | 121.14 | 16.57 | 218.48 | 58.98 |
| 2125 | 96.27 | 190.48 | 54.94 | 69.66 | 70.52 |
| 6614 | 96.21 | 183.60 | 64.33 | 438.27 | 117.69 |
| 17361 | 96.18 | 28.93 | 11.40 | 138.07 | 55.62 |
| 13647 | 96.15 | 1685.74 | 240.33 | 965.67 | 279.68 |
| 3121 | 96.09 | 495.24 | 184.53 | 1291.00 | 320.21 |
| 23093 | 96.03 | 106.37 | 12.36 | 186.37 | 43.33 |
| 20873 | 96.03 | 3443.13 | 613.84 | 2121.19 | 488.68 |
| 15135 | 96.00 | 1256.66 | 187.64 | 774.12 | 176.10 |
| 6405 | 95.90 | 202.88 | 43.49 | 403.99 | 105.10 |
| 968 | 95.78 | 29.31 | 9.99 | 81.27 | 22.89 |
| 19943 | 95.78 | 148.72 | 40.47 | 367.33 | 115.68 |
| 5199 | 95.57 | 231.08 | 78.06 | 560.22 | 167.42 |
| 16150 | 95.51 | 274.61 | 48.72 | 520.97 | 135.92 |
| 23758 | 95.45 | 88.49 | 20.75 | 175.01 | 41.28 |
| 21078 | 95.42 | 318.58 | 74.48 | 629.47 | 142.80 |
| 28 | 95.42 | 145.06 | 98.13 | 532.55 | 178.76 |
| 2465 | 95.39 | 67.67 | 23.37 | 131.86 | 26.71 |
| 1508 | 95.33 | 269.31 | 91.76 | 654.52 | 194.51 |
| 3610 | 95.33 | 430.67 | 215.13 | 1122.89 | 327.90 |
| 18629 | 95.30 | 1002.30 | 147.79 | 653.52 | 144.64 |
| 3069 | 95.27 | 95.79 | 24.02 | 181.96 | 42.00 |
| 25467 | 95.21 | 320.12 | 106.53 | 737.06 | 245.44 |
| 20810 | 94.99 | 2328.92 | 400.59 | 1448.17 | 356.77 |
| 4449 | 94.72 | 115.32 | 31.26 | 243.54 | 69.77 |
| 15653 | 94.60 | 1852.53 | 268.29 | 1284.72 | 282.04 |
| 24770 | 94.57 | 60.89 | 37.80 | 244.14 | 106.68 |
| 20716 | 94.54 | 407.31 | 96.00 | 723.45 | 165.86 |
| 1549 | 94.54 | 114.38 | 21.37 | 201.87 | 48.01 |
| 21950 | 94.42 | 493.04 | 82.54 | 812.67 | 152.27 |
| 1546 | 94.36 | 122.71 | 35.02 | 244.53 | 64.28 |
| 24564 | 94.35 | 97.01 | 57.45 | 615.45 | 190.61 |
| 24563 | 94.16 | 24.77 | 36.61 | 322.32 | 110.47 |
| 457 | 94.10 | 658.43 | 132.04 | 285.53 | 94.14 |
| 17198 | 94.10 | 174.10 | 183.51 | 910.03 | 269.39 |
| 18502 | 93.98 | 124.08 | 73.30 | 765.24 | 269.62 |
| 21695 | 93.92 | 142.04 | 27.58 | 49.80 | 30.26 |
| 16351 | 93.86 | 224.63 | 88.04 | 65.23 | 32.31 |
| 3870 | 93.84 | 56.07 | 22.14 | 152.24 | 56.26 |
| 1993 | 93.77 | 93.20 | 19.75 | 23.92 | 17.40 |
| 19040 | 93.71 | 706.16 | 170.63 | 181.75 | 113.25 |
| 7196 | 93.65 | 574.19 | 128.31 | 176.23 | 87.09 |
| 1501 | 93.65 | 224.82 | 95.99 | 51.78 | 53.84 |
| 20886 | 93.62 | 80.08 | 149.92 | 801.44 | 315.41 |
| 20849 | 93.47 | 566.69 | 140.91 | 281.36 | 87.91 |
| 1809 | 93.44 | 275.58 | 89.54 | 34.04 | 133.49 |
| 1463 | 93.38 | 1519.27 | 270.01 | 664.00 | 313.79 |
| 7489 | 93.33 | 22.54 | 9.10 | 72.97 | 31.20 |
| 18453 | 93.28 | 88.03 | 19.21 | 218.34 | 72.82 |
| 16726 | 93.28 | 486.85 | 132.99 | 1061.35 | 225.30 |
| 20887 | 93.22 | 168.32 | 177.62 | 874.64 | 339.69 |
| 2109 | 93.19 | 1476.03 | 210.52 | 911.33 | 166.60 |
| 1462 | 93.19 | 954.56 | 196.88 | 432.34 | 223.37 |
| 25718 | 93.13 | 683.37 | 89.19 | 419.94 | 86.09 |
| 17159 | 93.07 | 1527.58 | 315.26 | 787.22 | 213.24 |
| 17104 | 93.04 | 855.38 | 133.20 | 481.52 | 111.05 |
| 17401 | 93.04 | 2406.67 | 718.29 | 1005.70 | 409.58 |
| 23854 | 93.04 | 1043.25 | 158.05 | 521.42 | 171.16 |
| 3430 | 92.98 | 1105.90 | 415.94 | 451.02 | 154.70 |
| 19768 | 92.92 | 1379.96 | 280.91 | 786.38 | 167.89 |
| 25691 | 92.89 | 1341.48 | 251.62 | 775.97 | 169.40 |
| 7197 | 92.89 | 474.21 | 129.15 | 188.31 | 86.11 |

TABLE 5H

| GLGC | LDA | Tox Group | Tox Group | Non-Tox | Non-Tox |
|---|---|---|---|---|---|
| Identifier | Score | Mean | SD | Group Mean | Group SD |
| 1698 | 95.69 | 476.04 | 217.52 | 66.29 | 80.81 |
| 19254 | 93.32 | 450.27 | 111.28 | 243.51 | 70.21 |
| 23917 | 92.66 | 1506.66 | 499.29 | 718.95 | 184.83 |
| 17541 | 92.42 | 1949.27 | 848.82 | 715.92 | 315.92 |
| 20803 | 91.23 | 799.85 | 172.29 | 470.96 | 121.12 |
| 1537 | 90.76 | 257.23 | 167.48 | 25.97 | 54.59 |
| 25069 | 90.61 | 345.14 | 130.65 | 122.58 | 64.89 |
| 18990 | 90.28 | 86.48 | 40.00 | 20.60 | 20.74 |
| 20795 | 89.27 | 395.60 | 169.67 | 145.49 | 73.47 |
| 6014 | 89.18 | 250.89 | 107.92 | 79.07 | 39.75 |
| 13609 | 89.08 | 127.39 | 51.22 | 239.16 | 63.31 |
| 353 | 88.14 | 319.61 | 99.94 | 169.89 | 88.77 |
| 19252 | 88.05 | 1076.93 | 223.42 | 699.29 | 132.43 |
| 1399 | 87.58 | 525.84 | 225.50 | 194.83 | 76.18 |
| 20802 | 87.50 | 435.04 | 93.17 | 244.10 | 82.49 |
| 20804 | 87.44 | 1875.82 | 427.00 | 1059.53 | 324.98 |
| 24192 | 87.16 | 197.41 | 91.63 | 74.59 | 46.05 |
| 2059 | 87.00 | 193.67 | 24.25 | 136.36 | 35.16 |
| 11755 | 86.73 | 376.55 | 164.92 | 141.89 | 130.13 |
| 14970 | 86.63 | 129.68 | 33.81 | 200.04 | 40.68 |
| 21038 | 86.52 | 242.02 | 70.96 | 103.82 | 41.91 |
| 21039 | 86.46 | 195.33 | 59.92 | 78.33 | 43.60 |
| 22352 | 86.44 | 284.98 | 97.78 | 147.56 | 105.44 |
| 4944 | 86.29 | 211.24 | 47.96 | 119.87 | 58.35 |
| 2242 | 86.21 | 1439.71 | 469.38 | 2188.97 | 546.30 |
| 20035 | 86.06 | 430.87 | 178.90 | 180.79 | 99.78 |
| 14347 | 85.85 | 400.13 | 169.40 | 165.49 | 124.98 |
| 14633 | 85.60 | 234.78 | 89.03 | 88.80 | 83.21 |
| 15964 | 85.54 | 674.79 | 216.85 | 1091.41 | 285.42 |
| 12812 | 85.49 | 52.00 | 16.73 | 97.11 | 34.86 |
| 22502 | 85.39 | 158.92 | 82.43 | 53.23 | 48.19 |
| 11840 | 85.36 | 122.01 | 37.49 | 67.99 | 20.17 |
| 354 | 85.33 | 388.15 | 110.75 | 216.19 | 104.30 |
| 23314 | 85.33 | 562.77 | 365.79 | 72.82 | 278.18 |
| 13610 | 85.29 | 239.35 | 63.10 | 365.74 | 106.91 |
| 3816 | 85.24 | 464.69 | 118.27 | 309.23 | 67.90 |
| 15171 | 84.95 | 419.71 | 164.49 | 224.19 | 79.03 |
| 22501 | 84.65 | 492.96 | 180.94 | 251.35 | 55.90 |
| 8820 | 84.40 | 597.48 | 343.99 | 137.31 | 114.55 |
| 5863 | 84.29 | 88.93 | 23.67 | 139.47 | 34.68 |
| 24235 | 84.25 | 1152.14 | 527.92 | 473.62 | 203.30 |
| 405 | 83.80 | 132.67 | 34.34 | 208.32 | 63.52 |
| 12331 | 83.65 | 391.83 | 107.95 | 591.12 | 141.29 |
| 1410 | 83.60 | 34.40 | 19.24 | 89.22 | 43.41 |
| 22197 | 83.56 | 181.41 | 38.36 | 111.12 | 43.86 |
| 17892 | 83.55 | 153.95 | 40.92 | 306.40 | 134.74 |
| 21513 | 83.49 | 75.92 | 24.74 | 120.24 | 29.73 |
| 11429 | 83.43 | 212.12 | 34.36 | 269.26 | 41.65 |
| 20895 | 83.42 | 188.70 | 90.22 | 303.22 | 74.58 |
| 12848 | 83.34 | 297.78 | 63.29 | 431.68 | 92.39 |
| 18259 | 83.24 | 519.34 | 278.97 | 208.74 | 145.33 |
| 3822 | 83.20 | 1346.58 | 265.08 | 925.26 | 284.34 |
| 24246 | 83.14 | 450.51 | 118.31 | 305.90 | 95.78 |
| 21632 | 83.14 | 122.74 | 47.18 | 31.65 | 49.47 |
| 18396 | 83.12 | 111.98 | 44.34 | 66.03 | 26.28 |
| 3053 | 83.04 | 154.60 | 38.76 | 96.88 | 33.21 |
| 16718 | 83.02 | 771.65 | 152.36 | 1131.02 | 291.60 |
| 12979 | 82.91 | 827.72 | 363.04 | 363.63 | 189.87 |
| 26319 | 82.82 | 76.87 | 13.91 | 48.99 | 22.63 |
| 352 | 82.73 | 127.68 | 32.93 | 81.40 | 54.77 |
| 17850 | 82.65 | 478.49 | 74.33 | 350.42 | 68.02 |
| 16726 | 82.61 | 775.42 | 171.63 | 1060.46 | 228.56 |
| 25902 | 82.59 | 112.19 | 22.14 | 159.55 | 48.13 |
| 6765 | 82.55 | 507.81 | 142.81 | 730.21 | 168.95 |
| 22625 | 82.55 | 203.73 | 89.37 | 109.20 | 101.37 |
| 20086 | 82.52 | 270.19 | 119.18 | 107.78 | 72.84 |
| 22414 | 82.49 | 91.38 | 20.25 | 62.37 | 32.42 |
| 15069 | 82.45 | 156.30 | 69.08 | 89.93 | 53.08 |
| 23435 | 82.42 | 143.51 | 70.04 | 32.23 | 45.61 |
| 13607 | 82.37 | 34.94 | 7.53 | 22.53 | 9.86 |
| 15382 | 82.29 | 978.24 | 634.06 | 120.29 | 179.44 |
| 22656 | 82.26 | 199.64 | 38.98 | 123.05 | 53.17 |
| 26083 | 82.21 | 1826.66 | 491.08 | 1187.90 | 721.09 |
| 19184 | 82.21 | 185.49 | 78.89 | 78.67 | 75.04 |
| 13611 | 82.20 | 130.10 | 78.13 | 250.25 | 82.89 |
| 16039 | 82.15 | 697.44 | 191.99 | 482.12 | 97.81 |
| 2924 | 82.14 | 213.38 | 38.03 | 154.90 | 50.18 |
| 8283 | 82.11 | 273.51 | 122.40 | 128.67 | 44.94 |
| 4235 | 82.01 | 583.10 | 107.05 | 411.30 | 95.75 |
| 22413 | 81.99 | 109.06 | 23.31 | 68.44 | 38.34 |
| 3091 | 81.96 | 479.65 | 112.26 | 714.58 | 157.74 |
| 1651 | 81.95 | 628.76 | 65.78 | 789.11 | 181.29 |
| 8211 | 81.93 | 3918.21 | 2663.36 | 3502.10 | 1459.77 |
| 20841 | 81.92 | 143.31 | 33.78 | 95.74 | 25.14 |
| 12978 | 81.88 | 178.61 | 68.70 | 96.11 | 47.83 |
| 13349 | 81.88 | 200.63 | 47.75 | 132.83 | 38.04 |
| 20082 | 81.87 | 91.12 | 20.35 | 66.30 | 28.33 |
| 1439 | 81.65 | 147.91 | 28.34 | 225.64 | 53.27 |
| 14346 | 81.56 | 203.45 | 102.23 | 50.68 | 82.80 |
| 15470 | 81.55 | 446.71 | 86.23 | 334.66 | 93.68 |
| 15295 | 81.48 | 211.13 | 62.16 | 133.01 | 44.12 |
| 20443 | 81.46 | 161.56 | 35.20 | 113.93 | 27.53 |
| 2979 | 81.44 | 245.69 | 57.16 | 282.97 | 42.84 |
| 24033 | 81.42 | 259.06 | 80.18 | 347.59 | 75.37 |
| 1558 | 81.39 | 321.49 | 76.64 | 200.81 | 63.40 |
| 24377 | 81.36 | 145.34 | 38.16 | 203.71 | 49.55 |
| 15296 | 81.36 | 211.59 | 76.79 | 126.72 | 51.34 |
| 15032 | 81.33 | 183.52 | 59.26 | 265.32 | 74.21 |
| 19433 | 81.22 | 249.89 | 135.26 | 95.01 | 61.36 |
| 4956 | 81.16 | 164.38 | 98.90 | 69.29 | 29.02 |
| 18011 | 80.90 | 67.94 | 34.59 | 27.48 | 28.90 |
| 4592 | 80.90 | 249.94 | 54.72 | 177.09 | 36.45 |
| 25253 | 80.87 | 356.00 | 58.62 | 290.00 | 68.77 |
| 18449 | 80.81 | 729.28 | 116.57 | 610.20 | 123.99 |
| 17736 | 80.81 | 182.31 | 146.86 | 69.27 | 157.44 |
| 20801 | 80.66 | 227.27 | 55.54 | 150.06 | 48.38 |
| 22412 | 80.58 | 140.47 | 30.74 | 91.22 | 45.78 |
| 18597 | 80.46 | 1089.16 | 347.96 | 559.47 | 193.08 |
| 21239 | 80.43 | 229.76 | 97.82 | 106.28 | 59.82 |
| 15574 | 80.39 | 173.01 | 25.25 | 215.63 | 33.89 |
| 18967 | 80.39 | 337.68 | 55.22 | 487.47 | 203.79 |
| 3016 | 80.37 | 4148.89 | 2854.50 | 3998.79 | 1813.37 |
| 21305 | 80.36 | 272.12 | 81.64 | 438.75 | 129.17 |
| 24484 | 80.31 | 66.39 | 12.02 | 92.42 | 26.08 |
| 25064 | 80.28 | 2074.70 | 700.66 | 1115.73 | 310.65 |
| 4392 | 80.03 | 3259.52 | 1607.18 | 2948.56 | 850.63 |
| 18300 | 79.97 | 206.84 | 132.88 | 487.38 | 169.27 |
| 24900 | 79.96 | 488.04 | 143.15 | 638.38 | 155.04 |
| 25098 | 79.90 | 93.64 | 67.91 | 36.16 | 34.64 |
| 21147 | 79.81 | 268.70 | 99.55 | 361.28 | 80.70 |
| 15750 | 79.71 | 47.36 | 18.14 | 21.51 | 14.89 |

TABLE 5I

| GLGC | LDA | Tox Group | Tox Group | Non-Tox | Non-Tox |
|---|---|---|---|---|---|
| Identifier | Score | Mean | SD | Group Mean | Group SD |
| 2242 | 82.51 | 1386.39 | 557.25 | 2237.29 | 505.01 |
| 5601 | 80.41 | 570.05 | 236.57 | 903.71 | 216.83 |
| 4944 | 80.39 | 210.32 | 80.95 | 114.51 | 51.54 |
| 15032 | 78.99 | 176.05 | 67.41 | 270.72 | 70.95 |
| 13610 | 78.86 | 260.43 | 88.06 | 371.73 | 104.73 |
| 3610 | 78.84 | 722.35 | 368.53 | 1146.23 | 311.02 |
| 5863 | 78.76 | 96.37 | 30.11 | 141.94 | 33.29 |
| 1529 | 78.54 | 203.36 | 69.83 | 300.60 | 65.42 |
| 17682 | 78.29 | 507.13 | 211.81 | 773.82 | 172.62 |
| 10985 | 78.22 | 735.68 | 231.86 | 1069.30 | 225.65 |
| 21632 | 77.91 | 98.75 | 74.15 | 27.96 | 44.65 |
| 28 | 77.64 | 315.43 | 178.66 | 545.11 | 171.54 |
| 15964 | 77.61 | 745.68 | 276.40 | 1111.07 | 273.12 |
| 17550 | 77.50 | 879.01 | 298.17 | 1290.95 | 333.72 |
| 23314 | 77.31 | 506.68 | 414.87 | 47.74 | 245.21 |
| 17524 | 77.19 | 794.19 | 308.69 | 1135.59 | 259.89 |
| 11618 | 77.12 | 257.75 | 117.01 | 388.64 | 105.31 |
| 23435 | 77.07 | 107.07 | 69.42 | 28.24 | 40.65 |
| 812 | 76.93 | 105.28 | 36.08 | 153.16 | 36.80 |
| 13609 | 76.92 | 163.77 | 55.10 | 243.19 | 61.57 |
| 3091 | 76.77 | 535.18 | 168.51 | 724.55 | 150.86 |
| 16312 | 76.70 | 108.77 | 62.22 | 45.54 | 31.63 |
| 20694 | 76.61 | 688.47 | 220.38 | 933.57 | 204.17 |
| 19679 | 76.55 | 499.67 | 216.56 | 771.74 | 190.03 |
| 14970 | 76.36 | 144.83 | 50.08 | 203.14 | 37.69 |
| 24496 | 76.32 | 72.15 | 40.14 | 113.67 | 35.59 |
| 10818 | 76.28 | 251.30 | 167.92 | 480.32 | 177.62 |
| 18337 | 76.16 | 1120.66 | 375.56 | 1593.01 | 326.83 |
| 1698 | 76.15 | 259.77 | 253.73 | 57.45 | 46.82 |
| 2702 | 76.15 | 433.75 | 181.46 | 270.79 | 68.25 |
| 17755 | 76.09 | 278.24 | 99.73 | 390.16 | 92.04 |
| 7489 | 75.92 | 37.03 | 20.90 | 75.16 | 30.46 |
| 21654 | 75.86 | 551.82 | 178.12 | 366.37 | 116.43 |
| 15299 | 75.82 | 120.11 | 57.11 | 72.50 | 54.88 |
| 13349 | 75.79 | 183.06 | 52.76 | 130.07 | 35.07 |
| 1159 | 75.77 | 712.96 | 239.20 | 1011.11 | 211.67 |
| 18272 | 75.77 | 134.16 | 52.28 | 179.70 | 40.85 |
| 23005 | 75.72 | 694.34 | 270.62 | 901.12 | 190.44 |
| 8721 | 75.64 | 109.17 | 63.60 | 188.60 | 63.43 |
| 10887 | 75.63 | 42.57 | 19.85 | 65.79 | 22.04 |
| 3916 | 75.59 | 472.89 | 195.40 | 675.96 | 140.94 |
| 16314 | 75.54 | 110.20 | 71.12 | 41.23 | 39.76 |
| 22554 | 75.51 | 387.64 | 139.23 | 544.84 | 133.65 |
| 5384 | 75.41 | 90.12 | 61.25 | 28.04 | 36.31 |
| 7936 | 75.30 | 107.61 | 27.73 | 139.51 | 30.80 |
| 5923 | 75.17 | 439.81 | 176.29 | 606.68 | 131.73 |
| 19184 | 75.15 | 190.82 | 119.94 | 71.94 | 64.87 |
| 21239 | 75.09 | 197.82 | 98.17 | 101.23 | 52.71 |
| 3874 | 74.97 | 637.40 | 187.18 | 871.96 | 181.31 |
| 5900 | 74.94 | 205.87 | 72.79 | 265.10 | 54.52 |
| 7784 | 74.81 | 532.12 | 161.80 | 699.90 | 128.21 |
| 18522 | 74.81 | 548.81 | 212.63 | 772.15 | 185.03 |
| 22569 | 74.81 | 417.82 | 171.09 | 628.93 | 157.19 |
| 2555 | 74.79 | 134.28 | 53.66 | 81.97 | 40.03 |
| 9673 | 74.72 | 35.38 | 16.35 | 65.52 | 26.97 |
| 4473 | 74.68 | 122.22 | 55.23 | 175.55 | 47.15 |
| 23917 | 74.67 | 1098.72 | 458.70 | 701.40 | 145.27 |
| 20458 | 74.64 | 271.25 | 94.25 | 374.56 | 94.29 |
| 6674 | 74.54 | 1776.75 | 507.96 | 2387.57 | 539.31 |
| 4360 | 74.46 | 253.43 | 81.01 | 337.54 | 69.89 |
| 3995 | 74.45 | 447.64 | 135.49 | 615.34 | 139.51 |
| 6046 | 74.40 | 135.01 | 56.88 | 197.57 | 60.74 |
| 11164 | 74.38 | 332.33 | 139.83 | 485.92 | 129.73 |
| 9079 | 74.38 | 581.21 | 173.48 | 749.66 | 159.41 |
| 15955 | 74.37 | 490.57 | 195.79 | 701.12 | 150.24 |
| 22612 | 74.35 | 330.37 | 111.38 | 469.08 | 108.90 |
| 6765 | 74.29 | 544.27 | 202.38 | 740.81 | 159.94 |
| 21147 | 74.26 | 274.00 | 87.67 | 366.40 | 77.47 |
| 4291 | 74.22 | 180.51 | 91.51 | 288.32 | 84.88 |
| 4463 | 74.19 | 86.69 | 63.34 | 154.87 | 56.17 |
| 4462 | 74.15 | 658.57 | 311.71 | 971.30 | 305.73 |
| 9781 | 74.13 | 82.19 | 36.96 | 124.27 | 34.07 |
| 14095 | 74.13 | 270.72 | 76.14 | 358.04 | 71.36 |
| 13618 | 74.08 | 137.35 | 40.63 | 99.14 | 26.21 |
| 18271 | 74.07 | 587.16 | 201.63 | 753.02 | 149.78 |
| 22681 | 74.06 | 507.76 | 361.88 | 202.52 | 156.32 |
| 21157 | 74.05 | 549.82 | 137.16 | 428.96 | 84.27 |
| 23261 | 74.04 | 1121.37 | 378.88 | 1550.48 | 320.61 |
| 2370 | 74.04 | 876.31 | 227.54 | 1077.70 | 174.57 |
| 10130 | 74.03 | 167.62 | 59.58 | 224.47 | 53.57 |
| 11937 | 74.01 | 101.08 | 23.16 | 79.06 | 19.14 |
| 811 | 73.98 | 180.08 | 66.32 | 257.46 | 56.05 |
| 12979 | 73.96 | 632.88 | 317.40 | 350.02 | 172.71 |
| 23546 | 73.90 | 549.94 | 189.79 | 721.45 | 151.51 |
| 20801 | 73.86 | 215.55 | 69.25 | 146.31 | 43.89 |
| 409 | 73.83 | 746.67 | 188.60 | 947.21 | 178.98 |
| 4440 | 73.83 | 195.43 | 69.44 | 295.13 | 82.26 |
| 21305 | 73.82 | 298.39 | 90.29 | 446.76 | 126.64 |
| 22101 | 73.80 | 85.02 | 82.10 | 175.65 | 80.50 |
| 15330 | 73.67 | 58.68 | 23.74 | 83.24 | 23.75 |
| 20161 | 73.64 | 80.23 | 54.25 | 29.99 | 27.33 |
| 15050 | 73.63 | 541.66 | 141.16 | 688.65 | 174.84 |
| 16813 | 73.61 | 231.75 | 81.80 | 331.59 | 80.11 |
| 18792 | 73.60 | 98.71 | 33.22 | 136.87 | 36.34 |
| 16756 | 73.57 | 240.33 | 81.11 | 168.05 | 37.88 |
| 21341 | 73.57 | 463.05 | 136.52 | 620.74 | 147.68 |
| 3467 | 73.54 | 461.68 | 163.07 | 646.99 | 168.60 |
| 20082 | 73.54 | 102.09 | 38.64 | 64.04 | 25.68 |
| 15039 | 73.52 | 177.90 | 93.67 | 278.20 | 88.82 |
| 9905 | 73.49 | 576.55 | 180.69 | 755.53 | 145.11 |
| 15986 | 73.46 | 214.52 | 95.30 | 326.69 | 83.60 |
| 9053 | 73.45 | 190.10 | 53.40 | 240.11 | 47.80 |
| 1460 | 73.32 | 302.66 | 131.64 | 185.02 | 73.88 |
| 15111 | 73.26 | 785.18 | 294.19 | 1118.72 | 264.03 |
| 15110 | 73.25 | 505.21 | 179.79 | 713.50 | 178.30 |
| 15112 | 73.00 | 1338.19 | 433.49 | 1860.86 | 460.35 |
| 354 | 72.87 | 373.67 | 185.53 | 207.02 | 87.88 |
| 25198 | 72.83 | 49.29 | 21.40 | 25.88 | 13.23 |
| 21683 | 72.77 | 53.28 | 30.07 | 25.72 | 19.21 |
| 16726 | 72.69 | 800.41 | 280.17 | 1075.60 | 214.53 |
| 18300 | 72.65 | 285.09 | 167.97 | 498.43 | 162.68 |
| 353 | 72.64 | 298.13 | 157.91 | 162.53 | 75.73 |
| 4198 | 72.64 | 603.75 | 177.10 | 780.82 | 177.13 |
| 24234 | 72.61 | 391.71 | 269.60 | 175.87 | 68.56 |
| 6641 | 72.55 | 304.37 | 93.60 | 402.49 | 84.73 |
| 15296 | 72.54 | 195.64 | 91.33 | 122.82 | 44.73 |
| 23783 | 72.45 | 376.37 | 89.08 | 460.99 | 76.97 |
| 4327 | 72.45 | 133.62 | 67.44 | 79.38 | 32.50 |
| 18128 | 72.27 | 163.39 | 43.26 | 205.45 | 45.93 |
| 18000 | 72.20 | 1021.88 | 441.49 | 1515.83 | 541.89 |
| 10464 | 72.19 | 90.84 | 30.16 | 122.79 | 30.91 |
| 24235 | 72.19 | 833.55 | 457.25 | 456.15 | 168.02 |
| 1399 | 72.16 | 341.24 | 183.76 | 188.40 | 64.08 |
| 18396 | 72.13 | 106.40 | 55.73 | 63.70 | 20.92 |
| 20753 | 72.02 | 157.80 | 39.75 | 117.80 | 25.81 |
| 25567 | 71.99 | 715.87 | 268.63 | 465.90 | 181.93 |
| 17256 | 71.98 | 313.90 | 166.05 | 436.12 | 114.73 |
| 14121 | 71.92 | 492.14 | 155.94 | 350.47 | 102.93 |
| 16012 | 71.84 | 101.22 | 49.06 | 62.06 | 26.39 |
| 11840 | 71.83 | 96.37 | 36.59 | 66.61 | 18.13 |
| 17684 | 71.81 | 170.05 | 66.05 | 237.48 | 55.17 |
| 15701 | 71.80 | 47.52 | 19.49 | 30.00 | 11.38 |
| 794 | 71.77 | 143.65 | 62.53 | 212.58 | 63.38 |
| 24770 | 71.76 | 149.41 | 95.43 | 249.51 | 105.16 |
| 11483 | 71.74 | 141.85 | 116.98 | 51.93 | 39.61 |
| 15295 | 71.74 | 190.57 | 76.92 | 129.84 | 38.91 |
| 3430 | 71.70 | 651.98 | 230.79 | 441.70 | 152.47 |
| 20056 | 71.66 | 246.08 | 95.02 | 318.69 | 67.21 |
| 12031 | 71.64 | 192.48 | 67.66 | 134.78 | 33.69 |
| 23961 | 71.60 | 644.10 | 203.09 | 793.72 | 143.04 |
| 20803 | 71.57 | 629.95 | 256.03 | 463.60 | 103.39 |
| 17541 | 71.55 | 1248.41 | 894.94 | 692.89 | 234.54 |
| 12978 | 71.54 | 152.96 | 71.09 | 93.05 | 44.29 |
| 17734 | 71.52 | 279.85 | 275.77 | 104.11 | 64.03 |
| 18360 | 71.37 | 154.88 | 51.56 | 206.67 | 54.97 |
| 17196 | 71.36 | 99.85 | 27.32 | 128.69 | 24.41 |
| 17301 | 71.34 | 325.89 | 119.33 | 233.24 | 70.86 |
| 25777 | 71.29 | 882.80 | 556.03 | 413.32 | 182.36 |
| 20298 | 71.28 | 409.64 | 131.62 | 556.86 | 153.30 |
| 16775 | 71.26 | 800.69 | 398.31 | 1188.38 | 388.39 |
| 17357 | 71.23 | 178.34 | 104.23 | 275.09 | 93.07 |
| 18906 | 71.16 | 164.62 | 90.59 | 266.79 | 88.78 |
| 1884 | 71.12 | 208.69 | 48.64 | 169.12 | 34.33 |

TABLE 5J

| GLGC Identifier | LDA Score | Tox Group Mean | Tox Group SD | Non-Tox Group Mean | Non-Tox Group SD |
|---|---|---|---|---|---|
| 17829 | 92.65 | 759.68 | 633.86 | 2726.68 | 1360.50 |
| 25468 | 90.11 | 657.58 | 614.46 | 2655.18 | 1078.33 |
| 24109 | 89.60 | 75.68 | 42.47 | 221.62 | 99.80 |
| 1684 | 89.47 | 788.73 | 736.74 | 3493.87 | 1629.14 |
| 25469 | 89.11 | 523.47 | 471.39 | 1875.13 | 750.57 |
| 1688 | 88.99 | 985.99 | 996.97 | 5062.79 | 2851.87 |
| 20082 | 86.48 | 84.34 | 9.94 | 66.36 | 28.45 |
| 4312 | 85.90 | 125.63 | 20.84 | 65.92 | 30.34 |
| 14003 | 85.48 | 588.35 | 140.53 | 940.91 | 244.68 |
| 5129 | 85.32 | 88.98 | 34.42 | 179.18 | 56.59 |
| 1685 | 85.14 | 1891.26 | 1942.12 | 8508.70 | 4812.11 |
| 7489 | 84.90 | 26.53 | 14.62 | 73.20 | 31.11 |
| 1687 | 84.65 | 544.45 | 532.83 | 1797.73 | 696.06 |
| 494 | 84.50 | 1183.13 | 183.42 | 774.08 | 266.75 |
| 17743 | 84.44 | 74.48 | 35.97 | 103.03 | 28.16 |
| 20864 | 84.41 | 1168.66 | 229.66 | 1938.09 | 636.48 |
| 16169 | 84.14 | 336.78 | 145.47 | 178.83 | 293.41 |
| 11967 | 83.98 | 1036.36 | 258.41 | 1617.83 | 495.77 |
| 7278 | 83.62 | 1079.66 | 205.71 | 1408.78 | 288.29 |
| 21766 | 83.55 | 202.85 | 35.26 | 284.66 | 63.71 |
| 19112 | 83.49 | 227.09 | 41.26 | 162.45 | 41.41 |
| 247 | 83.22 | 78.49 | 23.83 | 127.29 | 32.51 |
| 18996 | 83.22 | 175.14 | 36.61 | 124.78 | 29.81 |
| 1542 | 83.19 | 741.70 | 151.84 | 1084.13 | 306.88 |
| 17832 | 83.19 | 522.94 | 599.21 | 1979.69 | 796.76 |
| 17332 | 83.07 | 223.62 | 28.27 | 303.15 | 73.10 |
| 1246 | 82.94 | 37.24 | 17.41 | 82.08 | 35.89 |
| 16168 | 82.94 | 544.90 | 152.30 | 363.58 | 234.93 |
| 3615 | 82.64 | 103.67 | 34.57 | 197.88 | 61.86 |
| 21339 | 82.63 | 81.54 | 44.75 | 34.07 | 19.67 |
| 1689 | 82.61 | 1224.06 | 1215.72 | 4062.22 | 1648.08 |
| 24051 | 82.30 | 75.09 | 17.26 | 113.95 | 26.52 |
| 24821 | 82.27 | 34.36 | 7.77 | 54.32 | 19.77 |
| 3610 | 82.03 | 734.56 | 248.13 | 1122.80 | 330.52 |
| 1553 | 81.63 | 1952.70 | 632.62 | 3812.62 | 1693.78 |
| 23505 | 81.63 | 790.51 | 196.75 | 566.19 | 124.65 |
| 21648 | 81.57 | 298.40 | 58.99 | 208.18 | 69.29 |
| 21542 | 81.48 | 75.73 | 11.78 | 53.64 | 19.14 |
| 495 | 81.45 | 270.73 | 74.76 | 127.48 | 87.19 |
| 18468 | 81.39 | 106.55 | 21.07 | 77.98 | 27.23 |
| 15393 | 81.33 | 222.37 | 28.91 | 286.78 | 51.31 |
| 18681 | 81.30 | 388.94 | 53.06 | 282.82 | 72.56 |
| 4012 | 81.23 | 1137.93 | 352.70 | 702.11 | 303.50 |
| 25550 | 81.11 | 130.44 | 21.18 | 99.94 | 23.47 |
| 15599 | 81.08 | 768.89 | 96.61 | 962.67 | 147.01 |
| 245 | 81.08 | 30.84 | 10.46 | 51.23 | 15.00 |
| 3713 | 80.93 | 785.80 | 153.20 | 1070.46 | 218.25 |
| 7681 | 80.90 | 141.52 | 29.83 | 104.60 | 44.18 |
| 19358 | 80.77 | 230.36 | 276.27 | 811.89 | 308.44 |
| 20876 | 80.75 | 1429.42 | 179.01 | 2010.11 | 495.92 |
| 14638 | 80.72 | 103.18 | 17.90 | 77.40 | 20.36 |
| 24843 | 80.63 | 1529.74 | 555.96 | 2719.25 | 1061.12 |
| 4291 | 80.53 | 163.79 | 60.20 | 282.61 | 88.79 |
| 9391 | 80.47 | 668.60 | 95.16 | 863.78 | 204.49 |
| 17234 | 80.44 | 450.62 | 66.65 | 591.69 | 138.75 |
| 20741 | 80.44 | 223.50 | 26.65 | 175.19 | 43.80 |
| 23884 | 80.38 | 55.79 | 14.99 | 30.14 | 28.25 |
| 3941 | 80.35 | 312.71 | 52.90 | 243.38 | 62.94 |
| 6691 | 80.35 | 119.49 | 85.12 | 119.56 | 46.57 |
| 19188 | 80.32 | 899.58 | 236.54 | 1310.91 | 334.70 |
| 2242 | 80.13 | 1529.47 | 425.16 | 2188.74 | 547.68 |
| 20714 | 80.11 | 251.69 | 65.33 | 169.88 | 95.99 |
| 2702 | 80.11 | 352.18 | 62.63 | 280.79 | 90.45 |
| 2812 | 79.92 | 250.95 | 52.91 | 182.78 | 42.75 |
| 20713 | 79.77 | 321.28 | 83.43 | 211.11 | 121.91 |
| 18502 | 79.77 | 372.75 | 197.72 | 765.58 | 271.46 |
| 11324 | 79.74 | 567.08 | 75.40 | 686.26 | 133.81 |
| 12846 | 79.68 | 27.13 | 8.38 | 43.38 | 16.45 |
| 15642 | 79.43 | 574.29 | 92.23 | 434.05 | 119.62 |
| 1844 | 79.43 | 215.94 | 40.20 | 163.57 | 52.46 |
| 9439 | 79.37 | 715.53 | 238.18 | 1099.47 | 279.57 |
| 1312 | 79.31 | 877.80 | 98.92 | 1048.20 | 167.10 |
| 21462 | 79.31 | 332.31 | 60.15 | 254.18 | 55.30 |
| 17887 | 79.25 | 984.05 | 226.20 | 1384.89 | 288.41 |
| 20918 | 79.25 | 568.16 | 114.17 | 403.50 | 84.82 |
| 15237 | 79.22 | 243.57 | 60.93 | 168.46 | 37.30 |
| 11610 | 79.19 | 368.78 | 38.57 | 303.07 | 70.24 |
| 6059 | 79.07 | 132.38 | 25.33 | 187.49 | 43.92 |
| 9035 | 79.04 | 153.86 | 24.05 | 125.62 | 27.03 |
| 2782 | 79.00 | 413.70 | 142.88 | 205.21 | 80.64 |
| 25366 | 78.91 | 89.96 | 46.99 | 44.98 | 55.94 |
| 20866 | 78.89 | 654.18 | 82.36 | 778.30 | 119.91 |
| 13004 | 78.85 | 174.31 | 28.36 | 131.55 | 40.25 |
| 21140 | 78.79 | 125.03 | 91.50 | 108.35 | 40.63 |
| 11136 | 78.76 | 832.19 | 153.81 | 1147.90 | 344.29 |
| 1247 | 78.73 | 839.48 | 329.16 | 1582.78 | 517.89 |
| 25705 | 78.67 | 608.91 | 95.39 | 477.51 | 114.34 |
| 8445 | 78.64 | 50.64 | 6.93 | 39.43 | 18.79 |
| 16521 | 78.64 | 378.70 | 73.70 | 284.05 | 76.53 |
| 3608 | 78.46 | 198.11 | 80.98 | 358.92 | 138.13 |
| 17693 | 78.46 | 1038.76 | 282.54 | 1505.15 | 387.40 |
| 45 | 78.37 | 97.82 | 39.87 | 173.04 | 76.68 |
| 4532 | 78.31 | 171.23 | 78.76 | 279.78 | 96.10 |
| 21914 | 78.27 | 520.42 | 91.18 | 411.11 | 83.67 |
| 1962 | 78.25 | 44.77 | 12.65 | 26.15 | 23.39 |
| 19110 | 77.85 | 342.86 | 94.88 | 201.97 | 95.13 |
| 21575 | 77.78 | 452.86 | 97.04 | 333.22 | 68.32 |
| 19222 | 77.73 | 563.31 | 40.36 | 635.63 | 111.62 |
| 1515 | 77.63 | 246.92 | 46.18 | 186.59 | 43.06 |
| 9073 | 77.63 | 44.73 | 15.30 | 22.89 | 18.48 |
| 573 | 77.61 | 1599.70 | 404.19 | 2608.86 | 1776.16 |
| 16091 | 77.52 | 20.73 | 9.39 | 32.57 | 13.59 |
| 1401 | 77.33 | 69.28 | 14.03 | 52.22 | 17.29 |
| 21147 | 77.30 | 282.41 | 67.81 | 361.22 | 81.20 |
| 15364 | 77.24 | 77.86 | 12.53 | 102.74 | 36.36 |
| 17154 | 77.24 | 245.45 | 57.67 | 186.78 | 60.02 |
| 3454 | 77.15 | 100.75 | 18.92 | 75.51 | 30.81 |
| 15299 | 77.05 | 115.51 | 45.17 | 75.17 | 56.24 |
| 24770 | 76.96 | 124.63 | 58.14 | 244.33 | 107.12 |
| 4011 | 76.93 | 792.94 | 249.01 | 476.14 | 218.70 |
| 108 | 76.86 | 612.75 | 314.84 | 275.19 | 150.60 |
| 16881 | 76.78 | 442.88 | 61.71 | 533.80 | 110.83 |
| 18887 | 76.75 | 165.20 | 20.55 | 143.02 | 37.45 |
| 3886 | 76.75 | 74.47 | 22.33 | 42.38 | 20.96 |
| 11137 | 76.72 | 1138.55 | 218.66 | 1635.07 | 463.88 |
| 18354 | 76.71 | 704.94 | 297.65 | 400.28 | 242.40 |
| 15576 | 76.69 | 520.40 | 95.90 | 421.09 | 93.97 |
| 28 | 76.62 | 309.69 | 141.93 | 532.57 | 180.04 |
| 25290 | 76.53 | 233.26 | 73.75 | 140.64 | 55.93 |
| 21302 | 76.45 | 175.69 | 45.11 | 245.52 | 73.79 |
| 17274 | 76.44 | 77.42 | 33.89 | 146.25 | 65.82 |
| 20801 | 76.44 | 195.17 | 43.72 | 150.37 | 48.96 |

TABLE 5K

| GLGC Identifier | LDA Score | Tox Group Mean | Tox Group SD | Non-Tox Group Mean | Non-Tox Group SD |
|---|---|---|---|---|---|
| 20848 | 98.67 | 1124.03 | 59.72 | 548.54 | 158.49 |
| 15146 | 98.61 | 552.75 | 212.61 | 125.29 | 66.30 |
| 23123 | 98.54 | 948.44 | 137.32 | 316.83 | 113.69 |
| 25747 | 98.48 | 177.09 | 33.14 | 42.07 | 35.81 |
| 14929 | 98.39 | 2578.08 | 443.16 | 753.00 | 395.31 |
| 15004 | 98.36 | 1003.54 | 557.03 | 153.76 | 135.69 |
| 457 | 98.36 | 766.78 | 198.11 | 285.03 | 90.56 |
| 19040 | 98.36 | 746.18 | 87.47 | 181.80 | 113.32 |
| 12606 | 98.36 | 139.84 | 17.95 | 295.27 | 98.40 |
| 15003 | 98.33 | 555.22 | 226.49 | 31.19 | 86.19 |
| 21165 | 98.33 | 169.51 | 57.41 | 28.30 | 24.49 |
| 22592 | 98.33 | 743.64 | 93.52 | 227.11 | 172.72 |
| 15002 | 98.24 | 640.78 | 258.49 | 133.14 | 98.70 |
| 6416 | 98.21 | 579.40 | 132.32 | 123.67 | 88.39 |
| 20582 | 98.21 | 294.34 | 14.97 | 487.80 | 95.06 |
| 17159 | 98.15 | 1500.61 | 126.72 | 787.85 | 215.88 |
| 1501 | 98.15 | 248.82 | 53.21 | 51.72 | 53.85 |
| 22536 | 98.15 | 3172.12 | 437.63 | 1609.00 | 403.10 |
| 24496 | 98.09 | 30.75 | 7.27 | 111.42 | 36.91 |
| 7196 | 98.06 | 534.14 | 57.92 | 176.74 | 89.27 |
| 7197 | 98.06 | 552.05 | 97.28 | 187.97 | 84.72 |
| 22626 | 98.06 | 466.77 | 115.62 | 84.66 | 75.68 |
| 1809 | 98.03 | 551.79 | 225.15 | 32.34 | 127.23 |
| 17325 | 98.03 | 521.47 | 220.14 | 55.89 | 101.96 |
| 17477 | 98.03 | 241.66 | 34.05 | 111.41 | 35.04 |
| 6842 | 98.00 | 214.44 | 33.38 | 110.48 | 29.69 |
| 18529 | 98.00 | 501.19 | 67.11 | 190.38 | 73.93 |
| 21166 | 97.94 | 715.26 | 183.98 | 263.82 | 92.19 |
| 574 | 97.85 | 1110.83 | 280.01 | 349.51 | 177.04 |
| 24564 | 97.79 | 141.81 | 78.70 | 614.84 | 191.71 |
| 3121 | 97.79 | 435.91 | 101.84 | 1290.92 | 319.95 |
| 24563 | 97.73 | 53.16 | 51.89 | 321.95 | 111.13 |
| 14600 | 97.67 | 377.21 | 86.43 | 184.44 | 47.39 |
| 18657 | 97.67 | 817.51 | 100.75 | 432.51 | 105.51 |
| 3493 | 97.63 | 123.77 | 18.10 | 61.40 | 17.94 |
| 8829 | 97.57 | 506.29 | 44.16 | 283.09 | 85.65 |
| 22631 | 97.57 | 1970.17 | 341.41 | 1035.66 | 227.87 |
| 10532 | 97.54 | 194.55 | 35.06 | 100.22 | 29.27 |
| 21796 | 97.54 | 1253.95 | 159.97 | 690.15 | 198.29 |
| 3125 | 97.51 | 134.07 | 16.15 | 301.07 | 82.87 |
| 7804 | 97.51 | 960.98 | 105.31 | 1652.52 | 334.35 |
| 4944 | 97.51 | 322.82 | 51.74 | 119.57 | 56.74 |
| 1463 | 97.48 | 1492.64 | 275.86 | 664.70 | 314.91 |
| 16394 | 97.42 | 1770.55 | 477.74 | 595.39 | 336.14 |
| 16518 | 97.39 | 1674.58 | 199.69 | 953.13 | 316.63 |
| 21391 | 97.39 | 491.14 | 76.01 | 218.82 | 131.14 |
| 12551 | 97.39 | 81.94 | 8.91 | 164.20 | 42.11 |
| 11157 | 97.36 | 381.78 | 35.68 | 622.92 | 138.68 |
| 7307 | 97.33 | 78.43 | 11.40 | 28.42 | 17.35 |
| 23651 | 97.33 | 2999.14 | 682.81 | 737.32 | 670.73 |
| 18275 | 97.21 | 161.22 | 17.79 | 261.59 | 56.25 |
| 2563 | 97.12 | 270.81 | 32.33 | 158.90 | 37.75 |
| 21797 | 97.12 | 684.25 | 148.72 | 331.98 | 107.52 |
| 25198 | 97.09 | 72.42 | 16.64 | 27.14 | 14.63 |
| 15879 | 97.09 | 195.88 | 18.98 | 348.95 | 67.27 |
| 20885 | 97.06 | 198.55 | 50.26 | 589.85 | 226.42 |
| 24321 | 97.03 | 278.42 | 73.76 | 654.31 | 157.88 |
| 15032 | 97.03 | 98.00 | 17.89 | 265.50 | 73.53 |
| 17221 | 97.03 | 228.07 | 58.62 | 528.15 | 137.97 |
| 2534 | 97.03 | 70.98 | 11.01 | 35.47 | 11.17 |
| 15964 | 97.03 | 389.05 | 102.49 | 1091.29 | 283.24 |
| 16172 | 97.00 | 196.13 | 57.63 | 438.64 | 92.11 |
| 10241 | 97.00 | 135.36 | 24.60 | 59.08 | 23.90 |
| 14677 | 96.97 | 173.50 | 38.06 | 69.76 | 30.14 |
| 18528 | 96.97 | 806.92 | 124.34 | 361.09 | 159.22 |
| 24388 | 96.91 | 366.07 | 61.09 | 177.80 | 66.28 |
| 20884 | 96.88 | 157.01 | 69.56 | 737.17 | 291.54 |
| 22213 | 96.85 | 343.29 | 29.34 | 220.99 | 47.39 |
| 20457 | 96.85 | 203.76 | 31.70 | 396.48 | 99.84 |
| 10015 | 96.85 | 467.24 | 95.91 | 230.34 | 82.57 |
| 14970 | 96.85 | 103.48 | 14.71 | 199.88 | 40.65 |
| 2569 | 96.85 | 169.84 | 58.46 | 421.57 | 98.69 |
| 20828 | 96.82 | 843.23 | 197.75 | 322.31 | 161.39 |
| 15928 | 96.73 | 360.97 | 86.20 | 159.46 | 54.19 |
| 1460 | 96.69 | 382.75 | 102.15 | 191.62 | 82.76 |
| 19991 | 96.66 | 169.60 | 23.54 | 342.07 | 85.80 |
| 14142 | 96.57 | 126.88 | 24.18 | 75.34 | 18.27 |
| 15089 | 96.54 | 343.46 | 36.17 | 177.01 | 69.57 |
| 17473 | 96.51 | 693.48 | 64.78 | 442.45 | 103.23 |
| 20983 | 96.51 | 56.90 | 15.12 | 137.12 | 56.79 |
| 7414 | 96.48 | 301.62 | 37.09 | 183.56 | 50.38 |
| 645 | 96.42 | 46.88 | 15.03 | 135.75 | 49.83 |
| 13610 | 96.30 | 183.04 | 38.90 | 365.50 | 106.63 |
| 17933 | 96.27 | 250.36 | 25.67 | 394.80 | 75.13 |
| 17363 | 96.21 | 639.82 | 80.77 | 1037.93 | 191.02 |
| 5205 | 96.18 | 86.34 | 21.51 | 204.18 | 49.25 |
| 13332 | 96.12 | 184.35 | 54.35 | 438.90 | 102.70 |
| 16885 | 96.12 | 481.97 | 76.93 | 847.27 | 179.62 |
| 4235 | 96.03 | 655.06 | 64.01 | 411.65 | 95.74 |
| 20088 | 96.00 | 216.81 | 25.74 | 391.74 | 86.08 |
| 13723 | 95.97 | 1591.34 | 343.04 | 844.53 | 377.73 |
| 2107 | 95.94 | 286.61 | 18.41 | 438.00 | 95.36 |
| 9212 | 95.94 | 1468.88 | 150.78 | 909.30 | 234.39 |
| 23076 | 95.88 | 225.13 | 23.27 | 126.52 | 43.88 |
| 25064 | 95.88 | 1945.50 | 256.26 | 1121.25 | 327.07 |
| 3995 | 95.85 | 316.65 | 57.49 | 606.04 | 143.87 |
| 7892 | 95.72 | 197.94 | 41.59 | 93.14 | 62.88 |
| 14120 | 95.69 | 344.76 | 63.42 | 681.34 | 196.77 |
| 20458 | 95.48 | 190.71 | 40.37 | 368.84 | 96.93 |
| 968 | 95.42 | 28.67 | 11.78 | 81.24 | 22.91 |
| 15833 | 95.39 | 347.90 | 22.55 | 491.39 | 86.11 |
| 1453 | 95.30 | 123.25 | 24.55 | 52.01 | 26.39 |
| 24643 | 95.30 | 22.65 | 15.29 | 92.91 | 36.14 |
| 1454 | 95.27 | 243.07 | 44.54 | 107.34 | 52.73 |
| 23033 | 95.24 | 416.40 | 24.35 | 579.36 | 117.73 |
| 18074 | 94.97 | 109.26 | 17.39 | 48.61 | 23.99 |
| 9905 | 94.97 | 409.12 | 110.92 | 745.80 | 152.14 |
| 25802 | 94.94 | 793.44 | 106.90 | 521.62 | 118.73 |
| 1214 | 94.88 | 67.47 | 15.18 | 153.85 | 51.68 |
| 2465 | 94.75 | 74.41 | 17.98 | 131.77 | 26.88 |
| 2368 | 94.72 | 338.76 | 47.77 | 623.40 | 131.64 |
| 19824 | 94.72 | 96.00 | 24.52 | 215.81 | 73.19 |
| 646 | 94.72 | 210.57 | 63.36 | 527.32 | 192.98 |
| 14989 | 94.54 | 784.37 | 97.84 | 533.89 | 115.84 |
| 405 | 94.48 | 122.46 | 18.09 | 208.02 | 63.59 |
| 25546 | 94.39 | 236.19 | 103.10 | 500.97 | 150.34 |
| 22910 | 94.33 | 205.38 | 23.87 | 311.27 | 55.99 |
| 15297 | 94.24 | 235.35 | 26.33 | 147.28 | 40.80 |
| 17494 | 94.24 | 137.15 | 20.45 | 216.68 | 41.79 |
| 2010 | 94.21 | 280.66 | 119.92 | 31.78 | 286.73 |
| 19712 | 94.12 | 38.70 | 9.79 | 84.74 | 26.43 |
| 1564 | 94.03 | 1045.96 | 352.70 | 42.41 | 190.11 |
| 17735 | 94.00 | 260.66 | 25.70 | 179.21 | 105.51 |
| 3853 | 94.00 | 89.36 | 14.28 | 154.56 | 34.31 |
| 20481 | 93.94 | 123.57 | 15.86 | 201.41 | 41.25 |
| 1510 | 93.94 | 410.93 | 156.67 | 839.46 | 222.78 |
| 21072 | 93.88 | 97.50 | 27.28 | 199.81 | 51.39 |
| 17800 | 93.81 | 115.79 | 18.77 | 196.78 | 42.92 |
| 14465 | 93.69 | 22.00 | 7.12 | 55.40 | 19.66 |
| 17249 | 93.63 | 662.67 | 98.62 | 1014.19 | 206.07 |
| 4449 | 93.57 | 129.63 | 26.81 | 243.37 | 70.00 |
| 1993 | 93.48 | 86.65 | 13.28 | 24.00 | 17.68 |
| 15540 | 93.45 | 116.06 | 52.11 | 33.92 | 19.17 |
| 12848 | 93.39 | 278.64 | 36.68 | 431.16 | 92.63 |
| 23063 | 93.30 | 242.82 | 57.21 | 390.31 | 77.53 |
| 20816 | 93.24 | 1045.14 | 268.49 | 407.56 | 184.26 |
| 1970 | 93.12 | 395.31 | 97.34 | 159.82 | 57.55 |
| 2629 | 92.97 | 126.65 | 56.54 | 22.18 | 24.99 |
| 4234 | 92.87 | 227.21 | 26.55 | 368.61 | 110.36 |
| 23783 | 92.87 | 303.32 | 50.24 | 456.35 | 79.84 |
| 20849 | 92.82 | 517.85 | 86.60 | 281.86 | 89.61 |
| 3438 | 92.81 | 157.80 | 81.72 | 149.25 | 39.94 |
| 2576 | 92.78 | 43.64 | 15.68 | 84.39 | 23.87 |
| 1472 | 92.75 | 84.81 | 22.82 | 179.09 | 72.56 |
| 1824 | 92.72 | 58.52 | 11.62 | 110.12 | 31.28 |
| 21653 | 92.66 | 435.18 | 92.53 | 237.04 | 66.87 |
| 24649 | 92.66 | 80.76 | 6.94 | 112.06 | 23.19 |
| 17736 | 92.57 | 156.31 | 28.57 | 69.99 | 158.10 |
| 20126 | 92.54 | 206.98 | 53.24 | 75.61 | 46.32 |
| 15850 | 92.48 | 1864.12 | 172.78 | 1413.57 | 279.10 |

TABLE 5L

| GLGC Identifier | LDA Score | Tox Group Mean | Tox Group SD | Non-Tox Group Mean | Non-Tox Group SD |
|---|---|---|---|---|---|
| 7540 | 97.93 | 486.02 | 138.76 | 157.21 | 80.71 |
| 7299 | 97.84 | 646.85 | 211.22 | 178.29 | 134.95 |
| 4661 | 95.47 | 517.39 | 93.47 | 306.62 | 84.32 |
| 13614 | 94.20 | 559.10 | 110.65 | 323.06 | 68.04 |
| 14595 | 92.40 | 158.58 | 45.64 | 77.34 | 33.09 |
| 22479 | 92.04 | 716.72 | 125.18 | 416.64 | 126.59 |
| 23151 | 91.91 | 200.64 | 48.10 | 356.08 | 100.63 |
| 15964 | 91.55 | 539.50 | 171.88 | 1092.30 | 283.63 |
| 15411 | 91.34 | 532.28 | 101.56 | 303.52 | 93.15 |
| 13615 | 90.34 | 398.90 | 85.87 | 240.22 | 52.84 |
| 12921 | 90.13 | 225.68 | 80.44 | 101.95 | 47.41 |
| 12979 | 89.28 | 754.80 | 237.57 | 364.95 | 194.44 |
| 21354 | 88.97 | 645.15 | 137.68 | 417.97 | 125.69 |
| 16982 | 88.41 | 872.27 | 500.25 | 127.82 | 293.88 |
| 20713 | 88.19 | 613.63 | 263.40 | 208.35 | 112.71 |
| 22619 | 88.03 | 501.19 | 81.50 | 363.98 | 67.50 |
| 24321 | 87.93 | 413.07 | 112.27 | 654.29 | 158.97 |
| 14763 | 87.65 | 304.65 | 189.03 | 37.13 | 142.64 |
| 16521 | 87.65 | 508.30 | 116.48 | 282.94 | 73.28 |
| 24200 | 87.65 | 819.79 | 161.12 | 425.21 | 136.58 |
| 18300 | 87.44 | 220.58 | 102.85 | 486.89 | 169.94 |
| 22698 | 87.20 | 115.27 | 56.59 | 268.84 | 120.86 |
| 13310 | 87.15 | 232.04 | 61.40 | 124.22 | 68.91 |
| 23166 | 87.07 | 254.30 | 83.26 | 126.36 | 61.00 |
| 1894 | 87.01 | 371.06 | 120.65 | 196.88 | 70.39 |
| 22103 | 86.70 | 364.57 | 103.66 | 219.40 | 53.63 |
| 21654 | 86.49 | 610.80 | 129.78 | 376.37 | 127.86 |
| 5183 | 86.42 | 320.31 | 60.86 | 221.48 | 61.55 |
| 6102 | 86.24 | 198.65 | 25.41 | 143.71 | 30.86 |
| 8759 | 86.16 | 246.43 | 53.78 | 156.18 | 40.90 |
| 15191 | 85.85 | 2673.45 | 2339.47 | 2414.85 | 1220.31 |
| 20714 | 85.62 | 475.80 | 301.89 | 167.76 | 86.41 |
| 15538 | 85.56 | 293.17 | 36.37 | 218.71 | 56.03 |
| 4119 | 85.47 | 162.78 | 28.48 | 109.13 | 32.45 |
| 3020 | 85.38 | 424.83 | 78.70 | 293.70 | 77.59 |
| 22737 | 85.25 | 409.70 | 157.83 | 207.21 | 89.14 |
| 19031 | 85.24 | 118.24 | 42.75 | 59.90 | 50.43 |
| 8065 | 85.15 | 225.82 | 45.65 | 163.47 | 35.91 |
| 11057 | 85.12 | 96.32 | 38.40 | 34.75 | 28.49 |
| 9583 | 85.07 | 208.74 | 101.61 | 55.02 | 59.66 |
| 20711 | 84.95 | 140.70 | 71.44 | 33.55 | 34.91 |
| 21975 | 84.94 | 342.10 | 74.80 | 211.95 | 62.48 |
| 15535 | 84.79 | 635.56 | 107.51 | 476.52 | 79.47 |
| 20715 | 84.77 | 296.44 | 124.89 | 126.05 | 58.80 |
| 21683 | 84.77 | 83.44 | 41.31 | 26.99 | 20.17 |
| 18678 | 84.72 | 196.91 | 72.64 | 100.06 | 53.79 |
| 2457 | 84.67 | 464.90 | 167.87 | 288.94 | 67.89 |
| 18269 | 84.55 | 548.35 | 110.14 | 772.70 | 179.32 |
| 21339 | 84.46 | 79.78 | 30.57 | 34.21 | 20.21 |
| 16775 | 84.32 | 572.11 | 282.27 | 1168.56 | 397.36 |
| 8202 | 84.27 | 377.45 | 72.53 | 277.16 | 54.79 |
| 17477 | 84.19 | 180.63 | 52.28 | 111.57 | 35.73 |
| 24197 | 84.17 | 107.40 | 60.94 | 236.21 | 79.34 |
| 15679 | 84.16 | 286.66 | 65.08 | 173.83 | 46.74 |
| 17516 | 84.12 | 769.10 | 139.21 | 544.65 | 126.18 |
| 1807 | 84.08 | 1593.11 | 543.91 | 4019.95 | 2715.05 |
| 1597 | 84.01 | 141.64 | 66.96 | 42.68 | 38.09 |
| 6758 | 83.67 | 60.74 | 21.52 | 28.80 | 13.40 |
| 11324 | 83.67 | 525.31 | 77.71 | 686.40 | 133.36 |
| 15667 | 85.51 | 1304.24 | 352.22 | 2487.79 | 1225.01 |
| 23978 | 83.49 | 74.40 | 21.67 | 112.19 | 29.95 |
| 15446 | 83.46 | 502.42 | 69.06 | 388.27 | 92.25 |
| 23712 | 83.36 | 224.13 | 38.61 | 157.15 | 38.03 |
| 16476 | 83.27 | 533.78 | 102.18 | 788.60 | 304.36 |
| 21014 | 83.22 | 324.17 | 132.01 | 148.40 | 78.26 |
| 5295 | 83.12 | 408.06 | 135.30 | 217.58 | 80.67 |
| 6046 | 83.07 | 101.90 | 48.10 | 194.33 | 61.90 |
| 7451 | 82.91 | 502.98 | 103.58 | 367.08 | 83.19 |
| 7471 | 82.90 | 308.76 | 49.66 | 224.13 | 54.98 |
| 14425 | 82.88 | 332.80 | 79.03 | 203.82 | 68.76 |
| 6833 | 82.80 | 96.02 | 13.68 | 73.52 | 18.72 |
| 12673 | 82.79 | 90.29 | 25.44 | 40.47 | 22.14 |
| 21125 | 82.76 | 96.85 | 28.42 | 152.75 | 47.47 |
| 17950 | 82.75 | 89.75 | 11.67 | 61.68 | 19.97 |
| 8820 | 82.74 | 530.25 | 320.31 | 138.57 | 119.39 |
| 1857 | 82.73 | 341.51 | 97.88 | 203.31 | 63.37 |
| 9026 | 82.73 | 109.55 | 35.12 | 60.22 | 26.27 |
| 19509 | 82.73 | 48.13 | 11.49 | 80.75 | 26.24 |
| 14677 | 82.70 | 123.20 | 43.11 | 69.90 | 30.74 |
| 1858 | 82.64 | 264.03 | 71.62 | 153.29 | 49.94 |
| 21956 | 82.63 | 206.97 | 23.50 | 163.56 | 37.58 |
| 14131 | 82.63 | 69.28 | 24.69 | 33.77 | 24.51 |
| 6431 | 82.62 | 132.49 | 55.91 | 49.83 | 28.54 |
| 17088 | 82.59 | 92.61 | 16.98 | 58.41 | 31.43 |
| 15666 | 82.57 | 1060.02 | 522.22 | 2855.82 | 1671.25 |
| 19011 | 82.51 | 487.88 | 60.90 | 393.64 | 86.49 |
| 20522 | 82.48 | 341.19 | 119.99 | 166.57 | 84.98 |
| 21147 | 82.43 | 260.55 | 45.69 | 361.25 | 81.16 |
| 22321 | 82.42 | 175.73 | 62.89 | 94.40 | 68.17 |
| 17357 | 82.25 | 167.86 | 96.71 | 269.67 | 96.37 |
| 24438 | 82.21 | 98.87 | 20.24 | 143.39 | 40.54 |
| 16552 | 82.19 | 106.93 | 35.18 | 162.92 | 41.40 |
| 23679 | 81.96 | 67.13 | 19.94 | 38.29 | 19.93 |
| 1804 | 81.93 | 1429.11 | 390.65 | 3161.94 | 1771.85 |
| 16446 | 81.63 | 26.33 | 5.45 | 37.15 | 10.18 |
| 24566 | 81.55 | 61.11 | 42.07 | 180.55 | 89.38 |
| 15032 | 81.50 | 153.02 | 48.41 | 265.54 | 73.91 |
| 16681 | 81.28 | 120.46 | 46.82 | 63.39 | 25.75 |
| 23869 | 81.20 | 68.78 | 38.38 | 35.67 | 78.90 |
| 21443 | 81.12 | 204.24 | 81.36 | 91.06 | 49.71 |
| 1422 | 81.09 | 170.29 | 61.30 | 300.89 | 105.05 |
| 16520 | 80.98 | 273.60 | 150.69 | 86.32 | 98.04 |
| 8212 | 80.98 | 2755.24 | 1630.16 | 2776.64 | 1026.95 |
| 16610 | 80.56 | 243.87 | 59.82 | 165.05 | 65.89 |
| 13091 | 80.48 | 52.53 | 22.18 | 93.54 | 32.42 |
| 13004 | 80.46 | 212.11 | 74.18 | 131.27 | 39.09 |
| 20404 | 80.43 | 94.71 | 35.90 | 45.29 | 43.92 |
| 20801 | 80.39 | 235.97 | 71.05 | 150.06 | 48.11 |
| 15409 | 80.33 | 650.73 | 204.15 | 413.05 | 118.78 |
| 2153 | 80.16 | 416.39 | 243.57 | 174.99 | 148.74 |
| 16312 | 80.12 | 102.23 | 41.22 | 49.22 | 37.54 |
| 28 | 80.08 | 305.95 | 229.49 | 532.06 | 179.36 |
| 9541 | 80.05 | 434.33 | 105.00 | 293.71 | 104.56 |
| 4749 | 80.02 | 382.14 | 128.89 | 229.43 | 180.48 |
| 13092 | 79.97 | 78.72 | 26.06 | 126.13 | 38.28 |
| 4290 | 79.94 | 131.21 | 41.46 | 84.46 | 26.82 |
| 20458 | 79.76 | 244.63 | 78.16 | 368.93 | 97.12 |
| 3254 | 79.68 | 261.62 | 54.46 | 188.01 | 48.62 |
| 1943 | 79.66 | 47.96 | 16.20 | 25.73 | 11.95 |
| 24219 | 79.60 | 487.67 | 128.97 | 321.74 | 100.36 |
| 7197 | 79.60 | 330.86 | 107.57 | 188.93 | 88.45 |
| 15137 | 79.56 | 1740.58 | 785.79 | 1800.11 | 446.41 |
| 20457 | 79.40 | 282.98 | 97.45 | 396.37 | 100.16 |
| 18713 | 79.36 | 381.95 | 48.08 | 304.10 | 71.82 |
| 343 | 79.15 | 86.27 | 53.27 | 26.04 | 28.49 |
| 4235 | 79.08 | 495.44 | 76.22 | 412.41 | 97.43 |
| 15421 | 78.89 | 574.98 | 96.06 | 739.12 | 153.32 |
| 19665 | 78.87 | 164.53 | 59.70 | 88.19 | 51.24 |
| 20925 | 78.68 | 466.02 | 114.97 | 342.39 | 120.38 |
| 12276 | 78.61 | 103.82 | 42.09 | 187.47 | 61.18 |
| 24472 | 78.43 | 185.77 | 62.80 | 235.91 | 53.31 |
| 18352 | 78.40 | 338.81 | 174.54 | 155.29 | 86.17 |
| 45 | 78.36 | 76.12 | 49.26 | 173.08 | 76.39 |
| 25453 | 78.35 | 158.39 | 37.24 | 209.35 | 50.63 |
| 7489 | 78.33 | 30.74 | 20.35 | 73.04 | 31.19 |
| 1977 | 78.29 | 187.70 | 37.39 | 133.15 | 38.47 |
| 20523 | 78.29 | 867.83 | 225.50 | 579.11 | 163.88 |
| 17394 | 78.25 | 484.34 | 116.34 | 347.89 | 115.27 |
| 23868 | 78.20 | 339.24 | 209.69 | 170.18 | 283.60 |
| 20961 | 78.19 | 20.76 | 3.97 | 29.87 | 11.94 |

TABLE 5M

| GLGC Identifier | LDA Score | Tox Group Mean | Tox Group SD | Non-Tox Group Mean | Non-Tox Group SD |
|---|---|---|---|---|---|
| 9583 | 83.08244685 | 136.5487393 | 110.2849532 | 37.66760888 | 13.19753272 |
| 16982 | 82.32427648 | 483.6882478 | 552.3046692 | 49.88186324 | 32.90131915 |
| 15032 | 82.28102403 | 177.3289571 | 70.86858812 | 283.5409217 | 59.40838768 |
| 15964 | 81.60585161 | 743.874312 | 299.3609708 | 1181.361174 | 213.1612425 |
| 12979 | 80.3700673 | 643.9611477 | 322.5396617 | 306.527439 | 85.13902429 |
| 21654 | 80.32714885 | 549.4204342 | 209.6721242 | 339.6935388 | 55.84290884 |
| 19184 | 80.29859221 | 184.5060699 | 138.4017224 | 57.12969511 | 21.21914631 |
| 5461 | 80.12975735 | 363.2475499 | 214.8634774 | 167.0601785 | 45.37528089 |
| 23651 | 79.97244535 | 1637.54072 | 1189.420285 | 542.9096823 | 191.3034224 |
| 14425 | 79.31714567 | 289.2956631 | 105.737495 | 184.9582598 | 40.7473309 |
| 16312 | 78.76788965 | 101.8624891 | 64.40370386 | 38.35845782 | 14.61990063 |
| 22681 | 78.67353585 | 469.7183212 | 361.5563587 | 167.2478183 | 55.584236 |
| 23166 | 78.55613634 | 206.8477645 | 101.4273335 | 108.1093764 | 29.94389506 |
| 1529 | 78.52440674 | 215.9442383 | 69.39046225 | 311.3015724 | 57.33641031 |
| 28 | 78.45860958 | 337.7569525 | 190.3579737 | 572.6706363 | 145.8390237 |
| 2242 | 78.44441476 | 1562.266609 | 687.2650843 | 2311.300749 | 401.81139 |
| 7489 | 78.41251816 | 39.969397 | 22.84173 | 80.91009417 | 28.09717441 |
| 2555 | 78.31866535 | 138.9497043 | 71.0446582 | 72.74579762 | 17.34013384 |
| 22569 | 78.31833136 | 433.3052164 | 165.3260103 | 660.2852423 | 135.0527541 |
| 11618 | 78.26405705 | 253.3853136 | 122.3102383 | 409.7968553 | 86.37081821 |
| 3874 | 77.9921845 | 655.5341186 | 183.3817932 | 905.2090016 | 155.1052713 |
| 17682 | 77.92371537 | 543.6295408 | 230.3423337 | 801.6274752 | 133.4359357 |
| 4291 | 77.81767172 | 182.8583968 | 89.67887639 | 304.1338558 | 72.33137744 |
| 22321 | 77.79228804 | 179.8586879 | 123.2440901 | 75.47084945 | 26.5781107 |
| 21683 | 77.71496802 | 55.09213984 | 33.27371704 | 21.13344315 | 9.738536318 |
| 812 | 77.52008149 | 110.300102 | 37.74055592 | 159.2009582 | 31.00283772 |
| 15928 | 77.50321471 | 230.6186191 | 81.85977686 | 144.792893 | 33.217028 |
| 17361 | 77.49 | 81.56 | 49.55 | 151.85 | 49.33 |
| 3610 | 77.34289675 | 786.5228846 | 383.1597512 | 1195.762426 | 266.7672417 |
| 19040 | 77.34022478 | 341.4502271 | 225.2340943 | 150.6823975 | 34.34075604 |
| 15382 | 77.33170789 | 389.1289702 | 422.3483993 | 77.24627235 | 48.54365298 |
| 6046 | 77.32 | 132.00 | 60.76 | 209.20 | 53.92 |
| 16314 | 77.26 | 103.96 | 76.71 | 33.61 | 21.85 |
| 16168 | 77.11995458 | 630.283295 | 458.341233 | 308.4957265 | 64.72400923 |
| 12978 | 77.09123094 | 161.0616731 | 78.8602948 | 82.73480249 | 24.06911838 |
| 8721 | 76.93057898 | 122.2361625 | 61.9077009 | 198.8519365 | 58.96316989 |
| 21239 | 76.71932666 | 181.7185987 | 94.60956961 | 89.35257633 | 26.32116899 |
| 3091 | 76.72 | 545.67 | 168.85 | 749.73 | 128.16 |
| 13610 | 76.70479785 | 274.9562845 | 90.96833619 | 381.8322514 | 61.62951755 |
| 14970 | 76.68191914 | 152.2102141 | 48.9266423 | 210.6102648 | 31.30381828 |
| 22929 | 76.65586747 | 487.9160657 | 270.6330491 | 875.0391787 | 272.829724 |
| 15299 | 76.64785157 | 136.3012386 | 106.157285 | 61.66374238 | 17.88937389 |
| 3050 | 76.59 | 151.97 | 82.62 | 77.07 | 24.98 |
| 17325 | 76.58205441 | 189.7373516 | 208.0626111 | 31.0587134 | 24.22087464 |
| 24219 | 76.53329103 | 444.4375114 | 155.5594702 | 293.4620384 | 58.4499819 |
| 14929 | 76.3703011 | 1275.172779 | 801.0896181 | 653.6952264 | 132.6222434 |
| 6641 | 76.28696916 | 306.0713042 | 88.62194155 | 420.6952038 | 68.81743517 |
| 19723 | 76.2759473 | 128.2970893 | 90.41070177 | 60.09331086 | 19.39755748 |
| 13151 | 76.2443847 | 1189.02038 | 539.5803104 | 699.6056428 | 197.7526277 |
| 15300 | 76.21582806 | 266.4468852 | 233.7031532 | 96.87648497 | 38.58692577 |
| 16756 | 76.03547035 | 221.6236525 | 72.76140952 | 160.6260948 | 27.82533344 |
| 17161 | 76.03263139 | 1821.710174 | 615.9155321 | 1215.712544 | 234.8577001 |
| 9053 | 75.99806282 | 188.4077043 | 54.90371237 | 248.8278068 | 39.5416499 |
| 20458 | 75.72902924 | 275.504871 | 100.5231472 | 389.1120081 | 82.94622112 |
| 6638 | 75.69462768 | 69.35965051 | 25.19842597 | 99.4446383 | 21.49763394 |
| 24431 | 75.66373307 | 140.4973047 | 186.7414923 | 42.63904535 | 13.19878574 |
| 15110 | 75.64870326 | 524.7385351 | 161.2970513 | 744.3958487 | 164.5366762 |
| 24200 | 75.62916451 | 597.8931172 | 203.1549298 | 387.8593222 | 82.09773986 |
| 3875 | 75.61 | 354.67 | 119.89 | 510.04 | 111.81 |
| 7936 | 75.6144687 | 108.4356886 | 31.04246293 | 144.7023827 | 27.85248861 |
| 3823 | 75.50 | 654.04 | 216.61 | 458.26 | 76.00 |
| 20848 | 75.49473122 | 739.8558427 | 245.0915553 | 506.9787921 | 87.26939539 |
| 1246 | 75.4800354 | 51.06050058 | 35.73888552 | 88.19304576 | 29.97104786 |
| 3995 | 75.44012291 | 463.5694638 | 147.804498 | 633.8236834 | 110.344027 |
| 1460 | 75.37749871 | 290.3524955 | 157.0068948 | 170.5734639 | 30.83287626 |
| 574 | 75.37182078 | 578.2333054 | 363.7499773 | 306.4754643 | 52.52429358 |
| 18300 | 75.28548287 | 313.2217374 | 163.4937659 | 527.1882256 | 147.3671747 |
| 2905 | 75.27729998 | 347.6900677 | 151.3778017 | 208.053687 | 61.26056458 |
| 22197 | 75.25726023 | 157.3709099 | 70.51415356 | 101.3246948 | 27.03541912 |
| 21147 | 75.23404753 | 286.2720645 | 82.6150118 | 378.7980181 | 67.04188806 |
| 15330 | 75.22252467 | 58.49125065 | 22.6188477 | 86.8547667 | 21.0269227 |
| 21391 | 75.21166981 | 385.8061478 | 231.5126036 | 186.3801082 | 64.9269088 |
| 9905 | 75.17125633 | 584.5801895 | 181.1793745 | 780.6799824 | 116.1344345 |
| 20056 | 75.15121658 | 244.8044459 | 87.51577736 | 328.9803149 | 56.49987294 |
| 22612 | 75.13100984 | 343.7327296 | 116.5116157 | 484.2960858 | 98.80695732 |
| 23868 | 75.06003574 | 476.5917806 | 578.566726 | 104.3862329 | 73.16177261 |
| 14458 | 75.02262821 | 66.07115821 | 38.46172099 | 29.15168483 | 17.52209128 |
| 24237 | 74.96551494 | 89.34383693 | 56.62184758 | 42.92380577 | 17.40618436 |
| 14424 | 74.93411934 | 239.4400853 | 296.6620083 | 40.59217046 | 37.53029959 |
| 17401 | 74.88535596 | 1485.695027 | 694.8549568 | 908.508536 | 210.902772 |
| 18906 | 74.86197625 | 170.7813444 | 84.29130131 | 280.2632832 | 81.29656617 |
| 13611 | 74.83642558 | 171.0261776 | 92.33219744 | 268.1311179 | 69.5925432 |
| 5601 | 74.82 | 640.28 | 294.69 | 934.56 | 178.65 |
| 7299 | 74.79100215 | 340.4805627 | 256.9208944 | 144.5353128 | 52.30383717 |
| 12921 | 74.78231826 | 160.5493302 | 75.66485918 | 89.60925607 | 28.73773092 |
| 4463 | 74.76762245 | 101.5953476 | 62.27587437 | 161.6717233 | 53.31108112 |
| 8143 | 74.69080343 | 104.7695109 | 84.13921659 | 29.09088827 | 30.02739607 |
| 10818 | 74.69046943 | 290.080445 | 197.297128 | 507.055784 | 156.484313 |
| 23538 | 74.65656886 | 187.0143437 | 128.8639475 | 88.48179831 | 33.56740662 |
| 4944 | 74.64504601 | 188.8391331 | 90.79119087 | 105.8633001 | 33.59442944 |
| 15111 | 74.61314941 | 829.5271044 | 273.3268883 | 1166.379712 | 236.6780581 |
| 10985 | 74.58459278 | 800.410809 | 240.2270404 | 1100.953535 | 203.6618654 |
| 17357 | 74.57323692 | 177.8296623 | 108.4523586 | 287.6047245 | 80.31450427 |
| 17908 | 74.56789299 | 121.3571079 | 116.1216261 | 42.52999623 | 16.5484268 |
| 4330 | 74.56171407 | 347.3358307 | 137.4559711 | 482.9800669 | 108.2803404 |
| 3121 | 74.54468028 | 959.6912721 | 406.1173378 | 1369.205783 | 250.5821685 |
| 23299 | 74.52480753 | 468.8078098 | 165.8361914 | 330.3112996 | 69.58410495 |
| 20161 | 74.51345168 | 72.01468121 | 53.68059035 | 25.31805526 | 16.61070956 |
| 15089 | 74.51328468 | 251.3256155 | 99.68382039 | 160.3812585 | 49.67999362 |
| 20457 | 74.51311768 | 307.2459887 | 108.9163745 | 417.6507608 | 84.51558942 |
| 22592 | 74.45049348 | 441.3278412 | 302.5254789 | 185.7428044 | 92.86088318 |
| 21025 | 74.37 | 313.31 | 107.42 | 441.97 | 94.86 |
| 20830 | 74.35313372 | 763.4705375 | 278.5082765 | 513.0660947 | 135.9445144 |
| 23261 | 74.33008801 | 1167.643034 | 374.5231911 | 1601.584279 | 272.589167 |
| 15618 | 74.28733655 | 115.8554442 | 40.3151267 | 80.50306764 | 17.75243271 |
| 1422 | 74.27831867 | 203.5115649 | 89.60232364 | 319.0362239 | 84.83935923 |
| 5863 | 74.19832668 | 106.0616484 | 33.34272725 | 146.2567669 | 29.69099415 |
| 6804 | 74.10681184 | 789.9900816 | 408.8443154 | 1302.23147 | 346.2547845 |
| 15986 | 74.09829495 | 229.6581874 | 101.2853036 | 339.5941441 | 70.48693419 |
| 18360 | 74.08076017 | 154.4788107 | 47.05055977 | 214.393766 | 51.15202013 |
| 12349 | 74.04652561 | 196.4837332 | 54.09188201 | 244.5657486 | 51.7956927 |
| 13609 | 74.00076819 | 176.8117791 | 58.87359803 | 251.9175082 | 56.78328918 |
| 19678 | 73.99809622 | 44.46188591 | 60.23324179 | 110.3513435 | 45.83978038 |
| 1727 | 73.94699487 | 105.4102508 | 122.46824 | 22.29966809 | 20.76306568 |
| 18337 | 73.9209432 | 1205.405107 | 398.898709 | 1647.906831 | 276.5380239 |
| 4479 | 73.90691538 | 235.8144938 | 118.8454211 | 131.9693374 | 56.66432098 |
| 12961 | 73.90073646 | 137.3492423 | 37.56911937 | 177.0745243 | 32.15894315 |
| 15879 | 73.8893806 | 284.5730052 | 70.16546857 | 362.8390325 | 59.90658185 |
| 7540 | 73.88403667 | 252.9068785 | 154.8627671 | 138.9588658 | 33.26393784 |
| 1462 | 73.80103873 | 698.281705 | 424.3668671 | 379.7373024 | 81.29117089 |
| 15002 | 73.72672467 | 244.2298557 | 206.548638 | 112.5697128 | 27.72152824 |
| 13727 | 73.69182211 | 67.87259725 | 42.11981673 | 119.1840195 | 37.60278063 |
| 15955 | 73.57 | 515.14 | 191.35 | 728.18 | 122.31 |
| 20035 | 73.51781032 | 306.7725912 | 177.3556465 | 157.6016663 | 53.16881717 |
| 8339 | 73.49175865 | 292.7362043 | 124.6264371 | 423.1068251 | 88.76931187 |
| 811 | 73.48324176 | 192.9770905 | 69.9330111 | 265.1530947 | 46.48636774 |
| 7101 | 73.48 | 1028.63 | 1448.92 | 269.03 | 75.33 |
| 15039 | 73.40876071 | 191.9823051 | 102.7247359 | 287.9523913 | 78.10921214 |
| 3822 | 73.37469314 | 1222.471751 | 463.1311279 | 866.8616534 | 181.1339295 |
| 3959 | 73.36600925 | 453.5922062 | 139.9476597 | 330.9248233 | 74.21747797 |
| 4952 | 73.3546534 | 155.5933788 | 74.76467916 | 95.46100924 | 25.88868161 |
| 13411 | 73.35114644 | 525.6540474 | 243.9929933 | 878.9727098 | 298.4088281 |
| 24496 | 73.34864147 | 77.53936584 | 41.56582163 | 118.8841241 | 29.67076515 |
| 23978 | 73.34279655 | 86.92932267 | 32.18783863 | 116.8288797 | 26.49810705 |
| 11483 | 73.32041883 | 116.3027555 | 97.07083281 | 45.19525799 | 13.89151735 |
| 22885 | 73.32025183 | 1845.034431 | 706.0839859 | 1184.427221 | 338.8455491 |
| 4440 | 73.28 | 210.00 | 74.37 | 306.59 | 75.86 |
| 2195 | 73.27115446 | 58.1346164 | 36.41544415 | 94.82246526 | 34.85537693 |
| 20694 | 73.25712663 | 743.8512961 | 251.4832563 | 959.0486315 | 180.735879 |
| 3467 | 73.26 | 477.56 | 179.67 | 670.32 | 151.77 |
| 14677 | 73.22 | 105.84 | 49.33 | 62.34 | 18.47 |
| 6487 | 73.18247858 | 87.46073345 | 24.66936209 | 113.1656478 | 25.19154745 |
| 3608 | 73.17680065 | 234.714193 | 128.0553145 | 383.4977487 | 124.1499765 |
| 23203 | 73.16243884 | 136.4482476 | 40.60846178 | 175.9440252 | 38.17308244 |
| 10887 | 73.15091598 | 45.59776079 | 19.26180792 | 68.18660382 | 20.96287878 |
| 12561 | 73.12536531 | 102.2762346 | 52.56512622 | 159.1250387 | 45.41988674 |
| 15663 | 73.11718241 | 250.3325832 | 89.69920875 | 172.228523 | 33.35386467 |
| 7196 | 73.11150448 | 293.5589143 | 170.4462218 | 155.3520027 | 40.04001176 |
| 11164 | 73.11 | 349.24 | 142.19 | 507.35 | 120.35 |
| 3941 | 73.0941367 | 308.735741 | 77.67557449 | 230.069061 | 48.84198107 |
| 22554 | 73.07392996 | 415.0183429 | 141.5557663 | 556.6455466 | 106.8579765 |
| 13343 | 73.06808504 | 157.2067443 | 46.99161278 | 208.9077432 | 43.13164312 |
| 12332 | 73.04537332 | 411.1613085 | 193.5891409 | 580.8890108 | 134.5335609 |
| 7128 | 73.02817254 | 239.1426458 | 69.19063177 | 314.3465504 | 55.04435889 |
| 794 | 73.02800554 | 149.9988713 | 59.20316287 | 220.6178599 | 54.39878992 |
| 21632 | 73.02550058 | 81.27734286 | 68.17005823 | 21.99813036 | 38.2953058 |
| 19031 | 73.01998965 | 115.0485875 | 95.43994528 | 48.9126224 | 21.82538707 |
| 20828 | 73.00846679 | 502.2473423 | 271.1834974 | 284.5311051 | 92.4929031 |
| 22101 | 73.0081328 | 95.0688379 | 89.97980952 | 187.4798581 | 72.68823613 |
| 17477 | 72.96554834 | 152.2283562 | 61.41721729 | 103.9500869 | 20.61868868 |
| 21653 | 72.94266963 | 312.5412982 | 114.3057351 | 222.6382613 | 40.97720451 |
| 4789 | 72.94250263 | 59.69316361 | 25.79130654 | 36.25017547 | 16.9263929 |
| 24568 | 72.92747282 | 100.9854279 | 45.77643689 | 166.3747268 | 65.68252702 |
| 23202 | 72.92496785 | 121.8218073 | 37.4223132 | 164.3583568 | 35.739692 |
| 25453 | 72.91945692 | 169.5385768 | 55.06858446 | 219.2370093 | 42.22252817 |
| 13634 | 72.91695195 | 1089.909525 | 505.6176099 | 708.2744112 | 127.1635939 |
| 9673 | 72.89039929 | 41.62752139 | 23.9624369 | 67.9158819 | 25.83115298 |
| 22626 | 72.88555635 | 183.9210533 | 157.8210185 | 66.65379062 | 23.30181235 |
| 13349 | 72.86251065 | 172.7498279 | 55.72890499 | 123.9271713 | 27.77975703 |
| 8829 | 72.82527012 | 370.3425049 | 120.1345988 | 265.086816 | 63.71656822 |
| 15051 | 72.81 | 870.06 | 414.32 | 531.84 | 140.63 |
| 17771 | 72.79387452 | 987.2353328 | 409.5437444 | 656.0935041 | 156.8142212 |
| 14484 | 72.73325429 | 334.2823847 | 89.84388565 | 437.9713071 | 96.59005867 |
| 14185 | 72.70803761 | 286.6012774 | 150.7172826 | 168.4541254 | 57.75119127 |
| 18529 | 72.64224044 | 279.8103006 | 134.5542568 | 172.941485 | 39.31168364 |
| 23946 | 72.63038359 | 163.7394849 | 60.22818988 | 222.3458685 | 52.09881666 |
| 17159 | 72.53636379 | 1017.46374 | 356.3241579 | 743.4742457 | 134.8926558 |
| 21443 | 72.53068586 | 141.5087876 | 81.92489411 | 79.90222801 | 27.46553869 |
| 5855 | 72.51882901 | 48.54935197 | 31.99643857 | 74.57794713 | 25.25898096 |
| 13618 | 72.50196223 | 131.446852 | 42.43820367 | 95.49719596 | 21.0584271 |
| 12716 | 72.48993838 | 131.6741256 | 35.67214558 | 169.4946023 | 38.20699186 |
| 17550 | 72.45587081 | 986.160813 | 374.7937126 | 1326.286035 | 307.3041885 |
| 5474 | 72.45002588 | 535.2923376 | 201.9471092 | 756.7417489 | 194.0568571 |
| 5711 | 72.44701992 | 273.463279 | 99.04844473 | 392.0601198 | 106.5505539 |
| 2912 | 72.39291261 | 1931.737359 | 615.063966 | 2564.077466 | 522.3042249 |
| 9017 | 72.38122276 | 76.73353212 | 33.16762831 | 116.2884854 | 36.84832913 |
| 6059 | 72.36118301 | 154.2019464 | 39.08353915 | 195.0358442 | 41.70427967 |
| 1501 | 72.33913929 | 109.7890806 | 98.72204686 | 39.88217718 | 21.66435281 |
| 8188 | 72.32127052 | 307.4560841 | 113.435179 | 412.5977746 | 118.9863598 |
| 23195 | 72.30156477 | 232.9214407 | 106.7475078 | 322.6563231 | 70.56526638 |
| 7285 | 72.30 | 183.98 | 45.26 | 227.37 | 39.94 |
| 21458 | 72.29321488 | 333.719882 | 163.5279209 | 208.7840327 | 68.3434868 |
| 23957 | 72.26165228 | 111.136839 | 62.08098358 | 56.84170567 | 26.48020347 |
| 7784 | 72.19284915 | 562.8262904 | 162.4051288 | 718.7859352 | 107.9257063 |
| 6416 | 72.17 | 221.69 | 181.98 | 105.92 | 33.73 |
| 19679 | 72.16997044 | 554.0548312 | 249.8434896 | 799.208115 | 160.2227266 |
| 3916 | 72.16429251 | 521.2494374 | 191.635131 | 693.1755282 | 117.6873361 |
| 24388 | 72.16 | 256.14 | 119.20 | 163.06 | 35.67 |
| 4235 | 72.16145355 | 511.7131741 | 134.644402 | 389.7019942 | 70.87532979 |
| 17196 | 72.15544163 | 105.3599138 | 26.38579321 | 132.0773497 | 22.43465669 |
| 21462 | 72.1414138 | 306.539429 | 72.05119023 | 242.5457166 | 45.94897687 |
| 1510 | 72.14124681 | 644.6907685 | 250.3002812 | 882.9239564 | 187.473853 |
| 2348 | 72.13807385 | 327.6327036 | 189.49475 | 501.69599 | 190.9571321 |
| 17524 | 72.1098512 | 874.8824969 | 306.1319417 | 1156.444814 | 234.2742269 |
| 10464 | 72.10116732 | 93.88361398 | 31.76228943 | 126.6499333 | 27.52656727 |
| 7127 | 72.10100032 | 189.6279016 | 95.06964563 | 284.503156 | 81.78200409 |
| 21882 | 72.03520315 | 626.539768 | 164.7108169 | 793.6760678 | 153.0810134 |
| 17339 | 71.9294935 | 1792.985725 | 669.1390035 | 2389.414771 | 537.6641779 |
| 10015 | 71.92414956 | 325.4652102 | 153.5765557 | 212.0585252 | 42.32926652 |
| 20801 | 71.85 | 199.99 | 73.50 | 140.35 | 32.13 |
| 7888 | 71.84 | 318.41 | 78.58 | 247.97 | 40.89 |
| 17256 | 71.80658306 | 324.8525266 | 154.4265957 | 449.9846896 | 98.32616047 |
| 22930 | 71.79455921 | 198.0132602 | 107.4265272 | 333.5952638 | 130.8979194 |
| 3049 | 71.77535445 | 291.7940055 | 154.6257178 | 166.9363278 | 53.28371204 |
| 17734 | 71.76 | 206.37 | 202.42 | 95.30 | 30.54 |
| 20082 | 71.732436 | 92.49771136 | 42.32852743 | 59.76248687 | 14.71505541 |
| 4327 | 71.732436 | 124.904039 | 64.17386639 | 73.50786335 | 19.33196751 |
| 18271 | 71.70638433 | 622.1754394 | 201.2914108 | 765.3878724 | 134.2823131 |
| 1141 | 71.70371236 | 310.4547546 | 97.82116884 | 226.1620877 | 48.17094826 |
| 3713 | 71.69770044 | 870.0920545 | 222.4658473 | 1118.081047 | 183.6493294 |
| 7537 | 71.69469448 | 182.2977249 | 58.80458232 | 237.2841089 | 52.87814656 |
| 22596 | 71.67799469 | 80.40368647 | 26.06975968 | 58.43304066 | 14.91196991 |
| 4360 | 71.67214976 | 269.7964439 | 91.90423108 | 345.4475402 | 58.55070595 |
| 1081 | 71.66630484 | 413.8169497 | 133.9204914 | 554.0918883 | 106.6621528 |
| 2702 | 71.60084167 | 366.9630027 | 146.7576451 | 258.704476 | 48.99924667 |
| 354 | 71.60 | 342.25 | 192.43 | 190.95 | 42.15 |
| 5199 | 71.58898482 | 426.6781047 | 194.5965508 | 588.2380815 | 150.0565394 |
| 25747 | 71.58380789 | 77.46426615 | 61.56836353 | 34.93635566 | 16.33129208 |
| 13633 | 71.57228503 | 490.859187 | 292.9104741 | 281.7702118 | 78.21967829 |
| 20003 | 71.55424926 | 27.26624376 | 18.63775544 | 51.09157179 | 22.27713208 |
| 25198 | 71.54923932 | 41.83738407 | 21.30414887 | 24.46897318 | 10.2887544 |
| 5481 | 71.53187155 | 91.61281005 | 65.17050178 | 28.14592964 | 47.24102799 |
| 13332 | 71.4802692 | 348.318777 | 115.9413156 | 459.9662366 | 88.50144973 |
| 6321 | 71.42616189 | 574.0456997 | 185.5861715 | 430.1525559 | 101.4344889 |
| 4473 | 71.42599489 | 131.0465748 | 57.9009332 | 181.2716922 | 41.7246204 |
| 405 | 71.40862711 | 163.6570742 | 53.25338415 | 214.369048 | 52.02616005 |
| 23872 | 71.40645614 | 128.3896922 | 182.3235051 | 24.91985805 | 23.80373187 |
| 18302 | 71.39142633 | 60.93274749 | 77.95488674 | 124.3849227 | 68.01025453 |
| 15042 | 71.38341043 | 113.7848867 | 77.4706215 | 57.27629582 | 27.29420376 |
| 6382 | 71.3775655 | 168.3590284 | 54.66912751 | 117.2240917 | 30.5916709 |
| 1409 | 71.37422555 | 356.3482649 | 100.2570505 | 457.0897876 | 90.41166982 |
| 10130 | 71.36303669 | 174.0633085 | 65.67212316 | 230.5180359 | 47.39273862 |
| 21125 | 71.34867487 | 116.793056 | 56.17889018 | 159.8219905 | 40.70025457 |
| 20481 | 71.33147409 | 164.2250117 | 44.84688901 | 208.9019923 | 36.59950412 |
| 16859 | 71.33 | 166.91 | 73.19 | 112.81 | 33.48 |
| 16147 | 71.31427331 | 133.2713322 | 41.16539683 | 174.3821982 | 34.98987877 |
| 9699 | 71.31143434 | 40.800459 | 21.59336067 | 56.86011612 | 17.18231905 |
| 10789 | 71.31 | 226.28 | 98.93 | 319.54 | 77.45 |
| 6796 | 71.30592341 | 237.5148442 | 61.53051141 | 182.3973545 | 44.66569526 |
| 410 | 71.28855564 | 870.9734112 | 244.8206654 | 1083.444257 | 197.6148927 |
| 18564 | 71.21123562 | 177.1818749 | 50.68623343 | 222.8971499 | 43.2196108 |
| 12798 | 71.20856365 | 127.9179407 | 41.67147705 | 161.9583087 | 30.85329433 |
| 15004 | 71.20 | 315.68 | 341.04 | 126.60 | 39.41 |
| 21318 | 71.1972078 | 71.28904452 | 31.21133472 | 42.85410721 | 22.48605551 |
| 6039 | 71.14877841 | 398.0605484 | 140.8521054 | 292.5555827 | 43.87001826 |
| 18792 | 71.14527146 | 105.5641832 | 35.06965105 | 140.7557808 | 34.59681697 |
| 15642 | 71.13725556 | 552.6908782 | 175.7519777 | 408.6795547 | 83.65679612 |
| 12812 | 71.1339156 | 71.16451798 | 36.21027548 | 103.4513266 | 31.81785501 |
| 14996 | 71.11671482 | 339.3300514 | 143.9979671 | 507.2107686 | 153.7067385 |
| 498 | 71.08865917 | 683.2994891 | 214.007319 | 507.7755444 | 92.92888055 |
| 10087 | 71.08548621 | 1154.31678 | 346.7061181 | 1463.958309 | 251.6377099 |
| 12331 | 71.08264725 | 472.782575 | 167.0649748 | 617.169582 | 120.6867211 |
| 8477 | 71.07145839 | 659.0457127 | 204.6617645 | 463.617062 | 103.0264273 |
| 13954 | 71.06 | 948.19 | 350.16 | 1298.60 | 301.79 |
| 17907 | 71.03 | 1012.87 | 306.06 | 1257.12 | 200.00 |
| 22656 | 71.02269501 | 175.5960199 | 69.44916713 | 113.0049246 | 41.69051937 |
| 2370 | 71.01401112 | 915.6984826 | 221.2013897 | 1099.411882 | 156.5781346 |
| 10016 | 70.99714434 | 301.5274805 | 145.9792275 | 190.3539826 | 43.03506275 |
| 18269 | 70.99380438 | 637.3872989 | 170.1980876 | 810.1018171 | 163.937515 |
| 22928 | 70.99347038 | 162.5453963 | 62.7086771 | 235.9206416 | 78.67137638 |
| 24321 | 70.99 | 515.86 | 195.77 | 686.86 | 131.04 |
| 23512 | 70.98812645 | 828.9897486 | 249.3344159 | 1077.375262 | 203.7223722 |
| 7903 | 70.98528749 | 350.5453484 | 194.23864 | 521.8749865 | 172.1493708 |
| 6336 | 70.98 | 336.24 | 89.69 | 418.43 | 89.90 |
| 11967 | 70.95 | 1213.17 | 570.43 | 1709.91 | 412.19 |
| 11708 | 70.94270303 | 386.8003922 | 118.0261743 | 291.4028205 | 61.61537016 |
| 20849 | 70.93418614 | 372.7188256 | 145.9724592 | 262.8478403 | 56.35553021 |
| 20086 | 70.92550225 | 176.2588503 | 100.9839636 | 94.57079689 | 56.93242072 |
| 16775 | 70.91949032 | 829.8082119 | 416.7547122 | 1259.056219 | 355.5379472 |
| 1698 | 70.92 | 172.23 | 191.95 | 50.55 | 32.52 |
| 14095 | 70.92 | 281.28 | 79.38 | 369.45 | 63.47 |
| 6765 | 70.91665136 | 585.0367365 | 187.8003804 | 763.3969282 | 148.4962585 |
| 1581 | 70.89978457 | 84.40443826 | 27.89534583 | 62.31427166 | 13.19097482 |
| 22820 | 70.89410664 | 288.1190696 | 111.4524723 | 200.7418441 | 47.57591793 |
| 5990 | 70.85953808 | 366.3519689 | 68.11041757 | 308.364785 | 51.8240886 |
| 22747 | 70.83933134 | 74.14874761 | 30.31242787 | 98.18564151 | 26.53935912 |
| 21885 | 70.82196356 | 142.8105941 | 40.75769988 | 189.0843655 | 42.6957976 |
| 3079 | 70.79674688 | 63.04721313 | 43.40895794 | 28.63200188 | 23.267219 |
| 5923 | 70.79674688 | 483.7836606 | 173.4808852 | 620.2452282 | 121.7386925 |
| 14867 | 70.80 | 101.12 | 62.31 | 165.12 | 71.18 |
| 19235 | 70.79340692 | 763.4928387 | 289.1267594 | 1038.844606 | 281.3859308 |
| 7690 | 70.79090196 | 257.5909963 | 97.89101874 | 171.849413 | 74.75028528 |
| 13111 | 70.79056796 | 174.860056 | 60.32230683 | 227.4712045 | 55.77617287 |
| 1159 | 70.77654014 | 806.917713 | 265.6053539 | 1032.085281 | 192.0252292 |
| 9781 | 70.77069521 | 92.58980656 | 36.11235607 | 127.638116 | 32.75832457 |
| 17393 | 70.75399542 | 204.124932 | 109.1717801 | 121.382968 | 33.63659555 |
| 5329 | 70.7476495 | 33.30547604 | 19.24667641 | 51.50320834 | 17.81606651 |
| 3878 | 70.74197158 | 403.2347516 | 111.4733788 | 513.4119933 | 109.3514016 |
| 9468 | 70.73913261 | 42.8674446 | 35.25182606 | 68.53373052 | 31.39077316 |
| 353 | 70.73 | 272.05 | 161.59 | 149.39 | 40.00 |
| 21305 | 70.70456405 | 335.5403178 | 107.0804394 | 461.1318069 | 122.4271664 |
| 4462 | 70.66481856 | 730.6257892 | 304.6597778 | 995.431334 | 245.7726301 |
| 19768 | 70.64511281 | 963.1099008 | 248.7687166 | 752.6982114 | 130.8907506 |
| 17807 | 70.61939513 | 1025.458861 | 284.1245566 | 795.8935405 | 128.7916384 |
| 7279 | 70.58 | 177.33 | 131.04 | 191.37 | 58.86 |
| 23961 | 70.54775304 | 666.1151134 | 193.4003866 | 805.831464 | 112.8350419 |
| 16520 | 70.54240911 | 132.8613946 | 84.96659613 | 72.6601183 | 44.25249046 |
| 17499 | 70.54190812 | 50.17968339 | 30.54421913 | 22.00448366 | 22.12875837 |
| 14790 | 70.5272123 | 109.4097569 | 74.61549723 | 185.3000757 | 76.25523345 |
| 6916 | 70.52470734 | 317.8219585 | 111.0268929 | 408.6141486 | 85.19381033 |
| 11974 | 70.51318448 | 172.0478497 | 92.75009213 | 244.794786 | 74.37487748 |
| 11455 | 70.50 | 162.65 | 95.78 | 94.80 | 26.70 |
| 7543 | 70.49564971 | 178.547379 | 78.57317657 | 269.0421232 | 91.30723273 |
| 12467 | 70.48 | 91.52 | 43.59 | 57.64 | 16.70 |
| 17684 | 70.48178888 | 183.8798358 | 61.31828646 | 243.7559457 | 49.96031474 |
| 17438 | 70.47026603 | 26.7382404 | 45.54097206 | 57.63231313 | 34.17013966 |
| 13176 | 70.47009903 | 46.41799018 | 20.28410744 | 65.32124446 | 19.51464161 |
| 275 | 70.45339924 | 453.7148571 | 254.4387856 | 576.7986868 | 132.1872501 |
| 14020 | 70.44 | 212.80 | 56.70 | 266.01 | 46.38 |
| 3430 | 70.43636546 | 621.1802909 | 275.8648069 | 418.2233015 | 103.8022286 |
| 6518 | 70.43619846 | 144.0774161 | 37.08502734 | 112.7147406 | 24.8752467 |
| 18303 | 70.44 | 281.64 | 239.24 | 513.56 | 243.07 |
| 5867 | 70.42 | 195.07 | 60.67 | 148.14 | 26.48 |
| 6927 | 70.39010705 | 264.7935922 | 87.90568922 | 348.9047929 | 78.75748433 |
| 25070 | 70.38994005 | 353.201825 | 90.9057057 | 442.8817225 | 89.01735385 |
| 12587 | 70.38426212 | 172.8425554 | 49.41038279 | 225.0384086 | 48.36937066 |
| 20865 | 70.38142316 | 235.5178941 | 58.52316469 | 291.3112086 | 53.15153075 |
| 24236 | 70.36472337 | 98.10809021 | 31.96761671 | 73.04437691 | 15.28584669 |
| 16684 | 70.35620648 | 709.3649229 | 236.7375456 | 508.8945621 | 112.4304221 |
| 9452 | 70.35069555 | 245.7617883 | 292.6221619 | 114.9709603 | 32.36274589 |
| 4199 | 70.33583273 | 447.7856929 | 168.99085 | 592.8718764 | 144.2735394 |
| 11454 | 70.33 | 328.59 | 156.12 | 216.73 | 53.33 |
| 21796 | 70.32764984 | 888.4017259 | 360.4669486 | 657.7468182 | 113.1481704 |
| 19998 | 70.32 | 192.15 | 78.72 | 267.63 | 67.09 |
| 1399 | 70.32 | 291.48 | 158.06 | 180.41 | 40.15 |
| 1463 | 70.30477113 | 1010.906056 | 562.2315641 | 597.6285113 | 147.5163605 |
| 8599 | 70.30143117 | 289.7102636 | 121.7540684 | 408.8106404 | 103.3414894 |
| 19067 | 70.28423039 | 126.0808384 | 48.73348414 | 169.7256121 | 43.06255744 |
| 24235 | 70.27621449 | 713.0504022 | 392.6566221 | 431.1344096 | 115.3208855 |
| 5295 | 70.27320853 | 300.3673 | 122.6395005 | 200.3777563 | 56.99205768 |
| 17157 | 70.27036957 | 66.74546809 | 35.9806367 | 40.40264137 | 14.12606346 |
| 24762 | 70.26986857 | 718.3765021 | 276.1477473 | 983.3177792 | 297.9605419 |
| 22599 | 70.25600775 | 66.34406284 | 31.76809853 | 41.24936186 | 18.37197756 |
| 20829 | 70.25032982 | 1242.416049 | 483.5054646 | 851.3168509 | 199.4060102 |
| 1885 | 70.2439839 | 271.0949115 | 74.76518095 | 352.5464662 | 81.05516141 |
| 7700 | 70.23329604 | 122.8595378 | 82.18167819 | 72.07967282 | 16.69398572 |
| 6711 | 70.22995608 | 67.6521358 | 24.44261842 | 47.10757143 | 22.07497066 |
| 22328 | 70.2127553 | 317.0894814 | 111.2229989 | 404.0684734 | 93.91538499 |
| 13392 | 70.19872748 | 239.3228528 | 71.29262811 | 181.6550147 | 37.08840136 |
| 1798 | 70.18970959 | 258.6239005 | 95.82095389 | 346.7327101 | 96.88717299 |
| 9114 | 70.1811927 | 693.860219 | 204.9305374 | 879.8300873 | 192.7878948 |
| 4933 | 70.17618276 | 388.4071663 | 424.0827485 | 93.57485666 | 104.1871857 |
| 25777 | 70.16465991 | 731.1269475 | 475.1048291 | 385.6387638 | 125.2433796 |
| 5565 | 70.16131995 | 296.7569975 | 131.2082754 | 413.3646434 | 102.2345034 |
| 17420 | 70.14679114 | 61.25008761 | 32.17535043 | 94.12664744 | 32.93397715 |
| 7872 | 70.14111321 | 85.7718341 | 33.42042032 | 118.8883017 | 31.24593067 |
| 19085 | 70.13593627 | 94.39700898 | 39.41352311 | 61.50537192 | 14.57063483 |
| 25567 | 70.13309731 | 673.5066146 | 317.8219004 | 438.9509529 | 133.112788 |
| 21024 | 70.12675139 | 455.6164345 | 93.77946063 | 553.7599162 | 96.12838839 |
| 21105 | 70.12124046 | 249.5365471 | 66.25713529 | 312.1801594 | 54.80674377 |
| 4661 | 70.11873549 | 388.812595 | 126.7826634 | 288.3700687 | 54.8123755 |
| 6635 | 70.1182345 | 193.7443247 | 78.12105317 | 263.6595233 | 72.24389761 |
| 16708 | 70.11255657 | 207.7538048 | 51.36507757 | 256.4151971 | 46.44776023 |
| 2250 | 70.09836175 | 1118.061362 | 305.4698352 | 1406.389129 | 242.1009635 |
| 9067 | 70.09568978 | 803.7783177 | 204.3856207 | 624.9499096 | 138.7609652 |
| 15146 | 70.08166196 | 203.6218298 | 143.5123436 | 112.756109 | 37.18053855 |
| 1478 | 70.02972562 | 270.2709361 | 105.7728946 | 371.6625226 | 79.43883267 |
| 406 | 69.97528431 | 313.9225633 | 96.71895909 | 398.3675185 | 80.50659235 |
| 24234 | 69.97010738 | 302.5101331 | 219.1370069 | 168.0694456 | 50.6457125 |
| 20493 | 69.92969389 | 391.4896341 | 143.6531328 | 510.9476405 | 105.1896405 |
| 4178 | 69.84652895 | 527.8687514 | 134.5334345 | 640.2250757 | 119.9461864 |
| 45 | 69.83517309 | 120.9649065 | 88.26258123 | 186.4908089 | 67.03141815 |
| 1454 | 69.83 | 155.56 | 72.94 | 98.16 | 40.12 |
| 25379 | 69.81830631 | 91.36952894 | 33.44083062 | 67.37191422 | 14.99700037 |
| 11692 | 69.79192064 | 1135.765908 | 414.4834877 | 1546.524472 | 408.082855 |
| 19086 | 69.76970992 | 146.2982894 | 67.62426161 | 91.90156365 | 25.40768257 |
| 17447 | 69.71510162 | 757.1092798 | 315.0026535 | 1014.03074 | 248.7855862 |
| 5497 | 69.70658473 | 618.3891525 | 241.8729868 | 823.9281494 | 151.3202488 |
| 23194 | 69.65498238 | 62.69622659 | 24.81693426 | 41.16752769 | 22.21797666 |
| 19 | 69.62943171 | 426.8830038 | 118.6334492 | 336.4255709 | 62.63947723 |
| 11849 | 69.60087507 | 948.1751709 | 279.8387309 | 737.4883024 | 123.97332 |
| 3465 | 69.59753511 | 210.0319804 | 70.48668178 | 271.4668918 | 62.44793967 |
| 1993 | 69.59519714 | 43.10184781 | 30.86190782 | 20.51127087 | 10.4903739 |
| 22662 | 69.52 | 107.46 | 29.01 | 136.36 | 29.33 |
| 18452 | 69.51754313 | 321.3878641 | 118.9110657 | 424.391574 | 94.62603068 |
| 17324 | 69.50618727 | 312.5926635 | 107.1245732 | 383.7679626 | 72.29693664 |
| 744 | 69.50602027 | 282.8384135 | 77.81116212 | 353.1333504 | 70.01135148 |
| 19943 | 69.50318131 | 284.2980177 | 126.3869505 | 383.928817 | 104.8721705 |
| 13930 | 69.50084334 | 214.9089308 | 153.331537 | 106.240643 | 42.57434118 |
| 22539 | 69.47729664 | 36.74107571 | 37.02283507 | 67.50720611 | 37.70265225 |
| 16476 | 69.46894674 | 661.9654825 | 207.0570396 | 807.3400046 | 148.2467882 |
| 20753 | 69.46059685 | 146.9881391 | 38.9952964 | 114.6096864 | 22.23178425 |
| 7197 | 69.38344383 | 282.3300938 | 150.9619233 | 170.1503853 | 54.40399664 |
| 556 | 69.38260884 | 55.50132335 | 17.48087181 | 75.27571431 | 24.04221562 |
| 4198 | 69.32015163 | 622.3402992 | 199.7713179 | 799.2132627 | 160.4720245 |
| 3244 | 69.30595681 | 95.06917614 | 31.63411195 | 119.81669 | 24.27866027 |
| 23063 | 69.28291111 | 328.2658823 | 83.6090783 | 404.561604 | 68.57292929 |
| 24264 | 69.24567058 | 26.11217385 | 22.43333372 | 43.28478863 | 18.55868879 |
| 2153 | 69.23765468 | 324.5935101 | 302.8245339 | 143.8406632 | 45.13859767 |
| 5496 | 69.23448172 | 508.9524014 | 208.9382494 | 686.2856793 | 135.7152932 |
| 4529 | 69.23130876 | 67.85449471 | 27.85368995 | 90.38311629 | 24.2100319 |
| 22352 | 69.21 | 240.63 | 198.59 | 129.55 | 52.38 |
| 22537 | 69.21410798 | 218.5350397 | 146.7680792 | 320.5449701 | 127.5696536 |
| 1430 | 69.19139627 | 91.40795716 | 91.79231802 | 157.3163186 | 82.8694698 |
| 12276 | 69.14563885 | 146.8290814 | 72.19394428 | 197.3180931 | 55.12187566 |
| 408 | 69.14246589 | 130.3805348 | 67.27728587 | 191.4580768 | 65.83246181 |
| 14184 | 69.13444999 | 138.8526752 | 74.21831436 | 90.86184089 | 35.50680695 |
| 5837 | 69.05412401 | 707.5200515 | 227.3360419 | 877.5856354 | 176.1594803 |
| 19152 | 69.04293515 | 209.4889223 | 82.42495052 | 150.4710597 | 37.99742228 |
| 24648 | 69.01371053 | 23.19157675 | 11.6951982 | 35.71395341 | 12.84500013 |
| 291 | 68.98264892 | 188.6257241 | 56.90927233 | 232.0130777 | 38.28705897 |
| 409 | 68.87944423 | 803.4588849 | 193.8990371 | 969.1247908 | 164.618582 |
| 20816 | 68.79995324 | 595.8358273 | 369.9222458 | 370.4656146 | 83.63140389 |
| 20449 | 68.79711428 | 100.4900488 | 132.9211559 | 33.15487613 | 21.87043029 |
| 23445 | 68.77089561 | 516.3551752 | 187.237735 | 686.2066418 | 139.3621424 |
| 17494 | 68.73933301 | 185.7094369 | 45.48548725 | 223.0254103 | 37.74558387 |
| 24438 | 68.73064912 | 114.0695333 | 42.85206114 | 148.9829095 | 36.09924566 |
| 20817 | 68.72 | 1865.76 | 1135.85 | 1150.17 | 447.11 |
| 25705 | 68.6853927 | 571.3566592 | 176.4043974 | 451.9728048 | 76.32131489 |
| 20414 | 68.68171874 | 85.25065547 | 29.1778343 | 114.5185098 | 31.66919651 |
| 1712 | 68.61658957 | 209.6897328 | 68.60632447 | 160.3879218 | 35.87902845 |
| 13846 | 68.60523371 | 999.5515778 | 297.3365691 | 776.9704191 | 122.9631955 |
| 18301 | 68.5671582 | 62.34075661 | 33.80497723 | 100.8072372 | 42.70710806 |
| 18070 | 68.56181426 | 29.36749701 | 21.99959698 | 48.21170897 | 19.38594154 |
| 15191 | 68.53075266 | 3290.474496 | 1751.223512 | 2180.500127 | 805.9269968 |
| 17473 | 68.52507473 | 517.999113 | 161.8598317 | 427.536449 | 71.9934835 |
| 21053 | 68.51839482 | 66.73426419 | 31.71787962 | 102.8261937 | 48.28425026 |
| 22196 | 68.4878342 | 63.01977878 | 25.81558037 | 44.76996899 | 14.72142187 |
| 14309 | 68.45844258 | 112.8770993 | 71.13031295 | 191.135603 | 83.9940291 |
| 18741 | 68.45560361 | 22.45924623 | 9.465804661 | 31.42492016 | 12.24548318 |
| 18011 | 68.45359964 | 55.32740853 | 47.59398519 | 21.92483457 | 18.1624083 |
| 17269 | 68.45025968 | 556.6625611 | 223.6922613 | 748.9429353 | 194.3156688 |
| 4589 | 68.42738097 | 1175.409579 | 346.4630047 | 1472.99309 | 302.8077957 |
| 19469 | 68.41903108 | 301.3400452 | 113.0311594 | 382.8696906 | 90.3486576 |
| 21145 | 68.41853008 | 166.4457933 | 59.78209152 | 210.9753547 | 64.34239489 |
| 20780 | 68.39882433 | 441.7507389 | 191.5473306 | 567.4880409 | 192.6094197 |
| 1214 | 68.38179055 | 128.3025451 | 68.13347663 | 158.5489338 | 45.71421849 |
| 755 | 68.37845059 | 34.87466691 | 29.79373274 | 64.08006595 | 34.39363901 |
| 16006 | 68.36492377 | 71.88449213 | 53.75743963 | 35.40098018 | 17.41759455 |
| 14138 | 68.33603313 | 60.32285477 | 26.70754215 | 75.29445347 | 17.84433561 |
| 15851 | 68.32785024 | 317.1865116 | 273.6873358 | 160.1095765 | 75.57569123 |
| 21061 | 68.32 | 67.94 | 30.57 | 46.71 | 18.28 |
| 23783 | 68.29294768 | 395.5367742 | 88.22790322 | 467.9801054 | 73.38152003 |
| 15185 | 68.29 | 234.32 | 137.00 | 142.70 | 43.80 |
| 8210 | 68.29010872 | 744.1044707 | 212.872552 | 921.2790683 | 180.1467716 |
| 17104 | 68.25904711 | 595.24177 | 185.1588591 | 458.2361879 | 73.95955511 |
| 17999 | 68.24986223 | 901.7089805 | 380.2928546 | 1228.53441 | 405.2247232 |
| 18190 | 68.24719026 | 182.2505082 | 61.26301134 | 229.5060244 | 48.58869963 |
| 22602 | 68.22998948 | 241.7042791 | 126.4784222 | 348.9579426 | 102.9813519 |
| 9082 | 68.21328969 | 53.72565077 | 28.46924103 | 38.09238567 | 10.55678356 |
| 16012 | 68.18473305 | 93.81377915 | 55.30071228 | 58.55860103 | 14.99778497 |
| 14989 | 68.13580268 | 631.4437331 | 150.7953416 | 512.7063086 | 97.02311395 |
| 3987 | 68.09589018 | 229.0363328 | 70.16578864 | 180.4561841 | 37.27169908 |
| 23837 | 68.09 | 121.06 | 52.18 | 85.23 | 27.33 |
| 8317 | 68.06 | 1149.89 | 388.88 | 1428.19 | 346.12 |
| 15302 | 68.04929777 | 20.3076197 | 8.692629328 | 27.81934381 | 10.23548138 |
| 18001 | 67.99802943 | 322.9223513 | 154.3838937 | 447.9263548 | 164.826114 |
| 16649 | 67.97865767 | 147.8668375 | 84.05591013 | 97.60434066 | 32.64861331 |
| 22538 | 67.96963979 | 268.3883299 | 96.52292148 | 356.5133042 | 83.51530908 |
| 24770 | 67.9607889 | 167.8615447 | 99.9131833 | 258.4592806 | 101.0571212 |
| 23321 | 67.95544497 | 543.4812122 | 158.9463892 | 669.1827565 | 121.2762102 |
| 5297 | 67.89 | 282.49 | 103.56 | 368.51 | 102.45 |
| 1850 | 67.86 | 62.21 | 93.09 | 24.45 | 96.13 |
| 17394 | 67.81833971 | 452.0683779 | 169.8687842 | 324.7418707 | 84.03380507 |
| 13974 | 67.81282878 | 486.1960174 | 343.7799181 | 277.9765889 | 70.48364801 |
| 16204 | 67.80698385 | 1040.091921 | 276.0342753 | 829.9462579 | 117.9912852 |
| 17541 | 67.78 | 1031.81 | 707.66 | 671.17 | 173.64 |
| 12031 | 67.78126618 | 168.7845658 | 59.30153211 | 130.3205806 | 25.6922294 |
| 23047 | 67.77224829 | 56.55080604 | 20.02279821 | 70.52393306 | 16.27808767 |
| 20818 | 67.76991032 | 1218.483928 | 808.490787 | 683.4443517 | 312.9826702 |
| 25718 | 67.7640654 | 500.4365747 | 141.4001347 | 404.9703762 | 60.84572176 |
| 21657 | 67.74970358 | 540.3602663 | 166.2162285 | 426.2383025 | 80.58986325 |
| 6055 | 67.74953658 | 852.9112049 | 291.949659 | 1087.752099 | 221.2048224 |
| 825 | 67.72899584 | 33.81589022 | 15.82849621 | 49.46192808 | 17.8340854 |
| 5838 | 67.71229605 | 538.5143205 | 169.6443258 | 674.9497738 | 122.9308275 |
| 17175 | 67.70394616 | 829.2548848 | 224.8030928 | 660.0175001 | 115.4189706 |
| 16726 | 67.70377916 | 870.2897617 | 304.5065136 | 1099.441777 | 185.69785 |
| 1546 | 67.7007732 | 196.1735398 | 73.15499669 | 253.3459783 | 55.85865002 |
| 17744 | 67.69208931 | 46.14572439 | 26.53139174 | 64.03176308 | 23.43213839 |
| 18361 | 67.6610277 | 621.8671848 | 267.2018135 | 448.8817377 | 121.6090859 |
| 4451 | 67.64933785 | 238.855669 | 88.60178484 | 300.3323635 | 63.64516262 |
| 18396 | 67.6296321 | 90.02171091 | 44.79575334 | 61.70407738 | 16.44084885 |
| 2554 | 67.62946511 | 57.15798904 | 20.53670721 | 42.64349823 | 12.30989757 |
| 15190 | 67.61810925 | 3108.275869 | 1723.862361 | 1862.426944 | 876.4994172 |
| 18606 | 67.59239158 | 847.3774987 | 254.5206766 | 660.8042777 | 115.149482 |
| 15295 | 67.57 | 171.07 | 70.81 | 126.38 | 31.75 |
| 770 | 67.50905963 | 701.6100581 | 282.7824207 | 933.1963529 | 236.566298 |

TABLE 5N

| GLGC Identifier | PLS_Score |
|---|---|
| 25024 | −0.03408754 |
| 21011 | 0.005158207 |
| 8317 | 0.00286913 |
| 15861 | 0.01758436 |
| 15862 | 0.01155703 |
| 15028 | −0.04786289 |
| 15154 | 0.01881327 |
| 15296 | 0.00676223 |
| 16518 | 0.02598835 |
| 17764 | −0.02342505 |
| 20711 | −0.01317801 |
| 23778 | 0.002304377 |
| 20795 | 0.00146821 |
| 20817 | 0.0314257 |
| 20833 | −0.004259089 |
| 20919 | −0.0198629 |
| 20920 | −0.007400703 |
| 21012 | −0.003223273 |
| 22351 | −0.008960611 |
| 15848 | −0.01718595 |
| 15849 | −0.04416249 |
| 15850 | −0.01030871 |
| 23837 | −0.0118801 |
| 4312 | 0.003691487 |
| 20864 | 0.007678122 |
| 10241 | 0.01076413 |
| 11434 | 0.06352768 |
| 20801 | −0.01583562 |
| 15126 | −0.002417698 |
| 15297 | −0.006103148 |
| 15124 | 0.01198701 |
| 16080 | 0.02010419 |
| 21013 | −0.001557214 |
| 13479 | −0.03089779 |
| 13480 | 0.003500852 |
| 6780 | −0.003917337 |
| 18989 | 0.000967733 |
| 1475 | 0.01773045 |
| 1321 | −0.03506051 |
| 11955 | 0.02492273 |
| 1920 | 0.01128843 |
| 15189 | −0.005276864 |
| 17765 | −0.02927309 |
| 4010 | 0.0263635 |
| 23225 | 0.01153367 |
| 11956 | −0.009530467 |
| 11755 | −0.03076732 |
| 20713 | 0.02154138 |
| 25057 | 0.01553224 |
| 17378 | −0.008536189 |
| 14956 | 0.00635737 |
| 14957 | −0.008478985 |
| 16468 | 0.01178596 |
| 5733 | 0.01442401 |
| 4748 | 0.00604811 |
| 4749 | −0.001180088 |
| 17758 | −0.01322739 |
| 1301 | −0.03655559 |
| 15125 | −0.005030922 |
| 17541 | 0.01180132 |
| 6406 | 0.008492458 |
| 1598 | 0.03642105 |
| 17805 | −0.01636465 |
| 1537 | −0.02368897 |
| 16768 | 0.005025752 |
| 17158 | −0.006618596 |
| 1037 | −0.03482728 |
| 17377 | 0.009030169 |
| 8664 | 0.005364025 |
| 15569 | −0.01163379 |
| 15408 | −0.004117654 |
| 15409 | 0.02009719 |
| 4615 | −0.0216485 |
| 16148 | −0.007715343 |
| 21078 | −0.002250057 |
| 23109 | 0.005140497 |
| 25064 | −0.02576101 |
| 1466 | −0.0115101 |
| 15741 | 0.001858723 |
| 13723 | −0.03098842 |
| 1183 | 0.007847724 |
| 1174 | −0.02682282 |
| 1814 | −0.02409571 |
| 23445 | 0.01268358 |
| 25069 | −0.01803054 |
| 25070 | −0.001117053 |
| 1247 | 0.002905345 |
| 17301 | 0.02169327 |
| 14346 | 0.01814763 |
| 15017 | −0.005796293 |
| 634 | 0.02392324 |
| 17806 | −0.03059827 |
| 15174 | 0.02558445 |
| 20887 | 0.003184597 |
| 20818 | 0.03540093 |
| 33 | 0.000687164 |
| 23523 | 0.04827108 |
| 1853 | 0.000184702 |
| 23987 | −0.009158069 |
| 21651 | −0.01072442 |
| 635 | 0.01430005 |
| 14347 | 0.007348958 |
| 25098 | 0.01413377 |
| 17157 | 0.002967211 |
| 17337 | 0.03499423 |
| 15703 | 0.003194804 |
| 15662 | −0.01996508 |
| 13973 | 0.01031566 |
| 18075 | 0.001804553 |
| 18076 | 0.01474427 |
| 4234 | −0.03231172 |
| 23625 | 0.008422249 |
| 15243 | −0.009537201 |
| 25165 | 0.004905388 |
| 3454 | −0.01269925 |
| 23045 | −0.01042821 |
| 17326 | −0.01356372 |
| 17327 | −0.01550095 |
| 22603 | 0.01994649 |
| 117 | −0.01073836 |
| 16649 | −0.003848922 |
| 985 | −0.004571139 |
| 4011 | 0.02594932 |
| 16007 | −0.03245922 |
| 16155 | −0.03767058 |
| 25198 | −0.04053008 |
| 744 | 0.01448024 |
| 5496 | −1.62254E−05 |
| 5497 | −0.004547023 |
| 25204 | 0.01864999 |
| 17535 | 0.01886001 |
| 16156 | −0.01055435 |
| 4723 | −0.02257333 |
| 2367 | 0.00281055 |
| 2368 | 0.0198073 |
| 6554 | −0.01628744 |
| 12422 | −0.003597185 |
| 12423 | −0.01363361 |
| 25247 | 0.02928529 |
| 20404 | −0.003382577 |
| 18956 | −0.03746372 |
| 2554 | 0.001275564 |
| 3254 | −0.02432042 |
| 4003 | −0.01871112 |
| 25257 | −0.006161937 |
| 15281 | −0.02035118 |
| 1214 | 0.01756383 |
| 18727 | −0.01572102 |
| 18246 | 0.001154571 |
| 18452 | −0.01337099 |
| 18453 | −0.007857254 |
| 20493 | 0.01936436 |
| 5492 | −0.01191286 |
| 18028 | −0.03629819 |
| 1354 | 0.009908063 |
| 25290 | 0.02397325 |
| 20494 | −0.000954101 |
| 18750 | −0.02634051 |
| 25315 | −0.03588133 |
| 3987 | 0.009837479 |
| 20149 | −0.04258657 |
| 22412 | −0.004335643 |
| 22413 | −0.00221225 |
| 109 | −0.005122522 |
| 22411 | 0.01450058 |
| 455 | −0.01210526 |
| 25405 | 0.01309029 |
| 20298 | −0.05332408 |
| 1622 | −0.003529147 |
| 21882 | 0.006960723 |
| 7872 | −0.01691339 |
| 24615 | −0.003635782 |
| 25460 | −0.007971963 |
| 25467 | −0.002433017 |
| 25468 | 0.009742874 |
| 25469 | −0.01432337 |
| 16449 | −0.000927568 |
| 16450 | 0.004114473 |
| 5837 | −0.005018729 |
| 25480 | 0.006534462 |
| 25481 | 0.03633816 |
| 4012 | 0.02058364 |
| 10886 | −0.02500923 |
| 5493 | −0.00559364 |
| 15127 | 0.01913647 |
| 14003 | 0.00302135 |
| 355 | 0.001723895 |
| 356 | −0.01191485 |
| 16248 | 0.02829451 |
| 15832 | −0.003373712 |
| 1471 | −0.007821926 |
| 18647 | −0.00834588 |
| 25518 | −0.01890072 |
| 9224 | −0.009229792 |
| 15135 | 0.03026445 |
| 25525 | 0.01468858 |
| 18990 | 0.002379164 |
| 16211 | −0.01861134 |
| 1943 | 0.01443373 |
| 25545 | −0.02041409 |
| 21583 | −0.000591347 |
| 25546 | −0.006230616 |
| 10260 | −0.002039004 |
| 25563 | −0.009749564 |
| 14121 | −0.01940992 |
| 3609 | 0.0020902 |
| 18005 | −0.000341325 |
| 16268 | −0.05654464 |
| 22196 | 0.01060633 |
| 12014 | 0.006231096 |
| 16708 | 0.01482556 |
| 16398 | 0.006464105 |
| 25632 | 0.03466999 |
| 4957 | 0.008092677 |
| 25643 | −0.03402377 |
| 23300 | 0.03958223 |
| 1546 | 0.01170207 |
| 22675 | −0.008282468 |
| 818 | −0.01053171 |
| 1550 | 0.01494726 |
| 1551 | 0.02599436 |
| 20715 | 0.01030098 |
| 16947 | 0.02858744 |
| 20884 | −0.02730658 |
| 24778 | −0.02842167 |
| 25675 | −0.0203886 |
| 20810 | −0.02795083 |
| 15653 | −0.00909295 |
| 25676 | −0.04245567 |
| 19244 | 0.01925244 |
| 1069 | 0.02009015 |
| 3202 | 0.01047109 |
| 25682 | −0.03644181 |
| 25686 | 0.01175157 |
| 20872 | 0.005200382 |
| 15201 | 0.01743058 |
| 9620 | 0.009678062 |
| 20427 | −0.007203343 |
| 25691 | −0.01287446 |
| 25699 | −0.01975985 |
| 10860 | −0.01890404 |
| 10267 | −0.01660402 |
| 5667 | 0.003279787 |
| 18611 | −0.01685318 |
| 17175 | 0.008473313 |
| 25702 | 0.006244145 |
| 10109 | 0.005310704 |
| 25707 | 0.03233485 |
| 15875 | 0.002634939 |
| 25719 | −0.01698852 |
| 4441 | 0.01366032 |
| 13646 | 0.01512804 |
| 23708 | 0.000573755 |
| 20844 | −0.00279304 |
| 22219 | 0.003093927 |
| 16272 | −0.004407614 |
| 25770 | −0.01879616 |
| 20173 | −0.007049952 |
| 407 | 0.004526638 |
| 8663 | 0.01127171 |
| 19824 | 1.61079E−05 |
| 1921 | 0.006592317 |
| 24428 | 0.01721819 |
| 24438 | −0.00262423 |
| 18619 | 0.005152837 |
| 24496 | −0.03948592 |
| 24567 | −0.01201788 |
| 291 | −0.02495906 |
| 24770 | −0.008714317 |
| 24843 | −0.03153809 |
| 24874 | 0.02920487 |
| 18686 | 0.01941361 |
| 43 | −0.01441405 |
| 133 | 0.04627691 |
| 24590 | −0.01762193 |
| 16675 | 0.03559083 |
| 13682 | 0.003206818 |
| 417 | −0.0215943 |
| 18008 | 0.003835681 |
| 466 | −0.003738717 |
| 24639 | −0.01283457 |
| 556 | −0.004202022 |
| 714 | 0.005186919 |
| 729 | −0.003318912 |
| 770 | 0.01406266 |
| 797 | 0.01683459 |
| 912 | −0.01437363 |
| 1928 | −0.007305755 |
| 1929 | 0.01778287 |
| 16610 | 0.01123602 |
| 24648 | 0.004198686 |
| 1104 | 0.02800208 |
| 1602 | 0.01814398 |
| 8426 | −0.0182353 |
| 1203 | −0.0288901 |
| 617 | −0.008825291 |
| 11692 | 0.02179052 |
| 19997 | 0.002543063 |
| 10071 | −0.01549941 |
| 16676 | 0.0117799 |
| 19952 | 0.004150428 |
| 15379 | −0.02876546 |
| 25907 | 0.03277824 |
| 19002 | −0.01186146 |
| 19943 | 0.000162394 |
| 20082 | 0.02651264 |
| 18078 | 0.000639759 |
| 20839 | −0.000873427 |
| 4259 | 0.01316487 |
| 15385 | 0.01291856 |
| 4242 | 0.01189998 |
| 16435 | −0.000204926 |
| 16849 | 0.02508564 |
| 15022 | 0.02776678 |
| 8888 | 0.01160653 |
| 1867 | −0.00064856 |
| 24329 | −0.03123893 |
| 1729 | −0.03759896 |
| 9541 | −0.03444796 |
| 21696 | 0.009596217 |
| 20812 | 0.0196699 |
| 13938 | −0.01164793 |
| 15434 | −0.006764275 |
| 15097 | 0.001716813 |
| 23362 | −0.0179409 |
| 17473 | −0.01096604 |
| 15616 | 0.001493839 |
| 18713 | 0.01234178 |
| 815 | −0.02093439 |
| 15247 | 0.01110444 |
| 21950 | 0.000306391 |
| 21682 | −0.006126722 |
| 20802 | −0.01220903 |
| 23709 | 0.02399753 |
| 16510 | 0.03670125 |
| 4449 | −0.00546298 |
| 18077 | 0.0171604 |
| 17160 | 0.01415535 |
| 2109 | −0.005310179 |
| 15190 | −0.01250142 |
| 16918 | −0.01725919 |
| 23660 | −0.01086482 |
| 8749 | −0.03118036 |
| 18687 | 0.003382211 |
| 21975 | 0.01300874 |
| 21842 | 0.001369081 |
| 15191 | 0.01105956 |
| 20717 | 0.01063375 |
| 3431 | −0.006921202 |
| 17570 | 0.007088764 |
| 15259 | −0.01822124 |
| 17563 | −0.02220618 |
| 17829 | 0.005354438 |
| 16081 | 0.0205121 |
| 1474 | −0.03084054 |
| 17448 | 0.02467472 |
| 9125 | −0.01139344 |
| 17196 | −0.06969452 |
| 8212 | 0.02652411 |
| 20702 | 0.002678285 |
| 573 | −0.02872789 |
| 409 | −0.007299354 |
| 4574 | −0.02958615 |
| 754 | −0.0157468 |
| 15468 | 0.000192713 |
| 12700 | −0.01010274 |
| 14124 | −0.01342113 |
| 20126 | 0.0146427 |
| 4450 | −0.04028917 |
| 4451 | −0.04007754 |
| 17197 | 0.02424782 |
| 17198 | 0.033739 |
| 16726 | 0.01229342 |
| 23698 | 0.01072602 |
| 23699 | 0.005510382 |
| 1540 | 0.02953147 |
| 19255 | −0.02175437 |
| 19256 | −0.047948 |
| 20405 | 0.02330483 |
| 20885 | −0.003796437 |
| 46 | 0.01204979 |
| 6055 | −0.01505172 |
| 14997 | −0.01111345 |
| 24563 | 0.002454691 |
| 24564 | −0.01268496 |
| 24651 | −0.0234343 |
| 240 | −0.01207596 |
| 10878 | −0.05290645 |
| 17105 | 0.02110802 |
| 1514 | 0.007158728 |
| 15112 | −0.007915743 |
| 24900 | 0.000776591 |
| 9109 | 0.02180698 |
| 1427 | −0.01731983 |
| 16683 | −0.02202782 |
| 3549 | −0.002275369 |
| 23524 | 0.02175325 |
| 19825 | 0.001300221 |
| 18958 | −0.009980402 |
| 20803 | −0.01980488 |
| 16871 | −0.02941303 |
| 12606 | −0.006382196 |
| 1970 | −0.00636348 |
| 23826 | −0.001208646 |
| 20925 | 0.01287874 |
| 20780 | −0.009828659 |
| 16895 | −0.01042923 |
| 1424 | 0.01814117 |
| 20481 | −2.73489E−05 |
| 1542 | 0.01467805 |
| 17226 | 0.04658792 |
| 17227 | 0.03661337 |
| 1479 | −0.02727375 |
| 1558 | 0.001784993 |
| 1559 | −0.00440292 |
| 20753 | 0.000428273 |
| 20865 | −0.02611805 |
| 1306 | 0.01473606 |
| 19543 | 0.01029956 |
| 15872 | 0.006396827 |
| 24640 | 0.02250593 |
| 20597 | −0.0072339 |
| 439 | 0.002488504 |
| 20518 | −0.008984546 |
| 12903 | 0.007889638 |
| 21562 | 0.002491812 |
| 10248 | 0.03579842 |
| 23606 | −0.000202168 |
| 21122 | 0.005247012 |
| 21123 | 0.01623291 |
| 570 | 0.0196455 |
| 16847 | 0.01145459 |
| 16204 | 0.02414009 |
| 16205 | 0.008361849 |
| 23854 | −0.01483347 |
| 24626 | −0.0146705 |
| 1885 | −0.01965638 |
| 13940 | 0.000886116 |
| 18108 | −0.005199345 |
| 646 | −0.05841963 |
| 20513 | 0.02871836 |
| 20483 | 0.002659336 |
| 11849 | 0.01031365 |
| 1977 | 0.000325571 |
| 20772 | 0.01157497 |
| 16448 | −0.01863292 |
| 18107 | 0.0166564 |
| 755 | −0.03462439 |
| 16681 | 0.0152882 |
| 4198 | 0.02822708 |
| 4199 | 0.004798302 |
| 16147 | 0.01038541 |
| 17554 | −0.02472233 |
| 16354 | 0.02817476 |
| 945 | 0.00993543 |
| 989 | −0.01391793 |
| 16407 | −0.000955995 |
| 7914 | 0.000102491 |
| 1419 | −0.04516254 |
| 24885 | 0.01988852 |
| 7064 | −0.005395484 |
| 17149 | 0.02755652 |
| 17150 | 0.03952128 |
| 17393 | −0.005221711 |
| 17394 | −0.00579925 |
| 1508 | −0.0102906 |
| 17284 | −0.007007458 |
| 17285 | 0.0214901 |
| 18501 | 0.02471658 |
| 18502 | −0.03477159 |
| 4589 | −0.000894857 |
| 18597 | 0.005855973 |
| 4594 | −0.01689378 |
| 16444 | 0.02065756 |
| 20809 | −0.02390898 |
| 15411 | 0.01785927 |
| 4467 | 0.01709855 |
| 18070 | 0.01584395 |
| 7488 | −0.02057392 |
| 24643 | −0.001264686 |
| 1509 | 0.00454317 |
| 13005 | −0.006822573 |
| 1894 | −0.00274857 |
| 4254 | −0.01411081 |
| 1762 | −0.01280683 |
| 1763 | −0.003490757 |
| 7784 | 0.002189607 |
| 23961 | −0.005958063 |
| 20868 | −0.01507699 |
| 20869 | −0.009079757 |
| 20699 | 0.00043838 |
| 20700 | −0.004172502 |
| 11153 | −0.02787509 |
| 16948 | −0.003215995 |
| 1678 | 0.000367942 |
| 1976 | 0.01736856 |
| 17502 | 0.01984278 |
| 17661 | −0.008856236 |
| 15580 | −0.02737185 |
| 17411 | −0.004684325 |
| 4178 | 0.00538893 |
| 15150 | −0.007069793 |
| 11852 | −0.000403569 |
| 4809 | −0.03041049 |
| 19067 | −0.007720506 |
| 20582 | −0.04267649 |
| 22374 | −0.01256255 |
| 22927 | −0.03448938 |
| 4222 | −0.0165522 |
| 7090 | −0.02020823 |
| 15927 | 6.41932E−05 |
| 11865 | −0.006393904 |
| 19402 | −0.04323217 |
| 16139 | −0.009440685 |
| 6451 | 0.006511471 |
| 16419 | −0.01146098 |
| 18084 | −0.01723762 |
| 15371 | −0.01097884 |
| 15376 | −0.008551695 |
| 15887 | −0.0465706 |
| 15888 | −0.007077734 |
| 15401 | 0.03108703 |
| 18902 | −0.003807752 |
| 15505 | 0.02092673 |
| 6153 | 0.005509851 |
| 4361 | −0.000569115 |
| 4386 | 0.02562726 |
| 24235 | 0.000464768 |
| 9952 | −0.009126578 |
| 9071 | −0.000939401 |
| 474 | −0.01146703 |
| 9091 | −0.0287723 |
| 17420 | 0.002994313 |
| 11959 | 0.01476976 |
| 17693 | 0.01033417 |
| 17289 | −0.003851629 |
| 17290 | 0.01185756 |
| 20522 | 0.000628409 |
| 20523 | 0.003173917 |
| 17249 | −0.02066336 |
| 16023 | 0.006094849 |
| 17779 | −0.000918023 |
| 1159 | 0.01132209 |
| 17630 | 0.009499276 |
| 13420 | 0.005331431 |
| 14595 | 0.02173968 |
| 16529 | −0.0408304 |
| 4482 | 0.03541986 |
| 4484 | 0.02414248 |
| 18190 | 0.02839109 |
| 17717 | 0.01780007 |
| 9027 | 0.01143368 |
| 13647 | 0.001145029 |
| 820 | −0.02052028 |
| 12016 | 0.004811067 |
| 21695 | 0.005617932 |
| 4499 | 0.00030477 |
| 8599 | 0.01191982 |
| 12275 | 0.004126427 |
| 12276 | 0.006840609 |
| 18274 | 0.000625962 |
| 18275 | −0.006242172 |
| 4512 | 0.01254979 |
| 15876 | 0.0076095 |
| 17500 | −0.02208598 |
| 23783 | −0.003488245 |
| 13542 | −0.001915889 |
| 22539 | 0.006842911 |
| 23322 | −0.002697228 |
| 12848 | −0.01525511 |
| 3853 | 0.02945047 |
| 3439 | −0.01804814 |
| 12020 | 0.01677873 |
| 3870 | 0.007775934 |
| 548 | 0.01829203 |
| 17752 | 0.01777645 |
| 18967 | −0.03837527 |
| 7505 | 0.00383637 |
| 9084 | −0.02018928 |
| 10540 | 0.02506434 |
| 3895 | −0.01868215 |
| 18396 | 0.01085198 |
| 18291 | 0.01498073 |
| 23063 | −0.002563515 |
| 18361 | 0.01949046 |
| 14309 | 0.002836866 |
| 21007 | −0.003881654 |
| 23203 | 0.001480229 |
| 4412 | 0.01905504 |
| 21035 | −0.01397706 |
| 18462 | −0.0280539 |
| 22386 | 0.01780035 |

1. A method of predicting at least one toxic effect of a compound, comprising:
(a) preparing a gene expression profile of a kidney tissue or cell sample exposed to the compound; and
(b) comparing the gene expression profile to a database comprising at least part of the data or information of Tables 5A-5N.

2. A method of claim 1, wherein the gene expression profile prepared from the tissue or cell sample comprises the level of expression for at least one gene.

3. A method of claim 1, wherein the kidney tissue or cell sample is derived from human tissue or cells.

4. A method of claim 2, wherein the level of expression is compared to a Tox Group Mean and/or Non-Tox Group Mean value in Tables 5A-5M.

5. A method of claim 4, wherein the level of expression is normalized prior to comparison.

6. A method of claim 2, wherein the gene expression level is a fold-change value calculated by an RMA algorithm.

7. A method of claim 6, wherein a prediction score is calculated for the tissue or cell sample, comprising:
a) multiplying the fold-change value for at least two genes in the gene expression profile by a PLS score from the database for the at least two genes; and
b) summing the products.

8. A method of claim 7, further comprising:
a) comparing the prediction score to a cut-off prediction score for a toxicity database, wherein a sample prediction score greater than or equal to the cut-off prediction score is indicative of a toxic response.

9. A method of claim 7, wherein the database PLS score for each gene is obtained from Table 5N.

10. A method of claim 1, wherein the database comprises nearly all of the data or information in Tables 5A-5N.

11. A method of predicting at least one toxic effect of a compound, comprising:
(a) detecting the level of expression in a tissue or cell sample exposed to the compound of two or more genes from Tables 1-5N; wherein differential expression of the genes in Tables 1-5N compared to a control is indicative of at least one toxic effect.

12. A method of predicting the progression of a toxic effect of a compound, comprising:
(a) detecting the level of expression in a tissue or cell sample exposed to the compound of two or more genes from Tables 1-5N; wherein differential expression of the genes in Tables 1-5N compared to a control is indicative of toxicity progression.

13. A method of claim 11, wherein the toxic effect is renal toxicity.

14. A method of identifying an agent that modulates the onset or progression of a toxic response, comprising:
(a) exposing a cell to the agent and a known toxin; and
(b) detecting the expression level of two or more genes from Tables 1-5N; wherein differential expression of the genes in Tables 1-5N compared to a control is indicative of toxicity.

15. A method of predicting the cellular pathways that a compound modulates in a cell, comprising:
(a) detecting the level of expression in a tissue or cell sample exposed to the compound of two or more genes from Tables 1-5N; wherein differential expression of the genes in Tables 1-5N compared to a control is associated the modulation of at least one cellular pathway.

16. A method of claim 11, wherein the compound exposure is in vivo.

17. A method of claim 11, wherein the level of expression is detected by an amplification or hybridization assay.

18. A method of claim 17, wherein the amplification assay is quantitative or semiquantitative PCR.

19. A method of claim 17, wherein the hybridization assay is selected from the group consisting of Northern blot, dot or slot blot, nuclease protection and microarray assays.

20. The method of claim 11, wherein the expression levels of at least 5 genes are detected.

21. The method of claim 11, wherein the expression levels of at least 10 genes are detected.

22. The method of claim 11, wherein the expression levels of at least 25 genes are detected.

23. The method of claim 11, wherein the expression levels of at least 30 genes are detected.

24. The method of claim 11, wherein the expression levels of at least 50 genes are detected.

25. The method of claim 11, wherein the expression levels of at least 75 genes are detected.

26. The method of claim 11, wherein the expression levels of at least 100 genes are detected.

27. The method of claim 11, wherein the two or more genes are rat genes.

28. A method of claim 11, wherein the effect is selected from the group consisting of renal tubule toxicity, renal tubule obstruction, glomerular injury and toxicity to the S2 segment of the proximal tubule.

29. A method of claim 13, wherein the renal toxicity is associated with at least one kidney disease pathology selected from the group consisting of renal tubule toxicity, renal tubule obstruction, glomerular injury and toxicity to the S2 segment of the proximal tubule.

30. A method of claim 15, wherein the cellular pathway is modulated by a compound selected from the group consisting of acyclovir, adriamycin, amphotericin, BEA, carboplatin, carbon tetrachloride, cephaloridine, chloroform, cidofovir, ciprofibrate, cisplatin, colchicine, cyclophosphamide, cyclosporine A, dantrolene, diclofenac, diflunisal, ethylene glycol, gentamicin, hexachloro-1,3-butadiene, hydralazine, ifosfamide, indomethacin, lithium chloride, meloxicam, menadione, mercuric chloride, olsalazine, puromycin aminonucleoside (PAN), pentamidine, phenacetin, propyleneimine, semustine, sodium chromate, sodium oxalate, sulfadiazine, suramin, tacrolimus, thioacetamide, vancomycin, AY-25329, cephalosporine, citrinin, hexachloro-1,3-butadiene and pamindronate.

31. A set of at least two probes, wherein each of the probes comprises a sequence that specifically hybridizes to a gene in Tables 1-5N.

32. A set of probes according to claim 31, wherein the set comprises probes that hybridize to at least 10 genes.

33. A set of probes according to claim 31, wherein the set comprises probes that hybridize to at least 25 genes.

34. A set of probes according to claim 31, wherein the set comprises probes that hybridize to at least 50 genes.

35. A set of probes according to claim 31, wherein the set comprises probes that hybridize to at least 100 genes.

36. A set of probes according to claim 31, wherein the probes are attached to a solid support.

37. A set of probes according to claim 36, wherein the solid support is selected from the group consisting of a membrane, a glass support and a silicon support.

38. A solid support comprising at least two probes, wherein each of the probes comprises a sequence that specifically hybridizes to a gene in Tables 1-5N.

39. A solid support of claim 38, wherein the gene is a rat gene.

40. A solid support of claim 38, wherein the array comprises at least about 100 different oligonucleotides in discrete locations per square centimeter.

41. A solid support of claim 38, wherein the array comprises at least about 1000 different oligonucleotides in discrete locations per square centimeter.

42. A solid support of claim 38, wherein the array comprises at least about 10,000 different oligonucleotides in discrete locations per square centimeter.

43. A computer system comprising:
(a) a database containing information related to the expression level in a tissue or cell sample exposed to a renal toxin of a set of genes comprising at least two genes in Tables 1-5N; and
(b) a user interface to access, recover or view the information.

44. A computer system of claim 43, wherein the database further comprises sequence information for the genes.

45. A computer system of claim 43, wherein the database further comprises information identifying the expression level for the set of genes in the tissue or cell sample before exposure to a renal toxin.

46. A computer system of claim 43, wherein the database further comprises information identifying the expression level of the set of genes in a tissue or cell sample exposed to at least a second renal toxin.

47. A computer system of claim 43, further comprising records including descriptive information from an external database, which information correlates said genes to records in the external database.

48. A computer system of claim 47, wherein the external database is GenBank.

49. A method of using a computer system of claim 43 to present information identifying the expression level in a tissue or cell of at least one gene in Tables 1-5N, comprising:
comparing the expression level of at least one gene in Tables 1-5N in a tissue or cell exposed to a test compound to the level of expression of said gene after exposure to the test compound in the database.

50. A method of claim 49, wherein the expression levels of at least 10 genes are compared.

51. A method of claim 49, wherein the expression levels of at least 50 genes are compared.

52. A method of claim 49, wherein the expression levels of at least 100 genes are compared.

53. A method of claim 49, further comprising the step of displaying the level of expression of at least one gene in the tissue or cell sample compared to the expression level of said gene when exposed to a toxin.

54. A method of claim 14, wherein the known toxin is a renal toxin.

55. A method of claim 54, wherein the renal toxin is selected from the group consisting of acyclovir, adriamycin, amphotericin, BEA, carboplatin, carbon tetrachloride, cephaloridine, chloroform, cidofovir, ciprofibrate, cisplatin, colchicine, cyclophosphamide, cyclosporine A, dantrolene, diclofenac, diflunisal, ethylene glycol, gentamicin, hexachloro-1,3-butadiene, hydralazine, ifosfamide, indomethacin, lithium chloride, meloxicam, menadione, mercuric chloride, olsalazine, puromycin aminonucleoside, pentamidine, phenacetin, propyleneimine, semustine, sodium chromate, sodium oxalate, sulfadiazine, suramin, tacrolimus, thioacetamide, and vancomycin, AY-25329, cephalosporine, citrinin, hexachloro-1,3-butadiene and pamindronate.

56. A method of claim 11, wherein nearly all of the genes in Tables 1-5N are detected.

57. A method of claim 56, wherein all of the genes in at least one of Tables 5A-5N are detected.

58. A kit comprising at least one solid support of claim 38 packaged with gene expression information for said genes.

59. A kit comprising at least one solid support of claim 38 packaged with instructions for its use.

60. A kit of claim 58, wherein the gene expression information comprises gene expression levels in a tissue or cell sample exposed to a renal toxin.

61. A kit of claim 58, wherein the gene expression information comprises a PLS score for each of said genes.

62. A kit of claim 58, wherein the gene expression information is in an electronic format.

63. A method of identifying an agent that modulates at least one activity of a protein encoded by a gene in Tables 1-5N comprising:
(a) exposing the protein to the agent; and
(b) assaying at least one activity of said protein.

64. A method of claim 63, wherein the agent is exposed to a cell expressing the protein.

65. A method of claim 64, wherein the cell is exposed to a known toxin.

66. A method of claim 65, wherein the toxin modulates the expression of the protein.

67. A computer system of claim 43, wherein the genes are rat genes.
